(19) United States
(12) Patent Application Publication
(10) Pub. No.: US 2014/0342190 A1
(43) Pub. Date: Nov. 20, 2014

(54) Rechargeable storage battery with improved performance

(71) Applicant: Peter Tamburrino, Antioch, IL (US)

(72) Inventor: Peter Tamburrino, Antioch, IL (US)

(21) Appl. No.: 13/986,639

(22) Filed: May 20, 2013

(51) Int. Cl. H01M 2/10; H01M 10/0525; H01M 10/42

(52) U.S. Cl. CPC H01M 2/105; H01M 10/4257; H01M 10/0525; H01M 2220/30; H01M 2010/4271
USPC 429/7

(57) ABSTRACT

A battery pack is provided for use with a wide variety of electronic and electrical equipment. Included is a battery pack for a cordless power device. The battery pack has a housing defining a hollow cavity, with a plurality of rechargeable energy cells disposed within the hollow cavity of the housing. The number of energy cells is divisible by numbers other than 8. A single control circuit is electrically coupled to the energy cells for controlling the operation of the energy cells during charging and discharging of the energy cells. In one example, the output voltage of energy cells is substantially less than that of an electrical series of 8 energy cells. Nonetheless, dual output voltages are provided, by employing a voltage boost feature in the control circuit.

### FIELD OF THE INVENTION

The present invention relates generally to electrical storage batteries and, in particular, to battery packs having a plurality of rechargeable cells electrically coupled to each other and to a control circuit disposed within a common housing. In particular, the present invention relates to a plurality of lithium ion cells arranged according to an improved internal packing configuration. These, and additional components such as a control circuit, are disposed within a housing, such as a housing of conventional size and design.

### BACKGROUND OF THE INVENTION

There has been interest in the electrical power supply industry to provide rechargeable battery systems having a compact, lightweight construction made with relatively inexpensive components such as readily commercially available individual storage cells coupled together and operating under control of one or more control circuits so as to provide advanced functions such as fuel gauging, cell balancing and communication via a serial data communications bus.

In addition to battery capacity needed to drive the intended load, demands arise from the nature of the application and the intended use of the load and battery system. An example of one particularly challenging field of use is that of modern rugged mobile military applications. The military is demanding higher performance, lower weight, longer effective usage times and high reliability for mobile, handheld applications such as navigation, fire control and Multiband Inter/Intra Team Radios (MBITR). These systems rely on increasingly sophisticated battery packs for their power requirements, yet they present unique design challenges because of the extreme environments to which they are exposed. Design engineers are faced with an array of challenges in developing effective battery systems—from cell and cell pack selection to intelligent power management, from safety concerns to charging systems. For example, should the battery system undergo full or partial power failure, a command signal may change state in an unexpected and undesired manner. Armed with an understanding of these demands, however, designers can make the best choices for battery-supplied power in today's rugged military applications.

Without a simple and cost-effective charging system, coupled with reliable rechargeable battery chemistry, the significance of portable lightweight battery energy sources would drop as a practical reality and have a far less impact on today's world. Handheld radios, telemetry monitors, weather stations, test equipment, missiles, rockets and satellites and the myriad of other equipment all rely on cost-effective reliable rechargeable battery technology for their operation. Indeed, without practical rechargeable battery systems, devices would be too cumbersome in their operation for everyday use.

Arguably, the most promising widespread rechargeable battery technology in use today is lithium ion technology. Development of this battery chemistry technology is far from an overnight phenomenon, having first been discovered in 1912 and the first lithium batteries were proposed about 1970. As is true in many other disciplines, substantial advancements in the technology had to wait until new materials with unusual performance characteristics were developed. Today, lithium ion technology can take many forms. Perhaps the greatest and most promising form is that of Lithium Cobalt Oxide (Li-cobalt), but Lithium Manganese Oxide (Li-manganese), Lithium Iron Phosphate (Li-phosphate), Lithium Nickel Manganese Cobalt Oxide (NMC), Lithium Nickel Cobalt Aluminum Oxide (NCA) and Lithium Titanate (Li-titanate) also play a substantial, commercially significant role. As will be seen herein, the present invention can be readily applied to these and other battery chemistries. Lithium-ion (Li-ion) cell characteristics include a nominal voltage of 3.6 V, 1000 duty cycles per lifetime, a rate load current of less than 4° C., an average energy density of 160 Wh/kg, a charge time of less than 4 hours and a typical discharge rate of a few percent per month when in storage. Li-ion cells operate effectively between −20° C. and +60° C. With recent improvements in battery chemistry, most notably new chemical formulations, the range is extended from −30° C. to +80° C.

Principally, three primary components come together to form a lithium-ion cell. These include a positive electrode or cathode, made from a layered metal oxide such as lithium cobalt oxide, a polyanion such as lithium iron phosphate or a spinel such as lithium manganese oxide. Also included is a negative electrode or anode made, for example, from carbon, graphite, or the like. An electrolyte surrounds the electrodes and may comprise, for example, a lithium salt suspended in an organic solvent. Examples of electrolytes also include mixtures of organic carbonates such as ethylene carbonate or diethyl carbonate. Since pure lithium is highly reactive, battery designers frequently opt to use a non-aqueous electrolyte. Of importance here is the recognition that these various material types making up a lithium ion cell must be compatible one with another and when combined in a battery system, the voltage, capacity, operational life and operational safety of the resulting lithium-ion battery can take on a wide variety of values. Typically, the electrodes and electrolyte are protected by an outer container sealed to prevent the intrusion of water. Compared to other battery chemistries, lithium-ion battery systems require careful control in their operation to limit peak voltages and to prevent a wide array of damage to the battery system.

After construction, a lithium-ion cell must be charged in order to acquire energy which is stored in the battery for later use. When the battery is being charged, lithium ions are liberated from the positive electrode, and move through the electrolyte to the negative electrode where they remain. During discharge, the lithium ions move in a reverse direction across the electrolyte toward the positive electrode, producing energy to an external device through electron flow through the device, a process interconnected that to that of ion flow within the cell.

As will be seen herein, the present invention has found immediate application with lithium-ion cells having a cylindrical form. However, as will be appreciated from studying the materials herein, the present invention also finds immediate practical application to other shapes or formats of lithium-ion cells, including those having a soft flat body or pouch, as well as larger cylindrical shapes which include terminals affording ready mechanical connection to external devices.

As mentioned, the present invention finds application for use with rechargeable battery systems. However, in the field of lithium ion technology, at least, these types of systems all have a limited thermal operating range. At times, it is necessary to provide portable lightweight electrical power in environments having extreme temperature ranges. A classic solution overcoming this type of problem has been to use non-rechargeable battery systems typically referred to as primary lithium battery systems. The present invention also has relevance to non-rechargeable or primary battery systems. In extreme applications, rechargeable battery chemistries may not be able to perform in a reliable manner. In this instance, disposable, one-time-use lithium cells (known as lithium-primary cells) may be considered. These lithium-primary cells feature a nominal voltage of 3.6 V, an optimal load current of less than 5° C., an average energy density of 160 Wh/kg and a negligible self-discharge rate supporting years of storage.

The range of anticipated operating temperatures often lies at the heart of extreme applications. By way of example, lithium-primary cells have been known to operate in temperatures ranging from −40° C. to +80° C. Examples of lithium-primary chemistries include lithium thionyl chloride (Li/SOCl2), lithium sulfur dioxide (Li/SO2) and lithium manganese dioxide (Li/MnO2).

Although the present invention is discussed with regard to a wide array of lithium-ion technologies, the present invention applies equally well to different types of battery chemistries, employing materials unrelated to those of lithium-ion systems. As will be seen herein, in one aspect, the present invention is directed to systems of battery packs, which employ a plurality of individual cells physically associated together and electrically coupled together to operate as a single entity. Thus, the present invention is concerned with balancing their compatibilities among all of the components employed within the systems, despite the precise nature of any particular system. Such considerations will come to the fore when considering the development of control circuitry designed to protect the system as a whole as well as to provide balance among its various components so as to optimize overall system performance.

One ongoing challenge has been to offer greater battery capacities in ever smaller sized packages. A special example of this industry goal is to provide increases in energy capacity for conventional, standardized packages that are well defined in the industry. Battery systems are not readily miniaturized using photolithographic and other popular techniques, as may be possible with other electronics components. Rather, reductions in battery size are more usually accompanied by improvements in battery materials themselves to pack greater energy storage in a smaller sized package. This of course may be attended by changes in battery chemistry. The present invention is concerned with advantages in increasing the capacity of battery packs, regardless of any particular chemistry employed, or whether the battery cells are rechargeable, or not.

Approaching the problem from a different perspective, there is a need to adapt and improve upon known commercial products so as to reduce overall operating expenses by eliminating the need for additional training of end-users and maintenance technicians. A special example of this is in the realm of military applications, where familiarity with new, improved products is vital to mission success, where lives are placed at risk in the interest of national defense. As is well known to those employed in the battlefield, it is surprising how quickly even very small changes can spin out of control in a critical life-threatening situation. The more the details and familiarity with systems is reduced, greater attention can be paid to the task at hand.

Apart from using known systems in a known way, it is frequently necessary to adapt or customize a system to meet changing conditions. By reducing the need to pay attention to changes in standardized systems, a user can devote greater energy to adapting a given system to meet unusual, unforeseen requirements. As a related benefit, by keeping improvements in existing equipment transparent to the user, greater use can be made of related accessories. As those responsible for systems operation will attest, oftentimes the array of accessories can outweigh the system they support.

As with other types of electronic components, battery systems are becoming more sophisticated, and have a tendency to use newer materials that exhibit sensitivities and requirements not previously encountered. With the ability to apply increasingly complex electronic controls, materials and component arrangements that are more inherently unstable may be made reliable in a practical environment. Nonetheless, the overall package must, as always, be rugged and capable of withstanding harsh environmental conditions. Controls needed to maintain a high standard of systems reliability must however not be prohibitively expensive or unusually difficult to deploy in practical real-world products. As will be seen herein, the present invention provides these desired types of improvements, thus delivering advantages without unnecessary downside risk.

As systems managers will immediately appreciate, substantial cost advantages can be achieved whenever a system can be constructed from a smaller variety of different types of components. For example, inventory costs are reduced, critical components are easier to stock and are more readily obtained in the available marketplace. In addition, training costs are reduced, and it is more likely that peripheral knowledge and skills developed for similar but not identical products can be brought to bear for products being designed and deployed. As a result, design times for new products can be greatly reduced. The present invention provides such advantages and allows construction of the battery packs and other battery systems to be simplified.

Despite advances, relatively simple, durable devices are needed for providing portable and lightweight electrical energy sources.

### SUMMARY OF THE INVENTION

With the advent of portable lightweight electronics devices, the need for reliable cost effective portable lightweight energy sources has increased dramatically. A popular format for battery storage energy sources is the so-called “battery pack.” Battery pack systems typically include a plurality of energy storage cells, coupled together and disposed within an outer container. Electrical terminals are provided to connect the internal energy cells to external load devices. It has become increasingly popular to provide some manner of visual gauge to provide a ready estimate of the remaining battery life, and perhaps to indicate critical operating parameters such as output voltage and temperature conditions within the battery pack.

As mentioned, the present invention is not intended to be limited to any particular battery chemistry or type. However, initial attention has been focused on lithium-ion battery technology arranged in an industry standard “2590 battery pack” type. In this type of arrangement, pluralities of lithium ion cells are disposed, along with one or more control circuits, within an outer surrounding housing. The individual cells are electrically coupled together according to a defined configuration, by electrically conductive interconnects, which in turn are coupled to battery pack terminals for communication with external load devices.

Although a number of different configurations may be theoretically possible in the abstract sense for standardized battery types, industry standard 2590 battery packs have been provided with 24 lithium-ion cells, thus setting the overall energy capacity of the battery pack, typically estimated as 24 times the energy capacity of each individual cell. Because the 2590 battery packs have been well defined in the commercial marketplace, it is not possible to improve battery capacity by enlarging the standardized size of the outer battery pack container. Rather, as will be seen herein, additional energy cells are disposed within the standardized size container according to the present invention. In addition, it has become accepted practice to divide the total number of cells in two to form two packs or sections. The packs are then coupled to one another in series or parallel to provide two different operating voltages, with the higher voltage usually being double that of the lower output voltage.

According to one aspect of the present invention, the cells are arranged in a combined series/parallel arrangement, sufficient to provide the lower operating voltage expected by an end-user. The present invention then employs a voltage regulator circuit to boost the lower voltage to an upper voltage level expected by the end user. In this manner, a battery pack is provided meeting a user's customary expectations. In addition to the voltage regulator circuit, other control functions are provided by an internal control circuit disposed within the outer housing. With the present invention, a user enjoys an immediate increase in battery power.

An example embodiment is directed to a battery pack for electronics devices and the like. The pack includes an outer housing supporting an electronic control module and a battery terminal block connected to the control module. A plurality of individual energy cells are disposed within the housing and are coupled to each other, the control module and the terminal block. Also included is a plurality of sense wires coupling the energy cells to the control module.

Another example embodiment is directed to an internal component arrangement within a battery pack. The pack includes a housing and a housing cover. The arrangement includes a plurality of energy cells assembled beforehand, for later insertion in the housing,

In one example embodiment, a battery pack for a cordless power device comprises a housing defining a hollow cavity, and a plurality of rechargeable energy cells disposed within the hollow cavity of the housing. The number of energy cells is divisible by a number other than 8, and the energy cells are coupled together to provide a lower maximum voltage than that required by the user. A plurality of interconnecting links electrically couple the energy cells together and provide a convenient internal component arrangement that can be fabricated prior to insertion within the outer housing. A control circuit is electrically coupled to the energy cells for controlling the operation of the energy cells during charging and discharging of the energy cells, and to perform other protective and power management functions. The control circuit also includes a voltage boost function that raises the output voltage of the energy cells to a maximum voltage required by the user.

The present invention finds immediate application in the field of smart battery packs which are capable of self-monitoring, wherein the voltage of each energy cell is individually monitored by a controller in the pack, such as a microprocessor, microcontroller, etc. This requires that each energy cell be wired up to the controller.

### BRIEF DESCRIPTION OF THE DRAWINGS

In the drawings:

FIG. 1 is a fragmentary schematic plan view of a battery pack according to principles of the present invention;

FIG. 2 is a fragmentary schematic plan view of a prior art battery pack;

FIG. 3 is a schematic diagrammatic view of the arrangement of FIG. 2;

FIG. 4 is a schematic diagrammatic view of the lower level components of the arrangement of FIG. 1;

FIG. 5 is a schematic diagrammatic view of the upper level components of the arrangement of FIG. 1;

FIG. 6 is a perspective view of the arrangement of FIG. 1;

FIG. 7 is a perspective view of the arrangement of FIG. 5;

FIG. 8 is a fragmentary schematic plan view of the battery pack including a printed circuit board and both connectors;

FIGS. 9-11 are fragmentary plan views of the arrangement of FIG. 8; and

FIGS. 12-14 are fragmentary schematic plan views of the top connector of the arrangement of FIG. 8.

### DESCRIPTION OF PREFERRED EMBODIMENTS

The invention disclosed herein is, of course, susceptible of embodiment in many forms. Shown in the drawings, and described herein in detail, are preferred embodiments of the invention. It is understood, however, that the present disclosure is an exemplification of the principles of the invention and does not limit the invention to the illustrated embodiments.

For ease of description, a battery pack device embodying the present invention provides electrical power for a variety of different electrical devices. The battery pack device is described herein in its usual assembled position as shown in the accompanying drawings and terms such as upstream, downstream, inner, outer, upper, lower, horizontal, longitudinal, etc., may be used herein with reference to this usual position. However, the device may be manufactured, transported, sold or used in orientations other than that described and shown herein.

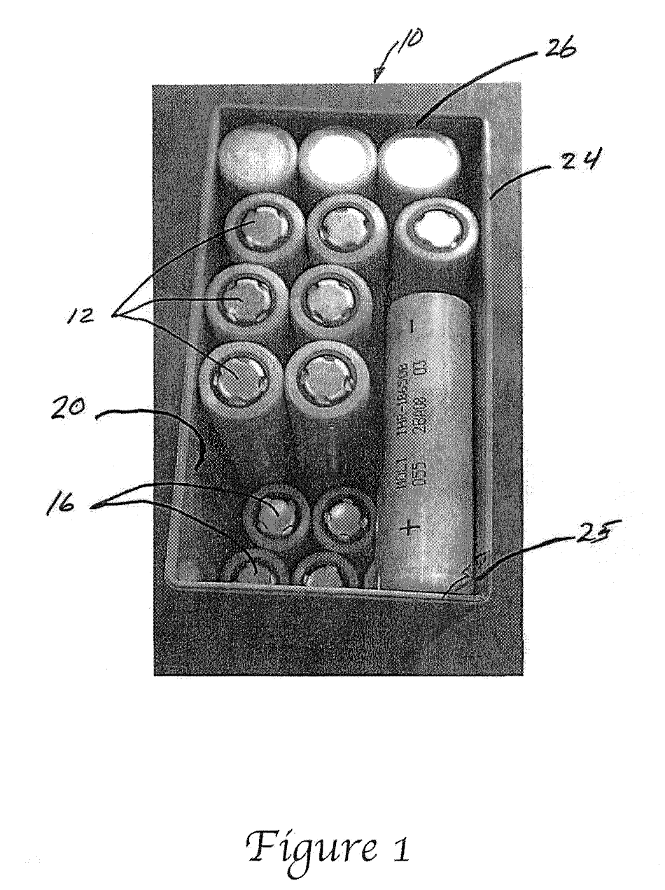

Referring now to the drawings, and initially to FIG. 1, a battery pack is generally indicated at 10. Battery pack 10 includes a plurality of rechargeable energy cells disposed within the hollow cavity of a housing 24. Preferably, housing 24 is made of a hard, tough plastic material formed by injection molding. The energy cells are enclosed within the housing 24 by a cover 25, shown partly broken away in FIG. 1. Also included in battery pack 10 is a control circuit, and interconnects electrically coupling the energy cells together, which are not shown in FIG. 1.

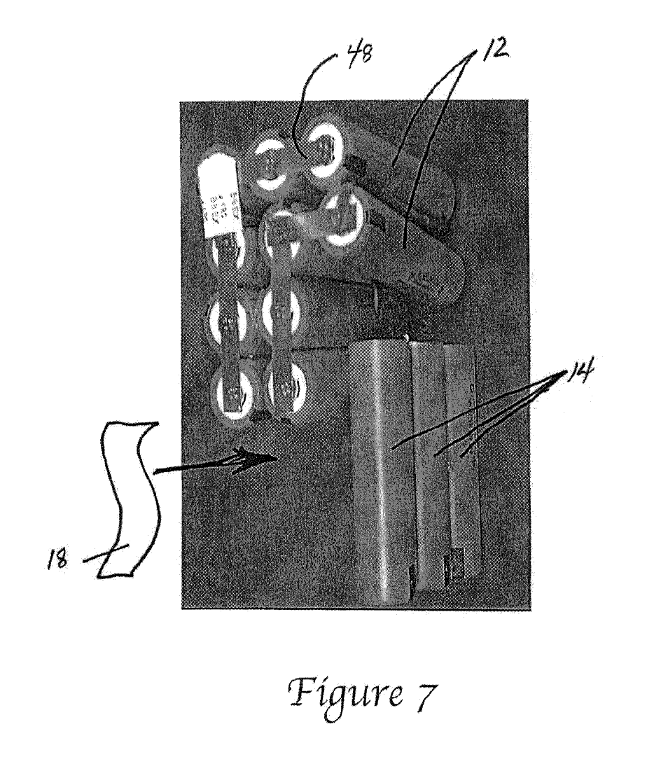

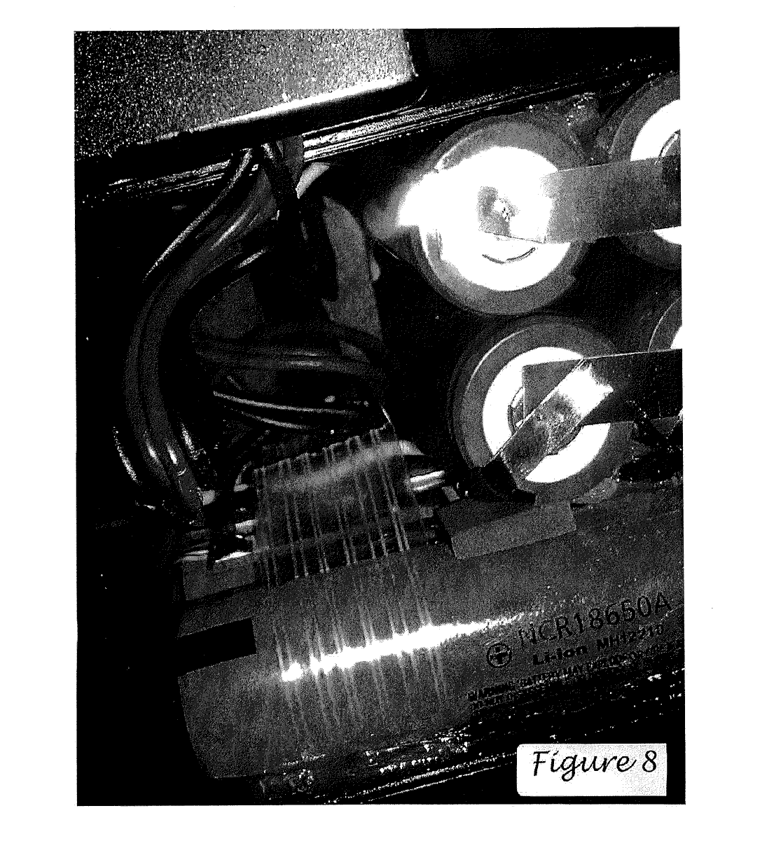

According to one aspect of the present invention, the cells are arranged in an internal component arrangement, preferably before being inserted within a housing 24. The arrangement is held in place by a plurality of interconnect straps which are welded, soldered or otherwise secured to the terminals of the energy cells, in a manner known in the art. One example of a preassembled internal component arrangement will be described below with respect to FIG. 7. Interconnects could comprise conductors having other forms, such as a wire form, if desired.

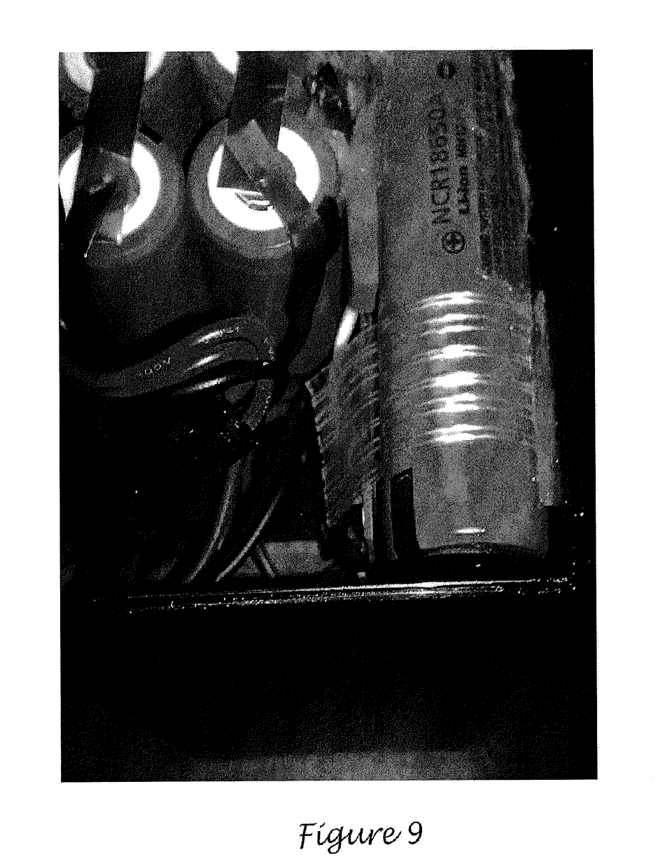

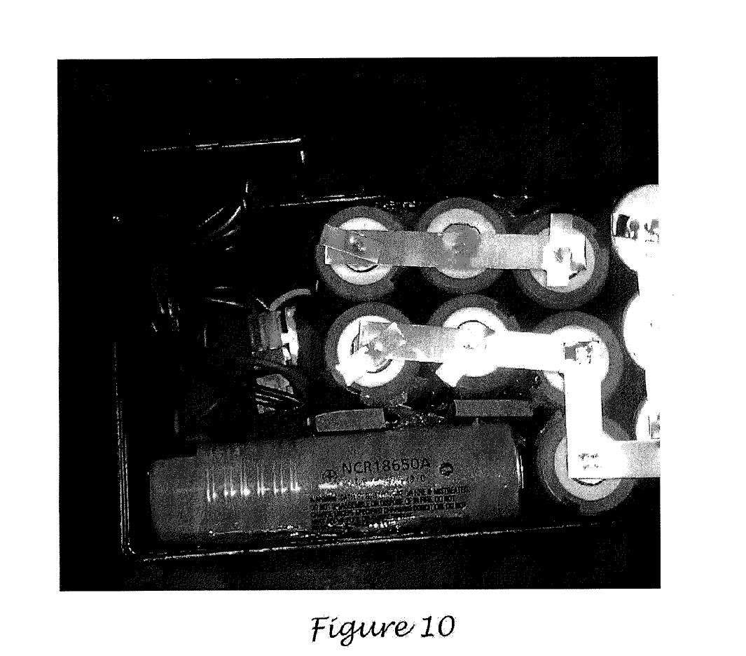

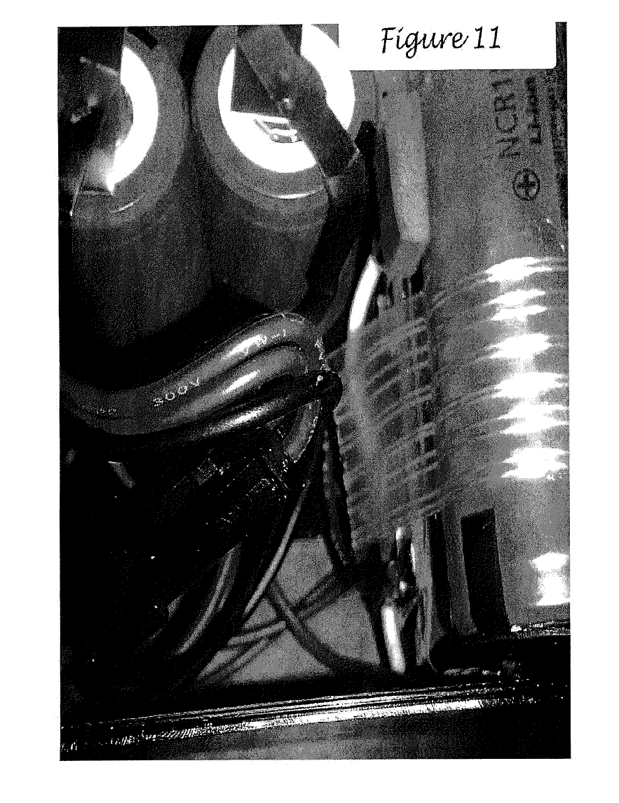

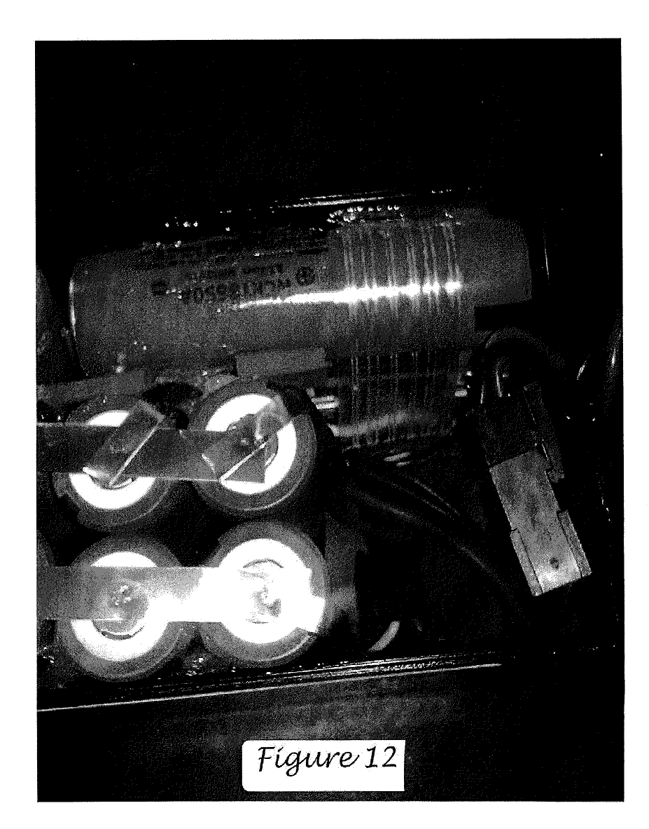

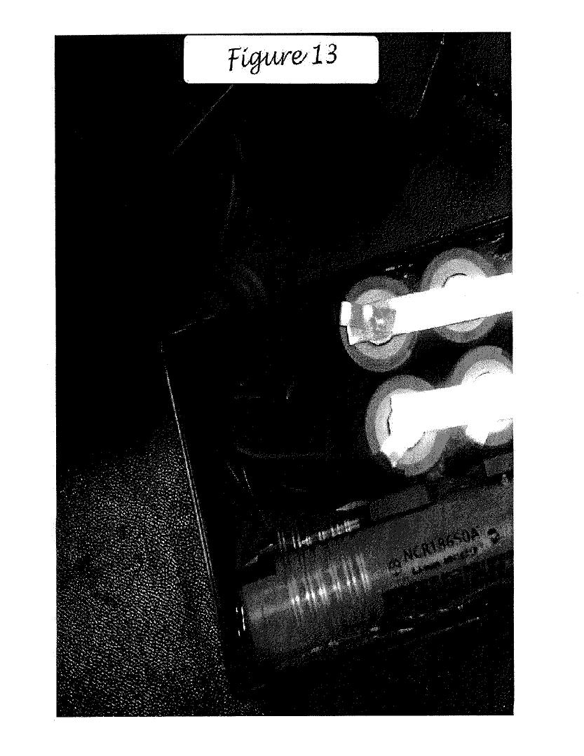

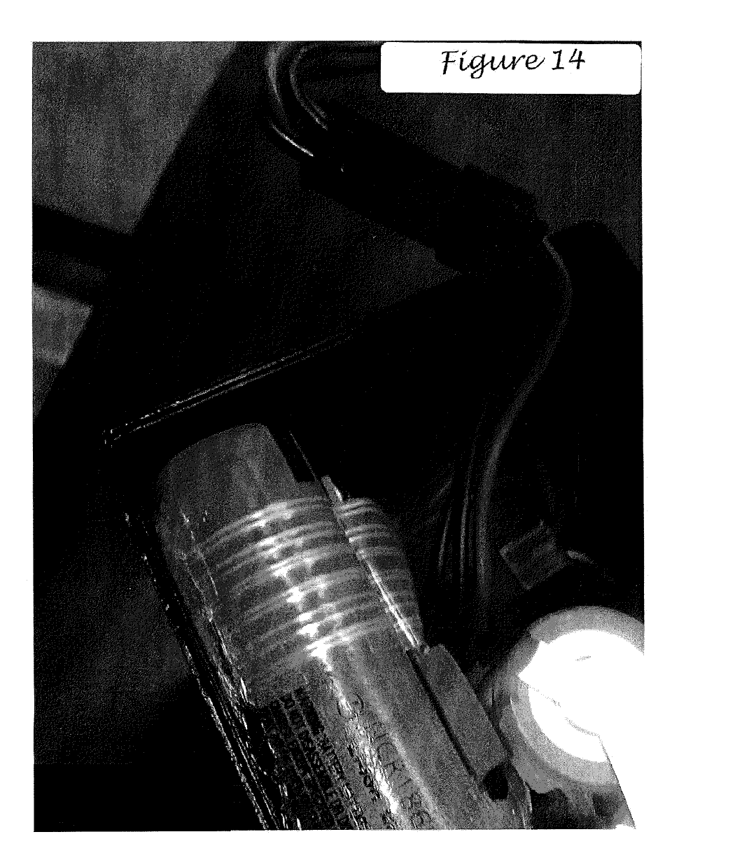

FIGS. 8-14 show the battery pack of the present invention with the cells wired to a printed circuit board (pcb). In a preferred embodiment, a flexible circuit board is provided. The Figures including the top connector show how the circuit provides a battery with two negative terminals and two positive terminals from the circuit board to mimic two separate packs (which is accomplished on the circuit board through an IC that divides the single or core pack into two packs). The two red wires are the positive leads of the two separate packs, and the two black wires are the corresponding negative leads. The bottom connector is also shown to illustrate how the cells are connected to the circuit board for protecting, monitoring and splitting the core pack into two packs. In addition, the Figures show the location of the circuit board under the orange foam inserts. The circuit board is positioned adjacent the three cells along the side wall of the housing. The circuit board is protected from jolting against the neighboring cells by the foam inserts. In this manner, the circuit board protects, monitors, balances and splits the two packs for communication with the connector out of the battery.

Principles of the present invention can be applied to a wide variety of battery packs and other battery products. The present invention will be described herein with regard to an industry standard “2590 battery pack” type. This type of battery pack has demonstrated high rate capability, is lightweight, has high energy density and provides long operating life and long shelf life while operating in a wide range of temperatures. Such a conventional battery is typically rated at about 206-215 Wh (watt-hours) and is suitable for use in communications, medical, military and instrumentation applications where extended battery life is critical. In this type of arrangement, a plurality of lithium-ion cells are disposed, along with one or more control circuits within an outer surrounding housing.

The cells serve as the primary energy source of the battery pack. Cells include a positive terminal adjacent its cathode electrode, and a negative terminal adjacent its anode electrode. The cathode and anode terminals are separated by a thin plastic film or separator. All three elements are maintained in an electrolyte medium to promote charge transfer between the electrodes that releases stored battery power. For example, a polymer battery uses a gel polymer as its electrolyte.

A large number of 18650 type cells have been placed in wide spread commercial use. This type of cell has its components contained in an outer cylindrical metal enclosure employed as a negative terminal. The cylindrical 18650 cells are efficient at distributing heat generated from the center of the cell to the cell exterior. Heretofore, 2590 type battery packs have been provided with 24 energy cells arranged in two packs or sections, to provide either a nominal 15 V output (as when the two sections are coupled in parallel) or a 30 V output, when the energy cells are all connected in series with one another. As a result, overall battery capacity is bounded by the precise type of energy cell employed and the output voltage desired.

As mentioned, it is generally preferred to use rechargeable lithium-ion 18650-type energy cells, available from a variety of different sources. Accordingly, it is to be expected that the battery capacity of the individual energy cells might vary from one source to another, thus providing a designer of battery packs with a range of choices for the makeup of the internal energy cells components disposed within the housing 24. Assuming, for example, that 18650 type cells having a battery capacity of 3.0 Ah are considered, the overall capacity of battery pack 10 would yield (3.7V/cell) (24 cells) (3.0 Ah) or 266.4 Wh. While the overall battery capacity can vary somewhat depending upon the commercial source of the energy cells, the capacity is generally observed to fall within a relatively narrow range of values due to practical, commercially available choices. According to principles of the present invention, the internal component arrangements of energy cells within housing 24 can be improved to allow additional standard-sized readily commercially available energy cells, thus substantially increasing the capacity of the battery pack.

The control circuit must perform a number of different functions. For example, in addition to minimizing thermal effects due to discharge under load, the control circuit must also control the charge rates of the energy cells. Consider, for example, a 18650 Li-cobalt cell. Even though this type of battery gives a high specific energy, it cannot be charged and discharged at a current higher than its rating. For example, an 18650 cell with a 2,000 mAh rating can only be charged and discharged at 2,000 mA. Forcing a fast charge or applying a load higher than 2,000 mA causes overheating and undue stress. One manufacturer recommends a charge-rate of 0.8 C at a level less than 2,000 mA for an optimal fast charge. The control circuit limits the charge and discharge rate to a safe level of about 1 C.

The control circuit controls safety and power management. The circuit may be packaged in the form of a printed circuit board having not only protection circuitry and thermal sensors, but which also provides the system intelligence for advanced functions such as fuel-gauge calculations on remaining cell capacity, cell balancing, managing thermal sensors such as thermistors to monitor internal pack temperature and to register not only operating temperature at the core, but also at the edge of the pack, as well as outside the enclosure. The control circuit also provides other advanced functions, such as LEDs that indicate pack or cell status, and a serial data communications bus that communicates with the host device.

As mentioned, battery protection functions are often included to limit the charge and discharge rates to safe levels. Since the cells are most critically affected by extreme temperatures, many of the advanced functions are employed for temperature control in one way or another. For example, forcing a fast charge or applying a load higher than recommended causes overheating and undue stress. Also, the battery's chemical reaction at high discharge rates generates a substantial amount of heat, and the effects of this heat must be factored into a practical battery-pack design. The effect of the generated heat is compounded in a multicell pack. Accordingly, the control circuit is employed to limit the charge and discharge rates to safe levels in this regard, as well. Active safety circuits have been required for some time now to ensure that commercially important battery chemistries are kept in a stable condition.

Each rechargeable battery chemistry has its own set of risks that must be managed on an ongoing basis. Li-ion batteries require the greatest degree of protection, including a thermal shutdown separator and exhaust vents (within each cell) to vent internal pressure. Typically, vent holes are unobstructed openings that expel potential gas vented from cells (when the cells are stressed under load or subject to high temperature environmental conditions). In some applications, high-pressure vent holes are also provided to moderate internal pressures by exhausting warm air within a pack only after a specific pressure has been reached within the pack. As long as the pressure is not increased to a dangerous level within the pack, high-pressure vent holes can control heat generated within the pack.

An external safety circuit that prevents overvoltage during charge and undervoltage during discharge must often be provided, along with one or more thermal sensors to prevent thermal runaway. Adequate battery protection must be provided to afford an appropriate level of safety and must be incorporated into the battery pack design. This attention to detail is warranted, however, since Li-ion battery packs have the potential of offering the most attractive method of portable battery power. As a result, many of the portable devices using the older chemistries have migrated to Li-ion in recent years.

In addition to these and other functions, a control circuit according to principles of the present invention also has a voltage boost capability, allowing the energy cells of the battery pack to be coupled together for a lower voltage than would otherwise be required. With voltage boost provided by the control circuit, this lower voltage can be increased as desired to a maximum level.

Referring again to FIG. 1, the plurality of energy cells is configured in different internal component arrangements, even though each of the energy cells is preferably identical to one another, to prevent load imbalance and the premature failure of the overall battery pack. For example, referring to the top of FIG. 1, ten energy cells 12 are disposed in an upright position. As shown in the bottom right corner of FIG. 1, three cells 14 are disposed one on top of the other, in a reclined position. Finally, six energy cells 16 disposed in the bottom of housing 24 are disposed in an upright position. The arrangement of the uppermost level of internal energy cell components is illustrated in FIG. 5 in diagrammatic form. Numeral 20 is applied to a recess or opening in the topmost layer of internal energy cell components which allows the energy cells 16 of the bottom layer to be partially visible in FIG. 1. FIG. 5 also shows a schematic representation of a control circuit 18 disposed between adjacent energy cells 12. As will be explained in further detail herein, it is generally preferred although not required, that the control circuitry is embodied on a flexible ribbon-like circuit board, to allow it to be easily accommodated within an internal energy cell assembly. As can be seen at the top of FIG. 1, energy cells 12 are recessed within a housing 24, being spaced from the top of the housing by a recess 26. With the advent of commercially affordable very low profile control circuitry, it may be possible to dispose some or all of the control circuitry atop the energy cells although, at this time, such would be prohibitively expensive.

Referring now to FIG. 4, a diagrammatic illustration of the lower level internal energy component assembly is shown. As mentioned above, the bottom-most array of upright energy cells 16 is partially visible in FIG. 1. An array of nine energy cells 40 is disposed above energy cells 16, and is arranged in three stacks, each stack being three cells deep. Thus, the bottom array contains fifteen energy cells, while the top array shown in FIG. 5 contains thirteen energy cells, for a total of 28 energy cells for battery pack 10 according to principles of the present invention. The lithium ion battery pack of the present invention provides substantially increased capacity. At the same time, the lower output voltage remains about the same, and the current draw across each cell is less, the operating temperature is reduced and the overall weight of the battery is not increased appreciably. To obtain a further advantage in overall battery capacity over conventional 24 cell 2590 type battery packs, 3.1 Ah energy cells are used in battery pack 10, rather than 3.0 Ah energy cells.

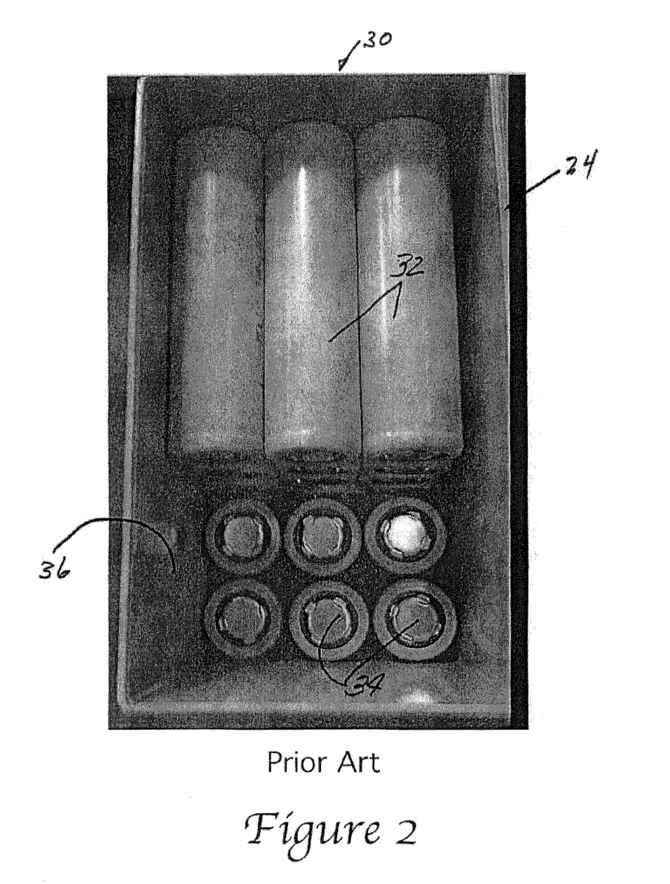

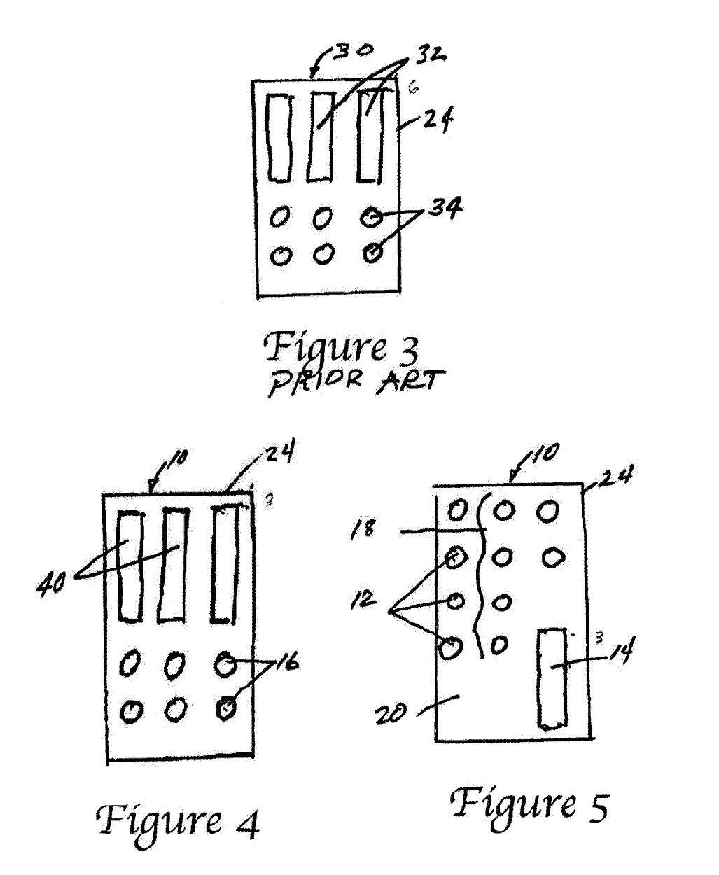

Turning now to FIG. 2, a prior art 2590-type battery pack 30 is shown having 24 energy cells. An array of eighteen reclining energy cells 32 are arranged in three vertically oriented stacks. An array of six upright energy cells 34 is located at the bottom of housing 24. A recess 36 is disposed above energy cells 34, to make room for electrical connectors for connecting battery pack 30 to an external load. FIG. 3 shows a schematic representation of energy cell placement. As mentioned, the energy cells 32 extend from near the top to the bottom of housing 24.

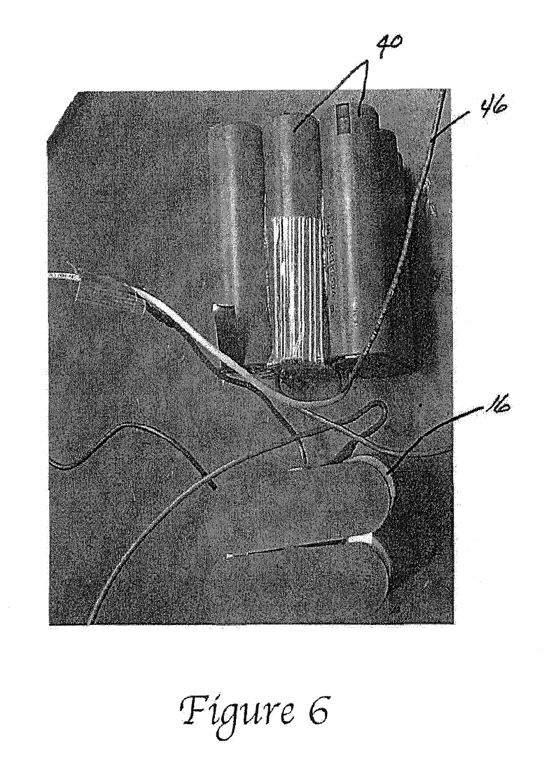

Referring now to FIG. 6, the bottom layer of the internal energy cell arrangement of battery pack 10 is shown prior to insertion into housing 24. Instead of conductive straps, interconnect wires 46 are used to couple the individual energy cells to one another and to the remaining circuitry of the battery pack. FIG. 7 shows the upper layer of internal energy cell arrangement of battery pack 10, with the energy cells interconnected by interconnect straps 48. A flexible control circuit 18 is shown in schematic form, ready to be associated with the energy cells.

As mentioned above, the prior art 2590-type lithium ion rechargeable battery 30 includes two independent 15-volt sections or packs, each with twelve cells and separate control and protection circuitry and battery capacity gauges for each pack, that allow operation of the battery in either 15-volt or 30-volt modes. As opposed to battery packs according to principles of the present invention, the prior art conventional 2590-type battery includes a pair of battery packs (pack A and pack B) that operate in combination. The combination operates in parallel or in series depending on how the connector on the battery engages the end device. Both packs A and B have their own protection, balancing and fuel gauging circuitry. Each individual pack (A or B) has twelve cells (18650 type) connected in a 4 series, 3 parallel connection (known as 4S3P). This can then result in a 4S6P or 8S3P configuration when the connector is engaged with the end device. For example, a pack assembled in a 4S6P configuration (four cells in series, six strings in parallel) Li-ion pack using 18650 cells (18-mm diameter, 65-mm length, 2.4-Ah), provides 14.4 V and 14.4 Ah of capacity. Thus, a conventional 2590 battery is limited to a total of twenty-four energy cells and a total watt-hour capacity of (3.7V/cell) (number of energy cells) (Ah rating of the energy cell). For example, the use of 3.0 Ah 18650 energy cells would yield a capacity of (3.7V/cell) (24 energy cells) (3.0 Ah) or 266.4 Wh. A significant advantage of the battery pack of the present invention is the use of a homogenous design that eliminates the use of two packs (pack A and pack B) so as to eliminate the possibility of an imbalance between (non-existent multiple) packs A and B as in a conventional 2590-type battery pack design. Out of balance packs result in a truncated run time on the 8S discharge due to one of the packs (either A or B) striking its low voltage cutoff first.

Relying on the existing draft angles of the conventional plastic housing of a conventional 2590 battery pack, along with a novel packing configuration, 28 cells can be positioned within the standard plastic housing of a conventional 2590-type battery. A representative diagram of the battery configuration of the present invention is shown in FIG. 1.

A table of representative values for a typical 2590-type battery pack is as follows:

| | |
|---|---|
| Model | Ultralife BB-2590 Rechargeable |
| | Battery |
| Nominal Dim- Length | 4.40 in. - 112.5 mm |
| Nominal Dim- Width | 2.45 in. - 62.5 mm |
| Nominal Dim- Height | 5.0 in. - 127.0 mm |
| Nominal Dim- Weight | 3.10 Lb (1.4 Kg) |
| Packs (sections) | 2 (12 energy cells each) |
| Nominal Dim- Maximum Voltage | 33 V, Two (2) 16.5 V Section |
| Nominal Dim- Nominal Voltage | 28.8 V, Two (2) 14.4 V Section |
| Nominal Dim- Capacity- Series | 6.2 Ah @ 28.8 V |
| (32.8 v) Mode (Pack A and Pack | |
| B Connected in Series) | |
| Nominal Dim- Capacity- Parallel | 12.4 Ah @ 16.5 V |
| (16.4 v). Mode (Pack A and Pack | |
| B Connected in Parallel) | |
| Nominal Dim- Storage | 20 C. to +55 C. (−4 F. to +131 F.) |
| Temperature Range | |
| Exterior/Housing- | Hard plastic, black (Noryl |
| | N190X-701) |
| temporary thermal disabling | 70 +− 5 deg C. internal |
| device | pack temperature |
| permanent thermal disabling | 68 deg C. extended storage |
| device | temperature |

These nominal specifications pertain to military batteries and other products manufactured by Ultralife Corporation, headquartered in Newark, N.Y.

As mentioned above, battery packs according to principles of the present invention have a resulting cell count (28 cells) that is not divisible by eight and, if used in a standard dual pack 2590-type configuration, would result in two separate packs of 4S3.5P with which it is not possible to achieve an 8S3.5P configuration. Instead, a battery design according to the present invention utilizing one pack (pack A or B only) is employed to provide a 4S7P configuration.

As mentioned, the present battery pack also includes but a single set of protection, balancing and fuel gauge circuitry. Moreover, due to the increased parallel connections, an additional ptc (positive temperature coefficient) parallel break is provided to account for any cell failures along the parallel string. The circuit is then regulated at the 29V end (using various methods) to simulate the eight cell series connection, thus resulting in an effective 8S3.5P output. This results in a higher intrinsic watt-hour capacity than a conventional 2590 battery pack. For example, an arrangement of the same 3.0 Ah 18650 cells according to the present invention would yield a capacity of (3.7V/cell) (28 cells) (3.0 Ah) or 310.8 Wh. This represents an increase in capacity by 16.7% from the same 18650 cells used in a conventional 2590 battery versus the improved 2590 battery design of the present invention with the present new battery configuration.

Run test data relating to a conventional 2590 battery pack and a battery pack according to the present invention are shown in Appendices A and B, respectively. As indicated in Appendix A, over a run time of about 5.5 hours, the conventional battery pack (in a single pack configuration) exhibited a capacity of about 95.6 Wh (corrected)—which translates to about 191.2 Wh as a double pack configuration. As indicated in Appendix B, over a run time of about 5.4 hours, the battery pack of the present invention exhibited a capacity of about 299.2 Wh (corrected).

A range of anticipated operating temperatures often lies at the heart of extreme applications. A battery pack must be continuously monitored to manage its thermal loading. Oftentimes, the primary temperature-related concern arises from temperature changes that are dependent on the amount of current drawn from the pack (i.e., greater current results in greater heat generation). These temperature increases, both within and outside the pack, must be factored into the design of the battery pack and portable device. Thermal monitoring and heat dissipation within the battery pack is critical for high-temperature operation.

Temperature-related concerns are not limited to high temperature levels. The performance of rechargeable Li-ion batteries starts to suffer as the temperature drops below 0° C., causing the internal impedance of the battery to increase. Cell capacity is also reduced at lower temperatures. If these cells are used or stored at or below −50° C., irreparable damage may occur under certain conditions to internal separators within the cells, making the cells a safety hazard.

A table of physical, electrical and environmental requirements of a battery pack according to the present invention is included below:

Physical Requirements

| | |
|---|---|
| Size (includes PCB | 4.369″ × 2.419″ × 4.969″ |
| connector board) | |
| Weight | 3.1 lbs |

Electrical Requirements

| | |
|---|---|
| Nominal capacity | 21 Ah (14.4 V), 10.5 Ah (28.8 V) |
| Output side (line) voltage | Battery terminal voltage: 14.4 V, 28.8 V |
| Output current rating | 16 A in 14.4 V mode, 8 A in 28.8 V mode |
| Fuel Gauge accuracy | Fuel gauge accuracy is 5% |
| Overcharge protection | Circuit protects against an overvoltage on |
| | the battery pack by opening the charge |
| | FET at 17.5 V in 14.4 V mode. The |
| | charge FET remains open until the |
| | voltage drops to a maximum of 16.4 V |
| Discharge protection | Battery enters self protection mode to |
| | prevent over discharge of battery under |
| | 9.6 V (in 14.4 V mode). |
| Overcurrent protection | Battery opens the discharge FET upon an |
| | current above 18 A (time within 1 s in |
| | 14.4 V mode) |
| Short circuit protection | Battery opens the discharge FET upon a |
| | short circuit (time within 500 ms) |
| Discharged storage | After battery shuts down due to low state |
| | of charge, the battery survives 6 months |
| | in discharged state without losing more |
| | than 15% of its original capacity. |
| Data information | Data is available under standard SMBus |
| | protocol |
| Connectivity | Battery contains connector pinout listed |
| | below |
| | Pin 1 Battery 1 negative |
| | Pin 2 Battery 2 negative |
| | Pin 3 Battery 1 postive |
| | Pin 4 Battery 1 positive |
| | Pin 5 Battery 2 positive |

Environmental Requirements

| | |
|---|---|
| Operating temperature range | −20 C.-45 C. (discharge) |
| Storage temperature range | −40 C.-60 C. |
| Packaging | Abs/Polycarb blend |
| Mil-PRF-32383/3 | Battery meets requirement |

With the features described herein, the heat of the energy cells of battery pack 10 upon discharge is reduced since the heat on discharge follows a close relationship to a resistive heating function. The R (internal resistance of the energy cell) in the 4S6P configuration is R/6. The R in the 4S7P configuration (utilizing the same energy cell in both designs) is R/7. This results in a 14% drop in heat due to energy cell discharge since the parallel string has a lower parallel resistance.

The present invention provides an improved high watt-hour lithium ion rechargeable battery pack including a plurality of cells (not comprising a multiple of eight) and an electrical circuit to provide a battery pack that mimics eight cells in series. As will be seen herein, the 28 energy cells are coupled together to achieve a maximum voltage which is substantially less than that of 28 energy cells coupled in series. Accordingly, the electrical control circuit includes a regulator with output voltage boosting circuitry to provide both of the desired 14.8V and 29.6V outputs. For example, the voltage boost circuitry can employ conventional switched-mode power supply techniques. In particular, the present invention relates to a battery pack comprising a non-multiple of eight cells (of the type typically used in a 2590 battery pack) and a corresponding mechanical packing assembly. The improved electromechanical design provides an increased capacity of about 16% watt-hours more than a standard 2590 battery pack due to the increase in cell count (as a non-multiple of eight cells).

There are other substantial advantages of present battery pack designs according to principles of the present invention, in addition to the substantial increase in capacity mentioned above. These advantages include reduced heat of the cells upon discharge, and avoidance of an imbalance in multiple internal battery packs. In a conventional 2590-type battery pack design, two 4S protection circuits (each including overvoltage, undervoltage, overcurrent and short circuit) must be employed, along with two 4S fuel gauge circuits. Both control circuits are necessary to accomplish an 8S voltage. By way of contrast, with the present invention, only one control circuit is required to provide voltage regulation (boost) as well as the protection, balancing and fuel gauge circuit functions for all of the energy cells employed in battery pack 10. Since only a single control circuit is used in the present invention, a substantial reduction in internal control components is achieved. Thus, both the complexity and cost of the battery pack are reduced.

The foregoing description and the accompanying drawings are illustrative of the present invention. Still other variations and arrangements are possible without departing from the spirit and scope of this invention. For example, although the battery pack and method according to the principles of the present invention have been explained above with regard to a particular commercial application, it will be readily appreciated that the present battery pack and method can be advantageously employed to provide improved measured dispensing of a variety of materials.

APPENDIX A
Conventional 2590 Battery Pack Run Time Test

| | | | | | | | | | | | | | | | Calculated Voltage | |
|---|---|---|---|---|---|---|---|---|---|---|---|---|---|---|---|---|
| | | | | | | | | | | | | | | | [symbol] | |
| | Raw data from B & K Electronic Load | | | | | Calculated Cell | Calculated Power | | | Corrected Power given a voltage and/or current [symbol] | | | | | Moving (II) | Voltage |
| Time | Current | Current | Voltage | Current | | Voltage | Peak | | Accumulated | Corrected | Corrected | Peak | | Accumulated | Average | Noise |
| (S) | Date | Time | (V) | (A) | Ah | Avg Volt | Power | W * 5 sec/hr | Wh | Voltage | Current | Power | W * 5 sec/hr | Wh | (V) | (V) |
| 5 | May 4, 2012 | 11:50:49 AM | 15.69 | 4.000 | 0.0058 | 3.923 | 62.760 | 0.087 | 0.09 | 15.740 | 4.0000 | 62.960 | 0.087 | 0.09 | | |
| 10 | May 4, 2012 | 11:50:54 AM | 15.65 | 4.000 | 0.0113 | 3.913 | 62.600 | 0.087 | 0.17 | 15.700 | 4.0000 | 62.800 | 0.087 | 0.17 | | |
| 15 | May 4, 2012 | 11:50:59 AM | 15.63 | 3.999 | 0.0168 | 3.908 | 62.504 | 0.087 | 0.26 | 15.680 | 3.9990 | 62.704 | 0.087 | 0.26 | | |
| 20 | May 4, 2012 | 11:51:04 AM | 15.61 | 4.000 | 0.0224 | 3.903 | 62.440 | 0.087 | 0.35 | 15.660 | 4.0000 | 62.640 | 0.087 | 0.35 | | |
| 25 | May 4, 2012 | 11:51:09 AM | 15.59 | 4:000 | 0.0278 | 3.898 | 62.360 | 0.087 | 0.43 | 15.640 | 4.0000 | 62.560 | 0.087 | 0.44 | | |
| 30 | May 4, 2012 | 11:51:14 AM | 15.58 | 4.000 | 0.0333 | 3.895 | 62.320 | 0.087 | 0.52 | 15.630 | 4.0000 | 62.520 | 0.087 | 0.52 | 15.59 | −0.006 |
| 35 | May 4, 2012 | 11:51:19 AM | 15.56 | 4.000 | 0.0390 | 3.890 | 62.240 | 0.086 | 0.61 | 15.610 | 4.0000 | 62.440 | 0.087 | 0.61 | 15.57 | −0.010 |
| 40 | May 4, 2012 | 11:51:24 AM | 15.55 | 4.000 | 0.0446 | 3.888 | 62.200 | 0.086 | 0.69 | 15.600 | 4.0000 | 62.400 | 0.087 | 0.70 | 15.56 | −0.006 |
| 45 | May 4, 2012 | 11:51:29 AM | 15.54 | 4.000 | 0.0501 | 3.885 | 62.160 | 0.086 | 0.78 | 15.590 | 4.0000 | 62.360 | 0.087 | 0.78 | 15.54 | −0.004 |
| 50 | May 4, 2012 | 11:51:34 AM | 15.53 | 4.000 | 0.0556 | 3.883 | 62.120 | 0.086 | 0.87 | 15.580 | 4.0000 | 62.320 | 0.087 | 0.87 | 15.53 | −0.002 |
| 55 | May 4, 2012 | 11:51:39 AM | 15.52 | 3.999 | 0.0612 | 3.880 | 62.064 | 0.086 | 0.95 | 15.570 | 3.9990 | 62.264 | 0.086 | 0.96 | 15.52 | −0.002 |
| 60 | May 4, 2012 | 11:51:44 AM | 15.51 | 3.999 | 0.0667 | 3.878 | 62.024 | 0.086 | 1.04 | 15.560 | 3.9990 | 62.324 | 0.086 | 1.04 | 15.51 | −0.002 |
| 65 | May 4, 2012 | 11:51:49 AM | 15.50 | 4.000 | 0.0723 | 3.875 | 62.000 | 0.086 | 1.12 | 15.550 | 4.0000 | 62.200 | 0.086 | 1.13 | 15.50 | −0.003 |
| 70 | May 4, 2012 | 11:51:54 AM | 15.49 | 4.000 | 0.0778 | 3.873 | 61.960 | 0.086 | 1.21 | 15.540 | 4.0000 | 62.160 | 0.086 | 1.21 | 15.49 | −0.005 |
| 75 | May 4, 2012 | 11:51:59 AM | 15.48 | 3.999 | 0.0834 | 3.870 | 61.905 | 0.086 | 1.30 | 15.530 | 3.9990 | 62.104 | 0.086 | 1.30 | 15.49 | −0.006 |
| 80 | May 4, 2012 | 11:52:04 AM | 15.48 | 4.000 | 0.0889 | 3.870 | 61.920 | 0.086 | 1.38 | 15.530 | 4.0000 | 62.120 | 0.086 | 1.39 | 15.48 | −0.001 |
| 85 | May 4, 2012 | 11:52:09 AM | 15.47 | 4.000 | 0.0945 | 3.868 | 61.880 | 0.086 | 1.47 | 15.520 | 4.0000 | 62.080 | 0.086 | 1.47 | 15.47 | −0.002 |
| 90 | May 4, 2012 | 11:52:14 AM | 15.46 | 4.000 | 0.1000 | 3.865 | 61.840 | 0.086 | 1.55 | 15.510 | 4.0000 | 62.040 | 0.086 | 1.56 | 15.47 | −0.005 |
| 95 | May 4, 2012 | 11:52:19 AM | 15.46 | 4.000 | 0.1055 | 3.865 | 61.840 | −0.086 | 1.64 | 15.510 | 4.0000 | 62.040 | 0.086 | 1.65 | 15.46 | 0.001 |
| 100 | May 4, 2012 | 11:52:24 AM | 15.45 | 3.999 | 0.1111 | 3.863 | 61.785 | 0.086 | 1.73 | 15.500 | 3.9990 | 61.985 | 0.086 | 1.73 | 15.45 | −0.004 |
| 105 | May 4, 2012 | 11:52:29 AM | 15.45 | 4.000 | 0.1166 | 3.863 | 61.800 | 0.086 | 1.81 | 15.500 | 4.0000 | 62.000 | 0.086 | 1.82 | 15.45 | 0.002 |
| 110 | May 4, 2012 | 11:52:34 AM | 15.44 | 3.999 | 0.1222 | 3.860 | 61.745 | 0.086 | 1.90 | 15.490 | 3.9990 | 61.945 | 0.086 | 1.90 | 15.44 | −0.003 |
| 115 | May 4, 2012 | 11:52:39 AM | 15.44 | 4.000 | 0.1276 | 3.860 | 61.760 | 0.086 | 1.98 | 15.490 | 4.0000 | 61.960 | 0.086 | 1.99 | 15.44 | −0.003 |
| 120 | May 4, 2012 | 11:52:44 AM | 15.43 | 3.999 | 0.1331 | 3.858 | 61.705 | 0.086 | 2.07 | 15.480 | 3.9990 | 61.905 | 0.086 | 2.08 | 15.43 | −0.003 |
| 125 | May 4, 2012 | 11:52:49 AM | 15.43 | 4:000 | 0.1386 | 3.858 | 61.720 | 0.086 | 2.16 | 15.480 | 4.0000 | 61.920 | 0.086 | 2.16 | 15.43 | 0.002 |
| 130 | May 4, 2012 | 11:52:54 AM | 15.42 | 4.000 | 0.1442 | 3.855 | 61.680 | 0.086 | 2.24 | 15.470 | 4.0000 | 61.880 | 0.086 | 2.25 | 15.42 | −0.004 |
| 135 | May 4, 2012 | 11:52:59 AM | 15.42 | 3.999 | 0.1497 | 3.855 | 61.665 | 0.086 | 2.33 | 15.470 | 3.9990 | 61.865 | 0.086 | 2.33 | 15.42 | 0.001 |
| 140 | May 4, 2012 | 11:53:04 AM | 15.41 | 3.999 | 0.1553 | 3.853 | 61.625 | 0.086 | 2.41 | 15.460 | 3.9990 | 61.825 | 0.086 | 2.42 | 15.41 | −0.005 |
| 145 | May 4, 2012 | 11:53:09 AM | 15.41 | 4.000 | 0.1610 | 3.853 | 61.640 | 0.086 | 2.50 | 15.460 | 4.0000 | 61.840 | 0.086 | 2.51 | 15.41 | 0.000 |
| 150 | May 4, 2012 | 11:53:14 AM | 15.41 | 4.000 | 0.1666 | 3.853 | 61.640 | 0.086 | 2.58 | 15.460 | 4.0000 | 61.840 | 0.086 | 2.59 | 15.41 | 0.004 |
| 155 | May 4, 2012 | 11:53:19 AM | 15.40 | 3.999 | 0.1721 | 3.850 | 61.585 | 0.086 | 2.67 | 15.450 | 3.9990 | 61.785 | 0.086 | 2.68 | 15.40 | −0.002 |
| 160 | May 4, 2012 | 11:53:24 AM | 15.40 | 4.000 | 0.1776 | 3.850 | 61.600 | 0.086 | 2.75 | 15.450 | 4.0000 | 61.800 | 0.086 | 2.76 | 15.40 | 0.002 |
| 165 | May 4, 2012 | 11:53:29 AM | 15.39 | 3.999 | 0.1832 | 3.848 | 61.545 | 0.085 | 2.84 | 15.440 | 3.9990 | 61.745 | 0.086 | 2.85 | 15.39 | −0.005 |
| 170 | May 4, 2012 | 11:53:34 AM | 15.39 | 4.000 | 0.1887 | 3.848 | 61.560 | 0.086 | 2.93 | 15.440 | 4.0000 | 61.760 | 0.086 | 2.93 | 15.39 | −0.001 |
| 175 | May 4, 2012 | 11:53:39 AM | 15.39 | 3.999 | 0.1943 | 3.848 | 61.545 | 0.085 | 3.01 | 15.440 | 3.9990 | 61.745 | 0.086 | 3.02 | 15.39 | 0.003 |
| 180 | May 4, 2012 | 11:53:44 AM | 15.38 | 4.000 | 0.1999 | 3.845 | 61.520 | 0.085 | 3.10 | 15.430 | 4.0000 | 61.720 | 0.086 | 3.11 | 15.38 | −0.003 |
| 185 | May 4, 2012 | 11:53:49 AM | 15.38 | 3.999 | 0.2054 | 3.845 | 61.505 | 0.085 | 3.18 | 15.430 | 3.9990 | 61.705 | 0.086 | 3.19 | 15.38 | 0.001 |
| 190 | May 4, 2012 | 11:53:54 AM | 15.38 | 3.999 | 0.2109 | 3.845 | 61.505 | 0.085 | 3.27 | 15.430 | 3.9990 | 61.705 | 0.086 | 3.28 | 15.38 | 0.005 |
| 195 | May 4, 2012 | 11:53:59 AM | 15.37 | 4.000 | 0.2165 | 3.843 | 61.480 | 0.085 | 3.35 | 15.420 | 4.0000 | 61.680 | 0.086 | 3.36 | 15.37 | −0.002 |
| 200 | May 4, 2012 | 11:54:04 AM | 15.37 | 3.999 | 0.2220 | 3.843 | 61.465 | 0.085 | 3.44 | 15.420 | 3.9990 | 61.665 | 0.086 | 3.45 | 15.37 | 0.002 |
| 205 | May 4, 2012 | 11:54:09 AM | 15.36 | 3.999 | 0.2276 | 3.840 | 61.425 | 0.085 | 3.52 | 15.410 | 3.9990 | 61.625 | 0.086 | 3.53 | 15.36 | −0.005 |
| 210 | May 4, 2012 | 11:54:14 AM | 15.36 | 3.999 | 0.2331 | 3.840 | 61.425 | 0.085 | 3.61 | 15.410 | 3.9990 | 61.625 | 0.086 | 3.62 | 15.36 | −0.001 |
| 215 | May 4, 2012 | 11:54:19 AM | 15.36 | 3.999 | 0.2386 | 3.840 | 61.425 | 0.085 | 3.69 | 15.410 | 3.9990 | 61.625 | 0.086 | 3.71 | 15.36 | 0.003 |
| 220 | May 4, 2012 | 11:54:24 AM | 15.35 | 3.999 | 0.2442 | 3.838 | 61.385 | 0.085 | 3.78 | 15.400 | 3.9990 | 61.585 | 0.086 | 3.79 | 15.35 | −0.004 |
| 225 | May 4, 2012 | 11:54:29 AM | 15.35 | 3.999 | 0.2497 | 3.838 | 61.385 | 0.085 | 3.86 | 15.400 | 3.9990 | 61.585 | 0.086 | 3.88 | 15.35 | 0.000 |
| 230 | May 4, 2012 | 11:54:34 AM | 15.35 | 4.000 | 0.2553 | 3.838 | 61.400 | 0.085 | 3.95 | 15.400 | 4.0000 | 61.600 | 0.086 | 3.96 | 15.35 | 0.004 |
| 235 | May 4, 2012 | 11:54:39 AM | 15.34 | 3.999 | 0.2608 | 3.835 | 61.345 | 0.085 | 4.03 | 15.390 | 3.9990 | 61.545 | 0.085 | 4.05 | 15.34 | −0.004 |
| 240 | May 4, 2012 | 11:54:44 AM | 15.34 | 3.999 | 0.2663 | 3.835 | 61.345 | 0.085 | 4.12 | 15.390 | 3.9990 | 61.545 | 0.085 | 4.13 | 15.34 | 0.000 |
| 245 | May 4, 2012 | 11:54:49 AM | 15.34 | 4.000 | 0.2719 | 3.835 | 61.360 | 0.085 | 4.21 | 15.390 | 4.0000 | 61.560 | 0.086 | 4.22 | 15.34 | 0.004 |
| 250 | May 4, 2012 | 11:54:54 AM | 15:33 | 4.000 | 0.2774 | 3.833 | 61.320 | 0.085 | 4.29 | 15.380 | 4.0000 | 61.520 | 0.085 | 4.30 | 15.33 | −0.004 |
| 255 | May 4, 2012 | 11:54:59 AM | 15.33 | 3.999 | 0.2830 | 3.833 | 61.305 | 0.085 | 4.38 | 15.380 | 3.9990 | 61.505 | 0.085 | 4.39 | 15.33 | −0.001 |
| 260 | May 4, 2012 | 11:55:04 AM | 15.33 | 3.999 | 0.2885 | 3.833 | 61.305 | 0.085 | 4.46 | 15.380 | 3.9990 | 61.505 | 0.085 | 4.48 | 15.33 | 0.003 |
| 265 | May 4, 2012 | 11:55:09 AM | 15:32 | 3.999 | 0.2941 | 3.830 | 61.265 | 0.085 | 4.55 | 15.370 | 3.9990 | 61.465 | 0.085 | 4.56 | 15.32 | −0.005 |
| 270 | May 4, 2012 | 11:55:14 AM | 15.32 | 3.999 | 0.2996 | 3.830 | 61.265 | 0.085 | 4.63 | 15.370 | 3.9990 | 61.465 | 0.085 | 4.65 | 15.32 | −0.002 |
| 275 | May 4, 2012 | 11:55:19 AM | 15.32 | 4.000 | 0.3051 | 3.830 | 61.280 | 0.085 | 4.72 | 15.370 | 4.0000 | 61.480 | 0.085 | 4.73 | 15.32 | 0.002 |
| 280 | May 4, 2012 | 11:55:24 AM | 15.32 | 3.999 | 0.3107 | 3.830 | 61.265 | 0.085 | 4.80 | 15.370 | 3.9990 | 61.465 | 0.085 | 4.82 | 15.32 | 0.005 |
| 285 | May 4, 2012 | 11:55:29 AM | 15.31 | 3.999 | 0.3161 | 3.828 | 61.225 | 0.085 | 4.89 | 15.360 | 3.9990 | 61.425 | 0.085 | 4.90 | 15.31 | −0.003 |
| 290 | May 4, 2012 | 11:55:34 AM | 15:31 | 3.999 | 0.3218 | 3.828 | 61.225 | 0.085 | 4.97 | 15.360 | 3.9990 | 61.425 | 0.085 | 4.99 | 15.31 | 0.001 |
| 295 | May 4, 2012 | 11:55:39 AM | 15:31 | 3.999 | 0.3273 | 3.828 | 61.225 | 0.085 | 5.06 | 15.360 | 3.9990 | 61.425 | 0.085 | 5.07 | 15.31 | −0.004 |
| 300 | May 4, 2012 | 11:55:44 AM | 15.30 | 3.999 | 0.3329 | 3.825 | 61.185 | 0.085 | 5.14 | 15.350 | 3.9990 | 61.385 | 0.085 | 5.16 | 15.30 | −0.004 |
| 305 | May 4, 2012 | 11:55:49 AM | 15.30 | 3.999 | 0.3384 | 3.825 | 61.185 | 0.085 | 5.23 | 15.350 | 3.9990 | 61.385 | 0.085 | 5.24 | 15.30 | −0.001 |
| 310 | May 4, 2012 | 11:55:54 AM | 15.30 | 4.000 | 0.3440 | 3.825 | 61.200 | 0.085 | 5.31 | 15.350 | 4.0000 | 61.400 | 0.085 | 5.33 | 15.30 | 0.003 |
| 315 | May 4, 2012 | 11:55:59 AM | 15:29 | 3.999 | 0.3495 | 3.823 | 61.145 | 0.085 | 5.40 | 15.340 | 3.9990 | 61.345 | 0.085 | 5.41 | 15.29 | −0.005 |
| 320 | May 4, 2012 | 11:56:04 AM | 15.29 | 3.999 | 0.3549 | 3.823 | 61.145 | 0.085 | 5.48 | 15.340 | 3.9990 | 61.345 | 0.085 | 5.50 | 15.29 | −0.002 |
| 325 | May 4, 2012 | 11:56:09 AM | 15.29 | 3:999 | 0.3604 | 3.823 | 61.145 | 0.085 | 5.57 | 15.340 | 3.9990 | 61.345 | 0.085 | 5.58 | 15.29 | 0.002 |
| 330 | May 4, 2012 | 11:56:14 AM | 15.29 | 3.999 | 0.3660 | 3.823 | [symbol] | [symbol] | [symbol] | [symbol] | 3.9990 | 61.345 | 0.085 | 5.67 | 15.29 | 0.005 |
| 335 | May 4, 2012 | 11:56:19 AM | 15.28 | 3.999 | 0.3715 | 3.820 | 61.105 | 0.085 | 5.74 | 15.330 | 3.9990 | 61.305 | 0.085 | 5.75 | 15.28 | −0.003 |
| 340 | May 4, 2012 | 11:56:24 AM | 15.28 | 4.000 | 0.3770 | 3.820 | 61.120 | 0.085 | 5.82 | 15.330 | 4.0000 | 61.320 | 0.085 | 5.84 | 15.28 | 0.000 |
| 345 | May 4, 2012 | 11:56:29 AM | 15.28 | 3.999 | 0.3826 | 3.820 | 61.105 | 0.085 | 5.91 | 15.330 | 3.9990 | 61.305 | 0.085 | 5.92 | 15.28 | 0.003 |
| 350 | May 4, 2012 | 11:56:34 AM | 15.27 | 3.999 | 0.3881 | 3.818 | 61.065 | 0.085 | 5.99 | 15.320 | 3.9990 | 61.265 | 0.085 | 6.01 | 15.27 | −0.005 |
| 355 | May 4, 2012 | 11:56:39 AM | 15.27 | 3.999 | 0.3937 | 3.818 | 61.065 | 0.085 | 6.07 | 15.320 | 3.9990 | 61.265 | 0.085 | 6.09 | 15.27 | −0.002 |
| 360 | May 4, 2012 | 11:56:44 AM | 15.27 | 4.000 | 0.3992 | 3.818 | 61.080 | 0.085 | 6.16 | 15.320 | 4.0000 | 61.280 | 0.085 | 6.18 | 15.27 | 0.002 |
| 365 | May 4, 2012 | 11:56:49 AM | 15.27 | 3.999 | 0.4048 | 3.818 | 61.065 | 0.085 | 6.24 | 15.320 | 3.9990 | 61.265 | 0.085 | 6.26 | 15.27 | 0.005 |
| 370 | May 4, 2012 | 11:56:54 AM | 15.26 | 3.999 | 0.4103 | 3.815 | 61.025 | 0.085 | 6.33 | 15.310 | 3.9990 | 61.225 | 0.085 | 6.35 | 15.26 | −0.003 |
| 375 | May 4, 2012 | 11:56:59 AM | 15.26 | 3.999 | 0.4159 | 3.815 | 61.025 | 0.085 | 6.41 | 15.310 | 3.9990 | 61.225 | 0.085 | 6.43 | 15.26 | 0.000 |
| 380 | May 4, 2012 | 11:57:04 AM | 15.26 | 4.000 | 0.4214 | 3.815 | 61.040 | 0.085 | 6.50 | 15.310 | 4.0000 | 61.240 | 0.085 | 6.52 | 15.26 | 0.003 |
| 385 | May 4, 2012 | 11:56:09 AM | 15.25 | 3.999 | 0.4269 | 3.813 | 60.985 | 0.085 | 6.58 | 15.310 | 3.9990 | 61.185 | 0.085 | 6.61 | 15.25 | −0.005 |
| 390 | May 4, 2012 | 11:57:14 AM | 15.25 | 3.999 | 0.4325 | 3.813 | 60.985 | 0.085 | 6.67 | 15.300 | 3.9990 | 61.185 | 0.085 | 6.69 | 15.25 | −0.002 |
| 395 | May 4, 2012 | 11:57:19 AM | 15.25 | 3.999 | 0.4380 | 3.813 | 60.985 | 0.085 | 6.75 | 15.300 | 3.9990 | 61.185 | 0.085 | 6.77 | 15.25 | 0.002 |
| 400 | May 4, 2012 | 11:57:24 AM | 15.25 | 4.000 | 0.4436 | 3.813 | 61.000 | 0.085 | 6.84 | 15.300 | 4.0000 | 61.200 | 0.085 | 6.86 | 15.25 | 0.005 |
| 405 | May 4, 2012 | 11:57:29 AM | 15.24 | 3.999 | 0.4493 | 3.810 | 60.945 | 0.085 | 6.92 | 15.290 | 3.9990 | 61.145 | 0.085 | 6.94 | 15.24 | −0.003 |
| 410 | May 4, 2012 | 11:57:34 AM | 15.24 | 3.999 | 0.4548 | 3.810 | 60.945 | 0.085 | 7.01 | 15.290 | 3.9990 | 61.160 | 0.085 | 7.03 | 15.24 | 0.000 |
| 415 | May 4, 2012 | 11:57:39 AM | 15.24 | 4.000 | 0.4604 | 3.810 | 60.960 | 0.085 | 7.09 | 15.290 | 4.0000 | 61.105 | 0.085 | 7.11 | 15.24 | 0.003 |
| 420 | May 4, 2012 | 11:57:44 AM | 15.23 | 3.999 | 0.4657 | 3.808 | 60.905 | 0.085 | 7.18 | 15.280 | 3.9990 | 61.105 | 0.085 | 7.20 | 15.23 | −0.005 |
| 425 | May 4, 2012 | 11:57:49 AM | 15.23 | 3.999 | 0.4713 | 3.808 | 60.905 | 0.085 | 7.26 | 15.280 | 3.9990 | 61.105 | 0.085 | 7.28 | 15.23 | −0.002 |
| 430 | May 4, 2012 | 11:57:54 AM | 15.23 | 3.999 | 0.4768 | 3.808 | 60.905 | 0.085 | 7.35 | 15.280 | 3.9990 | 61.105 | 0.085 | 7.37 | 15.23 | 0.001 |
| 435 | May 4, 2012 | 11:57:59 AM | 15.23 | 3.999 | 0.4824 | 3.808 | 60.905 | 0.085 | 7.43 | 15.280 | 3.9990 | 61.105 | 0.085 | 7.45 | 15.23 | 0.004 |
| 440 | May 4, 2012 | 11:58:04 AM | 15.22 | 3.999 | 0.4879 | 3.805 | 60.865 | 0.085 | 7.51 | 15.270 | 3.9990 | 61.035 | 0.085 | 7.54 | 15.22 | −0.004 |
| 445 | May 4, 2012 | 11:58:09 AM | 15.22 | 3.999 | 0.4935 | 3.805 | 60.865 | 0.085 | 7.60 | 15.270 | 3.9990 | 61.065 | 0.085 | 7.62 | 15.22 | −0.001 |
| 450 | May 4, 2012 | 11:58:14 AM | 15.22 | 3.999 | 0.4990 | 3.805 | 60.865 | 0.085 | 7.68 | 15.270 | 3.9990 | 61.065 | 0.085 | 7.71 | 15.22 | 0.001 |
| 455 | May 4, 2012 | 11:58:19 AM | 15.22 | 3.999 | 0.5045 | 3.805 | 60.865 | 0.085 | 7.77 | 15.270 | 3.9990 | 61.065 | 0.085 | 7.79 | 15.22 | 0.004 |
| 460 | May 4, 2012 | 11:58:24 AM | 15.21 | 3.999 | 0.5101 | 3.803 | 60.825 | 0.084 | 7.85 | 15.260 | 3.9990 | 61.025 | 0.085 | 7.88 | 15.21 | −0.004 |
| 465 | May 4, 2012 | 11:58:29 AM | 15.21 | 3.999 | 0.5156 | 3.803 | 60.825 | 0.084 | 7.94 | 15.260 | 3.9990 | 61.025 | 0.085 | 7.96 | 15.21 | −0.001 |
| 470 | May 4, 2012 | 11:58:34 AM | 15.21 | 3.999 | 0.5212 | 3.803 | 60.825 | 0.084 | 8.02 | 15.260 | 3.9990 | 61.025 | 0.085 | 8.05 | 15.21 | 0.001 |
| 475 | May 4, 2012 | 11:58:39 AM | 15.21 | 3.999 | 0.5267 | 3.803 | 60.825 | 0.084 | 8.11 | 15.260 | 3.9990 | 61.025 | 0.085 | 8.13 | 15.21 | 0.004 |
| 480 | May 4, 2012 | 11:58:44 AM | 15.20 | 3.999 | 0.5323 | 3.800 | 60.785 | 0.084 | 8.19 | 15.250 | 3.9990 | 60.985 | 0.085 | 8.22 | 15.20 | −0.004 |
| 485 | May 4, 2012 | 11:58:49 AM | 15.20 | 3.999 | 0.5378 | 3.800 | 60.785 | 0.084 | 8.27 | 15.250 | 3.9990 | 60.985 | 0.085 | 8.30 | 15.20 | −0.001 |
| 490 | May 4, 2012 | 11:58:54 AM | 15.20 | 3.999 | 0.5433 | 3.800 | 60.785 | 0.084 | 8.36 | 15.250 | 3.9990 | 60.985 | 0.085 | 8.39 | 15.20 | 0.001 |
| 495 | May 4, 2012 | 11:58:59 AM | 15.20 | 3.999 | 0.5489 | 3.800 | 60.785 | 0.084 | 8.44 | 15.250 | 3.9990 | 60.985 | 0.085 | 8.47 | 15.20 | 0.004 |
| 500 | May 4, 2012 | 11:59:04 AM | 15.19 | 3.999 | 0.5544 | 3.798 | 60.785 | 0.084 | 8.53 | 15.240 | 3.9990 | 60.945 | 0.085 | 8.56 | 15.19 | −0.004 |
| 505 | May 4, 2012 | 11:59:09 AM | 15.19 | 3.999 | 0.5600 | 3.798 | 60.745 | 0.084 | 8.61 | 15.240 | 3.9990 | 60.945 | 0.085 | 8.64 | 15.19 | −0.001 |
| 510 | May 4, 2012 | 11:59:14 AM | 15.19 | 3.999 | 0.5655 | 3.798 | 60.745 | 0.084 | 8.70 | 15.240 | 3.9990 | 60.945 | 0.085 | 8.73 | 15.19 | 0.001 |
| 515 | May 4, 2012 | 11:59:19 AM | 15.19 | 3.999 | 0.5711 | 3.798 | 60.745 | 0.084 | 8.78 | 15.240 | 3.9990 | 60.945 | 0.085 | 8.81 | 15.19 | 0.004 |
| 520 | May 4, 2012 | 11:59:24 AM | 15.18 | 3.999 | 0.5766 | 3.795 | 60.705 | 0.084 | 8.87 | 15.230 | 3.9990 | 60.905 | 0.085 | 8.89 | 15.18 | −0.004 |
| 525 | May 4, 2012 | 11:59:29 AM | 15.18 | 3.999 | 0.5821 | 3.795 | 60.705 | 0.084 | 8.95 | 15.230 | 3.9990 | 60.905 | 0.085 | 8.98 | 15.18 | −0.001 |
| 530 | May 4, 2012 | 11:59:34 AM | 15.18 | 3.999 | 0.5877 | 3.795 | 60.705 | 0.084 | 9.03 | 15.230 | 3.9990 | 60.905 | 0.085 | 9.06 | 15.18 | 0.001 |
| 535 | May 4, 2012 | 11:59:39 AM | 15.18 | 3.999 | 0.5932 | 3.795 | 60.705 | 0.084 | 9.12 | 15.230 | 3.9990 | 60.905 | 0.085 | 9.15 | 15.18 | 0.004 |
| 540 | May 4, 2012 | 11:59:44 AM | 15.17 | 3.999 | 0.5988 | 3.793 | 60.665 | 0.084 | 9.20 | 15.220 | 3.9990 | 60.865 | 0.085 | 9.23 | 15.17 | −0.004 |
| 545 | May 4, 2012 | 11:59:49 AM | 15.17 | 3.999 | 0.6043 | 3.793 | 60.665 | 0.084 | 9.29 | 15.220 | 3.9990 | 60.865 | 0.085 | 9.32 | 15.17 | −0.001 |
| 550 | May 4, 2012 | 11:59:54 AM | 15.17 | 3.999 | 0.6099 | 3.793 | 60.665 | 0.084 | 9.37 | 15.220 | 3.9990 | 60.865 | 0.085 | 9.40 | 15.17 | 0.001 |
| 555 | May 4, 2012 | 11:59:59 AM | 15.17 | 3.999 | 0.6154 | 3.790 | 60.625 | 0.084 | 9.46 | 15.220 | 3.9990 | 60.865 | 0.085 | 9.49 | 15.17 | 0.004 |
| 560 | May 4, 2012 | 12:00:04 PM | 15.16 | 3.999 | 0.6209 | 3.790 | 60.625 | 0.084 | 9.54 | 15.210 | 3.9990 | 60.825 | 0.084 | 9.57 | 15.16 | −0.004 |
| 565 | May 4, 2012 | 12:00:09 PM | 15.16 | 3.999 | 0.6265 | 3.790 | 60.625 | 0.084 | 9.62 | 15.210 | 3.9990 | 60.825 | 0.084 | 9.66 | 15.16 | −0.001 |
| 570 | May 4, 2012 | 12:00:14 PM | 15.16 | 3.999 | 0.6320 | 3.790 | 60.585 | 0.084 | 9.71 | 15.210 | 3.9990 | 60.825 | 0.084 | 9.74 | 15.16 | 0.001 |
| 575 | May 4, 2012 | 12:00:19 PM | 15.16 | 3.999 | 0.6376 | 3.788 | 60.585 | 0.084 | 9.79 | 15.210 | 3.9990 | 60.825 | 0.084 | 9.82 | 15.16 | 0.004 |
| 580 | May 4, 2012 | 12:00:24 PM | 15.15 | 3.999 | 0.6431 | 3.788 | 60.585 | 0.084 | 9.88 | 15.200 | 3.9990 | 60.785 | 0.084 | 9.91 | 15.15 | −0.004 |
| 585 | May 4, 2012 | 12:00:29 PM | 15.15 | 3.999 | 0.6487 | 3.788 | 60.585 | 0.084 | 9.96 | 15.200 | 3.9990 | 60.785 | 0.084 | 9.99 | 15.15 | −0.001 |
| 590 | May 4, 2012 | 12:00:34 PM | 15.15 | 3.999 | 0.6542 | 3.788 | 60.585 | 0.084 | 10.04 | 15.200 | 3.9990 | 60.785 | 0.084 | 10.08 | 15.15 | 0.001 |
| 595 | May 4, 2012 | 12:00:39 PM | 15.15 | 3.999 | 0.6598 | 3.785 | 60.545 | 0.084 | 10.13 | 15.200 | 3.9990 | 60.785 | 0.084 | 10.16 | 15.15 | 0.003 |
| 600 | May 4, 2012 | 12:00:44 PM | 15.14 | 3.999 | 0.6653 | 3.785 | 60.545 | 0.084 | 10.21 | 15.190 | 3.9990 | 60.745 | 0.084 | 10.25 | 15.14 | −0.005 |
| 605 | May 4, 2012 | 12:00:49 PM | 15.14 | 3.999 | 0.6710 | 3.785 | 60.545 | 0.084 | 10.30 | 15.190 | 3.9990 | 60.745 | 0.084 | 10.33 | 15.14 | −0.002 |
| 610 | May 4, 2012 | 12:00:54 PM | 15.14 | 3.999 | 0.6766 | 3.785 | 60.545 | 0.084 | 10.38 | 15.190 | 3.9990 | 60.745 | 0.084 | 10.42 | 15.14 | 0.000 |
| 615 | May 4, 2012 | 12:00:59 PM | 15.14 | 3.999 | 0.6821 | 3.785 | 60.454 | 0.084 | 10.47 | 15.190 | 3.9990 | 60.745 | 0.084 | 10.50 | 15.14 | 0.002 |
| 620 | May 4, 2012 | 12:01:04 PM | 15.14 | 3.999 | 0.6875 | 3.785 | 60.545 | 0.084 | 10.55 | 15.190 | 3.9990 | 60.745 | 0.084 | 10.58 | 15.14 | 0.005 |
| 625 | May 4, 2012 | 12:01:09 PM | 15.13 | 3.999 | 0.6930 | 3.783 | 60.505 | 0.084 | 10.63 | 15.180 | 3.9990 | 60.705 | 0.084 | 10.67 | 15.13 | −0.003 |
| 630 | May 4, 2012 | 12:01:14 PM | 15.13 | 3.999 | 0.6985 | 3.783 | 60.505 | 0.084 | 10.72 | 15.180 | 3.9990 | 60.705 | 0.084 | 10.75 | 15.13 | −0.001 |
| 635 | May 4, 2012 | 12:01:19 PM | 15.13 | 3.999 | 0.7041 | 3.783 | 60.505 | 0.084 | 10.80 | 15.180 | 3.9990 | 60.705 | 0.084 | 10.84 | 15.13 | 0.001 |
| 640 | May 4, 2012 | 12:01:24 PM | 15.13 | 3.999 | 0.7096 | 3.783 | 60.505 | 0.084 | 10.89 | 15.180 | 3.9990 | 60.705 | 0.084 | 10.92 | 15.13 | 0.004 |
| 645 | May 4, 2012 | 12:01:29 PM | 15.12 | 3.999 | 0.7152 | 3.780 | 60.465 | 0.084 | 10.97 | 15.170 | 3.9990 | 60.665 | 0.084 | 11.01 | 15.12 | −0.004 |
| 650 | May 4, 2012 | 12:01:34 PM | 15.12 | 3.999 | 0.7207 | 3.780 | 60.465 | 0.084 | 11.05 | 15.170 | 3.9990 | 60.665 | 0.084 | 11.09 | 15.12 | −0.001 |
| 655 | May 4, 2012 | 12:01:39 PM | 15.12 | 3.999 | 0.7263 | 3.780 | 60.465 | 0.084 | 11.14 | 15.170 | 3.9990 | 60.665 | 0.084 | 11.17 | 15.12 | 0.001 |
| 660 | May 4, 2012 | 12:01:44 PM | 15.12 | 3.999 | 0.7318 | 3.780 | 60.425 | 0.084 | 11.22 | 15.170 | 3.9990 | 60.665 | 0.084 | 11.26 | 15.12 | 0.003 |
| 665 | May 4, 2012 | 12:01:49 PM | 15.11 | 3.999 | 0.7375 | 3.778 | 60.425 | 0.084 | 11.31 | 15.160 | 3.9990 | 60.665 | 0.084 | 11.34 | 15.11 | −0.005 |
| 670 | May 4, 2012 | 12:01:54 PM | 15.11 | 3.999 | 0.7431 | 3.778 | 60.425 | 0.084 | 11.39 | 15.160 | 3.9990 | 60.625 | 0.084 | 11.43 | 15.11 | −0.002 |
| 675 | May 4, 2012 | 12:01:59 PM | 15.11 | 3.999 | 0.7486 | 3.778 | 60.425 | 0.084 | 11.47 | 15.160 | 3.9990 | 60.625 | 0.084 | 11.51 | 15.11 | 0.000 |
| 680 | May 4, 2012 | 12:02:04 PM | 15.11 | 3.999 | 0.7542 | 3.778 | 60.425 | 0.084 | 11.56 | 15.160 | 3.9990 | 60.625 | 0.084 | 11.59 | 15.11 | 0.002 |
| 685 | May 4, 2012 | 12:02:09 PM | 15.11 | 3.999 | 0.7597 | 3.778 | 60.425 | 0.084 | 11.64 | 15.160 | 3.9990 | 60.625 | 0.084 | 11.68 | 15.11 | 0.005 |
| 690 | May 4, 2012 | 12:02:14 PM | 15.10 | 3.999 | 0.7652 | 3.775 | 60.385 | 0.084 | 11.72 | 15.150 | 3.9990 | 60.585 | 0.084 | 11.76 | 15.10 | −0.003 |
| 695 | May 8, 2012 | 12:02:19 PM | 15.10 | 3.999 | 0.7708 | 3.775 | 60. [symbol] | 0.082 | [symbol] | [symbol] | 3.9990 | 60.585 | 0.082 | 11.85 | 15.10 | −0.001 |
| 700 | May 8, 2012 | 12:02:24 PM | 15.10 | 3.999 | 0.7762 | 3.775 | 60.385 | 0.082 | 11.89 | 15.150 | 3.9990 | 60.585 | 0.082 | 11.93 | 15.10 | 0.001 |
| 705 | May 8, 2012 | 12:02:29 PM | 15.10 | 3.999 | 0.7817 | 3.775 | 60.400 | 0.082 | 11.98 | 15.150 | 3.9990 | 60.600 | 0.082 | 12.02 | 15.10 | 0.003 |
| 710 | May 8, 2012 | 12:02:34 PM | 15.09 | 3.999 | 0.7873 | 3.773 | 60.345 | 0.082 | 12.06 | 15.140 | 3.9990 | 60.545 | 0.082 | 12.10 | 15.09 | −0.005 |
| 715 | May 8, 2012 | 12:02:39 PM | 15.09 | 3.999 | 0.7928 | 3.773 | 60.345 | 0.082 | 12.14 | 15.140 | 3.9990 | 60.545 | 0.082 | 12.18 | 15.09 | −0.002 |
| 720 | May 8, 2012 | 12:02:44 PM | 15.09 | 3.999 | 0.7983 | 3.773 | 60.345 | 0.082 | 12.23 | 15.140 | 3.9990 | 60.545 | 0.082 | 12.27 | 15.09 | 0.000 |
| 725 | May 8, 2012 | 12:02:49 PM | 15.09 | 3.999 | 0.8039 | 3.773 | 60.345 | 0.082 | 12.31 | 15.140 | 3.9990 | 60.545 | 0.082 | 12.35 | 15.09 | 0.002 |
| 730 | May 8, 2012 | 12:02:54 PM | 15.09 | 3.999 | 0.8094 | 3.773 | 60.345 | 0.082 | 12.40 | 15.140 | 3.9990 | 60.545 | 0.082 | 12.44 | 15.09 | 0.005 |
| 735 | May 8, 2012 | 12:02:59 PM | 15.08 | 3.999 | 0.8150 | 3.770 | 60.305 | 0.082 | 12.48 | 15.130 | 3.9990 | 60.505 | 0.082 | 12.52 | 15.08 | −0.003 |
| 740 | May 8, 2012 | 12:03:04 PM | 15.08 | 3.999 | 0.8205 | 3.770 | 60.305 | 0.082 | 12.56 | 15.130 | 3.9990 | 60.505 | 0.082 | 12.60 | 15.08 | −0.001 |
| 745 | May 8, 2012 | 12:03:09 PM | 15.08 | 3.999 | 0.8261 | 3.770 | 60.305 | 0.082 | 12.65 | 15.130 | 3.9990 | 60.505 | 0.082 | 12.69 | 15.08 | 0.001 |
| 750 | May 8, 2012 | 12:03:14 PM | 15.08 | 3.999 | 0.8316 | 3.770 | 60.305 | 0.082 | 12.73 | 15.130 | 3.9990 | 60.505 | 0.082 | 12.77 | 15.08 | 0.004 |
| 755 | May 8, 2012 | 12:03:19 PM | 15.07 | 3.999 | 0.8372 | 3.768 | 60.265 | 0.082 | 12.81 | 15.120 | 3.9990 | 60.465 | 0.082 | 12.86 | 15.08 | −0.004 |
| 760 | May 8, 2012 | 12:03:24 PM | 15.07 | 3.999 | 0.8427 | 3.768 | 60.265 | 0.082 | 12.90 | 15.120 | 3.9990 | 60.465 | 0.082 | 12.94 | 15.07 | −0.001 |
| 765 | May 8, 2012 | 12:03:29 PM | 15.07 | 3.999 | 0.8482 | 3.768 | 60.265 | 0.082 | 12.98 | 15.120 | 3.9990 | 60.465 | 0.082 | 13.02 | 15.07 | 0.001 |
| 770 | May 8, 2012 | 12:03:34 PM | 15.07 | 3.999 | 0.8538 | 3.768 | 60.265 | 0.082 | 13.07 | 15.120 | 3.9990 | 60.465 | 0.082 | 13.11 | 15.07 | 0.004 |
| 775 | May 8, 2012 | 12:03:39 PM | 15.06 | 3.999 | 0.8593 | 3.765 | 60.225 | 0.082 | 13.15 | 15.110 | 3.9990 | 60.425 | 0.082 | 13.19 | 15.07 | −0.004 |
| 780 | May 8, 2012 | 12:03:44 PM | 15.06 | 3.999 | 0.8650 | 3.765 | 60.225 | 0.082 | 13.23 | 15.110 | 3.9990 | 60.425 | 0.082 | 13.28 | 15.06 | −0.001 |
| 785 | May 8, 2012 | 12:03:49 PM | 15.06 | 3.999 | 0.8706 | 3.765 | 60.225 | 0.082 | 13.32 | 15.110 | 3.9990 | 60.425 | 0.082 | 13.36 | 15.06 | 0.001 |
| 790 | May 8, 2012 | 12:03:54 PM | 15.06 | 3.999 | 0.8761 | 3.765 | 60.225 | 0.082 | 13.40 | 15.110 | 3.9990 | 60.425 | 0.082 | 13.44 | 15.06 | 0.003 |
| 795 | May 8, 2012 | 12:03:59 PM | 15.05 | 3.999 | 0.8817 | 3.763 | 60.185 | 0.082 | 13.48 | 15.100 | 3.9990 | 60.385 | 0.082 | 13.53 | 15.06 | −0.005 |
| 800 | May 8, 2012 | 12:04:04 PM | 15.05 | 3.999 | 0.8872 | 3.763 | 60.185 | 0.082 | 13.57 | 15.100 | 3.9990 | 60.385 | 0.082 | 13.61 | 15.06 | 0.003 |
| 805 | May 8, 2012 | 12:04:09 PM | 15.05 | 3.999 | 0.8928 | 3.763 | 60.185 | 0.082 | 13.65 | 15.100 | 3.9990 | 60.385 | 0.082 | 13.70 | 15.05 | −0.001 |
| 810 | May 8, 2012 | 12:04:14 PM | 15.05 | 3.999 | 0.8983 | 3.763 | 60.185 | 0.082 | 13.73 | 15.100 | 3.9990 | 60.385 | 0.082 | 13.78 | 15.05 | 0.001 |
| 815 | May 8, 2012 | 12:04:19 PM | 15.05 | 3.999 | 0.9038 | 3.763 | 60.185 | 0.082 | 13.82 | 15.100 | 3.9990 | 60.385 | 0.082 | 13.86 | 15.05 | 0.003 |
| 820 | May 8, 2012 | 12:04:24 PM | 15.05 | 3.999 | 0.9094 | 3.763 | 60.185 | 0.082 | 13.90 | 15.100 | 3.9990 | 60.385 | 0.082 | 13.95 | 15.04 | 0.005 |
| 825 | May 8, 2012 | 12:04:29 PM | 15.04 | 3.999 | 0.9149 | 3.760 | 60.145 | 0.082 | 13.99 | 15.090 | 3.9990 | 60.345 | 0.082 | 14.03 | 15.04 | −0.003 |
| 830 | May 8, 2012 | 12:04:34 PM | 15.04 | 3.999 | 0.9205 | 3.760 | 60.145 | 0.082 | 14.07 | 15.090 | 3.9990 | 60.345 | 0.082 | 14.11 | 15.04 | −0.001 |
| 835 | May 8, 2012 | 12:04:39 PM | 15.04 | 3.999 | 0.9260 | 3.760 | 60.145 | 0.082 | 14.15 | 15.090 | 3.9990 | 60.345 | 0.082 | 14.20 | 15.04 | 0.001 |
| 840 | May 8, 2012 | 12:04:44 PM | 15.04 | 3.999 | 0.9316 | 3.760 | 60.145 | 0.082 | 14.24 | 15.090 | 3.9990 | 60.345 | 0.082 | 14.28 | 15.04 | 0.003 |
| 845 | May 8, 2012 | 12:04:49 PM | 15.03 | 3.999 | 0.9371 | 3.758 | 60.105 | 0.082 | 14.32 | 15.080 | 3.9990 | 60.305 | 0.082 | 14.37 | 15.03 | −0.005 |
| 850 | May 8, 2012 | 12:04:54 PM | 15.03 | 3.999 | 0.9427 | 3.758 | 60.105 | 0.082 | 14.40 | 15.080 | 3.9990 | 60.305 | 0.082 | 14.4 | 15.03 | −0.002 |
| 855 | May 8, 2012 | 12:04:59 PM | 15.03 | 3.999 | 0.9482 | 3.758 | 60.105 | 0.082 | 14.49 | 15.080 | 3.9990 | 60.305 | 0.082 | 14.53 | 15.03 | 0.000 |
| 860 | May 8, 2012 | 12:05:04 PM | 15.03 | 3.999 | 0.9537 | 3.758 | 60.105 | 0.082 | 14.57 | 15.080 | 3.9990 | 60.305 | 0.082 | 14.62 | 15.03 | 0.002 |
| 865 | May 8, 2012 | 12:05:09 PM | 15.03 | 3.999 | 0.9593 | 3.758 | 60.105 | 0.082 | 14.65 | 15.080 | 3.9990 | 60.305 | 0.082 | 14.70 | 15.03 | 0.005 |
| 870 | May 8, 2012 | 12:05:14 PM | 15.02 | 3.999 | 0.9648 | 3.755 | 60.065 | 0.082 | 14.74 | 15.070 | 3.9990 | 60.265 | 0.082 | 14.78 | 15.02 | −0.003 |
| 875 | May 8, 2012 | 12:05:19 PM | 15.02 | 3.999 | 0.9704 | 3.755 | 60.065 | 0.082 | 14.82 | 15.070 | 3.9990 | 60.265 | 0.082 | 14.87 | 15.02 | −0.001 |
| 880 | May 8, 2012 | 12:05:24 PM | 15.02 | 3.999 | 0.9759 | 3.755 | 60.065 | 0.082 | 14.90 | 15.070 | 3.9990 | 60.265 | 0.082 | 14.95 | 15.02 | 0.001 |
| 885 | May 8, 2012 | 12:05:29 PM | 15.02 | 3.999 | 0.9815 | 3.755 | 60.065 | 0.082 | 14.99 | 15.070 | 3.9990 | 60.265 | 0.082 | 15.04 | 15.02 | 0.003 |
| 890 | May 8, 2012 | 12:05:34 PM | 15.01 | 3.999 | 0.9870 | 3.753 | 60.025 | 0.082 | 15.07 | 15.060 | 3.9990 | 60.225 | 0.082 | 15.12 | 15.01 | −0.005 |
| 895 | May 8, 2012 | 12:05:39 PM | 15.01 | 3.999 | 0.9925 | 3.753 | 60.025 | 0.082 | 15.15 | 15.060 | 3.9990 | 60.225 | 0.082 | 15.20 | 15.01 | −0.002 |
| 900 | May 8, 2012 | 12:05:44 PM | 15.01 | 3.999 | 0.9981 | 3.753 | 60.025 | 0.082 | 15.24 | 15.060 | 3.9990 | 60.225 | 0.082 | 15.29 | 15.01 | 0.000 |
| 905 | May 8, 2012 | 12:05:49 PM | 15.01 | 3.999 | 1.0036 | 3.753 | 60.025 | 0.082 | 15.32 | 15.060 | 3.9990 | 60.225 | 0.082 | 15.37 | 15.01 | 0.002 |
| 910 | May 8, 2012 | 12:05:54 PM | 15.01 | 3.999 | 1.0092 | 3.753 | 60.025 | 0.082 | 15.40 | 15.060 | 3.9990 | 60.225 | 0.082 | 15.45 | 15.01 | 0.004 |
| 915 | May 8, 2012 | 12:05:59 PM | 15.00 | 3.999 | 1.0147 | 3.750 | 59.985 | 0.082 | 15.49 | 15.050 | 3.9990 | 60.185 | 0.082 | 15.54 | 15.00 | −0.004 |
| 920 | May 8, 2012 | 12:06:04 PM | 15.00 | 3.999 | 1.0203 | 3.750 | 59.985 | 0.082 | 15.57 | 15.050 | 3.9990 | 60.185 | 0.082 | 15.62 | 15.00 | −0.002 |
| 925 | May 8, 2012 | 12:06:09 PM | 15.00 | 3.999 | 1.0258 | 3.750 | 59.985 | 0.082 | 15.65 | 15.050 | 3.9990 | 60.185 | 0.082 | 15.70 | 15.00 | 0.000 |
| 930 | May 8, 2012 | 12:06:14 PM | 15.00 | 3.999 | 1.0314 | 3.750 | 59.985 | 0.082 | 15.74 | 15.050 | 3.9990 | 60.185 | 0.082 | 15.79 | 15.00 | 0.002 |
| 935 | May 8, 2012 | 12:06:19 PM | 15.00 | 3.999 | 1.0369 | 3.750 | 59.985 | 0.082 | 15.82 | 15.050 | 3.9990 | 60.185 | 0.082 | 15.87 | 14.99 | −0.004 |
| 940 | May 8, 2012 | 12:06:24 PM | 14.99 | 3.999 | 1.0424 | 3.748 | 59.945 | 0.082 | 15.90 | 15.040 | 3.9990 | 60.145 | 0.082 | 15.96 | 14.99 | −0.004 |
| 945 | May 8, 2012 | 12:06:29 PM | 14.99 | 3.999 | 1.0480 | 3.748 | 59.945 | 0.082 | 15.99 | 15.040 | 3.9990 | 60.145 | 0.082 | 16.04 | 14.99 | 0.002 |
| 950 | May 8, 2012 | 12:06:34 PM | 14.99 | 3.999 | 1.0535 | 3.748 | 59.945 | 0.082 | 16.07 | 15.040 | 3.9990 | 60.145 | 0.082 | 16.12 | 14.99 | 0.000 |
| 955 | May 8, 2012 | 12:06:39 PM | 14.99 | 3.999 | 1.0591 | 3.748 | 59.945 | 0.082 | 16.15 | 15.040 | 3.9990 | 60.145 | 0.082 | 16.21 | 14.99 | 0.002 |
| 960 | May 8, 2012 | 12:06:44 PM | 14.99 | 3.999 | 1.0646 | 3.748 | 59.945 | 0.082 | 16.24 | 15.040 | 3.9990 | 60.145 | 0.082 | 16.29 | 14.99 | 0.004 |
| 965 | May 8, 2012 | 12:06:49 PM | 14.98 | 3.999 | 1.0700 | 3.745 | 59.945 | 0.082 | 16.32 | 15.030 | 3.9990 | 60.105 | 0.083 | 16.37 | 14.98 | −0.004 |
| 970 | May 8, 2012 | 12:06:54 PM | 14.98 | 3.999 | 1.0755 | 3.745 | 59.905 | 0.082 | 16.40 | 15.030 | 3.9990 | 60.105 | 0.083 | 16.46 | −14.98 | −0.002 |
| 975 | May 8, 2012 | 12:06:59 PM | 14.98 | 3.999 | 1.0811 | 3.745 | 59.905 | 0.082 | 16.49 | 15.030 | 3.9990 | 60.105 | 0.083 | 16.54 | 14.98 | 0.000 |
| 980 | May 8, 2012 | 12:07:04 PM | 14.98 | 3.999 | 1.0866 | 3.745 | 59.905 | 0.082 | 16.57 | 15.030 | 3.9990 | 60.105 | 0.083 | 16.62 | 14.98 | 0.002 |
| 985 | May 8, 2012 | 12:07:09 PM | 14.98 | 3.999 | 1.0922 | 3.745 | 59.905 | 0.082 | 16.65 | 15.030 | 3.9990 | 60.105 | 0.083 | 16.71 | 14.98 | 0.004 |
| 990 | May 8, 2012 | 12:07:14 PM | 14.97 | 3.999 | 1.0977 | 3.743 | 59.865 | 0.082 | 16.74 | 15.020 | 3.9990 | 60.105 | 0.083 | 16.79 | 14.97 | −0.004 |
| 995 | May 8, 2012 | 12:07:19 PM | 14.97 | 3.999 | 1.1032 | 3.743 | 59.865 | 0.082 | 16.82 | 15.020 | 3.9990 | 60.065 | 0.083 | 16.87 | 14.97 | −0.002 |
| 1000 | May 8, 2012 | 12:07:24 PM | 14.97 | 3.999 | 1.1088 | 3.743 | 59.865 | 0.082 | 16.90 | 15.020 | 3.9990 | 60.065 | 0.083 | 16.96 | 14.97 | 0.000 |
| 1005 | May 8, 2012 | 12:07:29 PM | 14.97 | 3.999 | 1.1144 | 3.743 | 59.865 | 0.082 | 16.99 | 15.020 | 3.9990 | 60.065 | 0.083 | 17.04 | 14.97 | 0.002 |
| 1010 | May 8, 2012 | 12:07:34 PM | 14.97 | 3.999 | 1.1199 | 3.743 | 59.825 | 0.082 | 17.07 | 15.020 | 3.9990 | 60.065 | 0.083 | 17.12 | 14.97 | 0.004 |
| 1015 | May 8, 2012 | 12:07:39 PM | 14.96 | 3.999 | 1.1254 | 3.740 | 59.825 | 0.082 | 17.15 | 15.010 | 3.9990 | 60.065 | 0.083 | 17.21 | 14.96 | −0.004 |
| 1020 | May 8, 2012 | 12:07:44 PM | 14.96 | 3.999 | 1.1310 | 3.740 | 59.825 | 0.082 | 17.23 | 15.010 | 3.9990 | 60.065 | 0.083 | 17.29 | 14.96 | −0.002 |
| 1025 | May 8, 2012 | 12:07:49 PM | 14.96 | 3.999 | 1.1365 | 3.740 | 59.825 | 0.082 | 17.32 | 15.010 | 3.9990 | 60.025 | 0.083 | 17.37 | 14.96 | 0.000 |
| 1030 | May 8, 2012 | 12:07:54 PM | 14.96 | 3.999 | 1.1420 | 3.740 | 59.825 | 0.082 | 17.40 | 15.010 | 3.9990 | 60.025 | 0.083 | 17.46 | 14.96 | 0.002 |
| 1035 | May 8, 2012 | 12:07:59 PM | 14.96 | 3.999 | 1.1476 | 3.740 | 59.825 | 0.082 | 17.48 | 15.010 | 3.9990 | 60.025 | 0.083 | 17.54 | 14.96 | 0.004 |
| 1040 | May 8, 2012 | 12:08:04 PM | 14.95 | 3.999 | 1.1532 | 3.738 | 59.785 | 0.082 | 17.57 | 15.000 | 3.9990 | 59.025 | 0.083 | 17.62 | 14.95 | 0.004 |
| 1045 | May 8, 2012 | 12:08:09 PM | 14.95 | 3.999 | 1.1587 | 3.738 | 59.785 | 0.082 | 17.65 | 15.000 | 3.9990 | 59.985 | 0.083 | 17.71 | 14.95 | −0.002 |
| 1050 | May 8, 2012 | 12:08:14 PM | 14.95 | 3.999 | 1.1642 | 3.738 | 59.785 | 0.082 | 17.73 | 15.000 | 3.9990 | 59.985 | 0.083 | 17.79 | 14.95 | −0.000 |
| 1055 | May 8, 2012 | 12:08:19 PM | 14.95 | 3.999 | 1.1698 | 3.738 | 59.785 | 0.082 | 17.82 | 15.000 | 3.9990 | 59.985 | 0.083 | 17.87 | 14.95 | 0.002 |
| 1060 | May 8, 2012 | 12:08:24 PM | 14.95 | 3.999 | 1.1753 | 3.738 | [symbol] | 0.083 | [symbol] | [symbol] | 3.9990 | 59.985 | 0.083 | 17.96 | 14.95 | 0.004 |
| 1065 | May 8, 2012 | 12:08:29 PM | 14.94 | 3.999 | 1.1809 | 3.735 | 59.745 | 0.083 | 17.98 | 14.990 | 3.9990 | 59.945 | 0.083 | 18.04 | 14.94 | −0.004 |
| 1070 | May 8, 2012 | 12:08:34 PM | 14.94 | 3.999 | 1.1864 | 3.735 | 59.745 | 0.083 | 18.06 | 14.990 | 3.9990 | 59.945 | 0.083 | 18.12 | 14.94 | −0.003 |
| 1075 | May 8, 2012 | 12:08:39 PM | 14.94 | 3.999 | 1.1920 | 3.735 | 59.745 | 0.083 | 18.15 | 14.990 | 3.9990 | 59.945 | 0.083 | 18.21 | 14.94 | −0.001 |
| 1080 | May 8, 2012 | 12:08:44 PM | 14.94 | 3.999 | 1.1975 | 3.735 | 59.745 | 0.083 | 18.23 | 14.990 | 3.9990 | 59.945 | 0.083 | 18.29 | 14.94 | 0.001 |
| 1085 | May 8, 2012 | 12:08:49 PM | 14.94 | 3.999 | 1.2030 | 3.735 | 59.745 | 0.083 | 18.31 | 14.990 | 3.9990 | 59.945 | 0.083 | 18.37 | 14.94 | 0.003 |
| 1090 | May 8, 2012 | 12:08:54 PM | 14.94 | 3.999 | 1.2086 | 3.735 | 59.745 | 0.083 | 18.40 | 14.990 | 3.9990 | 59.945 | 0.083 | 18.46 | 14.94 | 0.005 |
| 1095 | May 8, 2012 | 12:08:59 PM | 14.93 | 3.999 | 1.2141 | 3.733 | 59.705 | 0.083 | 18.48 | 14.980 | 3.9990 | 59.905 | 0.083 | 18.54 | 14.93 | −0.004 |
| 1100 | May 8, 2012 | 12:09:04 PM | 14.93 | 3.999 | 1.2197 | 3.733 | 59.705 | 0.083 | 18.56 | 14.980 | 3.9990 | 59.905 | 0.083 | 18.62 | 14.93 | −0.002 |
| 1105 | May 8, 2012 | 12:09:09 PM | 14.93 | 3.999 | 1.2252 | 3.733 | 59.705 | 0.083 | 18.65 | 14.980 | 3.9990 | 59.905 | 0.083 | 18.71 | 14.93 | 0.000 |
| 1110 | May 8, 2012 | 12:09:14 PM | 14.93 | 3.999 | 1.2308 | 3.733 | 59.705 | 0.083 | 18.73 | 14.980 | 3.9990 | 59.905 | 0.083 | 18.79 | 14.93 | 0.002 |
| 1115 | May 8, 2012 | 12:09:19 PM | 14.93 | 3.999 | 1.2363 | 3.733 | 59.705 | 0.083 | 18.81 | 14.980 | 3.9990 | 59.905 | 0.083 | 18.87 | 14.93 | 0.004 |
| 1120 | May 8, 2012 | 12:09:24 PM | 14.92 | 3.999 | 1.2418 | 3.730 | 59.665 | 0.083 | 18.89 | 14.970 | 3.9990 | 59.865 | 0.083 | 18.96 | 14.92 | −0.004 |
| 1125 | May 8, 2012 | 12:09:29 PM | 14.92 | 3.999 | 1.2474 | 3.730 | 59.665 | 0.083 | 18.98 | 14.970 | 3.9990 | 59.865 | 0.083 | 19.04 | 14.92 | −0.002 |
| 1130 | May 8, 2012 | 12:09:34 PM | 14.92 | 3.999 | 1.2529 | 3.730 | 59.665 | 0.083 | 19.06 | 14.970 | 3.9990 | 59.865 | 0.083 | 19.12 | 14.92 | 0.000 |
| 1135 | May 8, 2012 | 12:09:39 PM | 14.92 | 3.999 | 1.2585 | 3.730 | 59.665 | 0.083 | 19.14 | 14.970 | 3.9990 | 59.865 | 0.083 | 19.21 | 14.92 | 0.002 |
| 1140 | May 8, 2012 | 12:09:44 PM | 14.92 | 3.999 | 1.2640 | 3.730 | 59.665 | 0.083 | 19.23 | 14.970 | 3.9990 | 59.865 | 0.083 | 19.29 | 14.92 | 0.004 |
| 1145 | May 8, 2012 | 12:09:49 PM | 14.91 | 3.999 | 1.2696 | 3.728 | 59.625 | 0.083 | 19.31 | 14.960 | 3.9990 | 59.825 | 0.083 | 19.37 | 14.91 | −0.004 |
| 1150 | May 8, 2012 | 12:09:54 PM | 14.91 | 3.999 | 1.2751 | 3.728 | 59.625 | 0.083 | 19.39 | 14.960 | 3.9990 | 59.825 | 0.083 | 19.46 | 14.91 | −0.002 |
| 1155 | May 8, 2012 | 12:09:59 PM | 14.91 | 3.999 | 1.2806 | 3.728 | 59.625 | 0.083 | 19.47 | 14.960 | 3.9990 | 59.825 | 0.083 | 19.54 | 14.91 | 0.000 |
| 1160 | May 8, 2012 | 12:10:04 PM | 14.91 | 3.999 | 1.2862 | 3.728 | 59.625 | 0.083 | 19.56 | 14.960 | 3.9990 | 59.825 | 0.083 | 19.62 | 14.91 | 0.002 |
| 1165 | May 8, 2012 | 12:10:09 PM | 14.91 | 3.999 | 1.2917 | 3.728 | 59.625 | 0.083 | 19.64 | 14.960 | 3.9990 | 59.825 | 0.083 | 19.70 | 14.91 | 0.004 |
| 1170 | May 8, 2012 | 12:10:14 PM | 14.90 | 3.999 | 1.2973 | 3.725 | 59.585 | 0.083 | 19.72 | 14.950 | 3.9990 | 59.785 | 0.083 | 19.79 | 14.90 | −0.004 |
| 1175 | May 8, 2012 | 12:10:19 PM | 14.90 | 3.999 | 1.3028 | 3.725 | 59.585 | 0.083 | 19.81 | 14.950 | 3.9990 | 59.785 | 0.083 | 19.87 | 14.90 | −0.002 |
| 1180 | May 8, 2012 | 12:10:24 PM | 14.90 | 3.999 | 1.3084 | 3.725 | 59.585 | 0.083 | 19.89 | 14.950 | 3.9990 | 59.785 | 0.083 | 19.95 | 14.90 | 0.000 |
| 1185 | May 8, 2012 | 12:10:29 PM | 14.90 | 3.999 | 1.3139 | 3.725 | 59.585 | 0.083 | 19.97 | 14.950 | 3.9990 | 59.785 | 0.083 | 20.04 | 14.90 | 0.002 |
| 1190 | May 8, 2012 | 12:10:34 PM | 14.90 | 3.999 | 1.3194 | 3.725 | 59.585 | 0.083 | 20.05 | 14.950 | 3.9990 | 59.785 | 0.083 | 20.12 | 14.90 | 0.004 |
| 1195 | May 8, 2012 | 12:10:39 PM | 14.89 | 3.999 | 1.3250 | 3.723 | 59.545 | 0.083 | 20.14 | 14.940 | 3.9990 | 59.745 | 0.083 | 20.20 | 14.89 | −0.005 |
| 1200 | May 8, 2012 | 12:10:44 PM | 14.89 | 3.999 | 1.3305 | 3.723 | 59.545 | 0.083 | 20.22 | 14.940 | 3.9990 | 59.745 | 0.083 | 20.29 | 14.89 | −0.003 |
| 1205 | May 8, 2012 | 12:10:49 PM | 14.89 | 3.999 | 1.3361 | 3.723 | 59.545 | 0.083 | 20.30 | 14.940 | 3.9990 | 59.745 | 0.083 | 20.37 | 14.89 | −0.001 |
| 1210 | May 8, 2012 | 12:10:54 PM | 14.89 | 3.999 | 1.3416 | 3.723 | 59.545 | 0.083 | 20.38 | 14.940 | 3.9990 | 59.745 | 0.083 | 20.45 | 14.89 | 0.001 |
| 1215 | May 8, 2012 | 12:10:59 PM | 14.89 | 3.999 | 1.3472 | 3.723 | 59.545 | 0.083 | 20.47 | 14.940 | 3.9990 | 59.745 | 0.083 | 20.52 | 14.89 | 0.003 |
| 1220 | May 8, 2012 | 12:11:04 PM | 14.89 | 3.999 | 1.3527 | 3.723 | 59.545 | 0.083 | 20.55 | 14.940 | 3.9990 | 59.745 | 0.083 | 20.62 | 14.89 | 0.005 |
| 1225 | May 8, 2012 | 12:11:09 PM | 14.88 | 3.999 | 1.3582 | 3.720 | 59.505 | 0.083 | 20.63 | 14.930 | 3.9990 | 59.705 | 0.083 | 20.70 | 14.88 | −0.004 |
| 1230 | May 8, 2012 | 12:11:14 PM | 14.88 | 3.999 | 1.3638 | 3.720 | 59.505 | 0.083 | 20.72 | 14.930 | 3.9990 | 59.705 | 0.083 | 20.78 | 14.88 | −0.002 |
| 1235 | May 8, 2012 | 12:11:19 PM | 14.88 | 3.999 | 1.3693 | 3.720 | 59.505 | 0.083 | 20.80 | 14.930 | 3.9990 | 59.705 | 0.083 | 20.87 | 14.88 | 0.000 |
| 1240 | May 8, 2012 | 12:11:24 PM | 14.88 | 3.999 | 1.3749 | 3.720 | 59.505 | 0.083 | 20.88 | 14.930 | 3.9990 | 59.705 | 0.083 | 20.95 | 14.88 | 0.002 |
| 1245 | May 8, 2012 | 12:11:29 PM | 14.88 | 3.999 | 1.3804 | 3.720 | 59.505 | 0.083 | 20.96 | 14.930 | 3.9990 | 59.705 | 0.083 | 21.03 | 14.88 | 0.004 |
| 1250 | May 8, 2012 | 12:11:34 PM | 14.88 | 3.999 | 1.3860 | 3.718 | 59.465 | 0.083 | 21.05 | 14.920 | 3.9990 | 59.665 | 0.083 | 21.11 | 14.87 | −0.004 |
| 1255 | May 8, 2012 | 12:11:39 PM | 14.88 | 3.999 | 1.3915 | 3.718 | 59.465 | 0.083 | 21.13 | 14.920 | 3.9990 | 59.665 | 0.083 | 21.20 | 14.87 | −0.002 |
| 1260 | May 8, 2012 | 12:11:44 PM | 14.87 | 3.999 | 1.3971 | 3.718 | 59.465 | 0.083 | 21.21 | 14.920 | 3.9990 | 59.665 | 0.083 | 21.28 | 14.87 | 0.000 |
| 1265 | May 8, 2012 | 12:11:49 PM | 14.87 | 3.999 | 1.4026 | 3.718 | 59.465 | 0.083 | 21.29 | 14.920 | 3.9990 | 59.665 | 0.083 | 21.36 | 14.87 | 0.002 |
| 1270 | May 8, 2012 | 12:11:54 PM | 14.87 | 3.999 | 1.4081 | 3.718 | 59.465 | 0.083 | 21.38 | 14.920 | 3.9990 | 59.665 | 0.083 | 21.45 | 14.87 | 0.004 |
| 1275 | May 8, 2012 | 12:11:59 PM | 14.86 | 3.999 | 1.4137 | 3.715 | 59.425 | 0.083 | 21.46 | 14.910 | 3.9990 | 59.625 | 0.083 | 21.53 | 14.86 | −0.005 |
| 1280 | May 8, 2012 | 12:12:04 PM | 14.86 | 3.999 | 1.4192 | 3.715 | 59.425 | 0.083 | 21.54 | 14.910 | 3.9990 | 59.625 | 0.083 | 21.61 | 14.86 | −0.003 |
| 1285 | May 8, 2012 | 12:12:09 PM | 14.86 | 3.999 | 1.4248 | 3.715 | 59.425 | 0.083 | 21.62 | 14.910 | 3.9990 | 59.625 | 0.083 | 21.69 | 14.86 | −0.001 |
| 1290 | May 8, 2012 | 12:12:14 PM | 14.86 | 3.999 | 1.4303 | 3.715 | 59.425 | 0.083 | 21.71 | 14.910 | 3.9990 | 59.625 | 0.083 | 21.78 | 14.86 | 0.001 |
| 1295 | May 8, 2012 | 12:12:19 PM | 14.86 | 3.999 | 1.4359 | 3.715 | 59.425 | 0.083 | 21.79 | 14.910 | 3.9990 | 59.625 | 0.083 | 21.86 | 14.86 | 0.003 |
| 1300 | May 8, 2012 | 12:12:24 PM | 14.86 | 3.999 | 1.4414 | 3.715 | 59.425 | 0.083 | 21.87 | 14.910 | 3.9990 | 59.625 | 0.083 | 21.94 | 14.86 | 0.005 |
| 1305 | May 8, 2012 | 12:12:29 PM | 14.85 | 3.999 | 1.4469 | 3.713 | 59.385 | 0.082 | 21.95 | 14.900 | 3.9990 | 59.585 | 0.083 | 22.03 | 14.85 | −0.004 |
| 1310 | May 8, 2012 | 12:12:34 PM | 14.85 | 3.999 | 1.4525 | 3.713 | 59.385 | 0.082 | 22.04 | 14.900 | 3.9990 | 59.585 | 0.083 | 22.11 | 14.85 | −0.002 |
| 1315 | May 8, 2012 | 12:12:39 PM | 14.85 | 3.999 | 1.4580 | 3.713 | 59.385 | 0.082 | 22.12 | 14.900 | 3.9990 | 59.585 | 0.083 | 22.19 | 14.85 | 0.000 |
| 1320 | May 8, 2012 | 12:12:44 PM | 14.85 | 3.999 | 1.4636 | 3.713 | 59.385 | 0.082 | 22.20 | 14.900 | 3.9990 | 59.585 | 0.083 | 22.27 | 14.85 | 0.002 |
| 1325 | May 8, 2012 | 12:12:49 PM | 14.85 | 3.999 | 1.4691 | 3.713 | 59.385 | 0.082 | 22.28 | 14.900 | 3.9990 | 59.585 | 0.083 | 22.36 | 14.85 | 0.004 |
| 1330 | May 8, 2012 | 12:12:54 PM | 14.84 | 3.999 | 1.4747 | 3.710 | 59.345 | 0.082 | 22.37 | 14.890 | 3.9990 | 59.545 | 0.083 | 22.44 | 14.84 | −0.005 |
| 1335 | May 8, 2012 | 12:12:59 PM | 14.84 | 3.999 | 1.4802 | 3.710 | 59.345 | 0.082 | 22.45 | 14.890 | 3.9990 | 59.545 | 0.083 | 22.52 | 14.84 | −0.003 |
| 1340 | May 8, 2012 | 12:13:04 PM | 14.84 | 3.999 | 1.4857 | 3.710 | 59.345 | 0.082 | 22.53 | 14.890 | 3.9990 | 59.545 | 0.083 | 22.61 | 14.84 | −0.001 |
| 1345 | May 8, 2012 | 12:13:10 PM | 14.84 | 3.999 | 1.4913 | 3.710 | 59.345 | 0.082 | 22.61 | 14.890 | 3.9990 | 59.545 | 0.083 | 22.69 | 14.84 | 0.001 |
| 1350 | May 8, 2012 | 12:13:15 PM | 14.84 | 3.999 | 1.4968 | 3.710 | 59.345 | 0.082 | 22.70 | 14.890 | 3.9990 | 59.545 | 0.083 | 22.77 | 14.84 | 0.003 |
| 1355 | May 8, 2012 | 12:13:20 PM | 14.84 | 3.999 | 1.5024 | 3.710 | 59.345 | 0.082 | 22.78 | 14.890 | 3.9990 | 59.545 | 0.083 | 22.85 | 14.84 | 0.005 |
| 1360 | May 8, 2012 | 12:13:25 PM | 14.83 | 3.999 | 1.5079 | 3.708 | 59.305 | 0.082 | 22.86 | 14.880 | 3.9990 | 59.505 | 0.083 | 22.94 | 14.84 | 0.005 |
| 1365 | May 8, 2012 | 12:13:30 PM | 14.83 | 3.999 | 1.5135 | 3.708 | 59.305 | 0.082 | 22.94 | 14.880 | 3.9990 | 59.505 | 0.083 | 23.02 | 14.83 | −0.003 |
| 1370 | May 8, 2012 | 12:13:35 PM | 14.83 | 3.999 | 1.5190 | 3.708 | 59.305 | 0.082 | 23.03 | 14.800 | 3.9990 | 59.505 | 0.083 | 23.10 | 14.83 | −0.001 |
| 1375 | May 8, 2012 | 12:13:40 PM | 14.83 | 3.999 | 1.5245 | 3.708 | 59.305 | 0.082 | 23.11 | 14.880 | 3.9990 | 59.505 | 0.083 | 23.18 | 14.83 | −0.001 |
| 1380 | May 8, 2012 | 12:13:45 PM | 14.83 | 3.999 | 1.5301 | 3.708 | 59.305 | 0.082 | 23.19 | 14.880 | 3.9990 | 59.505 | 0.083 | 23.27 | 14.83 | 0.003 |
| 1385 | May 8, 2012 | 12:13:50 PM | 14.83 | 3.999 | 1.5357 | 3.708 | 59.305 | 0.082 | 23.27 | 14.880 | 3.9990 | 59.505 | 0.083 | 23.35 | 14.83 | 0.005 |
| 1390 | May 8, 2012 | 12:13:55 PM | 14.82 | 3.999 | 1.5412 | 3.705 | 59.265 | 0.082 | 23.35 | 14.870 | 3.9990 | 59.465 | 0.083 | 23.43 | 14.82 | −0.004 |
| 1395 | May 8, 2012 | 12:14:00 PM | 14.82 | 3.999 | 1.5467 | 3.705 | 59.265 | 0.082 | 23.44 | 14.870 | 3.9990 | 59.465 | 0.083 | 23.51 | 14.82 | −0.002 |
| 1400 | May 8, 2012 | 12:14:05 PM | 14.82 | 3.999 | 1.5523 | 3.705 | 59.265 | 0.082 | 23.52 | 14.870 | 3.9990 | 59.465 | 0.083 | 23.60 | 14.82 | 0.000 |
| 1405 | May 8, 2012 | 12:14:10 PM | 14.82 | 3.999 | 1.5578 | 3.705 | 59.265 | 0.082 | 23.60 | 14.870 | 3.9990 | 59.465 | 0.083 | 23.68 | 14.82 | 0.002 |
| 1410 | May 8, 2012 | 12:14:15 PM | 14.82 | 3.999 | 1.5634 | 3.705 | 59.265 | 0.082 | 23.68 | 14.870 | 3.9990 | 59.465 | 0.083 | 23.76 | 14.82 | 0.004 |
| 1415 | May 8, 2012 | 12:14:20 PM | 14.81 | 3.999 | 1.5689 | 3.703 | 59.225 | 0.082 | 23.77 | 14.860 | 3.9990 | 59.425 | 0.083 | 23.84 | 14.81 | −0.005 |
| 1420 | May 8, 2012 | 12:14:25 PM | 14.81 | 3.999 | 1.5745 | 3.703 | 59.225 | 0.082 | 23.85 | 14.860 | 3.9990 | 59.425 | 0.083 | 23.93 | 14.81 | −0.004 |
| 1425 | May 8, 2012 | 12:14:30 PM | 14.81 | 3.999 | 1.5800 | 3.703 | 59. [symbol] | 0.082 | [symbol] | 14.860 | 3.9990 | 59.425 | 0.082 | 24.01 | 14.81 | −0.002 |
| 1430 | May 8, 2012 | 12:14:35 PM | 14.81 | 3.999 | 1.5855 | 3.703 | 59.225 | 0.082 | 24.01 | 14.860 | 3.9990 | 59.425 | 0.082 | 24.09 | 14.81 | 0.000 |
| 1435 | May 8, 2012 | 12:14:40 PM | 14.81 | 3.999 | 1.5911 | 3.703 | 59.225 | 0.082 | 24.10 | 14.860 | 3.9990 | 59.425 | 0.082 | 24.17 | 14.81 | 0.002 |
| 1440 | May 8, 2012 | 12:14:45 PM | 14.81 | 3.999 | 1.5966 | 3.703 | 59.225 | 0.082 | 24.18 | 14.860 | 3.9990 | 59.425 | 0.082 | 24.26 | 14.81 | 0.004 |
| 1445 | May 8, 2012 | 12:14:50 PM | 14.81 | 3.999 | 1.6021 | 3.703 | 59.225 | 0.082 | 24.26 | 14.850 | 3.9990 | 59.425 | 0.082 | 24.34 | 14.81 | 0.005 |
| 1450 | May 8, 2012 | 12:14:55 PM | 14.80 | 3.999 | 1.6077 | 3.700 | 59.185 | 0.082 | 24.34 | 14.850 | 3.9990 | 59.385 | 0.082 | 24.42 | 14.80 | −0.004 |
| 1455 | May 8, 2012 | 12:15:00 PM | 14.80 | 3.999 | 1.6133 | 3.700 | 59.185 | 0.082 | 24.42 | 14.850 | 3.9990 | 59.385 | 0.082 | 24.50 | 14.80 | −0.002 |
| 1460 | May 8, 2012 | 12:15:05 PM | 14.80 | 3.999 | 1.6188 | 3.700 | 59.185 | 0.082 | 24.51 | 14.850 | 3.9990 | 59.385 | 0.082 | 24.59 | 14.80 | 0.000 |
| 1465 | May 8, 2012 | 12:15:10 PM | 14.80 | 3.999 | 1.6243 | 3.700 | 59.185 | 0.082 | 24.59 | 14.850 | 3.9990 | 59.385 | 0.082 | 24.67 | 14.80 | 0.002 |
| 1470 | May 8, 2012 | 12:15:15 PM | 14.80 | 3.999 | 1.6299 | 3.700 | 59.185 | 0.082 | 24.67 | 14.850 | 3.9990 | 59.385 | 0.082 | 24.75 | 14.80 | 0.004 |
| 1475 | May 8, 2012 | 12:15:20 PM | 14.79 | 3.999 | 1.6354 | 3.698 | 59.145 | 0.082 | 24.75 | 14.840 | 3.9990 | 59.385 | 0.082 | 24.83 | 14.79 | −0.005 |
| 1480 | May 8, 2012 | 12:15:25 PM | 14.79 | 3.999 | 1.6410 | 3.698 | 59.145 | 0.082 | 24.83 | 14.840 | 3.9990 | 59.345 | 0.082 | 24.92 | 14.79 | −0.004 |
| 1485 | May 8, 2012 | 12:15:30 PM | 14.79 | 3.999 | 1.6465 | 3.698 | 59.145 | 0.082 | 24.92 | 14.840 | 3.9990 | 59.345 | 0.082 | 25.00 | 14.79 | −0.002 |
| 1490 | May 8, 2012 | 12:15:35 PM | 14.79 | 3.999 | 1.6521 | 3.698 | 59.145 | 0.082 | 25.00 | 14.840 | 3.9990 | 59.345 | 0.082 | 25.08 | 14.79 | 0.000 |
| 1495 | May 8, 2012 | 12:15:40 PM | 14.79 | 3.999 | 1.6576 | 3.698 | 59.145 | 0.082 | 25.08 | 14.840 | 3.9990 | 59.345 | 0.082 | 25.16 | 14.79 | 0.002 |
| 1500 | May 8, 2012 | 12:15:45 PM | 14.79 | 3.999 | 1.6631 | 3.698 | 59.145 | 0.082 | 25.16 | 14.840 | 3.9990 | 59.345 | 0.082 | 25.25 | 14.79 | 0.004 |
| 1505 | May 8, 2012 | 12:15:50 PM | 14.79 | 3.999 | 1.6687 | 3.698 | 59.145 | 0.082 | 25.25 | 14.840 | 3.9990 | 59.345 | 0.082 | 25.33 | 14.79 | 0.005 |
| 1510 | May 8, 2012 | 12:15:55 PM | 14.78 | 3.999 | 1.6742 | 3.695 | 59.105 | 0.082 | 25.33 | 14.830 | 3.9990 | 59.305 | 0.082 | 25.41 | 14.79 | 0.004 |
| 1515 | May 8, 2012 | 12:16:00 PM | 14.78 | 3.999 | 1.6798 | 3.695 | 59.105 | 0.082 | 25.41 | 14.830 | 3.9990 | 59.305 | 0.082 | 25.49 | 14.78 | −0.002 |
| 1520 | May 8, 2012 | 12:16:05 PM | 14.78 | 3.999 | 1.6853 | 3.695 | 59.105 | 0.082 | 25.49 | 14.830 | 3.9990 | 59.305 | 0.082 | 25.58 | 14.78 | −0.000 |
| 1525 | May 8, 2012 | 12:16:10 PM | 14.78 | 3.999 | 1.6909 | 3.695 | 59.105 | 0.082 | 25.57 | 14.830 | 3.9990 | 59.305 | 0.082 | 25.66 | 14.78 | 0.002 |
| 1530 | May 8, 2012 | 12:16:15 PM | 14.78 | 3.999 | 1.6964 | 3.695 | 59.105 | 0.082 | 25.66 | 14.830 | 3.9990 | 59.305 | 0.082 | 25.74 | 14.78 | 0.004 |
| 1535 | May 8, 2012 | 12:16:20 PM | 14.77 | 3.999 | 1.7019 | 3.693 | 59.065 | 0.082 | 25.74 | 14.820 | 3.9990 | 59.265 | 0.082 | 25.82 | 14.77 | −0.004 |
| 1540 | May 8, 2012 | 12:16:25 PM | 14.77 | 3.999 | 1.7075 | 3.693 | 59.065 | 0.082 | 25.82 | 14.820 | 3.9990 | 59.265 | 0.082 | 25.91 | 14.77 | −0.002 |
| 1545 | May 8, 2012 | 12:16:30 PM | 14.77 | 3.999 | 1.7132 | 3.693 | 59.065 | 0.082 | 25.90 | 14.820 | 3.9990 | 59.265 | 0.082 | 25.99 | 14.77 | 0.000 |
| 1550 | May 8, 2012 | 12:16:35 PM | 14.77 | 3.999 | 1.7187 | 3.693 | 59.065 | 0.082 | 25.98 | 14.820 | 3.9990 | 59.265 | 0.082 | 26.07 | 14.77 | 0.002 |
| 1555 | May 8, 2012 | 12:16:40 PM | 14.77 | 3.999 | 1.7243 | 3.693 | 59.065 | 0.082 | 26.07 | 14.820 | 3.9990 | 59.265 | 0.082 | 26.15 | 14.77 | 0.004 |
| 1560 | May 8, 2012 | 12:16:45 PM | 14.76 | 3.999 | 1.7298 | 3.690 | 59.025 | 0.082 | 26.15 | 14.810 | 3.9990 | 59.225 | 0.082 | 26.23 | 14.76 | −0.005 |
| 1565 | May 8, 2012 | 12:16:50 PM | 14.76 | 3.999 | 1.7354 | 3.690 | 59.025 | 0.082 | 26.23 | 14.810 | 3.9990 | 59.225 | 0.082 | 26.32 | 14.76 | −0.003 |
| 1570 | May 8, 2012 | 12:16:55 PM | 14.76 | 3.999 | 1.7409 | 3.690 | 59.025 | 0.082 | 26.31 | 14.810 | 3.9990 | 59.225 | 0.082 | 26.40 | 14.76 | −0.001 |
| 1575 | May 8, 2012 | 12:17:00 PM | 14.76 | 3.999 | 1.7465 | 3.690 | 59.025 | 0.082 | 26.39 | 14.810 | 3.9990 | 59.225 | 0.082 | 26.48 | 14.76 | 0.001 |
| 1580 | May 8, 2012 | 12:17:05 PM | 14.76 | 3.999 | 1.7520 | 3.690 | 59.025 | 0.082 | 26.48 | 14.810 | 3.9990 | 59.225 | 0.082 | 26.56 | 14.76 | 0.003 |
| 1585 | May 8, 2012 | 12:17:10 PM | 14.76 | 3.999 | 1.7575 | 3.690 | 59.025 | 0.082 | 26.56 | 14.810 | 3.9990 | 59.225 | 0.082 | 26.65 | 14.76 | 0.005 |
| 1590 | May 8, 2012 | 12:17:15 PM | 14.75 | 3.999 | 1.7631 | 3.688 | 59.985 | 0.082 | 26.64 | 14.800 | 3.9990 | 59.185 | 0.082 | 26.73 | 14.75 | −0.005 |
| 1595 | May 8, 2012 | 12:17:20 PM | 14.75 | 3.999 | 1.7686 | 3.688 | 59.985 | 0.082 | 26.72 | 14.800 | 3.9990 | 59.185 | 0.082 | 26.81 | 14.75 | −0.004 |
| 1600 | May 8, 2012 | 12:17:25 PM | 14.75 | 3.999 | 1.7742 | 3.688 | 59.985 | 0.082 | 26.80 | 14.800 | 3.9990 | 59.185 | 0.082 | 26.89 | 14.75 | −0.002 |
| 1605 | May 8, 2012 | 12:17:30 PM | 14.75 | 3.999 | 1.7797 | 3.688 | 59.985 | 0.082 | 26.89 | 14.800 | 3.9990 | 59.185 | 0.082 | 26.98 | 14.75 | 0.000 |
| 1610 | May 8, 2012 | 12:17:35 PM | 14.75 | 3.999 | 1.7853 | 3.688 | 59.985 | 0.082 | 26.97 | 14.800 | 3.9990 | 59.185 | 0.082 | 27.06 | 14.75 | 0.002 |
| 1615 | May 8, 2012 | 12:17:40 PM | 14.75 | 3.999 | 1.7908 | 3.688 | 58.985 | 0.082 | 27.05 | 14.800 | 3.9990 | 59.185 | 0.082 | 27.14 | 14.75 | 0.004 |
| 1620 | May 8, 2012 | 12:17:45 PM | 14.75 | 3.999 | 1.7964 | 3.688 | 58.985 | 0.082 | 27.13 | 14.800 | 3.9990 | 59.185 | 0.082 | 27.22 | 14.75 | 0.005 |
| 1625 | May 8, 2012 | 12:17:50 PM | 14.74 | 3.999 | 1.8019 | 3.685 | 58.945 | 0.082 | 27.21 | 14.790 | 3.9990 | 59.145 | 0.082 | 27.30 | 14.74 | −0.005 |
| 1630 | May 8, 2012 | 12:17:55 PM | 14.74 | 3.999 | 1.8075 | 3.685 | 58.945 | 0.082 | 27.30 | 14.790 | 3.9990 | 59.145 | 0.082 | 27.39 | 14.74 | −0.003 |
| 1635 | May 8, 2012 | 12:18:00 PM | 14.74 | 3.999 | 1.8130 | 3.685 | 58.945 | 0.082 | 27.38 | 14.790 | 3.9990 | 59.145 | 0.082 | 27.47 | 14.74 | −0.001 |
| 1640 | May 8, 2012 | 12:18:05 PM | 14.74 | 3.999 | 1.8185 | 3.685 | 58.945 | 0.082 | 27.46 | 14.790 | 3.9990 | 59.145 | 0.082 | 27.55 | 14.74 | 0.001 |
| 1645 | May 8, 2012 | 12:18:10 PM | 14.74 | 3.999 | 1.8241 | 3.685 | 58.945 | 0.082 | 27.54 | 14.790 | 3.9990 | 59.145 | 0.082 | 27.63 | 14.74 | 0.003 |
| 1650 | May 8, 2012 | 12:18:15 PM | 14.74 | 3.999 | 1.8296 | 3.685 | 58.945 | 0.082 | 27.62 | 14.790 | 3.9990 | 59.145 | 0.082 | 27.71 | 14.74 | 0.005 |
| 1655 | May 8, 2012 | 12:18:20 PM | 14.73 | 3.999 | 1.8352 | 3.683 | 58.905 | 0.082 | 27.70 | 14.780 | 3.9990 | 59.105 | 0.082 | 27.80 | 14.73 | −0.005 |
| 1660 | May 8, 2012 | 12:18:25 PM | 14.73 | 3.999 | 1.8407 | 3.683 | 58.905 | 0.082 | 27.79 | 14.780 | 3.9990 | 59.105 | 0.082 | 27.88 | 14.73 | −0.003 |
| 1665 | May 8, 2012 | 12:18:30 PM | 14.73 | 3.999 | 1.8463 | 3.683 | 58.905 | 0.082 | 27.87 | 14.780 | 3.9990 | 59.105 | 0.082 | 27.96 | 14.73 | −0.001 |
| 1670 | May 8, 2012 | 12:18:35 PM | 14.73 | 3.999 | 1.8518 | 3.683 | 58.905 | 0.082 | 27.95 | 14.780 | 3.9990 | 59.105 | 0.082 | 28.04 | 14.73 | 0.001 |
| 1675 | May 8, 2012 | 12:18:40 PM | 14.73 | 3.999 | 1.8574 | 3.683 | 58.905 | 0.082 | 28.03 | 14.780 | 3.9990 | 59.105 | 0.082 | 28.12 | 14.73 | 0.003 |
| 1680 | May 8, 2012 | 12:18:45 PM | 14.73 | 3.999 | 1.8629 | 3.683 | 58.905 | 0.082 | 28.11 | 14.780 | 3.9990 | 59.105 | 0.082 | 28.21 | 14.73 | 0.005 |
| 1685 | May 8, 2012 | 12:18:50 PM | 14.72 | 3.999 | 1.8685 | 3.680 | 58.865 | 0.082 | 28.20 | 14.770 | 3.9990 | 59.065 | 0.082 | 28.29 | 14.72 | −0.005 |
| 1690 | May 8, 2012 | 12:18:55 PM | 14.72 | 3.999 | 1.8740 | 3.680 | 58.865 | 0.082 | 28.28 | 14.770 | 3.9990 | 59.065 | 0.082 | 28.37 | 14.72 | −0.003 |
| 1695 | May 8, 2012 | 12:19:00 PM | 14.72 | 3.999 | 1.8795 | 3.680 | 58.865 | 0.082 | 28.36 | 14.770 | 3.9990 | 59.065 | 0.082 | 28.45 | 14.72 | −0.001 |
| 1700 | May 8, 2012 | 12:19:05 PM | 14.72 | 3.999 | 1.8849 | 3.680 | 58.865 | 0.082 | 28.44 | 14.770 | 3.9990 | 59.065 | 0.082 | 28.54 | 14.72 | 0.001 |
| 1705 | May 8, 2012 | 12:19:10 PM | 14.72 | 3.999 | 1.8905 | 3.680 | 58.865 | 0.082 | 28.52 | 14.770 | 3.9990 | 59.065 | 0.082 | 28.62 | 14.72 | 0.003 |
| 1710 | May 8, 2012 | 12:19:15 PM | 14.72 | 3.999 | 1.8962 | 3.680 | 58.865 | 0.082 | 28.60 | 14.770 | 3.9990 | 59.065 | 0.082 | 28.70 | 14.72 | 0.005 |
| 1715 | May 8, 2012 | 12:19:20 PM | 14.71 | 3.999 | 1.9017 | 3.678 | 58.825 | 0.082 | 28.69 | 14.760 | 3.9990 | 59.025 | 0.082 | 28.78 | 14.71 | −0.005 |
| 1720 | May 8, 2012 | 12:19:25 PM | 14.71 | 3.999 | 1.9073 | 3.678 | 58.825 | 0.082 | 28.77 | 14.760 | 3.9990 | 59.025 | 0.082 | 28.86 | 14.71 | −0.004 |
| 1725 | May 8, 2012 | 12:19:30 PM | 14.71 | 3.999 | 1.9128 | 3.678 | 58.825 | 0.082 | 28.85 | 14.760 | 3.9990 | 59.025 | 0.082 | 28.95 | 14.71 | −0.002 |
| 1730 | May 8, 2012 | 12:19:35 PM | 14.71 | 3.999 | 1.9184 | 3.678 | 58.825 | 0.082 | 28.93 | 14.760 | 3.9990 | 59.025 | 0.082 | 29.03 | 14.71 | 0.000 |
| 1735 | May 8, 2012 | 12:19:40 PM | 14.71 | 3.999 | 1.9239 | 3.678 | 58.825 | 0.082 | 29.01 | 14.760 | 3.9990 | 59.025 | 0.082 | 29.11 | 14.71 | 0.002 |
| 1740 | May 8, 2012 | 12:19:45 PM | 14.71 | 3.999 | 1.9294 | 3.678 | 58.825 | 0.082 | 29.09 | 14.760 | 3.9990 | 59.025 | 0.082 | 29.19 | 14.71 | 0.004 |
| 1745 | May 8, 2012 | 12:19:50 PM | 14.71 | 3.999 | 1.9350 | 3.678 | 58.825 | 0.082 | 29.18 | 14.760 | 3.9990 | 59.025 | 0.082 | 29.27 | 14.71 | 0.005 |
| 1750 | May 8, 2012 | 12:19:55 PM | 14.70 | 3.999 | 1.9405 | 3.675 | 58.785 | 0.082 | 29.26 | 14.750 | 3.9990 | 58.985 | 0.082 | 29.36 | 14.70 | −0.005 |
| 1755 | May 8, 2012 | 12:20:00 PM | 14.70 | 3.999 | 1.9461 | 3.675 | 58.785 | 0.082 | 29.34 | 14.750 | 3.9990 | 58.985 | 0.082 | 29.44 | 14.70 | −0.003 |
| 1760 | May 8, 2012 | 12:20:05 PM | 14.70 | 3.999 | 1.9517 | 3.675 | 58.785 | 0.082 | 29.42 | 14.750 | 3.9990 | 58.985 | 0.082 | 29.52 | 14.70 | −0.001 |
| 1765 | May 8, 2012 | 12:20:10 PM | 14.70 | 3.999 | 1.9572 | 3.675 | 58.785 | 0.082 | 29.50 | 14.750 | 3.9990 | 58.985 | 0.082 | 29.60 | 14.70 | 0.001 |
| 1770 | May 8, 2012 | 12:20:15 PM | 14.70 | 3.999 | 1.9627 | 3.675 | 58.785 | 0.082 | 29.58 | 14.750 | 3.9990 | 58.985 | 0.082 | 29.68 | 14.70 | 0.003 |
| 1775 | May 8, 2012 | 12:20:20 PM | 14.70 | 3.999 | 1.9683 | 3.675 | 58.785 | 0.082 | 29.67 | 14.750 | 3.9990 | 58.985 | 0.082 | 29.76 | 14.70 | 0.005 |
| 1780 | May 8, 2012 | 12:20:25 PM | 14.69 | 3.999 | 1.9738 | 3.673 | 58.745 | 0.082 | 29.75 | 14.740 | 3.9990 | 58.945 | 0.082 | 29.85 | 14.69 | −0.005 |
| 1785 | May 8, 2012 | 12:20:30 PM | 14.69 | 3.999 | 1.9794 | 3.673 | 58.745 | 0.082 | 29.83 | 14.740 | 3.9990 | 58.945 | 0.082 | 29.93 | 14.69 | −0.003 |
| 1790 | May 4, 2012 | 12:20:35 PM | 14.69 | 3.999 | 1.9849 | 3.673 | 58.745 | 0.082 | 29.97 | 14.740 | 3.9990 | 58.945 | 0.082 | 30.01 | 14.69 | −0.001 |
| 1795 | May 4, 2012 | 12:20:40 PM | 14.69 | 3.999 | 1.9905 | 3.673 | 58.745 | 0.082 | 29.99 | 14.740 | 3.9990 | 58.945 | 0.082 | 30.09 | 14.69 | 0.001 |
| 1800 | May 4, 2012 | 12:20:45 PM | 14.69 | 3.999 | 1.9960 | 3.673 | 58.745 | 0.082 | 30.07 | 14.740 | 3.9990 | 58.945 | 0.082 | 30.17 | 14.69 | 0.003 |
| 1805 | May 4, 2012 | 12:20:50 PM | 14.69 | 3.999 | 2.0016 | 3.673 | 58.745 | 0.082 | 30.16 | 14.740 | 3.9990 | 58.945 | 0.082 | 30.26 | 14.69 | 0.005 |
| 1810 | May 4, 2012 | 12:20:55 PM | 14.68 | 3.999 | 2.0071 | 3.670 | 58.705 | 0.082 | 30.24 | 14.730 | 3.9990 | 58.905 | 0.082 | 30.34 | 14.68 | −0.005 |
| 1815 | May 4, 2012 | 12:21:00 PM | 14.68 | 3.999 | 2.0126 | 3.670 | 58.705 | 0.082 | 30.32 | 14.730 | 3.9990 | 58.905 | 0.082 | 30.42 | 14.68 | −0.004 |
| 1820 | May 4, 2012 | 12:21:05 PM | 14.68 | 3.999 | 2.0182 | 3.670 | 58.705 | 0.082 | 30.40 | 14.730 | 3.9990 | 58.905 | 0.082 | 30.50 | 14.68 | −0.002 |
| 1825 | May 4, 2012 | 12:21:10 PM | 14.68 | 3.999 | 2.0237 | 3.670 | 58.705 | 0.082 | 30.48 | 14.730 | 3.9990 | 58.905 | 0.082 | 30.58 | 14.68 | −0.000 |
| 1830 | May 4, 2012 | 12:21:15 PM | 14.68 | 3.999 | 2.0293 | 3.670 | 58.705 | 0.082 | 30.56 | 14.730 | 3.9990 | 58.905 | 0.082 | 30.66 | 14.68 | 0.002 |
| 1835 | May 4, 2012 | 12:21:20 PM | 14.68 | 3.999 | 2.0348 | 3.670 | 58.705 | 0.082 | 30.64 | 14.730 | 3.9990 | 58.905 | 0.082 | 30.75 | 14.68 | 0.004 |
| 1840 | May 4, 2012 | 12:21:25 PM | 14.68 | 3.999 | 2.0404 | 3.670 | 58.705 | 0.082 | 30.73 | 14.730 | 3.9990 | 58.905 | 0.082 | 30.83 | 14.68 | 0.005 |
| 1845 | May 4, 2012 | 12:21:30 PM | 14.67 | 3.999 | 2.0459 | 3.668 | 58.665 | 0.081 | 30.81 | 14.720 | 3.9990 | 58.865 | 0.082 | 30.91 | 14.67 | −0.005 |
| 1850 | May 4, 2012 | 12:21:35 PM | 14.67 | 3.999 | 2.0515 | 3.668 | 58.665 | 0.081 | 30.89 | 14.720 | 3.9990 | 58.865 | 0.082 | 30.99 | 14.67 | −0.004 |
| 1855 | May 4, 2012 | 12:21:40 PM | 14.67 | 3.999 | 2.0570 | 3.668 | 58.665 | 0.081 | 30.97 | 14.720 | 3.9990 | 58.865 | 0.082 | 31.07 | 14.67 | −0.002 |
| 1860 | May 4, 2012 | 12:21:45 PM | 14.67 | 3.999 | 2.0626 | 3.668 | 58.665 | 0.081 | 31.05 | 14.720 | 3.9990 | 58.865 | 0.082 | 31.16 | 14.67 | 0.000 |
| 1865 | May 4, 2012 | 12:21:50 PM | 14.67 | 3.999 | 2.0681 | 3.668 | 58.665 | 0.081 | 31.13 | 14.720 | 3.9990 | 58.865 | 0.082 | 31.24 | 14.67 | 0.002 |
| 1870 | May 4, 2012 | 12:21:55 PM | 14.67 | 3.999 | 2.0736 | 3.668 | 58.665 | 0.081 | 31.22 | 14.720 | 3.9990 | 58.865 | 0.082 | 31.32 | 14.67 | 0.004 |
| 1875 | May 4, 2012 | 12:22:00 PM | 14.67 | 3.999 | 2.0792 | 3.668 | 58.665 | 0.081 | 31.30 | 14.720 | 3.9990 | 58.865 | 0.082 | 31.40 | 14.67 | 0.005 |
| 1880 | May 4, 2012 | 12:22:05 PM | 14.66 | 3.999 | 2.0847 | 3.665 | 58.625 | 0.081 | 31.38 | 14.710 | 3.9990 | 58.825 | 0.082 | 31.48 | 14.66 | −0.005 |
| 1885 | May 4, 2012 | 12:22:10 PM | 14.66 | 3.999 | 2.0903 | 3.665 | 58.625 | 0.081 | 31.46 | 14.710 | 3.9990 | 58.825 | 0.082 | 31.56 | 14.66 | −0.003 |
| 1890 | May 4, 2012 | 12:22:15 PM | 14.66 | 3.999 | 2.0958 | 3.665 | 58.625 | 0.081 | 31.54 | 14.710 | 3.9990 | 58.825 | 0.082 | 31.65 | 14.66 | −0.001 |
| 1895 | May 4, 2012 | 12:22:20 PM | 14.66 | 3.999 | 2.1014 | 3.665 | 58.625 | 0.081 | 31.62 | 14.710 | 3.9990 | 58.825 | 0.082 | 31.73 | 14.66 | 0.001 |
| 1900 | May 4, 2012 | 12:22:25 PM | 14.66 | 3.999 | 2.1069 | 3.665 | 58.625 | 0.081 | 31.70 | 14.710 | 3.9990 | 58.825 | 0.082 | 31.81 | 14.66 | 0.003 |
| 1905 | May 4, 2012 | 12:22:30 PM | 14.66 | 3.999 | 2.1125 | 3.665 | 58.625 | 0.081 | 31.79 | 14.710 | 3.9990 | 58.825 | 0.082 | 31.89 | 14.66 | 0.005 |
| 1910 | May 4, 2012 | 12:22:35 PM | 14.65 | 3.999 | 2.1180 | 3.663 | 58.585 | 0.081 | 31.87 | 14.700 | 3.9990 | 58.785 | 0.082 | 31.97 | 14.65 | −0.005 |
| 1915 | May 4, 2012 | 12:22:40 PM | 14.65 | 3.999 | 2.1236 | 3.663 | 58.585 | 0.081 | 31.95 | 14.700 | 3.9990 | 58.785 | 0.082 | 32.05 | 14.65 | −0.004 |
| 1920 | May 4, 2012 | 12:22:45 PM | 14.65 | 3.999 | 2.1291 | 3.663 | 58.585 | 0.081 | 32.03 | 14.700 | 3.9990 | 58.785 | 0.082 | 32.14 | 14.65 | −0.002 |
| 1925 | May 4, 2012 | 12:22:50 PM | 14.65 | 3.999 | 2.1347 | 3.663 | 58.585 | 0.081 | 32.11 | 14.700 | 3.9990 | 58.785 | 0.082 | 32.22 | 14.65 | 0.000 |
| 1930 | May 4, 2012 | 12:22:55 PM | 14.65 | 3.999 | 2.1402 | 3.663 | 58.585 | 0.081 | 32.19 | 14.700 | 3.9990 | 58.785 | 0.082 | 32.30 | 14.65 | 0.002 |
| 1935 | May 4, 2012 | 12:23:00 PM | 14.65 | 3.999 | 2.1457 | 3.663 | 58.585 | 0.081 | 32.27 | 14.700 | 3.9990 | 58.785 | 0.082 | 32.38 | 14.65 | 0.004 |
| 1940 | May 4, 2012 | 12:23:05 PM | 14.65 | 3.999 | 2.1513 | 3.663 | 58.585 | 0.081 | 32.35 | 14.700 | 3.9990 | 58.785 | 0.082 | 32.46 | 14.65 | 0.005 |
| 1945 | May 4, 2012 | 12:23:10 PM | 14.64 | 3.999 | 2.1568 | 3.660 | 58.545 | 0.081 | 32.44 | 14.690 | 3.9990 | 58.745 | 0.082 | 32.54 | 14.64 | −0.005 |
| 1950 | May 4, 2012 | 12:23:15 PM | 14.64 | 3.999 | 2.1624 | 3.660 | 58.545 | 0.081 | 32.52 | 14.690 | 3.9990 | 58.745 | 0.082 | 32.63 | 14.64 | −0.004 |
| 1955 | May 4, 2012 | 12:23:20 PM | 14.64 | 3.999 | 2.1679 | 3.660 | 58.545 | 0.081 | 32.60 | 14.690 | 3.9990 | 58.745 | 0.082 | 32.71 | 14.64 | −0.002 |
| 1960 | May 4, 2012 | 12:23:25 PM | 14.64 | 3.999 | 2.1735 | 3.660 | 58.545 | 0.081 | 32.68 | 14.690 | 3.9990 | 58.745 | 0.082 | 32.79 | 14.64 | 0.000 |
| 1965 | May 4, 2012 | 12:23:30 PM | 14.64 | 3.999 | 2.1790 | 3.660 | 58.545 | 0.081 | 32.76 | 14.690 | 3.9990 | 58.745 | 0.082 | 32.87 | 14.64 | 0.002 |
| 1970 | May 4, 2012 | 12:23:35 PM | 14.64 | 3.999 | 2.1846 | 3.660 | 58.545 | 0.081 | 32.84 | 14.690 | 3.9990 | 58.745 | 0.082 | 32.95 | 14.64 | 0.004 |
| 1975 | May 4, 2012 | 12:23:40 PM | 14.64 | 3.999 | 2.1901 | 3.660 | 58.545 | 0.081 | 32.92 | 14.690 | 3.9990 | 58.745 | 0.082 | 33.03 | 14.64 | 0.005 |
| 1980 | May 4, 2012 | 12:23:45 PM | 14.63 | 3.999 | 2.1957 | 3.658 | 58.505 | 0.081 | 33.01 | 14.680 | 3.9990 | 58.705 | 0.082 | 33.12 | 14.63 | −0.005 |
| 1985 | May 4, 2012 | 12:23:50 PM | 14.63 | 3.999 | 2.2012 | 3.658 | 58.505 | 0.081 | 33.09 | 14.680 | 3.9990 | 58.705 | 0.082 | 33.20 | 14.63 | −0.004 |
| 1990 | May 4, 2012 | 12:23:55 PM | 14.63 | 3.999 | 2.2067 | 3.658 | 58.505 | 0.081 | 33.17 | 14.680 | 3.9990 | 58.705 | 0.082 | 33.28 | 14.63 | −0.002 |
| 1995 | May 4, 2012 | 12:24:00 PM | 14.63 | 3.999 | 2.2123 | 3.658 | 58.505 | 0.081 | 33.25 | 14.680 | 3.9990 | 58.705 | 0.082 | 33.36 | 14.63 | 0.000 |
| 2000 | May 4, 2012 | 12:24:05 PM | 14.63 | 3.999 | 2.2178 | 3.658 | 58.505 | 0.081 | 33.33 | 14.680 | 3.9990 | 58.705 | 0.082 | 33.44 | 14.63 | 0.002 |
| 2005 | May 4, 2012 | 12:24:10 PM | 14.63 | 3.999 | 2.2234 | 3.658 | 58.505 | 0.081 | 33.41 | 14.680 | 3.9990 | 58.705 | 0.082 | 33.52 | 14.63 | 0.004 |
| 2010 | May 4, 2012 | 12:24:15 PM | 14.63 | 3.999 | 2.2289 | 3.658 | 58.505 | 0.081 | 33.49 | 14.680 | 3.9990 | 58.705 | 0.082 | 33.60 | 14.63 | 0.005 |
| 2015 | May 4, 2012 | 12:24:20 PM | 14.62 | 3.999 | 2.2345 | 3.655 | 58.465 | 0.081 | 33.57 | 14.670 | 3.9990 | 58.665 | 0.081 | 33.69 | 14.62 | −0.005 |
| 2020 | May 4, 2012 | 12:24:25 PM | 14.62 | 3.999 | 2.2400 | 3.655 | 58.465 | 0.081 | 33.66 | 14.670 | 3.9990 | 58.665 | 0.081 | 33.77 | 14.62 | −0.004 |
| 2025 | May 4, 2012 | 12:24:30 PM | 14.62 | 3.999 | 2.2456 | 3.655 | 58.465 | 0.081 | 33.74 | 14.670 | 3.9990 | 58.665 | 0.081 | 33.85 | 14.62 | −0.002 |
| 2030 | May 4, 2012 | 12:24:35 PM | 14.62 | 3.999 | 2.2511 | 3.655 | 58.465 | 0.081 | 33.82 | 14.670 | 3.9990 | 58.665 | 0.081 | 33.93 | 14.62 | 0.000 |
| 2035 | May 4, 2012 | 12:24:40 PM | 14.62 | 3.999 | 2.2567 | 3.655 | 58.465 | 0.081 | 33.90 | 14.670 | 3.9990 | 58.665 | 0.081 | 34.01 | 14.62 | 0.002 |
| 2040 | May 4, 2012 | 12:24:45 PM | 14.62 | 3.999 | 2.2622 | 3.655 | 58.465 | 0.081 | 33.98 | 14.670 | 3.9990 | 58.665 | 0.081 | 34.09 | 14.62 | 0.004 |
| 2045 | May 4, 2012 | 12:24:50 PM | 14.62 | 3.999 | 2.2678 | 3.655 | 58.465 | 0.081 | 34.06 | 14.670 | 3.9990 | 58.665 | 0.081 | 34.17 | 14.62 | 0.005 |
| 2050 | May 4, 2012 | 12:24:55 PM | 14.61 | 3.999 | 2.2733 | 3.653 | 58.425 | 0.081 | 34.14 | 14.660 | 3.9990 | 58.625 | 0.081 | 34.26 | 14.61 | −0.005 |
| 2055 | May 4, 2012 | 12:25:00 PM | 14.61 | 3.999 | 2.2789 | 3.653 | 58.425 | 0.081 | 34.22 | 14.660 | 3.9990 | 58.625 | 0.081 | 34.34 | 14.61 | −0.004 |
| 2060 | May 4, 2012 | 12:25:05 PM | 14.61 | 3.999 | 2.2844 | 3.653 | 58.425 | 0.081 | 34.30 | 14.660 | 3.9990 | 58.625 | 0.081 | 34.42 | 14.61 | −0.003 |
| 2065 | May 4, 2012 | 12:25:10 PM | 14.61 | 3.999 | 2.2900 | 3.653 | 58.425 | 0.081 | 34.39 | 14.660 | 3.9990 | 58.625 | 0.081 | 34.50 | 14.61 | −0.001 |
| 2070 | May 4, 2012 | 12:25:15 PM | 14.61 | 3.999 | 2.2955 | 3.653 | 58.425 | 0.081 | 34.47 | 14.660 | 3.9990 | 58.625 | 0.081 | 34.58 | 14.61 | 0.001 |
| 2075 | May 4, 2012 | 12:25:20 PM | 14.61 | 3.999 | 2.3010 | 3.653 | 58.425 | 0.081 | 34.55 | 14.660 | 3.9990 | 58.625 | 0.081 | 34.66 | 14.61 | 0.003 |
| 2080 | May 4, 2012 | 12:25:25 PM | 14.61 | 3.999 | 2.3066 | 3.653 | 58.425 | 0.081 | 34.63 | 14.660 | 3.9990 | 58.625 | 0.081 | 34.74 | 14.61 | 0.004 |
| 2085 | May 4, 2012 | 12:25:30 PM | 14.61 | 3.999 | 2.3121 | 3.653 | 58.425 | 0.081 | 34.71 | 14.660 | 3.9990 | 58.625 | 0.081 | 34.83 | 14.61 | 0.005 |
| 2090 | May 4, 2012 | 12:25:35 PM | 14.60 | 3.999 | 2.3177 | 3.650 | 58.385 | 0.081 | 34.79 | 14.650 | 3.9990 | 58.585 | 0.081 | 34.91 | 14.60 | −0.005 |
| 2095 | May 4, 2012 | 12:25:40 PM | 14.60 | 3.999 | 2.3232 | 3.650 | 58.385 | 0.081 | 34.87 | 14.650 | 3.9990 | 58.585 | 0.081 | 34.99 | 14.60 | −0.003 |
| 2100 | May 4, 2012 | 12:25:45 PM | 14.60 | 3.999 | 2.3288 | 3.650 | 58.385 | 0.081 | 34.95 | 14.650 | 3.9990 | 58.585 | 0.081 | 35.07 | 14.60 | −0.001 |
| 2105 | May 4, 2012 | 12:25:50 PM | 14.60 | 3.999 | 2.3343 | 3.650 | 58.385 | 0.081 | 35.03 | 14.650 | 3.9990 | 58.585 | 0.081 | 35.15 | 14.60 | 0.001 |
| 2110 | May 4, 2012 | 12:25:55 PM | 14.60 | 3.999 | 2.3399 | 3.650 | 58.385 | 0.081 | 35.12 | 14.650 | 3.9990 | 58.585 | 0.081 | 35.23 | 14.60 | 0.003 |
| 2115 | May 4, 2012 | 12:26:00 PM | 14.60 | 3.999 | 2.3454 | 3.650 | 58.385 | 0.081 | 35.20 | 14.650 | 3.9990 | 58.585 | 0.081 | 35.31 | 14.60 | 0.005 |
| 2120 | May 4, 2012 | 12:26:05 PM | 14.59 | 3.999 | 2.3509 | 3.648 | 58.345 | 0.081 | 35.28 | 14.640 | 3.9990 | 58.545 | 0.081 | 35.40 | 14.59 | −0.005 |
| 2125 | May 4, 2012 | 12:26:10 PM | 14.59 | 3.999 | 2.3565 | 3.648 | 58.345 | 0.081 | 35.36 | 14.640 | 3.9990 | 58.545 | 0.081 | 35.48 | 14.59 | −0.004 |
| 2130 | May 4, 2012 | 12:26:15 PM | 14.59 | 3.999 | 2.3620 | 3.648 | 58.345 | 0.081 | 35.44 | 14.640 | 3.9990 | 58.545 | 0.081 | 35.56 | 14.59 | −0.003 |
| 2135 | May 4, 2012 | 12:26:20 PM | 14.59 | 3.999 | 2.3676 | 3.648 | 58.345 | 0.081 | 35.52 | 14.640 | 3.9990 | 58.545 | 0.081 | 35.64 | 14.59 | −0.001 |
| 2140 | May 4, 2012 | 12:26:25 PM | 14.59 | 3.999 | 2.3731 | 3.648 | 58.345 | 0.081 | 35.60 | 14.640 | 3.9990 | 58.545 | 0.081 | 35.72 | 14.59 | 0.001 |
| 2145 | May 4, 2012 | 12:26:30 PM | 14.59 | 3.999 | 2.3787 | 3.648 | 58.345 | 0.081 | 35.68 | 14.640 | 3.9990 | 58.545 | 0.081 | 35.80 | 14.59 | 0.003 |
| 2150 | May 4, 2012 | 12:26:35 PM | 14.59 | 3.999 | 2.3842 | 3.648 | 58.345 | 0.081 | 35.76 | 14.640 | 3.9990 | 58.545 | 0.081 | 35.88 | 14.59 | 0.004 |
| 2155 | May 4, 2012 | 12:26:40 PM | 14.59 | 3.999 | 2.3898 | 3.648 | 58.345 | 0.081 | 33.85 | 14.630 | 3.9990 | 58.545 | 0.081 | 35.96 | 14.59 | 0.005 |
| 2160 | May 4, 2012 | 12:26:45 PM | 14.58 | 3.999 | 2.3953 | 3.645 | 58.305 | 0.081 | 35.93 | 14.630 | 3.9990 | 58.505 | 0.081 | 36.05 | 14.58 | −0.005 |
| 2165 | May 4, 2012 | 12:26:50 PM | 14.58 | 3.999 | 2.4009 | 3.645 | 58.305 | 0.081 | 36.01 | 14.630 | 3.9990 | 58.505 | 0.081 | 36.13 | 14.58 | −0.004 |
| 2170 | May 4, 2012 | 12:26:55 PM | 14.58 | 3.999 | 2.4064 | 3.645 | 58.305 | 0.081 | 36.09 | 14.630 | 3.9990 | 58.505 | 0.081 | 36.21 | 14.58 | −0.002 |
| 2175 | May 4, 2012 | 12:27:00 PM | 14.58 | 3.999 | 2.4119 | 3.645 | 58.305 | 0.081 | 36.17 | 14.630 | 3.9990 | 58.505 | 0.081 | 36.29 | 14.58 | 0.000 |
| 2180 | May 4, 2012 | 12:27:05 PM | 14.58 | 3.999 | 2.4173 | 3.645 | 58.305 | 0.081 | 36.25 | 14.630 | 3.9990 | 58.505 | 0.081 | 36.37 | 14.58 | 0.002 |
| 2185 | May 4, 2012 | 12:27:10 PM | 14.58 | 3.999 | 2.4229 | 3.645 | 58.305 | 0.081 | 36.33 | 14.630 | 3.9990 | 58.505 | 0.081 | 36.45 | 14.58 | 0.004 |
| 2190 | May 4, 2012 | 12:27:15 PM | 14.58 | 3.999 | 2.4284 | 3.645 | 58.305 | 0.081 | 36.41 | 14.630 | 3.9990 | 58.505 | 0.081 | 36.53 | 14.58 | 0.005 |
| 2195 | May 4, 2012 | 12:27:20 PM | 14.57 | 3.999 | 2.4339 | 3.643 | 58.265 | 0.081 | 36.49 | 14.620 | 3.9990 | 58.465 | 0.081 | 36.61 | 14.57 | −0.005 |
| 2200 | May 4, 2012 | 12:27:25 PM | 14.57 | 3.999 | 2.4395 | 3.643 | 58.265 | 0.081 | 36.57 | 14.620 | 3.9990 | 58.465 | 0.081 | 36.70 | 14.57 | −0.004 |
| 2205 | May 4, 2012 | 12:27:30 PM | 14.57 | 3.999 | 2.4450 | 3.643 | 58.265 | 0.081 | 36.65 | 14.620 | 3.9990 | 58.465 | 0.081 | 36.78 | 14.57 | −0.001 |
| 2210 | May 4, 2012 | 12:27:35 PM | 14.57 | 3.999 | 2.4506 | 3.643 | 58.265 | 0.081 | 36.74 | 14.620 | 3.9990 | 58.465 | 0.081 | 36.86 | 14.57 | 0.001 |
| 2215 | May 4, 2012 | 12:27:40 PM | 14.57 | 3.999 | 2.4561 | 3.643 | 58.265 | 0.081 | 36.82 | 14.620 | 3.9990 | 58.465 | 0.081 | 36.94 | 14.57 | 0.003 |
| 2220 | May 4, 2012 | 12:27:45 PM | 14.57 | 3.999 | 2.4617 | 3.643 | 58.265 | 0.081 | 36.90 | 14.620 | 3.9990 | 58.465 | 0.081 | 37.02 | 14.57 | 0.004 |
| 2225 | May 4, 2012 | 12:27:50 PM | 14.57 | 3.999 | 2.4672 | 3.643 | 58.265 | 0.081 | 36.98 | 14.620 | 3.9990 | 58.465 | 0.081 | 37.10 | 14.57 | 0.005 |
| 2230 | May 4, 2012 | 12:27:55 PM | 14.57 | 3.999 | 2.4727 | 3.643 | 58.265 | 0.081 | 37.06 | 14.620 | 3.9990 | 58.465 | 0.081 | 37.18 | 14.57 | 0.005 |
| 2235 | May 4, 2012 | 12:28:00 PM | 14.56 | 3.999 | 2.4785 | 3.640 | 58.225 | 0.081 | 37.14 | 14.610 | 3.9990 | 58.465 | 0.081 | 37.26 | 14.56 | −0.005 |
| 2240 | May 4, 2012 | 12:28:05 PM | 14.56 | 3.999 | 2.4841 | 3.640 | 58.225 | 0.081 | 37.22 | 14.610 | 3.9990 | 58.465 | 0.081 | 37.35 | 14.56 | −0.004 |
| 2245 | May 4, 2012 | 12:28:10 PM | 14.56 | 3.999 | 2.4896 | 3.640 | 58.225 | 0.081 | 37.30 | 14.610 | 3.9990 | 58.465 | 0.081 | 37.43 | 14.56 | −0.002 |
| 2250 | May 4, 2012 | 12:28:15 PM | 14.56 | 3.999 | 2.4951 | 3.640 | 58.225 | 0.081 | 37.38 | 14.610 | 3.9990 | 58.465 | 0.081 | 37.51 | 14.56 | 0.000 |
| 2255 | May 4, 2012 | 12:28:20 PM | 14.56 | 3.999 | 2.5006 | 3.640 | 58.225 | 0.081 | 37.46 | 14.610 | 3.9990 | 58.465 | 0.081 | 37.59 | 14.56 | 0.002 |
| 2260 | May 4, 2012 | 12:28:25 PM | 14.56 | 3.999 | 2.5062 | 3.640 | 58.225 | 0.081 | 37.54 | 14.610 | 3.9990 | 58.465 | 0.081 | 37.67 | 14.56 | 0.004 |
| 2265 | May 4, 2012 | 12:28:30 PM | 14.56 | 3.999 | 2.5118 | 3.640 | 58.225 | 0.081 | 37.63 | 14.610 | 3.9990 | 58.465 | 0.081 | 37.75 | 14.56 | 0.005 |
| 2270 | May 4, 2012 | 12:28:35 PM | 14.55 | 3.999 | 2.5173 | 3.638 | 58.185 | 0.081 | 37.71 | 14.600 | 3.9990 | 58.385 | 0.081 | 37.83 | 14.55 | −0.005 |
| 2275 | May 4, 2012 | 12:28:40 PM | 14.55 | 3.999 | 2.5228 | 3.638 | 58.185 | 0.081 | 37.79 | 14.600 | 3.9990 | 58.385 | 0.081 | 37.91 | 14.55 | −0.004 |
| 2280 | May 4, 2012 | 12:28:45 PM | 14.55 | 3.999 | 2.5284 | 3.638 | 58.185 | 0.081 | 37.87 | 14.600 | 3.9990 | 58.385 | 0.081 | 37.99 | 14.55 | −0.003 |
| 2285 | May 4, 2012 | 12:28:50 PM | 14.55 | 3.999 | 2.5339 | 3.638 | 58.185 | 0.081 | 37.95 | 14.600 | 3.9990 | 58.385 | 0.081 | 38.08 | 14.55 | −0.001 |
| 2290 | May 4, 2012 | 12:28:55 PM | 14.55 | 3.999 | 2.5395 | 3.638 | 58.185 | 0.081 | 38.03 | 14.600 | 3.9990 | 58.385 | 0.081 | 38.16 | 14.55 | 0.001 |
| 2295 | May 4, 2012 | 12:29:00 PM | 14.55 | 3.999 | 2.5450 | 3.638 | 58.185 | 0.081 | 38.11 | 14.600 | 3.9990 | 58.385 | 0.081 | 38.24 | 14.55 | 0.003 |
| 2300 | May 4, 2012 | 12:29:05 PM | 14.55 | 3.999 | 2.5506 | 3.638 | 58.185 | 0.081 | 38.19 | 14.600 | 3.9990 | 58.385 | 0.081 | 38.32 | 14.55 | 0.004 |
| 2305 | May 4, 2012 | 12:29:10 PM | 14.55 | 3.999 | 2.5561 | 3.638 | 58.185 | 0.081 | 38.27 | 14.600 | 3.9990 | 58.385 | 0.081 | 38.40 | 14.55 | 0.005 |
| 2310 | May 4, 2012 | 12:29:15 PM | 14.54 | 3.999 | 2.5617 | 3.635 | 58.145 | 0.081 | 38.35 | 14.590 | 3.9990 | 58.345 | 0.081 | 38.48 | 14.54 | −0.005 |
| 2315 | May 4, 2012 | 12:29:20 PM | 14.54 | 3.999 | 2.5672 | 3.635 | 58.145 | 0.081 | 38.43 | 14.590 | 3.9990 | 58.345 | 0.081 | 38.56 | 14.54 | −0.004 |
| 2320 | May 4, 2012 | 12:29:25 PM | 14.54 | 3.999 | 2.5727 | 3.635 | 58.145 | 0.081 | 38.51 | 14.590 | 3.9990 | 58.345 | 0.081 | 38.64 | 14.54 | −0.002 |
| 2325 | May 4, 2012 | 12:29:30 PM | 14.54 | 3.999 | 2.5783 | 3.635 | 58.145 | 0.081 | 38.60 | 14.590 | 3.9990 | 58.345 | 0.081 | 38.72 | 14.54 | 0.000 |
| 2330 | May 4, 2012 | 12:29:35 PM | 14.54 | 3.999 | 2.5839 | 3.635 | 58.145 | 0.081 | 38.68 | 14.590 | 3.9990 | 58.345 | 0.081 | 38.81 | 14.54 | 0.002 |
| 2335 | May 4, 2012 | 12:29:40 PM | 14.54 | 3.999 | 2.5894 | 3.635 | 58.145 | 0.081 | 38.76 | 14.590 | 3.9990 | 58.345 | 0.081 | 38.89 | 14.54 | 0.004 |
| 2340 | May 4, 2012 | 12:29:45 PM | 14.54 | 3.999 | 2.5949 | 3.635 | 58.145 | 0.081 | 38.84 | 14.590 | 3.9990 | 58.345 | 0.081 | 38.97 | 14.54 | 0.005 |
| 2345 | May 4, 2012 | 12:29:50 PM | 14.53 | 3.999 | 2.6005 | 3.633 | 58.105 | 0.081 | 38.92 | 14.580 | 3.9990 | 58.305 | 0.081 | 39.05 | 14.53 | −0.005 |
| 2350 | May 4, 2012 | 12:29:55 PM | 14.53 | 3.999 | 2.6060 | 3.633 | 58.105 | 0.081 | 39.00 | 14.580 | 3.9990 | 58.305 | 0.081 | 39.13 | 14.53 | −0.004 |
| 2355 | May 4, 2012 | 12:30:00 PM | 14.53 | 3.999 | 2.6116 | 3.633 | 58.105 | 0.081 | 39.08 | 14.580 | 3.9990 | 58.305 | 0.081 | 39.21 | 14.53 | −0.003 |
| 2360 | May 4, 2012 | 12:30:05 PM | 14.53 | 3.999 | 2.6170 | 3.633 | 58.105 | 0.081 | 39.16 | 14.580 | 3.9990 | 58.305 | 0.081 | 39.29 | 14.53 | −0.001 |
| 2365 | May 4, 2012 | 12:30:10 PM | 14.53 | 3.999 | 2.6225 | 3.633 | 58.105 | 0.081 | 39.24 | 14.580 | 3.9990 | 58.305 | 0.081 | 39.37 | 14.53 | 0.001 |
| 2370 | May 4, 2012 | 12:30:15 PM | 14.53 | 3.999 | 2.6280 | 3.633 | 58.105 | 0.081 | 39.32 | 14.580 | 3.9990 | 58.305 | 0.081 | 39.45 | 14.53 | 0.003 |
| 2375 | May 4, 2012 | 12:30:20 PM | 14.53 | 3.999 | 2.6336 | 3.633 | 58.105 | 0.081 | 39.40 | 14.580 | 3.9990 | 58.305 | 0.081 | 39.53 | 14.53 | 0.004 |
| 2380 | May 4, 2012 | 12:30:25 PM | 14.53 | 3.999 | 2.6391 | 3.633 | 58.105 | 0.081 | 39.48 | 14.580 | 3.9990 | 58.305 | 0.081 | 39.62 | 14.53 | 0.005 |
| 2385 | May 4, 2012 | 12:30:30 PM | 14.52 | 3.999 | 2.6647 | 3.630 | 58.065 | 0.081 | 39.56 | 14.570 | 3.9990 | 58.265 | 0.081 | 39.70 | 14.52 | −0.005 |
| 2390 | May 4, 2012 | 12:30:35 PM | 14.52 | 3.999 | 2.6504 | 3.630 | 58.065 | 0.081 | 39.64 | 14.570 | 3.9990 | 58.265 | 0.081 | 39.78 | 14.52 | −0.004 |
| 2395 | May 4, 2012 | 12:30:40 PM | 14.52 | 3.999 | 2.6559 | 3.630 | 58.065 | 0.081 | 39.72 | 14.570 | 3.9990 | 58.265 | 0.081 | 39.86 | 14.52 | −0.003 |
| 2400 | May 4, 2012 | 12:30:45 PM | 14.52 | 3.999 | 2.6615 | 3.630 | 58.065 | 0.081 | 39.81 | 14.570 | 3.9990 | 58.265 | 0.081 | 39.94 | 14.52 | −0.001 |
| 2405 | May 4, 2012 | 12:30:50 PM | 14.52 | 3.999 | 2.6670 | 3.630 | 58.065 | 0.081 | 39.89 | 14.570 | 3.9990 | 58.265 | 0.081 | 40.02 | 14.52 | 0.001 |
| 2410 | May 4, 2012 | 12:30:55 PM | 14.52 | 3.999 | 2.6726 | 3.630 | 58.065 | 0.081 | 39.97 | 14.570 | 3.9990 | 58.265 | 0.081 | 40.10 | 14.52 | 0.003 |
| 2415 | May 4, 2012 | 12:31:00 PM | 14.52 | 3.999 | 2.6781 | 3.630 | 58.065 | 0.081 | 40.05 | 14.570 | 3.9990 | 58.265 | 0.081 | 40.18 | 14.52 | 0.004 |
| 2420 | May 4, 2012 | 12:31:05 PM | 14.52 | 3.999 | 2.6835 | 3.630 | 58.065 | 0.081 | 40.13 | 14.570 | 3.9990 | 58.265 | 0.081 | 40.26 | 14.52 | 0.005 |
| 2425 | May 4, 2012 | 12:31:10 PM | 14.51 | 3.999 | 2.6890 | 3.628 | 58.025 | 0.081 | 40.21 | 14.560 | 3.9990 | 58.225 | 0.081 | 40.34 | 14.51 | −0.005 |
| 2430 | May 4, 2012 | 12:31:15 PM | 14.51 | 3.999 | 2.6946 | 3.628 | 58.025 | 0.081 | 40.29 | 14.560 | 3.9990 | 58.225 | 0.081 | 40.42 | 14.51 | −0.004 |
| 2435 | May 4, 2012 | 12:31:20 PM | 14.51 | 3.999 | 2.7001 | 3.628 | 58.025 | 0.081 | 40.37 | 14.560 | 3.9990 | 58.225 | 0.081 | 40.51 | 14.51 | −0.003 |
| 2440 | May 4, 2012 | 12:31:25 PM | 14.51 | 3.999 | 2.7057 | 3.628 | 58.025 | 0.081 | 40.45 | 14.560 | 3.9990 | 58.225 | 0.081 | 40.59 | 14.51 | −0.001 |
| 2445 | May 4, 2012 | 12:31:30 PM | 14.51 | 3.999 | 2.7112 | 3.628 | 58.025 | 0.081 | 40.53 | 14.560 | 3.9990 | 58.225 | 0.081 | 40.67 | 14.51 | 0.001 |
| 2450 | May 4, 2012 | 12:31:35 PM | 14.51 | 3.999 | 2.7167 | 3.628 | 58.025 | 0.081 | 40.61 | 14.560 | 3.9990 | 58.225 | 0.081 | 40.75 | 14.51 | 0.003 |
| 2455 | May 4, 2012 | 12:31:40 PM | 14.51 | 3.999 | 2.7223 | 3.628 | 58.025 | 0.081 | 40.69 | 14.560 | 3.9990 | 58.225 | 0.081 | 40.83 | 14.51 | 0.004 |
| 2460 | May 4, 2012 | 12:31:45 PM | 14.51 | 3.999 | 2.7278 | 3.628 | 58.025 | 0.081 | 40.77 | 14.560 | 3.9990 | 58.225 | 0.081 | 40.91 | 14.51 | 0.005 |
| 2465 | May 4, 2012 | 12:31:50 PM | 14.50 | 3.999 | 2.7334 | 3.625 | 57.986 | 0.081 | 40.85 | 14.550 | 3.9990 | 58.185 | 0.081 | 40.99 | 14.50 | −0.005 |
| 2470 | May 4, 2012 | 12:31:55 PM | 14.50 | 3.999 | 2.7389 | 3.625 | 57.986 | 0.081 | 40.93 | 14.550 | 3.9990 | 58.185 | 0.081 | 41.07 | 14.50 | −0.004 |
| 2475 | May 4, 2012 | 12:32:00 PM | 14.50 | 3.999 | 2.7445 | 3.625 | 57.986 | 0.081 | 41.01 | 14.550 | 3.9990 | 58.185 | 0.081 | 41.15 | 14.50 | −0.003 |
| 2480 | May 4, 2012 | 12:32:05 PM | 14.50 | 3.999 | 2.7500 | 3.625 | 57.986 | 0.081 | 41.10 | 14.550 | 3.9990 | 58.185 | 0.081 | 41.23 | 14.50 | −0.002 |
| 2485 | May 4, 2012 | 12:32:10 PM | 14.50 | 3.999 | 2.7555 | 3.625 | 57.986 | 0.081 | 41.18 | 14.550 | 3.9990 | 58.185 | 0.081 | 41.31 | 14.50 | 0.000 |
| 2490 | May 4, 2012 | 12:32:15 PM | 14.50 | 3.999 | 2.7611 | 3.625 | 57.986 | 0.081 | 41.26 | 14.550 | 3.9990 | 58.185 | 0.081 | 41.39 | 14.50 | 0.002 |
| 2495 | May 4, 2012 | 12:32:20 PM | 14.50 | 3.999 | 2.7667 | 3.625 | 57.986 | 0.081 | 41.34 | 14.550 | 3.9990 | 58.185 | 0.081 | 41.48 | 14.50 | 0.003 |
| 2500 | May 4, 2012 | 12:32:25 PM | 14.50 | 3.999 | 2.7722 | 3.625 | 57.986 | 0.081 | 41.42 | 14.550 | 3.9990 | 58.185 | 0.081 | 41.56 | 14.50 | 0.004 |
| 2505 | May 4, 2012 | 12:32:30 PM | 14.50 | 3.999 | 2.7777 | 3.625 | 57.986 | 0.081 | 41.50 | 14.550 | 3.9990 | 58.185 | 0.081 | 41.64 | 14.50 | 0.005 |
| 2510 | May 4, 2012 | 12:32:35 PM | 14.49 | 3.999 | 2.7833 | 3.623 | 57.946 | 0.080 | 41.58 | 14.540 | 3.9990 | 58.145 | 0.081 | 41.72 | 14.49 | −0.005 |
| 2515 | May 4, 2012 | 12:32:40 PM | 14.49 | 3.999 | 2.7888 | 3.623 | 57.946 | 0.080 | 41.66 | 14.540 | 3.9990 | 58.145 | 0.081 | 41.80 | 14.49 | −0.004 |
| 2520 | May 4, 2012 | 12:32:45 PM | 14.49 | 3.999 | 2.7943 | 3.623 | [symbol] | [symbol] | [symbol] | [symbol] 40 | 3.9990 | 58.145 | 0.081 | 41.88 | 14.49 | −0.002 |
| 2525 | May 4, 2012 | 12:32:50 PM | 14.49 | 3.999 | 2.7999 | 3.623 | 57.946 | 0.080 | 41.82 | 14.540 | 3.9990 | 58.145 | 0.081 | 41.96 | 14.49 | 0.000 |
| 2530 | May 4, 2012 | 12:32:55 PM | 14.49 | 3.999 | 2.8054 | 3.623 | 57.946 | 0.080 | 41.90 | 14.540 | 3.9990 | 58.145 | 0.081 | 42.04 | 14.49 | 0.002 |
| 2535 | May 4, 2012 | 12:33:00 PM | 14.49 | 3.999 | 2.8110 | 3.623 | 57.946 | 0.080 | 41.98 | 14.540 | 3.9990 | 58.145 | 0.081 | 42.12 | 14.49 | 0.004 |
| 2540 | May 4, 2012 | 12:33:05 PM | 14.49 | 3.999 | 2.8165 | 3.623 | 57.946 | 0.080 | 42.06 | 14.540 | 3.9990 | 58.145 | 0.081 | 42.20 | 14.49 | 0.005 |
| 2545 | May 4, 2012 | 12:33:10 PM | 14.48 | 3.999 | 2.8221 | 3.620 | 57.906 | 0.080 | 42.14 | 14.530 | 3.9990 | 58.105 | 0.081 | 42.28 | 14.48 | −0.005 |
| 2550 | May 4, 2012 | 12:33:15 PM | 14.48 | 3.999 | 2.8276 | 3.620 | 57.906 | 0.080 | 42.22 | 14.530 | 3.9990 | 58.105 | 0.081 | 42.36 | 14.48 | −0.004 |
| 2555 | May 4, 2012 | 12:33:20 PM | 14.48 | 3.999 | 2.8331 | 3.620 | 57.906 | 0.080 | 42.30 | 14.530 | 3.9990 | 58.105 | 0.081 | 42.44 | 14.48 | −0.002 |
| 2560 | May 4, 2012 | 12:33:25 PM | 14.48 | 3.999 | 2.8387 | 3.620 | 57.906 | 0.080 | 42.38 | 14.530 | 3.9990 | 58.105 | 0.081 | 42.52 | 14.48 | 0.000 |
| 2565 | May 4, 2012 | 12:33:30 PM | 14.48 | 3.999 | 2.8442 | 3.620 | 57.906 | 0.080 | 42.46 | 14.530 | 3.9990 | 58.105 | 0.081 | 42.61 | 14.48 | 0.002 |
| 2570 | May 4, 2012 | 12:33:35 PM | 14.48 | 3.999 | 2.8498 | 3.620 | 57.906 | 0.080 | 42.54 | 14.530 | 3.9990 | 58.105 | 0.081 | 42.69 | 14.48 | 0.004 |
| 2575 | May 4, 2012 | 12:33:40 PM | 14.48 | 3.999 | 2.8553 | 3.620 | 57.906 | 0.080 | 42.62 | 14.530 | 3.9990 | 58.105 | 0.081 | 42.77 | 14.48 | 0.005 |
| 2580 | May 4, 2012 | 12:33:45 PM | 14.47 | 3.999 | 2.8609 | 3.618 | 57.866 | 0.080 | 42.70 | 14.520 | 3.9990 | 58.065 | 0.081 | 42.85 | 14.47 | −0.005 |
| 2585 | May 4, 2012 | 12:33:50 PM | 14.47 | 3.999 | 2.8664 | 3.618 | 57.866 | 0.080 | 42.78 | 14.520 | 3.9990 | 58.065 | 0.081 | 42.93 | 14.47 | −0.004 |
| 2590 | May 4, 2012 | 12:33:55 PM | 14.47 | 3.999 | 2.8721 | 3.618 | 57.866 | 0.080 | 42.87 | 14.520 | 3.9990 | 58.065 | 0.081 | 43.01 | 14.47 | −0.003 |
| 2595 | May 4, 2012 | 12:34:00 PM | 14.47 | 3.999 | 2.8777 | 3.618 | 57.866 | 0.080 | 42.95 | 14.520 | 3.9990 | 58.065 | 0.081 | 43.09 | 14.47 | −0.002 |
| 2600 | May 4, 2012 | 12:34:05 PM | 14.47 | 3.999 | 2.8832 | 3.618 | 57.866 | 0.080 | 43.03 | 14.520 | 3.9990 | 58.065 | 0.081 | 43.17 | 14.47 | 0.000 |
| 2605 | May 4, 2012 | 12:34:10 PM | 14.47 | 3.999 | 2.8888 | 3.618 | 57.866 | 0.080 | 43.11 | 14.520 | 3.9990 | 58.065 | 0.081 | 43.25 | 14.47 | 0.002 |
| 2610 | May 4, 2012 | 12:34:15 PM | 14.47 | 3.999 | 2.8943 | 3.618 | 57.866 | 0.080 | 43.19 | 14.520 | 3.9990 | 58.065 | 0.081 | 43.33 | 14.47 | 0.003 |
| 2615 | May 4, 2012 | 12:34:20 PM | 14.47 | 3.999 | 2.8999 | 3.618 | 57.866 | 0.080 | 43.27 | 14.520 | 3.9990 | 58.065 | 0.081 | 43.41 | 14.47 | 0.004 |
| 2620 | May 4, 2012 | 12:34:25 PM | 14.47 | 3.999 | 2.9054 | 3.618 | 57.866 | 0.080 | 43.35 | 14.520 | 3.9990 | 58.065 | 0.081 | 43.49 | 14.47 | 0.005 |
| 2625 | May 4, 2012 | 12:34:30 PM | 14.46 | 3.999 | 2.9110 | 3.615 | 57.826 | 0.080 | 43.43 | 14.510 | 3.9990 | 58.025 | 0.081 | 43.57 | 14.46 | −0.005 |
| 2630 | May 4, 2012 | 12:34:35 PM | 14.46 | 3.999 | 2.9165 | 3.615 | 57.826 | 0.080 | 43.51 | 14.510 | 3.9990 | 58.025 | 0.081 | 43.65 | 14.46 | −0.004 |
| 2635 | May 4, 2012 | 12:34:40 PM | 14.46 | 3.999 | 2.9220 | 3.615 | 57.826 | 0.080 | 43.59 | 14.510 | 3.9990 | 58.025 | 0.081 | 43.73 | 14.46 | −0.003 |
| 2640 | May 4, 2012 | 12:34:45 PM | 14.46 | 3.999 | 2.9274 | 3.615 | 57.826 | 0.080 | 43.67 | 14.510 | 3.9990 | 58.025 | 0.081 | 43.82 | 14.46 | −0.001 |
| 2645 | May 4, 2012 | 12:34:50 PM | 14.46 | 3.999 | 2.9330 | 3.615 | 57.826 | 0.080 | 43.75 | 14.510 | 3.9990 | 58.025 | 0.081 | 43.90 | 14.46 | 0.001 |
| 2650 | May 4, 2012 | 12:34:55 PM | 14.46 | 3.999 | 2.9385 | 3.615 | 57.826 | 0.080 | 43.83 | 14.510 | 3.9990 | 58.025 | 0.081 | 43.98 | 14.46 | 0.003 |
| 2655 | May 4, 2012 | 12:35:00 PM | 14.46 | 3.999 | 2.9440 | 3.615 | 57.826 | 0.080 | 43.91 | 14.510 | 3.9990 | 58.025 | 0.081 | 44.06 | 14.46 | 0.004 |
| 2660 | May 4, 2012 | 12:35:05 PM | 14.46 | 3.999 | 2.9496 | 3.615 | 57.826 | 0.080 | 43.99 | 14.510 | 3.9990 | 58.025 | 0.081 | 44.14 | 14.46 | 0.005 |
| 2665 | May 4, 2012 | 12:35:10 PM | 14.45 | 3.999 | 2.9551 | 3.613 | 57.786 | 0.080 | 44.07 | 14.500 | 3.9990 | 57.986 | 0.081 | 44.22 | 14.45 | −0.005 |
| 2670 | May 4, 2012 | 12:35:15 PM | 14.45 | 3.999 | 2.9607 | 3.613 | 57.786 | 0.080 | 44.15 | 14.500 | 3.9990 | 57.986 | 0.081 | 44.30 | 14.45 | −0.004 |
| 2675 | May 4, 2012 | 12:35:20 PM | 14.45 | 3.999 | 2.9662 | 3.613 | 57.786 | 0.080 | 44.23 | 14.500 | 3.9990 | 57.986 | 0.081 | 44.38 | 14.45 | −0.003 |
| 2680 | May 4, 2012 | 12:35:25 PM | 14.45 | 3.999 | 2.9718 | 3.613 | 57.786 | 0.080 | 44.31 | 14.500 | 3.9990 | 57.986 | 0.081 | 44.46 | 14.45 | −0.002 |
| 2685 | May 4, 2012 | 12:35:30 PM | 14.45 | 3.999 | 2.9773 | 3.613 | 57.786 | 0.080 | 44.39 | 14.500 | 3.9990 | 57.986 | 0.081 | 44.54 | 14.45 | 0.000 |
| 2690 | May 4, 2012 | 12:35:35 PM | 14.45 | 3.999 | 2.9828 | 3.613 | 57.786 | 0.080 | 44.47 | 14.500 | 3.9990 | 57.986 | 0.081 | 44.62 | 14.45 | 0.002 |
| 2695 | May 4, 2012 | 12:35:40 PM | 14.45 | 3.999 | 2.9884 | 3.613 | 57.786 | 0.080 | 44.55 | 14.500 | 3.9990 | 57.986 | 0.081 | 44.70 | 14.45 | 0.003 |
| 2700 | May 4, 2012 | 12:35:45 PM | 14.45 | 3.999 | 2.9939 | 3.613 | 57.786 | 0.080 | 44.63 | 14.500 | 3.9990 | 57.986 | 0.081 | 44.78 | 14.45 | 0.004 |
| 2705 | May 4, 2012 | 12:35:50 PM | 14.45 | 3.999 | 2.9996 | 3.613 | 57.786 | 0.080 | 44.71 | 14.500 | 3.9990 | 57.986 | 0.081 | 44.86 | 14.45 | 0.005 |
| 2710 | May 4, 2012 | 12:35:55 PM | 14.44 | 3.999 | 3.0052 | 3.610 | 57.746 | 0.080 | 44.79 | 14.490 | 3.9990 | 57.946 | 0.080 | 44.94 | 14.44 | −0.005 |
| 2715 | May 4, 2012 | 12:36:00 PM | 14.44 | 3.999 | 3.0107 | 3.610 | 57.746 | 0.080 | 44.87 | 14.490 | 3.9990 | 57.946 | 0.080 | 45.02 | 14.44 | −0.004 |
| 2720 | May 4, 2012 | 12:36:05 PM | 14.44 | 3.999 | 3.0163 | 3.610 | 57.746 | 0.080 | 44.95 | 14.490 | 3.9990 | 57.946 | 0.080 | 45.10 | 14.44 | −0.003 |
| 2725 | May 4, 2012 | 12:36:10 PM | 14.44 | 3.999 | 3.0218 | 3.610 | 57.746 | 0.080 | 45.03 | 14.490 | 3.9990 | 57.946 | 0.080 | 45.18 | 14.44 | −0.002 |
| 2730 | May 4, 2012 | 12:36:15 PM | 14.44 | 3.999 | 3.0274 | 3.610 | 57.746 | 0.080 | 45.11 | 14.490 | 3.9990 | 57.946 | 0.080 | 45.26 | 14.44 | 0.000 |
| 2735 | May 4, 2012 | 12:36:20 PM | 14.44 | 3.999 | 3.0329 | 3.610 | 57.746 | 0.080 | 45.19 | 14.490 | 3.9990 | 57.946 | 0.080 | 45.35 | 14.44 | 0.002 |
| 2740 | May 4, 2012 | 12:36:25 PM | 14.44 | 3.999 | 3.0384 | 3.610 | 57.746 | 0.080 | 45.27 | 14.490 | 3.9990 | 57.946 | 0.080 | 45.43 | 14.44 | 0.003 |
| 2745 | May 4, 2012 | 12:36:30 PM | 14.44 | 3.999 | 3.0440 | 3.610 | 57.746 | 0.080 | 45.35 | 14.490 | 3.9990 | 57.946 | 0.080 | 45.51 | 14.44 | 0.004 |
| 2750 | May 4, 2012 | 12:36:35 PM | 14.44 | 3.999 | 3.0495 | 3.610 | 57.746 | 0.080 | 45.43 | 14.490 | 3.9990 | 57.946 | 0.080 | 45.59 | 14.44 | 0.005 |
| 2755 | May 4, 2012 | 12:36:40 PM | 14.43 | 3.999 | 3.0551 | 3.608 | 57.706 | 0.080 | 45.51 | 14.480 | 3.9990 | 57.906 | 0.080 | 45.67 | 14.43 | −0.005 |
| 2760 | May 4, 2012 | 12:36:45 PM | 14.43 | 3.999 | 3.0606 | 3.608 | 57.706 | 0.080 | 45.59 | 14.480 | 3.9990 | 57.906 | 0.080 | 45.75 | 14.43 | −0.004 |
| 2765 | May 4, 2012 | 12:36:50 PM | 14.43 | 3.999 | 3.0662 | 3.608 | 57.706 | 0.080 | 45.67 | 14.480 | 3.9990 | 57.906 | 0.080 | 45.83 | 14.43 | −0.003 |
| 2770 | May 4, 2012 | 12:36:55 PM | 14.43 | 3.999 | 3.0717 | 3.608 | 57.706 | 0.080 | 45.75 | 14.480 | 3.9990 | 57.906 | 0.080 | 45.91 | 14.43 | −0.002 |
| 2775 | May 4, 2012 | 12:37:00 PM | 14.43 | 3.999 | 3.0772 | 3.608 | 57.706 | 0.080 | 45.83 | 14.480 | 3.9990 | 57.906 | 0.080 | 45.99 | 14.43 | 0.000 |
| 2780 | May 4, 2012 | 12:37:05 PM | 14.43 | 3.999 | 3.0828 | 3.608 | 57.706 | 0.080 | 45.91 | 14.480 | 3.9990 | 57.906 | 0.080 | 46.07 | 14.43 | 0.002 |
| 2785 | May 4, 2012 | 12:37:10 PM | 14.43 | 3.999 | 3.0883 | 3.608 | 57.706 | 0.080 | 46.00 | 14.480 | 3.9990 | 57.906 | 0.080 | 46.15 | 14.43 | 0.003 |
| 2790 | May 4, 2012 | 12:37:15 PM | 14.43 | 3.999 | 3.0939 | 3.608 | 57.706 | 0.080 | 46.08 | 14.480 | 3.9990 | 57.906 | 0.080 | 46.23 | 14.43 | 0.004 |
| 2795 | May 4, 2012 | 12:37:20 PM | 14.43 | 3.999 | 3.0994 | 3.608 | 57.706 | 0.080 | 46.16 | 14.480 | 3.9990 | 57.906 | 0.080 | 46.31 | 14.43 | 0.005 |
| 2800 | May 4, 2012 | 12:37:25 PM | 14.42 | 3.999 | 3.1050 | 3.605 | 57.666 | 0.080 | 46.24 | 14.470 | 3.9990 | 57.866 | 0.080 | 46.39 | 14.42 | −0.005 |
| 2805 | May 4, 2012 | 12:37:30 PM | 14.42 | 3.999 | 3.1105 | 3.605 | 57.666 | 0.080 | 46.32 | 14.470 | 3.9990 | 57.866 | 0.080 | 46.47 | 14.42 | −0.004 |
| 2810 | May 4, 2012 | 12:37:35 PM | 14.42 | 3.999 | 3.1161 | 3.605 | 57.666 | 0.080 | 46.40 | 14.470 | 3.9990 | 57.866 | 0.080 | 46.55 | 14.42 | −0.003 |
| 2815 | May 4, 2012 | 12:37:40 PM | 14.42 | 3.999 | 3.1216 | 3.605 | 57.666 | 0.080 | 46.48 | 14.470 | 3.9990 | 57.866 | 0.080 | 46.63 | 14.42 | −0.002 |
| 2820 | May 4, 2012 | 12:37:45 PM | 14.42 | 3.999 | 3.1271 | 3.605 | 57.666 | 0.080 | 46.56 | 14.470 | 3.9990 | 57.866 | 0.080 | 46.71 | 14.42 | 0.000 |
| 2825 | May 4, 2012 | 12:37:50 PM | 14.42 | 3.999 | 3.1327 | 3.605 | 57.666 | 0.080 | 46.64 | 14.470 | 3.9990 | 57.866 | 0.080 | 46.79 | 14.42 | 0.002 |
| 2830 | May 4, 2012 | 12:37:55 PM | 14.42 | 3.999 | 3.1382 | 3.605 | 57.666 | 0.080 | 46.72 | 14.470 | 3.9990 | 57.866 | 0.080 | 46.87 | 14.42 | 0.003 |
| 2835 | May 4, 2012 | 12:38:00 PM | 14.42 | 3.999 | 3.1438 | 3.605 | 57.666 | 0.080 | 46.80 | 14.470 | 3.9990 | 57.866 | 0.080 | 46.95 | 14.42 | 0.004 |
| 2840 | May 4, 2012 | 12:38:05 PM | 14.42 | 3.999 | 3.1491 | 3.605 | 57.666 | 0.080 | 46.88 | 14.470 | 3.9990 | 57.866 | 0.080 | 47.03 | 14.42 | 0.005 |
| 2845 | May 4, 2012 | 12:38:10 PM | 14.41 | 3.999 | 3.1547 | 3.603 | 57.626 | 0.080 | 46.96 | 14.460 | 3.9990 | 57.826 | 0.080 | 47.11 | 14.41 | −0.005 |
| 2850 | May 4, 2012 | 12:38:15 PM | 14.41 | 3.999 | 3.1602 | 3.603 | 57.626 | 0.080 | 47.04 | 14.460 | 3.9990 | 57.826 | 0.080 | 47.19 | 14.41 | −0.004 |
| 2855 | May 4, 2012 | 12:38:20 PM | 14.41 | 3.999 | 3.1658 | 3.603 | 57.626 | 0.080 | 47.12 | 14.460 | 3.9990 | 57.826 | 0.080 | 47.27 | 14.41 | −0.003 |
| 2860 | May 4, 2012 | 12:38:25 PM | 14.41 | 3.999 | 3.1713 | 3.603 | 57.626 | 0.080 | 47.20 | 14.460 | 3.9990 | 57.826 | 0.080 | 47.36 | 14.41 | −0.002 |
| 2865 | May 4, 2012 | 12:38:30 PM | 14.41 | 3.999 | 3.1769 | 3.603 | 57.626 | 0.080 | 47.28 | 14.460 | 3.9990 | 57.826 | 0.080 | 47.44 | 14.41 | −0.001 |
| 2870 | May 4, 2012 | 12:38:35 PM | 14.41 | 3.999 | 3.1824 | 3.603 | 57.626 | 0.080 | 47.36 | 14.460 | 3.9990 | 57.826 | 0.080 | 47.52 | 14.41 | 0.001 |
| 2875 | May 4, 2012 | 12:38:40 PM | 14.41 | 3.999 | 3.1879 | 3.603 | 57.626 | 0.080 | 47.44 | 14.460 | 3.9990 | 57.826 | 0.080 | 47.60 | 14.41 | 0.002 |
| 2880 | May 4, 2012 | 12:38:45 PM | 14.41 | 3.999 | 3.1937 | 3.603 | 57.626 | 0.080 | 47.52 | 14.460 | 3.9990 | 57.826 | 0.080 | 47.68 | 14.41 | 0.003 |
| 2885 | May 4, 2012 | 12:38:50 PM | 14.41 | 3.999 | 3.1992 | 3.603 | 57.626 | 0.080 | 47.60 | 14.460 | 3.9990 | 57.826 | 0.080 | 47.76 | 14.41 | 0.004 |
| 2890 | May 4, 2012 | 12:38:55 PM | 14.41 | 3.999 | 3.2048 | 3.603 | 57.626 | 0.080 | 47.68 | 14.460 | 3.9990 | 57.826 | 0.080 | 47.84 | 14.41 | 0.005 |
| 2895 | May 4, 2012 | 12:39:00 PM | 14.40 | 3.999 | 3.2103 | 3.600 | 57.586 | 0.080 | 47.76 | 14.450 | 3.9990 | 57.786 | 0.080 | 47.92 | 14.40 | −0.005 |
| 2900 | May 4, 2012 | 12:39:05 PM | 14.40 | 3.999 | 3.2158 | 3.600 | 57.586 | 0.080 | 47.84 | 14.450 | 3.9990 | 57.786 | 0.080 | 48.00 | 14.40 | −0.004 |
| 2905 | May 4, 2012 | 12:39:10 PM | 14.40 | 3.999 | 3.2214 | 3.600 | 57.586 | 0.080 | 47.92 | 14.450 | 3.9990 | 57.786 | 0.080 | 48.08 | 14.40 | −0.003 |
| 2910 | May 4, 2012 | 12:39:15 PM | 14.40 | 3.999 | 3.2269 | 3.600 | 57.586 | 0.080 | 48.00 | 14.450 | 3.9990 | 57.786 | 0.080 | 48.16 | 14.40 | −0.002 |
| 2915 | May 4, 2012 | 12:39:20 PM | 14.40 | 3.999 | 3.2325 | 3.600 | 57.586 | 0.080 | 48.08 | 14.450 | 3.9990 | 57.786 | 0.080 | 48.24 | 14.40 | 0.000 |
| 2920 | May 4, 2012 | 12:39:25 PM | 14.40 | 3.999 | 3.2380 | 3.600 | 57.586 | 0.080 | 48.16 | 14.450 | 3.9990 | 57.786 | 0.080 | 48.32 | 14.40 | 0.002 |
| 2925 | May 4, 2012 | 12:39:30 PM | 14.40 | 3.999 | 3.2436 | 3.600 | 57.586 | 0.080 | 48.24 | 14.450 | 3.9990 | 57.786 | 0.080 | 48.40 | 14.40 | 0.003 |
| 2930 | May 4, 2012 | 12:39:35 PM | 14.40 | 3.999 | 3.2491 | 3.600 | 57.586 | 0.080 | 48.32 | 14.450 | 3.9990 | 57.786 | 0.080 | 48.48 | 14.40 | 0.004 |
| 2935 | May 4, 2012 | 12:39:40 PM | 14.40 | 3.999 | 3.2546 | 3.600 | 57.586 | 0.080 | 48.40 | 14.450 | 3.9990 | 57.786 | 0.080 | 48.56 | 14.40 | 0.005 |
| 2940 | May 4, 2012 | 12:39:45 PM | 14.39 | 3.999 | 3.2598 | 3.598 | 57.546 | 0.080 | 48.48 | 14.440 | 3.9990 | 57.746 | 0.080 | 48.64 | 14.39 | −0.005 |
| 2945 | May 4, 2012 | 12:39:50 PM | 14.39 | 3.999 | 3.2657 | 3.598 | 57.546 | 0.080 | 48.56 | 14.440 | 3.9990 | 57.746 | 0.080 | 48.72 | 14.39 | −0.004 |
| 2950 | May 4, 2012 | 12:39:55 PM | 14.39 | 3.999 | 3.2713 | 3.598 | 57.546 | 0.080 | 48.64 | 14.440 | 3.9990 | 57.746 | 0.080 | 48.80 | 14.39 | −0.003 |
| 2955 | May 4, 2012 | 12:40:00 PM | 14.39 | 3.999 | 3.2768 | 3.598 | 57.546 | 0.080 | 48.72 | 14.440 | 3.9990 | 57.746 | 0.080 | 48.88 | 14.39 | −0.002 |
| 2960 | May 4, 2012 | 12:40:05 PM | 14.39 | 3.999 | 3.2824 | 3.598 | 57.546 | 0.080 | 48.80 | 14.440 | 3.9990 | 57.746 | 0.080 | 48.96 | 14.39 | −0.001 |
| 2965 | May 4, 2012 | 12:40:10 PM | 14.39 | 3.999 | 3.2879 | 3.598 | 57.546 | 0.080 | 48.88 | 14.440 | 3.9990 | 57.746 | 0.080 | 49.04 | 14.39 | 0.001 |
| 2970 | May 4, 2012 | 12:40:15 PM | 14.39 | 3.999 | 3.2935 | 3.598 | 57.546 | 0.080 | 48.96 | 14.440 | 3.9990 | 57.746 | 0.080 | 49.12 | 14.39 | 0.002 |
| 2975 | May 4, 2012 | 12:40:20 PM | 14.39 | 3.999 | 3.2990 | 3.598 | 57.546 | 0.080 | 49.04 | 14.440 | 3.9990 | 57.746 | 0.080 | 49.20 | 14.39 | 0.003 |
| 2980 | May 4, 2012 | 12:40:25 PM | 14.39 | 3.999 | 3.3045 | 3.598 | 57.546 | 0.080 | 49.12 | 14.440 | 3.9990 | 57.746 | 0.080 | 49.28 | 14.39 | 0.004 |
| 2985 | May 4, 2012 | 12:40:30 PM | 14.39 | 3.999 | 3.3101 | 3.598 | 57.546 | 0.080 | 49.20 | 14.440 | 3.9990 | 57.746 | 0.080 | 49.36 | 14.39 | 0.005 |
| 2990 | May 4, 2012 | 12:40:35 PM | 14.38 | 3.999 | 3.3156 | 3.595 | 57.506 | 0.080 | 49.28 | 14.430 | 3.9990 | 57.706 | 0.080 | 49.44 | 14.38 | −0.005 |
| 2995 | May 4, 2012 | 12:40:40 PM | 14.38 | 3.999 | 3.3212 | 3.595 | 57.506 | 0.080 | 49.36 | 14.430 | 3.9990 | 57.706 | 0.080 | 49.52 | 14.38 | −0.004 |
| 3000 | May 4, 2012 | 12:40:45 PM | 14.38 | 3.999 | 3.3267 | 3.595 | 57.506 | 0.080 | 49.44 | 14.430 | 3.9990 | 57.706 | 0.080 | 49.60 | 14.38 | −0.003 |
| 3005 | May 4, 2012 | 12:40:50 PM | 14.38 | 3.999 | 3.3323 | 3.595 | 57.506 | 0.080 | 49.52 | 14.430 | 3.9990 | 57.706 | 0.080 | 49.68 | 14.38 | −0.002 |
| 3010 | May 4, 2012 | 12:40:55 PM | 14.38 | 3.999 | 3.3378 | 3.595 | 57.506 | 0.080 | 49.59 | 14.430 | 3.9990 | 57.706 | 0.080 | 49.76 | 14.38 | −0.001 |
| 3015 | May 4, 2012 | 12:41:00 PM | 14.38 | 3.999 | 3.3434 | 3.595 | 57.506 | 0.080 | 49.67 | 14.430 | 3.9990 | 57.706 | 0.080 | 49.84 | 14.38 | 0.001 |
| 3020 | May 4, 2012 | 12:41:05 PM | 14.38 | 3.999 | 3.3489 | 3.595 | 57.506 | 0.080 | 49.75 | 14.430 | 3.9990 | 57.706 | 0.080 | 49.92 | 14.38 | 0.002 |
| 3025 | May 4, 2012 | 12:41:10 PM | 14.38 | 3.999 | 3.3544 | 3.595 | 57.506 | 0.080 | 49.83 | 14.430 | 3.9990 | 57.706 | 0.080 | 50.00 | 14.38 | 0.003 |
| 3030 | May 4, 2012 | 12:41:15 PM | 14.38 | 3.999 | 3.3600 | 3.595 | 57.506 | 0.080 | 49.91 | 14.430 | 3.9990 | 57.706 | 0.080 | 50.08 | 14.38 | 0.004 |
| 3035 | May 4, 2012 | 12:41:20 PM | 14.38 | 3.999 | 3.3654 | 3.595 | 57.506 | 0.080 | 49.99 | 14.430 | 3.9990 | 57.706 | 0.080 | 50.16 | 14.38 | 0.005 |
| 3040 | May 4, 2012 | 12:41:25 PM | 14.37 | 3.999 | 3.3709 | 3.593 | 57.466 | 0.080 | 50.07 | 14.420 | 3.9990 | 57.666 | 0.080 | 50.24 | 14.37 | −0.005 |
| 3045 | May 4, 2012 | 12:41:30 PM | 14.37 | 3.999 | 3.3764 | 3.593 | 57.466 | 0.080 | 50.15 | 14.420 | 3.9990 | 57.666 | 0.080 | 50.32 | 14.37 | −0.004 |
| 3050 | May 4, 2012 | 12:41:35 PM | 14.37 | 3.999 | 3.3820 | 3.593 | 57.466 | 0.080 | 50.23 | 14.420 | 3.9990 | 57.666 | 0.080 | 50.40 | 14.37 | −0.003 |
| 3055 | May 4, 2012 | 12:41:40 PM | 14.37 | 3.999 | 3.3875 | 3.593 | 57.466 | 0.080 | 50.31 | 14.420 | 3.9990 | 57.666 | 0.080 | 50.48 | 14.37 | −0.002 |
| 3060 | May 4, 2012 | 12:41:45 PM | 14.37 | 3.999 | 3.3931 | 3.593 | 57.466 | 0.080 | 50.39 | 14.420 | 3.9990 | 57.666 | 0.080 | 50.56 | 14.37 | −0.001 |
| 3065 | May 4, 2012 | 12:41:50 PM | 14.37 | 3.999 | 3.3986 | 3.593 | 57.466 | 0.080 | 50.47 | 14.420 | 3.9990 | 57.666 | 0.080 | 50.64 | 14.37 | 0.000 |
| 3070 | May 4, 2012 | 12:41:55 PM | 14.37 | 3.999 | 3.4042 | 3.593 | 57.466 | 0.080 | 50.55 | 14.420 | 3.9990 | 57.666 | 0.080 | 50.72 | 14.37 | 0.000 |
| 3075 | May 4, 2012 | 12:42:00 PM | 14.37 | 3.999 | 3.4097 | 3.593 | 57.466 | 0.080 | 50.63 | 14.420 | 3.9990 | 57.666 | 0.080 | 50.80 | 14.37 | 0.001 |
| 3080 | May 4, 2012 | 12:42:05 PM | 14.37 | 3.999 | 3.4153 | 3.593 | 57.466 | 0.080 | 50.71 | 14.420 | 3.9990 | 57.666 | 0.080 | 50.88 | 14.37 | 0.002 |
| 3085 | May 4, 2012 | 12:42:10 PM | 14.37 | 3.999 | 3.4208 | 3.593 | 57.466 | 0.080 | 50.79 | 14.420 | 3.9990 | 57.666 | 0.080 | 50.96 | 14.37 | 0.003 |
| 3090 | May 4, 2012 | 12:42:15 PM | 14.37 | 3.999 | 3.4265 | 3.593 | 57.466 | 0.080 | 50.87 | 14.420 | 3.9990 | 57.666 | 0.080 | 51.04 | 14.37 | 0.004 |
| 3095 | May 4, 2012 | 12:42:20 PM | 14.37 | 3.999 | 3.4321 | 3.593 | 57.466 | 0.080 | 50.95 | 14.420 | 3.9990 | 57.666 | 0.080 | 51.12 | 14.37 | 0.005 |
| 3100 | May 4, 2012 | 12:42:25 PM | 14.36 | 3.999 | 3.4376 | 3.590 | 57.426 | 0.080 | 51.03 | 14.410 | 3.9990 | 57.626 | 0.080 | 51.20 | 14.36 | −0.005 |
| 3105 | May 4, 2012 | 12:42:30 PM | 14.36 | 3.999 | 3.4432 | 3.590 | 57.426 | 0.080 | 51.11 | 14.410 | 3.9990 | 57.626 | 0.080 | 51.28 | 14.36 | −0.004 |
| 3110 | May 4, 2012 | 12:42:35 PM | 14.36 | 3.999 | 3.4487 | 3.590 | 57.426 | 0.080 | 51.19 | 14.410 | 3.9990 | 57.626 | 0.080 | 51.36 | 14.36 | −0.003 |
| 3115 | May 4, 2012 | 12:42:40 PM | 14.36 | 3.999 | 3.4543 | 3.590 | 57.426 | 0.080 | 51.27 | 14.410 | 3.9990 | 57.626 | 0.080 | 51.44 | 14.36 | −0.002 |
| 3120 | May 4, 2012 | 12:42:45 PM | 14.36 | 3.999 | 3.4598 | 3.590 | 57.426 | 0.080 | 51.35 | 14.410 | 3.9990 | 57.626 | 0.080 | 51.52 | 14.36 | −0.001 |
| 3125 | May 4, 2012 | 12:42:50 PM | 14.36 | 3.999 | 3.4654 | 3.590 | 57.426 | 0.080 | 51.43 | 14.410 | 3.9990 | 57.626 | 0.080 | 51.60 | 14.36 | 0.000 |
| 3130 | May 4, 2012 | 12:42:55 PM | 14.36 | 3.999 | 3.4709 | 3.590 | 57.426 | 0.080 | 51.51 | 14.410 | 3.9990 | 57.626 | 0.080 | 51.68 | 14.36 | 0.000 |
| 3135 | May 4, 2012 | 12:43:00 PM | 14.36 | 3.999 | 3.4765 | 3.590 | 57.426 | 0.080 | 51.59 | 14.410 | 3.9990 | 57.626 | 0.080 | 51.76 | 14.36 | 0.001 |
| 3140 | May 4, 2012 | 12:43:05 PM | 14.36 | 3.999 | 3.4820 | 3.590 | 57.426 | 0.080 | 51.67 | 14.410 | 3.9990 | 57.626 | 0.080 | 51.84 | 14.36 | 0.002 |
| 3145 | May 4, 2012 | 12:43:10 PM | 14.36 | 3.999 | 3.4875 | 3.590 | 57.426 | 0.080 | 51.75 | 14.410 | 3.9990 | 57.626 | 0.080 | 51.92 | 14.36 | 0.003 |
| 3150 | May 4, 2012 | 12:43:15 PM | 14.36 | 3.999 | 3.4931 | 3.590 | 57.426 | 0.080 | 51.83 | 14.410 | 3.9990 | 57.626 | 0.080 | 52.00 | 14.36 | 0.004 |
| 3155 | May 4, 2012 | 12:43:20 PM | 14.36 | 3.999 | 3.4987 | 3.590 | 57.426 | 0.080 | 51.91 | 14.410 | 3.9990 | 57.626 | 0.080 | 52.08 | 14.36 | 0.005 |
| 3160 | May 4, 2012 | 12:43:25 PM | 14.35 | 3.999 | 3.5040 | 3.588 | 57.386 | 0.080 | 51.99 | 14.400 | 3.9990 | 57.586 | 0.080 | 52.16 | 14.35 | −0.005 |
| 3165 | May 4, 2012 | 12:43:30 PM | 14.35 | 3.999 | 3.5095 | 3.588 | 57.386 | 0.080 | 52.07 | 14.400 | 3.9990 | 57.586 | 0.080 | 52.24 | 14.35 | −0.004 |
| 3170 | May 4, 2012 | 12:43:35 PM | 14.35 | 3.999 | 3.5151 | 3.588 | 57.386 | 0.080 | 52.15 | 14.400 | 3.9990 | 57.586 | 0.080 | 52.32 | 14.35 | −0.003 |
| 3175 | May 4, 2012 | 12:43:40 PM | 14.35 | 3.999 | 3.5206 | 3.588 | 57.386 | 0.080 | 52.23 | 14.400 | 3.9990 | 57.586 | 0.080 | 52.40 | 14.35 | −0.002 |
| 3180 | May 4, 2012 | 12:43:45 PM | 14.35 | 3.999 | 3.5262 | 3.588 | 57.386 | 0.080 | 52.31 | 14.400 | 3.9990 | 57.586 | 0.080 | 52.48 | 14.35 | −0.001 |
| 3185 | May 4, 2012 | 12:43:50 PM | 14.35 | 3.999 | 3.5317 | 3.588 | 57.386 | 0.080 | 52.39 | 14.400 | 3.9990 | 57.586 | 0.080 | 52.56 | 14.35 | 0.001 |
| 3190 | May 4, 2012 | 12:43:55 PM | 14.35 | 3.999 | 3.5373 | 3.588 | 57.386 | 0.080 | 52.47 | 14.400 | 3.9990 | 57.586 | 0.080 | 52.64 | 14.35 | 0.002 |
| 3195 | May 4, 2012 | 12:44:00 PM | 14.35 | 3.999 | 3.5428 | 3.588 | 57.386 | 0.080 | 52.55 | 14.400 | 3.9990 | 57.586 | 0.080 | 52.72 | 14.35 | 0.003 |
| 3200 | May 4, 2012 | 12:44:05 PM | 14.35 | 3.999 | 3.5483 | 3.588 | 57.386 | 0.080 | 52.63 | 14.400 | 3.9990 | 57.586 | 0.080 | 52.80 | 14.35 | 0.004 |
| 3205 | May 4, 2012 | 12:44:10 PM | 14.35 | 3.999 | 3.5539 | 3.588 | 57.386 | 0.080 | 52.71 | 14.400 | 3.9990 | 57.586 | 0.080 | 52.88 | 14.35 | 0.005 |
| 3210 | May 4, 2012 | 12:44:15 PM | 14.34 | 3.999 | 3.5594 | 3.585 | 57.346 | 0.080 | 52.79 | 14.390 | 3.9990 | 57.546 | 0.080 | 52.96 | 14.34 | −0.005 |
| 3215 | May 4, 2012 | 12:44:20 PM | 14.34 | 3.999 | 3.5650 | 3.585 | 57.346 | 0.080 | 52.87 | 14.390 | 3.9990 | 57.546 | 0.080 | 53.04 | 14.34 | −0.004 |
| 3220 | May 4, 2012 | 12:44:25 PM | 14.34 | 3.999 | 3.5705 | 3.585 | 57.346 | 0.080 | 52.95 | 14.390 | 3.9990 | 57.546 | 0.080 | 53.12 | 14.34 | −0.003 |
| 3225 | May 4, 2012 | 12:44:30 PM | 14.34 | 3.999 | 3.5761 | 3.585 | 57.346 | 0.080 | 53.02 | 14.390 | 3.9990 | 57.546 | 0.080 | 53.20 | 14.34 | −0.002 |
| 3230 | May 4, 2012 | 12:44:35 PM | 14.34 | 3.999 | 3.5816 | 3.585 | 57.346 | 0.080 | 53.10 | 14.390 | 3.9990 | 57.546 | 0.080 | 53.28 | 14.34 | −0.001 |
| 3235 | May 4, 2012 | 12:44:40 PM | 14.34 | 3.999 | 3.5873 | 3.585 | 57.346 | 0.080 | 53.18 | 14.390 | 3.9990 | 57.546 | 0.080 | 53.36 | 14.34 | 0.000 |
| 3240 | May 4, 2012 | 12:44:45 PM | 14.34 | 3.999 | 3.5929 | 3.585 | 57.346 | 0.080 | 53.26 | 14.390 | 3.9990 | 57.546 | 0.080 | 53.44 | 14.34 | 0.001 |
| 3245 | May 4, 2012 | 12:44:50 PM | 14.34 | 3.999 | 3.5984 | 3.585 | 57.346 | 0.080 | 53.34 | 14.390 | 3.9990 | 57.546 | 0.080 | 53.52 | 14.34 | 0.001 |
| 3250 | May 4, 2012 | 12:44:55 PM | 14.34 | 3.999 | 3.6040 | 3.585 | 57.346 | 0.080 | 53.41 | 14.390 | 3.9990 | 57.546 | 0.080 | 53.60 | 14.34 | 0.002 |
| 3255 | May 4, 2012 | 12:45:00 PM | 14.34 | 3.999 | 3.6095 | 3.585 | 57.346 | 0.080 | 53.50 | 14.390 | 3.9990 | 57.546 | 0.080 | 53.68 | 14.34 | 0.003 |
| 3260 | May 4, 2012 | 12:45:05 PM | 14.34 | 3.999 | 3.6151 | 3.585 | 57.346 | 0.080 | 53.58 | 14.390 | 3.9990 | 57.546 | 0.080 | 53.76 | 14.34 | 0.004 |
| 3265 | May 4, 2012 | 12:45:10 PM | 14.33 | 3.999 | 3.6206 | 3.583 | 57.306 | 0.080 | 53.66 | 14.380 | 3.9990 | 57.506 | 0.080 | 53.84 | 14.34 | −0.005 |
| 3270 | May 4, 2012 | 12:45:15 PM | 14.34 | 3.999 | 3.6262 | 3.585 | 57.346 | 0.080 | 53.74 | 14.390 | 3.9990 | 57.546 | 0.080 | 53.92 | 14.33 | 0.005 |
| 3275 | May 4, 2012 | 12:45:20 PM | 14.33 | 3.999 | 3.6317 | 3.583 | 57.306 | 0.080 | 53.82 | 14.380 | 3.9990 | 57.506 | 0.080 | 54.00 | 14.33 | −0.004 |
| 3280 | May 4, 2012 | 12:45:25 PM | 14.33 | 3.999 | 3.6372 | 3.583 | 57.306 | 0.080 | 53.90 | 14.380 | 3.9990 | 57.506 | 0.080 | 54.08 | 14.33 | −0.003 |
| 3285 | May 4, 2012 | 12:45:30 PM | 14.33 | 3.999 | 3.6428 | 3.583 | 57.306 | 0.080 | 53.98 | 14.380 | 3.9990 | 57.506 | 0.080 | 54.16 | 14.33 | −0.002 |
| 3290 | May 4, 2012 | 12:45:35 PM | 14.33 | 3.999 | 3.6484 | 3.583 | 57.306 | 0.080 | 54.06 | 14.380 | 3.9990 | 57.506 | 0.080 | 54.24 | 14.33 | −0.001 |
| 3295 | May 4, 2012 | 12:45:40 PM | 14.33 | 3.999 | 3.6539 | 3.583 | 57.306 | 0.080 | 54.14 | 14.380 | 3.9990 | 57.506 | 0.080 | 54.32 | 14.33 | −0.001 |
| 3300 | May 4, 2012 | 12:45:45 PM | 14.33 | 3.999 | 3.6594 | 3.583 | 57.306 | 0.080 | 54.22 | 14.380 | 3.9990 | 57.506 | 0.080 | 54.40 | 14.33 | 0.000 |
| 3305 | May 4, 2012 | 12:45:50 PM | 14.33 | 3.999 | 3.6650 | 3.583 | 57.306 | 0.080 | 54.30 | 14.380 | 3.9990 | 57.506 | 0.080 | 54.48 | 14.33 | 0.001 |
| 3310 | May 4, 2012 | 12:45:55 PM | 14.33 | 3.999 | 3.6705 | 3.583 | 57.306 | 0.080 | 54.38 | 14.380 | 3.9990 | 57.506 | 0.080 | 54.56 | 14.33 | 0.002 |
| 3315 | May 4, 2012 | 12:46:00 PM | 14.33 | 3.999 | 3.6761 | 3.583 | 57.306 | 0.080 | 54.46 | 14.380 | 3.9990 | 57.506 | 0.080 | 54.64 | 14.33 | 0.003 |
| 3320 | May 4, 2012 | 12:46:05 PM | 14.33 | 3.999 | 3.6816 | 3.583 | 57.306 | 0.080 | 54.54 | 14.380 | 3.9990 | 57.506 | 0.080 | 54.72 | 14.33 | 0.004 |
| 3325 | May 4, 2012 | 12:46:10 PM | 14.33 | 3.999 | 3.6872 | 3.583 | 57.306 | 0.080 | 54.62 | 14.380 | 3.9990 | 57.506 | 0.080 | 54.80 | 14.33 | 0.005 |
| 3330 | May 4, 2012 | 12:46:15 PM | 14.32 | 3.999 | 3.6927 | 3.580 | 57.266 | 0.080 | 54.70 | 14.370 | 3.9990 | 57.466 | 0.080 | 54.88 | 14.32 | −0.005 |
| 3335 | May 4, 2012 | 12:46:20 PM | 14.32 | 3.999 | 3.6983 | 3.580 | 57.266 | 0.080 | 54.78 | 14.370 | 3.9990 | 57.466 | 0.080 | 54.96 | 14.32 | −0.004 |
| 3340 | May 4, 2012 | 12:46:25 PM | 14.32 | 3.999 | 3.7038 | 3.580 | 57.266 | 0.080 | 54.86 | 14.370 | 3.9990 | 57.466 | 0.080 | 55.04 | 14.32 | −0.003 |
| 3345 | May 4, 2012 | 12:46:30 PM | 14.32 | 3.999 | 3.7093 | 3.580 | 57.266 | 0.080 | 54.94 | 14.370 | 3.9990 | 57.466 | 0.080 | 55.12 | 14.32 | −0.002 |
| 3350 | May 4, 2012 | 12:46:35 PM | 14.32 | 3.999 | 3.7149 | 3.580 | 57.266 | 0.080 | 55.01 | 14.370 | 3.9990 | 57.466 | 0.080 | 55.20 | 14.32 | −0.001 |
| 3355 | May 4, 2012 | 12:46:40 PM | 14.32 | 3.999 | 3.7204 | 3.580 | 57.266 | 0.080 | 55.09 | 14.370 | 3.9990 | 57.466 | 0.080 | 55.28 | 14.32 | 0.000 |
| 3360 | May 4, 2012 | 12:46:45 PM | 14.32 | 3.999 | 3.7260 | 3.580 | 57.266 | 0.080 | 55.17 | 14.370 | 3.9990 | 57.466 | 0.080 | 55.36 | 14.32 | 0.000 |
| 3365 | May 4, 2012 | 12:46:50 PM | 14.32 | 3.999 | 3.7315 | 3.580 | 57.266 | 0.080 | 55.25 | 14.370 | 3.9990 | 57.466 | 0.080 | 55.44 | 14.32 | 0.001 |
| 3370 | May 4, 2012 | 12:46:55 PM | 14.32 | 3.999 | 3.7371 | 3.580 | 57.266 | 0.080 | 55.33 | 14.370 | 3.9990 | 57.466 | 0.080 | 55.52 | 14.32 | 0.002 |
| 3375 | May 4, 2012 | 12:47:00 PM | 14.32 | 3.999 | 3.7426 | 3.580 | 57.266 | 0.080 | 55.41 | 14.370 | 3.9990 | 57.466 | 0.080 | 55.60 | 14.32 | 0.003 |
| 3380 | May 4, 2012 | 12:47:05 PM | 14.32 | 3.999 | 3.7482 | 3.580 | 57.266 | 0.080 | 55.49 | 14.370 | 3.9990 | 57.466 | 0.080 | 55.68 | 14.32 | 0.004 |
| 3385 | May 4, 2012 | 12:47:10 PM | 14.32 | 3.999 | 3.7537 | 3.580 | 57.266 | 0.080 | 55.57 | 14.370 | 3.9990 | 57.466 | 0.080 | 55.76 | 14.32 | 0.005 |
| 3390 | May 4, 2012 | 12:47:15 PM | 14.31 | 3.999 | 3.7592 | 3.578 | 57.226 | 0.079 | 55.65 | 14.360 | 3.9990 | 57.426 | 0.080 | 55.84 | 14.31 | −0.005 |
| 3395 | May 4, 2012 | 12:47:20 PM | 14.31 | 3.999 | 3.7648 | 3.578 | 57.226 | 0.079 | 55.73 | 14.360 | 3.9990 | 57.426 | 0.080 | 55.92 | 14.31 | −0.004 |
| 3400 | May 4, 2012 | 12:47:25 PM | 14.31 | 3.999 | 3.7703 | 3.578 | 57.226 | 0.079 | 55.81 | 14.360 | 3.9990 | 57.426 | 0.080 | 56.00 | 14.31 | −0.003 |
| 3405 | May 4, 2012 | 12:47:30 PM | 14.31 | 3.999 | 3.7759 | 3.578 | 57.226 | 0.079 | 55.89 | 14.360 | 3.9990 | 57.426 | 0.080 | 56.08 | 14.31 | −0.002 |
| 3410 | May 4, 2012 | 12:47:35 PM | 14.31 | 3.999 | 3.7814 | 3.578 | 57.226 | 0.079 | 55.97 | 14.360 | 3.9990 | 57.426 | 0.080 | 56.16 | 14.31 | −0.001 |
| 3415 | May 4, 2012 | 12:47:40 PM | 14.31 | 3.999 | 3.7870 | 3.578 | 57.226 | 0.079 | 56.05 | 14.360 | 3.9990 | 57.426 | 0.080 | 56.24 | 14.31 | 0.000 |
| 3420 | May 4, 2012 | 12:47:45 PM | 14.31 | 3.999 | 3.7925 | 3.578 | 57.226 | 0.079 | 56.13 | 14.360 | 3.9990 | 57.426 | 0.080 | 56.32 | 14.31 | 0.000 |
| 3425 | May 4, 2012 | 12:47:50 PM | 14.31 | 3.999 | 3.7981 | 3.578 | 57.226 | 0.079 | 56.21 | 14.360 | 3.9990 | 57.426 | 0.080 | 56.40 | 14.31 | 0.000 |
| 3430 | May 4, 2012 | 12:47:55 PM | 14.31 | 3.999 | 3.8036 | 3.578 | 57.226 | 0.079 | 56.29 | 14.360 | 3.9990 | 57.426 | 0.080 | 56.48 | 14.31 | 0.001 |
| 3435 | May 4, 2012 | 12:48:00 PM | 14.31 | 3.999 | 3.8092 | 3.578 | 57.226 | 0.079 | 56.37 | 14.360 | 3.9990 | 57.426 | 0.080 | 56.56 | 14.31 | 0.002 |
| 3440 | May 4, 2012 | 12:48:05 PM | 14.31 | 3.999 | 3.8147 | 3.578 | 57.226 | 0.079 | 56.45 | 14.360 | 3.9990 | 57.426 | 0.080 | 56.64 | 14.31 | 0.003 |
| 3445 | May 4, 2012 | 12:48:10 PM | 14.31 | 3.999 | 3.8203 | 3.578 | 57.226 | 0.079 | 56.53 | 14.360 | 3.9990 | 57.426 | 0.080 | 56.72 | 14.31 | 0.004 |
| 3450 | May 4, 2012 | 12:48:15 PM | 14.31 | 3.999 | 3.8258 | 3.578 | 57.226 | 0.079 | 56.60 | 14.360 | 3.9990 | 57.426 | 0.080 | 56.80 | 14.31 | 0.005 |
| 3455 | May 4, 2012 | 12:48:20 PM | 14.30 | 3.999 | 3.8312 | 3.575 | 57.186 | 0.079 | 56.68 | 14.350 | 3.9990 | 57.386 | 0.080 | 56.88 | 14.30 | −0.005 |
| 3460 | May 4, 2012 | 12:48:25 PM | 14.30 | 3.999 | 3.8367 | 3.575 | 57.186 | 0.079 | 56.76 | 14.350 | 3.9990 | 57.386 | 0.080 | 56.96 | 14.30 | −0.004 |
| 3465 | May 4, 2012 | 12:48:30 PM | 14.30 | 3.999 | 3.8423 | 3.575 | 57.186 | 0.079 | 56.84 | 14.350 | 3.9990 | 57.386 | 0.080 | 57.04 | 14.30 | −0.003 |
| 3470 | May 4, 2012 | 12:48:35 PM | 14.30 | 3.999 | 3.8478 | 3.575 | 57.186 | 0.079 | 56.92 | 14.350 | 3.9990 | 57.386 | 0.080 | 57.12 | 14.30 | −0.002 |
| 3475 | May 4, 2012 | 12:48:40 PM | 14.30 | 3.999 | 3.8534 | 3.575 | 57.186 | 0.079 | 57.00 | 14.350 | 3.9990 | 57.386 | 0.080 | 57.19 | 14.30 | −0.001 |
| 3480 | May 4, 2012 | 12:48:45 PM | 14.30 | 3.999 | 3.8589 | 3.575 | 57.186 | 0.079 | 57.08 | 14.350 | 3.9990 | 57.386 | 0.080 | 57.27 | 14.30 | 0.000 |
| 3485 | May 4, 2012 | 12:48:50 PM | 14.30 | 3.999 | 3.8645 | 3.575 | 57.186 | 0.079 | 57.16 | 14.350 | 3.9990 | 57.386 | 0.080 | 57.35 | 14.30 | 0.000 |
| 3490 | May 4, 2012 | 12:48:55 PM | 14.30 | 3.999 | 3.8700 | 3.575 | 57.186 | 0.079 | 57.24 | 14.350 | 3.9990 | 57.386 | 0.080 | 57.43 | 14.30 | 0.000 |
| 3495 | May 4, 2012 | 12:49:00 PM | 14.30 | 3.999 | 3.8755 | 3.575 | 57.186 | 0.079 | 57.32 | 14.350 | 3.9990 | 57.386 | 0.080 | 57.51 | 14.30 | 0.001 |
| 3500 | May 4, 2012 | 12:49:05 PM | 14.30 | 3.999 | 3.8811 | 3.575 | 57.186 | 0.079 | 57.40 | 14.350 | 3.9990 | 57.386 | 0.080 | 57.59 | 14.30 | 0.002 |
| 3505 | May 4, 2012 | 12:49:10 PM | 14.30 | 3.999 | 3.8866 | 3.575 | 57.186 | 0.079 | 57.48 | 14.350 | 3.9990 | 57.386 | 0.080 | 57.67 | 14.30 | 0.003 |
| 3510 | May 4, 2012 | 12:49:15 PM | 14.30 | 3.999 | 3.8922 | 3.575 | 57.186 | 0.079 | 57.56 | 14.350 | 3.9990 | 57.386 | 0.080 | 57.75 | 14.30 | 0.004 |
| 3515 | May 4, 2012 | 12:49:20 PM | 14.30 | 3.999 | 3.8979 | 3.575 | 57.186 | 0.079 | 57.64 | 14.350 | 3.9990 | 57.386 | 0.080 | 57.83 | 14.30 | 0.005 |
| 3520 | May 4, 2012 | 12:49:25 PM | 14.29 | 3.999 | 3.9034 | 3.573 | 57.146 | 0.079 | 57.72 | 14.340 | 3.9990 | 57.346 | 0.080 | 57.91 | 14.29 | −0.005 |
| 3525 | May 4, 2012 | 12:49:30 PM | 14.29 | 3.999 | 3.9090 | 3.573 | 57.146 | 0.079 | 57.80 | 14.340 | 3.9990 | 57.346 | 0.080 | 57.99 | 14.29 | −0.004 |
| 3530 | May 4, 2012 | 12:49:35 PM | 14.29 | 3.999 | 3.9145 | 3.573 | 57.146 | 0.079 | 57.88 | 14.340 | 3.9990 | 57.346 | 0.080 | 58.07 | 14.29 | −0.003 |
| 3535 | May 4, 2012 | 12:49:40 PM | 14.29 | 3.999 | 3.9201 | 3.573 | 57.146 | 0.079 | 57.95 | 14.340 | 3.9990 | 57.346 | 0.080 | 58.15 | 14.29 | −0.002 |
| 3540 | May 4, 2012 | 12:49:45 PM | 14.29 | 3.999 | 3.9256 | 3.573 | 57.146 | 0.079 | 58.03 | 14.340 | 3.9990 | 57.346 | 0.080 | 58.23 | 14.29 | −0.001 |
| 3545 | May 4, 2012 | 12:49:50 PM | 14.29 | 3.999 | 3.9312 | 3.573 | 57.146 | 0.079 | 58.11 | 14.340 | 3.9990 | 57.346 | 0.080 | 58.31 | 14.29 | 0.000 |
| 3550 | May 4, 2012 | 12:49:55 PM | 14.29 | 3.999 | 3.9367 | 3.573 | 57.146 | 0.079 | 58.19 | 14.340 | 3.9990 | 57.346 | 0.080 | 58.39 | 14.29 | 0.000 |
| 3555 | May 4, 2012 | 12:50:00 PM | 14.29 | 3.999 | 3.9422 | 3.573 | 57.146 | 0.079 | 58.27 | 14.340 | 3.9990 | 57.346 | 0.080 | 58.47 | 14.29 | 0.000 |
| 3560 | May 4, 2012 | 12:50:05 PM | 14.29 | 3.999 | 3.9478 | 3.573 | 57.146 | 0.079 | 58.35 | 14.340 | 3.9990 | 57.346 | 0.080 | 58.55 | 14.29 | 0.000 |
| 3565 | May 4, 2012 | 12:50:10 PM | 14.29 | 3.999 | 3.9533 | 3.573 | 57.146 | 0.079 | 58.43 | 14.340 | 3.9990 | 57.346 | 0.080 | 58.63 | 14.29 | 0.001 |
| 3570 | May 4, 2012 | 12:50:15 PM | 14.29 | 3.999 | 3.9589 | 3.573 | 57.146 | 0.079 | 58.51 | 14.340 | 3.9990 | 57.346 | 0.080 | 58.71 | 14.29 | 0.002 |
| 3575 | May 4, 2012 | 12:50:20 PM | 14.29 | 3.999 | 3.9644 | 3.573 | 57.146 | 0.079 | 58.59 | 14.340 | 3.9990 | 57.346 | 0.080 | 58.79 | 14.29 | 0.003 |
| 3580 | May 4, 2012 | 12:50:25 PM | 14.29 | 3.999 | 3.9700 | 3.573 | 57.146 | 0.079 | 58.67 | 14.340 | 3.9990 | 57.346 | 0.080 | 58.87 | 14.29 | 0.004 |
| 3585 | May 4, 2012 | 12:50:30 PM | 14.29 | 3.999 | 3.9755 | 3.573 | 57.146 | 0.079 | 58.75 | 14.340 | 3.9990 | 57.346 | 0.080 | 58.95 | 14.29 | 0.005 |
| 3590 | May 4, 2012 | 12:50:35 PM | 14.28 | 3.999 | 3.9811 | 3.570 | 57.106 | 0.079 | 58.83 | 14.330 | 3.9990 | 57.306 | 0.080 | 59.03 | 14.28 | −0.005 |
| 3595 | May 4, 2012 | 12:50:40 PM | 14.28 | 3.999 | 3.9866 | 3.570 | 57.106 | 0.079 | 58.91 | 14.330 | 3.9990 | 57.306 | 0.080 | 59.11 | 14.28 | −0.004 |
| 3600 | May 4, 2012 | 12:50:45 PM | 14.28 | 3.999 | 3.9922 | 3.570 | 57.106 | 0.079 | 58.99 | 14.330 | 3.9990 | 57.306 | 0.080 | 59.19 | 14.28 | −0.003 |
| 3605 | May 4, 2012 | 12:50:50 PM | 14.28 | 3.999 | 3.9977 | 3.570 | 57.106 | 0.079 | 59.07 | 14.330 | 3.9990 | 57.306 | 0.080 | 59.27 | 14.28 | −0.002 |
| 3610 | May 4, 2012 | 12:50:55 PM | 14.28 | 3.999 | 4.0031 | 3.570 | 57.106 | 0.079 | 59.14 | 14.330 | 3.9990 | 57.306 | 0.080 | 59.35 | 14.28 | −0.001 |
| 3615 | May 4, 2012 | 12:51:00 PM | 14.28 | 3.999 | 4.0086 | 3.570 | 57.106 | 0.079 | [symbol] | 14.330 | 3.9990 | 57.306 | 0.080 | 59.43 | 14.28 | 0.000 |
| 3620 | May 4, 2012 | 12:51:05 PM | 14.28 | 3.999 | 4.0142 | 3.570 | 57.106 | 0.079 | 59.30 | 14.330 | 3.9990 | 57.306 | 0.080 | 59.50 | 14.28 | 0.000 |
| 3625 | May 4, 2012 | 12:51:10 PM | 14.28 | 3.999 | 4.0197 | 3.570 | 57.106 | 0.079 | 58.38 | 14.330 | 3.9990 | 57.306 | 0.080 | 59.58 | 14.28 | 0.001 |
| 3630 | May 4, 2012 | 12:51:15 PM | 14.28 | 3.999 | 4.0252 | 3.570 | 57.106 | 0.079 | 59.46 | 14.330 | 3.9990 | 57.306 | 0.080 | 59.66 | 14.28 | 0.002 |
| 3635 | May 4, 2012 | 12:51:20 PM | 14.28 | 3.999 | 4.0308 | 3.570 | 57.106 | 0.079 | 59.54 | 14.330 | 3.9990 | 57.306 | 0.080 | 59.74 | 14.28 | 0.003 |
| 3640 | May 4, 2012 | 12:51:25 PM | 14.28 | 3.999 | 4.0365 | 3.570 | 57.106 | 0.079 | 59.62 | 14.330 | 3.9990 | 57.306 | 0.080 | 59.82 | 14.28 | 0.004 |
| 3645 | May 4, 2012 | 12:51:30 PM | 14.28 | 3.999 | 4.0420 | 3.570 | 57.106 | 0.079 | 59.70 | 14.330 | 3.9990 | 57.306 | 0.080 | 59.90 | 14.28 | 0.005 |
| 3650 | May 4, 2012 | 12:51:35 PM | 14.27 | 3.999 | 4.0476 | 3.568 | 57.066 | 0.079 | 59.78 | 14.320 | 3.9990 | 57.266 | 0.080 | 59.98 | 14.27 | −0.005 |
| 3655 | May 4, 2012 | 12:51:40 PM | 14.27 | 3.999 | 4.0531 | 3.568 | 57.066 | 0.079 | 59.86 | 14.320 | 3.9990 | 57.266 | 0.080 | 60.06 | 14.27 | −0.004 |
| 3660 | May 4, 2012 | 12:51:45 PM | 14.27 | 3.999 | 4.0587 | 3.568 | 57.066 | 0.079 | 59.94 | 14.320 | 3.9990 | 57.266 | 0.080 | 60.14 | 14.27 | −0.003 |
| 3665 | May 4, 2012 | 12:51:50 PM | 14.27 | 3.999 | 4.0642 | 3.568 | 57.066 | 0.079 | 60.02 | 14.320 | 3.9990 | 57.266 | 0.080 | 60.22 | 14.27 | −0.002 |
| 3670 | May 4, 2012 | 12:51:55 PM | 14.27 | 3.999 | 4.0698 | 3.568 | 57.066 | 0.079 | 60.10 | 14.320 | 3.9990 | 57.266 | 0.080 | 60.30 | 14.27 | −0.001 |
| 3675 | May 4, 2012 | 12:52:00 PM | 14.27 | 3.999 | 4.0753 | 3.568 | 57.066 | 0.079 | 60.18 | 14.320 | 3.9990 | 57.266 | 0.080 | 60.38 | 14.27 | 0.000 |
| 3680 | May 4, 2012 | 12:52:05 PM | 14.27 | 3.999 | 4.0808 | 3.568 | 57.066 | 0.079 | 60.25 | 14.320 | 3.9990 | 57.266 | 0.080 | 60.46 | 14.27 | 0.000 |
| 3685 | May 4, 2012 | 12:52:10 PM | 14.27 | 3.999 | 4.0862 | 3.568 | 57.066 | 0.079 | 60.33 | 14.320 | 3.9990 | 57.266 | 0.080 | 60.54 | 14.27 | 0.000 |
| 3690 | May 4, 2012 | 12:52:15 PM | 14.27 | 3.999 | 4.0918 | 3.568 | 57.066 | 0.079 | 60.41 | 14.320 | 3.9990 | 57.266 | 0.080 | 60.62 | 14.27 | 0.000 |
| 3695 | May 4, 2012 | 12:52:20 PM | 14.27 | 3.999 | 4.0973 | 3.568 | 57.066 | 0.079 | 60.49 | 14.320 | 3.9990 | 57.266 | 0.080 | 60.70 | 14.27 | 0.000 |
| 3700 | May 4, 2012 | 12:52:25 PM | 14.27 | 3.999 | 4.1028 | 3.568 | 57.066 | 0.079 | 60.57 | 14.320 | 3.9990 | 57.266 | 0.080 | 60.78 | 14.27 | 0.001 |
| 3705 | May 4, 2012 | 12:52:30 PM | 14.27 | 3.999 | 4.1084 | 3.568 | 57.066 | 0.079 | 60.65 | 14.320 | 3.9990 | 57.266 | 0.080 | 60.86 | 14.27 | 0.002 |
| 3710 | May 4, 2012 | 12:52:35 PM | 14.27 | 3.999 | 4.1139 | 3.568 | 57.066 | 0.079 | 60.73 | 14.320 | 3.9990 | 57.266 | 0.080 | 60.94 | 14.27 | 0.003 |
| 3715 | May 4, 2012 | 12:52:40 PM | 14.27 | 3.999 | 4.1195 | 3.568 | 57.066 | 0.079 | 60.81 | 14.320 | 3.9990 | 57.266 | 0.080 | 61.02 | 14.27 | 0.004 |
| 3720 | May 4, 2012 | 12:52:45 PM | 14.27 | 3.999 | 4.1250 | 3.568 | 57.066 | 0.079 | 60.89 | 14.320 | 3.9990 | 57.266 | 0.080 | 61.10 | 14.27 | 0.005 |
| 3725 | May 4, 2012 | 12:52:50 PM | 14.26 | 3.999 | 4.1306 | 3.565 | 57.026 | 0.079 | 60.97 | 14.310 | 3.9990 | 57.266 | 0.079 | 61.18 | 14.26 | −0.005 |
| 3730 | May 4, 2012 | 12:52:55 PM | 14.26 | 3.999 | 4.1361 | 3.565 | 57.026 | 0.079 | 61.05 | 14.310 | 3.9990 | 57.266 | 0.079 | 61.25 | 14.26 | −0.004 |
| 3735 | May 4, 2012 | 12:53:00 PM | 14.26 | 3.999 | 4.1417 | 3.565 | 57.026 | 0.079 | 61.13 | 14.310 | 3.9990 | 57.266 | 0.079 | 61.33 | 14.26 | −0.003 |
| 3740 | May 4, 2012 | 12:53:05 PM | 14.26 | 3.999 | 4.1472 | 3.565 | 57.026 | 0.079 | 61.21 | 14.310 | 3.9990 | 57.266 | 0.079 | 61.41 | 14.26 | −0.002 |
| 3745 | May 4, 2012 | 12:53:10 PM | 14.26 | 3.999 | 4.1527 | 3.565 | 57.026 | 0.079 | 61.29 | 14.310 | 3.9990 | 57.266 | 0.079 | 61.49 | 14.26 | −0.001 |
| 3750 | May 4, 2012 | 12:53:15 PM | 14.26 | 3.999 | 4.1583 | 3.565 | 57.026 | 0.079 | 61.36 | 14.310 | 3.9990 | 57.266 | 0.079 | 61.57 | 14.26 | 0.000 |
| 3755 | May 4, 2012 | 12:53:20 PM | 14.26 | 3.999 | 4.1638 | 3.565 | 57.026 | 0.079 | 61.44 | 14.310 | 3.9990 | 57.266 | 0.079 | 61.65 | 14.26 | 0.000 |
| 3760 | May 4, 2012 | 12:53:25 PM | 14.26 | 3.999 | 4.1694 | 3.565 | 57.026 | 0.079 | 61.52 | 14.310 | 3.9990 | 57.266 | 0.079 | 61.73 | 14.26 | 0.000 |
| 3765 | May 4, 2012 | 12:53:30 PM | 14.26 | 3.999 | 4.1749 | 3.565 | 57.026 | 0.079 | 61.60 | 14.310 | 3.9990 | 57.266 | 0.079 | 61.81 | 14.26 | 0.000 |
| 3770 | May 4, 2012 | 12:53:35 PM | 14.26 | 3.999 | 4.1805 | 3.565 | 57.026 | 0.079 | 61.68 | 14.310 | 3.9990 | 57.266 | 0.079 | 61.89 | 14.26 | 0.001 |
| 3775 | May 4, 2012 | 12:53:40 PM | 14.26 | 3.999 | 4.1860 | 3.565 | 57.026 | 0.079 | 61.76 | 14.310 | 3.9990 | 57.266 | 0.079 | 61.97 | 14.26 | 0.002 |
| 3780 | May 4, 2012 | 12:53:45 PM | 14.26 | 3.999 | 4.1915 | 3.565 | 57.026 | 0.079 | 61.84 | 14.310 | 3.9990 | 57.266 | 0.079 | 62.05 | 14.26 | 0.003 |
| 3785 | May 4, 2012 | 12:53:50 PM | 14.26 | 3.999 | 4.1971 | 3.565 | 57.026 | 0.079 | 61.92 | 14.310 | 3.9990 | 57.266 | 0.079 | 62.13 | 14.26 | 0.004 |
| 3790 | May 4, 2012 | 12:53:55 PM | 14.26 | 3.999 | 4.2026 | 3.565 | 57.026 | 0.079 | 62.00 | 14.310 | 3.9990 | 57.266 | 0.079 | 62.21 | 14.26 | 0.005 |
| 3795 | May 4, 2012 | 12:54:00 PM | 14.25 | 3.999 | 4.2082 | 3.563 | 56.986 | 0.079 | 62.08 | 14.300 | 3.9990 | 57.186 | 0.079 | 62.29 | 14.25 | −0.005 |
| 3800 | May 4, 2012 | 12:54:05 PM | 14.25 | 3.999 | 4.2137 | 3.563 | 56.986 | 0.079 | 62.16 | 14.300 | 3.9990 | 57.186 | 0.079 | 62.37 | 14.25 | −0.004 |
| 3805 | May 4, 2012 | 12:54:10 PM | 14.25 | 3.999 | 4.2193 | 3.563 | 56.986 | 0.079 | 62.24 | 14.300 | 3.9990 | 57.186 | 0.079 | 62.45 | 14.25 | −0.003 |
| 3810 | May 4, 2012 | 12:54:15 PM | 14.25 | 3.999 | 4.2248 | 3.563 | 56.986 | 0.079 | 62.31 | 14.300 | 3.9990 | 57.186 | 0.079 | 62.53 | 14.25 | −0.002 |
| 3815 | May 4, 2012 | 12:54:20 PM | 14.25 | 3.999 | 4.2304 | 3.563 | 56.986 | 0.079 | 62.39 | 14.300 | 3.9990 | 57.186 | 0.079 | 62.61 | 14.25 | −0.001 |
| 3820 | May 4, 2012 | 12:54:25 PM | 14.25 | 3.999 | 4.2359 | 3.563 | 56.986 | 0.079 | 62.47 | 14.300 | 3.9990 | 57.186 | 0.079 | 62.68 | 14.25 | 0.000 |
| 3825 | May 4, 2012 | 12:54:30 PM | 14.25 | 3.999 | 4.2414 | 3.563 | 56.986 | 0.079 | 62.55 | 14.300 | 3.9990 | 57.186 | 0.079 | 62.76 | 14.25 | 0.000 |
| 3830 | May 4, 2012 | 12:54:35 PM | 14.25 | 3.999 | 4.2470 | 3.563 | 56.986 | 0.079 | 62.63 | 14.300 | 3.9990 | 57.186 | 0.079 | 62.84 | 14.25 | 0.000 |
| 3835 | May 4, 2012 | 12:54:40 PM | 14.25 | 3.999 | 4.2525 | 3.563 | 56.986 | 0.079 | 62.71 | 14.300 | 3.9990 | 57.186 | 0.079 | 62.92 | 14.25 | 0.000 |
| 3840 | May 4, 2012 | 12:54:45 PM | 14.25 | 3.999 | 4.2581 | 3.563 | 56.986 | 0.079 | 62.79 | 14.300 | 3.9990 | 57.186 | 0.079 | 63.00 | 14.25 | 0.000 |
| 3845 | May 4, 2012 | 12:54:50 PM | 14.25 | 3.999 | 4.2636 | 3.563 | 56.986 | 0.079 | 62.87 | 14.300 | 3.9990 | 57.186 | 0.079 | 63.08 | 14.25 | 0.001 |
| 3850 | May 4, 2012 | 12:54:55 PM | 14.25 | 3.999 | 4.2692 | 3.563 | 56.986 | 0.079 | 62.95 | 14.300 | 3.9990 | 57.186 | 0.079 | 63.16 | 14.25 | 0.002 |
| 3855 | May 4, 2012 | 12:55:00 PM | 14.25 | 3.999 | 4.2747 | 3.563 | 56.986 | 0.079 | 63.03 | 14.300 | 3.9990 | 57.186 | 0.079 | 63.24 | 14.25 | 0.003 |
| 3860 | May 4, 2012 | 12:55:05 PM | 14.25 | 3.999 | 4.2802 | 3.563 | 56.986 | 0.079 | 63.11 | 14.300 | 3.9990 | 57.186 | 0.079 | 63.32 | 14.25 | 0.004 |
| 3865 | May 4, 2012 | 12:55:10 PM | 14.25 | 3.999 | 4.2860 | 3.563 | 56.986 | 0.079 | 63.19 | 14.300 | 3.9990 | 57.186 | 0.079 | 63.40 | 14.25 | 0.005 |
| 3870 | May 4, 2012 | 12:55:15 PM | 14.24 | 3.999 | 4.2915 | 3.560 | 56.946 | 0.079 | 63.26 | 14.290 | 3.9990 | 57.146 | 0.079 | 63.48 | 14.24 | −0.005 |
| 3875 | May 4, 2012 | 12:55:20 PM | 14.24 | 3.999 | 4.2971 | 3.560 | 56.946 | 0.079 | 63.34 | 14.290 | 3.9990 | 57.146 | 0.079 | 63.56 | 14.24 | −0.004 |
| 3880 | May 4, 2012 | 12:55:25 PM | 14.24 | 3.999 | 4.3026 | 3.560 | 56.946 | 0.079 | 63.42 | 14.290 | 3.9990 | 57.146 | 0.079 | 63.64 | 14.24 | −0.003 |
| 3885 | May 4, 2012 | 12:55:30 PM | 14.24 | 3.999 | 4.3082 | 3.560 | 56.946 | 0.079 | 63.50 | 14.290 | 3.9990 | 57.146 | 0.079 | 63.72 | 14.24 | −0.002 |
| 3890 | May 4, 2012 | 12:55:35 PM | 14.24 | 3.999 | 4.3137 | 3.560 | 56.946 | 0.079 | 63.58 | 14.290 | 3.9990 | 57.146 | 0.079 | 63.80 | 14.24 | −0.001 |
| 3895 | May 4, 2012 | 12:55:40 PM | 14.24 | 3.999 | 4.3192 | 3.560 | 56.946 | 0.079 | 63.66 | 14.290 | 3.9990 | 57.146 | 0.079 | 63.88 | 14.24 | 0.000 |
| 3900 | May 4, 2012 | 12:55:45 PM | 14.24 | 3.999 | 4.3248 | 3.560 | 56.946 | 0.079 | 63.74 | 14.290 | 3.9990 | 57.146 | 0.079 | 63.96 | 14.24 | 0.000 |
| 3905 | May 4, 2012 | 12:55:50 PM | 14.24 | 3.999 | 4.3303 | 3.560 | 56.946 | 0.079 | 63.82 | 14.290 | 3.9990 | 57.146 | 0.079 | 64.03 | 14.24 | 0.000 |
| 3910 | May 4, 2012 | 12:55:55 PM | 14.24 | 3.999 | 4.3359 | 3.560 | 56.946 | 0.079 | 63.90 | 14.290 | 3.9990 | 57.146 | 0.079 | 64.11 | 14.24 | 0.000 |
| 3915 | May 4, 2012 | 12:56:00 PM | 14.24 | 3.999 | 4.3414 | 3.560 | 56.946 | 0.079 | 63.98 | 14.290 | 3.9990 | 57.146 | 0.079 | 64.19 | 14.24 | 0.001 |
| 3920 | May 4, 2012 | 12:56:05 PM | 14.24 | 3.999 | 4.3470 | 3.560 | 56.946 | 0.079 | 64.06 | 14.290 | 3.9990 | 57.146 | 0.079 | 64.27 | 14.24 | 0.002 |
| 3925 | May 4, 2012 | 12:56:10 PM | 14.24 | 3.999 | 4.3525 | 3.560 | 56.946 | 0.079 | 64.13 | 14.290 | 3.9990 | 57.146 | 0.079 | 64.35 | 14.24 | 0.003 |
| 3930 | May 4, 2012 | 12:56:15 PM | 14.24 | 3.999 | 4.3580 | 3.560 | 56.946 | 0.079 | 64.21 | 14.290 | 3.9990 | 57.146 | 0.079 | 64.43 | 14.24 | 0.004 |
| 3935 | May 4, 2012 | 12:56:20 PM | 14.24 | 3.999 | 4.3636 | 3.560 | 56.946 | 0.079 | 64.29 | 14.290 | 3.9990 | 57.146 | 0.079 | 64.51 | 14.24 | 0.005 |
| 3940 | May 4, 2012 | 12:56:25 PM | 14.23 | 3.999 | 4.3691 | 3.558 | 56.906 | 0.079 | 64.37 | 14.280 | 3.9990 | 57.106 | 0.079 | 64.59 | 14.23 | −0.005 |
| 3945 | May 4, 2012 | 12:56:30 PM | 14.23 | 3.999 | 4.3747 | 3.558 | 56.906 | 0.079 | 64.45 | 14.280 | 3.9990 | 57.106 | 0.079 | 64.67 | 14.23 | −0.004 |
| 3950 | May 4, 2012 | 12:56:35 PM | 14.23 | 3.999 | 4.3802 | 3.558 | 56.906 | 0.079 | 64.53 | 14.280 | 3.9990 | 57.106 | 0.079 | 64.75 | 14.23 | −0.003 |
| 3955 | May 4, 2012 | 12:56:40 PM | 14.23 | 3.999 | 4.3856 | 3.558 | 56.906 | 0.079 | 64.61 | 14.280 | 3.9990 | 57.106 | 0.079 | 64.83 | 14.23 | −0.002 |
| 3960 | May 4, 2012 | 12:56:45 PM | 14.23 | 3.999 | 4.3911 | 3.558 | 56.906 | 0.079 | 64.69 | 14.280 | 3.9990 | 57.106 | 0.079 | 64.91 | 14.23 | −0.001 |
| 3965 | May 4, 2012 | 12:56:50 PM | 14.23 | 3.999 | 4.3967 | 3.558 | 56.906 | 0.079 | 64.77 | 14.280 | 3.9990 | 57.106 | 0.079 | 64.99 | 14.23 | 0.000 |
| 3970 | May 4, 2012 | 12:56:55 PM | 14.23 | 3.999 | 4.4022 | 3.558 | 56.906 | 0.079 | 64.85 | 14.280 | 3.9990 | 57.106 | 0.079 | 65.07 | 14.23 | 0.000 |
| 3975 | May 4, 2012 | 12:57:00 PM | 14.23 | 3.999 | 4.4078 | 3.558 | 56.906 | 0.079 | 64.92 | 14.280 | 3.9990 | 57.106 | 0.079 | 65.15 | 14.23 | 0.000 |
| 3980 | May 4, 2012 | 12:57:05 PM | 14.23 | 3.999 | 4.4133 | 3.558 | 56.906 | 0.079 | 65.00 | 14.280 | 3.9990 | 57.106 | 0.079 | 65.22 | 14.23 | 0.000 |
| 3985 | May 4, 2012 | 12:57:10 PM | 14.23 | 3.999 | 4.4188 | 3.558 | 56.906 | 0.079 | 65.08 | 14.280 | 3.9990 | 57.106 | 0.079 | 65.30 | 14.23 | 0.000 |
| 3990 | May 4, 2012 | 12:57:15 PM | 14.23 | 3.999 | 4.4244 | 3.558 | 56.906 | 0.079 | 65.16 | 14.280 | 3.9990 | 57.106 | 0.079 | 65.38 | 14.23 | 0.001 |
| 3995 | May 4, 2012 | 12:57:20 PM | 14.23 | 3.999 | 4.4299 | 3.558 | 56.906 | 0.079 | 65.24 | 14.280 | 3.9990 | 57.106 | 0.079 | 65.46 | 14.23 | 0.002 |
| 4000 | May 4, 2012 | 12:57:25 PM | 14.23 | 3.999 | 4.4355 | 3.558 | 56.906 | 0.079 | 65.32 | 14.280 | 3.9990 | 57.106 | 0.079 | 65.54 | 14.23 | 0.003 |
| 4005 | May 4, 2012 | 12:57:30 PM | 14.23 | 3.999 | 4.4410 | 3.558 | 56.906 | 0.079 | 65.40 | 14.280 | 3.9990 | 57.106 | 0.079 | 65.62 | 14.22 | 0.004 |
| 4010 | May 4, 2012 | 12:57:35 PM | 14.23 | 3.999 | 4.4466 | 3.555 | 56.906 | 0.079 | 65.48 | 14.280 | 3.9990 | 57.106 | 0.079 | 65.70 | 14.22 | 0.005 |
| 4015 | May 4, 2012 | 12:57:40 PM | 14.22 | 3.999 | 4.4521 | 3.555 | 56.866 | 0.079 | 65.56 | 14.270 | 3.9990 | 57.066 | 0.079 | 65.78 | 14.22 | −0.005 |
| 4020 | May 4, 2012 | 12:57:45 PM | 14.22 | 3.999 | 4.4577 | 3.555 | 56.866 | 0.079 | 65.64 | 14.270 | 3.9990 | 57.066 | 0.079 | 65.86 | 14.22 | −0.004 |
| 4025 | May 4, 2012 | 12:57:50 PM | 14.22 | 3.999 | 4.4632 | 3.555 | 56.866 | 0.079 | 65.71 | 14.270 | 3.9990 | 57.066 | 0.079 | 65.94 | 14.22 | −0.003 |
| 4030 | May 4, 2012 | 12:57:55 PM | 14.22 | 3.999 | 4.4688 | 3.555 | 56.866 | 0.079 | 65.79 | 14.270 | 3.9990 | 57.066 | 0.079 | 66.02 | 14.22 | −0.002 |
| 4035 | May 4, 2012 | 12:58:00 PM | 14.22 | 3.999 | 4.4743 | 3.555 | 56.866 | 0.079 | 65.87 | 14.270 | 3.9990 | 57.066 | 0.079 | 66.10 | 14.22 | −0.001 |
| 4040 | May 4, 2012 | 12:58:05 PM | 14.22 | 3.999 | 4.4798 | 3.555 | 56.866 | 0.079 | 65.95 | 14.270 | 3.9990 | 57.066 | 0.079 | 66.18 | 14.22 | 0.000 |
| 4045 | May 4, 2012 | 12:58:10 PM | 14.22 | 3.999 | 4.4854 | 3.555 | 56.866 | 0.079 | 66.03 | 14.270 | 3.9990 | 57.066 | 0.079 | 66.26 | 14.22 | 0.000 |
| 4050 | May 4, 2012 | 12:58:15 PM | 14.22 | 3.999 | 4.4909 | 3.555 | 56.866 | 0.079 | 66.11 | 14.270 | 3.9990 | 57.066 | 0.079 | 66.33 | 14.22 | 0.000 |
| 4055 | May 4, 2012 | 12:58:20 PM | 14.22 | 3.999 | 4.4965 | 3.555 | 56.866 | 0.079 | 66.19 | 14.270 | 3.9990 | 57.066 | 0.079 | 66.41 | 14.22 | 0.001 |
| 4060 | May 4, 2012 | 12:58:25 PM | 14.22 | 3.999 | 4.5020 | 3.555 | 56.866 | 0.079 | 66.27 | 14.270 | 3.9990 | 57.066 | 0.079 | 66.49 | 14.22 | 0.002 |
| 4065 | May 4, 2012 | 12:58:30 PM | 14.22 | 3.999 | 4.5075 | 3.555 | 56.866 | 0.079 | 66.35 | 14.270 | 3.9990 | 57.066 | 0.079 | 66.57 | 14.22 | 0.003 |
| 4070 | May 4, 2012 | 12:58:35 PM | 14.22 | 3.999 | 4.5131 | 3.555 | 56.866 | 0.079 | 66.43 | 14.270 | 3.9990 | 57.066 | 0.079 | 66.65 | 14.22 | 0.004 |
| 4075 | May 4, 2012 | 12:58:40 PM | 14.22 | 3.999 | 4.5186 | 3.555 | 56.866 | 0.079 | 66.50 | 14.270 | 3.9990 | 57.066 | 0.079 | 66.73 | 14.22 | 0.005 |
| 4080 | May 4, 2012 | 12:58:45 PM | 14.21 | 3.999 | 4.5242 | 3.553 | 56.826 | 0.079 | 66.58 | 14.260 | 3.9990 | 57.026 | 0.079 | 66.81 | 14.21 | −0.005 |
| 4085 | May 4, 2012 | 12:58:50 PM | 14.21 | 3.999 | 4.5297 | 3.553 | 56.826 | 0.079 | 66.66 | 14.260 | 3.9990 | 57.026 | 0.079 | 66.89 | 14.21 | −0.004 |
| 4090 | May 4, 2012 | 12:58:55 PM | 14.21 | 3.999 | 4.5353 | 3.553 | 56.826 | 0.079 | 66.74 | 14.260 | 3.9990 | 57.026 | 0.079 | 66.97 | 14.21 | −0.003 |
| 4095 | May 4, 2012 | 12:59:00 PM | 14.21 | 3.999 | 4.5408 | 3.553 | 56.826 | 0.079 | 66.82 | 14.260 | 3.9990 | 57.026 | 0.079 | 67.05 | 14.21 | −0.002 |
| 4100 | May 4, 2012 | 12:59:05 PM | 14.21 | 3.999 | 4.5464 | 3.553 | 56.826 | 0.079 | 66.90 | 14.260 | 3.9990 | 57.026 | 0.079 | 67.13 | 14.21 | −0.001 |
| 4105 | May 4, 2012 | 12:59:10 PM | 14.21 | 3.999 | 4.5519 | 3.553 | 56.826 | 0.079 | 66.98 | 14.260 | 3.9990 | 57.026 | 0.079 | 67.21 | 14.21 | 0.000 |
| 4110 | May 4, 2012 | 12:59:15 PM | 14.21 | 3.999 | 4.5575 | 3.553 | 56.826 | 0.079 | 67.06 | 14.260 | 3.9990 | 57.026 | 0.079 | 67.29 | 14.21 | 0.000 |
| 4115 | May 4, 2012 | 12:59:20 PM | 14.21 | 3.999 | 4.5630 | 3.553 | 56.826 | 0.079 | 67.14 | 14.260 | 3.9990 | 57.026 | 0.079 | 67.36 | 14.21 | 0.000 |
| 4120 | May 4, 2012 | 12:59:25 PM | 14.21 | 3.999 | 4.5685 | 3.553 | 56.826 | 0.079 | 67.21 | 14.260 | 3.9990 | 57.026 | 0.079 | 67.44 | 14.21 | 0.000 |
| 4125 | May 4, 2012 | 12:59:30 PM | 14.21 | 3.999 | 4.5741 | 3.553 | 56.826 | 0.079 | 67.29 | 14.260 | 3.9990 | 57.026 | 0.079 | 67.52 | 14.21 | 0.000 |
| 4130 | May 4, 2012 | 12:59:35 PM | 14.21 | 3.999 | 4.5796 | 3.553 | 56.826 | 0.079 | 67.37 | 14.260 | 3.9990 | 57.026 | 0.079 | 67.60 | 14.21 | 0.001 |
| 4135 | May 4, 2012 | 12:59:40 PM | 14.21 | 3.999 | 4.5852 | 3.553 | 56.826 | 0.079 | 67.45 | 14.260 | 3.9990 | 57.026 | 0.079 | 67.68 | 14.21 | 0.002 |
| 4140 | May 4, 2012 | 12:59:45 PM | 14.21 | 3.999 | 4.5907 | 3.553 | 56.826 | 0.079 | 67.53 | 14.260 | 3.9990 | 57.026 | 0.079 | 67.76 | 14.21 | 0.003 |
| 4145 | May 4, 2012 | 12:59:50 PM | 14.21 | 3.999 | 4.5963 | 3.553 | 56.826 | 0.079 | 67.61 | 14.260 | 3.9990 | 57.026 | 0.079 | 67.84 | 14.21 | 0.004 |
| 4150 | May 4, 2012 | 12:59:55 PM | 14.21 | 3.999 | 4.6018 | 3.550 | 56.826 | 0.079 | 67.69 | 14.260 | 3.9990 | 57.026 | 0.079 | 67.92 | 14.21 | 0.005 |
| 4155 | May 4, 2012 | 1:00:00 PM | 14.20 | 3.999 | 4.6074 | 3.550 | 56.786 | 0.079 | 67.77 | 14.250 | 3.9990 | 56.986 | 0.079 | 68.00 | 14.20 | −0.005 |
| 4160 | May 4, 2012 | 1:00:05 PM | 14.20 | 3.999 | 4.6129 | 3.550 | 56.786 | 0.079 | 67.85 | 14.250 | 3.9990 | 56.986 | 0.079 | 68.08 | 14.20 | −0.004 |
| 4165 | May 4, 2012 | 1:00:10 PM | 14.20 | 3.999 | 4.6184 | 3.550 | 56.786 | 0.079 | 67.93 | 14.250 | 3.9990 | 56.986 | 0.079 | 68.16 | 14.20 | −0.003 |
| 4170 | May 4, 2012 | 1:00:15 PM | 14.20 | 3.999 | 4.6240 | 3.550 | 56.786 | 0.079 | 68.00 | 14.250 | 3.9990 | 56.986 | 0.079 | 68.24 | 14.20 | −0.002 |
| 4175 | May 4, 2012 | 1:00:20 PM | 14.20 | 3.999 | 4.6295 | 3.550 | 56.786 | 0.079 | 68.08 | 14.250 | 3.9990 | 56.986 | 0.079 | 68.31 | 14.20 | −0.001 |
| 4180 | May 4, 2012 | 1:00:25 PM | 14.20 | 3.999 | 4.6351 | 3.550 | 56.786 | 0.079 | 68.16 | 14.250 | 3.9990 | 56.986 | 0.079 | 68.39 | 14.20 | 0.000 |
| 4185 | May 4, 2012 | 1:00:30 PM | 14.20 | 3.999 | 4.6406 | 3.550 | 56.786 | 0.079 | 68.24 | 14.250 | 3.9990 | 56.986 | 0.079 | 68.47 | 14.20 | 0.000 |
| 4190 | May 4, 2012 | 1:00:35 PM | 14.20 | 3.999 | 4.6462 | 3.550 | 56.786 | 0.079 | 68.32 | 14.250 | 3.9990 | 56.986 | 0.079 | 68.55 | 14.20 | 0.001 |
| 4195 | May 4, 2012 | 1:00:40 PM | 14.20 | 3.999 | 4.6517 | 3.550 | 56.786 | 0.079 | 68.40 | 14.250 | 3.9990 | 56.986 | 0.079 | 68.63 | 14.20 | 0.001 |
| 4200 | May 4, 2012 | 1:00:45 PM | 14.20 | 3.999 | 4.6573 | 3.550 | 56.786 | 0.079 | 68.48 | 14.250 | 3.9990 | 56.986 | 0.079 | 68.71 | 14.20 | 0.002 |
| 4205 | May 4, 2012 | 1:00:50 PM | 14.20 | 3.999 | 4.6628 | 3.550 | 56.786 | 0.079 | 68.56 | 14.240 | 3.9990 | 56.986 | 0.079 | 68.79 | 14.20 | 0.003 |
| 4210 | May 4, 2012 | 1:00:55 PM | 14.20 | 3.999 | 4.6683 | 3.550 | 56.786 | 0.079 | 68.63 | 14.250 | 3.9990 | 56.986 | 0.079 | 68.87 | 14.20 | 0.004 |
| 4215 | May 4, 2012 | 1:01:00 PM | 14.19 | 3.999 | 4.6739 | 3.550 | 56.746 | 0.079 | 68.71 | 14.240 | 3.9990 | 56.946 | 0.079 | 68.95 | 14.20 | −0.005 |
| 4220 | May 4, 2012 | 1:01:05 PM | 14.20 | 3.999 | 4.6794 | 3.548 | 56.746 | 0.079 | 68.79 | 14.240 | 3.9990 | 56.946 | 0.079 | 69.03 | 14.19 | 0.005 |
| 4225 | May 4, 2012 | 1:01:10 PM | 14.19 | 3.999 | 4.6850 | 3.548 | 56.746 | 0.079 | 68.87 | 14.240 | 3.9990 | 56.946 | 0.079 | 69.11 | 14.19 | −0.004 |
| 4230 | May 4, 2012 | 1:01:15 PM | 14.19 | 3.999 | 4.6905 | 3.548 | 56.746 | 0.079 | 68.95 | 14.240 | 3.9990 | 56.946 | 0.079 | 69.19 | 14.19 | −0.003 |
| 4235 | May 4, 2012 | 1:01:20 PM | 14.19 | 3.999 | 4.6961 | 3.548 | 56.746 | 0.079 | 69.03 | 14.240 | 3.9990 | 56.946 | 0.079 | 69.26 | 14.19 | −0.002 |
| 4240 | May 4, 2012 | 1:01:25 PM | 14.19 | 3.999 | 4.7016 | 3.548 | 56.746 | 0.079 | 69.11 | 14.240 | 3.9990 | 56.946 | 0.079 | 69.34 | 14.19 | −0.001 |
| 4245 | May 4, 2012 | 1:01:30 PM | 14.19 | 3.999 | 4.7072 | 3.548 | 56.746 | 0.079 | 69.19 | 14.240 | 3.9990 | 56.946 | 0.079 | 69.42 | 14.19 | −0.001 |
| 4250 | May 4, 2012 | 1:01:35 PM | 14.19 | 3.999 | 4.7127 | 3.548 | 56.746 | 0.079 | 69.27 | 14.240 | 3.9990 | 56.946 | 0.079 | 69.50 | 14.19 | 0.000 |
| 4255 | May 4, 2012 | 1:01:40 PM | 14.19 | 3.999 | 4.7182 | 3.548 | 56.746 | 0.079 | 69.34 | 14.240 | 3.9990 | 56.946 | 0.079 | 69.58 | 14.19 | 0.000 |
| 4260 | May 4, 2012 | 1:01:45 PM | 14.19 | 3.999 | 4.7238 | 3.548 | 56.746 | 0.079 | 69.42 | 14.240 | 3.9990 | 56.946 | 0.079 | 69.66 | 14.19 | 0.001 |
| 4265 | May 4, 2012 | 1:01:50 PM | 14.19 | 3.999 | 4.7293 | 3.548 | 56.746 | 0.079 | 69.50 | 14.240 | 3.9990 | 56.946 | 0.079 | 69.74 | 14.19 | 0.002 |
| 4270 | May 4, 2012 | 1:01:55 PM | 14.19 | 3.999 | 4.7349 | 3.548 | 56.746 | 0.079 | 69.58 | 14.240 | 3.9990 | 56.946 | 0.079 | 69.82 | 14.19 | 0.003 |
| 4275 | May 4, 2012 | 1:02:00 PM | 14.19 | 3.999 | 4.7404 | 3.548 | 56.746 | 0.079 | 69.66 | 14.240 | 3.9990 | 56.946 | 0.079 | 69.90 | 14.19 | 0.004 |
| 4280 | May 4, 2012 | 1:02:05 PM | 14.19 | 3.999 | 4.7460 | 3.548 | 56.746 | 0.079 | 69.74 | 14.240 | 3.9990 | 56.946 | 0.079 | 69.98 | 14.19 | 0.005 |
| 4285 | May 4, 2012 | 1:02:10 PM | 14.18 | 3.999 | 4.7515 | 3.545 | 56.706 | 0.079 | 69.82 | 14.230 | 3.9990 | 56.906 | 0.079 | 70.06 | 14.18 | −0.005 |
| 4290 | May 4, 2012 | 1:02:15 PM | 14.18 | 3.999 | 4.7571 | 3.545 | 56.706 | 0.079 | 69.90 | 14.230 | 3.9990 | 56.906 | 0.079 | 70.13 | 14.18 | −0.004 |
| 4295 | May 4, 2012 | 1:02:20 PM | 14.18 | 3.999 | 4.7626 | 3.545 | 56.706 | 0.079 | 69.97 | 14.230 | 3.9990 | 56.906 | 0.079 | 70.21 | 14.18 | −0.003 |
| 4300 | May 4, 2012 | 1:02:25 PM | 14.18 | 3.999 | 4.7682 | 3.545 | 56.706 | 0.079 | 70.05 | 14.230 | 3.9990 | 56.906 | 0.079 | 70.29 | 14.18 | −0.002 |
| 4305 | May 4, 2012 | 1:02:30 PM | 14.18 | 3.999 | 4.7737 | 3.545 | 56.706 | 0.079 | 70.13 | 14.230 | 3.9990 | 56.906 | 0.079 | 70.37 | 14.18 | 0.000 |
| 4310 | May 4, 2012 | 1:02:35 PM | 14.18 | 3.999 | 4.7793 | 3.545 | 56.706 | 0.079 | 70.21 | 14.230 | 3.9990 | 56.906 | 0.079 | 70.45 | 14.18 | 0.002 |
| 4315 | May 4, 2012 | 1:02:40 PM | 14.18 | 3.999 | 4.7848 | 3.545 | 56.706 | 0.079 | 70.29 | 14.230 | 3.9990 | 56.906 | 0.079 | 70.53 | 14.18 | 0.003 |
| 4320 | May 4, 2012 | 1:02:45 PM | 14.18 | 3.999 | 4.7904 | 3.545 | 56.706 | 0.079 | 70.37 | 14.230 | 3.9990 | 56.906 | 0.079 | 70.61 | 14.18 | 0.004 |
| 4325 | May 4, 2012 | 1:02:50 PM | 14.18 | 3.999 | 4.7959 | 3.545 | 56.706 | 0.079 | 70.45 | 14.230 | 3.9990 | 56.906 | 0.079 | 70.69 | 14.18 | 0.005 |
| 4330 | May 4, 2012 | 1:02:55 PM | 14.17 | 3.999 | 4.8016 | 3.543 | 56.666 | 0.079 | 70.53 | 14.220 | 3.9990 | 56.866 | 0.079 | 70.77 | 14.17 | −0.005 |
| 4335 | May 4, 2012 | 1:03:00 PM | 14.17 | 3.999 | 4.8072 | 3.543 | 56.666 | 0.079 | 70.60 | 14.220 | 3.9990 | 56.866 | 0.079 | 70.85 | 14.17 | −0.004 |
| 4340 | May 4, 2012 | 1:03:05 PM | 14.17 | 3.999 | 4.8127 | 3.543 | 56.666 | 0.079 | 70.68 | 14.220 | 3.9990 | 56.866 | 0.079 | 70.92 | 14.17 | −0.003 |
| 4345 | May 4, 2012 | 1:03:10 PM | 14.17 | 3.999 | 4.8183 | 3.543 | 56.666 | 0.079 | 70.76 | 14.220 | 3.9990 | 56.866 | 0.079 | 71.00 | 14.17 | −0.002 |
| 4350 | May 4, 2012 | 1:03:15 PM | 14.17 | 3.999 | 4.8238 | 3.543 | 56.666 | 0.079 | 70.84 | 14.220 | 3.9990 | 56.866 | 0.079 | 71.08 | 14.17 | −0.001 |
| 4355 | May 4, 2012 | 1:03:20 PM | 14.17 | 3.999 | 4.8294 | 3.543 | 56.666 | 0.079 | 70.92 | 14.220 | 3.9990 | 56.866 | 0.079 | 71.16 | 14.17 | 0.000 |
| 4360 | May 4, 2012 | 1:03:25 PM | 14.17 | 3.999 | 4.8349 | 3.543 | 56.666 | 0.079 | 71.00 | 14.220 | 3.9990 | 56.866 | 0.079 | 71.24 | 14.17 | 0.001 |
| 4365 | May 4, 2012 | 1:03:30 PM | 14.17 | 3.999 | 4.8404 | 3.543 | 56.666 | 0.079 | 71.08 | 14.220 | 3.9990 | 56.866 | 0.079 | 71.32 | 14.17 | 0.002 |
| 4370 | May 4, 2012 | 1:03:35 PM | 14.17 | 3.999 | 4.8460 | 3.543 | 56.666 | 0.079 | 71.16 | 14.220 | 3.9990 | 56.866 | 0.079 | 71.40 | 14.17 | 0.003 |
| 4375 | May 4, 2012 | 1:03:40 PM | 14.17 | 3.999 | 4.8515 | 3.543 | 56.666 | 0.079 | 71.23 | 14.220 | 3.9990 | 56.866 | 0.079 | 71.48 | 14.17 | 0.004 |
| 4380 | May 4, 2012 | 1:03:45 PM | 14.17 | 3.999 | 4.8571 | 3.543 | 56.666 | 0.079 | 71.31 | 14.220 | 3.9990 | 56.866 | 0.079 | 71.56 | 14.17 | 0.005 |
| 4385 | May 4, 2012 | 1:03:50 PM | 14.16 | 3.999 | 4.8626 | 3.540 | 56.626 | 0.079 | 71.39 | 14.210 | 3.9990 | 56.826 | 0.079 | 71.64 | 14.16 | −0.005 |
| 4390 | May 4, 2012 | 1:03:55 PM | 14.16 | 3.999 | 4.8682 | 3.540 | 56.626 | 0.079 | 71.47 | 14.210 | 3.9990 | 56.826 | 0.079 | 71.71 | 14.16 | −0.004 |
| 4395 | May 4, 2012 | 1:04:00 PM | 14.16 | 3.999 | 4.8737 | 3.540 | 56.626 | 0.079 | 71.55 | 14.210 | 3.9990 | 56.826 | 0.079 | 71.79 | 14.16 | −0.003 |
| 4400 | May 4, 2012 | 1:04:05 PM | 14.16 | 3.999 | 4.8792 | 3.540 | 56.626 | 0.079 | 71.63 | 14.210 | 3.9990 | 56.826 | 0.079 | 71.87 | 14.16 | −0.002 |
| 4405 | May 4, 2012 | 1:04:10 PM | 14.16 | 3.999 | 4.8848 | 3.540 | 56.626 | 0.079 | 71.71 | 14.210 | 3.9990 | 56.826 | 0.079 | 71.95 | 14.16 | −0.001 |
| 4410 | May 4, 2012 | 1:04:15 PM | 14.16 | 3.999 | 4.8903 | 3.540 | 56.626 | 0.079 | 71.78 | 14.210 | 3.9990 | 56.826 | 0.079 | 72.03 | 14.16 | 0.001 |
| 4415 | May 4, 2012 | 1:04:20 PM | 14.16 | 3.999 | 4.8959 | 3.540 | 56.626 | 0.079 | 71.86 | 14.210 | 3.9990 | 56.826 | 0.079 | 72.11 | 14.16 | 0.002 |
| 4420 | May 4, 2012 | 1:04:25 PM | 14.16 | 3.999 | 4.9014 | 3.540 | 56.626 | 0.079 | 71.94 | 14.210 | 3.9990 | 56.826 | 0.079 | 72.19 | 14.16 | 0.003 |
| 4425 | May 4, 2012 | 1:04:30 PM | 14.16 | 3.999 | 4.9070 | 3.540 | 56.626 | 0.079 | 72.02 | 14.210 | 3.9990 | 56.826 | 0.079 | 72.27 | 14.16 | 0.004 |
| 4430 | May 4, 2012 | 1:04:35 PM | 14.16 | 3.999 | 4.9124 | 3.540 | 56.626 | 0.079 | 72.10 | 14.210 | 3.9990 | 56.826 | 0.079 | 72.35 | 14.16 | 0.005 |
| 4435 | May 4, 2012 | 1:04:40 PM | 14.15 | 3.999 | 4.9180 | 3.538 | 56.586 | 0.079 | 72.18 | 14.200 | 3.9990 | 56.786 | 0.079 | 72.42 | 14.15 | −0.005 |
| 4440 | May 4, 2012 | 1:04:45 PM | 14.15 | 3.999 | 4.9235 | 3.538 | 56.586 | 0.079 | 72.26 | 14.200 | 3.9990 | 56.786 | 0.079 | 72.50 | 14.15 | −0.004 |
| 4445 | May 4, 2012 | 1:04:50 PM | 14.15 | 3.999 | 4.9291 | 3.538 | 56.586 | 0.079 | 72.34 | 14.200 | 3.9990 | 56.786 | 0.079 | 72.58 | 14.15 | −0.003 |
| 4450 | May 4, 2012 | 1:04:55 PM | 14.15 | 3.999 | 4.9346 | 3.538 | 56.586 | 0.079 | 72.41 | 14.200 | 3.9990 | 56.786 | 0.079 | 72.66 | 14.15 | −0.002 |
| 4455 | May 4, 2012 | 1:05:00 PM | 14.15 | 3.999 | 4.9401 | 3.538 | 56.586 | 0.079 | 72.49 | 14.200 | 3.9990 | 56.786 | 0.079 | 72.94 | 14.15 | −0.001 |
| 4460 | May 4, 2012 | 1:05:05 PM | 14.15 | 3.999 | 4.9457 | 3.538 | 56.586 | 0.079 | 72.57 | 14.200 | 3.9990 | 56.786 | 0.079 | 72.82 | 14.15 | 0.000 |
| 4465 | May 4, 2012 | 1:05:10 PM | 14.15 | 3.999 | 4.9512 | 3.538 | 56.586 | 0.079 | 72.65 | 14.200 | 3.9990 | 56.786 | 0.079 | 72.90 | 14.15 | 0.001 |
| 4470 | May 4, 2012 | 1:05:15 PM | 14.15 | 3.999 | 4.9568 | 3.538 | 56.586 | 0.079 | 72.73 | 14.200 | 3.9990 | 56.786 | 0.079 | 72.98 | 14.15 | 0.002 |
| 4475 | May 4, 2012 | 1:05:20 PM | 14.15 | 3.999 | 4.9622 | 3.538 | 56.586 | 0.079 | 72.81 | 14.200 | 3.9990 | 56.786 | 0.079 | 73.06 | 14.15 | 0.003 |
| 4480 | May 4, 2012 | 1:05:25 PM | 14.15 | 3.999 | 4.9677 | 3.538 | 56.586 | 0.079 | 72.89 | 14.200 | 3.9990 | 56.786 | 0.079 | 73.13 | 14.15 | 0.004 |
| 4485 | May 4, 2012 | 1:05:30 PM | 14.15 | 3.999 | 4.9733 | 3.538 | 56.586 | 0.079 | 72.96 | 14.200 | 3.9990 | 56.786 | 0.079 | 73.21 | 14.15 | 0.005 |
| 4490 | May 4, 2012 | 1:05:35 PM | 14.14 | 3.999 | 4.9788 | 3.535 | 56.546 | 0.079 | 73.04 | 14.190 | 3.9990 | 56.746 | 0.079 | 73.29 | 14.14 | −0.005 |
| 4495 | May 4, 2012 | 1:05:40 PM | 14.14 | 3.999 | 4.9843 | 3.535 | 56.546 | 0.079 | 73.12 | 14.190 | 3.9990 | 56.746 | 0.079 | 73.37 | 14.14 | −0.004 |
| 4500 | May 4, 2012 | 1:05:45 PM | 14.14 | 3.999 | 4.9899 | 3.535 | 56.546 | 0.079 | 73.20 | 14.190 | 3.9990 | 56.746 | 0.079 | 73.45 | 14.14 | −0.003 |
| 4505 | May 4, 2012 | 1:05:50 PM | 14.14 | 3.999 | 4.9954 | 3.535 | 56.546 | 0.079 | 73.28 | 14.190 | 3.9990 | 56.746 | 0.079 | 73.53 | 14.14 | −0.002 |
| 4510 | May 4, 2012 | 1:05:55 PM | 14.14 | 3.999 | 5.0010 | 3.535 | 56.546 | 0.079 | 73.36 | 14.190 | 3.9990 | 56.746 | 0.079 | 73.61 | 14.14 | −0.001 |
| 4515 | May 4, 2012 | 1:06:00 PM | 14.14 | 3.999 | 5.0065 | 3.535 | 56.546 | 0.079 | 73.44 | 14.190 | 3.9990 | 56.746 | 0.079 | 73.69 | 14.14 | 0.001 |
| 4520 | May 4, 2012 | 1:06:05 PM | 14.14 | 3.999 | 5.0121 | 3.535 | 56.546 | 0.079 | 73.51 | 14.190 | 3.9990 | 56.746 | 0.079 | 73.76 | 14.14 | 0.002 |
| 4525 | May 4, 2012 | 1:06:10 PM | 14.14 | 3.999 | 5.0176 | 3.535 | 56.546 | 0.079 | 73.59 | 14.190 | 3.9990 | 56.746 | 0.079 | 73.84 | 14.14 | 0.003 |
| 4530 | May 4, 2012 | 1:06:15 PM | 14.14 | 3.999 | 5.0231 | 3.535 | 56.546 | 0.079 | 73.67 | 14.190 | 3.9990 | 56.746 | 0.079 | 73.92 | 14.14 | 0.004 |
| 4535 | May 4, 2012 | 1:06:20 PM | 14.14 | 3.999 | 5.0287 | 3.535 | 56.546 | 0.079 | 73.75 | 14.190 | 3.9990 | 56.746 | 0.079 | 74.00 | 14.14 | 0.005 |
| 4540 | May 4, 2012 | 1:06:25 PM | 14.13 | 3.999 | 5.0342 | 3.533 | 56.506 | 0.079 | 73.83 | 14.180 | 3.9990 | 56.706 | 0.079 | 74.08 | 14.13 | −0.005 |
| 4545 | May 4, 2012 | 1:06:30 PM | 14.13 | 3.999 | 5.0398 | 3.533 | 56.506 | 0.079 | 73.91 | 14.180 | 3.9990 | 56.706 | 0.079 | 74.16 | 14.13 | −0.004 |
| 4550 | May 4, 2012 | 1:06:35 PM | 14.13 | 3.999 | 5.0453 | 3.533 | 56.506 | 0.079 | 73.98 | 14.180 | 3.9990 | 56.706 | 0.079 | 74.24 | 14.13 | −0.003 |
| 4555 | May 4, 2012 | 1:06:40 PM | 14.13 | 3.999 | 5.0509 | 3.533 | 56.506 | 0.079 | 74.06 | 14.180 | 3.9990 | 56.706 | 0.079 | 74.32 | 14.13 | −0.002 |
| 4560 | May 4, 2012 | 1:06:45 PM | 14.13 | 3.999 | 5.0564 | 3.533 | 56.506 | 0.079 | 74.14 | 14.180 | 3.9990 | 56.706 | 0.079 | 74.39 | 14.13 | 0.000 |
| 4565 | May 4, 2012 | 1:06:50 PM | 14.13 | 3.999 | 5.0619 | 3.533 | 56.506 | 0.079 | 74.22 | 14.180 | 3.9990 | 56.706 | 0.079 | 74.47 | 14.13 | 0.002 |
| 4570 | May 4, 2012 | 1:06:55 PM | 14.13 | 3.999 | 5.0675 | 3.533 | 56.506 | 0.079 | 74.30 | 14.180 | 3.9990 | 56.706 | 0.079 | 74.55 | 14.13 | 0.003 |
| 4575 | May 4, 2012 | 1:07:00 PM | 14.13 | 3.999 | 5.0730 | 3.533 | 56.506 | 0.079 | 74.38 | 14.180 | 3.9990 | 56.706 | 0.079 | 74.63 | 14.13 | 0.004 |
| 4580 | May 4, 2012 | 1:07:05 PM | 14.13 | 3.999 | 5.0786 | 3.533 | 56.506 | 0.079 | 74.46 | 14.180 | 3.9990 | 56.706 | 0.079 | 74.71 | 14.13 | 0.005 |
| 4585 | May 4, 2012 | 1:07:10 PM | 14.12 | 3.999 | 5.0838 | 3.530 | 56.466 | 0.079 | 74.53 | 14.170 | 3.9990 | 56.666 | 0.079 | 74.79 | 14.12 | −0.005 |
| 4590 | May 4, 2012 | 1:07:15 PM | 14.12 | 3.999 | 5.0896 | 3.530 | 56.466 | 0.079 | 74.61 | 14.170 | 3.9990 | 56.666 | 0.079 | 74.87 | 14.12 | −0.004 |
| 4595 | May 4, 2012 | 1:07:20 PM | 14.12 | 3.999 | 5.0952 | 3.530 | 56.466 | 0.079 | 74.69 | 14.170 | 3.9990 | 56.666 | 0.079 | 74.95 | 14.12 | −0.003 |
| 4600 | May 4, 2012 | 1:07:25 PM | 14.12 | 3.999 | 5.1007 | 3.530 | 56.466 | 0.079 | 74.77 | 14.170 | 3.9990 | 56.666 | 0.079 | 75.02 | 14.12 | −0.002 |
| 4605 | May 4, 2012 | 1:07:30 PM | 14.12 | 3.999 | 5.1063 | 3.530 | 56.466 | 0.079 | 74.85 | 14.170 | 3.9990 | 56.666 | 0.079 | 75.10 | 14.12 | 0.000 |
| 4610 | May 4, 2012 | 1:07:35 PM | 14.12 | 3.999 | 5.1118 | 3.530 | 56.466 | 0.079 | 74.93 | 14.170 | 3.9990 | 56.666 | 0.079 | 75.18 | 14.12 | 0.002 |
| 4615 | May 4, 2012 | 1:07:40 PM | 14.12 | 3.999 | 5.1174 | 3.530 | 56.466 | 0.079 | 75.00 | 14.170 | 3.9990 | 56.666 | 0.079 | 75.26 | 14.12 | 0.003 |
| 4620 | May 4, 2012 | 1:07:45 PM | 14.12 | 3.999 | 5.1229 | 3.530 | 56.466 | 0.079 | 75.08 | 14.170 | 3.9990 | 56.666 | 0.079 | 75.34 | 14.12 | 0.004 |
| 4625 | May 4, 2012 | 1:07:50 PM | 14.12 | 3.999 | 5.1284 | 3.530 | 56.466 | 0.079 | 75.16 | 14.170 | 3.9990 | 56.666 | 0.079 | 75.42 | 14.12 | −0.005 |
| 4630 | May 4, 2012 | 1:07:55 PM | 14.11 | 3.999 | 5.1340 | 3.528 | 56.426 | 0.079 | 75.24 | 14.160 | 3.9990 | 56.626 | 0.079 | 75.50 | 14.12 | 0.005 |
| 4635 | May 4, 2012 | 1:08:00 PM | 14.11 | 3.999 | 5.1395 | 3.528 | 56.426 | 0.079 | 75.32 | 14.160 | 3.9990 | 56.626 | 0.079 | 75.58 | 14.11 | −0.004 |
| 4640 | May 4, 2012 | 1:08:05 PM | 14.11 | 3.999 | 5.1451 | 3.528 | 56.426 | 0.079 | 75.40 | 14.160 | 3.9990 | 56.626 | 0.079 | 75.65 | 14.11 | −0.003 |
| 4645 | May 4, 2012 | 1:08:10 PM | 14.11 | 3.999 | 5.1506 | 3.528 | 56.426 | 0.079 | 75.47 | 14.160 | 3.9990 | 56.626 | 0.079 | 75.73 | 14.11 | −0.001 |
| 4650 | May 4, 2012 | 1:08:15 PM | 14.11 | 3.999 | 5.1562 | 3.528 | 56.426 | 0.079 | 75.55 | 14.160 | 3.9990 | 56.626 | 0.079 | 75.81 | 14.11 | 0.001 |
| 4655 | May 4, 2012 | 1:08:20 PM | 14.11 | 3.999 | 5.1617 | 3.528 | 56.426 | 0.079 | 75.63 | 14.160 | 3.9990 | 56.626 | 0.079 | 75.89 | 14.11 | 0.003 |
| 4660 | May 4, 2012 | 1:08:25 PM | 14.11 | 3.999 | 5.1672 | 3.528 | 56.426 | 0.079 | 75.71 | 14.160 | 3.9990 | 56.626 | 0.079 | 75.97 | 14.11 | 0.004 |
| 4665 | May 4, 2012 | 1:08:30 PM | 14.11 | 3.999 | 5.1728 | 3.528 | 56.426 | 0.079 | 75.79 | 14.160 | 3.9990 | 56.626 | 0.079 | 76.05 | 14.11 | 0.005 |
| 4670 | May 4, 2012 | 1:08:35 PM | 14.10 | 3.999 | 5.1783 | 3.525 | 56.386 | 0.079 | 75.87 | 14.150 | 3.9990 | 56.586 | 0.079 | 76.13 | 14.10 | −0.005 |
| 4675 | May 4, 2012 | 1:08:40 PM | 14.10 | 3.999 | 5.1839 | 3.525 | 56.386 | 0.079 | 75.94 | 14.150 | 3.9990 | 56.586 | 0.079 | 76.20 | 14.10 | −0.004 |
| 4680 | May 4, 2012 | 1:08:45 PM | 14.10 | 3.999 | 5.1894 | 3.525 | 56.386 | 0.079 | 76.02 | 14.150 | 3.9990 | 56.586 | 0.079 | 76.28 | 14.10 | −0.003 |
| 4685 | May 4, 2012 | 1:08:50 PM | 14.10 | 3.999 | 5.1950 | 3.525 | 56.386 | 0.079 | 76.10 | 14.150 | 3.9990 | 56.586 | 0.079 | 76.36 | 14.10 | −0.001 |
| 4690 | May 4, 2012 | 1:08:55 PM | 14.10 | 3.999 | 5.2005 | 3.525 | 56.386 | 0.079 | 76.18 | 14.150 | 3.9990 | 56.586 | 0.079 | 76.44 | 14.10 | 0.001 |
| 4695 | May 4, 2012 | 1:09:00 PM | 14.10 | 3.999 | 5.2060 | 3.525 | 56.386 | 0.079 | 76.26 | 14.150 | 3.9990 | 56.586 | 0.079 | 76.52 | 14.10 | 0.003 |
| 4700 | May 4, 2012 | 1:09:05 PM | 14.10 | 3.999 | 5.2116 | 3.525 | 56.386 | 0.079 | 76.34 | 14.150 | 3.9990 | 56.586 | 0.079 | 76.60 | 14.10 | 0.004 |
| 4705 | May 4, 2012 | 1:09:10 PM | 14.10 | 3.999 | 5.5171 | 3.525 | 56.386 | 0.079 | 76.41 | 14.150 | 3.9990 | 56.586 | 0.079 | 76.68 | 14.10 | 0.005 |
| 4710 | May 4, 2012 | 1:09:15 PM | 14.09 | 3.999 | 5.2227 | 3.523 | 56.346 | 0.078 | 76.49 | 14.140 | 3.9990 | 56.546 | 0.079 | 76.75 | 14.09 | −0.005 |
| 4715 | May 4, 2012 | 1:09:20 PM | 14.09 | 3.999 | 5.2282 | 3.523 | 56.346 | 0.078 | 76.57 | 14.140 | 3.9990 | 56.546 | 0.079 | 76.83 | 14.09 | −0.004 |
| 4720 | May 4, 2012 | 1:09:25 PM | 14.09 | 3.999 | 5.2338 | 3.523 | 56.346 | 0.078 | 76.65 | 14.140 | 3.9990 | 56.546 | 0.079 | 76.91 | 14.09 | −0.002 |
| 4725 | May 4, 2012 | 1:09:30 PM | 14.09 | 3.999 | 5.2393 | 3.523 | 56.346 | 0.078 | 76.73 | 14.140 | 3.9990 | 56.546 | 0.079 | 76.99 | 14.09 | 0.000 |
| 4730 | May 4, 2012 | 1:09:35 PM | 14.09 | 3.999 | 5.2448 | 3.523 | 56.346 | 0.078 | 76.81 | 14.140 | 3.9990 | 56.546 | 0.079 | 77.07 | 14.09 | 0.002 |
| 4735 | May 4, 2012 | 1:09:40 PM | 14.09 | 3.999 | 5.2504 | 3.523 | 56.346 | 0.078 | 76.88 | 14.140 | 3.9990 | 56.546 | 0.079 | 77.15 | 14.09 | 0.004 |
| 4740 | May 4, 2012 | 1:09:45 PM | 14.09 | 3.999 | 5.2559 | 3.523 | 56.346 | 0.078 | 76.96 | 14.140 | 3.9990 | 56.546 | 0.079 | 77.23 | 14.09 | 0.005 |
| 4745 | May 4, 2012 | 1:09:50 PM | 14.08 | 3.999 | 5.2615 | 3.520 | 56.306 | 0.078 | 77.04 | 14.130 | 3.9990 | 56.506 | 0.078 | 77.30 | 14.08 | −0.005 |
| 4750 | May 4, 2012 | 1:09:55 PM | 14.08 | 3.999 | 5.2670 | 3.520 | 56.306 | 0.078 | 77.12 | 14.130 | 3.9990 | 56.506 | 0.078 | 77.38 | 14.08 | −0.004 |
| 4755 | May 4, 2012 | 1:10:00 PM | 14.08 | 3.999 | 5.2726 | 3.520 | 56.306 | 0.078 | 77.20 | 14.130 | 3.9990 | 56.506 | 0.078 | 77.46 | 14.08 | −0.003 |
| 4760 | May 4, 2012 | 1:10:05 PM | 14.08 | 3.999 | 5.2781 | 3.520 | 56.306 | 0.078 | 77.28 | 14.130 | 3.9990 | 56.506 | 0.078 | 77.54 | 14.08 | −0.002 |
| 4765 | May 4, 2012 | 1:10:10 PM | 14.08 | 3.999 | 5.2837 | 3.520 | 56.306 | 0.078 | 77.35 | 14.130 | 3.9990 | 56.506 | 0.078 | 77.62 | 14.08 | 0.001 |
| 4770 | May 4, 2012 | 1:10:15 PM | 14.08 | 3.999 | 5.2892 | 3.520 | 56.306 | 0.078 | 77.43 | 14.130 | 3.9990 | 56.506 | 0.078 | 77.70 | 14.08 | 0.002 |
| 4775 | May 4, 2012 | 1:10:20 PM | 14.08 | 3.999 | 5.2947 | 3.520 | 56.306 | 0.078 | 77.51 | 14.130 | 3.9990 | 56.506 | 0.078 | 77.78 | 14.08 | 0.003 |
| 4780 | May 4, 2012 | 1:10:25 PM | 14.08 | 3.999 | 5.3003 | 3.520 | 56.306 | 0.078 | 77.59 | 14.130 | 3.9990 | 56.506 | 0.078 | 77.85 | 14.08 | 0.004 |
| 4785 | May 4, 2012 | 1:10:30 PM | 14.08 | 3.999 | 5.3058 | 3.520 | 56.306 | 0.078 | 77.67 | 14.130 | 3.9990 | 56.506 | 0.078 | 77.93 | 14.08 | 0.005 |
| 4790 | May 4, 2012 | 1:10:35 PM | 14.07 | 3.999 | 5.3114 | 3.518 | 56.266 | 0.078 | 77.74 | 14.120 | 3.9990 | 56.466 | 0.078 | 78.01 | 14.07 | −0.005 |
| 4795 | May 4, 2012 | 1:10:40 PM | 14.07 | 3.999 | 5.3169 | 3.518 | 56.266 | 0.078 | 77.82 | 14.120 | 3.9990 | 56.466 | 0.078 | 78.09 | 14.07 | −0.004 |
| 4800 | May 4, 2012 | 1:10:45 PM | 14.07 | 3.999 | 5.3225 | 3.518 | 56.266 | 0.078 | 77.90 | 14.120 | 3.9990 | 56.466 | 0.078 | 78.17 | 14.07 | −0.002 |
| 4805 | May 4, 2012 | 1:10:50 PM | 14.07 | 3.999 | 5.3280 | 3.518 | 56.266 | 0.078 | 77.98 | 14.120 | 3.9990 | 56.466 | 0.078 | 78.25 | 14.07 | 0.000 |
| 4810 | May 4, 2012 | 1:10:55 PM | 14.07 | 3.999 | 5.3335 | 3.518 | 56.266 | 0.078 | 78.06 | 14.120 | 3.9990 | 56.466 | 0.078 | 78.32 | 14.07 | 0.002 |
| 4815 | May 4, 2012 | 1:11:00 PM | 14.07 | 3.999 | 5.3391 | 3.518 | 56.266 | 0.078 | 78.14 | 14.120 | 3.9990 | 56.466 | 0.078 | 78.40 | 14.07 | 0.004 |
| 4820 | May 4, 2012 | 1:11:05 PM | 14.07 | 3.999 | 5.3446 | 3.518 | 56.266 | 0.078 | 78.21 | 14.120 | 3.9990 | 56.466 | 0.078 | 78.48 | 14.07 | 0.005 |
| 4825 | May 4, 2012 | 1:11:10 PM | 14.06 | 3.999 | 5.3502 | 3.515 | 56.266 | 0.078 | 78.29 | 14.110 | 3.9990 | 56.426 | 0.078 | 78.56 | 14.06 | −0.005 |
| 4830 | May 4, 2012 | 1:11:15 PM | 14.06 | 3.999 | 5.3557 | 3.515 | 56.266 | 0.078 | 78.37 | 14.110 | 3.9990 | 56.426 | 0.078 | 78.64 | 14.06 | −0.003 |
| 4835 | May 4, 2012 | 1:11:20 PM | 14.06 | 3.999 | 5.3613 | 3.515 | 56.266 | 0.078 | 78.45 | 14.110 | 3.9990 | 56.426 | 0.078 | 78.72 | 14.06 | −0.001 |
| 4840 | May 4, 2012 | 1:11:25 PM | 14.06 | 3.999 | 5.3669 | 3.515 | 56.266 | 0.078 | 78.53 | 14.110 | 3.9990 | 56.426 | 0.078 | 78.79 | 14.06 | 0.001 |
| 4845 | May 4, 2012 | 1:11:30 PM | 14.06 | 3.999 | 5.3724 | 3.515 | 56.266 | 0.078 | 78.60 | 14.110 | 3.9990 | 56.426 | 0.078 | 78.87 | 14.06 | 0.003 |
| 4850 | May 4, 2012 | 1:11:35 PM | 14.06 | 3.999 | 5.3779 | 3.515 | 56.266 | 0.078 | 78.68 | 14.110 | 3.9990 | 56.426 | 0.078 | 78.95 | 14.06 | 0.005 |
| 4855 | May 4, 2012 | 1:11:40 PM | 14.05 | 3.999 | 5.3834 | 3.513 | 56.186 | 0.078 | 78.76 | 14.100 | 3.9990 | 56.386 | 0.078 | 79.03 | 14.05 | −0.005 |
| 4860 | May 4, 2012 | 1:11:45 PM | 14.05 | 3.999 | 5.3890 | 3.513 | 56.186 | 0.078 | 78.84 | 14.100 | 3.9990 | 56.386 | 0.078 | 79.11 | 14.05 | −0.004 |
| 4865 | May 4, 2012 | 1:11:50 PM | 14.05 | 3.999 | 5.3945 | 3.513 | 56.186 | 0.078 | 78.92 | 14.100 | 3.9990 | 56.386 | 0.078 | 79.19 | 14.05 | −0.002 |
| 4870 | May 4, 2012 | 1:11:55 PM | 14.05 | 3.999 | 5.4001 | 3.513 | 56.186 | 0.078 | 78.99 | 14.100 | 3.9990 | 56.386 | 0.078 | 79.26 | 14.05 | 0.000 |
| 4875 | May 4, 2012 | 1:12:00 PM | 14.05 | 3.999 | 5.4056 | 3.513 | 56.186 | 0.078 | 79.07 | 14.100 | 3.9990 | 56.386 | 0.078 | 79.34 | 14.05 | 0.002 |
| 4880 | May 4, 2012 | 1:12:05 PM | 14.05 | 3.999 | 5.4111 | 3.513 | 56.186 | 0.078 | 79.15 | 14.100 | 3.9990 | 56.386 | 0.078 | 79.42 | 14.05 | 0.004 |
| 4885 | May 4, 2012 | 1:12:10 PM | 14.05 | 3.999 | 5.4167 | 3.513 | 56.186 | 0.078 | 79.23 | 14.100 | 3.9990 | 56.386 | 0.078 | 79.50 | 14.05 | 0.005 |
| 4890 | May 4, 2012 | 1:12:15 PM | 14.04 | 3.999 | 5.4222 | 3.510 | 56.146 | 0.078 | 79.31 | 14.090 | 3.9990 | 56.346 | 0.078 | 79.58 | 14.04 | −0.005 |
| 4895 | May 4, 2012 | 1:12:20 PM | 14.04 | 3.999 | 5.4278 | 3.510 | 56.146 | 0.078 | 79.38 | 14.090 | 3.9990 | 56.346 | 0.078 | 79.66 | 14.04 | −0.004 |
| 4900 | May 4, 2012 | 1:12:25 PM | 14.04 | 3.999 | 5.4333 | 3.510 | 56.146 | 0.078 | 79.46 | 14.090 | 3.9990 | 56.346 | 0.078 | 79.73 | 14.04 | −0.002 |
| 4905 | May 4, 2012 | 1:12:30 PM | 14.04 | 3.999 | 5.4389 | 3.510 | 56.146 | 0.078 | 79.54 | 14.090 | 3.9990 | 56.346 | 0.078 | 79.81 | 14.04 | 0.000 |
| 4910 | May 4, 2012 | 1:12:35 PM | 14.04 | 3.999 | 5.4444 | 3.510 | 56.146 | 0.078 | 79.62 | 14.090 | 3.9990 | 56.346 | 0.078 | 79.89 | 14.04 | 0.002 |
| 4915 | May 4, 2012 | 1:12:40 PM | 14.04 | 3.999 | 5.4500 | 3.510 | 56.146 | 0.078 | 79.70 | 14.090 | 3.9990 | 56.346 | 0.078 | 79.97 | 14.04 | 0.004 |
| 4920 | May 4, 2012 | 1:12:45 PM | 14.04 | 3.999 | 5.4555 | 3.510 | 56.146 | 0.078 | 79.77 | 14.090 | 3.9990 | 56.346 | 0.078 | 80.05 | 14.04 | 0.005 |
| 4925 | May 4, 2012 | 1:12:50 PM | 14.03 | 3.999 | 5.4610 | 3.508 | 56.106 | 0.078 | 79.85 | 14.080 | 3.9990 | 56.306 | 0.078 | 80.13 | 14.03 | −0.005 |
| 4930 | May 4, 2012 | 1:12:55 PM | 14.03 | 3.999 | 5.4666 | 3.508 | 56.106 | 0.078 | 79.93 | 14.080 | 3.9990 | 56.306 | 0.078 | 80.20 | 14.03 | −0.004 |
| 4935 | May 4, 2012 | 1:13:00 PM | 14.03 | 3.999 | 5.4721 | 3.508 | 56.106 | 0.078 | 80.01 | 14.080 | 3.9990 | 56.306 | 0.078 | 80.28 | 14.03 | −0.002 |
| 4940 | May 4, 2012 | 1:13:05 PM | 14.03 | 3.999 | 5.4777 | 3.508 | 56.106 | 0.078 | 80.09 | 14.080 | 3.9990 | 56.306 | 0.078 | 80.36 | 14.03 | 0.000 |
| 4945 | May 4, 2012 | 1:13:10 PM | 14.03 | 3.999 | 5.4832 | 3.508 | 56.106 | 0.078 | 80.16 | 14.080 | 3.9990 | 56.306 | 0.078 | 80.44 | 14.03 | 0.002 |
| 4950 | May 4, 2012 | 1:13:15 PM | 14.03 | 3.999 | 5.4888 | 3.508 | 56.106 | 0.078 | 80.24 | 14.080 | 3.9990 | 56.306 | 0.078 | 80.52 | 14.03 | 0.004 |
| 4955 | May 4, 2012 | 1:13:20 PM | 14.03 | 3.999 | 5.4943 | 3.508 | 56.106 | 0.078 | 80.32 | 14.080 | 3.9990 | 56.306 | 0.078 | 80.59 | 14.03 | 0.005 |
| 4960 | May 4, 2012 | 1:13:25 PM | 14.02 | 3.999 | 5.4999 | 3.505 | 56.066 | 0.078 | 80.40 | 14.070 | 3.9990 | 56.266 | 0.078 | 80.67 | 14.02 | −0.005 |
| 4965 | May 4, 2012 | 1:13:30 PM | 14.02 | 3.999 | 5.5054 | 3.505 | 56.066 | 0.078 | 80.48 | 14.070 | 3.9990 | 56.266 | 0.078 | 80.75 | 14.02 | −0.003 |
| 4970 | May 4, 2012 | 1:13:35 PM | 14.02 | 3.999 | 5.5110 | 3.505 | 56.066 | 0.078 | 80.55 | 14.070 | 3.9990 | 56.266 | 0.078 | 80.83 | 14.02 | −0.001 |
| 4975 | May 4, 2012 | 1:13:40 PM | 14.02 | 3.999 | 5.5165 | 3.505 | 56.066 | 0.078 | 80.63 | 14.070 | 3.9990 | 56.266 | 0.078 | 80.91 | 14.02 | 0.001 |
| 4980 | May 4, 2012 | 1:13:45 PM | 14.02 | 3.999 | 5.5221 | 3.505 | 56.066 | 0.078 | 80.71 | 14.070 | 3.9990 | 56.266 | 0.078 | 80.99 | 14.02 | 0.003 |
| 4985 | May 4, 2012 | 1:13:50 PM | 14.02 | 3.999 | 5.5276 | 3.505 | 56.066 | 0.078 | 80.78 | 14.070 | 3.9990 | 56.266 | 0.078 | 81.06 | 14.02 | 0.005 |
| 4990 | May 4, 2012 | 1:13:55 PM | 14.01 | 3.999 | 5.5332 | 3.503 | 56.026 | 0.078 | 80.86 | 14.060 | 3.9990 | 56.226 | 0.078 | 81.14 | 14.01 | −0.005 |
| 4995 | May 4, 2012 | 1:14:00 PM | 14.01 | 3.999 | 5.5387 | 3.503 | 56.026 | 0.078 | 80.94 | 14.060 | 3.9990 | 56.226 | 0.078 | 81.22 | 14.01 | −0.003 |
| 5000 | May 4, 2012 | 1:14:05 PM | 14.01 | 3.999 | 5.5442 | 3.503 | 56.026 | 0.078 | 81.02 | 14.060 | 3.9990 | 56.226 | 0.078 | 81.30 | 14.01 | −0.001 |
| 5005 | May 4, 2012 | 1:14:10 PM | 14.01 | 3.999 | 5.5498 | 3.503 | 56.026 | 0.078 | 81.10 | 14.060 | 3.9990 | 56.226 | 0.078 | 81.38 | 14.01 | 0.001 |
| 5010 | May 4, 2012 | 1:14:15 PM | 14.01 | 3.999 | 5.5553 | 3.503 | 56.026 | 0.078 | 81.18 | 14.060 | 3.9990 | 56.226 | 0.078 | 81.45 | 14.01 | 0.003 |
| 5015 | May 4, 2012 | 1:14:20 PM | 14.01 | 3.999 | 5.5609 | 3.503 | 56.026 | 0.078 | 81.25 | 14.060 | 3.9990 | 56.226 | 0.078 | 81.53 | 14.01 | 0.005 |
| 5020 | May 4, 2012 | 1:14:25 PM | 14.00 | 3.999 | 5.5664 | 3.500 | 56.986 | 0.078 | 81.33 | 14.050 | 3.9990 | 56.186 | 0.078 | 81.61 | 14.00 | −0.005 |
| 5025 | May 4, 2012 | 1:14:30 PM | 14.00 | 3.999 | 5.5720 | 3.500 | 56.986 | 0.078 | 81.41 | 14.050 | 3.9990 | 56.186 | 0.078 | 81.69 | 14.00 | −0.003 |
| 5030 | May 4, 2012 | 1:14:35 PM | 14.00 | 3.999 | 5.5775 | 3.500 | 56.986 | 0.078 | 81.49 | 14.050 | 3.9990 | 56.186 | 0.078 | 81.77 | 14.00 | −0.001 |
| 5035 | May 4, 2012 | 1:14:40 PM | 14.00 | 3.999 | 5.5831 | 3.500 | 56.986 | 0.078 | 81.56 | 14.050 | 3.9990 | 56.186 | 0.078 | 81.84 | 14.00 | 0.001 |
| 5040 | May 4, 2012 | 1:14:45 PM | 14.00 | 3.999 | 5.5886 | 3.500 | 56.986 | 0.078 | 81.64 | 14.050 | 3.9990 | 56.186 | 0.078 | 81.92 | 14.00 | 0.003 |
| 5045 | May 4, 2012 | 1:14:50 PM | 14.00 | 3.999 | 5.5942 | 3.500 | 56.986 | 0.078 | 81.72 | 14.050 | 3.9990 | 56.186 | 0.078 | 82.00 | 14.00 | 0.005 |
| 5050 | May 4, 2012 | 1:14:55 PM | 13.99 | 3.999 | 5.5997 | 3.498 | 56.946 | 0.078 | 81.80 | 14.040 | 3.9990 | 56.146 | 0.078 | 82.08 | 13.99 | −0.004 |
| 5055 | May 4, 2012 | 1:15:00 PM | 13.99 | 3.999 | 5.6052 | 3.498 | 56.946 | 0.078 | 81.88 | 14.040 | 3.9990 | 56.146 | 0.078 | 82.16 | 13.99 | −0.002 |
| 5060 | May 4, 2012 | 1:15:05 PM | 13.99 | 3.999 | 5.6108 | 3.498 | 56.946 | 0.078 | 81.95 | 14.040 | 3.9990 | 56.146 | 0.078 | 82.23 | 13.99 | 0.000 |
| 5065 | May 4, 2012 | 1:15:10 PM | 13.99 | 3.999 | 5.6165 | 3.498 | 56.946 | 0.078 | 82.03 | 14.040 | 3.9990 | 56.146 | 0.078 | 82.31 | 13.99 | 0.002 |
| 5070 | May 4, 2012 | 1:15:15 PM | 13.99 | 3.999 | 5.6220 | 3.498 | 56.946 | 0.078 | 82.11 | 14.040 | 3.9990 | 56.146 | 0.078 | 82.39 | 13.99 | 0.004 |
| 5075 | May 4, 2012 | 1:15:20 PM | 13.98 | 3.999 | 5.6276 | 3.495 | 55.906 | 0.078 | [symbol] | 14.030 | 3.9990 | 56.106 | 0.078 | 82.47 | 13.98 | −0.005 |
| 5080 | May 4, 2012 | 1:15:25 PM | 13.98 | 3.999 | 5.6331 | 3.495 | 55.906 | 0.078 | 82.26 | 14.030 | 3.9990 | 56.106 | 0.078 | 82.55 | 13.98 | −0.004 |
| 5085 | May 4, 2012 | 1:15:30 PM | 13.98 | 3.999 | 5.6387 | 3.495 | 55.906 | 0.078 | 82.34 | 14.030 | 3.9990 | 56.106 | 0.078 | 82.62 | 13.98 | −0.002 |
| 5090 | May 4, 2012 | 1:15:35 PM | 13.98 | 3.999 | 5.6442 | 3.495 | 55.906 | 0.078 | 82.42 | 14.030 | 3.9990 | 56.106 | 0.078 | 82.70 | 13.98 | 0.000 |
| 5095 | May 4, 2012 | 1:15:40 PM | 13.98 | 3.999 | 5.6498 | 3.495 | 55.906 | 0.078 | 82.50 | 14.030 | 3.9990 | 56.106 | 0.078 | 82.78 | 13.98 | 0.002 |
| 5100 | May 4, 2012 | 1:15:45 PM | 13.98 | 3.999 | 5.6553 | 3.495 | 55.906 | 0.078 | 82.57 | 14.030 | 3.9990 | 56.106 | 0.078 | 82.86 | 13.98 | 0.004 |
| 5105 | May 4, 2012 | 1:15:50 PM | 13.98 | 3.999 | 5.6609 | 3.495 | 55.906 | 0.078 | 82.65 | 14.030 | 3.9990 | 56.106 | 0.078 | 82.94 | 13.97 | 0.005 |
| 5110 | May 4, 2012 | 1:15:55 PM | 13.97 | 3.999 | 5.6664 | 3.493 | 55.866 | 0.078 | 82.73 | 14.020 | 3.9990 | 56.066 | 0.078 | 83.01 | 13.97 | −0.003 |
| 5115 | May 4, 2012 | 1:16:00 PM | 13.97 | 3.999 | 5.6720 | 3.493 | 55.866 | 0.078 | 82.81 | 14.020 | 3.9990 | 56.066 | 0.078 | 83.09 | 13.97 | −0.001 |
| 5120 | May 4, 2012 | 1:16:05 PM | 13.97 | 3.999 | 5.6775 | 3.493 | 55.866 | 0.078 | 82.89 | 14.020 | 3.9990 | 56.066 | 0.078 | 83.17 | 13.97 | 0.001 |
| 5125 | May 4, 2012 | 1:16:10 PM | 13.97 | 3.999 | 5.6830 | 3.493 | 55.866 | 0.078 | 82.96 | 14.020 | 3.9990 | 56.066 | 0.078 | 83.25 | 13.97 | 0.003 |
| 5130 | May 4, 2012 | 1:16:15 PM | 13.96 | 3.999 | 5.6886 | 3.490 | 55.826 | 0.078 | 83.04 | 14.010 | 3.9990 | 56.026 | 0.078 | 83.33 | 13.97 | −0.005 |
| 5135 | May 4, 2012 | 1:16:20 PM | 13.96 | 3.999 | 5.6941 | 3.490 | 55.826 | 0.078 | 83.12 | 14.010 | 3.9990 | 56.026 | 0.078 | 83.40 | 13.96 | −0.003 |
| 5140 | May 4, 2012 | 1:16:25 PM | 13.96 | 3.999 | 5.6997 | 3.490 | 55.826 | 0.078 | 83.20 | 14.010 | 3.9990 | 56.026 | 0.078 | 83.48 | 13.96 | −0.001 |
| 5145 | May 4, 2012 | 1:16:30 PM | 13.96 | 3.999 | 5.7052 | 3.490 | 55.826 | 0.078 | 83.27 | 14.010 | 3.9990 | 56.026 | 0.078 | 83.56 | 13.96 | 0.001 |
| 5150 | May 4, 2012 | 1:16:35 PM | 13.96 | 3.999 | 5.7108 | 3.490 | 55.826 | 0.078 | 83.35 | 14.010 | 3.9990 | 56.026 | 0.078 | 83.64 | 13.96 | 0.003 |
| 5155 | May 4, 2012 | 1:16:40 PM | 13.96 | 3.999 | 5.7163 | 3.490 | 55.826 | 0.078 | 83.43 | 14.010 | 3.9990 | 56.026 | 0.078 | 83.71 | 13.95 | 0.005 |
| 5160 | May 4, 2012 | 1:16:45 PM | 13.95 | 3.999 | 5.7219 | 3.488 | 55.786 | 0.077 | 83.51 | 14.000 | 3.9990 | 55.986 | 0.078 | 83.79 | 13.95 | −0.003 |
| 5165 | May 4, 2012 | 1:16:50 PM | 13.95 | 3.999 | 5.7275 | 3.488 | 55.786 | 0.077 | 83.58 | 14.000 | 3.9990 | 55.986 | 0.078 | 83.87 | 13.95 | −0.001 |
| 5170 | May 4, 2012 | 1:16:55 PM | 13.95 | 3.999 | 5.7330 | 3.488 | 55.786 | 0.077 | 83.66 | 14.000 | 3.9990 | 55.986 | 0.078 | 83.95 | 13.95 | 0.001 |
| 5175 | May 4, 2012 | 1:17:00 PM | 13.95 | 3.999 | 5.7385 | 3.488 | 55.786 | 0.077 | 83.74 | 14.000 | 3.9990 | 55.986 | 0.078 | 84.03 | 13.95 | 0.003 |
| 5180 | May 4, 2012 | 1:17:05 PM | 13.94 | 3.999 | 5.7441 | 3.485 | 55.746 | 0.077 | 83.82 | 13.990 | 3.9990 | 55.946 | 0.078 | 84.10 | 13.94 | −0.005 |
| 5185 | May 4, 2012 | 1:17:10 PM | 13.94 | 3.999 | 5.7496 | 3.485 | 55.746 | 0.077 | 83.89 | 13.990 | 3.9990 | 55.946 | 0.078 | 84.18 | 13.94 | −0.002 |
| 5190 | May 4, 2012 | 1:17:15 PM | 13.94 | 3.999 | 5.7552 | 3.485 | 55.746 | 0.077 | 83.97 | 13.990 | 3.9990 | 55.946 | 0.078 | 84.26 | 13.94 | 0.000 |
| 5195 | May 4, 2012 | 1:17:20 PM | 13.94 | 3.999 | 5.7607 | 3.485 | 55.746 | 0.077 | 84.05 | 13.990 | 3.9990 | 55.946 | 0.078 | 84.34 | 13.94 | 0.002 |
| 5200 | May 4, 2012 | 1:17:25 PM | 13.94 | 3.999 | 5.7663 | 3.485 | 55.746 | 0.077 | 84.12 | 13.990 | 3.9990 | 55.946 | 0.078 | 84.41 | 13.94 | 0.004 |
| 5205 | May 4, 2012 | 1:17:30 PM | 13.93 | 3.999 | 5.7718 | 3.483 | 55.706 | 0.077 | 84.20 | 13.980 | 3.9990 | 55.906 | 0.078 | 84.49 | 13.93 | −0.004 |
| 5210 | May 4, 2012 | 1:17:35 PM | 13.93 | 3.999 | 5.7773 | 3.483 | 55.706 | 0.077 | 84.28 | 13.980 | 3.9990 | 55.906 | 0.078 | 84.57 | 13.93 | −0.002 |
| 5215 | May 4, 2012 | 1:17:40 PM | 13.93 | 3.999 | 5.7829 | 3.483 | 55.706 | 0.077 | 84.36 | 13.980 | 3.9990 | 55.906 | 0.078 | 84.65 | 13.93 | 0.000 |
| 5220 | May 4, 2012 | 1:17:45 PM | 13.93 | 3.999 | 5.7884 | 3.483 | 55.706 | 0.077 | 84.43 | 13.980 | 3.9990 | 55.906 | 0.078 | 84.72 | 13.93 | 0.002 |
| 5225 | May 4, 2012 | 1:17:50 PM | 13.93 | 3.999 | 5.7940 | 3.483 | 55.706 | 0.077 | 84.51 | 13.980 | 3.9990 | 55.906 | 0.078 | 84.80 | 13.93 | 0.005 |
| 5230 | May 4, 2012 | 1:17:55 PM | 13.92 | 3.999 | 5.7995 | 3.480 | 55.666 | 0.077 | 84.59 | 13.970 | 3.9990 | 55.866 | 0.078 | 84.88 | 13.92 | −0.003 |
| 5235 | May 4, 2012 | 1:18:00 PM | 13.92 | 3.999 | 5.8051 | 3.480 | 55.666 | 0.077 | 84.67 | 13.970 | 3.9990 | 55.866 | 0.078 | 84.96 | 13.92 | −0.001 |
| 5240 | May 4, 2012 | 1:18:05 PM | 13.92 | 3.999 | 5.8106 | 3.480 | 55.666 | 0.077 | 84.74 | 13.970 | 3.9990 | 55.866 | 0.078 | 85.03 | 13.92 | 0.001 |
| 5245 | May 4, 2012 | 1:18:10 PM | 13.92 | 3.999 | 5.8162 | 3.480 | 55.666 | 0.077 | 84.82 | 13.970 | 3.9990 | 55.866 | 0.078 | 85.11 | 13.92 | 0.004 |
| 5250 | May 4, 2012 | 1:18:15 PM | 13.91 | 3.999 | 5.8217 | 3.478 | 55.626 | 0.077 | 84.90 | 13.960 | 3.9990 | 55.826 | 0.078 | 85.19 | 13.91 | −0.004 |
| 5255 | May 4, 2012 | 1:18:20 PM | 13.91 | 3.999 | 5.8273 | 3.478 | 55.626 | 0.077 | 84.98 | 13.960 | 3.9990 | 55.826 | 0.078 | 85.27 | 13.91 | −0.001 |
| 5260 | May 4, 2012 | 1:18:25 PM | 13.91 | 3.999 | 5.8328 | 3.478 | 55.626 | 0.077 | 85.05 | 13.960 | 3.9990 | 55.826 | 0.078 | 85.34 | 13.91 | 0.001 |
| 5265 | May 4, 2012 | 1:18:30 PM | 13.91 | 3.999 | 5.8383 | 3.478 | 55.626 | 0.077 | 85.13 | 13.960 | 3.9990 | 55.826 | 0.078 | 85.42 | 13.91 | 0.004 |
| 5270 | May 4, 2012 | 1:18:35 PM | 13.90 | 3.999 | 5.8439 | 3.475 | 55.586 | 0.077 | 85.21 | 13.950 | 3.9990 | 55.786 | 0.077 | 85.50 | 13.90 | −0.004 |
| 5275 | May 4, 2012 | 1:18:40 PM | 13.90 | 3.999 | 5.8494 | 3.475 | 55.586 | 0.077 | 85.28 | 13.950 | 3.9990 | 55.786 | 0.077 | 85.58 | 13.90 | −0.001 |
| 5280 | May 4, 2012 | 1:18:45 PM | 13.90 | 3.999 | 5.8550 | 3.475 | 55.586 | 0.077 | 85.36 | 13.950 | 3.9990 | 55.786 | 0.077 | 85.65 | 13.90 | 0.002 |
| 5285 | May 4, 2012 | 1:18:50 PM | 13.90 | 3.999 | 5.8604 | 3.475 | 55.586 | 0.077 | 85.44 | 13.950 | 3.9990 | 55.786 | 0.077 | 85.73 | 13.90 | 0.005 |
| 5290 | May 4, 2012 | 1:18:55 PM | 13.89 | 3.999 | 5.8661 | 3.473 | 55.546 | 0.077 | 85.52 | 13.940 | 3.9990 | 55.746 | 0.077 | 85.81 | 13.89 | −0.003 |
| 5295 | May 4, 2012 | 1:19:00 PM | 13.89 | 3.999 | 5.8715 | 3.473 | 55.546 | 0.077 | 85.59 | 13.940 | 3.9990 | 55.746 | 0.077 | 85.89 | 13.89 | 0.000 |
| 5300 | May 4, 2012 | 1:19:05 PM | 13.89 | 3.999 | 5.8770 | 3.473 | 55.546 | 0.077 | 85.67 | 13.940 | 3.9990 | 55.746 | 0.077 | 85.96 | 13.89 | 0.003 |
| 5305 | May 4, 2012 | 1:19:10 PM | 13.88 | 3.999 | 5.8826 | 3.470 | 55.506 | 0.077 | 85.75 | 13.930 | 3.9990 | 55.706 | 0.077 | 86.04 | 13.88 | −0.005 |
| 5310 | May 4, 2012 | 1:19:15 PM | 13.88 | 3.999 | 5.8883 | 3.470 | 55.506 | 0.077 | 85.82 | 13.930 | 3.9990 | 55.706 | 0.077 | 86.12 | 13.88 | −0.002 |
| 5315 | May 4, 2012 | 1:19:20 PM | 13.88 | 3.999 | 5.8939 | 3.470 | 55.506 | 0.077 | 85.90 | 13.930 | 3.9990 | 55.706 | 0.077 | 86.20 | 13.88 | 0.002 |
| 5320 | May 4, 2012 | 1:19:25 PM | 13.88 | 3.999 | 5.8994 | 3.470 | 55.506 | 0.077 | 85.98 | 13.930 | 3.9990 | 55.706 | 0.077 | 86.27 | 13.88 | 0.005 |
| 5325 | May 4, 2012 | 1:19:30 PM | 13.87 | 3.999 | 5.9049 | 3.468 | 55.466 | 0.077 | 86.06 | 13.920 | 3.9990 | 55.666 | 0.077 | 86.35 | 13.87 | −0.003 |
| 5330 | May 4, 2012 | 1:19:35 PM | 13.87 | 3.999 | 5.9105 | 3.468 | 55.466 | 0.077 | 86.13 | 13.920 | 3.9990 | 55.666 | 0.077 | 86.43 | 13.87 | 0.001 |
| 5335 | May 4, 2012 | 1:19:40 PM | 13.87 | 3.999 | 5.9160 | 3.468 | 55.466 | 0.077 | 86.21 | 13.920 | 3.9990 | 55.666 | 0.077 | 86.51 | 13.87 | 0.004 |
| 5340 | May 4, 2012 | 1:19:45 PM | 13.86 | 3.999 | 5.9216 | 3.465 | 55.426 | 0.077 | 86.29 | 13.910 | 3.9990 | 55.626 | 0.077 | 86.58 | 13.86 | −0.004 |
| 5345 | May 4, 2012 | 1:19:50 PM | 13.86 | 3.999 | 5.9271 | 3.465 | 55.426 | 0.077 | 86.36 | 13.910 | 3.9990 | 55.626 | 0.077 | 86.66 | 13.86 | −0.001 |
| 5350 | May 4, 2012 | 1:19:55 PM | 13.86 | 3.999 | 5.9327 | 3.465 | 55.426 | 0.077 | 86.44 | 13.910 | 3.9990 | 55.626 | 0.077 | 86.74 | 13.86 | 0.003 |
| 5355 | May 4, 2012 | 1:20:00 PM | 13.85 | 3.999 | 5.9382 | 3.463 | 55.386 | 0.077 | 86.52 | 13.900 | 3.9990 | 55.586 | 0.077 | 86.82 | 13.85 | −0.005 |
| 5360 | May 4, 2012 | 1:20:05 PM | 13.85 | 3.999 | 5.9437 | 3.463 | 55.386 | 0.077 | 86.59 | 13.900 | 3.9990 | 55.586 | 0.077 | 86.89 | 13.85 | −0.002 |
| 5365 | May 4, 2012 | 1:20:10 PM | 13.85 | 3.999 | 5.9493 | 3.463 | 55.386 | 0.077 | 86.67 | 13.900 | 3.9990 | 55.586 | 0.077 | 86.97 | 13.85 | 0.002 |
| 5370 | May 4, 2012 | 1:20:15 PM | 13.85 | 3.999 | 5.9548 | 3.463 | 55.386 | 0.077 | 86.75 | 13.900 | 3.9990 | 55.586 | 0.077 | 87.05 | 13.85 | 0.005 |
| 5375 | May 4, 2012 | 1:20:20 PM | 13.84 | 3.999 | 5.9604 | 3.460 | 55.346 | 0.077 | 86.83 | 13.890 | 3.9990 | 55.546 | 0.077 | 87.12 | 13.84 | −0.003 |
| 5380 | May 4, 2012 | 1:20:25 PM | 13.84 | 3.999 | 5.9659 | 3.460 | 55.346 | 0.077 | 86.90 | 13.890 | 3.9990 | 55.546 | 0.077 | 87.20 | 13.84 | 0.001 |
| 5385 | May 4, 2012 | 1:20:30 PM | 13.84 | 3.999 | 5.9715 | 3.460 | 55.346 | 0.077 | 86.98 | 13.890 | 3.9990 | 55.546 | 0.077 | 87.28 | 13.84 | 0.004 |
| 5390 | May 4, 2012 | 1:20:35 PM | 13.83 | 3.999 | 5.9770 | 3.458 | 55.306 | 0.077 | 87.06 | 13.880 | 3.9990 | 55.506 | 0.077 | 87.36 | 13.83 | −0.003 |
| 5395 | May 4, 2012 | 1:20:40 PM | 13.83 | 3.999 | 5.9826 | 3.458 | 55.306 | 0.077 | 87.13 | 13.880 | 3.9990 | 55.506 | 0.077 | 87.43 | 13.83 | 0.001 |
| 5400 | May 4, 2012 | 1:20:45 PM | 13.83 | 3.999 | 5.9881 | 3.458 | 55.306 | 0.077 | 87.21 | 13.880 | 3.9990 | 55.506 | 0.077 | 87.51 | 13.83 | 0.005 |
| 5405 | May 4, 2012 | 1:20:50 PM | 13.82 | 3.999 | 5.9937 | 3.455 | 55.266 | 0.077 | 87.29 | 13.870 | 3.9990 | 55.466 | 0.077 | 87.59 | 13.82 | −0.002 |
| 5410 | May 4, 2012 | 1:20:55 PM | 13.82 | 3.999 | 5.9992 | 3.455 | 55.266 | 0.077 | 87.36 | 13.870 | 3.9990 | 55.466 | 0.077 | 87.66 | 13.82 | 0.002 |
| 5415 | May 4, 2012 | 1:21:00 PM | 13.81 | 4.000 | 6.0048 | 3.453 | 55.240 | 0.077 | 87.44 | 13.860 | 3.9990 | 55.440 | 0.077 | 87.74 | 13.81 | −0.004 |
| 5420 | May 4, 2012 | 1:21:05 PM | 13.81 | 3.999 | 6.0103 | 3.453 | 55.226 | 0.077 | 87.52 | 13.860 | 3.9990 | 55.426 | 0.077 | 87.82 | 13.81 | 0.000 |
| 5425 | May 4, 2012 | 1:21:10 PM | 13.81 | 3.999 | 6.0158 | 3.453 | 55.226 | 0.077 | 87.59 | 13.860 | 3.9990 | 55.426 | 0.077 | 87.89 | 13.81 | 0.004 |
| 5430 | May 4, 2012 | 1:21:15 PM | 13.80 | 3.999 | 6.0214 | 3.450 | 55.186 | 0.077 | 87.67 | 13.850 | 3.9990 | 55.386 | 0.077 | 87.97 | 13.80 | −0.002 |
| 5435 | May 4, 2012 | 1:21:20 PM | 13.80 | 3.999 | 6.0269 | 3.450 | 55.186 | 0.077 | 87.75 | 13.850 | 3.9990 | 55.386 | 0.077 | 88.05 | 13.80 | 0.002 |
| 5440 | May 4, 2012 | 1:21:25 PM | 13.79 | 3.999 | 6.0325 | 3.448 | [symbol] | [symbol] | [symbol] | [symbol] | 3.9990 | 55.346 | 0.077 | 88.13 | 13.79 | −0.004 |
| 5445 | May 4, 2012 | 1:21:30 PM | 13.79 | 3.999 | 6.0380 | 3.448 | 55.146 | 0.077 | 87.90 | 13.840 | 3.9990 | 55.346 | 0.077 | 88.20 | 13.79 | 0.000 |
| 5450 | May 4, 2012 | 1:21:35 PM | 13.79 | 3.999 | 6.0436 | 3.448 | 55.146 | 0.077 | 87.98 | 13.840 | 3.9990 | 55.346 | 0.077 | 88.28 | 13.79 | 0.005 |
| 5455 | May 4, 2012 | 1:21:40 PM | 13.78 | 3.999 | 6.0492 | 3.445 | 55.106 | 0.077 | 88.05 | 13.830 | 3.9990 | 55.306 | 0.077 | 88.36 | 13.78 | −0.001 |
| 5460 | May 4, 2012 | 1:21:45 PM | 13.78 | 3.999 | 6.0547 | 3.445 | 55.106 | 0.077 | 88.13 | 13.830 | 3.9990 | 55.306 | 0.077 | 88.43 | 13.78 | 0.004 |
| 5465 | May 4, 2012 | 1:21:50 PM | 13.77 | 3.999 | 6.0602 | 3.443 | 55.066 | 0.076 | 88.21 | 13.820 | 3.9990 | 55.266 | 0.077 | 88.51 | 13.77 | −0.002 |
| 5470 | May 4, 2012 | 1:21:55 PM | 13.77 | 3.999 | 6.0658 | 3.443 | 55.066 | 0.076 | 88.28 | 13.820 | 3.9990 | 55.266 | 0.077 | 88.59 | 13.77 | 0.003 |
| 5475 | May 4, 2012 | 1:22:00 PM | 13.76 | 3.999 | 6.0713 | 3.440 | 55.0.26 | 0.076 | 88.36 | 13.810 | 3.9990 | 55.226 | 0.077 | 88.66 | 13.76 | −0.003 |
| 5480 | May 4, 2012 | 1:22:05 PM | 13.76 | 3.999 | 6.0769 | 3.440 | 55.026 | 0.076 | 88.44 | 13.810 | 3.9990 | 55.226 | 0.077 | 88.74 | 13.76 | 0.003 |
| 5485 | May 4, 2012 | 1:22:10 PM | 13.75 | 3.999 | 6.0824 | 3.438 | 54.986 | 0.076 | 88.51 | 13.800 | 3.9990 | 55.186 | 0.077 | 88.82 | 13.75 | −0.003 |
| 5490 | May 4, 2012 | 1:22:15 PM | 13.75 | 3.999 | 6.0880 | 3.438 | 54.986 | 0.076 | 88.59 | 13.800 | 3.9990 | 55.186 | 0.077 | 88.89 | 13.75 | 0.003 |
| 5495 | May 4, 2012 | 1:22:20 PM | 13.74 | 3.999 | 6.0935 | 3.435 | 54.946 | 0.076 | 88.66 | 13.790 | 3.9990 | 55.146 | 0.077 | 88.97 | 13.74 | −0.003 |
| 5500 | May 4, 2012 | 1:22:25 PM | 13.74 | 3.999 | 6.0990 | 3.435 | 54.946 | 0.076 | 88.74 | 13.790 | 3.9990 | 55.146 | 0.077 | 89.05 | 13.74 | 0.003 |
| 5505 | May 4, 2012 | 1:22:30 PM | 13.73 | 3.999 | 6.1046 | 3.433 | 54.906 | 0.076 | 88.82 | 13.780 | 3.9990 | 55.106 | 0.077 | 89.12 | 13.73 | −0.002 |
| 5510 | May 4, 2012 | 1:22:35 PM | 13.73 | 3.999 | 6.1101 | 3.433 | 54.906 | 0.076 | 88.89 | 13.780 | 3.9990 | 55.106 | 0.077 | 89.20 | 13.73 | 0.004 |
| 5515 | May 4, 2012 | 1:22:40 PM | 13.72 | 3.999 | 6.1157 | 3.430 | 54.866 | 0.076 | 88.97 | 13.770 | 3.9990 | 55.066 | 0.076 | 89.28 | 13.72 | −0.001 |
| 5520 | May 4, 2012 | 1:22:45 PM | 13.72 | 3.999 | 6.1212 | 3.430 | 54.866 | 0.076 | 89.05 | 13.770 | 3.9990 | 55.066 | 0.076 | 89.35 | 13.71 | 0.005 |
| 5525 | May 4, 2012 | 1:22:50 PM | 13.71 | 3.999 | 6.1268 | 3.428 | 54.826 | 0.076 | 89.12 | 13.760 | 3.9990 | 55.026 | 0.076 | 89.43 | 13.71 | 0.001 |
| 5530 | May 4, 2012 | 1:22:55 PM | 13.70 | 4.000 | 6.1323 | 3.425 | 54.800 | 0.076 | 89.20 | 13.750 | 4.0000 | 55.000 | 0.076 | 89.50 | 13.70 | −0.003 |
| 5535 | May 4, 2012 | 1:23:00 PM | 13.70 | 3.999 | 6.1379 | 3.425 | 54.786 | 0.076 | 89.27 | 13.750 | 3.9990 | 54.986 | 0.076 | 89.58 | 13.70 | 0.004 |
| 5540 | May 4, 2012 | 1:23:05 PM | 13.69 | 3.999 | 6.1434 | 3.423 | 54.746 | 0.076 | 89.35 | 13.740 | 3.9990 | 54.946 | 0.076 | 89.66 | 13.69 | 0.000 |
| 5545 | May 4, 2012 | 1:23:10 PM | 13.68 | 3.999 | 6.1488 | 3.420 | 54.706 | 0.076 | 89.43 | 13.730 | 3.9990 | 54.906 | 0.076 | 89.73 | 13.68 | −0.004 |
| 5550 | May 4, 2012 | 1:23:15 PM | 13.68 | 3.999 | 6.1543 | 3.420 | 54.706 | 0.076 | 89.50 | 13.730 | 3.9990 | 54.906 | 0.076 | 89.81 | 13.68 | 0.004 |
| 5555 | May 4, 2012 | 1:23:20 PM | 13.67 | 3.999 | 6.1599 | 3.418 | 54.666 | 0.076 | 89.58 | 13.720 | 3.9990 | 54.866 | 0.076 | 89.89 | 13.67 | 0.001 |
| 5560 | May 4, 2012 | 1:23:25 PM | 13.66 | 3.999 | 6.1654 | 3.415 | 54.626 | 0.076 | 89.65 | 13.710 | 3.9990 | 54.826 | 0.076 | 89.96 | 13.66 | −0.003 |
| 5565 | May 4, 2012 | 1:23:30 PM | 13.66 | 3.999 | 6.1710 | 3.415 | 54.626 | 0.076 | 89.73 | 13.710 | 3.9990 | 54.826 | 0.076 | 90.04 | 13.66 | 0.005 |
| 5570 | May 4, 2012 | 1:23:35 PM | 13.65 | 3.999 | 6.1765 | 3.413 | 54.586 | 0.076 | 89.81 | 13.700 | 3.9990 | 54.786 | 0.076 | 90.11 | 13.65 | 0.002 |
| 5575 | May 4, 2012 | 1:23:40 PM | 13.64 | 3.999 | 6.1821 | 3.410 | 54.546 | 0.076 | 89.88 | 13.690 | 3.9990 | 54.746 | 0.076 | 90.19 | 13.64 | −0.001 |
| 5580 | May 4, 2012 | 1:23:45 PM | 13.63 | 3.999 | 6.1876 | 3.408 | 54.506 | 0.076 | 89.96 | 13.680 | 3.9990 | 54.706 | 0.076 | 90.27 | 13.63 | −0.003 |
| 5585 | May 4, 2012 | 1:23:50 PM | 13.63 | 3.999 | 6.1931 | 3.408 | 54.506 | 0.076 | 90.03 | 13.680 | 3.9990 | 54.706 | 0.076 | 90.34 | 13.62 | 0.005 |
| 5590 | May 4, 2012 | 1:23:55 PM | 13.62 | 3.999 | 6.1987 | 3.405 | 54.466 | 0.076 | 90.11 | 13.670 | 3.9990 | 54.666 | 0.076 | 90.42 | 13.62 | 0.004 |
| 5595 | May 4, 2012 | 1:24:00 PM | 13.61 | 3.999 | 6.2042 | 3.403 | 54.426 | 0.076 | 90.18 | 13.660 | 3.9990 | 54.626 | 0.076 | 90.49 | 13.61 | 0.003 |
| 5600 | May 4, 2012 | 1:24:05 PM | 13.60 | 3.999 | 6.2098 | 3.400 | 54.386 | 0.076 | 90.26 | 13.650 | 3.9990 | 54.586 | 0.076 | 90.57 | 13.60 | 0.002 |
| 5605 | May 4, 2012 | 1:24:10 PM | 13.59 | 3.999 | 6.2153 | 3.398 | 54.346 | 0.075 | 90.33 | 13.640 | 3.9990 | 54.546 | 0.076 | 90.65 | 13.59 | 0.001 |
| 5610 | May 4, 2012 | 1:24:15 PM | 13.58 | 3.999 | 6.2209 | 3.395 | 54.306 | 0.075 | 90.41 | 13.630 | 3.9990 | 54.506 | 0.076 | 90.72 | 13.58 | 0.000 |
| 5615 | May 4, 2012 | 1:24:20 PM | 13.57 | 3.999 | 6.2265 | 3.393 | 54.266 | 0.075 | 90.49 | 13.620 | 3.9990 | 54.466 | 0.076 | 90.80 | 13.57 | 0.000 |
| 5620 | May 4, 2012 | 1:24:25 PM | 13.56 | 3.999 | 6.2320 | 3.390 | 54.226 | 0.075 | 90.56 | 13.610 | 3.9990 | 54.426 | 0.076 | 90.87 | 13.56 | 0.001 |
| 5625 | May 4, 2012 | 1:24:30 PM | 13.55 | 3.999 | 6.2375 | 3.388 | 54.186 | 0.075 | 90.64 | 13.600 | 3.9990 | 54.386 | 0.076 | 90.95 | 13.55 | 0.002 |
| 5630 | May 4, 2012 | 1:24:35 PM | 13.54 | 3.999 | 6.2430 | 3.385 | 54.146 | 0.075 | 90.71 | 13.590 | 3.9990 | 54.346 | 0.075 | 91.02 | 13.54 | 0.003 |
| 5635 | May 4, 2012 | 1:24:40 PM | 13.53 | 3.999 | 6.2486 | 3.383 | 54.106 | 0.075 | 90.79 | 13.580 | 3.9990 | 54.306 | 0.075 | 91.10 | 13.53 | 0.004 |
| 5640 | May 4, 2012 | 1:24:45 PM | 13.52 | 3.999 | 6.2541 | 3.380 | 54.066 | 0.075 | 90.86 | 13.570 | 3.9990 | 54.266 | 0.075 | 91.17 | 13.51 | 0.005 |
| 5645 | May 4, 2012 | 1:24:50 PM | 13.50 | 3.999 | 6.2597 | 3.375 | 53.987 | 0.075 | 90.94 | 13.550 | 3.9990 | 54.186 | 0.075 | 91.25 | 13.50 | −0.003 |
| 5650 | May 4, 2012 | 1:24:55 PM | 13.49 | 3.999 | 6.2652 | 3.373 | 53.947 | 0.075 | 91.01 | 13.540 | 3.9990 | 54.146 | 0.075 | 91.33 | 13.49 | 0.000 |
| 5655 | May 4, 2012 | 1:25:00 PM | 13.48 | 3.999 | 6.2709 | 3.370 | 53.907 | 0.075 | 91.09 | 13.530 | 3.9990 | 54.106 | 0.075 | 91.40 | 13.48 | 0.003 |
| 5660 | May 4, 2012 | 1:25:05 PM | 13.47 | 3.999 | 6.2765 | 3.368 | 53.867 | 0.075 | 91.16 | 13.520 | 3.9990 | 54.066 | 0.075 | 91.48 | 13.46 | 0.005 |
| 5665 | May 4, 2012 | 1:25:10 PM | 13.45 | 3.999 | 6.2820 | 3.363 | 53.787 | 0.075 | 91.24 | 13.500 | 3.9990 | 53.987 | 0.075 | 91.55 | 13.45 | −0.001 |
| 5670 | May 4, 2012 | 1:25:15 PM | 13.44 | 3.999 | 6.2876 | 3.360 | 53.747 | 0.075 | 91.31 | 13.490 | 3.9990 | 53.947 | 0.075 | 91.63 | 13.44 | 0.004 |
| 5675 | May 4, 2012 | 1:25:20 PM | 13.42 | 3.999 | 6.2931 | 3.355 | 53.667 | 0.075 | 91.38 | 13.470 | 3.9990 | 53.867 | 0.075 | 91.70 | 13.42 | −0.003 |
| 5680 | May 4, 2012 | 1:25:25 PM | 13.41 | 3.999 | 6.2987 | 3.353 | 53.627 | 0.074 | 91.46 | 13.460 | 3.9990 | 53.827 | 0.075 | 91.77 | 13.41 | 0.002 |
| 5685 | May 4, 2012 | 1:25:30 PM | 13.40 | 3.999 | 6.3042 | 3.350 | 53.587 | 0.074 | 91.53 | 13.450 | 3.9990 | 53.787 | 0.075 | 91.85 | 13.39 | 0.007 |
| 5690 | May 4, 2012 | 1:25:35 PM | 13.38 | 4.000 | 6.3097 | 3.345 | 53.520 | 0.074 | 91.61 | 13.430 | 4.0000 | 53.720 | 0.075 | 91.92 | 13.38 | 0.004 |
| 5695 | May 4, 2012 | 1:25:40 PM | 13.36 | 3.999 | 6.3153 | 3.340 | 53.427 | 0.074 | 91.68 | 13.410 | 3.9990 | 53.627 | 0.074 | 92.00 | 13.36 | 0.000 |
| 5700 | May 4, 2012 | 1:25:45 PM | 13.35 | 3.999 | 6.3208 | 3.338 | 53.387 | 0.074 | 91.76 | 13.400 | 3.9990 | 53.587 | 0.074 | 92.07 | 13.34 | 0.007 |
| 5705 | May 4, 2012 | 1:25:50 PM | 13.33 | 3.999 | 6.3264 | 3.333 | 53.307 | 0.074 | 91.83 | 13.380 | 3.9990 | 53.507 | 0.074 | 92.15 | 13.33 | 0.005 |
| 5710 | May 4, 2012 | 1:25:55 PM | 13.31 | 3.999 | 6.3319 | 3.328 | 53.227 | 0.074 | 91.90 | 13.360 | 3.9990 | 53.427 | 0.074 | 92.22 | 13.31 | 0.003 |
| 5715 | May 4, 2012 | 1:26:00 PM | 13.29 | 3.999 | 6.3375 | 3.323 | 53.147 | 0.074 | 91.98 | 13.340 | 3.9990 | 53.347 | 0.074 | 92.30 | 13.29 | 0.002 |
| 5720 | May 4, 2012 | 1:26:05 PM | 13.27 | 3.999 | 6.3430 | 3.318 | 53.067 | 0.074 | 92.05 | 13.320 | 3.9990 | 53.267 | 0.074 | 92.37 | 13.27 | 0.001 |
| 5725 | May 4, 2012 | 1:26:10 PM | 13.25 | 4.000 | 6.3486 | 3.313 | 53.000 | 0.074 | 92.13 | 13.300 | 4.0000 | 53.200 | 0.074 | 92.44 | 13.25 | 0.000 |
| 5730 | May 4, 2012 | 1:26:15 PM | 13.23 | 3.999 | 6.3541 | 3.308 | 52.907 | 0.073 | 92.20 | 13.280 | 3.9990 | 53.107 | 0.074 | 92.52 | 13.23 | 0.001 |
| 5735 | May 4, 2012 | 1:26:20 PM | 13.21 | 4.000 | 6.3597 | 3.303 | 52.840 | 0.073 | 92.27 | 13.260 | 4.0000 | 53.040 | 0.074 | 92.59 | 13.21 | 0.002 |
| 5740 | May 4, 2012 | 1:26:25 PM | 13.19 | 3.999 | 6.3652 | 3.298 | 52.747 | 0.073 | 92.35 | 13.240 | 3.9990 | 52.947 | 0.074 | 92.66 | 13.19 | 0.004 |
| 5745 | May 4, 2012 | 1:26:30 PM | 13.17 | 3.999 | 6.3708 | 3.293 | 52.667 | 0.073 | 92.42 | 13.220 | 3.9990 | 52.867 | 0.073 | 92.74 | 13.16 | 0.005 |
| 5750 | May 4, 2012 | 1:26:35 PM | 13.15 | 3.999 | 6.3763 | 3.288 | 52.587 | 0.073 | 92.49 | 13.200 | 3.9990 | 52.787 | 0.073 | 92.81 | 13.14 | 0.008 |
| 5755 | May 4, 2012 | 1:26:40 PM | 13.12 | 3.999 | 6.3818 | 3.280 | 52.467 | 0.073 | 92.56 | 13.170 | 3.9990 | 52.667 | 0.073 | 92.88 | 13.12 | 0.002 |
| 5760 | May 4, 2012 | 1:26:45 PM | 13.10 | 3.999 | 6.3874 | 3.275 | 52.387 | 0.073 | 92.64 | 13.150 | 3.9990 | 52.587 | 0.073 | 92.96 | 13.09 | 0.006 |
| 5765 | May 4, 2012 | 1:26:50 PM | 13.07 | 3.999 | 6.3929 | 3.268 | 52.267 | 0.073 | 92.71 | 13.120 | 3.9990 | 52.467 | 0.073 | 93.03 | 13.07 | 0.002 |
| 5770 | May 4, 2012 | 1:26:55 PM | 13.05 | 3.999 | 6.3985 | 3.263 | 52.187 | 0.072 | 92.78 | 13.100 | 3.9990 | 52.387 | 0.073 | 93.10 | 13.04 | 0.008 |
| 5775 | May 4, 2012 | 1:27:00 PM | 13.02 | 3.999 | 6.4039 | 3.255 | 52.067 | 0.072 | 92.85 | 13.070 | 3.9990 | 52.267 | 0.073 | 93.18 | 13.01 | 0.005 |
| 5780 | May 4, 2012 | 1:27:05 PM | 12.99 | 3.999 | 6.4094 | 3.248 | 51.947 | 0.072 | 92.93 | 13.040 | 3.9990 | 52.147 | 0.072 | 93.25 | 12.99 | 0.004 |
| 5785 | May 4, 2012 | 1:27:10 PM | 12.96 | 3.999 | 6.4150 | 3.240 | 51.827 | 0.072 | 93.00 | 13.010 | 3.9990 | 52.027 | 0.072 | 93.32 | 12.96 | 0.003 |
| 5790 | May 4, 2012 | 1:27:15 PM | 12.93 | 4.000 | 6.4205 | 3.233 | 51.720 | 0.072 | 93.07 | 12.980 | 4.0000 | 51.920 | 0.072 | 93.39 | 12.93 | 0.003 |
| 5795 | May 4, 2012 | 1:27:20 PM | 12.90 | 3.999 | 6.4261 | 3.225 | 51.587 | 0.072 | 93.14 | 12.950 | 3.9990 | 51.787 | 0.072 | 93.46 | 12.90 | 0.004 |
| 5800 | May 4, 2012 | 1:27:25 PM | 12.87 | 3.999 | 6.4316 | 3.218 | 51.467 | 0.071 | 93.21 | 12.920 | 3.9990 | 51.667 | 0.072 | 93.54 | 12.86 | 0.006 |
| 5805 | May 4, 2012 | 1:27:30 PM | 12.84 | 3.999 | 6.4371 | 3.210 | [symbol] | [symbol] | [symbol] | 12.890 | 3.9990 | 51.547 | 0.072 | 93.61 | 12.83 | 0.010 |
| 5810 | May 4, 2012 | 1:27:35 PM | 12.80 | 3.999 | 6.4427 | 3.200 | 51.187 | 0.071 | 93.36 | 12.850 | 3.9990 | 51.387 | 0.071 | 93.68 | 12.80 | 0.005 |
| 5815 | May 4, 2012 | 1:27:40 PM | 12.77 | 3.999 | 6.4482 | 3.193 | 51.067 | 0.071 | 93.43 | 12.820 | 3.9990 | 51.267 | 0.071 | 93.75 | 12.76 | 0.011 |
| 5820 | May 4, 2012 | 1:27:45 PM | 12.73 | 3.999 | 6.4538 | 3.183 | 50.907 | 0.071 | 93.50 | 12.780 | 3.9990 | 51.107 | 0.071 | 93.82 | 12.72 | 0.008 |
| 5825 | May 4, 2012 | 1:27:50 PM | 12.69 | 3.999 | 6.4593 | 3.173 | 50.747 | 0.070 | 93.57 | 12.740 | 3.9990 | 50.947 | 0.071 | 93.89 | 12.68 | 0.007 |
| 5830 | May 4, 2012 | 1:27:55 PM | 12.65 | 3.999 | 6.4649 | 3.163 | 50.587 | 0.070 | 93.64 | 12.700 | 3.9990 | 50.787 | 0.071 | 93.96 | 12.64 | 0.008 |
| 5835 | May 4, 2012 | 1:28:00 PM | 12.61 | 3.999 | 6.4704 | 3.153 | 50.427 | 0.070 | 93.71 | 12.660 | 3.9990 | 50.627 | 0.070 | 94.03 | 12.60 | 0.012 |
| 5840 | May 4, 2012 | 1:28:05 PM | 12.56 | 3.999 | 6.4759 | 3.140 | 50.227 | 0.070 | 93.78 | 12.610 | 3.9990 | 50.427 | 0.070 | 94.10 | 12.55 | 0.006 |
| 5845 | May 4, 2012 | 1:28:10 PM | 12.52 | 3.999 | 6.4815 | 3.130 | 50.067 | 0.070 | 93.82 | 12.570 | 3.9990 | 50.267 | 0.070 | 94.17 | 12.51 | 0.014 |
| 5850 | May 4, 2012 | 1:28:15 PM | 12.47 | 3.999 | 6.4871 | 3.118 | 49.868 | 0.069 | 93.92 | 12.520 | 3.9990 | 50.067 | 0.070 | 94.24 | 12.46 | 0.014 |
| 5855 | May 4, 2012 | 1:28:20 PM | 12.42 | 3.999 | 6.4926 | 3.105 | 49.668 | 0.069 | 93.99 | 12.470 | 3.9990 | 49.868 | 0.069 | 94.31 | 12.40 | 0.015 |
| 5860 | May 4, 2012 | 1:28:25 PM | 12.36 | 3.999 | 6.4981 | 3.090 | 49.428 | 0.069 | 94.06 | 12.410 | 3.9990 | 49.628 | 0.069 | 94.38 | 12.35 | 0.011 |
| 5865 | May 4, 2012 | 1:28:30 PM | 12.31 | 3.999 | 6.5037 | 3.078 | 49.228 | 0.068 | 94.12 | 12.360 | 3.9990 | 49.428 | 0.069 | 94.45 | 12.29 | 0.020 |
| 5870 | May 4, 2012 | 1:28:35 PM | 12.25 | 3.999 | 6.5092 | 3.063 | 48.988 | 0.068 | 94.19 | 12.300 | 3.9990 | 49.188 | 0.068 | 94.52 | 12.23 | 0.022 |
| 5875 | May 4, 2012 | 1:28:40 PM | 12.18 | 3.999 | 6.5149 | 3.045 | 48.708 | 0.068 | 94.26 | 12.230 | 3.9990 | 48.908 | 0.068 | 94.59 | 12.16 | 0.019 |
| 5880 | May 4, 2012 | 1:28:45 PM | 12.12 | 3.999 | 6.5205 | 3.030 | 48.468 | 0.067 | 94.33 | 12.170 | 3.9990 | 48.668 | 0.068 | 94.65 | 12.09 | 0.032 |
| 5885 | May 4, 2012 | 1:28:50 PM | 12.04 | 3.999 | 6.5260 | 3.010 | 48.148 | 0.067 | 94.39 | 12.090 | 3.9990 | 48.348 | 0.067 | 94.72 | 12.01 | 0.031 |
| 5890 | May 4, 2012 | 1:28:55 PM | 11.96 | 3.999 | 6.5316 | 2.990 | 47.828 | 0.066 | 94.46 | 12.010 | 3.9990 | 48.028 | 0.067 | 94.79 | 11.92 | 0.037 |
| 5895 | May 4, 2012 | 1:29:00 PM | 11.88 | 3.999 | 6.5371 | 2.970 | 47.508 | 0.066 | 94.53 | 11.930 | 3.9990 | 47.708 | 0.066 | 94.85 | 11.83 | 0.053 |
| 5900 | May 4, 2012 | 1:29:05 PM | 11.78 | 3.999 | 6.5427 | 2.945 | 47.108 | 0.065 | 94.59 | 11.830 | 3.9990 | 47.308 | 0.066 | 94.92 | 11.72 | 0.059 |
| 5905 | May 4, 2012 | 1:29:10 PM | 11.67 | 4.000 | 6.5482 | 2.918 | 46.680 | 0.065 | 94.66 | 11.720 | 4.0000 | 46.880 | 0.065 | 94.98 | 11.60 | 0.068 |
| 5910 | May 4, 2012 | 1:29:15 PM | 11.55 | 3.999 | 6.5538 | 2.888 | 46.188 | 0.064 | 94.72 | 11.600 | 3.9990 | 46.388 | 0.064 | 95.05 | 11.47 | 0.081 |
| 5915 | May 4, 2012 | 1:29:20 PM | 11.41 | 3.999 | 6.5593 | 2.853 | 45.629 | 0.063 | 94.78 | 11.460 | 3.9990 | 45.829 | 0.064 | 95.11 | 11.32 | 0.089 |
| 5920 | May 4, 2012 | 1:29:25 PM | 11.26 | 3.999 | 6.5649 | 2.815 | 45.029 | 0.063 | 94.85 | 11.310 | 3.9990 | 45.229 | 0.063 | 95.17 | 11.16 | 0.103 |
| 5925 | May 4, 2012 | 1:29:30 PM | 11.08 | 3.999 | 6.5704 | 2.770 | 44.309 | 0.062 | 94.91 | 11.130 | 3.9990 | 44.509 | 0.062 | 95.24 | 10.97 | 0.105 |
| 5930 | May 4, 2012 | 1:29:35 PM | 10.87 | 3.999 | 6.5760 | 2.718 | 43.469 | 0.060 | 94.97 | 10.920 | 3.9990 | 43.669 | 0.061 | 95.30 | | |
| 5935 | May 4, 2012 | 1:29:40 PM | 10.66 | 3.999 | 6.5815 | 2.665 | 42.629 | 0.059 | 95.03 | 10.710 | 3.9990 | 42.829 | 0.059 | 95.36 | | |
| 5940 | May 4, 2012 | 1:29:45 PM | 10.41 | 3.999 | 6.5871 | 2.603 | 41.630 | 0.058 | 95.09 | 10.460 | 3.9990 | 41.830 | 0.058 | 95.41 | | |
| 5945 | May 4, 2012 | 1:29:50 PM | 10.16 | 3.999 | 6.5926 | 2.540 | 40.630 | 0.056 | 95.14 | 10.210 | 3.9990 | 40.830 | 0.057 | 95.47 | | |
| 5950 | May 4, 2012 | 1:29:55 PM | 9.87 | 3.999 | 6.5981 | 2.468 | 39.470 | 0.055 | 95.20 | 9.920 | 3.9990 | 39.670 | 0.055 | 95.53 | | |
| 5955 | | | | | | 0.000 | 0.000 | 0.000 | 95.20 | 0.050 | 0.0000 | 0.000 | 0.000 | 95.53 | | |
| 5960 | | | | | | 0.000 | 0.000 | 0.000 | 95.20 | 0.050 | 0.0000 | 0.000 | 0.000 | 95.53 | | |
| 5965 | | | | | | 0.000 | 0.000 | 0.000 | 95.20 | 0.050 | 0.0000 | 0.000 | 0.000 | 95.53 | | |
| 5970 | | | | | | 0.000 | 0.000 | 0.000 | 95.20 | 0.050 | 0.0000 | 0.000 | 0.000 | 95.53 | | |
| 5975 | | | | | | 0.000 | 0.000 | 0.000 | 95.20 | 0.050 | 0.0000 | 0.000 | 0.000 | 95.53 | | |
| 5980 | | | | | | 0.000 | 0.000 | 0.000 | 95.20 | 0.050 | 0.0000 | 0.000 | 0.000 | 95.53 | | |
| 5985 | | | | | | 0.000 | 0.000 | 0.000 | 95.20 | 0.050 | 0.0000 | 0.000 | 0.000 | 95.53 | | |
| 5990 | | | | | | 0.000 | 0.000 | 0.000 | 95.20 | 0.050 | 0.0000 | 0.000 | 0.000 | 95.53 | | |
| 5995 | | | | | | 0.000 | 0.000 | 0.000 | 95.20 | 0.050 | 0.0000 | 0.000 | 0.000 | 95.53 | | |
| 6000 | | | | | | 0.000 | 0.000 | 0.000 | 95.20 | 0.050 | 0.0000 | 0.000 | 0.000 | 95.53 | | |
| 6005 | | | | | | 0.000 | 0.000 | 0.000 | 95.20 | 0.050 | 0.0000 | 0.000 | 0.000 | 95.53 | | |
| 6010 | | | | | | 0.000 | 0.000 | 0.000 | 95.20 | 0.050 | 0.0000 | 0.000 | 0.000 | 95.53 | | |
| 6015 | | | | | | 0.000 | 0.000 | 0.000 | 95.20 | 0.050 | 0.0000 | 0.000 | 0.000 | 95.53 | | |
| 6020 | | | | | | 0.000 | 0.000 | 0.000 | 95.20 | 0.050 | 0.0000 | 0.000 | 0.000 | 95.53 | | |
| 6025 | | | | | | 0.000 | 0.000 | 0.000 | 95.20 | 0.050 | 0.0000 | 0.000 | 0.000 | 95.53 | | |
| 6030 | | | | | | 0.000 | 0.000 | 0.000 | 95.20 | 0.050 | 0.0000 | 0.000 | 0.000 | 95.53 | | |
| 6035 | | | | | | 0.000 | 0.000 | 0.000 | 95.20 | 0.050 | 0.0000 | 0.000 | 0.000 | 95.53 | | |
| 6040 | | | | | | 0.000 | 0.000 | 0.000 | 95.20 | 0.050 | 0.0000 | 0.000 | 0.000 | 95.53 | | |
| 6045 | | | | | | 0.000 | 0.000 | 0.000 | 95.20 | 0.050 | 0.0000 | 0.000 | 0.000 | 95.53 | | |
| 6050 | | | | | | 0.000 | 0.000 | 0.000 | 95.20 | 0.050 | 0.0000 | 0.000 | 0.000 | 95.53 | | |
| 6055 | | | | | | 0.000 | 0.000 | 0.000 | 95.20 | 0.050 | 0.0000 | 0.000 | 0.000 | 95.53 | | |
| 6060 | | | | | | 0.000 | 0.000 | 0.000 | 95.20 | 0.050 | 0.0000 | 0.000 | 0.000 | 95.53 | | |
| 6065 | | | | | | 0.000 | 0.000 | 0.000 | 95.20 | 0.050 | 0.0000 | 0.000 | 0.000 | 95.53 | | |
| 6070 | | | | | | 0.000 | 0.000 | 0.000 | 95.20 | 0.050 | 0.0000 | 0.000 | 0.000 | 95.53 | | |
| 6075 | | | | | | 0.000 | 0.000 | 0.000 | 95.20 | 0.050 | 0.0000 | 0.000 | 0.000 | 95.53 | | |
| 6080 | | | | | | 0.000 | 0.000 | 0.000 | 95.20 | 0.050 | 0.0000 | 0.000 | 0.000 | 95.53 | | |
| 6085 | | | | | | 0.000 | 0.000 | 0.000 | 95.20 | 0.050 | 0.0000 | 0.000 | 0.000 | 95.53 | | |
| 6090 | | | | | | 0.000 | 0.000 | 0.000 | 95.20 | 0.050 | 0.0000 | 0.000 | 0.000 | 95.53 | | |
| 6095 | | | | | | 0.000 | 0.000 | 0.000 | 95.20 | 0.050 | 0.0000 | 0.000 | 0.000 | 95.53 | | |
| 6100 | | | | | | 0.000 | 0.000 | 0.000 | 95.20 | 0.050 | 0.0000 | 0.000 | 0.000 | 95.53 | | |
| 6105 | | | | | | 0.000 | 0.000 | 0.000 | 95.20 | 0.050 | 0.0000 | 0.000 | 0.000 | 95.53 | | |
| 6110 | | | | | | 0.000 | 0.000 | 0.000 | 95.20 | 0.050 | 0.0000 | 0.000 | 0.000 | 95.53 | | |
| 6115 | | | | | | 0.000 | 0.000 | 0.000 | 95.20 | 0.050 | 0.0000 | 0.000 | 0.000 | 95.53 | | |
| 6120 | | | | | | 0.000 | 0.000 | 0.000 | 95.20 | 0.050 | 0.0000 | 0.000 | 0.000 | 95.53 | | |
| 6125 | | | | | | 0.000 | 0.000 | 0.000 | 95.20 | 0.050 | 0.0000 | 0.000 | 0.000 | 95.53 | | |
| 6130 | | | | | | 0.000 | 0.000 | 0.000 | 95.20 | 0.050 | 0.0000 | 0.000 | 0.000 | 95.53 | | |
| 6135 | | | | | | 0.000 | 0.000 | 0.000 | 95.20 | 0.050 | 0.0000 | 0.000 | 0.000 | 95.53 | | |
| 6140 | | | | | | 0.000 | 0.000 | 0.000 | 95.20 | 0.050 | 0.0000 | 0.000 | 0.000 | 95.53 | | |
| 6145 | | | | | | 0.000 | 0.000 | 0.000 | 95.20 | 0.050 | 0.0000 | 0.000 | 0.000 | 95.53 | | |
| 6150 | | | | | | 0.000 | 0.000 | 0.000 | 95.20 | 0.050 | 0.0000 | 0.000 | 0.000 | 95.53 | | |
| 6155 | | | | | | 0.000 | 0.000 | 0.000 | 95.20 | 0.050 | 0.0000 | 0.000 | 0.000 | 95.53 | | |
| 6160 | | | | | | 0.000 | 0.000 | 0.000 | 95.20 | 0.050 | 0.0000 | 0.000 | 0.000 | 95.53 | | |
| 6165 | | | | | | 0.000 | 0.000 | 0.000 | 95.20 | 0.050 | 0.0000 | 0.000 | 0.000 | 95.53 | | |

| Avg Pwr (W) | Run Time (H) | Cal Wh | Avg Volt (V) | A-H | Cal Wh | Avg Pwr (W) | Run Time (H) | Cal Wh | Avg Volt (V) | A-H | Cal Wh | Wh | Corrected Wh | Voltage Offset | Current Offset |
|---|---|---|---|---|---|---|---|---|---|---|---|---|---|---|---|
| 17.503 | 5.439 | 95.20 | 14.403 | 6.598 | 95.03 | 17.564 | 5.439 | 95.53 | 4.427 | 6.598 | 29.21 | 95.20 | 95.53 | 0.05 | 0 |

[symbol]

indicates data missing or illegible when filed

APPENDIX B
Present Battery Pack Run Time Test

| | | | | | | | | | | | | | | | Calculated Voltage | |
|---|---|---|---|---|---|---|---|---|---|---|---|---|---|---|---|---|
| | | | | | | Calculated | | | | | | | | | Noise | |
| | Raw data from B & K Electronic Load | | | | | Cell | Calculated Power | | | Corrected Power given a voltage and/or current [symbol] | | | | | Moving (II) | Voltage |
| Time | Current | Current | Voltage | Current | | Voltage | | | Accumulated | Corrected | Corrected | Peak | | Accumulated | Average | Noise |
| (S) | Date | Time | (V) | (A) | Ah | Avg Volt | Peak Power | W * 5 sec/hr | Wh | Voltage | Current | Power | W * 5 sec/hr | Wh | (V) | (V) |
| 5 | May 8, 2012 | 9:28:21 AM | 15.90 | 4.000 | 0.0061 | 3.975 | 63.600 | 0.088 | 0.09 | 15.950 | 4.0000 | 63.800 | 0.089 | 0.09 | | |
| 10 | May 8, 2012 | 9:28:26 AM | 15.89 | 4.000 | 0.0115 | 3.973 | 63.560 | 0.088 | 0.18 | 15.940 | 4.0000 | 63.760 | 0.089 | 0.18 | | |
| 15 | May 8, 2012 | 9:28:31 AM | 15.87 | 4.000 | 0.0170 | 3.968 | 63.480 | 0.088 | 0.26 | 15.920 | 4.0000 | 63.680 | 0.088 | 0.27 | | |
| 20 | May 8, 2012 | 9:28:36 AM | 15.86 | 4.000 | 0.0225 | 3.965 | 63.440 | 0.088 | 0.35 | 15.910 | 4.0000 | 63.640 | 0.088 | 0.35 | | |
| 25 | May 8, 2012 | 9:28:41 AM | 15.86 | 4.000 | 0.0281 | 3.965 | 63.440 | 0.088 | 0.44 | 15.910 | 4.0000 | 63.640 | 0.088 | 0.44 | | |
| 30 | May 8, 2012 | 9:28:46 AM | 15.85 | 3.999 | 0.0337 | 3.963 | 63.384 | 0.088 | 0.53 | 15.900 | 3.9990 | 63.584 | 0.088 | 0.53 | 15.85 | −0.003 |
| 35 | May 8, 2012 | 9:28:51 AM | 15.84 | 4.000 | 0.0392 | 3.961 | 63.360 | 0.088 | 0.62 | 15.890 | 4.0000 | 63.560 | 0.088 | 0.62 | 15.84 | −0.005 |
| 40 | May 8, 2012 | 9:28:56 AM | 15.84 | 4.000 | 0.0448 | 3.960 | 63.360 | 0.088 | 0.71 | 15.890 | 4.0000 | 63.560 | 0.088 | 0.71 | 15.84 | 0.003 |
| 45 | May 8, 2012 | 9:29:01 AM | 15.83 | 4.000 | 0.0503 | 3.958 | 63.320 | 0.088 | 0.79 | 15.880 | 4.0000 | 63.520 | 0.088 | 0.80 | 15.83 | −0.001 |
| 50 | May 8, 2012 | 9:29:06 AM | 15.82 | 4.000 | 0.0558 | 3.955 | 63.280 | 0.088 | 0.88 | 15.870 | 4.0000 | 63.480 | 0.088 | 0.88 | 15.83 | −0.005 |
| 55 | May 8, 2012 | 9:29:11 AM | 15.82 | 4.000 | 0.0614 | 3.955 | 63.280 | 0.088 | 0.97 | 15.870 | 4.0000 | 63.480 | 0.088 | 0.97 | 15.82 | 0.000 |
| 60 | May 8, 2012 | 9:29:16 AM | 15.81 | 4.000 | 0.0669 | 3.953 | 63.240 | 0.088 | 1.06 | 15.860 | 4.0000 | 63.440 | 0.088 | 1.06 | 15.81 | −0.005 |
| 65 | May 8, 2012 | 9:29:21 AM | 15.81 | 4.000 | 0.0725 | 3.953 | 63.240 | 0.088 | 1.14 | 15.860 | 4.0000 | 63.440 | 0.088 | 1.15 | 15.81 | 0.000 |
| 70 | May 8, 2012 | 9:29:26 AM | 15.80 | 4.000 | 0.0780 | 3.950 | 63.200 | 0.088 | 1.23 | 15.850 | 4.0000 | 63.400 | 0.088 | 1.24 | 15.81 | −0.005 |
| 75 | May 8, 2012 | 9:29:31 AM | 15.80 | 4.000 | 0.0836 | 3.950 | 63.200 | 0.088 | 1.32 | 15.850 | 4.0000 | 63.400 | 0.088 | 1.32 | 15.80 | −0.001 |
| 80 | May 8, 2012 | 9:29:36 AM | 15.80 | 4.000 | 0.0891 | 3.950 | 63.200 | 0.088 | 1.41 | 15.850 | 4.0000 | 63.400 | 0.088 | 1.41 | 15.80 | 0.003 |
| 85 | May 8, 2012 | 9:29:41 AM | 15.79 | 4.000 | 0.0947 | 3.948 | 63.160 | 0.088 | 1.50 | 15.840 | 4.0000 | 63.360 | 0.088 | 1.50 | 15.79 | −0.004 |
| 90 | May 8, 2012 | 9:29:46 AM | 15.79 | 4.000 | 0.1002 | 3.948 | 63.160 | 0.088 | 1.58 | 15.840 | 4.0000 | 63.360 | 0.088 | 1.59 | 15.79 | 0.000 |
| 95 | May 8, 2012 | 9:29:51 AM | 15.79 | 4.000 | 0.1058 | 3.948 | 63.160 | 0.088 | 1.67 | 15.840 | 4.0000 | 63.360 | 0.088 | 1.68 | 15.79 | 0.004 |
| 100 | May 8, 2012 | 9:29:56 AM | 15.78 | 4.000 | 0.1114 | 3.945 | 63.120 | 0.088 | 1.76 | 15.830 | 4.0000 | 63.320 | 0.088 | 1.76 | 15.78 | −0.004 |
| 105 | May 8, 2012 | 9:30:01 AM | 15.78 | 4.000 | 0.1168 | 3.945 | 63.120 | 0.088 | 1.85 | 15.830 | 4.0000 | 63.320 | 0.088 | 1.85 | 15.78 | 0.000 |
| 110 | May 8, 2012 | 9:30:06 AM | 15.78 | 4.000 | 0.1224 | 3.945 | 63.120 | 0.088 | 1.93 | 15.830 | 4.0000 | 63.320 | 0.088 | 1.94 | 15.78 | 0.004 |
| 115 | May 8, 2012 | 9:30:11 AM | 15.77 | 4.000 | 0.1280 | 3.943 | 63.080 | 0.088 | 2.02 | 15.820 | 4.0000 | 63.280 | 0.088 | 2.03 | 15.77 | −0.004 |
| 120 | May 8, 2012 | 9:30:16 AM | 15.77 | 4.000 | 0.1335 | 3.943 | 63.080 | 0.088 | 2.11 | 15.820 | 4.0000 | 63.280 | 0.088 | 2.12 | 15.77 | −0.001 |
| 125 | May 8, 2012 | 9:30:21 AM | 15.77 | 4.000 | 0.1391 | 3.943 | 63.080 | 0.088 | 2.20 | 15.820 | 4.0000 | 63.280 | 0.088 | 2.20 | 15.77 | 0.003 |
| 130 | May 8, 2012 | 9:30:26 AM | 15.76 | 4.000 | 0.1446 | 3.940 | 63.040 | 0.088 | 2.28 | 15.810 | 4.0000 | 63.240 | 0.088 | 2.29 | 15.76 | −0.005 |
| 135 | May 8, 2012 | 9:30:31 AM | 15.76 | 4.000 | 0.1502 | 3.940 | 63.040 | 0.088 | 2.37 | 15.810 | 4.0000 | 63.240 | 0.088 | 2.38 | 15.76 | −0.002 |
| 140 | May 8, 2012 | 9:30:36 AM | 15.76 | 3.999 | 0.1557 | 3.940 | 63.024 | 0.088 | 2.46 | 15.810 | 3.9990 | 63.224 | 0.088 | 2.47 | 15.76 | 0.001 |
| 145 | May 8, 2012 | 9:30:41 AM | 15.76 | 4.000 | 0.1612 | 3.940 | 63.040 | 0.088 | 2.55 | 15.810 | 4.0000 | 63.240 | 0.088 | 2.56 | 15.76 | 0.003 |
| 150 | May 8, 2012 | 9:30:46 AM | 15.75 | 4.000 | 0.1668 | 3.938 | 63.000 | 0.088 | 2.63 | 15.800 | 4.0000 | 63.200 | 0.088 | 2.64 | 15.75 | −0.005 |
| 155 | May 8, 2012 | 9:30:51 AM | 15.75 | 4.000 | 0.1723 | 3.938 | 63.000 | 0.088 | 2.72 | 15.800 | 4.0000 | 63.200 | 0.088 | 2.73 | 15.75 | −0.002 |
| 160 | May 8, 2012 | 9:30:56 AM | 15.75 | 4.000 | 0.1780 | 3.938 | 63.000 | 0.088 | 2.81 | 15.800 | 4.0000 | 63.200 | 0.088 | 2.82 | 15.75 | 0.000 |
| 165 | May 8, 2012 | 9:31:01 AM | 15.75 | 4.000 | 0.1836 | 3.938 | 63.000 | 0.088 | 2.90 | 15.800 | 4.0000 | 63.200 | 0.088 | 2.91 | 15.75 | 0.002 |
| 170 | May 8, 2012 | 9:31:06 AM | 15.75 | 4.000 | 0.1891 | 3.938 | 63.000 | 0.088 | 2.98 | 15.800 | 4.0000 | 63.200 | 0.088 | 2.99 | 15.75 | 0.005 |
| 175 | May 8, 2012 | 9:31:11 AM | 15.74 | 4.000 | 0.1947 | 3.935 | 62.960 | 0.087 | 3.07 | 15.790 | 4.0000 | 63.160 | 0.088 | 3.08 | 15.74 | −0.003 |
| 180 | May 8, 2012 | 9:31:16 AM | 15.74 | 3.999 | 0.2002 | 3.935 | 62.944 | 0.087 | 3.16 | 15.790 | 3.9990 | 63.144 | 0.088 | 3.17 | 15.74 | −0.001 |
| 185 | May 8, 2012 | 9:31:21 AM | 15.74 | 4.000 | 0.2058 | 3.935 | 62.960 | 0.087 | 3.25 | 15.790 | 4.0000 | 63.160 | 0.088 | 3.26 | 15.74 | 0.001 |
| 190 | May 8, 2012 | 9:31:26 AM | 15.74 | 4.000 | 0.2113 | 3.935 | 62.960 | 0.087 | 3.33 | 15.790 | 4.0000 | 63.160 | 0.088 | 3.34 | 15.74 | 0.003 |
| 195 | May 8, 2012 | 9:31:31 AM | 15.73 | 4.000 | 0.2169 | 3.933 | 62.920 | 0.087 | 3.42 | 15.780 | 4.0000 | 63.120 | 0.088 | 3.43 | 15.73 | −0.005 |
| 200 | May 8, 2012 | 9:31:36 AM | 15.73 | 3.999 | 0.2224 | 3.933 | 62.904 | 0.087 | 3.51 | 15.780 | 3.9990 | 63.104 | 0.088 | 3.52 | 15.73 | −0.002 |
| 205 | May 8, 2012 | 9:31:41 AM | 15.73 | 4.000 | 0.2280 | 3.933 | 62.920 | 0.087 | 3.60 | 15.780 | 4.0000 | 63.120 | 0.088 | 3.61 | 15.73 | 0.000 |
| 210 | May 8, 2012 | 9:31:46 AM | 15.73 | 4.000 | 0.2335 | 3.933 | 62.920 | 0.087 | 3.68 | 15.780 | 4.0000 | 63.120 | 0.088 | 3.70 | 15.73 | 0.002 |
| 215 | May 8, 2012 | 9:31:51 AM | 15.73 | 4.000 | 0.2390 | 3.933 | 62.920 | 0.087 | 3.77 | 15.780 | 4.0000 | 63.120 | 0.088 | 3.78 | 15.73 | 0.004 |
| 220 | May 8, 2012 | 9:31:56 AM | 15.72 | 4.000 | 0.2446 | 3.930 | 62.880 | 0.087 | 3.86 | 15.770 | 4.0000 | 63.080 | 0.088 | 3.87 | 15.72 | −0.004 |
| 225 | May 8, 2012 | 9:32:01 AM | 15.72 | 4.000 | 0.2502 | 3.930 | 62.880 | 0.087 | 3.95 | 15.770 | 4.0000 | 63.080 | 0.088 | 3.96 | 15.72 | −0.002 |
| 230 | May 8, 2012 | 9:32:06 AM | 15.72 | 4.000 | 0.2557 | 3.930 | 62.880 | 0.087 | 4.03 | 15.770 | 4.0000 | 63.080 | 0.088 | 4.05 | 15.72 | 0.000 |
| 235 | May 8, 2012 | 9:32:11 AM | 15.72 | 4.000 | 0.2612 | 3.930 | 62.880 | 0.087 | 4.12 | 15.770 | 4.0000 | 63.080 | 0.088 | 4.13 | 15.72 | 0.002 |
| 240 | May 8, 2012 | 9:32:16 AM | 15.72 | 3.999 | 0.2668 | 3.930 | 62.864 | 0.087 | 4.21 | 15.770 | 3.9990 | 63.064 | 0.088 | 4.22 | 15.72 | 0.004 |
| 245 | May 8, 2012 | 9:32:21 AM | 15.71 | 4.000 | 0.2723 | 3.928 | 62.840 | 0.087 | 4.30 | 15.760 | 4.0000 | 63.040 | 0.088 | 4.31 | 15.71 | −0.005 |
| 250 | May 8, 2012 | 9:32:26 AM | 15.71 | 4.000 | 0.2779 | 3.928 | 62.840 | 0.087 | 4.38 | 15.760 | 4.0000 | 63.040 | 0.088 | 4.40 | 15.71 | −0.004 |
| 255 | May 8, 2012 | 9:32:31 AM | 15.71 | 4.000 | 0.2835 | 3.928 | 62.840 | 0.087 | 4.47 | 15.760 | 4.0000 | 63.040 | 0.088 | 4.48 | 15.71 | −0.002 |
| 260 | May 8, 2012 | 9:32:36 AM | 15.71 | 4.000 | 0.2890 | 3.928 | 62.840 | 0.087 | 4.56 | 15.760 | 4.0000 | 63.040 | 0.088 | 4.57 | 15.71 | 0.000 |
| 265 | May 8, 2012 | 9:32:41 AM | 15.71 | 4.000 | 0.2945 | 3.928 | 62.840 | 0.087 | 4.64 | 15.760 | 4.0000 | 63.040 | 0.088 | 4.66 | 15.71 | 0.002 |
| 270 | May 8, 2012 | 9:32:46 AM | 15.71 | 4.000 | 0.3001 | 3.928 | 62.840 | 0.087 | 4.73 | 15.760 | 4.0000 | 63.040 | 0.088 | 4.75 | 15.71 | 0.004 |
| 275 | May 8, 2012 | 9:32:51 AM | 15.71 | 3.999 | 0.3056 | 3.928 | 62.824 | 0.087 | 4.82 | 15.760 | 3.9990 | 63.024 | 0.088 | 4.83 | 15.71 | 0.005 |
| 280 | May 8, 2012 | 9:32:56 AM | 15.70 | 4.000 | 0.3112 | 3.925 | 62.800 | 0.087 | 4.91 | 15.750 | 4.0000 | 63.000 | 0.088 | 4.92 | 15.70 | −0.004 |
| 285 | May 8, 2012 | 9:33:01 AM | 15.70 | 4.000 | 0.3167 | 3.925 | 62.800 | 0.087 | 4.99 | 15.750 | 4.0000 | 63.000 | 0.088 | 5.01 | 15.70 | −0.002 |
| 290 | May 8, 2012 | 9:33:06 AM | 15.70 | 3.999 | 0.3223 | 3.925 | 62.784 | 0.087 | 5.08 | 15.750 | 3.9990 | 62.984 | 0.087 | 5.10 | 15.70 | 0.000 |
| 295 | May 8, 2012 | 9:33:11 AM | 15.70 | 4.000 | 0.3278 | 3.925 | 62.800 | 0.087 | 5.17 | 15.750 | 4.0000 | 63.000 | 0.088 | 5.18 | 15.70 | 0.002 |
| 300 | May 8, 2012 | 9:33:16 AM | 15.70 | 3.999 | 0.3334 | 3.925 | 62.784 | 0.087 | 5.25 | 15.750 | 3.9990 | 62.984 | 0.087 | 5.27 | 15.70 | 0.004 |
| 305 | May 8, 2012 | 9:33:21 AM | 15.69 | 4.000 | 0.3389 | 3.923 | 62.760 | 0.087 | 5.34 | 15.740 | 4.0000 | 62.960 | 0.087 | 5.36 | 15.69 | −0.005 |
| 310 | May 8, 2012 | 9:33:26 AM | 15.69 | 3.999 | 0.3444 | 3.923 | 62.744 | 0.087 | 5.43 | 15.740 | 3.9990 | 62.944 | 0.087 | 5.45 | 15.69 | −0.004 |
| 315 | May 8, 2012 | 9:33:31 AM | 15.69 | 4.000 | 0.3500 | 3.923 | 62.760 | 0.087 | 5.52 | 15.740 | 4.0000 | 62.960 | 0.087 | 5.53 | 15.69 | −0.002 |
| 320 | May 8, 2012 | 9:33:36 AM | 15.69 | 3.999 | 0.3555 | 3.923 | 62.744 | 0.087 | 5.60 | 15.740 | 3.9990 | 62.944 | 0.087 | 5.62 | 15.69 | 0.000 |
| 325 | May 8, 2012 | 9:33:41 AM | 15.69 | 3.999 | 0.3611 | 3.923 | 62.744 | 0.087 | 5.69 | 15.740 | 3.9990 | 62.944 | 0.087 | 5.71 | 15.69 | 0.002 |
| 330 | May 8, 2012 | 9:33:46 AM | 15.69 | 4.000 | 0.3666 | 3.923 | 62.760 | 0.087 | 5.78 | 15.740 | 4.0000 | 62.960 | 0.087 | 5.80 | 15.69 | 0.004 |
| 335 | May 8, 2012 | 9:33:51 AM | 15.69 | 3.999 | 0.3722 | 3.923 | 62.744 | 0.087 | 5.86 | 15.740 | 3.9990 | 62.944 | 0.087 | 5.88 | 15.69 | 0.005 |
| 340 | May 8, 2012 | 9:33:56 AM | 15.68 | 4.000 | 0.3777 | 3.920 | 62.720 | 0.087 | 5.95 | 15.730 | 4.0000 | 62.920 | 0.087 | 5.97 | 15.68 | −0.005 |
| 345 | May 8, 2012 | 9:34:01 AM | 15.68 | 4.000 | 0.3833 | 3.920 | 62.720 | 0.087 | 6.04 | 15.730 | 4.0000 | 62.920 | 0.087 | 6.06 | 15.68 | −0.004 |
| 350 | May 8, 2012 | 9:34:06 AM | 15.68 | 3.999 | 0.3888 | 3.920 | 62.704 | 0.087 | 6.13 | 15.730 | 3.9990 | 62.904 | 0.087 | 6.15 | 15.68 | 0.002 |
| 355 | May 8, 2012 | 9:34:11 AM | 15.68 | 4.000 | 0.3944 | 3.920 | 62.720 | 0.087 | 6.21 | 15.730 | 4.0000 | 62.920 | 0.087 | 6.23 | 15.68 | 0.000 |
| 360 | May 8, 2012 | 9:34:16 AM | 15.68 | 4.000 | 0.3999 | 3.920 | 62.720 | 0.087 | 6.30 | 15.730 | 4.0000 | 62.920 | 0.087 | 6.32 | 15.68 | 0.002 |
| 365 | May 8, 2012 | 9:34:21 AM | 15.68 | 3.999 | 0.4055 | 3.920 | 62.704 | 0.087 | 6.39 | 15.730 | 3.9990 | 62.904 | 0.087 | 6.41 | 15.68 | 0.004 |
| 370 | May 8, 2012 | 9:34:26 AM | 15.68 | 4.000 | 0.4110 | 3.920 | 62.720 | 0.087 | 6.47 | 15.730 | 4.0000 | 62.920 | 0.087 | 6.50 | 15.68 | 0.005 |
| 375 | May 8, 2012 | 9:34:31 AM | 15.67 | 3.999 | 0.4165 | 3.918 | 62.664 | 0.087 | 6.56 | 15.720 | 3.9990 | 62.864 | 0.087 | 6.58 | 15.67 | −0.005 |
| 380 | May 8, 2012 | 9:34:36 AM | 15.67 | 3.999 | 0.4221 | 3.918 | 62.664 | 0.087 | 6.65 | 15.720 | 3.9990 | 62.864 | 0.087 | 6.67 | 15.67 | −0.004 |
| 385 | May 8, 2012 | 9:34:41 AM | 15.67 | 4.000 | 0.4276 | 3.918 | 62.680 | 0.087 | 6.74 | 15.720 | 4.0000 | 62.880 | 0.087 | 6.76 | 15.67 | −0.002 |
| 390 | May 8, 2012 | 9:34:46 AM | 15.67 | 3.999 | 0.4332 | 3.918 | 62.664 | 0.087 | 6.82 | 15.720 | 3.9990 | 62.864 | 0.087 | 6.84 | 15.67 | 0.000 |
| 395 | May 8, 2012 | 9:34:51 AM | 15.67 | 3.999 | 0.4387 | 3.918 | 62.664 | 0.087 | 6.91 | 15.720 | 3.9990 | 62.864 | 0.087 | 6.93 | 15.67 | 0.002 |
| 400 | May 8, 2012 | 9:34:56 AM | 15.67 | 3.999 | 0.4443 | 3.918 | 62.664 | 0.087 | 7.00 | 15.720 | 3.9990 | 62.864 | 0.087 | 7.02 | 15.67 | 0.004 |
| 405 | May 8, 2012 | 9:35:01 AM | 15.67 | 3.999 | 0.4498 | 3.918 | 62.664 | 0.087 | 7.08 | 15.720 | 3.9990 | 62.864 | 0.087 | 7.11 | 15.67 | 0.005 |
| 410 | May 8, 2012 | 9:35:06 AM | 15.66 | 3.999 | 0.4553 | 3.915 | 62.624 | 0.087 | 7.17 | 15.710 | 3.9990 | 62.824 | 0.087 | 7.19 | 15.66 | −0.004 |
| 415 | May 8, 2012 | 9:35:11 AM | 15.66 | 3.999 | 0.4609 | 3.915 | 62.624 | 0.087 | 7.26 | 15.710 | 3.9990 | 62.824 | 0.087 | 7.28 | 15.66 | −0.002 |
| 420 | May 8, 2012 | 9:35:16 AM | 15.66 | 3.999 | 0.4664 | 3.915 | 62.624 | 0.087 | 7.34 | 15.710 | 3.9990 | 62.824 | 0.087 | 7.37 | 15.66 | 0.000 |
| 425 | May 8, 2012 | 9:35:21 AM | 15.66 | 3.999 | 0.4720 | 3.915 | 62.624 | 0.087 | 7.43 | 15.710 | 3.9990 | 62.824 | 0.087 | 7.46 | 15.66 | 0.002 |
| 430 | May 8, 2012 | 9:35:26 AM | 15.66 | 3.999 | 0.4775 | 3.915 | 62.624 | 0.087 | 7.52 | 15.710 | 3.9990 | 62.824 | 0.087 | 7.54 | 15.66 | 0.004 |
| 435 | May 8, 2012 | 9:35:31 AM | 15.65 | 3.999 | 0.4831 | 3.913 | 62.584 | 0.087 | 7.61 | 15.700 | 3.9990 | 62.784 | 0.087 | 7.63 | 15.65 | −0.005 |
| 440 | May 8, 2012 | 9:35:36 AM | 15.65 | 4.000 | 0.4886 | 3.913 | 62.600 | 0.087 | 7.69 | 15.700 | 4.0000 | 62.800 | 0.087 | 7.72 | 15.65 | −0.004 |
| 445 | May 8, 2012 | 9:35:41 AM | 15.65 | 4.000 | 0.4942 | 3.913 | 62.600 | 0.087 | 7.78 | 15.700 | 4.0000 | 62.800 | 0.087 | 7.80 | 15.65 | −0.003 |
| 450 | May 8, 2012 | 9:35:46 AM | 15.65 | 3.999 | 0.4997 | 3.913 | 62.584 | 0.087 | 7.87 | 15.700 | 3.9990 | 62.784 | 0.087 | 7.89 | 15.65 | −0.001 |
| 455 | May 8, 2012 | 9:35:51 AM | 15.65 | 3.999 | 0.5053 | 3.913 | 62.584 | 0.087 | 7.95 | 15.700 | 3.9990 | 62.784 | 0.087 | 7.98 | 15.65 | 0.001 |
| 460 | May 8, 2012 | 9:35:56 AM | 15.65 | 3.999 | 0.5108 | 3.913 | 62.584 | 0.087 | 8.04 | 15.700 | 3.9990 | 62.784 | 0.087 | 8.07 | 15.65 | 0.003 |
| 465 | May 8, 2012 | 9:36:01 AM | 15.65 | 4.000 | 0.5160 | 3.913 | 62.600 | 0.087 | 8.13 | 15.700 | 4.0000 | 62.800 | 0.087 | 8.15 | 15.65 | 0.004 |
| 470 | May 8, 2012 | 9:36:06 AM | 15.65 | 3.999 | 0.5217 | 3.913 | 62.584 | 0.087 | 8.21 | 15.700 | 3.9990 | 62.784 | 0.087 | 8.24 | 15.65 | 0.005 |
| 475 | May 8, 2012 | 9:36:11 AM | 15.64 | 3.999 | 0.5273 | 3.910 | 62.544 | 0.087 | 8.30 | 15.690 | 3.9990 | 62.744 | 0.087 | 8.33 | 15.64 | −0.005 |
| 480 | May 8, 2012 | 9:36:16 AM | 15.64 | 3.999 | 0.5328 | 3.910 | 62.544 | 0.087 | 8.39 | 15.690 | 3.9990 | 62.744 | 0.087 | 8.41 | 15.64 | −0.004 |
| 485 | May 8, 2012 | 9:36:21 AM | 15.64 | 3.999 | 0.5384 | 3.910 | 62.544 | 0.087 | 8.47 | 15.690 | 3.9990 | 62.744 | 0.087 | 8.50 | 15.64 | −0.003 |
| 490 | May 8, 2012 | 9:36:26 AM | 15.64 | 3.999 | 0.5439 | 3.910 | 62.544 | 0.087 | 8.56 | 15.690 | 3.9990 | 62.744 | 0.087 | 8.59 | 15.64 | −0.001 |
| 495 | May 8, 2012 | 9:36:31 AM | 15.64 | 3.999 | 0.5495 | 3.910 | 62.544 | 0.087 | 8.65 | 15.690 | 3.9990 | 62.744 | 0.087 | 8.68 | 15.64 | 0.001 |
| 500 | May 8, 2012 | 9:36:36 AM | 15.64 | 3.999 | 0.5550 | 3.910 | 62.544 | 0.087 | 8.74 | 15.690 | 3.9990 | 62.744 | 0.087 | 8.76 | 15.64 | 0.003 |
| 505 | May 8, 2012 | 9:36:41 AM | 15.64 | 3.999 | 0.5605 | 3.910 | 62.544 | 0.087 | 8.82 | 15.690 | 3.9990 | 62.744 | 0.087 | 8.85 | 15.64 | 0.004 |
| 510 | May 8, 2012 | 9:36:46 AM | 15.64 | 3.999 | 0.5663 | 3.910 | 62.544 | 0.087 | 8.91 | 15.690 | 3.9990 | 62.744 | 0.087 | 8.94 | 15.64 | 0.005 |
| 515 | May 8, 2012 | 9:36:51 AM | 15.63 | 3.999 | 0.5718 | 3.908 | 62.504 | 0.087 | 9.00 | 15.680 | 3.9990 | 62.704 | 0.087 | 9.02 | 15.63 | −0.005 |
| 520 | May 8, 2012 | 9:36:56 AM | 15.63 | 3.999 | 0.5772 | 3.908 | 62.504 | 0.087 | 9.08 | 15.680 | 3.9990 | 62.704 | 0.087 | 9.11 | 15.63 | −0.004 |
| 525 | May 8, 2012 | 9:37:01 AM | 15.63 | 3.999 | 0.5827 | 3.908 | 62.504 | 0.087 | 9.17 | 15.680 | 3.9990 | 62.704 | 0.087 | 9.20 | 15.63 | −0.003 |
| 530 | May 8, 2012 | 9:37:06 AM | 15.63 | 3.999 | 0.5883 | 3.908 | 62.504 | 0.087 | 9.26 | 15.680 | 3.9990 | 62.704 | 0.087 | 9.29 | 15.63 | −0.001 |
| 535 | May 8, 2012 | 9:37:11 AM | 15.63 | 3.999 | 0.5938 | 3.908 | 62.504 | 0.087 | 9.34 | 15.680 | 3.9990 | 62.704 | 0.087 | 9.37 | 15.63 | 0.001 |
| 540 | May 8, 2012 | 9:37:16 AM | 15.63 | 3.999 | 0.5994 | 3.908 | 62.504 | 0.087 | 9.43 | 15.680 | 3.9990 | 62.704 | 0.087 | 9.46 | 15.63 | 0.003 |
| 545 | May 8, 2012 | 9:37:21 AM | 15.63 | 3.999 | 0.6049 | 3.908 | 62.504 | 0.087 | 9.52 | 15.680 | 3.9990 | 62.704 | 0.087 | 9.55 | 15.63 | 0.004 |
| 550 | May 8, 2012 | 9:37:26 AM | 15.63 | 3.999 | 0.6104 | 3.908 | 62.504 | 0.087 | 9.60 | 15.680 | 3.9990 | 62.704 | 0.087 | 9.63 | 15.63 | 0.005 |
| 555 | May 8, 2012 | 9:37:31 AM | 15.62 | 3.999 | 0.6160 | 3.905 | 62.464 | 0.087 | 9.69 | 15.670 | 3.9990 | 62.664 | 0.087 | 9.72 | 15.62 | −0.005 |
| 560 | May 8, 2012 | 9:37:36 AM | 15.62 | 3.999 | 0.6215 | 3.905 | 62.464 | 0.087 | 9.78 | 15.670 | 3.9990 | 62.664 | 0.087 | 9.81 | 15.62 | −0.004 |
| 565 | May 8, 2012 | 9:37:41 AM | 15.62 | 3.999 | 0.6271 | 3.905 | 62.464 | 0.087 | 9.86 | 15.670 | 3.9990 | 62.664 | 0.087 | 9.90 | 15.62 | −0.003 |
| 570 | May 8, 2012 | 9:37:46 AM | 15.62 | 3.999 | 0.6326 | 3.905 | 62.464 | 0.087 | 9.95 | 15.670 | 3.9990 | 62.664 | 0.087 | 9.98 | 15.62 | −0.002 |
| 575 | May 8, 2012 | 9:37:51 AM | 15.62 | 3.999 | 0.6383 | 3.905 | 62.464 | 0.087 | 10.04 | 15.670 | 3.9990 | 62.664 | 0.087 | 10.07 | 15.62 | 0.000 |
| 580 | May 8, 2012 | 9:37:56 AM | 15.62 | 3.999 | 0.6439 | 3.905 | 62.464 | 0.087 | 10.12 | 15.670 | 3.9990 | 62.664 | 0.087 | 10.16 | 15.62 | 0.002 |
| 585 | May 8, 2012 | 9:38:01 AM | 15.62 | 3.999 | 0.6494 | 3.905 | 62.464 | 0.087 | 10.21 | 15.670 | 3.9990 | 62.664 | 0.087 | 10.24 | 15.62 | 0.003 |
| 590 | May 8, 2012 | 9:38:06 AM | 15.62 | 3.999 | 0.6550 | 3.905 | 62.464 | 0.087 | 10.30 | 15.670 | 3.9990 | 62.664 | 0.087 | 10.33 | 15.62 | 0.004 |
| 595 | May 8, 2012 | 9:38:11 AM | 15.62 | 3.999 | 0.6605 | 3.905 | 62.464 | 0.087 | 10.38 | 15.670 | 3.9990 | 62.664 | 0.087 | 10.42 | 15.62 | 0.005 |
| 600 | May 8, 2012 | 9:38:16 AM | 15.61 | 3.999 | 0.6661 | 3.903 | 62.424 | 0.087 | 10.47 | 15.660 | 3.9990 | 62.624 | 0.087 | 10.50 | 15.61 | −0.005 |
| 605 | May 8, 2012 | 9:38:21 AM | 15.61 | 4.000 | 0.6716 | 3.903 | 62.440 | 0.087 | 10.56 | 15.660 | 4.0000 | 62.640 | 0.087 | 10.59 | 15.61 | −0.004 |
| 610 | May 8, 2012 | 9:38:26 AM | 15.61 | 3.999 | 0.6772 | 3.903 | 62.424 | 0.087 | 10.64 | 15.660 | 3.9990 | 62.624 | 0.087 | 10.68 | 15.61 | −0.003 |
| 615 | May 8, 2012 | 9:38:31 AM | 15.61 | 3.999 | 0.6827 | 3.903 | 62.424 | 0.087 | 10.73 | 15.660 | 3.9990 | 62.624 | 0.087 | 10.77 | 15.61 | −0.001 |
| 620 | May 8, 2012 | 9:38:36 AM | 15.61 | 3.999 | 0.6881 | 3.903 | 62.424 | 0.087 | 10.82 | 15.660 | 3.9990 | 62.624 | 0.087 | 10.85 | 15.61 | 0.001 |
| 625 | May 8, 2012 | 9:38:41 AM | 15.61 | 3.999 | 0.6938 | 3.903 | 62.424 | 0.087 | 10.90 | 15.660 | 3.9990 | 62.624 | 0.087 | 10.94 | 15.61 | 0.003 |
| 630 | May 8, 2012 | 9:38:46 AM | 15.61 | 3.999 | 0.6993 | 3.903 | 62.424 | 0.087 | 10.99 | 15.660 | 3.9990 | 62.624 | 0.087 | 11.03 | 15.61 | 0.004 |
| 635 | May 8, 2012 | 9:38:51 AM | 15.61 | 3.999 | 0.7049 | 3.903 | 62.424 | 0.087 | 11.08 | 15.660 | 3.9990 | 62.624 | 0.087 | 11.11 | 15.61 | 0.005 |
| 640 | May 8, 2012 | 9:38:56 AM | 15.60 | 3.999 | 0.7104 | 3.900 | 62.384 | 0.087 | 11.16 | 15.650 | 3.9990 | 62.584 | 0.087 | 11.20 | 15.60 | −0.005 |
| 645 | May 8, 2012 | 9:39:01 AM | 15.60 | 3.999 | 0.7160 | 3.900 | 62.384 | 0.087 | 11.25 | 15.650 | 3.9990 | 62.584 | 0.087 | 11.29 | 15.60 | −0.004 |
| 650 | May 8, 2012 | 9:39:06 AM | 15.60 | 3.999 | 0.7215 | 3.900 | 62.384 | 0.087 | 11.34 | 15.650 | 3.9990 | 62.584 | 0.087 | 11.37 | 15.60 | −0.003 |
| 655 | May 8, 2012 | 9:39:11 AM | 15.60 | 3.999 | 0.7271 | 3.900 | 62.384 | 0.087 | 11.42 | 15.650 | 3.9990 | 62.584 | 0.087 | 11.46 | 15.60 | −0.002 |
| 660 | May 8, 2012 | 9:39:16 AM | 15.60 | 3.999 | 0.7326 | 3.900 | 62.384 | 0.087 | 11.51 | 15.650 | 3.9990 | 62.584 | 0.087 | 11.55 | 15.60 | −0.001 |
| 665 | May 8, 2012 | 9:39:21 AM | 15.60 | 3.999 | 0.7382 | 3.900 | 62.384 | 0.087 | 11.60 | 15.650 | 3.9990 | 62.584 | 0.087 | 11.63 | 15.60 | 0.001 |
| 670 | May 8, 2012 | 9:39:26 AM | 15.60 | 3.999 | 0.7137 | 3.900 | 62.384 | 0.087 | 11.68 | 15.650 | 3.9990 | 62.584 | 0.087 | 11.72 | 15.60 | 0.002 |
| 675 | May 8, 2012 | 9:39:31 AM | 15.60 | 3.999 | 0.7493 | 3.900 | 62.384 | 0.087 | 11.77 | 15.650 | 3.9990 | 62.584 | 0.087 | 11.81 | 15.60 | 0.003 |
| 680 | May 8, 2012 | 9:39:36 AM | 15.60 | 3.999 | 0.7548 | 3.900 | 62.384 | 0.087 | 11.86 | 15.650 | 3.9990 | 62.584 | 0.087 | 11.90 | 15.60 | 0.004 |
| 685 | May 8, 2012 | 9:39:41 AM | 15.60 | 3.999 | 0.7604 | 3.900 | 62.384 | 0.087 | 11.94 | 15.650 | 3.9990 | 62.584 | 0.087 | 11.98 | 15.60 | 0.005 |
| 690 | May 8, 2012 | 9:39:46 AM | 15.59 | 3.999 | 0.7659 | 3.898 | 62.344 | 0.087 | 12.03 | 15.640 | 3.9990 | 62.544 | 0.087 | 12.07 | 15.59 | −0.005 |
| 695 | May 8, 2012 | 9:39:51 AM | 15.59 | 3.999 | 0.7715 | 3.898 | 62.344 | 0.087 | 12.12 | 15.640 | 3.9990 | 62.544 | 0.087 | 12.16 | 15.59 | −0.004 |
| 700 | May 8, 2012 | 9:39:56 AM | 15.59 | 3.999 | 0.7770 | 3.898 | 62.344 | 0.087 | 12.20 | 15.640 | 3.9990 | 62.544 | 0.087 | 12.24 | 15.59 | −0.003 |
| 705 | May 8, 2012 | 9:40:01 AM | 15.59 | 3.999 | 0.7826 | 3.898 | 62.344 | 0.087 | 12.29 | 15.640 | 3.9990 | 62.544 | 0.087 | 12.33 | 15.59 | −0.001 |
| 710 | May 8, 2012 | 9:40:06 AM | 15.59 | 3.999 | 0.7881 | 3.898 | 62.344 | 0.087 | 12.38 | 15.640 | 3.9990 | 62.544 | 0.087 | 12.42 | 15.59 | 0.001 |
| 715 | May 8, 2012 | 9:40:11 AM | 15.59 | 3.999 | 0.7936 | 3.898 | 62.344 | 0.087 | 12.46 | 15.640 | 3.9990 | 62.544 | 0.087 | 12.50 | 15.59 | 0.003 |
| 720 | May 8, 2012 | 9:40:16 AM | 15.59 | 3.999 | 0.7992 | 3.898 | 62.344 | 0.087 | 12.55 | 15.640 | 3.9990 | 62.544 | 0.087 | 12.59 | 15.59 | 0.004 |
| 725 | May 8, 2012 | 9:40:21 AM | 15.59 | 3.999 | 0.8047 | 3.898 | 62.344 | 0.087 | [symbol] | 15.640 | 3.9990 | 62.544 | 0.087 | 12.68 | 15.59 | 0.005 |
| 730 | May 8, 2012 | 9:40:26 AM | 15.58 | 3.999 | 0.8103 | 3.895 | 62.304 | 0.087 | 12.72 | 15.630 | 3.9990 | 62.504 | 0.087 | 12.76 | 15.58 | −0.005 |
| 735 | May 8, 2012 | 9:40:31 AM | 15.58 | 3.999 | 0.8158 | 3.895 | 62.304 | 0.087 | 12.81 | 15.630 | 3.9990 | 62.504 | 0.087 | 12.85 | 15.58 | −0.004 |
| 740 | May 8, 2012 | 9:40:36 AM | 15.58 | 3.999 | 0.8213 | 3.895 | 62.304 | 0.087 | 12.90 | 15.630 | 3.9990 | 62.504 | 0.087 | 12.94 | 15.58 | −0.003 |
| 745 | May 8, 2012 | 9:40:41 AM | 15.58 | 3.999 | 0.8269 | 3.895 | 62.304 | 0.087 | 12.98 | 15.630 | 3.9990 | 62.504 | 0.087 | 13.02 | 15.58 | −0.002 |
| 750 | May 8, 2012 | 9:40:46 AM | 15.58 | 3.999 | 0.8325 | 3.895 | 62.304 | 0.087 | 13.07 | 15.630 | 3.9990 | 62.504 | 0.087 | 13.11 | 15.58 | −0.001 |
| 755 | May 8, 2012 | 9:40:51 AM | 15.58 | 3.999 | 0.8380 | 3.895 | 62.304 | 0.087 | 13.16 | 15.630 | 3.9990 | 62.504 | 0.087 | 13.20 | 15.58 | 0.000 |
| 760 | May 8, 2012 | 9:40:56 AM | 15.58 | 3.999 | 0.8435 | 3.895 | 62.304 | 0.087 | 13.24 | 15.630 | 3.9990 | 62.504 | 0.087 | 13.29 | 15.58 | 0.001 |
| 765 | May 8, 2012 | 9:41:01 AM | 15.58 | 3.999 | 0.8491 | 3.895 | 62.304 | 0.087 | 13.33 | 15.630 | 3.9990 | 62.504 | 0.087 | 13.37 | 15.58 | 0.002 |
| 770 | May 8, 2012 | 9:41:06 AM | 15.58 | 3.999 | 0.8546 | 3.895 | 62.304 | 0.087 | 13.42 | 15.630 | 3.9990 | 62.504 | 0.087 | 13.46 | 15.58 | 0.003 |
| 775 | May 8, 2012 | 9:41:11 AM | 15.58 | 3.999 | 0.8602 | 3.895 | 62.304 | 0.087 | 13.50 | 15.630 | 3.9990 | 62.504 | 0.087 | 13.55 | 15.58 | 0.004 |
| 780 | May 8, 2012 | 9:41:16 AM | 15.58 | 3.999 | 0.8657 | 3.895 | 62.304 | 0.087 | 13.59 | 15.630 | 3.9990 | 62.504 | 0.087 | 13.63 | 15.58 | 0.005 |
| 785 | May 8, 2012 | 9:41:21 AM | 15.57 | 3.999 | 0.8713 | 3.893 | 62.264 | 0.086 | 13.68 | 15.620 | 3.9990 | 62.464 | 0.087 | 13.72 | 15.57 | −0.005 |
| 790 | May 8, 2012 | 9:41:26 AM | 15.57 | 3.999 | 0.8768 | 3.893 | 62.264 | 0.086 | 13.76 | 15.620 | 3.9990 | 62.464 | 0.087 | 13.81 | 15.57 | −0.004 |
| 795 | May 8, 2012 | 9:41:31 AM | 15.57 | 3.999 | 0.8824 | 3.893 | 62.264 | 0.086 | 13.85 | 15.620 | 3.9990 | 62.464 | 0.087 | 13.89 | 15.57 | −0.003 |
| 800 | May 8, 2012 | 9:41:36 AM | 15.57 | 3.999 | 0.8879 | 3.893 | 62.264 | 0.086 | 13.93 | 15.620 | 3.9990 | 62.464 | 0.087 | 13.98 | 15.57 | −0.002 |
| 805 | May 8, 2012 | 9:41:41 AM | 15.57 | 3.999 | 0.8935 | 3.893 | 62.264 | 0.086 | 14.02 | 15.620 | 3.9990 | 62.464 | 0.087 | 14.07 | 15.57 | 0.000 |
| 810 | May 8, 2012 | 9:41:46 AM | 15.57 | 3.999 | 0.8990 | 3.893 | 62.264 | 0.086 | 14.11 | 15.620 | 3.9990 | 62.464 | 0.087 | 14.15 | 15.57 | 0.002 |
| 815 | May 8, 2012 | 9:41:51 AM | 15.57 | 3.999 | 0.9046 | 3.893 | 62.264 | 0.086 | 14.19 | 15.620 | 3.9990 | 62.464 | 0.087 | 14.24 | 15.57 | 0.003 |
| 820 | May 8, 2012 | 9:41:56 AM | 15.57 | 3.999 | 0.9101 | 3.893 | 62.264 | 0.086 | 14.28 | 15.620 | 3.9990 | 62.464 | 0.087 | 14.33 | 15.57 | 0.004 |
| 825 | May 8, 2012 | 9:42:01 AM | 15.57 | 3.999 | 0.9156 | 3.893 | 62.264 | 0.086 | 14.37 | 15.620 | 3.9990 | 62.464 | 0.087 | 14.41 | 15.57 | 0.005 |
| 830 | May 8, 2012 | 9:42:06 AM | 15.56 | 3.999 | 0.9212 | 3.890 | 62.224 | 0.086 | 14.45 | 15.610 | 3.9990 | 62.424 | 0.087 | 14.50 | 15.56 | −0.005 |
| 835 | May 8, 2012 | 9:42:11 AM | 15.56 | 3.999 | 0.9267 | 3.890 | 62.224 | 0.086 | 14.54 | 15.610 | 3.9990 | 62.424 | 0.087 | 14.59 | 15.56 | −0.004 |
| 840 | May 8, 2012 | 9:42:16 AM | 15.56 | 3.999 | 0.9323 | 3.890 | 62.224 | 0.086 | 14.63 | 15.610 | 3.9990 | 62.424 | 0.087 | 14.67 | 15.56 | −0.003 |
| 845 | May 8, 2012 | 9:42:21 AM | 15.56 | 3.999 | 0.9378 | 3.890 | 62.224 | 0.086 | 14.71 | 15.610 | 3.9990 | 62.424 | 0.087 | 14.76 | 15.56 | −0.002 |
| 850 | May 8, 2012 | 9:42:26 AM | 15.56 | 3.999 | 0.9434 | 3.890 | 62.224 | 0.086 | 14.80 | 15.610 | 3.9990 | 62.424 | 0.087 | 14.85 | 15.56 | −0.001 |
| 855 | May 8, 2012 | 9:42:31 AM | 15.56 | 3.999 | 0.9489 | 3.890 | 62.224 | 0.086 | 14.89 | 15.610 | 3.9990 | 62.424 | 0.087 | 14.93 | 15.56 | 0.001 |
| 860 | May 8, 2012 | 9:42:36 AM | 15.56 | 3.999 | 0.9545 | 3.890 | 62.224 | 0.086 | 14.97 | 15.610 | 3.9990 | 62.424 | 0.087 | 15.02 | 15.56 | 0.002 |
| 865 | May 8, 2012 | 9:42:41 AM | 15.56 | 3.999 | 0.9600 | 3.890 | 62.224 | 0.086 | 15.06 | 15.610 | 3.9990 | 62.424 | 0.087 | 15.11 | 15.56 | 0.003 |
| 870 | May 8, 2012 | 9:42:46 AM | 15.56 | 3.999 | 0.9655 | 3.890 | 62.224 | 0.086 | 15.15 | 15.610 | 3.9990 | 62.424 | 0.087 | 15.19 | 15.56 | 0.004 |
| 875 | May 8, 2012 | 9:42:51 AM | 15.56 | 3.999 | 0.9711 | 3.890 | 62.224 | 0.086 | 15.23 | 15.610 | 3.9990 | 62.424 | 0.087 | 15.28 | 15.56 | 0.005 |
| 880 | May 8, 2012 | 9:42:56 AM | 15.55 | 3.999 | 0.9767 | 3.888 | 62.184 | 0.086 | 15.32 | 15.600 | 3.9990 | 62.384 | 0.087 | 15.37 | 15.55 | −0.005 |
| 885 | May 8, 2012 | 9:43:01 AM | 15.55 | 3.999 | 0.9822 | 3.888 | 62.184 | 0.086 | 15.40 | 15.600 | 3.9990 | 62.384 | 0.087 | 15.45 | 15.55 | −0.004 |
| 890 | May 8, 2012 | 9:43:06 AM | 15.55 | 3.999 | 0.9877 | 3.888 | 62.184 | 0.086 | 15.49 | 15.600 | 3.9990 | 62.384 | 0.087 | 15.54 | 15.55 | −0.003 |
| 895 | May 8, 2012 | 9:43:11 AM | 15.55 | 3.999 | 0.9933 | 3.888 | 62.184 | 0.086 | 15.58 | 15.600 | 3.9990 | 62.384 | 0.087 | 15.63 | 15.55 | −0.002 |
| 900 | May 8, 2012 | 9:43:16 AM | 15.55 | 3.999 | 0.9988 | 3.888 | 62.184 | 0.086 | 15.66 | 15.600 | 3.9990 | 62.384 | 0.087 | 15.71 | 15.55 | −0.001 |
| 905 | May 8, 2012 | 9:43:21 AM | 15.55 | 3.999 | 1.0044 | 3.888 | 62.184 | 0.086 | 15.75 | 15.600 | 3.9990 | 62.384 | 0.087 | 15.80 | 15.55 | 0.001 |
| 910 | May 8, 2012 | 9:43:26 AM | 15.55 | 3.999 | 1.0099 | 3.888 | 62.184 | 0.086 | 15.84 | 15.600 | 3.9990 | 62.384 | 0.087 | 15.89 | 15.55 | 0.002 |
| 915 | May 8, 2012 | 9:43:31 AM | 15.55 | 3.999 | 1.0155 | 3.888 | 62.184 | 0.086 | 15.92 | 15.600 | 3.9990 | 62.384 | 0.087 | 15.97 | 15.55 | 0.003 |
| 920 | May 8, 2012 | 9:43:36 AM | 15.55 | 3.999 | 1.0210 | 3.888 | 62.184 | 0.086 | 16.01 | 15.600 | 3.9990 | 62.384 | 0.087 | 16.06 | 15.55 | 0.004 |
| 925 | May 8, 2012 | 9:43:41 AM | 15.55 | 3.999 | 1.0266 | 3.888 | 62.184 | 0.086 | 16.10 | 15.600 | 3.9990 | 62.384 | 0.087 | 16.15 | 15.55 | 0.005 |
| 930 | May 8, 2012 | 9:43:46 AM | 15.54 | 3.999 | 1.0321 | 3.885 | 62.144 | 0.086 | 16.18 | 15.590 | 3.9990 | 62.344 | 0.087 | 16.23 | 15.54 | −0.005 |
| 935 | May 8, 2012 | 9:43:51 AM | 15.54 | 3.999 | 1.0377 | 3.885 | 62.144 | 0.086 | 16.27 | 15.590 | 3.9990 | 62.344 | 0.087 | 16.32 | 15.54 | −0.004 |
| 940 | May 8, 2012 | 9:43:56 AM | 15.54 | 3.999 | 1.0432 | 3.885 | 62.144 | 0.086 | 16.35 | 15.590 | 3.9990 | 62.344 | 0.087 | 16.41 | 15.54 | −0.003 |
| 945 | May 8, 2012 | 9:44:01 AM | 15.54 | 3.999 | 1.0487 | 3.885 | 62.144 | 0.086 | 16.44 | 15.590 | 3.9990 | 62.344 | 0.087 | 16.49 | 15.54 | −0.002 |
| 950 | May 8, 2012 | 9:44:06 AM | 15.54 | 3.999 | 1.0543 | 3.885 | 62.144 | 0.086 | 16.53 | 15.590 | 3.9990 | 62.344 | 0.087 | 16.58 | 15.54 | −0.001 |
| 955 | May 8, 2012 | 9:44:11 AM | 15.54 | 3.999 | 1.0598 | 3.885 | 62.144 | 0.086 | 16.61 | 15.590 | 3.9990 | 62.344 | 0.087 | 16.67 | 15.54 | 0.001 |
| 960 | May 8, 2012 | 9:44:16 AM | 15.54 | 3.999 | 1.0654 | 3.885 | 62.144 | 0.086 | 16.70 | 15.590 | 3.9990 | 62.344 | 0.087 | 16.75 | 15.54 | 0.002 |
| 965 | May 8, 2012 | 9:44:21 AM | 15.54 | 3.999 | 1.0709 | 3.885 | 62.144 | 0.086 | 16.79 | 15.590 | 3.9990 | 62.344 | 0.087 | 16.84 | 15.54 | 0.003 |
| 970 | May 8, 2012 | 9:44:26 AM | 15.54 | 3.999 | 1.0765 | 3.885 | 62.144 | 0.086 | 16.87 | 15.590 | 3.9990 | 62.344 | 0.087 | 16.93 | 15.54 | 0.004 |
| 975 | May 8, 2012 | 9:44:31 AM | 15.54 | 3.999 | 1.0820 | 3.885 | 62.144 | 0.086 | 16.96 | 15.590 | 3.9990 | 62.344 | 0.087 | 17.01 | 15.54 | 0.005 |
| 980 | May 8, 2012 | 9:44:36 AM | 15.53 | 3.999 | 1.0876 | 3.883 | 62.104 | 0.086 | 17.04 | 15.580 | 3.9990 | 62.304 | 0.087 | 17.10 | 15.53 | −0.005 |
| 985 | May 8, 2012 | 9:44:41 AM | 15.53 | 3.999 | 1.0931 | 3.883 | 62.104 | 0.086 | 17.13 | 15.580 | 3.9990 | 62.304 | 0.087 | 17.19 | 15.53 | −0.004 |
| 990 | May 8, 2012 | 9:44:46 AM | 15.53 | 3.999 | 1.0987 | 3.883 | 62.104 | 0.086 | 17.22 | 15.580 | 3.9990 | 62.304 | 0.087 | 17.27 | 15.53 | −0.003 |
| 995 | May 8, 2012 | 9:44:51 AM | 15.53 | 3.999 | 1.1042 | 3.883 | 62.104 | 0.086 | 17.30 | 15.580 | 3.9990 | 62.304 | 0.087 | 17.36 | 15.53 | −0.002 |
| ### | May 8, 2012 | 9:44:56 AM | 15.53 | 3.999 | 1.1097 | 3.883 | 62.104 | 0.086 | 17.39 | 15.580 | 3.9990 | 62.304 | 0.087 | 17.45 | 15.53 | 0.000 |
| ### | May 8, 2012 | 9:45:01 AM | 15.53 | 3.999 | 1.1153 | 3.883 | 62.104 | 0.086 | 17.48 | 15.580 | 3.9990 | 62.304 | 0.087 | 17.53 | 15.53 | 0.002 |
| ### | May 8, 2012 | 9:45:06 AM | 15.53 | 3.999 | 1.1208 | 3.883 | 62.104 | 0.086 | 17.56 | 15.580 | 3.9990 | 62.304 | 0.087 | 17.62 | 15.53 | 0.003 |
| ### | May 8, 2012 | 9:45:11 AM | 15.53 | 3.999 | 1.1264 | 3.883 | 62.104 | 0.086 | 17.65 | 15.580 | 3.9990 | 62.304 | 0.087 | 17.70 | 15.53 | 0.004 |
| ### | May 8, 2012 | 9:45:16 AM | 15.53 | 3.999 | 1.1319 | 3.883 | 62.104 | 0.086 | 17.73 | 15.580 | 3.9990 | 62.304 | 0.087 | 17.79 | 15.53 | 0.005 |
| ### | May 8, 2012 | 9:45:21 AM | 15.52 | 3.999 | 1.1375 | 3.880 | 62.064 | 0.086 | 17.82 | 15.570 | 3.9990 | 62.264 | 0.086 | 17.88 | 15.52 | −0.005 |
| ### | May 8, 2012 | 9:45:26 AM | 15.52 | 3.999 | 1.1430 | 3.880 | 62.064 | 0.086 | 17.91 | 15.570 | 3.9990 | 62.264 | 0.086 | 17.96 | 15.52 | −0.004 |
| ### | May 8, 2012 | 9:45:31 AM | 15.52 | 3.999 | 1.1485 | 3.880 | 62.064 | 0.086 | 17.99 | 15.570 | 3.9990 | 62.264 | 0.086 | 18.05 | 15.52 | −0.003 |
| ### | May 8, 2012 | 9:45:36 AM | 15.52 | 3.999 | 1.1541 | 3.880 | 62.064 | 0.086 | 18.08 | 15.570 | 3.9990 | 62.264 | 0.086 | 18.14 | 15.52 | −0.002 |
| ### | May 8, 2012 | 9:45:41 AM | 15.52 | 3.999 | 1.1596 | 3.880 | 62.064 | 0.086 | 18.17 | 15.570 | 3.9990 | 62.264 | 0.086 | 18.22 | 15.52 | −0.001 |
| ### | May 8, 2012 | 9:45:46 AM | 15.52 | 3.999 | 1.1652 | 3.880 | 62.064 | 0.086 | 18.25 | 15.570 | 3.9990 | 62.264 | 0.086 | 18.31 | 15.52 | 0.000 |
| ### | May 8, 2012 | 9:45:51 AM | 15.52 | 3.999 | 1.1707 | 3.880 | 62.064 | 0.086 | 18.34 | 15.570 | 3.9990 | 62.264 | 0.086 | 18.40 | 15.52 | 0.001 |
| ### | May 8, 2012 | 9:45:56 AM | 15.52 | 3.999 | 1.1763 | 3.880 | 62.064 | 0.086 | 18.42 | 15.570 | 3.9990 | 62.264 | 0.086 | 18.48 | 15.52 | 0.002 |
| ### | May 8, 2012 | 9:46:01 AM | 15.52 | 3.999 | 1.1818 | 3.880 | 62.064 | 0.086 | 18.51 | 15.570 | 3.9990 | 62.264 | 0.086 | 18.57 | 15.52 | 0.003 |
| ### | May 8, 2012 | 9:46:06 AM | 15.52 | 3.999 | 1.1874 | 3.880 | 62.064 | 0.086 | 18.60 | 15.570 | 3.9990 | 62.264 | 0.086 | 18.66 | 15.52 | 0.004 |
| ### | May 8, 2012 | 9:46:11 AM | 15.52 | 3.999 | 1.1929 | 3.880 | 62.064 | 0.086 | 18.68 | 15.570 | 3.9990 | 62.264 | 0.086 | 18.74 | 15.52 | 0.005 |
| ### | May 8, 2012 | 9:46:16 AM | 15.51 | 3.999 | 1.1985 | 3.878 | 62.024 | 0.086 | 18.77 | 15.560 | 3.9990 | 62.224 | 0.086 | 18.83 | 15.51 | −0.005 |
| ### | May 8, 2012 | 9:46:21 AM | 15.51 | 3.999 | 1.2040 | 3.878 | 62.024 | 0.086 | 18.86 | 15.560 | 3.9990 | 62.224 | 0.086 | 18.92 | 15.51 | −0.004 |
| ### | May 8, 2012 | 9:46:26 AM | 15.51 | 3.999 | 1.2095 | 3.878 | 62.024 | 0.086 | 18.94 | 15.560 | 3.9990 | 62.224 | 0.086 | 19.00 | 15.51 | −0.003 |
| ### | May 8, 2012 | 9:46:31 AM | 15.51 | 3.999 | 1.2151 | 3.878 | 62.024 | 0.086 | 19.03 | 15.560 | 3.9990 | 62.224 | 0.086 | 19.09 | 15.51 | −0.002 |
| ### | May 8, 2012 | 9:46:36 AM | 15.51 | 3.999 | 1.2206 | 3.878 | 62.024 | 0.086 | 19.11 | 15.560 | 3.9990 | 62.224 | 0.086 | 19.17 | 15.51 | −0.001 |
| ### | May 8, 2012 | 9:46:41 AM | 15.51 | 3.999 | 1.2262 | 3.878 | 62.024 | 0.086 | [symbol] | 15.560 | 3.9990 | 62.224 | 0.086 | 19.26 | 15.51 | 0.001 |
| ### | May 8, 2012 | 9:46:46 AM | 15.51 | 3.999 | 1.2317 | 3.878 | 62.024 | 0.086 | 19.29 | 15.560 | 3.9990 | 62.224 | 0.086 | 19.35 | 15.51 | 0.002 |
| ### | May 8, 2012 | 9:46:51 AM | 15.51 | 3.999 | 1.2373 | 3.878 | 62.024 | 0.086 | 19.37 | 15.560 | 3.9990 | 62.224 | 0.086 | 19.43 | 15.51 | 0.003 |
| ### | May 8, 2012 | 9:46:56 AM | 15.51 | 3.999 | 1.2428 | 3.878 | 62.024 | 0.086 | 19.46 | 15.560 | 3.9990 | 62.224 | 0.086 | 19.52 | 15.51 | 0.004 |
| ### | May 8, 2012 | 9:47:01 AM | 15.51 | 3.999 | 1.2484 | 3.878 | 62.024 | 0.086 | 19.54 | 15.560 | 3.9990 | 62.224 | 0.086 | 19.67 | 15.51 | 0.005 |
| ### | May 8, 2012 | 9:47:06 AM | 15.50 | 3.999 | 1.2540 | 3.875 | 61.985 | 0.086 | 19.63 | 15.550 | 3.9990 | 62.184 | 0.086 | 19.69 | 15.50 | −0.005 |
| ### | May 8, 2012 | 9:47:11 AM | 15.50 | 3.999 | 1.2595 | 3.875 | 61.985 | 0.086 | 19.72 | 15.550 | 3.9990 | 62.184 | 0.086 | 19.78 | 15.50 | −0.004 |
| ### | May 8, 2012 | 9:47:16 AM | 15.50 | 3.999 | 1.2650 | 3.875 | 61.985 | 0.086 | 19.80 | 15.550 | 3.9990 | 62.184 | 0.086 | 19.87 | 15.50 | −0.003 |
| ### | May 8, 2012 | 9:47:21 AM | 15.50 | 3.999 | 1.2706 | 3.875 | 61.985 | 0.086 | 19.89 | 15.550 | 3.9990 | 62.184 | 0.086 | 19.95 | 15.50 | −0.002 |
| ### | May 8, 2012 | 9:47:26 AM | 15.50 | 3.999 | 1.2761 | 3.875 | 61.985 | 0.086 | 19.97 | 15.550 | 3.9990 | 62.184 | 0.086 | 20.04 | 15.50 | −0.001 |
| ### | May 8, 2012 | 9:47:31 AM | 15.50 | 3.999 | 1.2817 | 3.875 | 61.985 | 0.086 | 20.06 | 15.550 | 3.9990 | 62.184 | 0.086 | 20.13 | 15.50 | 0.001 |
| ### | May 8, 2012 | 9:47:36 AM | 15.50 | 3.999 | 1.2872 | 3.875 | 61.985 | 0.086 | 20.15 | 15.550 | 3.9990 | 62.184 | 0.086 | 20.21 | 15.50 | 0.002 |
| ### | May 8, 2012 | 9:47:41 AM | 15.50 | 3.999 | 1.2928 | 3.875 | 61.985 | 0.086 | 20.23 | 15.550 | 3.9990 | 62.184 | 0.086 | 20.30 | 15.50 | 0.003 |
| ### | May 8, 2012 | 9:47:46 AM | 15.50 | 3.999 | 1.2983 | 3.875 | 61.985 | 0.086 | 20.32 | 15.550 | 3.9990 | 62.184 | 0.086 | 20.38 | 15.50 | 0.004 |
| ### | May 8, 2012 | 9:47:51 AM | 15.50 | 3.999 | 1.3038 | 3.875 | 61.985 | 0.086 | 20.41 | 15.550 | 3.9990 | 62.184 | 0.086 | 20.47 | 15.50 | 0.005 |
| ### | May 8, 2012 | 9:47:58 AM | 15.49 | 3.999 | 1.3094 | 3.873 | 61.945 | 0.086 | 20.49 | 15.540 | 3.9990 | 62.144 | 0.086 | 20.56 | 15.49 | −0.005 |
| ### | May 8, 2012 | 9:48:01 AM | 15.49 | 3.999 | 1.3149 | 3.873 | 61.945 | 0.086 | 20.58 | 15.540 | 3.9990 | 62.144 | 0.086 | 20.64 | 15.49 | −0.004 |
| ### | May 8, 2012 | 9:48:06 AM | 15.49 | 3.999 | 1.3203 | 3.873 | 61.945 | 0.086 | 20.66 | 15.540 | 3.9990 | 62.144 | 0.086 | 20.73 | 15.49 | −0.003 |
| ### | May 8, 2012 | 9:48:11 AM | 15.49 | 3.999 | 1.3258 | 3.873 | 61.945 | 0.086 | 20.75 | 15.540 | 3.9990 | 62.144 | 0.086 | 20.82 | 15.49 | −0.002 |
| ### | May 8, 2012 | 9:48:16 AM | 15.49 | 3.999 | 1.3314 | 3.873 | 61.945 | 0.086 | 20.84 | 15.540 | 3.9990 | 62.144 | 0.086 | 20.90 | 15.49 | −0.001 |
| ### | May 8, 2012 | 9:48:21 AM | 15.49 | 3.999 | 1.3369 | 3.873 | 61.945 | 0.086 | 20.92 | 15.540 | 3.9990 | 62.144 | 0.086 | 20.99 | 15.49 | 0.000 |
| ### | May 8, 2012 | 9:48:26 AM | 15.49 | 3.999 | 1.3425 | 3.873 | 61.945 | 0.086 | 21.01 | 15.540 | 3.9990 | 62.144 | 0.086 | 21.07 | 15.49 | 0.001 |
| ### | May 8, 2012 | 9:48:31 AM | 15.49 | 3.999 | 1.3480 | 3.873 | 61.945 | 0.086 | 21.09 | 15.540 | 3.9990 | 62.144 | 0.086 | 21.16 | 15.49 | 0.002 |
| ### | May 8, 2012 | 9:48:36 AM | 15.49 | 3.999 | 1.3536 | 3.873 | 61.945 | 0.086 | 21.18 | 15.540 | 3.9990 | 62.144 | 0.086 | 21.25 | 15.49 | 0.003 |
| ### | May 8, 2012 | 9:48:41 AM | 15.49 | 3.999 | 1.3591 | 3.873 | 61.945 | 0.086 | 21.27 | 15.540 | 3.9990 | 62.144 | 0.086 | 21.33 | 15.49 | 0.004 |
| ### | May 8, 2012 | 9:48:46 AM | 15.49 | 3.999 | 1.3647 | 3.873 | 61.945 | 0.086 | 21.35 | 15.540 | 3.9990 | 62.144 | 0.086 | 21.42 | 15.49 | 0.005 |
| ### | May 8, 2012 | 9:48:51 AM | 15.48 | 3.999 | 1.3702 | 3.870 | 61.905 | 0.086 | 21.44 | 15.530 | 3.9990 | 62.104 | 0.086 | 21.51 | 15.48 | −0.005 |
| ### | May 8, 2012 | 9:48:56 AM | 15.48 | 3.999 | 1.3758 | 3.870 | 61.905 | 0.086 | 21.52 | 15.530 | 3.9990 | 62.104 | 0.086 | 21.59 | 15.48 | −0.004 |
| ### | May 8, 2012 | 9:49:01 AM | 15.48 | 3.999 | 1.3813 | 3.870 | 61.905 | 0.086 | 21.61 | 15.530 | 3.9990 | 62.104 | 0.086 | 21.68 | 15.48 | −0.003 |
| ### | May 8, 2012 | 9:49:06 AM | 15.48 | 3.999 | 1.3868 | 3.870 | 61.905 | 0.086 | 21.70 | 15.530 | 3.9990 | 62.104 | 0.086 | 21.76 | 15.48 | −0.002 |
| ### | May 8, 2012 | 9:49:11 AM | 15.48 | 3.999 | 1.3924 | 3.870 | 61.905 | 0.086 | 21.78 | 15.530 | 3.9990 | 62.104 | 0.086 | 21.85 | 15.48 | 0.000 |
| ### | May 8, 2012 | 9:49:16 AM | 15.48 | 3.999 | 1.3979 | 3.870 | 61.905 | 0.086 | 21.87 | 15.530 | 3.9990 | 62.104 | 0.086 | 21.94 | 15.48 | 0.002 |
| ### | May 8, 2012 | 9:49:21 AM | 15.48 | 3.999 | 1.4035 | 3.870 | 61.905 | 0.086 | 21.95 | 15.530 | 3.9990 | 62.104 | 0.086 | 22.02 | 15.48 | 0.003 |
| ### | May 8, 2012 | 9:49:26 AM | 15.48 | 3.999 | 1.4090 | 3.870 | 61.905 | 0.086 | 22.04 | 15.530 | 3.9990 | 62.104 | 0.086 | 22.11 | 15.48 | 0.004 |
| ### | May 8, 2012 | 9:49:31 AM | 15.48 | 3.999 | 1.4146 | 3.870 | 61.905 | 0.086 | 22.13 | 15.530 | 3.9990 | 62.104 | 0.086 | 22.20 | 15.48 | 0.005 |
| ### | May 8, 2012 | 9:49:36 AM | 15.47 | 3.999 | 1.4201 | 3.868 | 61.865 | 0.086 | 22.21 | 15.520 | 3.9990 | 62.064 | 0.086 | 22.28 | 15.47 | −0.005 |
| ### | May 8, 2012 | 9:49:41 AM | 15.47 | 3.999 | 1.4257 | 3.868 | 61.865 | 0.086 | 22.30 | 15.520 | 3.9990 | 62.064 | 0.086 | 22.37 | 15.47 | −0.004 |
| ### | May 8, 2012 | 9:49:46 AM | 15.47 | 3.999 | 1.4312 | 3.868 | 61.865 | 0.086 | 22.38 | 15.520 | 3.9990 | 62.064 | 0.086 | 22.45 | 15.47 | −0.003 |
| ### | May 8, 2012 | 9:49:51 AM | 15.47 | 3.999 | 1.4368 | 3.868 | 61.865 | 0.086 | 22.47 | 15.520 | 3.9990 | 62.064 | 0.086 | 22.54 | 15.47 | −0.002 |
| ### | May 8, 2012 | 9:49:56 AM | 15.47 | 3.999 | 1.4423 | 3.868 | 61.865 | 0.086 | 22.56 | 15.520 | 3.9990 | 62.064 | 0.086 | 22.63 | 15.47 | −0.001 |
| ### | May 8, 2012 | 9:50:01 AM | 15.47 | 3.999 | 1.4478 | 3.868 | 61.865 | 0.086 | 22.64 | 15.520 | 3.9990 | 62.064 | 0.086 | 22.71 | 15.47 | 0.000 |
| ### | May 8, 2012 | 9:50:06 AM | 15.47 | 3.999 | 1.4534 | 3.868 | 61.865 | 0.086 | 22.73 | 15.520 | 3.9990 | 62.064 | 0.086 | 22.80 | 15.47 | 0.001 |
| ### | May 8, 2012 | 9:50:11 AM | 15.47 | 3.999 | 1.4589 | 3.868 | 61.865 | 0.086 | 22.81 | 15.520 | 3.9990 | 62.064 | 0.086 | 22.89 | 15.47 | 0.002 |
| ### | May 8, 2012 | 9:50:16 AM | 15.47 | 3.999 | 1.4645 | 3.868 | 61.865 | 0.086 | 22.90 | 15.520 | 3.9990 | 62.064 | 0.086 | 22.97 | 15.47 | 0.003 |
| ### | May 8, 2012 | 9:50:21 AM | 15.47 | 3.999 | 1.4701 | 3.868 | 61.865 | 0.086 | 22.98 | 15.520 | 3.9990 | 62.064 | 0.086 | 23.06 | 15.47 | 0.004 |
| ### | May 8, 2012 | 9:50:26 AM | 15.47 | 3.999 | 1.4756 | 3.868 | 61.865 | 0.086 | 23.07 | 15.520 | 3.9990 | 62.064 | 0.086 | 23.14 | 15.47 | 0.005 |
| ### | May 8, 2012 | 9:50:31 AM | 15.46 | 3.999 | 1.4811 | 3.865 | 61.825 | 0.086 | 23.16 | 15.510 | 3.9990 | 62.024 | 0.086 | 23.23 | 15.46 | −0.005 |
| ### | May 8, 2012 | 9:50:36 AM | 15.46 | 4.000 | 1.4868 | 3.865 | 61.840 | 0.086 | 23.24 | 15.510 | 4.0000 | 62.040 | 0.086 | 23.32 | 15.46 | −0.004 |
| ### | May 8, 2012 | 9:50:41 AM | 15.46 | 3.999 | 1.4924 | 3.865 | 61.825 | 0.086 | 23.33 | 15.510 | 3.9990 | 62.024 | 0.086 | 23.40 | 15.46 | −0.003 |
| ### | May 8, 2012 | 9:50:46 AM | 15.46 | 3.999 | 1.4977 | 3.865 | 61.825 | 0.086 | 23.41 | 15.510 | 3.9990 | 62.024 | 0.086 | 23.49 | 15.46 | −0.001 |
| ### | May 8, 2012 | 9:50:51 AM | 15.46 | 3.999 | 1.5033 | 3.865 | 61.825 | 0.086 | 23.50 | 15.510 | 3.9990 | 62.024 | 0.086 | 23.58 | 15.46 | 0.001 |
| ### | May 8, 2012 | 9:50:56 AM | 15.46 | 3.999 | 1.5088 | 3.865 | 61.825 | 0.086 | 23.59 | 15.510 | 3.9990 | 62.024 | 0.086 | 23.66 | 15.46 | 0.003 |
| ### | May 8, 2012 | 9:51:01 AM | 15.46 | 3.999 | 1.5144 | 3.865 | 61.825 | 0.086 | 23.67 | 15.510 | 3.9990 | 62.024 | 0.086 | 23.75 | 15.46 | 0.004 |
| ### | May 8, 2012 | 9:51:06 AM | 15.46 | 3.999 | 1.5199 | 3.865 | 61.825 | 0.086 | 23.76 | 15.510 | 3.9990 | 62.024 | 0.086 | 23.83 | 15.46 | 0.005 |
| ### | May 8, 2012 | 9:51:11 AM | 15.45 | 3.999 | 1.5255 | 3.863 | 61.785 | 0.086 | 23.84 | 15.500 | 3.9990 | 61.985 | 0.086 | 23.92 | 15.45 | −0.005 |
| ### | May 8, 2012 | 9:51:16 AM | 15.45 | 3.999 | 1.5310 | 3.863 | 61.785 | 0.086 | 23.93 | 15.500 | 3.9990 | 61.985 | 0.086 | 24.01 | 15.45 | −0.004 |
| ### | May 8, 2012 | 9:51:21 AM | 15.45 | 3.999 | 1.5366 | 3.863 | 61.785 | 0.086 | 24.01 | 15.500 | 3.9990 | 61.985 | 0.086 | 24.09 | 15.45 | −0.003 |
| ### | May 8, 2012 | 9:51:26 AM | 15.45 | 3.999 | 1.5421 | 3.863 | 61.785 | 0.086 | 24.10 | 15.500 | 3.9990 | 61.985 | 0.086 | 24.18 | 15.45 | −0.002 |
| ### | May 8, 2012 | 9:51:31 AM | 15.45 | 3.999 | 1.5477 | 3.863 | 61.785 | 0.086 | 24.19 | 15.500 | 3.9990 | 61.985 | 0.086 | 24.26 | 15.45 | −0.001 |
| ### | May 8, 2012 | 9:51:36 AM | 15.45 | 3.999 | 1.5533 | 3.863 | 61.785 | 0.086 | 24.27 | 15.500 | 3.9990 | 61.985 | 0.086 | 24.35 | 15.45 | 0.001 |
| ### | May 8, 2012 | 9:51:41 AM | 15.45 | 3.999 | 1.5588 | 3.863 | 61.785 | 0.086 | 24.36 | 15.500 | 3.9990 | 61.985 | 0.086 | 24.44 | 15.45 | 0.002 |
| ### | May 8, 2012 | 9:51:46 AM | 15.45 | 3.999 | 1.5643 | 3.863 | 61.785 | 0.086 | 24.44 | 15.500 | 3.9990 | 61.985 | 0.086 | 24.52 | 15.45 | 0.003 |
| ### | May 8, 2012 | 9:51:51 AM | 15.45 | 3.999 | 1.5699 | 3.863 | 61.785 | 0.086 | 24.53 | 15.500 | 3.9990 | 61.985 | 0.086 | 24.61 | 15.45 | 0.004 |
| ### | May 8, 2012 | 9:51:56 AM | 15.45 | 3.999 | 1.5754 | 3.863 | 61.785 | 0.086 | 24.62 | 15.500 | 3.9990 | 61.985 | 0.086 | 24.69 | 15.45 | 0.005 |
| ### | May 8, 2012 | 9:52:01 AM | 15.44 | 3.999 | 1.5809 | 3.860 | 61.745 | 0.086 | 24.70 | 15.490 | 3.9990 | 61.945 | 0.086 | 24.78 | 15.44 | −0.005 |
| ### | May 8, 2012 | 9:52:06 AM | 15.44 | 3.999 | 1.5865 | 3.860 | 61.745 | 0.086 | 24.79 | 15.490 | 3.9990 | 61.945 | 0.086 | 24.87 | 15.44 | −0.004 |
| ### | May 8, 2012 | 9:52:11 AM | 15.44 | 3.999 | 1.5921 | 3.860 | 61.745 | 0.086 | 24.87 | 15.490 | 3.9990 | 61.945 | 0.086 | 24.95 | 15.44 | −0.003 |
| ### | May 8, 2012 | 9:52:16 AM | 15.44 | 3.999 | 1.5976 | 3.860 | 61.745 | 0.086 | 24.96 | 15.490 | 3.9990 | 61.945 | 0.086 | 25.04 | 15.44 | −0.002 |
| ### | May 8, 2012 | 9:52:21 AM | 15.44 | 3.999 | 1.6031 | 3.860 | 61.745 | 0.086 | 25.04 | 15.490 | 3.9990 | 61.945 | 0.086 | 25.12 | 15.44 | 0.000 |
| ### | May 8, 2012 | 9:52:26 AM | 15.44 | 3.999 | 1.6087 | 3.860 | 61.745 | 0.086 | 25.13 | 15.490 | 3.9990 | 61.945 | 0.086 | 25.21 | 15.44 | 0.002 |
| ### | May 8, 2012 | 9:52:31 AM | 15.44 | 3.999 | 1.6142 | 3.860 | 61.745 | 0.086 | 25.22 | 15.490 | 3.9990 | 61.945 | 0.086 | 25.30 | 15.44 | 0.003 |
| ### | May 8, 2012 | 9:52:36 AM | 15.44 | 3.999 | 1.6198 | 3.860 | 61.745 | 0.086 | 25.30 | 15.490 | 3.9990 | 61.945 | 0.086 | 25.38 | 15.44 | 0.004 |
| ### | May 8, 2012 | 9:52:41 AM | 15.44 | 3.999 | 1.6253 | 3.860 | 61.745 | 0.086 | 25.39 | 15.490 | 3.9990 | 61.945 | 0.086 | 25.47 | 15.44 | 0.005 |
| ### | May 8, 2012 | 9:52:46 AM | 15.43 | 3.999 | 1.6309 | 3.858 | 61.705 | 0.086 | 25.47 | 15.480 | 3.9990 | 61.905 | 0.086 | 25.55 | 15.43 | −0.005 |
| ### | May 8, 2012 | 9:52:51 AM | 15.43 | 3.999 | 1.6364 | 3.858 | 61.705 | 0.086 | 25.56 | 15.480 | 3.9990 | 61.905 | 0.086 | 25.64 | 15.43 | −0.004 |
| ### | May 8, 2012 | 9:52:56 AM | 15.43 | 3.999 | 1.6419 | 3.858 | 61.705 | 0.086 | 25.64 | 15.480 | 3.9990 | 61.905 | 0.086 | 25.73 | 15.43 | −0.003 |
| ### | May 8, 2012 | 9:53:01 AM | 15.43 | 3.999 | 1.6475 | 3.858 | 61.705 | 0.086 | [symbol] | [symbol] | 3.9990 | 61.905 | 0.086 | 25.81 | 15.43 | −0.002 |
| ### | May 8, 2012 | 9:53:06 AM | 15.43 | 3.999 | 1.6530 | 3.858 | 61.705 | 0.086 | 25.82 | 15.480 | 3.9990 | 61.905 | 0.086 | 25.90 | 15.43 | −0.001 |
| ### | May 8, 2012 | 9:53:11 AM | 15.43 | 3.999 | 1.6586 | 3.858 | 61.705 | 0.086 | 25.90 | 15.480 | 3.9990 | 61.905 | 0.086 | 25.98 | 15.43 | 0.000 |
| ### | May 8, 2012 | 9:53:16 AM | 15.43 | 3.999 | 1.6641 | 3.858 | 61.705 | 0.086 | 25.99 | 15.480 | 3.9990 | 61.905 | 0.086 | 26.07 | 15.43 | 0.001 |
| ### | May 8, 2012 | 9:53:21 AM | 15.43 | 3.999 | 1.6697 | 3.858 | 61.705 | 0.086 | 26.07 | 15.480 | 3.9990 | 61.905 | 0.086 | 26.16 | 15.43 | 0.002 |
| ### | May 8, 2012 | 9:53:26 AM | 15.43 | 3.999 | 1.6752 | 3.858 | 61.705 | 0.086 | 26.16 | 15.480 | 3.9990 | 61.905 | 0.086 | 26.24 | 15.43 | 0.003 |
| ### | May 8, 2012 | 9:53:31 AM | 15.43 | 3.999 | 1.6808 | 3.858 | 61.705 | 0.086 | 26.24 | 15.480 | 3.9990 | 61.905 | 0.086 | 26.33 | 15.43 | 0.004 |
| ### | May 8, 2012 | 9:53:36 AM | 15.43 | 3.999 | 1.6863 | 3.858 | 61.705 | 0.086 | 26.33 | 15.480 | 3.9990 | 61.905 | 0.086 | 26.41 | 15.43 | 0.005 |
| ### | May 8, 2012 | 9:53:41 AM | 15.42 | 3.999 | 1.6918 | 3.855 | 61.665 | 0.086 | 26.42 | 15.470 | 3.9990 | 61.865 | 0.086 | 26.50 | 15.42 | −0.005 |
| ### | May 8, 2012 | 9:53:46 AM | 15.42 | 3.999 | 1.6974 | 3.855 | 61.665 | 0.086 | 26.50 | 15.470 | 3.9990 | 61.865 | 0.086 | 26.59 | 15.42 | −0.004 |
| ### | May 8, 2012 | 9:53:51 AM | 15.42 | 3.999 | 1.7029 | 3.855 | 61.665 | 0.086 | 26.59 | 15.470 | 3.9990 | 61.865 | 0.086 | 26.67 | 15.42 | −0.003 |
| ### | May 8, 2012 | 9:53:56 AM | 15.42 | 3.999 | 1.7085 | 3.855 | 61.665 | 0.086 | 26.67 | 15.470 | 3.9990 | 61.865 | 0.086 | 26.76 | 15.42 | −0.001 |
| ### | May 8, 2012 | 9:54:01 AM | 15.42 | 3.999 | 1.7140 | 3.855 | 61.665 | 0.086 | 26.76 | 15.470 | 3.9990 | 61.865 | 0.086 | 26.84 | 15.42 | 0.001 |
| ### | May 8, 2012 | 9:54:06 AM | 15.42 | 3.999 | 1.7196 | 3.855 | 61.665 | 0.086 | 26.84 | 15.470 | 3.9990 | 61.865 | 0.086 | 26.93 | 15.42 | 0.003 |
| ### | May 8, 2012 | 9:54:11 AM | 15.42 | 3.999 | 1.7251 | 3.855 | 61.665 | 0.086 | 26.93 | 15.470 | 3.9990 | 61.865 | 0.086 | 27.02 | 15.42 | 0.004 |
| ### | May 8, 2012 | 9:54:16 AM | 15.42 | 3.999 | 1.7307 | 3.855 | 61.665 | 0.086 | 27.02 | 15.470 | 3.9990 | 61.865 | 0.086 | 27.10 | 15.42 | 0.005 |
| ### | May 8, 2012 | 9:54:21 AM | 15.41 | 3.999 | 1.7362 | 3.853 | 61.625 | 0.086 | 27.10 | 15.460 | 3.9990 | 61.825 | 0.086 | 27.19 | 15.41 | −0.005 |
| ### | May 8, 2012 | 9:54:26 AM | 15.41 | 3.999 | 1.7418 | 3.853 | 61.625 | 0.086 | 27.19 | 15.460 | 3.9990 | 61.825 | 0.086 | 27.27 | 15.41 | −0.004 |
| ### | May 8, 2012 | 9:54:31 AM | 15.41 | 3.999 | 1.7474 | 3.853 | 61.625 | 0.086 | 27.27 | 15.460 | 3.9990 | 61.825 | 0.086 | 27.36 | 15.41 | −0.003 |
| ### | May 8, 2012 | 9:54:36 AM | 15.41 | 3.999 | 1.7529 | 3.853 | 61.625 | 0.086 | 27.36 | 15.460 | 3.9990 | 61.825 | 0.086 | 27.45 | 15.41 | −0.002 |
| ### | May 8, 2012 | 9:54:41 AM | 15.41 | 3.999 | 1.7584 | 3.853 | 61.625 | 0.086 | 27.44 | 15.460 | 3.9990 | 61.825 | 0.086 | 27.53 | 15.41 | 0.000 |
| ### | May 8, 2012 | 9:54:46 AM | 15.41 | 3.999 | 1.7639 | 3.853 | 61.625 | 0.086 | 27.53 | 15.460 | 3.9990 | 61.825 | 0.086 | 27.62 | 15.41 | 0.002 |
| ### | May 8, 2012 | 9:54:51 AM | 15.41 | 3.999 | 1.7695 | 3.853 | 61.625 | 0.086 | 27.61 | 15.460 | 3.9990 | 61.825 | 0.086 | 27.70 | 15.41 | 0.003 |
| ### | May 8, 2012 | 9:54:56 AM | 15.41 | 3.999 | 1.7750 | 3.853 | 61.625 | 0.086 | 27.70 | 15.460 | 3.9990 | 61.825 | 0.086 | 27.79 | 15.41 | 0.004 |
| ### | May 8, 2012 | 9:55:01 AM | 15.41 | 3.999 | 1.7806 | 3.853 | 61.625 | 0.086 | 27.79 | 15.460 | 3.9990 | 61.825 | 0.086 | 27.87 | 15.41 | 0.005 |
| ### | May 8, 2012 | 9:55:06 AM | 15.40 | 3.999 | 1.7861 | 3.850 | 61.585 | 0.086 | 27.87 | 15.450 | 3.9990 | 61.785 | 0.086 | 27.96 | 15.40 | −0.005 |
| ### | May 8, 2012 | 9:55:11 AM | 15.40 | 3.999 | 1.7917 | 3.850 | 61.585 | 0.086 | 27.96 | 15.450 | 3.9990 | 61.785 | 0.086 | 28.05 | 15.40 | −0.004 |
| ### | May 8, 2012 | 9:55:16 AM | 15.40 | 4.000 | 1.7972 | 3.850 | 61.600 | 0.086 | 28.04 | 15.450 | 4.0000 | 61.800 | 0.086 | 28.13 | 15.40 | −0.003 |
| ### | May 8, 2012 | 9:55:21 AM | 15.40 | 3.999 | 1.8028 | 3.850 | 61.585 | 0.086 | 28.13 | 15.450 | 3.9990 | 61.785 | 0.086 | 28.22 | 15.40 | −0.002 |
| ### | May 8, 2012 | 9:55:26 AM | 15.40 | 3.999 | 1.8083 | 3.850 | 61.585 | 0.086 | 28.21 | 15.450 | 3.9990 | 61.785 | 0.086 | 28.30 | 15.40 | 0.000 |
| ### | May 8, 2012 | 9:55:31 AM | 15.40 | 3.999 | 1.8138 | 3.850 | 61.585 | 0.086 | 28.30 | 15.450 | 3.9990 | 61.785 | 0.086 | 28.39 | 15.40 | 0.002 |
| ### | May 8, 2012 | 9:55:36 AM | 15.40 | 3.999 | 1.8194 | 3.850 | 61.585 | 0.086 | 28.38 | 15.450 | 3.9990 | 61.785 | 0.086 | 28.48 | 15.40 | 0.003 |
| ### | May 8, 2012 | 9:55:41 AM | 15.40 | 3.999 | 1.8249 | 3.850 | 61.585 | 0.086 | 28.47 | 15.450 | 3.9990 | 61.785 | 0.086 | 28.56 | 15.40 | 0.004 |
| ### | May 8, 2012 | 9:55:46 AM | 15.40 | 3.999 | 1.8305 | 3.850 | 61.585 | 0.086 | 28.56 | 15.450 | 3.9990 | 61.785 | 0.086 | 28.65 | 15.40 | 0.005 |
| ### | May 8, 2012 | 9:55:51 AM | 15.39 | 3.999 | 1.8360 | 3.848 | 61.545 | 0.085 | 28.64 | 15.440 | 3.9990 | 61.745 | 0.086 | 28.73 | 15.39 | −0.005 |
| ### | May 8, 2012 | 9:55:56 AM | 15.39 | 3.999 | 1.8416 | 3.848 | 61.545 | 0.085 | 28.73 | 15.440 | 3.9990 | 61.745 | 0.086 | 28.82 | 15.39 | −0.004 |
| ### | May 8, 2012 | 9:56:01 AM | 15.39 | 3.999 | 1.8471 | 3.848 | 61.545 | 0.085 | 28.81 | 15.440 | 3.9990 | 61.745 | 0.086 | 28.90 | 15.39 | −0.003 |
| ### | May 8, 2012 | 9:56:06 AM | 15.39 | 3.999 | 1.8527 | 3.848 | 61.545 | 0.085 | 28.90 | 15.440 | 3.9990 | 61.745 | 0.086 | 28.99 | 15.39 | −0.002 |
| ### | May 8, 2012 | 9:56:11 AM | 15.39 | 3.999 | 1.8582 | 3.848 | 61.545 | 0.085 | 28.98 | 15.440 | 3.9990 | 61.745 | 0.086 | 29.08 | 15.39 | −0.001 |
| ### | May 8, 2012 | 9:56:16 AM | 15.39 | 3.999 | 1.8638 | 3.848 | 61.545 | 0.085 | 29.07 | 15.440 | 3.9990 | 61.745 | 0.086 | 29.16 | 15.39 | 0.001 |
| ### | May 8, 2012 | 9:56:21 AM | 15.39 | 3.999 | 1.8693 | 3.848 | 61.545 | 0.085 | 29.15 | 15.440 | 3.9990 | 61.745 | 0.086 | 29.25 | 15.39 | 0.002 |
| ### | May 8, 2012 | 9:56:26 AM | 15.39 | 3.999 | 1.8749 | 3.848 | 61.545 | 0.085 | 29.24 | 15.440 | 3.9990 | 61.745 | 0.086 | 29.33 | 15.39 | 0.003 |
| ### | May 8, 2012 | 9:56:31 AM | 15.39 | 3.999 | 1.8804 | 3.848 | 61.545 | 0.085 | 29.32 | 15.440 | 3.9990 | 61.745 | 0.086 | 29.42 | 15.39 | 0.004 |
| ### | May 8, 2012 | 9:56:36 AM | 15.39 | 3.999 | 1.8860 | 3.848 | 61.545 | 0.085 | 29.41 | 15.440 | 3.9990 | 61.745 | 0.086 | 29.50 | 15.39 | 0.005 |
| ### | May 8, 2012 | 9:56:41 AM | 15.38 | 3.999 | 1.8915 | 3.845 | 61.505 | 0.085 | 29.50 | 15.430 | 3.9990 | 61.705 | 0.086 | 29.59 | 15.38 | −0.005 |
| ### | May 8, 2012 | 9:56:46 AM | 15.38 | 3.999 | 1.8970 | 3.845 | 61.505 | 0.085 | 29.58 | 15.430 | 3.9990 | 61.705 | 0.086 | 29.68 | 15.38 | −0.004 |
| ### | May 8, 2012 | 9:56:51 AM | 15.38 | 3.999 | 1.9026 | 3.845 | 61.505 | 0.085 | 29.67 | 15.430 | 3.9990 | 61.705 | 0.086 | 29.76 | 15.38 | −0.003 |
| ### | May 8, 2012 | 9:56:56 AM | 15.38 | 3.999 | 1.9081 | 3.845 | 61.505 | 0.085 | 29.75 | 15.430 | 3.9990 | 61.705 | 0.086 | 29.85 | 15.38 | −0.001 |
| ### | May 8, 2012 | 9:57:01 AM | 15.38 | 3.999 | 1.9137 | 3.845 | 61.505 | 0.085 | 29.84 | 15.430 | 3.9990 | 61.705 | 0.086 | 29.93 | 15.38 | 0.001 |
| ### | May 8, 2012 | 9:57:06 AM | 15.38 | 3.999 | 1.9192 | 3.845 | 61.505 | 0.085 | 29.92 | 15.430 | 3.9990 | 61.705 | 0.086 | 30.02 | 15.38 | 0.003 |
| ### | May 8, 2012 | 9:57:11 AM | 15.38 | 3.999 | 1.9248 | 3.845 | 61.505 | 0.085 | 30.01 | 15.430 | 3.9990 | 61.705 | 0.086 | 30.10 | 15.38 | 0.004 |
| ### | May 8, 2012 | 9:57:16 AM | 15.38 | 3.999 | 1.9303 | 3.845 | 61.505 | 0.085 | 30.09 | 15.430 | 3.9990 | 61.705 | 0.086 | 30.19 | 15.38 | 0.005 |
| ### | May 8, 2012 | 9:57:21 AM | 15.37 | 3.999 | 1.9359 | 3.843 | 61.465 | 0.085 | 30.18 | 15.420 | 3.9990 | 61.665 | 0.086 | 30.28 | 15.37 | −0.005 |
| ### | May 8, 2012 | 9:57:26 AM | 15.37 | 3.999 | 1.9414 | 3.843 | 61.465 | 0.085 | 30.26 | 15.420 | 3.9990 | 61.665 | 0.086 | 30.36 | 15.37 | −0.004 |
| ### | May 8, 2012 | 9:57:31 AM | 15.37 | 3.999 | 1.9469 | 3.843 | 61.465 | 0.085 | 30.35 | 15.420 | 3.9990 | 61.665 | 0.086 | 30.45 | 15.37 | −0.003 |
| ### | May 8, 2012 | 9:57:36 AM | 15.37 | 3.999 | 1.9525 | 3.843 | 61.465 | 0.085 | 30.44 | 15.420 | 3.9990 | 61.665 | 0.086 | 30.53 | 15.37 | −0.002 |
| ### | May 8, 2012 | 9:57:41 AM | 15.37 | 3.999 | 1.9580 | 3.843 | 61.465 | 0.085 | 30.52 | 15.420 | 3.9990 | 61.665 | 0.086 | 30.62 | 15.37 | 0.000 |
| ### | May 8, 2012 | 9:57:46 AM | 15.37 | 3.999 | 1.9636 | 3.843 | 61.465 | 0.085 | 30.61 | 15.420 | 3.9990 | 61.665 | 0.086 | 30.70 | 15.37 | 0.002 |
| ### | May 8, 2012 | 9:57:51 AM | 15.37 | 3.999 | 1.9691 | 3.843 | 61.465 | 0.085 | 30.69 | 15.420 | 3.9990 | 61.665 | 0.086 | 30.79 | 15.37 | 0.003 |
| ### | May 8, 2012 | 9:57:56 AM | 15.37 | 3.999 | 1.9747 | 3.843 | 61.465 | 0.085 | 30.78 | 15.420 | 3.9990 | 61.665 | 0.086 | 30.88 | 15.37 | 0.004 |
| ### | May 8, 2012 | 9:58:01 AM | 15.37 | 3.999 | 1.9802 | 3.843 | 61.465 | 0.085 | 30.86 | 15.420 | 3.9990 | 61.665 | 0.086 | 30.96 | 15.37 | 0.005 |
| ### | May 8, 2012 | 9:58:06 AM | 15.36 | 3.999 | 1.9858 | 3.840 | 61.425 | 0.085 | 30.95 | 15.410 | 3.9990 | 61.625 | 0.086 | 31.05 | 15.36 | −0.005 |
| ### | May 8, 2012 | 9:58:11 AM | 15.36 | 3.999 | 1.9913 | 3.840 | 61.425 | 0.085 | 31.03 | 15.410 | 3.9990 | 61.625 | 0.086 | 31.13 | 15.36 | −0.004 |
| ### | May 8, 2012 | 9:58:16 AM | 15.36 | 3.999 | 1.9970 | 3.840 | 61.425 | 0.085 | 31.12 | 15.410 | 3.9990 | 61.625 | 0.086 | 31.22 | 15.36 | −0.002 |
| ### | May 8, 2012 | 9:58:21 AM | 15.36 | 3.999 | 2.0025 | 3.840 | 61.425 | 0.085 | 31.20 | 15.410 | 3.9990 | 61.625 | 0.086 | 31.30 | 15.36 | 0.000 |
| ### | May 8, 2012 | 9:58:26 AM | 15.36 | 3.999 | 2.0079 | 3.840 | 61.425 | 0.085 | 31.29 | 15.410 | 3.9990 | 61.625 | 0.086 | 31.39 | 15.36 | 0.002 |
| ### | May 8, 2012 | 9:58:31 AM | 15.36 | 3.999 | 2.0135 | 3.840 | 61.425 | 0.085 | 31.37 | 15.410 | 3.9990 | 61.625 | 0.086 | 31.47 | 15.36 | 0.004 |
| ### | May 8, 2012 | 9:58:36 AM | 15.36 | 3.999 | 2.0190 | 3.840 | 61.425 | 0.085 | 31.46 | 15.410 | 3.9990 | 61.625 | 0.086 | 31.56 | 15.36 | 0.005 |
| ### | May 8, 2012 | 9:58:41 AM | 15.35 | 3.999 | 2.0246 | 3.838 | 61.385 | 0.085 | 31.54 | 15.400 | 3.9990 | 61.585 | 0.086 | 31.65 | 15.35 | −0.005 |
| ### | May 8, 2012 | 9:58:46 AM | 15.35 | 3.999 | 2.0301 | 3.838 | 61.385 | 0.085 | 31.63 | 15.400 | 3.9990 | 61.585 | 0.086 | 31.73 | 15.35 | −0.004 |
| ### | May 8, 2012 | 9:58:51 AM | 15.35 | 3.999 | 2.0357 | 3.838 | 61.385 | 0.085 | 31.71 | 15.400 | 3.9990 | 61.585 | 0.086 | 31.82 | 15.35 | −0.003 |
| ### | May 8, 2012 | 9:58:56 AM | 15.35 | 3.999 | 2.0412 | 3.838 | 61.385 | 0.085 | 31.80 | 15.400 | 3.9990 | 61.585 | 0.086 | 31.90 | 15.35 | −0.002 |
| ### | May 8, 2012 | 9:59:01 AM | 15.35 | 4.000 | 2.0468 | 3.838 | 61.400 | 0.085 | 31.89 | 15.400 | 4.0000 | 61.600 | 0.086 | 31.99 | 15.35 | 0.000 |
| ### | May 8, 2012 | 9:59:06 AM | 15.35 | 3.999 | 2.0523 | 3.838 | 61.385 | 0.085 | 31.97 | 15.400 | 3.9990 | 61.585 | 0.086 | 32.07 | 15.35 | 0.002 |
| ### | May 8, 2012 | 9:59:11 AM | 15.35 | 3.999 | 2.0578 | 3.838 | 61.385 | 0.085 | 32.06 | 15.400 | 3.9990 | 61.585 | 0.086 | 32.16 | 15.35 | 0.003 |
| ### | May 8, 2012 | 9:59:16 AM | 15.35 | 3.999 | 2.0634 | 3.838 | 61.385 | 0.085 | 32.14 | 15.400 | 3.9990 | 61.585 | 0.086 | 32.24 | 15.35 | 0.004 |
| ### | May 8, 2012 | 9:59:21 AM | 15.35 | 3.999 | 2.0689 | 3.838 | 61.345 | 0.085 | [symbol] | [symbol] | 3.9990 | 61.585 | 0.086 | 32.43 | 15.35 | 0.005 |
| ### | May 8, 2012 | 9:59:26 AM | 15.34 | 3.999 | 2.0745 | 3.835 | 61.345 | 0.085 | 32.31 | 15.390 | 3.9990 | 61.545 | 0.085 | 32.42 | 15.34 | −0.005 |
| ### | May 8, 2012 | 9:59:31 AM | 15.34 | 3.999 | 2.0800 | 3.835 | 61.345 | 0.085 | 32.40 | 15.390 | 3.9990 | 61.545 | 0.085 | 32.50 | 15.34 | −0.004 |
| ### | May 8, 2012 | 9:59:36 AM | 15.34 | 3.999 | 2.0856 | 3.835 | 61.345 | 0.085 | 32.48 | 15.390 | 3.9990 | 61.545 | 0.085 | 32.59 | 15.34 | −0.003 |
| ### | May 8, 2012 | 9:59:41 AM | 15.34 | 3.999 | 2.0912 | 3.835 | 61.345 | 0.085 | 32.57 | 15.390 | 3.9990 | 61.545 | 0.085 | 32.67 | 15.34 | −0.002 |
| ### | May 8, 2012 | 9:59:46 AM | 15.34 | 3.999 | 2.0967 | 3.835 | 61.345 | 0.085 | 32.65 | 15.390 | 3.9990 | 61.545 | 0.085 | 32.76 | 15.34 | 0.000 |
| ### | May 8, 2012 | 9:59:51 AM | 15.34 | 3.999 | 2.1022 | 3.835 | 61.345 | 0.085 | 32.74 | 15.390 | 3.9990 | 61.545 | 0.085 | 32.84 | 15.34 | 0.002 |
| ### | May 8, 2012 | 9:59:56 AM | 15.34 | 3.999 | 2.1078 | 3.835 | 61.345 | 0.085 | 32.82 | 15.390 | 3.9990 | 61.545 | 0.085 | 32.93 | 15.34 | 0.003 |
| ### | May 8, 2012 | 10:00:01 AM | 15.34 | 3.999 | 2.1133 | 3.835 | 61.345 | 0.085 | 32.91 | 15.390 | 3.9990 | 61.545 | 0.085 | 33.01 | 15.34 | 0.004 |
| ### | May 8, 2012 | 10:00:06 AM | 15.34 | 3.999 | 2.1189 | 3.835 | 61.345 | 0.085 | 32.99 | 15.390 | 3.9990 | 61.545 | 0.085 | 33.10 | 15.34 | 0.005 |
| ### | May 8, 2012 | 10:00:11 AM | 15.33 | 3.999 | 2.1244 | 3.833 | 61.305 | 0.085 | 33.08 | 15.380 | 3.9990 | 61.505 | 0.085 | 33.18 | 15.33 | −0.005 |
| ### | May 8, 2012 | 10:00:16 AM | 15.33 | 3.999 | 2.1300 | 3.833 | 61.305 | 0.085 | 33.16 | 15.380 | 3.9990 | 61.505 | 0.085 | 33.27 | 15.33 | −0.004 |
| ### | May 8, 2012 | 10:00:21 AM | 15.33 | 3.999 | 2.1355 | 3.833 | 61.305 | 0.085 | 33.25 | 15.380 | 3.9990 | 61.505 | 0.085 | 33.36 | 15.33 | −0.003 |
| ### | May 8, 2012 | 10:00:26 AM | 15.33 | 3.999 | 2.1410 | 3.833 | 61.305 | 0.085 | 33.33 | 15.380 | 3.9990 | 61.505 | 0.085 | 33.44 | 15.33 | −0.001 |
| ### | May 8, 2012 | 10:00:31 AM | 15.33 | 4.000 | 2.1466 | 3.833 | 61.320 | 0.085 | 33.42 | 15.380 | 4.0000 | 61.520 | 0.085 | 33.53 | 15.33 | 0.001 |
| ### | May 8, 2012 | 10:00:36 AM | 15.33 | 3.999 | 2.1521 | 3.833 | 61.305 | 0.085 | 33.50 | 15.380 | 3.9990 | 61.505 | 0.085 | 33.61 | 15.33 | 0.003 |
| ### | May 8, 2012 | 10:00:41 AM | 15.33 | 3.999 | 2.1577 | 3.833 | 61.305 | 0.085 | 33.59 | 15.380 | 3.9990 | 61.505 | 0.085 | 33.70 | 15.33 | 0.004 |
| ### | May 8, 2012 | 10:00:46 AM | 15.33 | 3.999 | 2.1632 | 3.833 | 61.305 | 0.085 | 33.67 | 15.380 | 3.9990 | 61.505 | 0.085 | 33.78 | 15.33 | 0.005 |
| ### | May 8, 2012 | 10:00:51 AM | 15.32 | 3.999 | 2.1688 | 3.830 | 61.265 | 0.085 | 33.76 | 15.370 | 3.9990 | 61.465 | 0.085 | 33.87 | 15.32 | −0.005 |
| ### | May 8, 2012 | 10:00:56 AM | 15.32 | 3.999 | 2.1743 | 3.830 | 61.265 | 0.085 | 33.84 | 15.370 | 3.9990 | 61.465 | 0.085 | 33.95 | 15.32 | −0.004 |
| ### | May 8, 2012 | 10:01:01 AM | 15.32 | 3.999 | 2.1799 | 3.830 | 61.265 | 0.085 | 33.93 | 15.370 | 3.9990 | 61.465 | 0.085 | 34.04 | 15.32 | −0.003 |
| ### | May 8, 2012 | 10:01:06 AM | 15.32 | 3.999 | 2.1854 | 3.830 | 61.265 | 0.085 | 34.01 | 15.370 | 3.9990 | 61.465 | 0.085 | 34.12 | 15.32 | −0.001 |
| ### | May 8, 2012 | 10:01:11 AM | 15.32 | 3.999 | 2.1909 | 3.830 | 61.265 | 0.085 | 34.10 | 15.370 | 3.9990 | 61.465 | 0.085 | 34.21 | 15.32 | −0.001 |
| ### | May 8, 2012 | 10:01:16 AM | 15.32 | 3.999 | 2.1965 | 3.830 | 61.265 | 0.085 | 34.19 | 15.370 | 3.9990 | 61.465 | 0.085 | 34.29 | 15.32 | 0.003 |
| ### | May 8, 2012 | 10:01:21 AM | 15.32 | 3.999 | 2.2020 | 3.830 | 61.265 | 0.085 | 34.27 | 15.370 | 3.9990 | 61.465 | 0.085 | 34.38 | 15.32 | 0.004 |
| ### | May 8, 2012 | 10:01:26 AM | 15.32 | 3.999 | 2.2076 | 3.830 | 61.265 | 0.085 | 34.36 | 15.370 | 3.9990 | 61.465 | 0.085 | 34.47 | 15.32 | 0.005 |
| ### | May 8, 2012 | 10:01:31 AM | 15.31 | 3.999 | 2.2131 | 3.828 | 61.225 | 0.085 | 34.44 | 15.360 | 3.9990 | 61.425 | 0.085 | 34.55 | 15.31 | −0.005 |
| ### | May 8, 2012 | 10:01:36 AM | 15.31 | 3.999 | 2.2187 | 3.828 | 61.225 | 0.085 | 34.53 | 15.360 | 3.9990 | 61.425 | 0.085 | 34.64 | 15.31 | −0.004 |
| ### | May 8, 2012 | 10:01:41 AM | 15.31 | 3.999 | 2.2242 | 3.828 | 61.225 | 0.085 | 34.61 | 15.360 | 3.9990 | 61.425 | 0.085 | 34.72 | 15.31 | −0.002 |
| ### | May 8, 2012 | 10:01:46 AM | 15.31 | 3.999 | 2.2298 | 3.828 | 61.225 | 0.085 | 34.70 | 15.360 | 3.9990 | 61.425 | 0.085 | 34.81 | 15.31 | 0.000 |
| ### | May 8, 2012 | 10:01:51 AM | 15.31 | 3.999 | 2.2353 | 3.828 | 61.225 | 0.085 | 34.78 | 15.360 | 3.9990 | 61.425 | 0.085 | 34.89 | 15.31 | 0.002 |
| ### | May 8, 2012 | 10:01:56 AM | 15.31 | 3.999 | 2.2409 | 3.828 | 61.225 | 0.085 | 34.87 | 15.360 | 3.9990 | 61.425 | 0.085 | 34.98 | 15.31 | 0.004 |
| ### | May 8, 2012 | 10:02:01 AM | 15.31 | 3.999 | 2.2464 | 3.828 | 61.225 | 0.085 | 34.95 | 15.360 | 3.9990 | 61.425 | 0.085 | 35.06 | 15.31 | 0.005 |
| ### | May 8, 2012 | 10:02:06 AM | 15.30 | 3.999 | 2.2520 | 3.825 | 61.185 | 0.085 | 35.04 | 15.350 | 3.9990 | 61.385 | 0.085 | 35.15 | 15.30 | −0.005 |
| ### | May 8, 2012 | 10:02:11 AM | 15.30 | 3.999 | 2.2575 | 3.825 | 61.185 | 0.085 | 35.12 | 15.350 | 3.9990 | 61.385 | 0.085 | 35.23 | 15.30 | −0.004 |
| ### | May 8, 2012 | 10:02:16 AM | 15.30 | 3.999 | 2.2630 | 3.825 | 61.185 | 0.085 | 35.21 | 15.350 | 3.9990 | 61.385 | 0.085 | 35.32 | 15.30 | −0.003 |
| ### | May 8, 2012 | 10:02:21 AM | 15.30 | 3.999 | 2.2686 | 3.825 | 61.185 | 0.085 | 35.29 | 15.350 | 3.9990 | 61.385 | 0.085 | 35.40 | 15.30 | −0.001 |
| ### | May 8, 2012 | 10:02:26 AM | 15.30 | 3.999 | 2.2741 | 3.825 | 61.185 | 0.085 | 35.38 | 15.350 | 3.9990 | 61.385 | 0.085 | 35.49 | 15.30 | 0.001 |
| ### | May 8, 2012 | 10:02:31 AM | 15.30 | 3.999 | 2.2797 | 3.825 | 61.185 | 0.085 | 35.46 | 15.350 | 3.9990 | 61.385 | 0.085 | 35.57 | 15.30 | 0.003 |
| ### | May 8, 2012 | 10:02:36 AM | 15.30 | 3.999 | 2.2852 | 3.825 | 61.185 | 0.085 | 35.55 | 15.350 | 3.9990 | 61.385 | 0.085 | 35.66 | 15.30 | 0.004 |
| ### | May 8, 2012 | 10:02:41 AM | 15.30 | 3.999 | 2.2909 | 3.825 | 61.185 | 0.085 | 35.63 | 15.350 | 3.9990 | 61.385 | 0.085 | 35.74 | 15.30 | 0.005 |
| ### | May 8, 2012 | 10:02:46 AM | 15.29 | 3.999 | 2.2963 | 3.823 | 61.145 | 0.085 | 35.72 | 15.340 | 3.9990 | 61.345 | 0.085 | 35.83 | 15.29 | −0.005 |
| ### | May 8, 2012 | 10:02:51 AM | 15.29 | 3.999 | 2.3019 | 3.823 | 61.145 | 0.085 | 35.80 | 15.340 | 3.9990 | 61.345 | 0.085 | 35.92 | 15.29 | −0.004 |
| ### | May 8, 2012 | 10:02:56 AM | 15.29 | 3.999 | 2.3074 | 3.823 | 61.145 | 0.085 | 35.89 | 15.340 | 3.9990 | 61.345 | 0.085 | 36.00 | 15.29 | −0.003 |
| ### | May 8, 2012 | 10:03:01 AM | 15.29 | 3.999 | 2.3130 | 3.823 | 61.145 | 0.085 | 35.97 | 15.340 | 3.9990 | 61.345 | 0.085 | 36.09 | 15.29 | −0..001 |
| ### | May 8, 2012 | 10:03:06 AM | 15.29 | 3.999 | 2.3185 | 3.823 | 61.145 | 0.085 | 36.05 | 15.334 | 3.9990 | 61.345 | 0.085 | 36.17 | 15.29 | 0.001 |
| ### | May 8, 2012 | 10:03:11 AM | 15.29 | 3.999 | 2.3240 | 3.823 | 61.145 | 0.085 | 36.14 | 15.340 | 3.9990 | 61.345 | 0.085 | 36.26 | 15.29 | 0.003 |
| ### | May 8, 2012 | 10:03:16 AM | 15.29 | 3.999 | 2.3296 | 3.823 | 61.145 | 0.085 | 36.22 | 15.340 | 3.9990 | 61.345 | 0.085 | 36.34 | 15.29 | 0.004 |
| ### | May 8, 2012 | 10:03:21 AM | 15.29 | 3.999 | 2.3351 | 3.823 | 61.145 | 0.085 | 36.31 | 15.340 | 3.9990 | 61.345 | 0.085 | 36.43 | 15.29 | 0.005 |
| ### | May 8, 2012 | 10:03:26 AM | 15.28 | 3.999 | 2.3407 | 3.820 | 61.105 | 0.085 | 36.39 | 15.330 | 3.9990 | 61.305 | 0.085 | 36.51 | 15.28 | −0.005 |
| ### | May 8, 2012 | 10:03:31 AM | 15.28 | 3.999 | 2.3462 | 3.820 | 61.105 | 0.085 | 36.48 | 15.330 | 3.9990 | 61.305 | 0.085 | 36.60 | 15.28 | −0.004 |
| ### | May 8, 2012 | 10:03:36 AM | 15.28 | 3.999 | 2.3518 | 3.820 | 61.105 | 0.085 | 36.56 | 15.330 | 3.9990 | 61.305 | 0.085 | 36.68 | 15.28 | −0.003 |
| ### | May 8, 2012 | 10:03:41 AM | 15.28 | 3.999 | 2.3573 | 3.820 | 61.105 | 0.085 | 36.65 | 15.330 | 3.9990 | 61.305 | 0.085 | 36.77 | 15.28 | −0.001 |
| ### | May 8, 2012 | 10:03:46 AM | 15.28 | 3.999 | 2.3629 | 3.820 | 61.105 | 0.085 | 36.73 | 15.330 | 3.9990 | 61.305 | 0.085 | 36.85 | 15.28 | 0.001 |
| ### | May 8, 2012 | 10:03:51 AM | 15.28 | 3.999 | 2.3684 | 3.820 | 61.105 | 0.085 | 36.82 | 15.330 | 3.9990 | 61.305 | 0.085 | 36.94 | 15.28 | 0.003 |
| ### | May 8, 2012 | 10:03:56 AM | 15.28 | 3.999 | 2.3740 | 3.820 | 61.105 | 0.085 | 36.90 | 15.330 | 3.9990 | 61.305 | 0.085 | 37.02 | 15.28 | 0.004 |
| ### | May 8, 2012 | 10:04:01 AM | 15.28 | 3.999 | 2.3795 | 3.820 | 61.105 | 0.085 | 36.99 | 15.330 | 3.9990 | 61.305 | 0.085 | 37.11 | 15.28 | 0.005 |
| ### | May 8, 2012 | 10:04:06 AM | 15.27 | 3.999 | 2.3851 | 3.818 | 61.065 | 0.085 | 37.07 | 15.320 | 3.9990 | 61.265 | 0.085 | 37.19 | 15.27 | −0.005 |
| ### | May 8, 2012 | 10:04:11 AM | 15.27 | 3.999 | 2.3906 | 3.818 | 61.065 | 0.085 | 37.16 | 15.320 | 3.9990 | 61.265 | 0.085 | 37.28 | 15.27 | −0.004 |
| ### | May 8, 2012 | 10:04:16 AM | 15.27 | 3.999 | 2.3962 | 3.818 | 61.065 | 0.085 | 37.24 | 15.320 | 3.9990 | 61.265 | 0.085 | 37.36 | 15.27 | −0.002 |
| ### | May 8, 2012 | 10:04:21 AM | 15.27 | 3.999 | 2.4017 | 3.818 | 61.065 | 0.085 | 37.33 | 15.320 | 3.9990 | 61.265 | 0.085 | 37.45 | 15.27 | 0.000 |
| ### | May 8, 2012 | 10:04:26 AM | 15.27 | 3.999 | 2.4072 | 3.818 | 61.065 | 0.085 | 37.41 | 15.320 | 3.9990 | 61.265 | 0.085 | 37.53 | 15.27 | 0.002 |
| ### | May 8, 2012 | 10:04:31 AM | 15.27 | 3.999 | 2.4128 | 3.818 | 61.065 | 0.085 | 37.50 | 15.320 | 3.9990 | 61.265 | 0.085 | 37.62 | 15.27 | 0.004 |
| ### | May 8, 2012 | 10:04:36 AM | 15.27 | 3.999 | 2.4183 | 3.818 | 61.065 | 0.085 | 37.58 | 15.320 | 3.9990 | 61.265 | 0.085 | 37.70 | 15.27 | 0.005 |
| ### | May 8, 2012 | 10:04:41 AM | 15.26 | 3.999 | 2.4239 | 3.815 | 61.025 | 0.085 | 37.67 | 15.310 | 3.9990 | 61.225 | 0.085 | 37.79 | 15.26 | −0.005 |
| ### | May 8, 2012 | 10:04:46 AM | 15.26 | 3.999 | 2.4294 | 3.815 | 61.025 | 0.085 | 37.75 | 15.310 | 3.9990 | 61.225 | 0.085 | 37.87 | 15.26 | −0.004 |
| ### | May 8, 2012 | 10:04:51 AM | 15.26 | 3.999 | 2.4349 | 3.815 | 61.025 | 0.085 | 37.84 | 15.310 | 3.9990 | 61.225 | 0.085 | 37.96 | 15.26 | −0.003 |
| ### | May 8, 2012 | 10:04:56 AM | 15.26 | 3.999 | 2.4405 | 3.815 | 61.025 | 0.085 | 37.92 | 15.310 | 3.9990 | 61.225 | 0.085 | 38.04 | 15.26 | −0.002 |
| ### | May 8, 2012 | 10:05:01 AM | 15.26 | 3.999 | 2.4460 | 3.815 | 61.025 | 0.085 | 38.01 | 15.310 | 3.9990 | 61.225 | 0.085 | 38.13 | 15.26 | 0.000 |
| ### | May 8, 2012 | 10:05:06 AM | 15.26 | 3.999 | 2.4516 | 3.815 | 61.025 | 0.085 | 38.09 | 15.310 | 3.9990 | 61.225 | 0.085 | 38.21 | 15.26 | 0.002 |
| ### | May 8, 2012 | 10:05:11 AM | 15.26 | 3.999 | 2.4571 | 3.815 | 61.025 | 0.085 | 38.18 | 15.310 | 3.9990 | 61.225 | 0.085 | 38.30 | 15.26 | 0.003 |
| ### | May 8, 2012 | 10:05:16 AM | 15.26 | 3.999 | 2.4627 | 3.815 | 61.025 | 0.085 | 38.26 | 15.310 | 3.9990 | 61.225 | 0.085 | 38.38 | 15.26 | 0.004 |
| ### | May 8, 2012 | 10:05:21 AM | 15.26 | 3.999 | 2.4682 | 3.815 | 61.025 | 0.085 | 38.35 | 15.310 | 3.9990 | 61.225 | 0.085 | 38.47 | 15.26 | 0.005 |
| ### | May 8, 2012 | 10:05:26 AM | 15.25 | 3.999 | 2.4738 | 3.813 | 60.985 | 0.085 | 38.43 | 15.300 | 3.9990 | 61.185 | 0.085 | 38.55 | 15.25 | −0.005 |
| ### | May 8, 2012 | 10:05:31 AM | 15.25 | 3.999 | 2.4793 | 3.813 | 60.985 | 0.085 | 38.51 | 15.300 | 3.9990 | 61.185 | 0.085 | 38.64 | 15.25 | −0.004 |
| ### | May 8, 2012 | 10:05:36 AM | 15.25 | 3.999 | 2.4849 | 3.813 | 60.985 | 0.085 | 38.60 | 15.300 | 3.9990 | 61.185 | 0.085 | 38.72 | 15.25 | −0.002 |
| ### | May 8, 2012 | 10:05:41 AM | 15.25 | 3.999 | 2.4904 | 3.813 | 60.985 | 0.085 | [symbol] | [symbol] | 3.9990 | 61.185 | 0.085 | 38.81 | 15.25 | 0.000 |
| ### | May 8, 2012 | 10:05:46 AM | 15.25 | 3.999 | 2.4959 | 3.813 | 60.985 | 0.085 | 38.77 | 15.300 | 3.9990 | 61.185 | 0.085 | 38.89 | 15.25 | 0.002 |
| ### | May 8, 2012 | 10:05:51 AM | 15.25 | 3.999 | 2.5015 | 3.813 | 60.985 | 0.085 | 38.85 | 15.300 | 3.9990 | 61.185 | 0.085 | 38.98 | 15.25 | 0.004 |
| ### | May 8, 2012 | 10:05:56 AM | 15.25 | 3.999 | 2.5070 | 3.813 | 60.985 | 0.085 | 38.94 | 15.300 | 3.9990 | 61.185 | 0.085 | 39.06 | 15.25 | 0.005 |
| ### | May 8, 2012 | 10:06:01 AM | 15.24 | 3.999 | 2.5126 | 3.810 | 60.945 | 0.085 | 39.02 | 15.290 | 3.9990 | 61.145 | 0.085 | 39.15 | 15.24 | −0.005 |
| ### | May 8, 2012 | 10:06:06 AM | 15.24 | 3.999 | 2.5182 | 3.810 | 60.945 | 0.085 | 39.11 | 15.290 | 3.9990 | 61.145 | 0.085 | 39.23 | 15.24 | −0.004 |
| ### | May 8, 2012 | 10:06:11 AM | 15.24 | 3.999 | 2.5237 | 3.810 | 60.945 | 0.085 | 39.19 | 15.290 | 3.9990 | 61.145 | 0.085 | 39.32 | 15.24 | −0.003 |
| ### | May 8, 2012 | 10:06:16 AM | 15.24 | 3.999 | 2.5292 | 3.810 | 60.945 | 0.085 | 39.28 | 15.290 | 3.9990 | 61.145 | 0.085 | 39.40 | 15.24 | −0.001 |
| ### | May 8, 2012 | 10:06:21 AM | 15.24 | 3.999 | 2.5348 | 3.810 | 60.945 | 0.085 | 39.36 | 15.290 | 3.9990 | 61.145 | 0.085 | 39.49 | 15.24 | 0.001 |
| ### | May 8, 2012 | 10:06:26 AM | 15.24 | 3.999 | 2.5403 | 3.810 | 60.945 | 0.085 | 39.45 | 15.290 | 3.9990 | 61.145 | 0.085 | 39.57 | 15.24 | 0.003 |
| ### | May 8, 2012 | 10:06:31 AM | 15.24 | 3.999 | 2.5459 | 3.810 | 60.945 | 0.085 | 39.53 | 15.290 | 3.9990 | 61.145 | 0.085 | 39.66 | 15.24 | 0.004 |
| ### | May 8, 2012 | 10:06:36 AM | 15.24 | 3.999 | 2.5514 | 3.810 | 60.945 | 0.085 | 39.62 | 15.290 | 3.9990 | 61.145 | 0.085 | 39.74 | 15.24 | 0.005 |
| ### | May 8, 2012 | 10:06:41 AM | 15.23 | 3.999 | 2.5570 | 3.808 | 60.905 | 0.085 | 39.70 | 15.280 | 3.9990 | 61.105 | 0.085 | 39.83 | 15.23 | −0.005 |
| ### | May 8, 2012 | 10:06:46 AM | 15.23 | 3.999 | 2.5625 | 3.808 | 60.905 | 0.085 | 39.78 | 15.280 | 3.9990 | 61.105 | 0.085 | 39.91 | 15.23 | −0.004 |
| ### | May 8, 2012 | 10:06:51 AM | 15.23 | 3.999 | 2.5680 | 3.808 | 60.905 | 0.085 | 39.87 | 15.280 | 3.9990 | 61.105 | 0.085 | 40.00 | 15.23 | −0.003 |
| ### | May 8, 2012 | 10:06:56 AM | 15.23 | 3.999 | 2.5736 | 3.808 | 60.905 | 0.085 | 39.95 | 15.280 | 3.9990 | 61.105 | 0.085 | 40.08 | 15.23 | −0.001 |
| ### | May 8, 2012 | 10:07:01 AM | 15.23 | 3.999 | 2.5791 | 3.808 | 60.905 | 0.085 | 40.04 | 15.280 | 3.9990 | 61.105 | 0.085 | 40.17 | 15.23 | 0.001 |
| ### | May 8, 2012 | 10:07:06 AM | 15.23 | 3.999 | 2.5847 | 3.808 | 60.905 | 0.085 | 40.12 | 15.280 | 3.9990 | 61.105 | 0.085 | 40.25 | 15.23 | 0.003 |
| ### | May 8, 2012 | 10:07:11 AM | 15.23 | 3.999 | 2.5902 | 3.808 | 60.905 | 0.085 | 40.21 | 15.280 | 3.9990 | 61.105 | 0.085 | 40.34 | 15.23 | 0.004 |
| ### | May 8, 2012 | 10:07:16 AM | 15.23 | 3.999 | 2.5958 | 3.808 | 60.905 | 0.085 | 40.29 | 15.280 | 3.9990 | 61.105 | 0.085 | 40.42 | 15.23 | 0.005 |
| ### | May 8, 2012 | 10:07:21 AM | 15.22 | 3.999 | 2.6013 | 3.805 | 60.865 | 0.085 | 40.38 | 15.270 | 3.9990 | 61.065 | 0.085 | 40.51 | 15.22 | −0.005 |
| ### | May 8, 2012 | 10:07:26 AM | 15.22 | 3.999 | 2.6069 | 3.805 | 60.865 | 0.085 | 40.46 | 15.270 | 3.9990 | 61.065 | 0.085 | 40.59 | 15.22 | −0.004 |
| ### | May 8, 2012 | 10:07:31 AM | 15.22 | 3.999 | 2.6124 | 3.805 | 60.865 | 0.085 | 40.55 | 15.270 | 3.9990 | 61.065 | 0.085 | 40.68 | 15.22 | −0.003 |
| ### | May 8, 2012 | 10:07:36 AM | 15.22 | 3.999 | 2.6180 | 3.805 | 60.865 | 0.085 | 40.63 | 15.270 | 3.9990 | 61.065 | 0.085 | 40.76 | 15.22 | −0.001 |
| ### | May 8, 2012 | 10:07:41 AM | 15.22 | 3.999 | 2.6235 | 3.805 | 60.865 | 0.085 | 40.71 | 15.270 | 3.9990 | 61.065 | 0.085 | 40.85 | 15.22 | 0.001 |
| ### | May 8, 2012 | 10:07:46 AM | 15.22 | 4.000 | 2.6290 | 3.805 | 60.880 | 0.085 | 40.80 | 15.270 | 4.0000 | 61.080 | 0.085 | 40.93 | 15.22 | 0.003 |
| ### | May 8, 2012 | 10:07:51 AM | 15.22 | 3.999 | 2.6346 | 3.805 | 60.865 | 0.085 | 40.88 | 15.270 | 3.9990 | 61.065 | 0.085 | 41.02 | 15.22 | 0.004 |
| ### | May 8, 2012 | 10:07:56 AM | 15.22 | 3.999 | 2.6401 | 3.805 | 60.865 | 0.085 | 40.97 | 15.270 | 3.9990 | 61.065 | 0.085 | 41.10 | 15.22 | 0.005 |
| ### | May 8, 2012 | 10:08:01 AM | 15.21 | 3.999 | 2.6457 | 3.803 | 60.825 | 0.084 | 41.05 | 15.260 | 3.9990 | 61.025 | 0.085 | 41.19 | 15.21 | −0.005 |
| ### | May 8, 2012 | 10:08:06 AM | 15.21 | 3.999 | 2.6512 | 3.803 | 60.825 | 0.084 | 41.14 | 15.260 | 3.9990 | 61.025 | 0.085 | 41.27 | 15.21 | −0.004 |
| ### | May 8, 2012 | 10:08:11 AM | 15.21 | 3.999 | 2.6568 | 3.803 | 60.825 | 0.084 | 41.22 | 15.260 | 3.9990 | 61.025 | 0.085 | 41.35 | 15.21 | −0.003 |
| ### | May 8, 2012 | 10:08:16 AM | 15.21 | 3.999 | 2.6626 | 3.803 | 60.825 | 0.084 | 41.31 | 15.260 | 3.9990 | 61.025 | 0.085 | 41.44 | 15.21 | −0.001 |
| ### | May 8, 2012 | 10:08:21 AM | 15.21 | 3.999 | 2.6679 | 3.803 | 60.825 | 0.084 | 41.39 | 15.260 | 3.9990 | 61.025 | 0.085 | 41.52 | 15.21 | 0.001 |
| ### | May 8, 2012 | 10:08:26 AM | 15.21 | 3.999 | 2.6735 | 3.803 | 60.825 | 0.084 | 41.48 | 15.260 | 3.9990 | 61.025 | 0.085 | 41.61 | 15.21 | 0.003 |
| ### | May 8, 2012 | 10:08:31 AM | 15.21 | 3.999 | 2.6790 | 3.803 | 60.825 | 0.084 | 41.56 | 15.260 | 3.9990 | 61.025 | 0.085 | 41.69 | 15.21 | 0.004 |
| ### | May 8, 2012 | 10:08:36 AM | 15.21 | 3.999 | 2.6845 | 3.803 | 60.825 | 0.084 | 41.64 | 15.260 | 3.9990 | 61.025 | 0.085 | 41.78 | 15.21 | 0.005 |
| ### | May 8, 2012 | 10:08:41 AM | 15.20 | 3.999 | 2.6900 | 3.800 | 60.785 | 0.084 | 41.73 | 15.250 | 3.9990 | 60.985 | 0.085 | 41.86 | 15.20 | −0.005 |
| ### | May 8, 2012 | 10:08:46 AM | 15.20 | 3.999 | 2.6956 | 3.800 | 60.785 | 0.084 | 41.81 | 15.250 | 3.9990 | 60.985 | 0.085 | 41.95 | 15.20 | −0.004 |
| ### | May 8, 2012 | 10:08:51 AM | 15.20 | 3.999 | 2.7012 | 3.800 | 60.785 | 0.084 | 41.90 | 15.250 | 3.9990 | 60.985 | 0.085 | 42.03 | 15.20 | −0.002 |
| ### | May 8, 2012 | 10:08:56 AM | 15.20 | 3.999 | 2.7067 | 3.800 | 60.785 | 0.084 | 41.98 | 15.250 | 3.9990 | 60.985 | 0.085 | 42.12 | 15.20 | 0.000 |
| ### | May 8, 2012 | 10:09:01 AM | 15.20 | 3.999 | 2.7123 | 3.800 | 60.785 | 0.084 | 42.07 | 15.250 | 3.9990 | 60.985 | 0.085 | 42.20 | 15.20 | 0.002 |
| ### | May 8, 2012 | 10:09:06 AM | 15.20 | 3.999 | 2.7178 | 3.800 | 60.785 | 0.084 | 42.15 | 15.250 | 3.9990 | 60.985 | 0.085 | 42.29 | 15.20 | 0.004 |
| ### | May 8, 2012 | 10:09:11 AM | 15.20 | 3.999 | 2.7233 | 3.800 | 60.785 | 0.084 | 42.23 | 15.250 | 3.9990 | 60.985 | 0.085 | 42.37 | 15.20 | 0.005 |
| ### | May 8, 2012 | 10:09:16 AM | 15.19 | 3.999 | 2.7289 | 3.798 | 60.745 | 0.084 | 42.32 | 15.240 | 3.9990 | 60.945 | 0.085 | 42.46 | 15.19 | −0.005 |
| ### | May 8, 2012 | 10:09:21 AM | 15.19 | 3.999 | 2.7344 | 3.798 | 60.745 | 0.084 | 42.40 | 15.240 | 3.9990 | 60.945 | 0.085 | 42.54 | 15.19 | −0.004 |
| ### | May 8, 2012 | 10:09:26 AM | 15.19 | 3.999 | 2.7400 | 3.798 | 60.745 | 0.084 | 42.49 | 15.240 | 3.9990 | 60.945 | 0.085 | 42.63 | 15.19 | −0.002 |
| ### | May 8, 2012 | 10:09:31 AM | 15.19 | 3.999 | 2.7455 | 3.798 | 60.745 | 0.084 | 42.57 | 15.240 | 3.9990 | 60.945 | 0.085 | 42.71 | 15.19 | 0.000 |
| ### | May 8, 2012 | 10:09:36 AM | 15.19 | 3.999 | 2.7510 | 3.798 | 60.745 | 0.084 | 42.66 | 15.240 | 3.9990 | 60.945 | 0.085 | 42.79 | 15.19 | 0.002 |
| ### | May 8, 2012 | 10:09:41 AM | 15.19 | 3.999 | 2.7566 | 3.798 | 60.745 | 0.084 | 42.74 | 15.240 | 3.9990 | 60.945 | 0.085 | 42.88 | 15.19 | 0.004 |
| ### | May 8, 2012 | 10:09:46 AM | 15.19 | 3.999 | 2.7621 | 3.798 | 60.745 | 0.084 | 42.83 | 15.240 | 3.9990 | 60.945 | 0.085 | 42.96 | 15.19 | 0.005 |
| ### | May 8, 2012 | 10:09:51 AM | 15.18 | 3.999 | 2.7677 | 3.795 | 60.705 | 0.084 | 42.91 | 15.230 | 3.9990 | 60.905 | 0.085 | 43.05 | 15.18 | −0.005 |
| ### | May 8, 2012 | 10:09:56 AM | 15.18 | 3.999 | 2.7732 | 3.795 | 60.705 | 0.084 | 42.99 | 15.230 | 3.9990 | 60.905 | 0.085 | 43.13 | 15.18 | −0.004 |
| ### | May 8, 2012 | 10:10:01 AM | 15.18 | 3.999 | 2.7788 | 3.795 | 60.705 | 0.084 | 43.08 | 15.230 | 3.9990 | 60.905 | 0.085 | 43.22 | 15.18 | −0.002 |
| ### | May 8, 2012 | 10:10:06 AM | 15.18 | 3.999 | 2.7843 | 3.795 | 60.705 | 0.084 | 43.16 | 15.230 | 3.9990 | 60.905 | 0.085 | 43.30 | 15.18 | 0.000 |
| ### | May 8, 2012 | 10:10:11 AM | 15.18 | 3.999 | 2.7899 | 3.795 | 60.705 | 0.084 | 43.25 | 15.230 | 3.9990 | 60.905 | 0.085 | 43.39 | 15.18 | 0.002 |
| ### | May 8, 2012 | 10:10:16 AM | 15.18 | 3.999 | 2.7954 | 3.795 | 60.705 | 0.084 | 43.33 | 15.230 | 3.9990 | 60.905 | 0.085 | 43.47 | 15.18 | 0.004 |
| ### | May 8, 2012 | 10:10:21 AM | 15.18 | 3.999 | 2.8010 | 3.795 | 60.705 | 0.084 | 43.42 | 15.230 | 3.9990 | 60.905 | 0.085 | 43.56 | 15.18 | 0.005 |
| ### | May 8, 2012 | 10:10:26 AM | 15.17 | 3.999 | 2.8065 | 3.793 | 60.665 | 0.084 | 43.50 | 15.220 | 3.9990 | 60.865 | 0.085 | 43.64 | 15.17 | −0.005 |
| ### | May 8, 2012 | 10:10:31 AM | 15.17 | 3.999 | 2.8120 | 3.793 | 60.665 | 0.084 | 43.58 | 15.220 | 3.9990 | 60.865 | 0.085 | 43.73 | 15.17 | −0.004 |
| ### | May 8, 2012 | 10:10:36 AM | 15.17 | 3.999 | 2.8176 | 3.793 | 60.665 | 0.084 | 43.67 | 15.220 | 3.9990 | 60.865 | 0.085 | 43.81 | 15.17 | −0.002 |
| ### | May 8, 2012 | 10:10:41 AM | 15.17 | 3.999 | 2.8231 | 3.793 | 60.665 | 0.084 | 43.75 | 15.220 | 3.9990 | 60.865 | 0.085 | 43.89 | 15.17 | 0.000 |
| ### | May 8, 2012 | 10:10:46 AM | 15.17 | 3.999 | 2.8287 | 3.793 | 60.665 | 0.084 | 43.84 | 15.220 | 3.9990 | 60.865 | 0.085 | 43.98 | 15.17 | 0.002 |
| ### | May 8, 2012 | 10:10:51 AM | 15.17 | 3.999 | 2.8342 | 3.793 | 60.665 | 0.084 | 43.92 | 15.220 | 3.9990 | 60.865 | 0.085 | 44.06 | 15.17 | 0.004 |
| ### | May 8, 2012 | 10:10:56 AM | 15.17 | 3.999 | 2.8398 | 3.793 | 60.665 | 0.084 | 44.01 | 15.220 | 3.9990 | 60.865 | 0.085 | 44.15 | 15.17 | 0.005 |
| ### | May 8, 2012 | 10:11:01 AM | 15.16 | 3.999 | 2.8453 | 3.790 | 60.605 | 0.084 | 44.09 | 15.210 | 3.9990 | 60.825 | 0.084 | 44.23 | 15.16 | −0.005 |
| ### | May 8, 2012 | 10:11:06 AM | 15.16 | 3.999 | 2.8509 | 3.790 | 60.625 | 0.084 | 44.17 | 15.210 | 3.9990 | 60.825 | 0.084 | 44.32 | 15.16 | −0.004 |
| ### | May 8, 2012 | 10:11:11 AM | 15.16 | 3.999 | 2.8564 | 3.790 | 60.625 | 0.084 | 44.26 | 15.210 | 3.9990 | 60.825 | 0.084 | 44.40 | 15.16 | −0.003 |
| ### | May 8, 2012 | 10:11:16 AM | 15.16 | 3.999 | 2.8620 | 3.790 | 60.625 | 0.084 | 44.34 | 15.210 | 3.9990 | 60.825 | 0.084 | 44.49 | 15.16 | −0.001 |
| ### | May 8, 2012 | 10:11:21 AM | 15.16 | 3.999 | 2.8675 | 3.790 | 60.625 | 0.084 | 44.43 | 15.210 | 3.9990 | 60.825 | 0.084 | 44.57 | 15.16 | 0.001 |
| ### | May 8, 2012 | 10:11:26 AM | 15.16 | 3.999 | 2.8730 | 3.790 | 60.625 | 0.084 | 44.51 | 15.210 | 3.9990 | 60.825 | 0.084 | 44.65 | 15.16 | 0.003 |
| ### | May 8, 2012 | 10:11:31 AM | 15.16 | 3.999 | 2.8786 | 3.790 | 60.625 | 0.084 | 44.59 | 15.210 | 3.9990 | 60.825 | 0.084 | 44.74 | 15.16 | 0.004 |
| ### | May 8, 2012 | 10:11:36 AM | 15.16 | 3.999 | 2.8841 | 3.790 | 60.625 | 0.084 | 44.68 | 15.210 | 3.9990 | 60.825 | 0.084 | 44.82 | 15.16 | 0.005 |
| ### | May 8, 2012 | 10:11:41 AM | 15.15 | 3.999 | 2.8897 | 3.788 | 60.585 | 0.084 | 44.76 | 15.200 | 3.9990 | 60.785 | 0.084 | 44.91 | 15.15 | −0.005 |
| ### | May 8, 2012 | 10:11:46 AM | 15.15 | 3.999 | 2.8952 | 3.788 | 60.585 | 0.084 | 44.85 | 15.200 | 3.9990 | 60.785 | 0.084 | 44.99 | 15.15 | −0.004 |
| ### | May 8, 2012 | 10:11:51 AM | 15.15 | 3.999 | 2.9008 | 3.788 | 60.585 | 0.084 | 44.93 | 15.200 | 3.9990 | 60.785 | 0.084 | 45.08 | 15.15 | −0.002 |
| ### | May 8, 2012 | 10:11:56 AM | 15.15 | 3.999 | 2.9063 | 3.788 | 60.585 | 0.084 | 45.02 | 15.200 | 3.9990 | 60.785 | 0.084 | 45.16 | 15.15 | 0.000 |
| ### | May 8, 2012 | 10:12:01 AM | 15.15 | 3.999 | 2.9119 | 3.788 | 60.585 | 0.084 | 45.16 | 15.200 | 3.9990 | 60.785 | 0.084 | 45.25 | 15.15 | 0.002 |
| ### | May 8, 2012 | 10:12:06 AM | 15.15 | 3.999 | 2.9174 | 3.788 | 60.585 | 0.084 | 45.18 | 15.200 | 3.9990 | 60.785 | 0.084 | 45.33 | 15.15 | 0.004 |
| ### | May 8, 2012 | 10:12:11 AM | 15.15 | 3.999 | 2.9230 | 3.788 | 60.585 | 0.084 | 45.27 | 15.200 | 3.9990 | 60.785 | 0.084 | 45.41 | 15.15 | 0.005 |
| ### | May 8, 2012 | 10:12:16 AM | 15.14 | 3.999 | 2.9285 | 3.785 | 60.545 | 0.084 | 45.35 | 15.190 | 3.9990 | 60.745 | 0.084 | 45.50 | 15.14 | −0.005 |
| ### | May 8, 2012 | 10:12:21 AM | 15.14 | 3.999 | 2.9341 | 3.785 | 60.545 | 0.084 | 45.44 | 15.190 | 3.9990 | 60.745 | 0.084 | 45.58 | 15.14 | −0.004 |
| ### | May 8, 2012 | 10:12:26 AM | 15.14 | 3.999 | 2.9396 | 3.785 | 60.545 | 0.084 | 45.52 | 15.190 | 3.9990 | 60.745 | 0.084 | 45.67 | 15.14 | −0.003 |
| ### | May 8, 2012 | 10:12:31 AM | 15.14 | 3.999 | 2.9451 | 3.785 | 60.545 | 0.084 | 45.60 | 15.190 | 3.9990 | 60.745 | 0.084 | 45.75 | 15.14 | −0.001 |
| ### | May 8, 2012 | 10:12:36 AM | 15.14 | 3.999 | 2.9507 | 3.785 | 60.545 | 0.084 | 45.69 | 15.190 | 3.9990 | 60.745 | 0.084 | 45.84 | 15.14 | 0.001 |
| ### | May 8, 2012 | 10:12:41 AM | 15.14 | 3.999 | 2.9562 | 3.785 | 60.545 | 0.084 | 45.77 | 15.190 | 3.9990 | 60.745 | 0.084 | 45.92 | 15.14 | 0.003 |
| ### | May 8, 2012 | 10:12:46 AM | 15.14 | 3.999 | 2.9618 | 3.785 | 60.545 | 0.084 | 45.86 | 15.190 | 3.9990 | 60.745 | 0.084 | 46.01 | 15.14 | 0.004 |
| ### | May 8, 2012 | 10:12:51 AM | 15.14 | 3.999 | 2.9673 | 3.785 | 60.545 | 0.084 | 45.94 | 15.190 | 3.9990 | 60.745 | 0.084 | 46.09 | 15.14 | 0.005 |
| ### | May 8, 2012 | 10:12:56 AM | 15.13 | 3.999 | 2.9729 | 3.783 | 60.505 | 0.084 | 46.02 | 15.180 | 3.9990 | 60.705 | 0.084 | 46.17 | 15.13 | −0.005 |
| ### | May 8, 2012 | 10:13:01 AM | 15.13 | 3.999 | 2.9784 | 3.783 | 60.505 | 0.084 | 46.11 | 15.180 | 3.9990 | 60.705 | 0.084 | 46.26 | 15.13 | −0.004 |
| ### | May 8, 2012 | 10:13:06 AM | 15.13 | 3.999 | 2.9840 | 3.783 | 60.505 | 0.084 | 46.19 | 15.180 | 3.9990 | 60.705 | 0.084 | 46.34 | 15.13 | −0.003 |
| ### | May 8, 2012 | 10:13:11 AM | 15.13 | 3.999 | 2.9895 | 3.783 | 60.505 | 0.084 | 46.28 | 15.180 | 3.9990 | 60.705 | 0.084 | 46.43 | 15.13 | −0.001 |
| ### | May 8, 2012 | 10:13:16 AM | 15.13 | 3.999 | 2.9950 | 3.783 | 60.505 | 0.084 | 46.36 | 15.180 | 3.9990 | 60.705 | 0.084 | 46.51 | 15.13 | 0.001 |
| ### | May 8, 2012 | 10:13:21 AM | 15.13 | 3.999 | 3.0006 | 3.783 | 60.505 | 0.084 | 46.45 | 15.180 | 3.9990 | 60.705 | 0.084 | 46.60 | 15.13 | 0.003 |
| ### | May 8, 2012 | 10:13:26 AM | 15.13 | 3.999 | 3.0061 | 3.783 | 60.505 | 0.084 | 46.53 | 15.180 | 3.9990 | 60.705 | 0.084 | 46.68 | 15.13 | 0.004 |
| ### | May 8, 2012 | 10:13:31 AM | 15.13 | 3.999 | 3.0117 | 3.783 | 60.505 | 0.084 | 46.61 | 15.180 | 3.9990 | 60.705 | 0.084 | 46.76 | 15.13 | 0.005 |
| ### | May 8, 2012 | 10:13:36 AM | 15.12 | 3.999 | 3.0172 | 3.780 | 60.465 | 0.084 | 46.70 | 15.170 | 3.9990 | 60.665 | 0.084 | 46.85 | 15.12 | −0.005 |
| ### | May 8, 2012 | 10:13:41 AM | 15.12 | 3.999 | 3.0228 | 3.780 | 60.465 | 0.084 | 46.78 | 15.170 | 3.9990 | 60.665 | 0.084 | 46.93 | 15.12 | −0.004 |
| ### | May 8, 2012 | 10:13:46 AM | 15.12 | 3.999 | 3.0283 | 3.780 | 60.465 | 0.084 | 46.87 | 15.170 | 3.9990 | 60.665 | 0.084 | 47.02 | 15.12 | −0.002 |
| ### | May 8, 2012 | 10:13:51 AM | 15.12 | 3.999 | 3.0338 | 3.780 | 60.465 | 0.084 | 46.95 | 15.170 | 3.9990 | 60.665 | 0.084 | 47.10 | 15.12 | 0.000 |
| ### | May 8, 2012 | 10:13:56 AM | 15.12 | 3.999 | 3.0394 | 3.780 | 60.465 | 0.084 | 47.01 | 15.170 | 3.9990 | 60.665 | 0.084 | 47.19 | 15.12 | 0.002 |
| ### | May 8, 2012 | 10:14:01 AM | 15.12 | 3.999 | 3.0450 | 3.780 | 60.465 | 0.084 | 47.12 | 15.170 | 3.9990 | 60.665 | 0.084 | 47.27 | 15.12 | 0.004 |
| ### | May 8, 2012 | 10:14:06 AM | 15.12 | 3.999 | 3.0505 | 3.780 | 60.465 | 0.084 | 47.20 | 15.170 | 3.9990 | 60.665 | 0.084 | 47.35 | 15.12 | 0.005 |
| ### | May 8, 2012 | 10:14:11 AM | 15.11 | 3.999 | 3.0560 | 3.778 | 60.425 | 0.084 | 47.28 | 15.160 | 3.9990 | 60.625 | 0.084 | 47.44 | 15.11 | −0.005 |
| ### | May 8, 2012 | 10:14:16 AM | 15.11 | 3.999 | 3.0616 | 3.778 | 60.425 | 0.084 | 47.37 | 15.160 | 3.9990 | 60.625 | 0.084 | 47.52 | 15.11 | −0.004 |
| ### | May 8, 2012 | 10:14:21 AM | 15.11 | 3.999 | 3.0671 | 3.778 | 60.425 | 0.084 | 47.45 | 15.160 | 3.9990 | 60.625 | 0.084 | 47.61 | 15.11 | −0.002 |
| ### | May 8, 2012 | 10:14:26 AM | 15.11 | 3.999 | 3.0727 | 3.778 | 60.425 | 0.084 | 47.54 | 15.160 | 3.9990 | 60.625 | 0.084 | 47.69 | 15.11 | 0.000 |
| ### | May 8, 2012 | 10:14:31 AM | 15.11 | 3.999 | 3.0782 | 3.778 | 60.425 | 0.084 | 47.62 | 15.160 | 3.9990 | 60.625 | 0.084 | 47.77 | 15.11 | 0.002 |
| ### | May 8, 2012 | 10:14:36 AM | 15.11 | 3.999 | 3.0838 | 3.778 | 60.425 | 0.084 | 47.70 | 15.160 | 3.9990 | 60.625 | 0.084 | 47.86 | 15.11 | 0.004 |
| ### | May 8, 2012 | 10:14:41 AM | 15.11 | 3.999 | 3.0893 | 3.778 | 60.425 | 0.084 | 47.79 | 15.160 | 3.9990 | 60.625 | 0.084 | 47.94 | 15.11 | 0.005 |
| ### | May 8, 2012 | 10:14:46 AM | 15.10 | 3.999 | 3.0947 | 3.775 | 60.385 | 0.084 | 47.87 | 15.150 | 3.9990 | 60.585 | 0.084 | 48.03 | 15.10 | −0.005 |
| ### | May 8, 2012 | 10:14:51 AM | 15.10 | 3.999 | 3.1003 | 3.775 | 60.385 | 0.084 | 47.96 | 15.150 | 3.9990 | 60.585 | 0.084 | 48.11 | 15.10 | −0.004 |
| ### | May 8, 2012 | 10:14:56 AM | 15.10 | 3.999 | 3.1058 | 3.775 | 60.385 | 0.084 | 48.04 | 15.150 | 3.9990 | 60.585 | 0.084 | 48.20 | 15.10 | −0.003 |
| ### | May 8, 2012 | 10:15:01 AM | 15.10 | 3.999 | 3.1114 | 3.775 | 60.385 | 0.084 | 48.12 | 15.150 | 3.9990 | 60.585 | 0.084 | 48.28 | 15.10 | −0.001 |
| ### | May 8, 2012 | 10:15:06 AM | 15.10 | 3.999 | 3.1169 | 3.775 | 60.385 | 0.084 | 48.21 | 15.150 | 3.9990 | 60.585 | 0.084 | 48.36 | 15.10 | 0.001 |
| ### | May 8, 2012 | 10:15:11 AM | 15.10 | 3.999 | 3.1225 | 3.775 | 60.385 | 0.084 | 48.29 | 15.150 | 3.9990 | 60.585 | 0.084 | 48.45 | 15.10 | 0.003 |
| ### | May 8, 2012 | 10:15:16 AM | 15.10 | 3.999 | 3.1280 | 3.775 | 60.385 | 0.084 | 48.38 | 15.150 | 3.9990 | 60.585 | 0.084 | 48.53 | 15.10 | 0.004 |
| ### | May 8, 2012 | 10:15:21 AM | 15.10 | 3.999 | 3.1336 | 3.775 | 60.385 | 0.084 | 48.46 | 15.150 | 3.9990 | 60.585 | 0.084 | 48.62 | 15.10 | 0.005 |
| ### | May 8, 2012 | 10:15:26 AM | 15.09 | 3.999 | 3.1391 | 3.773 | 60.345 | 0.084 | 48.54 | 15.140 | 3.9990 | 60.545 | 0.084 | 48.70 | 15.09 | −0.005 |
| ### | May 8, 2012 | 10:15:31 AM | 15.09 | 3.999 | 3.1446 | 3.773 | 60.345 | 0.084 | 48.63 | 15.140 | 3.9990 | 60.545 | 0.084 | 48.78 | 15.09 | −0.004 |
| ### | May 8, 2012 | 10:15:36 AM | 15.09 | 3.999 | 3.1502 | 3.773 | 60.345 | 0.084 | 48.71 | 15.140 | 3.9990 | 60.545 | 0.084 | 48.87 | 15.09 | −0.003 |
| ### | May 8, 2012 | 10:15:41 AM | 15.09 | 3.999 | 3.1557 | 3.773 | 60.345 | 0.084 | 48.79 | 15.140 | 3.9990 | 60.545 | 0.084 | 48.95 | 15.09 | −0.001 |
| ### | May 8, 2012 | 10:15:46 AM | 15.09 | 3.999 | 3.1613 | 3.773 | 60.345 | 0.084 | 48.88 | 15.140 | 3.9990 | 60.545 | 0.084 | 49.04 | 15.09 | 0.001 |
| ### | May 8, 2012 | 10:15:51 AM | 15.09 | 3.999 | 3.1668 | 3.773 | 60.345 | 0.084 | 48.96 | 15.140 | 3.9990 | 60.545 | 0.084 | 49.12 | 15.09 | 0.003 |
| ### | May 8, 2012 | 10:15:56 AM | 15.09 | 3.999 | 3.1724 | 3.773 | 60.345 | 0.084 | 49.05 | 15.140 | 3.9990 | 60.545 | 0.084 | 49.20 | 15.09 | 0.004 |
| ### | May 8, 2012 | 10:16:01 AM | 15.09 | 3.999 | 3.1779 | 3.773 | 60.345 | 0.084 | 49.13 | 15.140 | 3.9990 | 60.505 | 0.084 | 49.29 | 15.09 | 0.005 |
| ### | May 8, 2012 | 10:16:06 AM | 15.08 | 3.999 | 3.1834 | 3.770 | 60.305 | 0.084 | 49.21 | 15.130 | 3.9990 | 60.505 | 0.084 | 49.37 | 15.08 | −0.005 |
| ### | May 8, 2012 | 10:16:11 AM | 15.08 | 3.999 | 3.1890 | 3.770 | 60.305 | 0.084 | 49.30 | 15.130 | 3.9990 | 60.505 | 0.084 | 49.46 | 15.08 | −0.004 |
| ### | May 8, 2012 | 10:16:16 AM | 15.08 | 3.999 | 3.1946 | 3.770 | 60.305 | 0.084 | 49.38 | 15.130 | 3.9990 | 60.505 | 0.084 | 49.54 | 15.08 | −0.002 |
| ### | May 8, 2012 | 10:16:21 AM | 15.08 | 3.999 | 3.2001 | 3.770 | 60.305 | 0.084 | 49.46 | 15.130 | 3.9990 | 60.505 | 0.084 | 49.63 | 15.08 | 0.000 |
| ### | May 8, 2012 | 10:16:26 AM | 15.08 | 3.999 | 3.2057 | 3.770 | 60.305 | 0.084 | 49.55 | 15.130 | 3.9990 | 60.505 | 0.084 | 49.71 | 15.08 | 0.002 |
| ### | May 8, 2012 | 10:16:31 AM | 15.08 | 3.999 | 3.2112 | 3.770 | 60.305 | 0.084 | 49.63 | 15.130 | 3.9990 | 60.505 | 0.084 | 49.79 | 15.08 | 0.004 |
| ### | May 8, 2012 | 10:16:36 AM | 15.08 | 3.999 | 3.2168 | 3.770 | 60.305 | 0.084 | 49.72 | 15.130 | 3.9990 | 60.465 | 0.084 | 49.88 | 15.08 | 0.005 |
| ### | May 8, 2012 | 10:16:41 AM | 15.07 | 3.999 | 3.2223 | 3.768 | 60.265 | 0.084 | 49.80 | 15.120 | 3.9990 | 60.465 | 0.084 | 49.96 | 15.07 | −0.004 |
| ### | May 8, 2012 | 10:16:46 AM | 15.07 | 3.999 | 3.2278 | 3.768 | 60.265 | 0.084 | 49.88 | 15.120 | 3.9990 | 60.465 | 0.084 | 50.05 | 15.07 | −0.002 |
| ### | May 8, 2012 | 10:16:51 AM | 15.07 | 3.999 | 3.2334 | 3.768 | 60.265 | 0.084 | 49.97 | 15.120 | 3.9990 | 60.465 | 0.084 | 50.13 | 15.07 | 0.000 |
| ### | May 8, 2012 | 10:16:56 AM | 15.07 | 3.999 | 3.2389 | 3.768 | 60.265 | 0.084 | 50.05 | 15.120 | 3.9990 | 60.465 | 0.084 | 50.21 | 15.07 | 0.002 |
| ### | May 8, 2012 | 10:17:01 AM | 15.07 | 3.999 | 3.2445 | 3.768 | 60.265 | 0.084 | 50.13 | 15.120 | 3.9990 | 60.425 | 0.084 | 50.30 | 15.07 | 0.004 |
| ### | May 8, 2012 | 10:17:06 AM | 15.06 | 3.999 | 3.2500 | 3.765 | 60.225 | 0.084 | 50.22 | 15.110 | 3.9990 | 60.425 | 0.084 | 50.38 | 15.06 | −0.005 |
| ### | May 8, 2012 | 10:17:11 AM | 15.06 | 3.999 | 3.2556 | 3.765 | 60.225 | 0.084 | 50.30 | 15.110 | 3.9990 | 60.425 | 0.084 | 50.47 | 15.06 | −0.004 |
| ### | May 8, 2012 | 10:17:16 AM | 15.06 | 3.999 | 3.2611 | 3.765 | 60.225 | 0.084 | 50.39 | 15.110 | 3.9990 | 60.425 | 0.084 | 50.55 | 15.06 | −0.003 |
| ### | May 8, 2012 | 10:17:21 AM | 15.06 | 3.999 | 3.2667 | 3.765 | 60.225 | 0.084 | 50.47 | 15.110 | 3.9990 | 60.425 | 0.084 | 50.63 | 15.06 | −0.001 |
| ### | May 8, 2012 | 10:17:26 AM | 15.06 | 3.999 | 3.2722 | 3.765 | 60.225 | 0.084 | 50.55 | 15.110 | 3.9990 | 60.425 | 0.084 | 50.72 | 15.06 | 0.001 |
| ### | May 8, 2012 | 10:17:31 AM | 15.06 | 3.999 | 3.2778 | 3.765 | 60.225 | 0.084 | 50.64 | 15.110 | 3.9990 | 60.425 | 0.084 | 50.80 | 15.06 | 0.003 |
| ### | May 8, 2012 | 10:17:36 AM | 15.06 | 3.999 | 3.2833 | 3.765 | 60.225 | 0.084 | 50.72 | 15.110 | 3.9990 | 60.425 | 0.084 | 50.88 | 15.06 | 0.004 |
| ### | May 8, 2012 | 10:17:41 AM | 15.06 | 3.999 | 3.2888 | 3.765 | 60.225 | 0.084 | 50.80 | 15.110 | 3.9990 | 60.385 | 0.084 | 50.97 | 15.06 | 0.005 |
| ### | May 8, 2012 | 10:17:46 AM | 15.05 | 3.999 | 3.2944 | 3.763 | 60.185 | 0.084 | 50.89 | 15.100 | 3.9990 | 60.385 | 0.084 | 51.05 | 15.05 | −0.005 |
| ### | May 8, 2012 | 10:17:51 AM | 15.05 | 3.999 | 3.2999 | 3.763 | 60.185 | 0.084 | 50.97 | 15.100 | 3.9990 | 60.385 | 0.084 | 51.14 | 15.05 | −0.004 |
| ### | May 8, 2012 | 10:17:56 AM | 15.05 | 3.999 | 3.3055 | 3.763 | 60.185 | 0.084 | 51.05 | 15.100 | 3.9990 | 60.385 | 0.084 | 51.22 | 15.05 | −0.002 |
| ### | May 8, 2012 | 10:18:01 AM | 15.05 | 3.999 | 3.3110 | 3.763 | 60.185 | 0.084 | 51.14 | 15.100 | 3.9990 | 60.385 | 0.084 | 51.30 | 15.05 | 0.000 |
| ### | May 8, 2012 | 10:18:06 AM | 15.05 | 3.999 | 3.3166 | 3.763 | 60.185 | 0.084 | 51.22 | 15.100 | 3.9990 | 60.385 | 0.084 | 51.39 | 15.05 | 0.002 |
| ### | May 8, 2012 | 10:18:11 AM | 15.05 | 3.999 | 3.3222 | 3.763 | 60.185 | 0.084 | 51.31 | 15.100 | 3.9990 | 60.385 | 0.084 | 51.47 | 15.05 | 0.004 |
| ### | May 8, 2012 | 10:18:16 AM | 15.05 | 3.999 | 3.3277 | 3.763 | 60.185 | 0.084 | 51.39 | 15.100 | 3.9990 | 60.385 | 0.084 | 51.56 | 15.05 | 0.005 |
| ### | May 8, 2012 | 10:18:21 AM | 15.04 | 3.999 | 3.3332 | 3.760 | 60.145 | 0.084 | 51.47 | 15.090 | 3.9990 | 60.345 | 0.084 | 51.64 | 15.04 | −0.005 |
| ### | May 8, 2012 | 10:18:26 AM | 15.04 | 3.999 | 3.3388 | 3.760 | 60.145 | 0.084 | 51.56 | 15.090 | 3.9990 | 60.345 | 0.084 | 51.72 | 15.04 | −0.004 |
| ### | May 8, 2012 | 10:18:31 AM | 15.04 | 3.999 | 3.3443 | 3.760 | 60.145 | 0.084 | 51.64 | 15.090 | 3.9990 | 60.345 | 0.084 | 51.81 | 15.04 | −0.003 |
| ### | May 8, 2012 | 10:18:36 AM | 15.04 | 3.999 | 3.3499 | 3.760 | 60.145 | 0.084 | 51.72 | 15.090 | 3.9990 | 60.345 | 0.084 | 51.89 | 15.04 | −0.001 |
| ### | May 8, 2012 | 10:18:41 AM | 15.04 | 3.999 | 3.3554 | 3.760 | 60.145 | 0.084 | 51.81 | 15.090 | 3.9990 | 60.345 | 0.084 | 51.97 | 15.04 | 0.001 |
| ### | May 8, 2012 | 10:18:46 AM | 15.04 | 3.999 | 3.3609 | 3.760 | 60.145 | 0.084 | 51.89 | 15.090 | 3.9990 | 60.345 | 0.084 | 52.06 | 15.04 | 0.003 |
| ### | May 8, 2012 | 10:18:51 AM | 15.04 | 3.999 | 3.3665 | 3.760 | 60.145 | 0.084 | 51.97 | 15.090 | 3.9990 | 60.345 | 0.084 | 52.14 | 15.04 | 0.004 |
| ### | May 8, 2012 | 10:18:56 AM | 15.04 | 3.999 | 3.3720 | 3.760 | 60.145 | 0.084 | 52.06 | 15.090 | 3.9990 | 60.345 | 0.084 | 52.23 | 15.04 | 0.005 |
| ### | May 8, 2012 | 10:19:01 AM | 15.03 | 3.999 | 3.3776 | 3.758 | 60.105 | 0.083 | 52.14 | 15.080 | 3.9990 | 60.305 | 0.084 | 52.31 | 15.03 | −0.005 |
| ### | May 8, 2012 | 10:19:06 AM | 15.03 | 3.999 | 3.3831 | 3.758 | 60.105 | 0.083 | 52.22 | 15.080 | 3.9990 | 60.305 | 0.084 | 52.39 | 15.03 | −0.004 |
| ### | May 8, 2012 | 10:19:11 AM | 15.03 | 3.999 | 3.3887 | 3.758 | 60.105 | 0.083 | 52.31 | 15.080 | 3.9990 | 60.305 | 0.084 | 52.48 | 15.03 | −0.003 |
| ### | May 8, 2012 | 10:19:16 AM | 15.03 | 3.999 | 3.3942 | 3.758 | 60.105 | 0.083 | 52.39 | 15.080 | 3.9990 | 60.305 | 0.084 | 52.56 | 15.03 | −0.001 |
| ### | May 8, 2012 | 10:19:21 AM | 15.03 | 3.999 | 3.3998 | 3.758 | 60.105 | 0.083 | 52.47 | 15.080 | 3.9990 | 60.305 | 0.084 | 52.64 | 15.03 | 0.001 |
| ### | May 8, 2012 | 10:19:26 AM | 15.03 | 3.999 | 3.4053 | 3.758 | 60.105 | 0.083 | 52.56 | 15.080 | 3.9990 | 60.305 | 0.084 | 52.73 | 15.03 | 0.003 |
| ### | May 8, 2012 | 10:19:31 AM | 15.03 | 3.999 | 3.4113 | 3.758 | 60.105 | 0.083 | 52.64 | 15.080 | 3.9990 | 60.305 | 0.084 | 52.81 | 15.03 | 0.004 |
| ### | May 8, 2012 | 10:19:36 AM | 15.03 | 3.999 | 3.4166 | 3.758 | 60.105 | 0.083 | 52.73 | 15.080 | 3.9990 | 60.305 | 0.084 | 52.90 | 15.03 | 0.005 |
| ### | May 8, 2012 | 10:19:41 AM | 15.02 | 3.999 | 3.4221 | 3.755 | 60.065 | 0.083 | 52.81 | 15.070 | 3.9990 | 60.265 | 0.084 | 52.98 | 15.02 | −0.005 |
| ### | May 8, 2012 | 10:19:46 AM | 15.02 | 3.999 | 3.4277 | 3.755 | 60.065 | 0.083 | 52.89 | 15.070 | 3.9990 | 60.265 | 0.084 | 53.06 | 15.02 | −0.004 |
| ### | May 8, 2012 | 10:19:51 AM | 15.02 | 3.999 | 3.4333 | 3.755 | 60.065 | 0.083 | 52.98 | 15.070 | 3.9990 | 60.265 | 0.084 | 53.15 | 15.02 | −0.002 |
| ### | May 8, 2012 | 10:19:56 AM | 15.02 | 3.999 | 3.4389 | 3.755 | 60.065 | 0.083 | 53.06 | 15.070 | 3.9990 | 60.265 | 0.084 | 53.23 | 15.02 | 0.000 |
| ### | May 8, 2012 | 10:20:01 AM | 15.02 | 3.999 | 3.4444 | 3.755 | 60.065 | 0.083 | 53.14 | 15.070 | 3.9990 | 60.265 | 0.084 | 53.31 | 15.02 | 0.002 |
| ### | May 8, 2012 | 10:20:06 AM | 15.02 | 3.999 | 3.4500 | 3.755 | 60.065 | 0.083 | 53.23 | 15.070 | 3.9990 | 60.265 | 0.084 | 53.40 | 15.02 | 0.004 |
| ### | May 8, 2012 | 10:20:11 AM | 15.02 | 3.999 | 3.4555 | 3.755 | 60.065 | 0.083 | 53.31 | 15.070 | 3.9990 | 60.265 | 0.084 | 53.48 | 15.02 | 0.005 |
| ### | May 8, 2012 | 10:20:16 AM | 15.01 | 3.999 | 3.4610 | 3.753 | 60.025 | 0.083 | 53.39 | 15.060 | 3.9990 | 60.225 | 0.084 | 53.57 | 15.01 | −0.005 |
| ### | May 8, 2012 | 10:20:21 AM | 15.01 | 3.999 | 3.4666 | 3.753 | 60.025 | 0.083 | 53.48 | 15.060 | 3.9990 | 60.225 | 0.084 | 53.65 | 15.01 | −0.004 |
| ### | May 8, 2012 | 10:20:26 AM | 15.01 | 3.999 | 3.4721 | 3.753 | 60.025 | 0.083 | 53.56 | 15.060 | 3.9990 | 60.225 | 0.084 | 53.73 | 15.01 | −0.002 |
| ### | May 8, 2012 | 10:20:31 AM | 15.01 | 3.999 | 3.4779 | 3.753 | 60.025 | 0.083 | 53.64 | 15.060 | 3.9990 | 60.225 | 0.084 | 53.82 | 15.01 | 0.000 |
| ### | May 8, 2012 | 10:20:36 AM | 15.01 | 3.999 | 3.4831 | 3.753 | 60.025 | 0.083 | 53.73 | 15.060 | 3.9990 | 60.225 | 0.084 | 53.90 | 15.01 | 0.002 |
| ### | May 8, 2012 | 10:20:41 AM | 15.01 | 3.999 | 3.4889 | 3.753 | 60.025 | 0.083 | 53.81 | 15.060 | 3.9990 | 60.225 | 0.084 | 53.98 | 15.01 | 0.004 |
| ### | May 8, 2012 | 10:20:46 AM | 15.01 | 3.999 | 3.4945 | 3.753 | 60.025 | 0.083 | 53.89 | 15.060 | 3.9990 | 60.225 | 0.084 | 54.07 | 15.01 | 0.005 |
| ### | May 8, 2012 | 10:20:51 AM | 15.00 | 3.999 | 3.5000 | 3.750 | 59.985 | 0.083 | 53.98 | 15.050 | 3.9990 | 60.185 | 0.084 | 54.15 | 15.00 | −0.005 |
| ### | May 8, 2012 | 10:20:56 AM | 15.00 | 3.999 | 3.5056 | 3.750 | 59.985 | 0.083 | 54.06 | 15.050 | 3.9990 | 60.185 | 0.084 | 54.23 | 15.00 | −0.004 |
| ### | May 8, 2012 | 10:21:01 AM | 15.00 | 3.999 | 3.5111 | 3.750 | 59.985 | 0.083 | 54.14 | 15.050 | 3.9990 | 60.185 | 0.084 | 54.32 | 15.00 | −0.003 |
| ### | May 8, 2012 | 10:21:06 AM | 15.00 | 3.999 | 3.5167 | 3.750 | 59.985 | 0.083 | 54.23 | 15.050 | 3.9990 | 60.185 | 0.084 | 54.40 | 15.00 | −0.001 |
| ### | May 8, 2012 | 10:21:11 AM | 15.00 | 3.999 | 3.5219 | 3.750 | 59.985 | 0.083 | 54.31 | 15.050 | 3.9990 | 60.185 | 0.084 | 54.49 | 15.00 | 0.001 |
| ### | May 8, 2012 | 10:21:16 AM | 15.00 | 3.999 | 3.5278 | 3.750 | 59.985 | 0.083 | 54.39 | 15.050 | 3.9990 | 60.185 | 0.084 | 54.57 | 15.00 | 0.003 |
| ### | May 8, 2012 | 10:21:21 AM | 15.00 | 3.999 | 3.5330 | 3.750 | 59.985 | 0.083 | 54.48 | 15.050 | 3.9990 | 60.185 | 0.084 | 54.65 | 15.00 | 0.004 |
| ### | May 8, 2012 | 10:21:26 AM | 15.00 | 3.999 | 3.5389 | 3.750 | 59.985 | 0.083 | 54.56 | 15.050 | 3.9990 | 60.185 | 0.084 | 54.74 | 15.00 | 0.005 |
| ### | May 8, 2012 | 10:21:31 AM | 14.99 | 3.999 | 3.5444 | 3.748 | 59.945 | 0.083 | 54.64 | 15.040 | 3.9990 | 60.145 | 0.084 | 54.82 | 14.99 | −0.005 |
| ### | May 8, 2012 | 10:21:36 AM | 14.99 | 3.999 | 3.5499 | 3.748 | 59.945 | 0.083 | 54.73 | 15.040 | 3.9990 | 60.145 | 0.084 | 54.90 | 14.99 | −0.004 |
| ### | May 8, 2012 | 10:21:41 AM | 14.99 | 3.999 | 3.5553 | 3.748 | 59.945 | 0.083 | 54.81 | 15.040 | 3.9990 | 60.145 | 0.084 | 54.99 | 14.99 | −0.003 |
| ### | May 8, 2012 | 10:21:46 AM | 14.99 | 3.999 | 3.5609 | 3.748 | 59.945 | 0.083 | 54.89 | 15.040 | 3.9990 | 60.145 | 0.084 | 55.07 | 14.99 | −0.001 |
| ### | May 8, 2012 | 10:21:51 AM | 14.99 | 3.999 | 3.5664 | 3.748 | 59.945 | 0.083 | 54.98 | 15.040 | 3.9990 | 60.145 | 0.084 | 55.15 | 14.99 | 0.001 |
| ### | May 8, 2012 | 10:21:56 AM | 14.99 | 3.999 | 3.5719 | 3.748 | 59.945 | 0.083 | 55.06 | 15.040 | 3.9990 | 60.145 | 0.084 | 55.24 | 14.99 | 0.003 |
| ### | May 8, 2012 | 10:22:01 AM | 14.99 | 3.999 | 3.5775 | 3.748 | 59.945 | 0.083 | 55.14 | 15.040 | 3.9990 | 60.145 | 0.084 | 55.32 | 14.99 | 0.004 |
| ### | May 8, 2012 | 10:22:06 AM | 14.99 | 3.999 | 3.5830 | 3.748 | 59.945 | 0.083 | 55.23 | 15.040 | 3.9990 | 60.145 | 0.084 | 55.40 | 14.99 | 0.005 |
| ### | May 8, 2012 | 10:22:11 AM | 14.98 | 3.999 | 3.5887 | 3.745 | 59.905 | 0.083 | 55.31 | 15.030 | 3.9990 | 60.105 | 0.083 | 55.49 | 14.98 | −0.005 |
| ### | May 8, 2012 | 10:22:16 AM | 14.98 | 3.999 | 3.5939 | 3.745 | 59.905 | 0.083 | 55.39 | 15.030 | 3.9990 | 60.105 | 0.083 | 55.57 | 14.98 | −0.004 |
| ### | May 8, 2012 | 10:22:21 AM | 14.98 | 3.999 | 3.5995 | 3.745 | 59.905 | 0.083 | 55.47 | 15.030 | 3.9990 | 60.105 | 0.083 | 55.66 | 14.98 | −0.003 |
| ### | May 8, 2012 | 10:22:26 AM | 14.98 | 3.999 | 3.6054 | 3.745 | 59.905 | 0.083 | 55.56 | 15.030 | 3.9990 | 60.105 | 0.083 | 55.74 | 14.98 | −0.001 |
| ### | May 8, 2012 | 10:22:31 AM | 14.98 | 4.000 | 3.6109 | 3.745 | 59.905 | 0.083 | 55.64 | 15.030 | 4.0000 | 60.120 | 0.083 | 55.82 | 14.98 | 0.001 |
| ### | May 8, 2012 | 10:22:36 AM | 14.98 | 3.999 | 3.6165 | 3.745 | 59.905 | 0.083 | 55.72 | 15.030 | 3.9990 | 60.105 | 0.083 | 55.91 | 14.98 | 0.003 |
| ### | May 8, 2012 | 10:22:41 AM | 14.98 | 3.999 | 3.6220 | 3.745 | 59.905 | 0.083 | 55.81 | 15.030 | 3.9990 | 60.105 | 0.083 | 55.99 | 14.98 | 0.004 |
| ### | May 8, 2012 | 10:22:46 AM | 14.98 | 3.999 | 3.6276 | 3.745 | 59.905 | 0.083 | 55.89 | 15.030 | 3.9990 | 60.105 | 0.083 | 56.07 | 14.98 | 0.005 |
| ### | May 8, 2012 | 10:22:51 AM | 14.97 | 3.999 | 3.6331 | 3.743 | 59.865 | 0.083 | 55.97 | 15.020 | 3.9990 | 60.065 | 0.083 | 56.16 | 14.97 | −0.005 |
| ### | May 8, 2012 | 10:22:56 AM | 14.97 | 3.999 | 3.6387 | 3.743 | 59.865 | 0.083 | 56.06 | 15.020 | 3.9990 | 60.065 | 0.083 | 56.24 | 14.97 | −0.004 |
| ### | May 8, 2012 | 10:23:01 AM | 14.97 | 3.999 | 3.6442 | 3.743 | 59.865 | 0.083 | 56.14 | 15.020 | 3.9990 | 60.065 | 0.083 | 56.32 | 14.97 | −0.003 |
| ### | May 8, 2012 | 10:23:06 AM | 14.97 | 3.999 | 3.6497 | 3.743 | 59.865 | 0.083 | 56.22 | 15.020 | 3.9990 | 60.065 | 0.083 | 56.41 | 14.97 | −0.001 |
| ### | May 8, 2012 | 10:23:11 AM | 14.97 | 3.999 | 3.6553 | 3.743 | 59.865 | 0.083 | 56.31 | 15.020 | 3.9990 | 60.065 | 0.083 | 56.49 | 14.97 | 0.001 |
| ### | May 8, 2012 | 10:23:16 AM | 14.97 | 3.999 | 3.6608 | 3.743 | 59.865 | 0.083 | 56.39 | 15.020 | 3.9990 | 60.065 | 0.083 | 56.57 | 14.97 | 0.003 |
| ### | May 8, 2012 | 10:23:21 AM | 14.97 | 3.999 | 3.6664 | 3.743 | 59.865 | 0.083 | 56.47 | 15.020 | 3.9990 | 60.065 | 0.083 | 56.66 | 14.97 | 0.004 |
| ### | May 8, 2012 | 10:23:26 AM | 14.97 | 3.999 | 3.6719 | 3.743 | 59.865 | 0.083 | 56.56 | 15.020 | 3.9990 | 60.065 | 0.083 | 56.74 | 14.97 | 0.005 |
| ### | May 8, 2012 | 10:23:31 AM | 14.97 | 3.999 | 3.6775 | 3.743 | 59.865 | 0.083 | 56.64 | 15.020 | 3.9990 | 60.065 | 0.083 | 56.82 | 14.97 | −0.005 |
| ### | May 8, 2012 | 10:23:26 AM | 14.97 | 3.999 | 3.6830 | 3.743 | 59.865 | 0.083 | 56.72 | 15.020 | 3.9990 | 60.065 | 0.083 | 56.91 | 14.97 | −0.004 |
| ### | May 8, 2012 | 10:23:41 AM | 14.96 | 3.999 | 3.6882 | 3.740 | 59.825 | 0.083 | 56.81 | 15.010 | 3.9990 | 60.025 | 0.083 | 56.99 | 14.96 | −0.003 |
| ### | May 8, 2012 | 10:23:46 AM | 14.96 | 3.999 | 3.6941 | 3.740 | 59.825 | 0.083 | 56.89 | 15.010 | 3.9990 | 60.025 | 0.083 | 57.07 | 14.96 | −0.001 |
| ### | May 8, 2012 | 10:23:51 AM | 14.96 | 3.999 | 3.6997 | 3.740 | 59.825 | 0.083 | 56.97 | 15.010 | 3.9990 | 60.025 | 0.083 | 57.16 | 14.96 | 0.001 |
| ### | May 8, 2012 | 10:23:56 AM | 14.96 | 3.999 | 3.7052 | 3.740 | 59.825 | 0.083 | 57.05 | 15.010 | 3.9990 | 60.025 | 0.083 | 57.24 | 14.96 | 0.003 |
| ### | May 8, 2012 | 10:24:01 AM | 14.96 | 3.999 | 3.7108 | 3.740 | 59.825 | 0.083 | 57.14 | 15.010 | 3.9990 | 60.025 | 0.083 | 57.32 | 14.96 | 0.004 |
| ### | May 8, 2012 | 10:24:06 AM | 14.96 | 3.999 | 3.7163 | 3.740 | 59.825 | 0.083 | 57.22 | 15.010 | 3.9990 | 60.025 | 0.083 | 57.41 | 14.96 | 0.005 |
| ### | May 8, 2012 | 10:24:11 AM | 14.95 | 3.999 | 3.7218 | 3.738 | 59.785 | 0.083 | 57.30 | 15.000 | 3.9990 | 59.985 | 0.083 | 57.49 | 14.95 | −0.005 |
| ### | May 8, 2012 | 10:24:16 AM | 14.95 | 3.999 | 3.7270 | 3.738 | 59.785 | 0.083 | 57.39 | 15.000 | 3.9990 | 59.985 | 0.083 | 57.57 | 14.95 | −0.004 |
| ### | May 8, 2012 | 10:24:21 AM | 14.95 | 3.999 | 3.7329 | 3.738 | 59.785 | 0.083 | 57.47 | 15.000 | 3.9990 | 59.985 | 0.083 | 57.66 | 14.95 | −0.003 |
| ### | May 8, 2012 | 10:24:26 AM | 14.95 | 3.999 | 3.7381 | 3.738 | 59.785 | 0.083 | 57.55 | 15.000 | 3.9990 | 59.985 | 0.083 | 57.74 | 14.95 | −0.001 |
| ### | May 8, 2012 | 10:24:31 AM | 14.95 | 3.999 | 3.7440 | 3.738 | 59.785 | 0.083 | 57.64 | 15.000 | 3.9990 | 59.985 | 0.083 | 57.82 | 14.95 | 0.001 |
| ### | May 8, 2012 | 10:24:36 AM | 14.95 | 3.999 | 3.7496 | 3.738 | 59.785 | 0.083 | 57.72 | 15.000 | 3.9990 | 59.985 | 0.083 | 57.91 | 14.95 | 0.003 |
| ### | May 8, 2012 | 10:24:41 AM | 14.95 | 3.999 | 3.7551 | 3.738 | 59.785 | 0.083 | 57.80 | 15.000 | 3.9990 | 59.985 | 0.083 | 57.99 | 14.95 | 0.004 |
| ### | May 8, 2012 | 10:24:46 AM | 14.95 | 3.999 | 3.7607 | 3.738 | 59.785 | 0.083 | 57.89 | 15.000 | 3.9990 | 59.985 | 0.083 | 58.07 | 14.95 | 0.005 |
| ### | May 8, 2012 | 10:24:51 AM | 14.94 | 3.999 | 3.7662 | 3.735 | 59.745 | 0.083 | 57.97 | 14.990 | 3.9990 | 59.945 | 0.083 | 58.16 | 14.94 | −0.005 |
| ### | May 8, 2012 | 10:24:56 AM | 14.94 | 3.999 | 3.7718 | 3.735 | 59.745 | 0.083 | 58.05 | 14.990 | 3.9990 | 59.945 | 0.083 | 58.24 | 14.94 | −0.004 |
| ### | May 8, 2012 | 10:25:01 AM | 14.94 | 3.999 | 3.7769 | 3.735 | 59.745 | 0.083 | 58.13 | 14.990 | 3.9990 | 59.945 | 0.083 | 58.32 | 14.94 | −0.003 |
| ### | May 8, 2012 | 10:25:06 AM | 14.94 | 3.999 | 3.7825 | 3.735 | 59.745 | 0.083 | 58.22 | 14.990 | 3.9990 | 59.945 | 0.083 | 58.41 | 14.94 | −0.001 |
| ### | May 8, 2012 | 10:25:11 AM | 14.94 | 3.999 | 3.7880 | 3.735 | 59.745 | 0.083 | 58.30 | 14.990 | 3.9990 | 59.945 | 0.083 | 58.49 | 14.94 | 0.001 |
| ### | May 8, 2012 | 10:25:16 AM | 14.94 | 3.999 | 3.7939 | 3.735 | 59.745 | 0.083 | 58.38 | 14.990 | 3.9990 | 59.945 | 0.083 | 58.57 | 14.94 | 0.003 |
| ### | May 8, 2012 | 10:25:21 AM | 14.94 | 3.999 | 3.7991 | 3.735 | 59.745 | 0.083 | 58.47 | 14.990 | 3.9990 | 59.945 | 0.083 | 58.66 | 14.94 | 0.004 |
| ### | May 8, 2012 | 10:25:26 AM | 14.94 | 3.999 | 3.8050 | 3.735 | 59.745 | 0.083 | 58.55 | 14.990 | 3.9990 | 59.945 | 0.083 | 58.74 | 14.94 | 0.005 |
| ### | May 8, 2012 | 10:25:31 AM | 14.93 | 3.999 | 3.8106 | 3.733 | 59.705 | 0.083 | 58.63 | 14.980 | 3.9990 | 59.905 | 0.083 | 58.82 | 14.93 | −0.005 |
| ### | May 8, 2012 | 10:25:36 AM | 14.93 | 3.999 | 3.8158 | 3.733 | 59.705 | 0.083 | 58.71 | 14.980 | 3.9990 | 59.905 | 0.083 | 58.91 | 14.93 | −0.004 |
| ### | May 8, 2012 | 10:25:41 AM | 14.93 | 3.999 | 3.8217 | 3.733 | 59.705 | 0.083 | 58.80 | 14.980 | 3.9990 | 59.905 | 0.083 | 58.99 | 14.93 | −0.002 |
| ### | May 8, 2012 | 10:25:46 AM | 14.93 | 3.999 | 3.8269 | 3.733 | 59.705 | 0.083 | 58.88 | 14.980 | 3.9990 | 59.905 | 0.083 | 59.07 | 14.93 | 0.000 |
| ### | May 8, 2012 | 10:25:51 AM | 14.93 | 3.999 | 3.8328 | 3.733 | 59.705 | 0.083 | 58.96 | 14.980 | 3.9990 | 59.905 | 0.083 | 59.16 | 14.93 | 0.002 |
| ### | May 8, 2012 | 10:25:56 AM | 14.93 | 3.999 | 3.8383 | 3.733 | 59.705 | 0.083 | 59.05 | 14.980 | 3.9990 | 59.905 | 0.083 | 59.24 | 14.93 | 0.004 |
| ### | May 8, 2012 | 10:26:01 AM | 14.93 | 3.999 | 3.8438 | 3.733 | 59.705 | 0.083 | 59.13 | 14.980 | 3.9990 | 59.905 | 0.083 | 59.32 | 14.93 | 0.005 |
| ### | May 8, 2012 | 10:26:06 AM | 14.92 | 3.999 | 3.8494 | 3.730 | 59.665 | 0.083 | 59.21 | 14.970 | 3.9990 | 59.865 | 0.083 | 59.40 | 14.92 | −0.005 |
| ### | May 8, 2012 | 10:26:11 AM | 14.92 | 3.999 | 3.8549 | 3.730 | 59.665 | 0.083 | 59.30 | 14.970 | 3.9990 | 59.865 | 0.083 | 59.49 | 14.92 | −0.004 |
| ### | May 8, 2012 | 10:26:16 AM | 14.92 | 3.999 | 3.8605 | 3.730 | 59.665 | 0.083 | 59.38 | 14.970 | 3.9990 | 59.865 | 0.083 | 59.57 | 14.92 | −0.003 |
| ### | May 8, 2012 | 10:26:21 AM | 14.92 | 3.999 | 3.8660 | 3.730 | 59.665 | 0.083 | 59.46 | 14.970 | 3.9990 | 59.865 | 0.083 | 59.65 | 14.92 | −0.001 |
| ### | May 8, 2012 | 10:26:26 AM | 14.92 | 3.999 | 3.8716 | 3.730 | 59.665 | 0.083 | 59.54 | 14.970 | 3.9990 | 59.865 | 0.083 | 59.74 | 14.92 | 0.001 |
| ### | May 8, 2012 | 10:26:31 AM | 14.92 | 3.999 | 3.8771 | 3.730 | 59.665 | 0.083 | 59.63 | 14.970 | 3.9990 | 59.865 | 0.083 | 59.82 | 14.92 | 0.003 |
| ### | May 8, 2012 | 10:26:36 AM | 14.92 | 3.999 | 3.8827 | 3.730 | 59.665 | 0.083 | 59.71 | 14.970 | 3.9990 | 59.865 | 0.083 | 59.90 | 14.92 | 0.004 |
| ### | May 8, 2012 | 10:26:41 AM | 14.92 | 3.999 | 3.8879 | 3.730 | 59.665 | 0.083 | 59.79 | 14.970 | 3.9990 | 59.865 | 0.083 | 59.99 | 14.92 | 0.005 |
| ### | May 8, 2012 | 10:26:46 AM | 14.91 | 3.999 | 3.8938 | 3.728 | 59.625 | 0.083 | 59.88 | 14.960 | 3.9990 | 59.825 | 0.083 | 60.07 | 14.91 | −0.005 |
| ### | May 8, 2012 | 10:26:51 AM | 14.91 | 3.999 | 3.8993 | 3.728 | 59.625 | 0.083 | 59.96 | 14.960 | 3.9990 | 59.825 | 0.083 | 60.15 | 14.91 | −0.004 |
| ### | May 8, 2012 | 10:26:56 AM | 14.91 | 3.999 | 3.9048 | 3.728 | 59.625 | 0.083 | 60.04 | 14.960 | 3.9990 | 59.825 | 0.083 | 60.24 | 14.91 | −0.003 |
| ### | May 8, 2012 | 10:27:01 AM | 14.91 | 3.999 | 3.9104 | 3.728 | 59.625 | 0.083 | 60.12 | 14.960 | 3.9990 | 59.825 | 0.083 | 60.32 | 14.91 | −0.002 |
| ### | May 8, 2012 | 10:27:06 AM | 14.91 | 3.999 | 3.9159 | 3.728 | 59.625 | 0.083 | 60.21 | 14.960 | 3.9990 | 59.825 | 0.083 | 60.40 | 14.91 | 0.000 |
| ### | May 8, 2012 | 10:27:11 AM | 14.91 | 3.999 | 3.9215 | 3.728 | 59.625 | 0.083 | 60.29 | 14.960 | 3.9990 | 59.825 | 0.083 | 60.49 | 14.91 | 0.002 |
| ### | May 8, 2012 | 10:27:16 AM | 14.91 | 3.999 | 3.9270 | 3.728 | 59.625 | 0.083 | 60.37 | 14.960 | 3.9990 | 59.825 | 0.083 | 60.57 | 14.91 | 0.003 |
| ### | May 8, 2012 | 10:27:21 AM | 14.91 | 3.999 | 3.9326 | 3.728 | 59.625 | 0.083 | 60.45 | 14.960 | 3.9990 | 59.825 | 0.083 | 60.65 | 14.91 | 0.004 |
| ### | May 8, 2012 | 10:27:26 AM | 14.91 | 3.999 | 3.9381 | 3.728 | 59.625 | 0.083 | 60.54 | 14.960 | 3.9990 | 59.825 | 0.083 | 60.73 | 14.91 | 0.005 |
| ### | May 8, 2012 | 10:27:31 AM | 14.90 | 3.999 | 3.9437 | 3.725 | 59.585 | 0.083 | 60.62 | 14.950 | 3.9990 | 59.785 | 0.083 | 60.82 | 14.90 | −0.005 |
| ### | May 8, 2012 | 10:27:36 AM | 14.90 | 3.999 | 3.9489 | 3.725 | 59.585 | 0.083 | 60.70 | 14.950 | 3.9990 | 59.785 | 0.083 | 60.90 | 14.90 | −0.004 |
| ### | May 8, 2012 | 10:27:41 AM | 14.90 | 3.999 | 3.9548 | 3.725 | 59.585 | 0.083 | 60.79 | 14.950 | 3.9990 | 59.785 | 0.083 | 60.98 | 14.90 | −0.003 |
| ### | May 8, 2012 | 10:27:46 AM | 14.90 | 3.999 | 3.9603 | 3.725 | 59.585 | 0.083 | 60.87 | 14.950 | 3.9990 | 59.785 | 0.083 | 61.07 | 14.90 | −0.001 |
| ### | May 8, 2012 | 10:27:51 AM | 14.90 | 3.999 | 3.9655 | 3.725 | 59.585 | 0.083 | 60.95 | 14.950 | 3.9990 | 59.785 | 0.083 | 61.15 | 14.90 | 0.001 |
| ### | May 8, 2012 | 10:27:56 AM | 14.90 | 3.999 | 3.9710 | 3.725 | 59.585 | 0.083 | 61.03 | 14.950 | 3.9990 | 59.785 | 0.083 | 61.23 | 14.90 | 0.003 |
| ### | May 8, 2012 | 10:28:01 AM | 14.90 | 3.999 | 3.9770 | 3.725 | 59.585 | 0.083 | 61.12 | 14.950 | 3.9990 | 59.785 | 0.083 | 61.32 | 14.90 | 0.004 |
| ### | May 8, 2012 | 10:28:06 AM | 14.90 | 3.999 | 3.9825 | 3.725 | 59.585 | 0.083 | 61.20 | 14.950 | 3.9990 | 59.785 | 0.083 | 61.40 | 14.90 | 0.005 |
| ### | May 8, 2012 | 10:28:11 AM | 14.89 | 3.999 | 3.9877 | 3.723 | 59.545 | 0.083 | 61.28 | 14.940 | 3.9990 | 59.745 | 0.083 | 61.48 | 14.89 | −0.005 |
| ### | May 8, 2012 | 10:28:16 AM | 14.89 | 3.999 | 3.9936 | 3.723 | 59.545 | 0.083 | 61.37 | 14.940 | 3.9990 | 59.745 | 0.083 | 61.56 | 14.89 | −0.004 |
| ### | May 8, 2012 | 10:28:21 AM | 14.89 | 3.999 | 3.9991 | 3.723 | 59.545 | 0.083 | 61.45 | 14.940 | 3.9990 | 59.745 | 0.083 | 61.65 | 14.89 | −0.003 |
| ### | May 8, 2012 | 10:28:26 AM | 14.89 | 3.999 | 4.0047 | 3.723 | 59.545 | 0.083 | 61.53 | 14.940 | 3.9990 | 59.745 | 0.083 | 61.73 | 14.89 | −0.001 |
| ### | May 8, 2012 | 10:28:31 AM | 14.89 | 3.999 | 4.0102 | 3.723 | 59.545 | 0.083 | 61.61 | 14.940 | 3.9990 | 59.745 | 0.083 | 61.81 | 14.89 | 0.001 |
| ### | May 8, 2012 | 10:28:36 AM | 14.89 | 3.999 | 4.0154 | 3.723 | 59.545 | 0.083 | 61.70 | 14.940 | 3.9990 | 59.745 | 0.083 | 61.90 | 14.89 | 0.003 |
| ### | May 8, 2012 | 10:28:41 AM | 14.89 | 3.999 | 4.0213 | 3.723 | 59.545 | 0.083 | 61.78 | 14.940 | 3.9990 | 59.745 | 0.083 | 61.98 | 14.89 | 0.004 |
| ### | May 8, 2012 | 10:28:46 AM | 14.89 | 3.999 | 4.0265 | 3.723 | 59.545 | 0.083 | 61.86 | 14.940 | 3.9990 | 59.745 | 0.083 | 62.06 | 14.89 | 0.005 |
| ### | May 8, 2012 | 10:28:51 AM | 14.88 | 3.999 | 4.0321 | 3.720 | 59.505 | 0.083 | 61.94 | 14.930 | 4.0000 | 59.705 | 0.083 | 62.15 | 14.88 | −0.005 |
| ### | May 8, 2012 | 10:28:56 AM | 14.88 | 3.999 | 4.0376 | 3.720 | 59.505 | 0.083 | 62.03 | 14.930 | 3.9990 | 59.705 | 0.083 | 62.23 | 14.88 | −0.004 |
| ### | May 8, 2012 | 10:29:01 AM | 14.88 | 3.999 | 4.0435 | 3.720 | 59.505 | 0.083 | 62.11 | 14.930 | 3.9990 | 59.705 | 0.083 | 62.31 | 14.88 | −0.003 |
| ### | May 8, 2012 | 10:29:06 AM | 14.88 | 3.999 | 4.0490 | 3.720 | 59.505 | 0.083 | 62.19 | 14.930 | 3.9990 | 59.705 | 0.083 | 62.39 | 14.88 | −0.002 |
| ### | May 8, 2012 | 10:29:11 AM | 14.88 | 3.999 | 4.0542 | 3.720 | 59.505 | 0.083 | 62.27 | 14.930 | 3.9990 | 59.705 | 0.083 | 62.48 | 14.88 | 0.000 |
| ### | May 8, 2012 | 10:29:16 AM | 14.88 | 3.999 | 4.0599 | 3.720 | 59.505 | 0.083 | 62.36 | 14.930 | 3.9990 | 59.705 | 0.083 | 62.56 | 14.88 | 0.002 |
| ### | May 8, 2012 | 10:29:21 AM | 14.88 | 3.999 | 4.0655 | 3.720 | 59.505 | 0.083 | 62.44 | 14.930 | 3.9990 | 59.705 | 0.083 | 62.64 | 14.88 | 0.003 |
| ### | May 8, 2012 | 10:29:26 AM | 14.88 | 3.999 | 4.0709 | 3.720 | 59.505 | 0.083 | 62.52 | 14.930 | 3.9990 | 59.705 | 0.083 | 62.73 | 14.88 | 0.004 |
| ### | May 8, 2012 | 10:29:31 AM | 14.88 | 3.999 | 4.0768 | 3.720 | 59.505 | 0.083 | 62.61 | 14.930 | 3.9990 | 59.705 | 0.083 | 62.81 | 14.88 | 0.005 |
| ### | May 8, 2012 | 10:29:26 AM | 14.87 | 3.999 | 4.0823 | 3.718 | 59.465 | 0.083 | 62.69 | 14.920 | 3.9990 | 59.665 | 0.083 | 62.89 | 14.87 | −0.005 |
| ### | May 8, 2012 | 10:29:41 AM | 14.87 | 3.999 | 4.0875 | 3.718 | 59.465 | 0.083 | 62.77 | 14.920 | 3.9990 | 59.665 | 0.083 | 62.97 | 14.87 | −0.004 |
| ### | May 8, 2012 | 10:29:46 AM | 14.87 | 3.999 | 4.0934 | 3.718 | 59.465 | 0.083 | 62.85 | 14.920 | 3.9990 | 59.665 | 0.083 | 63.06 | 14.87 | −0.003 |
| ### | May 8, 2012 | 10:29:51 AM | 14.87 | 3.999 | 4.0989 | 3.718 | 59.465 | 0.083 | 62.94 | 14.920 | 3.9990 | 59.665 | 0.083 | 63.14 | 14.87 | −0.002 |
| ### | May 8, 2012 | 10:29:56 AM | 14.87 | 3.999 | 4.1041 | 3.718 | 59.465 | 0.083 | 63.02 | 14.920 | 3.9990 | 59.665 | 0.083 | 63.22 | 14.87 | −0.001 |
| ### | May 8, 2012 | 10:30:01 AM | 14.87 | 3.999 | 4.1100 | 3.718 | 59.465 | 0.083 | 63.10 | 14.920 | 3.9990 | 59.665 | 0.083 | 63.31 | 14.87 | 0.001 |
| ### | May 8, 2012 | 10:30:06 AM | 14.87 | 3.999 | 4.1156 | 3.718 | 59.465 | 0.083 | 63.18 | 14.920 | 3.9990 | 59.665 | 0.083 | 63.39 | 14.87 | 0.002 |
| ### | May 8, 2012 | 10:30:11 AM | 14.87 | 3.999 | 4.1211 | 3.718 | 59.465 | 0.083 | 63.27 | 14.920 | 3.9990 | 59.665 | 0.083 | 63.47 | 14.87 | 0.003 |
| ### | May 8, 2012 | 10:30:16 AM | 14.87 | 3.999 | 4.1267 | 3.718 | 59.465 | 0.083 | 63.35 | 14.920 | 3.9990 | 59.665 | 0.083 | 63.55 | 14.87 | 0.004 |
| ### | May 8, 2012 | 10:30:21 AM | 14.87 | 3.999 | 4.1319 | 3.718 | 59.465 | 0.083 | 63.43 | 14.920 | 3.9990 | 59.665 | 0.083 | 63.64 | 14.87 | 0.005 |
| ### | May 8, 2012 | 10:30:26 AM | 14.86 | 3.999 | 4.1376 | 3.715 | 59.425 | 0.083 | 63.51 | 14.910 | 3.9990 | 59.625 | 0.083 | 63.72 | 14.86 | −0.005 |
| ### | May 8, 2012 | 10:30:31 AM | 14.86 | 3.999 | 4.1432 | 3.715 | 59.425 | 0.083 | 63.60 | 14.910 | 3.9990 | 59.625 | 0.083 | 63.80 | 14.86 | −0.004 |
| ### | May 8, 2012 | 10:30:36 AM | 14.86 | 3.999 | 4.1487 | 3.715 | 59.425 | 0.083 | 63.68 | 14.910 | 3.9990 | 59.625 | 0.083 | 63.89 | 14.86 | −0.003 |
| ### | May 8, 2012 | 10:30:41 AM | 14.86 | 3.999 | 4.1543 | 3.715 | 59.425 | 0.083 | 63.76 | 14.910 | 3.9990 | 59.625 | 0.083 | 63.97 | 14.86 | −0.001 |
| ### | May 8, 2012 | 10:30:46 AM | 14.86 | 3.999 | 4.1598 | 3.715 | 59.425 | 0.083 | 63.84 | 14.910 | 3.9990 | 59.625 | 0.083 | 64.05 | 14.86 | 0.001 |
| ### | May 8, 2012 | 10:30:51 AM | 14.86 | 3.999 | 4.1654 | 3.715 | 59.425 | 0.083 | 63.93 | 14.910 | 3.9990 | 59.625 | 0.083 | 64.13 | 14.86 | 0.003 |
| ### | May 8, 2012 | 10:30:56 AM | 14.86 | 3.999 | 4.1709 | 3.715 | 59.425 | 0.083 | 64.01 | 14.910 | 3.9990 | 59.625 | 0.083 | 64.22 | 14.86 | 0.004 |
| ### | May 8, 2012 | 10:31:01 AM | 14.86 | 3.999 | 4.1765 | 3.715 | 59.425 | 0.083 | 64.09 | 15.910 | 3.9990 | 59.625 | 0.083 | 64.30 | 14.86 | 0.005 |
| ### | May 8, 2012 | 10:31:06 AM | 14.85 | 3.999 | 4.1820 | 3.713 | 59.385 | 0.082 | 64.17 | 14.900 | 3.9990 | 59.585 | 0.083 | 64.38 | 14.85 | −0.005 |
| ### | May 8, 2012 | 10:31:11 AM | 14.85 | 3.999 | 4.1875 | 3.713 | 59.385 | 0.082 | 64.26 | 14.900 | 3.9990 | 59.585 | 0.083 | 64.47 | 14.85 | −0.007 |
| ### | May 8, 2012 | 10:31:16 AM | 14.85 | 3.999 | 4.1931 | 3.713 | 59.385 | 0.082 | 64.34 | 14.900 | 3.9990 | 59.585 | 0.083 | 64.55 | 14.85 | −0.003 |
| ### | May 8, 2012 | 10:31:21 AM | 14.85 | 3.999 | 4.1987 | 3.713 | 59.385 | 0.082 | 64.42 | 14.900 | 3.9990 | 59.585 | 0.083 | 64.63 | 14.85 | −0.002 |
| ### | May 8, 2012 | 10:31:26 AM | 14.85 | 3.999 | 4.2042 | 3.713 | 59.385 | 0.082 | 64.50 | 14.900 | 3.9990 | 59.585 | 0.083 | 64.71 | 14.85 | 0.000 |
| ### | May 8, 2012 | 10:31:31 AM | 14.85 | 3.999 | 4.2098 | 3.713 | 59.385 | 0.082 | 64.59 | 14.900 | 3.9990 | 59.585 | 0.083 | 64.80 | 14.85 | 0.002 |
| ### | May 8, 2012 | 10:31:36 AM | 14.85 | 3.999 | 4.2153 | 3.713 | 59.385 | 0.082 | 64.67 | 14.900 | 3.9990 | 59.585 | 0.083 | 64.88 | 14.85 | 0.003 |
| ### | May 8, 2012 | 10:31:41 AM | 14.85 | 3.999 | 4.2208 | 3.713 | 59.385 | 0.082 | 64.75 | 14.900 | 3.9990 | 59.585 | 0.083 | 64.96 | 14.85 | 0.004 |
| ### | May 8, 2012 | 10:31:46 AM | 14.85 | 3.999 | 4.2264 | 3.713 | 59.385 | 0.082 | 64.83 | 14.900 | 3.9990 | 59.585 | 0.083 | 65.05 | 14.85 | 0.005 |
| ### | May 8, 2012 | 10:31:51 AM | 14.84 | 3.999 | 4.2319 | 3.710 | 59.345 | 0.082 | 64.92 | 14.890 | 3.9990 | 59.545 | 0.083 | 65.13 | 14.84 | −0.005 |
| ### | May 8, 2012 | 10:31:56 AM | 14.84 | 3.999 | 4.2375 | 3.710 | 59.345 | 0.082 | 65.00 | 14.890 | 3.9990 | 59.545 | 0.083 | 65.21 | 14.84 | −0.004 |
| ### | May 8, 2012 | 10:32:01 AM | 14.84 | 3.999 | 4.2430 | 3.710 | 59.345 | 0.082 | 65.08 | 14.890 | 3.9990 | 59.545 | 0.083 | 65.29 | 14.84 | −0.003 |
| ### | May 8, 2012 | 10:32:06 AM | 14.84 | 3.999 | 4.2486 | 3.710 | 59.345 | 0.082 | 65.16 | 14.890 | 3.9990 | 59.545 | 0.083 | 65.38 | 14.84 | −0.002 |
| ### | May 8, 2012 | 10:32:11 AM | 14.84 | 3.999 | 4.2541 | 3.710 | 59.345 | 0.082 | 65.25 | 14.890 | 3.9990 | 59.545 | 0.083 | 65.46 | 14.84 | 0.000 |
| ### | May 8, 2012 | 10:32:16 AM | 14.84 | 3.999 | 4.2596 | 3.710 | 59.345 | 0.082 | 65.33 | 14.890 | 3.9990 | 59.545 | 0.083 | 65.54 | 14.84 | 0.002 |
| ### | May 8, 2012 | 10:32:21 AM | 14.84 | 3.999 | 4.2652 | 3.710 | 59.345 | 0.082 | 65.41 | 14.890 | 3.9990 | 59.545 | 0.083 | 65.62 | 14.84 | 0.003 |
| ### | May 8, 2012 | 10:32:26 AM | 14.84 | 3.999 | 4.2707 | 3.710 | 59.345 | 0.082 | 65.49 | 14.890 | 3.9990 | 59.545 | 0.083 | 65.71 | 14.84 | 0.004 |
| ### | May 8, 2012 | 10:32:31 AM | 14.84 | 3.999 | 4.2763 | 3.710 | 59.345 | 0.082 | 65.58 | 14.890 | 3.9990 | 59.545 | 0.083 | 65.79 | 14.84 | 0.005 |
| ### | May 8, 2012 | 10:32:36 AM | 14.83 | 3.999 | 4.2818 | 3.708 | 59.305 | 0.082 | 65.66 | 14.880 | 3.9990 | 59.505 | 0.083 | 65.87 | 14.83 | −0.005 |
| ### | May 8, 2012 | 10:32:41 AM | 14.83 | 3.999 | 4.2874 | 3.708 | 59.305 | 0.082 | 65.74 | 14.880 | 3.9990 | 59.505 | 0.083 | 65.95 | 14.83 | −0.004 |
| ### | May 8, 2012 | 10:32:46 AM | 14.83 | 3.999 | 4.2929 | 3.708 | 59.305 | 0.082 | 65.82 | 14.880 | 3.9990 | 59.505 | 0.083 | 66.04 | 14.83 | −0.003 |
| ### | May 8, 2012 | 10:32:51 AM | 14.83 | 3.999 | 4.2985 | 3.708 | 59.305 | 0.082 | 65.90 | 14.880 | 3.9990 | 59.505 | 0.083 | 66.12 | 14.83 | −0.002 |
| ### | May 8, 2012 | 10:32:56 AM | 14.83 | 3.999 | 4.3040 | 3.708 | 59.305 | 0.082 | 65.99 | 14.880 | 3.9990 | 59.505 | 0.083 | 66.20 | 14.83 | −0.001 |
| ### | May 8, 2012 | 10:33:01 AM | 14.83 | 3.999 | 4.3095 | 3.708 | 59.305 | 0.082 | 66.07 | 14.880 | 3.9990 | 59.505 | 0.083 | 66.29 | 14.83 | 0.001 |
| ### | May 8, 2012 | 10:33:06 AM | 14.83 | 3.999 | 4.3151 | 3.708 | 59.305 | 0.082 | 66.15 | 14.880 | 3.9990 | 59.505 | 0.083 | 66.37 | 14.83 | 0.002 |
| ### | May 8, 2012 | 10:33:11 AM | 14.83 | 3.999 | 4.3207 | 3.708 | 59.305 | 0.082 | 66.23 | 14.880 | 3.9990 | 59.505 | 0.083 | 66.45 | 14.83 | 0.003 |
| ### | May 8, 2012 | 10:33:16 AM | 14.83 | 3.999 | 4.3262 | 3.708 | 59.305 | 0.082 | 66.32 | 14.880 | 3.9990 | 59.505 | 0.083 | 66.53 | 14.83 | 0.004 |
| ### | May 8, 2012 | 10:33:21 AM | 14.83 | 3.999 | 4.3317 | 3.708 | 59.305 | 0.082 | 66.40 | 14.880 | 3.9990 | 59.505 | 0.083 | 66.62 | 14.83 | 0.005 |
| ### | May 8, 2012 | 10:33:26 AM | 14.82 | 3.999 | 4.3373 | 3.705 | 59.265 | 0.082 | 66.48 | 14.870 | 3.9990 | 59.465 | 0.083 | 66.70 | 14.82 | −0.005 |
| ### | May 8, 2012 | 10:33:31 AM | 14.82 | 3.999 | 4.3428 | 3.705 | 59.265 | 0.082 | 66.56 | 14.870 | 3.9990 | 59.465 | 0.083 | 66.78 | 14.82 | 0.004 |
| ### | May 8, 2012 | 10:33:36 AM | 14.82 | 3.999 | 4.3484 | 3.705 | 59.265 | 0.082 | 66.65 | 14.870 | 3.9990 | 59.465 | 0.083 | 66.86 | 14.82 | −0.002 |
| ### | May 8, 2012 | 10:33:41 AM | 14.82 | 3.999 | 4.3539 | 3.705 | 59.265 | 0.082 | 66.73 | 14.870 | 3.9990 | 59.465 | 0.083 | 66.95 | 14.82 | 0.000 |
| ### | May 8, 2012 | 10:33:46 AM | 14.82 | 3.999 | 4.3595 | 3.705 | 59.265 | 0.082 | 66.81 | 14.870 | 3.9990 | 59.465 | 0.083 | 67.03 | 14.82 | 0.002 |
| ### | May 8, 2012 | 10:33:51 AM | 14.82 | 3.999 | 4.3650 | 3.705 | 59.265 | 0.082 | 66.89 | 14.870 | 3.9990 | 59.465 | 0.083 | 67.11 | 14.82 | 0.004 |
| ### | May 8, 2012 | 10:33:56 AM | 14.82 | 3.999 | 4.3705 | 3.705 | 59.265 | 0.082 | 66.98 | 14.870 | 3.9990 | 59.465 | 0.083 | 67.19 | 14.82 | 0.005 |
| ### | May 8, 2012 | 10:34:01 AM | 14.81 | 3.999 | 4.3761 | 3.703 | 59.225 | 0.082 | 67.06 | 14.860 | 3.9990 | 59.425 | 0.083 | 67.28 | 14.81 | −0.005 |
| ### | May 8, 2012 | 10:34:06 AM | 14.81 | 3.999 | 4.3817 | 3.703 | 59.225 | 0.082 | 67.14 | 14.860 | 3.9990 | 59.425 | 0.083 | 67.36 | 14.81 | −0.004 |
| ### | May 8, 2012 | 10:34:11 AM | 14.81 | 3.999 | 4.3872 | 3.703 | 59.225 | 0.082 | 67.22 | 14.860 | 3.9990 | 59.425 | 0.083 | 67.44 | 14.81 | −0.003 |
| ### | May 8, 2012 | 10:34:16 AM | 14.81 | 3.999 | 4.3927 | 3.703 | 59.225 | 0.082 | 67.30 | 14.860 | 3.9990 | 59.425 | 0.083 | 67.52 | 14.81 | −0.002 |
| ### | May 8, 2012 | 10:34:21 AM | 14.81 | 3.999 | 4.3983 | 3.703 | 59.225 | 0.082 | 67.39 | 14.860 | 3.9990 | 59.425 | 0.083 | 67.61 | 14.81 | −0.001 |
| ### | May 8, 2012 | 10:34:26 AM | 14.81 | 3.999 | 4.4038 | 3.703 | 59.225 | 0.082 | 67.47 | 14.860 | 3.9990 | 59.425 | 0.083 | 67.69 | 14.81 | 0.001 |
| ### | May 8, 2012 | 10:34:31 AM | 14.81 | 3.999 | 4.4094 | 3.703 | 59.225 | 0.082 | 67.55 | 14.860 | 3.9990 | 59.425 | 0.083 | 67.77 | 14.81 | 0.002 |
| ### | May 8, 2012 | 10:34:36 AM | 14.81 | 3.999 | 4.4149 | 3.703 | 59.225 | 0.082 | 67.63 | 14.860 | 3.9990 | 59.425 | 0.083 | 67.85 | 14.81 | 0.003 |
| ### | May 8, 2012 | 10:34:41 AM | 14.81 | 3.999 | 4.4205 | 3.703 | 59.225 | 0.082 | 67.72 | 14.860 | 3.9990 | 59.425 | 0.083 | 67.94 | 14.81 | 0.004 |
| ### | May 8, 2012 | 10:34:46 AM | 14.81 | 3.999 | 4.4260 | 3.703 | 59.225 | 0.082 | 67.80 | 14.860 | 3.9990 | 59.425 | 0.083 | 68.02 | 14.81 | 0.005 |
| ### | May 8, 2012 | 10:34:51 AM | 14.80 | 3.999 | 4.4315 | 3.700 | 59.185 | 0.082 | 67.88 | 14.850 | 3.9990 | 59.385 | 0.082 | 68.10 | 14.80 | −0.005 |
| ### | May 8, 2012 | 10:34:56 AM | 14.80 | 3.999 | 4.4371 | 3.700 | 59.185 | 0.082 | 67.96 | 14.850 | 3.9990 | 59.385 | 0.082 | 68.18 | 14.80 | −0.004 |
| ### | May 8, 2012 | 10:35:01 AM | 14.80 | 3.999 | 4.4427 | 3.700 | 59.185 | 0.082 | 68.04 | 14.850 | 3.9990 | 59.385 | 0.082 | 68.27 | 14.80 | −0.003 |
| ### | May 8, 2012 | 10:35:06 AM | 14.80 | 3.999 | 4.4482 | 3.700 | 59.185 | 0.082 | 68.13 | 14.850 | 3.9990 | 59.385 | 0.082 | 68.35 | 14.80 | −0.001 |
| ### | May 8, 2012 | 10:35:11 AM | 14.80 | 4.000 | 4.4537 | 3.700 | 59.185 | 0.082 | 68.21 | 14.850 | 4.0000 | 59.385 | 0.082 | 68.43 | 14.80 | 0.001 |
| ### | May 8, 2012 | 10:35:16 AM | 14.80 | 3.999 | 4.4593 | 3.700 | 59.185 | 0.082 | 68.29 | 14.850 | 3.9990 | 59.385 | 0.082 | 68.51 | 14.80 | 0.003 |
| ### | May 8, 2012 | 10:35:21 AM | 14.80 | 3.999 | 4.4646 | 3.700 | 59.185 | 0.082 | 68.37 | 14.850 | 3.9990 | 59.385 | 0.082 | 68.60 | 14.80 | 0.004 |
| ### | May 8, 2012 | 10:35:26 AM | 14.80 | 3.999 | 4.4702 | 3.700 | 59.185 | 0.082 | 68.46 | 14.850 | 3.9990 | 59.385 | 0.082 | 68.68 | 14.80 | 0.005 |
| ### | May 8, 2012 | 10:35:31 AM | 14.79 | 3.999 | 4.4757 | 3.698 | 59.145 | 0.082 | 68.54 | 14.840 | 3.9990 | 59.345 | 0.082 | 68.76 | 14.79 | −0.005 |
| ### | May 8, 2012 | 10:35:26 AM | 14.79 | 3.999 | 4.4813 | 3.698 | 59.145 | 0.082 | 68.62 | 14.840 | 3.9990 | 59.345 | 0.082 | 68.84 | 14.79 | −0.004 |
| ### | May 8, 2012 | 10:35:41 AM | 14.79 | 3.999 | 4.4870 | 3.698 | 59.145 | 0.082 | 68.70 | 14.840 | 3.9990 | 59.345 | 0.082 | 68.93 | 14.79 | −0.003 |
| ### | May 8, 2012 | 10:35:46 AM | 14.79 | 3.999 | 4.4925 | 3.698 | 59.145 | 0.082 | 68.78 | 14.840 | 3.9990 | 59.345 | 0.082 | 69.01 | 14.79 | −0.002 |
| ### | May 8, 2012 | 10:35:51 AM | 14.79 | 3.999 | 4.4981 | 3.698 | 59.145 | 0.082 | 68.87 | 14.840 | 3.9990 | 59.345 | 0.082 | 69.09 | 14.79 | −0.001 |
| ### | May 8, 2012 | 10:35:56 AM | 14.79 | 3.999 | 4.5036 | 3.698 | 59.145 | 0.082 | 68.95 | 14.840 | 3.9990 | 59.345 | 0.082 | 69.17 | 14.79 | 0.001 |
| ### | May 8, 2012 | 10:36:01 AM | 14.79 | 3.999 | 4.5092 | 3.698 | 59.145 | 0.082 | 69.03 | 14.840 | 3.9990 | 59.345 | 0.082 | 69.26 | 14.79 | 0.002 |
| ### | May 8, 2012 | 10:36:06 AM | 14.79 | 3.999 | 4.5148 | 3.698 | 59.145 | 0.082 | 69.11 | 14.840 | 3.9990 | 59.345 | 0.082 | 69.34 | 14.79 | 0.003 |
| ### | May 8, 2012 | 10:36:11 AM | 14.79 | 3.999 | 4.5203 | 3.698 | 59.145 | 0.082 | 69.19 | 14.840 | 3.9990 | 59.345 | 0.082 | 69.42 | 14.79 | 0.004 |
| ### | May 8, 2012 | 10:36:16 AM | 14.79 | 3.999 | 4.5258 | 3.698 | 59.145 | 0.082 | 69.28 | 14.840 | 3.9990 | 59.345 | 0.082 | 69.50 | 14.79 | 0.005 |
| ### | May 8, 2012 | 10:36:21 AM | 14.78 | 3.999 | 4.5314 | 3.695 | 59.105 | 0.082 | 69.36 | 14.830 | 3.9990 | 59.305 | 0.082 | 69.59 | 14.78 | −0.005 |
| ### | May 8, 2012 | 10:36:26 AM | 14.78 | 3.999 | 4.5369 | 3.695 | 59.105 | 0.082 | 69.44 | 14.830 | 3.9990 | 59.305 | 0.082 | 69.67 | 14.78 | −0.004 |
| ### | May 8, 2012 | 10:36:31 AM | 14.78 | 3.999 | 4.5424 | 3.695 | 59.105 | 0.082 | 69.52 | 14.830 | 3.9990 | 59.305 | 0.082 | 69.75 | 14.78 | −0.003 |
| ### | May 8, 2012 | 10:36:36 AM | 14.78 | 3.999 | 4.5480 | 3.695 | 59.105 | 0.082 | 69.61 | 14.830 | 3.9990 | 59.305 | 0.082 | 69.83 | 14.78 | −0.001 |
| ### | May 8, 2012 | 10:36:41 AM | 14.78 | 3.999 | 4.5536 | 3.695 | 59.105 | 0.082 | 69.69 | 14.830 | 3.9990 | 59.305 | 0.082 | 69.92 | 14.78 | 0.001 |
| ### | May 8, 2012 | 10:36:46 AM | 14.78 | 3.999 | 4.5589 | 3.695 | 59.105 | 0.082 | 69.77 | 14.830 | 3.9990 | 59.305 | 0.082 | 70.00 | 14.78 | 0.003 |
| ### | May 8, 2012 | 10:36:51 AM | 14.78 | 3.999 | 4.5644 | 3.695 | 59.105 | 0.082 | 69.85 | 14.830 | 3.9990 | 59.305 | 0.082 | 70.08 | 14.78 | 0.004 |
| ### | May 8, 2012 | 10:36:56 AM | 14.78 | 3.999 | 4.5700 | 3.695 | 59.105 | 0.082 | 69.93 | 14.830 | 3.9990 | 59.305 | 0.082 | 70.16 | 14.78 | 0.005 |
| ### | May 8, 2012 | 10:37:01 AM | 14.77 | 3.999 | 4.5756 | 3.693 | 59.065 | 0.082 | 70.02 | 14.820 | 3.9990 | 59.265 | 0.082 | 70.24 | 14.77 | −0.005 |
| ### | May 8, 2012 | 10:37:06 AM | 14.77 | 3.999 | 4.5811 | 3.693 | 59.065 | 0.082 | 70.10 | 14.820 | 3.9990 | 59.265 | 0.082 | 70.33 | 14.77 | −0.004 |
| ### | May 8, 2012 | 10:37:11 AM | 14.77 | 3.999 | 4.5868 | 3.693 | 59.065 | 0.082 | 70.18 | 14.820 | 3.9990 | 59.265 | 0.082 | 70.41 | 14.77 | −0.002 |
| ### | May 8, 2012 | 10:37:16 AM | 14.77 | 3.999 | 4.5923 | 3.693 | 59.065 | 0.082 | 70.26 | 14.820 | 3.9990 | 59.265 | 0.082 | 70.49 | 14.77 | 0.000 |
| ### | May 8, 2012 | 10:37:21 AM | 14.77 | 3.999 | 4.5979 | 3.693 | 59.065 | 0.082 | 70.34 | 14.820 | 3.9990 | 59.265 | 0.082 | 70.57 | 14.77 | 0.002 |
| ### | May 8, 2012 | 10:37:26 AM | 14.77 | 3.999 | 4.6034 | 3.693 | 59.065 | 0.082 | 70.43 | 14.820 | 3.9990 | 59.265 | 0.082 | 70.66 | 14.77 | 0.004 |
| ### | May 8, 2012 | 10:37:31 AM | 14.77 | 3.999 | 4.6090 | 3.693 | 59.065 | 0.082 | 70.51 | 14.820 | 3.9990 | 59.265 | 0.082 | 70.74 | 14.77 | 0.005 |
| ### | May 8, 2012 | 10:37:36 AM | 14.76 | 3.999 | 4.6145 | 3.690 | 59.025 | 0.082 | 70.59 | 14.810 | 3.9990 | 59.225 | 0.082 | 70.82 | 14.76 | −0.005 |
| ### | May 8, 2012 | 10:37:41 AM | 14.76 | 3.999 | 4.6201 | 3.690 | 59.025 | 0.082 | 70.67 | 14.810 | 3.9990 | 59.225 | 0.082 | 70.90 | 14.76 | −0.004 |
| ### | May 8, 2012 | 10:37:46 AM | 14.76 | 3.999 | 4.6256 | 3.690 | 59.025 | 0.082 | 70.75 | 14.810 | 3.9990 | 59.225 | 0.082 | 70.99 | 14.76 | −0.003 |
| ### | May 8, 2012 | 10:37:51 AM | 14.76 | 3.999 | 4.6312 | 3.690 | 59.025 | 0.082 | 70.84 | 14.810 | 3.9990 | 59.225 | 0.082 | 71.07 | 14.76 | −0.002 |
| ### | May 8, 2012 | 10:37:56 AM | 14.76 | 3.999 | 4.6367 | 3.690 | 59.025 | 0.082 | 70.92 | 14.810 | 3.9990 | 59.225 | 0.082 | 71.15 | 14.76 | −0.001 |
| ### | May 8, 2012 | 10:38:01 AM | 14.76 | 3.999 | 4.6422 | 3.690 | 59.025 | 0.082 | 71.00 | 14.810 | 3.9990 | 59.225 | 0.082 | 71.23 | 14.76 | 0.001 |
| ### | May 8, 2012 | 10:38:06 AM | 14.76 | 3.999 | 4.6478 | 3.690 | 59.025 | 0.082 | 71.08 | 14.810 | 3.9990 | 59.225 | 0.082 | 71.31 | 14.76 | 0.002 |
| ### | May 8, 2012 | 10:38:11 AM | 14.76 | 3.999 | 4.6533 | 3.690 | 59.025 | 0.082 | 71.16 | 14.810 | 3.9990 | 59.225 | 0.082 | 71.40 | 14.76 | 0.003 |
| ### | May 8, 2012 | 10:38:16 AM | 14.76 | 3.999 | 4.6589 | 3.690 | 59.025 | 0.082 | 71.25 | 14.810 | 3.9990 | 59.225 | 0.082 | 71.48 | 14.76 | 0.004 |
| ### | May 8, 2012 | 10:38:21 AM | 14.76 | 3.999 | 4.6644 | 3.690 | 59.025 | 0.082 | 71.33 | 14.810 | 3.9990 | 59.225 | 0.082 | 71.56 | 14.76 | 0.005 |
| ### | May 8, 2012 | 10:38:26 AM | 14.75 | 3.999 | 4.6700 | 3.688 | 58.985 | 0.082 | 71.41 | 14.800 | 3.9990 | 59.185 | 0.082 | 71.64 | 14.75 | −0.005 |
| ### | May 8, 2012 | 10:38:31 AM | 14.75 | 3.999 | 4.6755 | 3.688 | 58.985 | 0.082 | 71.49 | 14.800 | 3.9990 | 59.185 | 0.082 | 71.73 | 14.75 | −0.004 |
| ### | May 8, 2012 | 10:38:36 AM | 14.75 | 3.999 | 4.6811 | 3.688 | 58.985 | 0.082 | 71.57 | 14.800 | 3.9990 | 59.185 | 0.082 | 71.81 | 14.75 | −0.003 |
| ### | May 8, 2012 | 10:38:41 AM | 14.75 | 3.999 | 4.6866 | 3.688 | 58.985 | 0.082 | 71.66 | 14.800 | 3.9990 | 59.185 | 0.082 | 71.89 | 14.75 | −0.002 |
| ### | May 8, 2012 | 10:38:46 AM | 14.75 | 3.999 | 4.6920 | 3.688 | 58.985 | 0.082 | 71.74 | 14.800 | 3.9990 | 59.185 | 0.082 | 71.97 | 14.75 | 0.000 |
| ### | May 8, 2012 | 10:38:51 AM | 14.75 | 3.999 | 4.6975 | 3.688 | 58.985 | 0.082 | 71.82 | 14.800 | 3.9990 | 59.185 | 0.082 | 72.05 | 14.75 | 0.002 |
| ### | May 8, 2012 | 10:38:56 AM | 14.75 | 3.999 | 4.7031 | 3.688 | 58.985 | 0.082 | 71.90 | 14.800 | 3.9990 | 59.185 | 0.082 | 72.14 | 14.75 | 0.003 |
| ### | May 8, 2012 | 10:39:01 AM | 14.75 | 3.999 | 4.7088 | 3.688 | 58.985 | 0.082 | 71.98 | 14.800 | 3.9990 | 59.185 | 0.082 | 72.22 | 14.75 | 0.004 |
| ### | May 8, 2012 | 10:39:06 AM | 14.75 | 3.999 | 4.7144 | 3.688 | 58.985 | 0.082 | 72.06 | 14.800 | 3.9990 | 59.185 | 0.082 | 72.30 | 14.75 | 0.005 |
| ### | May 8, 2012 | 10:39:11 AM | 14.74 | 3.999 | 4.7199 | 3.685 | 58.945 | 0.082 | 72.15 | 14.790 | 3.9990 | 59.145 | 0.082 | 72.38 | 14.74 | −0.005 |
| ### | May 8, 2012 | 10:39:16 AM | 14.74 | 3.999 | 4.7254 | 3.685 | 58.945 | 0.082 | 72.23 | 14.790 | 3.9990 | 59.145 | 0.082 | 72.47 | 14.74 | −0.004 |
| ### | May 8, 2012 | 10:39:21 AM | 14.74 | 3.999 | 4.7310 | 3.685 | 58.945 | 0.082 | 72.31 | 14.790 | 3.9990 | 59.145 | 0.082 | 72.55 | 14.74 | −0.003 |
| ### | May 8, 2012 | 10:39:26 AM | 14.74 | 3.999 | 4.7365 | 3.685 | 58.945 | 0.082 | 72.39 | 14.790 | 3.9990 | 59.145 | 0.082 | 72.63 | 14.74 | −0.002 |
| ### | May 8, 2012 | 10:39:31 AM | 14.74 | 3.999 | 4.7421 | 3.685 | 58.945 | 0.082 | 72.47 | 14.790 | 3.9990 | 59.145 | 0.082 | 72.71 | 14.74 | −0.001 |
| ### | May 8, 2012 | 10:39:36 AM | 14.74 | 3.999 | 4.7476 | 3.685 | 58.945 | 0.082 | 72.56 | 14.790 | 3.9990 | 59.145 | 0.082 | 72.79 | 14.74 | 0.001 |
| ### | May 8, 2012 | 10:39:41 AM | 14.74 | 3.999 | 4.7531 | 3.685 | 58.945 | 0.082 | 72.64 | 14.790 | 3.9990 | 59.145 | 0.082 | 72.88 | 14.74 | 0.002 |
| ### | May 8, 2012 | 10:39:46 AM | 14.74 | 3.999 | 4.7587 | 3.685 | 58.945 | 0.082 | 72.72 | 14.790 | 3.9990 | 59.145 | 0.082 | 72.96 | 14.74 | 0.003 |
| ### | May 8, 2012 | 10:39:51 AM | 14.74 | 3.999 | 4.7642 | 3.685 | 58.945 | 0.082 | 72.80 | 14.790 | 3.9990 | 59.145 | 0.082 | 73.04 | 14.74 | 0.004 |
| ### | May 8, 2012 | 10:39:56 AM | 14.74 | 3.999 | 4.7698 | 3.685 | 58.945 | 0.082 | 72.88 | 14.790 | 3.9990 | 59.145 | 0.082 | 73.12 | 14.74 | 0.005 |
| ### | May 8, 2012 | 10:40:01 AM | 14.73 | 3.999 | 4.7753 | 3.683 | 58.905 | 0.082 | 72.97 | 14.780 | 3.9990 | 59.105 | 0.082 | 73.20 | 14.73 | −0.005 |
| ### | May 8, 2012 | 10:40:06 AM | 14.73 | 3.999 | 4.7809 | 3.683 | 58.905 | 0.082 | 73.05 | 14.780 | 3.9990 | 59.105 | 0.082 | 73.29 | 14.73 | −0.004 |
| ### | May 8, 2012 | 10:40:11 AM | 14.73 | 3.999 | 4.7864 | 3.683 | 58.905 | 0.082 | 73.13 | 14.780 | 3.9990 | 59.105 | 0.082 | 73.37 | 14.73 | −0.003 |
| ### | May 8, 2012 | 10:40:16 AM | 14.73 | 3.999 | 4.7919 | 3.683 | 58.905 | 0.082 | 73.21 | 14.780 | 3.9990 | 59.105 | 0.082 | 73.45 | 14.73 | −0.002 |
| ### | May 8, 2012 | 10:40:21 AM | 14.73 | 3.999 | 4.7975 | 3.683 | 58.905 | 0.082 | 73.29 | 14.780 | 3.9990 | 59.105 | 0.082 | 73.53 | 14.73 | 0.000 |
| ### | May 8, 2012 | 10:40:26 AM | 14.73 | 3.999 | 4.8030 | 3.683 | 58.905 | 0.082 | 73.37 | 14.780 | 3.9990 | 59.105 | 0.082 | 73.62 | 14.73 | 0.002 |
| ### | May 8, 2012 | 10:40:31 AM | 14.73 | 3.999 | 4.8086 | 3.683 | 58.905 | 0.082 | 73.46 | 14.780 | 3.9990 | 59.105 | 0.082 | 73.70 | 14.73 | 0.003 |
| ### | May 8, 2012 | 10:40:36 AM | 14.73 | 3.999 | 4.8141 | 3.683 | 58.905 | 0.082 | 73.54 | 14.780 | 3.9990 | 59.105 | 0.082 | 73.78 | 14.73 | 0.004 |
| ### | May 8, 2012 | 10:40:41 AM | 14.73 | 3.999 | 4.8197 | 3.683 | 58.905 | 0.082 | 73.62 | 14.780 | 3.9990 | 59.105 | 0.082 | 73.86 | 14.73 | 0.005 |
| ### | May 8, 2012 | 10:40:46 AM | 14.72 | 3.999 | 4.8252 | 3.680 | 58.865 | 0.082 | 73.70 | 14.770 | 3.9990 | 59.065 | 0.082 | 73.94 | 14.72 | −0.005 |
| ### | May 8, 2012 | 10:40:51 AM | 14.72 | 3.999 | 4.8308 | 3.680 | 58.865 | 0.082 | 73.78 | 14.770 | 3.9990 | 59.065 | 0.082 | 74.03 | 14.72 | −0.004 |
| ### | May 8, 2012 | 10:40:56 AM | 14.72 | 3.999 | 4.8363 | 3.680 | 58.865 | 0.082 | 73.87 | 14.770 | 3.9990 | 59.065 | 0.082 | 74.11 | 14.72 | −0.002 |
| ### | May 8, 2012 | 10:41:01 AM | 14.72 | 3.999 | 4.8419 | 3.680 | 58.865 | 0.082 | 73.95 | 14.770 | 3.9990 | 59.065 | 0.082 | 74.19 | 14.72 | 0.000 |
| ### | May 8, 2012 | 10:41:06 AM | 14.72 | 3.999 | 4.8474 | 3.680 | 58.865 | 0.082 | 74.03 | 14.770 | 3.9990 | 59.065 | 0.082 | 74.27 | 14.72 | 0.002 |
| ### | May 8, 2012 | 10:41:11 AM | 14.72 | 3.999 | 4.8529 | 3.680 | 58.865 | 0.082 | 74.11 | 14.770 | 3.9990 | 59.065 | 0.082 | 74.35 | 14.72 | 0.004 |
| ### | May 8, 2012 | 10:41:16 AM | 14.72 | 3.999 | 4.8588 | 3.680 | 58.865 | 0.082 | 74.19 | 14.770 | 3.9990 | 59.065 | 0.082 | 74.44 | 14.72 | 0.005 |
| ### | May 8, 2012 | 10:41:21 AM | 14.71 | 3.999 | 4.8639 | 3.678 | 58.825 | 0.082 | 74.27 | 14.760 | 3.9990 | 59.025 | 0.082 | 74.52 | 14.71 | −0.005 |
| ### | May 8, 2012 | 10:41:26 AM | 14.71 | 3.999 | 4.8694 | 3.678 | 58.825 | 0.082 | 74.36 | 14.760 | 3.9990 | 59.025 | 0.082 | 74.60 | 14.71 | −0.004 |
| ### | May 8, 2012 | 10:41:31 AM | 14.71 | 4.000 | 4.8750 | 3.678 | 58.825 | 0.082 | 74.44 | 14.760 | 4.0000 | 59.025 | 0.082 | 74.68 | 14.71 | −0.003 |
| ### | May 8, 2012 | 10:41:26 AM | 14.71 | 3.999 | 4.8805 | 3.678 | 58.825 | 0.082 | 74.52 | 14.760 | 3.9990 | 59.025 | 0.082 | 74.76 | 14.71 | −0.001 |
| ### | May 8, 2012 | 10:41:41 AM | 14.71 | 3.999 | 4.8862 | 3.678 | 58.825 | 0.082 | 74.60 | 14.760 | 3.9990 | 59.025 | 0.082 | 74.85 | 14.71 | 0.001 |
| ### | May 8, 2012 | 10:41:46 AM | 14.71 | 3.999 | 4.8918 | 3.678 | 58.825 | 0.082 | 74.68 | 14.760 | 3.9990 | 59.025 | 0.082 | 74.93 | 14.71 | 0.003 |
| ### | May 8, 2012 | 10:41:51 AM | 14.71 | 3.999 | 4.8973 | 3.678 | 58.825 | 0.082 | 74.76 | 14.760 | 3.9990 | 59.025 | 0.082 | 75.01 | 14.71 | 0.004 |
| ### | May 8, 2012 | 10:41:56 AM | 14.71 | 3.999 | 4.9029 | 3.678 | 58.825 | 0.082 | 74.85 | 14.760 | 3.9990 | 59.025 | 0.082 | 75.09 | 14.71 | 0.005 |
| ### | May 8, 2012 | 10:42:01 AM | 14.70 | 3.999 | 4.9085 | 3.675 | 58.785 | 0.082 | 74.93 | 14.750 | 3.9990 | 58.985 | 0.082 | 75.17 | 14.70 | −0.005 |
| ### | May 8, 2012 | 10:42:06 AM | 14.70 | 3.999 | 4.9140 | 3.675 | 58.785 | 0.082 | 75.01 | 14.750 | 3.9990 | 58.985 | 0.082 | 75.26 | 14.70 | −0.004 |
| ### | May 8, 2012 | 10:42:11 AM | 14.70 | 3.999 | 4.9195 | 3.675 | 58.785 | 0.082 | 75.09 | 14.750 | 3.9990 | 58.985 | 0.082 | 75.34 | 14.70 | −0.003 |
| ### | May 8, 2012 | 10:42:16 AM | 14.70 | 3.999 | 4.9251 | 3.675 | 58.785 | 0.082 | 75.17 | 14.750 | 3.9990 | 58.985 | 0.082 | 75.42 | 14.70 | −0.002 |
| ### | May 8, 2012 | 10:42:21 AM | 14.70 | 3.999 | 4.9306 | 3.675 | 58.785 | 0.082 | 75.25 | 14.750 | 3.9990 | 58.985 | 0.082 | 75.50 | 14.70 | −0.001 |
| ### | May 8, 2012 | 10:42:26 AM | 14.70 | 3.999 | 4.9361 | 3.675 | 58.785 | 0.082 | 75.34 | 14.750 | 3.9990 | 58.985 | 0.082 | 75.58 | 14.70 | 0.001 |
| ### | May 8, 2012 | 10:42:31 AM | 14.70 | 3.999 | 4.9417 | 3.675 | 58.785 | 0.082 | 75.42 | 14.750 | 3.9990 | 58.985 | 0.082 | 75.66 | 14.70 | 0.002 |
| ### | May 8, 2012 | 10:42:36 AM | 14.70 | 3.999 | 4.9473 | 3.675 | 58.785 | 0.082 | 75.50 | 14.750 | 3.9990 | 58.985 | 0.082 | 75.75 | 14.70 | 0.003 |
| ### | May 8, 2012 | 10:42:41 AM | 14.70 | 3.999 | 4.9528 | 3.675 | 58.785 | 0.082 | 75.58 | 14.750 | 3.9990 | 58.985 | 0.082 | 75.83 | 14.70 | 0.004 |
| ### | May 8, 2012 | 10:42:46 AM | 14.70 | 3.999 | 4.9583 | 3.675 | 58.785 | 0.082 | 75.66 | 14.750 | 3.9990 | 58.985 | 0.082 | 75.91 | 14.70 | 0.005 |
| ### | May 8, 2012 | 10:42:51 AM | 14.69 | 3.999 | 4.9639 | 3.673 | 58.745 | 0.082 | 75.74 | 14.740 | 3.9990 | 58.945 | 0.082 | 75.99 | 14.69 | −0.005 |
| ### | May 8, 2012 | 10:42:56 AM | 14.69 | 3.999 | 4.9694 | 3.673 | 58.745 | 0.082 | 75.83 | 14.740 | 3.9990 | 58.945 | 0.082 | 76.07 | 14.69 | −0.004 |
| ### | May 8, 2012 | 10:43:01 AM | 14.69 | 3.999 | 4.9752 | 3.673 | 58.745 | 0.082 | 75.91 | 14.740 | 3.9990 | 58.945 | 0.082 | 76.16 | 14.69 | −0.003 |
| ### | May 8, 2012 | 10:43:06 AM | 14.69 | 3.999 | 4.9803 | 3.673 | 58.745 | 0.082 | 75.99 | 14.740 | 3.9990 | 58.945 | 0.082 | 76.24 | 14.69 | −0.002 |
| ### | May 8, 2012 | 10:43:11 AM | 14.69 | 3.999 | 4.9859 | 3.673 | 58.745 | 0.082 | 76.07 | 14.740 | 3.9990 | 58.945 | 0.082 | 76.32 | 14.69 | −0.001 |
| ### | May 8, 2012 | 10:43:16 AM | 14.69 | 3.999 | 4.9914 | 3.673 | 58.745 | 0.082 | 76.15 | 14.740 | 3.9990 | 58.945 | 0.082 | 76.40 | 14.69 | 0.001 |
| ### | May 8, 2012 | 10:43:21 AM | 14.69 | 3.999 | 4.9973 | 3.673 | 58.745 | 0.082 | 76.23 | 14.740 | 3.9990 | 58.945 | 0.082 | 76.48 | 14.69 | 0.002 |
| ### | May 8, 2012 | 10:43:26 AM | 14.69 | 3.999 | 5.0025 | 3.673 | 58.745 | 0.082 | 76.32 | 14.740 | 3.9990 | 58.945 | 0.082 | 76.57 | 14.69 | 0.003 |
| ### | May 8, 2012 | 10:43:31 AM | 14.69 | 3.999 | 5.0080 | 3.673 | 58.745 | 0.082 | 76.40 | 14.740 | 3.9990 | 58.945 | 0.082 | 76.65 | 14.69 | 0.004 |
| ### | May 8, 2012 | 10:43:36 AM | 14.69 | 3.999 | 5.0136 | 3.673 | 58.745 | 0.082 | 76.48 | 14.740 | 3.9990 | 58.945 | 0.082 | 76.73 | 14.69 | 0.005 |
| ### | May 8, 2012 | 10:43:41 AM | 14.68 | 3.999 | 5.0191 | 3.670 | 58.705 | 0.082 | 76.56 | 14.730 | 3.9990 | 58.905 | 0.082 | 76.81 | 14.68 | −0.005 |
| ### | May 8, 2012 | 10:43:46 AM | 14.68 | 3.999 | 5.0247 | 3.670 | 58.705 | 0.082 | 76.64 | 14.730 | 3.9990 | 58.905 | 0.082 | 76.89 | 14.68 | −0.004 |
| ### | May 8, 2012 | 10:43:51 AM | 14.68 | 3.999 | 5.0302 | 3.670 | 58.705 | 0.082 | 76.72 | 14.730 | 3.9990 | 58.905 | 0.082 | 76.97 | 14.68 | −0.003 |
| ### | May 8, 2012 | 10:43:56 AM | 14.68 | 3.999 | 5.0359 | 3.670 | 58.705 | 0.082 | 76.80 | 14.730 | 3.9990 | 58.905 | 0.082 | 77.06 | 14.68 | −0.002 |
| ### | May 8, 2012 | 10:44:01 AM | 14.68 | 3.999 | 5.0415 | 3.670 | 58.705 | 0.082 | 76.89 | 14.730 | 3.9990 | 58.905 | 0.082 | 77.14 | 14.68 | −0.001 |
| ### | May 8, 2012 | 10:44:06 AM | 14.68 | 3.999 | 5.0469 | 3.670 | 58.705 | 0.082 | 76.97 | 14.730 | 3.9990 | 58.905 | 0.082 | 77.22 | 14.68 | 0.001 |
| ### | May 8, 2012 | 10:44:11 AM | 14.68 | 3.999 | 5.0524 | 3.670 | 58.705 | 0.082 | 77.05 | 14.730 | 3.9990 | 58.905 | 0.082 | 77.30 | 14.68 | 0.002 |
| ### | May 8, 2012 | 10:44:16 AM | 14.68 | 3.999 | 5.0580 | 3.670 | 58.705 | 0.082 | 77.13 | 14.730 | 3.9990 | 58.905 | 0.082 | 77.38 | 14.68 | 0.003 |
| ### | May 8, 2012 | 10:44:21 AM | 14.68 | 3.999 | 5.0635 | 3.670 | 58.705 | 0.082 | 77.21 | 14.730 | 3.9990 | 58.905 | 0.082 | 77.47 | 14.68 | 0.004 |
| ### | May 8, 2012 | 10:44:26 AM | 14.68 | 3.999 | 5.0690 | 3.670 | 58.705 | 0.082 | 77.29 | 14.730 | 3.9990 | 58.905 | 0.082 | 77.55 | 14.68 | 0.005 |
| ### | May 8, 2012 | 10:44:31 AM | 14.67 | 3.999 | 5.0748 | 3.668 | 58.665 | 0.081 | 77.81 | 14.720 | 3.9990 | 58.865 | 0.082 | 77.63 | 14.67 | −0.005 |
| ### | May 8, 2012 | 10:44:36 AM | 14.67 | 3.999 | 5.0803 | 3.668 | 58.665 | 0.081 | 77.46 | 14.720 | 3.9990 | 58.865 | 0.082 | 77.71 | 14.67 | −0.004 |
| ### | May 8, 2012 | 10:44:41 AM | 14.67 | 3.999 | 5.0858 | 3.668 | 58.665 | 0.081 | 77.54 | 14.720 | 3.9990 | 58.865 | 0.082 | 77.79 | 14.67 | −0.003 |
| ### | May 8, 2012 | 10:44:46 AM | 14.67 | 3.999 | 5.0914 | 3.668 | 58.665 | 0.081 | 77.62 | 14.720 | 3.9990 | 58.865 | 0.082 | 77.87 | 14.67 | −0.002 |
| ### | May 8, 2012 | 10:44:51 AM | 14.67 | 3.999 | 5.0969 | 3.668 | 58.665 | 0.081 | 77.70 | 14.720 | 3.9990 | 58.865 | 0.082 | 77.96 | 14.67 | 0.000 |
| ### | May 8, 2012 | 10:44:56 AM | 14.67 | 3.999 | 5.1025 | 3.668 | 58.665 | 0.081 | 77.78 | 14.720 | 3.9990 | 58.865 | 0.082 | 78.04 | 14.67 | 0.002 |
| ### | May 8, 2012 | 10:45:01 AM | 14.67 | 3.999 | 5.1080 | 3.668 | 58.665 | 0.081 | 77.86 | 14.720 | 3.9990 | 58.865 | 0.082 | 78.12 | 14.67 | 0.003 |
| ### | May 8, 2012 | 10:45:06 AM | 14.67 | 3.999 | 5.1136 | 3.668 | 58.665 | 0.081 | 77.95 | 14.720 | 3.9990 | 58.865 | 0.082 | 78.20 | 14.67 | 0.004 |
| ### | May 8, 2012 | 10:45:11 AM | 14.67 | 3.999 | 5.1191 | 3.668 | 58.665 | 0.081 | 78.03 | 14.720 | 3.9990 | 58.865 | 0.082 | 78.28 | 14.67 | 0.005 |
| ### | May 8, 2012 | 10:45:16 AM | 14.66 | 3.999 | 5.1247 | 3.665 | 58.625 | 0.081 | 78.11 | 14.710 | 3.9990 | 58.825 | 0.082 | 78.36 | 14.66 | −0.005 |
| ### | May 8, 2012 | 10:45:21 AM | 14.66 | 3.999 | 5.1302 | 3.665 | 58.625 | 0.081 | 78.19 | 14.710 | 3.9990 | 58.825 | 0.082 | 78.45 | 14.66 | −0.004 |
| ### | May 8, 2012 | 10:45:26 AM | 14.66 | 3.999 | 5.1358 | 3.665 | 58.625 | 0.081 | 78.27 | 14.710 | 3.9990 | 58.825 | 0.082 | 78.53 | 14.66 | −0.003 |
| ### | May 8, 2012 | 10:45:31 AM | 14.66 | 3.999 | 5.1413 | 3.665 | 58.625 | 0.081 | 78.35 | 14.710 | 3.9990 | 58.825 | 0.082 | 78.61 | 14.66 | −0.001 |
| ### | May 8, 2012 | 10:45:36 AM | 14.66 | 3.999 | 5.1468 | 3.665 | 58.625 | 0.081 | 78.43 | 14.710 | 3.9990 | 58.825 | 0.082 | 78.69 | 14.66 | 0.001 |
| ### | May 8, 2012 | 10:45:41 AM | 14.66 | 3.999 | 5.1524 | 3.665 | 58.625 | 0.081 | 78.52 | 14.710 | 3.9990 | 58.825 | 0.082 | 78.77 | 14.66 | 0.003 |
| ### | May 8, 2012 | 10:45:46 AM | 14.66 | 3.999 | 5.1579 | 3.665 | 58.625 | 0.081 | 78.60 | 14.710 | 3.9990 | 58.825 | 0.082 | 78.86 | 14.66 | 0.004 |
| ### | May 8, 2012 | 10:45:51 AM | 14.66 | 3.999 | 5.1635 | 3.665 | 58.625 | 0.081 | 78.68 | 14.710 | 3.9990 | 58.825 | 0.082 | 78.94 | 14.66 | 0.005 |
| ### | May 8, 2012 | 10:45:56 AM | 14.65 | 3.999 | 5.1690 | 3.663 | 58.585 | 0.081 | 78.76 | 14.700 | 3.9990 | 58.785 | 0.082 | 79.02 | 14.65 | −0.005 |
| ### | May 8, 2012 | 10:46:01 AM | 14.65 | 3.999 | 5.1746 | 3.663 | 58.585 | 0.081 | 78.84 | 14.700 | 3.9990 | 58.785 | 0.082 | 79.10 | 14.65 | −0.004 |
| ### | May 8, 2012 | 10:46:06 AM | 14.65 | 3.999 | 5.1801 | 3.663 | 58.585 | 0.081 | 78.92 | 14.700 | 3.9990 | 58.785 | 0.082 | 79.18 | 14.65 | −0.003 |
| ### | May 8, 2012 | 10:46:11 AM | 14.65 | 3.999 | 5.1857 | 3.663 | 58.585 | 0.081 | 79.00 | 14.700 | 3.9990 | 58.785 | 0.082 | 79.26 | 14.65 | −0.002 |
| ### | May 8, 2012 | 10:46:16 AM | 14.65 | 3.999 | 5.1912 | 3.663 | 58.585 | 0.081 | 79.09 | 14.700 | 3.9990 | 58.785 | 0.082 | 79.35 | 14.65 | −0.001 |
| ### | May 8, 2012 | 10:46:21 AM | 14.65 | 3.999 | 5.1967 | 3.663 | 58.585 | 0.081 | 79.17 | 14.700 | 3.9990 | 58.785 | 0.082 | 79.43 | 14.65 | 0.000 |
| ### | May 8, 2012 | 10:46:26 AM | 14.65 | 3.999 | 5.2023 | 3.663 | 58.585 | 0.081 | 79.25 | 14.700 | 3.9990 | 58.785 | 0.082 | 79.51 | 14.65 | 0.000 |
| ### | May 8, 2012 | 10:46:31 AM | 14.65 | 3.999 | 5.2078 | 3.663 | 58.585 | 0.081 | 79.33 | 14.700 | 3.9990 | 58.785 | 0.082 | 79.59 | 14.65 | 0.000 |
| ### | May 8, 2012 | 10:46:36 AM | 14.65 | 3.999 | 5.2314 | 3.663 | 58.585 | 0.081 | 79.41 | 14.700 | 3.9990 | 58.785 | 0.082 | 79.67 | 14.65 | 0.001 |
| ### | May 8, 2012 | 10:46:41 AM | 14.65 | 3.999 | 5.2188 | 3.663 | 58.585 | 0.081 | 79.49 | 14.700 | 3.9990 | 58.785 | 0.082 | 79.75 | 14.65 | 0.002 |
| ### | May 8, 2012 | 10:46:46 AM | 14.65 | 3.999 | 5.2243 | 3.663 | 58.585 | 0.081 | 79.57 | 14.700 | 3.9990 | 58.785 | 0.082 | 79.83 | 14.65 | 0.003 |
| ### | May 8, 2012 | 10:46:51 AM | 14.65 | 3.999 | 5.2298 | 3.663 | 58.585 | 0.081 | 79.65 | 14.700 | 3.9990 | 58.785 | 0.082 | 79.92 | 14.65 | 0.004 |
| ### | May 8, 2012 | 10:46:56 AM | 14.65 | 3.999 | 5.2354 | 3.663 | 58.585 | 0.081 | 79.74 | 14.700 | 3.9990 | 58.785 | 0.082 | 80.00 | 14.65 | 0.005 |
| ### | May 8, 2012 | 10:47:01 AM | 14.64 | 3.999 | 5.2409 | 3.660 | 58.545 | 0.081 | 79.82 | 14.690 | 3.9990 | 58.745 | 0.082 | 80.08 | 14.64 | −0.005 |
| ### | May 8, 2012 | 10:47:06 AM | 14.64 | 3.999 | 5.2465 | 3.660 | 58.545 | 0.081 | 79.90 | 14.690 | 3.9990 | 58.745 | 0.082 | 80.16 | 14.64 | −0.004 |
| ### | May 8, 2012 | 10:47:11 AM | 14.64 | 3.999 | 5.2520 | 3.660 | 58.545 | 0.081 | 79.98 | 14.690 | 3.9990 | 58.745 | 0.082 | 80.24 | 14.64 | −0.003 |
| ### | May 8, 2012 | 10:47:16 AM | 14.64 | 3.999 | 5.2576 | 3.660 | 58.545 | 0.081 | 80.06 | 14.690 | 3.9990 | 58.745 | 0.082 | 80.32 | 14.64 | −0.001 |
| ### | May 8, 2012 | 10:47:21 AM | 14.64 | 3.999 | 5.2631 | 3.660 | 58.545 | 0.081 | 80.14 | 14.690 | 3.9990 | 58.745 | 0.082 | 80.41 | 14.64 | 0.001 |
| ### | May 8, 2012 | 10:47:26 AM | 14.64 | 3.999 | 5.2686 | 3.660 | 58.545 | 0.081 | 80.22 | 14.690 | 3.9990 | 58.745 | 0.082 | 80.49 | 14.64 | 0.003 |
| ### | May 8, 2012 | 10:47:31 AM | 14.64 | 3.999 | 5.2742 | 3.660 | 58.545 | 0.081 | 80.31 | 14.690 | 3.9990 | 58.745 | 0.082 | 80.57 | 14.64 | 0.004 |
| ### | May 8, 2012 | 10:47:36 AM | 14.64 | 3.999 | 5.2797 | 3.660 | 58.545 | 0.081 | 80.39 | 14.690 | 3.9990 | 58.745 | 0.082 | 80.65 | 14.64 | 0.005 |
| ### | May 8, 2012 | 10:47:41 AM | 14.63 | 3.999 | 5.2853 | 3.658 | 58.505 | 0.081 | 80.47 | 14.680 | 3.9990 | 58.705 | 0.082 | 80.73 | 14.63 | −0.005 |
| ### | May 8, 2012 | 10:47:46 AM | 14.63 | 3.999 | 5.2908 | 3.658 | 58.505 | 0.081 | 80.55 | 14.680 | 3.9990 | 58.705 | 0.082 | 80.81 | 14.63 | −0.004 |
| ### | May 8, 2012 | 10:47:51 AM | 14.63 | 4.000 | 5.2964 | 3.658 | 58.505 | 0.081 | 80.63 | 14.680 | 4.0000 | 58.705 | 0.082 | 80.90 | 14.63 | −0.003 |
| ### | May 8, 2012 | 10:47:56 AM | 14.63 | 3.999 | 5.3019 | 3.658 | 58.505 | 0.081 | 80.71 | 14.680 | 3.9990 | 58.705 | 0.082 | 80.98 | 14.63 | −0.002 |
| ### | May 8, 2012 | 10:48:01 AM | 14.63 | 3.999 | 5.3074 | 3.658 | 58.505 | 0.081 | 80.79 | 14.680 | 3.9990 | 58.705 | 0.082 | 81.06 | 14.63 | −0.001 |
| ### | May 8, 2012 | 10:48:06 AM | 14.63 | 3.999 | 5.3130 | 3.658 | 58.505 | 0.081 | 80.87 | 14.680 | 3.9990 | 58.705 | 0.082 | 81.14 | 14.63 | 0.001 |
| ### | May 8, 2012 | 10:48:11 AM | 14.63 | 3.999 | 5.3185 | 3.658 | 58.505 | 0.081 | 80.96 | 14.680 | 3.9990 | 58.705 | 0.082 | 81.22 | 14.63 | 0.002 |
| ### | May 8, 2012 | 10:48:16 AM | 14.63 | 3.999 | 5.3241 | 3.658 | 58.505 | 0.081 | 81.04 | 14.680 | 3.9990 | 58.705 | 0.082 | 81.30 | 14.63 | 0.003 |
| ### | May 8, 2012 | 10:48:21 AM | 14.63 | 3.999 | 5.3296 | 3.658 | 58.505 | 0.081 | 81.12 | 14.680 | 3.9990 | 58.705 | 0.082 | 81.38 | 14.63 | 0.004 |
| ### | May 8, 2012 | 10:48:26 AM | 14.63 | 3.999 | 5.3352 | 3.658 | 58.505 | 0.081 | 81.20 | 14.680 | 3.9990 | 58.705 | 0.082 | 81.47 | 14.63 | 0.005 |
| ### | May 8, 2012 | 10:48:31 AM | 14.62 | 3.999 | 5.3407 | 3.655 | 58.465 | 0.081 | 81.28 | 14.670 | 3.9990 | 58.665 | 0.081 | 81.55 | 14.62 | −0.005 |
| ### | May 8, 2012 | 10:48:26 AM | 14.62 | 3.999 | 5.3462 | 3.655 | 58.465 | 0.081 | 81.36 | 14.670 | 3.9990 | 58.665 | 0.081 | 81.63 | 14.62 | −0.004 |
| ### | May 8, 2012 | 10:48:41 AM | 14.62 | 3.999 | 5.3518 | 3.655 | 58.465 | 0.081 | 81.44 | 14.670 | 3.9990 | 58.665 | 0.081 | 81.71 | 14.62 | −0.003 |
| ### | May 8, 2012 | 10:48:46 AM | 14.62 | 3.999 | 5.3575 | 3.655 | 58.465 | 0.081 | 81.52 | 14.670 | 3.9990 | 58.665 | 0.081 | 81.79 | 14.62 | −0.002 |
| ### | May 8, 2012 | 10:48:51 AM | 14.62 | 3.999 | 5.3631 | 3.655 | 58.465 | 0.081 | 81.61 | 14.670 | 3.9990 | 58.665 | 0.081 | 81.87 | 14.62 | 0.000 |
| ### | May 8, 2012 | 10:48:56 AM | 14.62 | 3.999 | 5.3686 | 3.655 | 58.465 | 0.081 | 81.69 | 14.670 | 3.9990 | 58.665 | 0.081 | 81.96 | 14.62 | 0.002 |
| ### | May 8, 2012 | 10:49:01 AM | 14.62 | 3.999 | 5.3742 | 3.655 | 58.465 | 0.081 | 81.77 | 14.670 | 3.9990 | 58.665 | 0.081 | 82.04 | 14.62 | 0.003 |
| ### | May 8, 2012 | 10:49:06 AM | 14.62 | 3.999 | 5.3797 | 3.655 | 58.465 | 0.081 | 81.85 | 14.670 | 3.9990 | 58.665 | 0.081 | 82.12 | 14.62 | 0.004 |
| ### | May 8, 2012 | 10:49:11 AM | 14.62 | 3.999 | 5.3852 | 3.655 | 58.465 | 0.081 | 81.93 | 14.670 | 3.9990 | 58.665 | 0.081 | 82.20 | 14.62 | 0.005 |
| ### | May 8, 2012 | 10:49:16 AM | 14.61 | 3.999 | 5.3908 | 3.653 | 58.425 | 0.081 | 82.01 | 14.660 | 3.9990 | 58.625 | 0.081 | 82.28 | 14.61 | −0.005 |
| ### | May 8, 2012 | 10:49:21 AM | 14.61 | 3.999 | 5.3963 | 3.653 | 58.425 | 0.081 | 82.09 | 14.660 | 3.9990 | 58.625 | 0.081 | 82.36 | 14.61 | −0.004 |
| ### | May 8, 2012 | 10:49:26 AM | 14.61 | 3.999 | 5.4019 | 3.653 | 58.425 | 0.081 | 82.17 | 14.660 | 3.9990 | 58.625 | 0.081 | 82.44 | 14.61 | −0.003 |
| ### | May 8, 2012 | 10:49:31 AM | 14.61 | 3.999 | 5.4074 | 3.653 | 58.425 | 0.081 | 82.25 | 14.660 | 3.9990 | 58.625 | 0.081 | 82.53 | 14.61 | −0.002 |
| ### | May 8, 2012 | 10:49:36 AM | 14.61 | 3.999 | 5.4130 | 3.653 | 58.425 | 0.081 | 82.34 | 14.660 | 3.9990 | 58.625 | 0.081 | 82.61 | 14.61 | 0.000 |
| ### | May 8, 2012 | 10:49:41 AM | 14.61 | 3.999 | 5.4185 | 3.653 | 58.425 | 0.081 | 82.42 | 14.660 | 3.9990 | 58.625 | 0.081 | 82.69 | 14.61 | 0.002 |
| ### | May 8, 2012 | 10:49:46 AM | 14.61 | 3.999 | 5.4240 | 3.653 | 58.425 | 0.081 | 82.50 | 14.660 | 3.9990 | 58.625 | 0.081 | 82.77 | 14.61 | 0.003 |
| ### | May 8, 2012 | 10:49:51 AM | 14.61 | 3.999 | 5.4296 | 3.653 | 58.425 | 0.081 | 82.58 | 14.660 | 3.9990 | 58.625 | 0.081 | 82.85 | 14.61 | 0.004 |
| ### | May 8, 2012 | 10:49:56 AM | 14.61 | 3.999 | 5.4351 | 3.653 | 58.425 | 0.081 | 82.66 | 14.660 | 3.9990 | 58.625 | 0.081 | 82.93 | 14.61 | 0.005 |
| ### | May 8, 2012 | 10:50:01 AM | 14.60 | 3.999 | 5.4407 | 3.650 | 58.385 | 0.081 | [symbol] | 14.650 | 3.9990 | 58.585 | 0.081 | 83.01 | 14.60 | −0.005 |
| ### | May 8, 2012 | 10:50:06 AM | 14:60 | 3.999 | 5.4463 | 3.650 | 58.385 | 0.081 | 82.82 | 14.650 | 3.9990 | 58.585 | 0.081 | 83.10 | 14.60 | −0.004 |
| ### | May 8, 2012 | 10:50:11 AM | 14:60 | 3.999 | 5.4518 | 3.650 | 58.385 | 0.081 | 82.90 | 14.650 | 3.9990 | 58.585 | 0.081 | 83.18 | 14.60 | −0.003 |
| ### | May 8, 2012 | 10:50:16 AM | 14:60 | 3.999 | 5.4573 | 3.650 | 58.385 | 0.081 | 82.98 | 14.650 | 3.9990 | 58.585 | 0.081 | 83.26 | 14.60 | −0.002 |
| ### | May 8, 2012 | 10:50:21 AM | 14:60 | 3.999 | 5.4629 | 3.650 | 58.385 | 0.081 | 83.07 | 14.650 | 3.9990 | 58.585 | 0.081 | 83.34 | 14.60 | −0.001 |
| ### | May 8, 2012 | 10:50:26 AM | 14:60 | 3.999 | 5.4684 | 3.650 | 58.385 | 0.081 | 83.15 | 14.650 | 3.9990 | 58.585 | 0.081 | 83.42 | 14.60 | 0.001 |
| ### | May 8, 2012 | 10:50:31 AM | 14:60 | 3.999 | 5.4739 | 3.650 | 58.385 | 0.081 | 83.23 | 14.650 | 3.9990 | 58.585 | 0.081 | 83.50 | 14.60 | 0.002 |
| ### | May 8, 2012 | 10:50:36 AM | 14:60 | 3.999 | 5.4795 | 3.650 | 58.385 | 0.081 | 83.31 | 14.650 | 3.9990 | 58.585 | 0.081 | 83.58 | 14.60 | 0.003 |
| ### | May 8, 2012 | 10:50:41 AM | 14:60 | 3.999 | 5.4851 | 3.650 | 58.385 | 0.081 | 83.39 | 14.650 | 3.9990 | 58.585 | 0.081 | 83.66 | 14.60 | 0.004 |
| ### | May 8, 2012 | 10:50:46 AM | 14:60 | 3.999 | 5.4906 | 3.650 | 58.385 | 0.081 | 83.47 | 14.650 | 3.9990 | 58.585 | 0.081 | 83.75 | 14.60 | 0.005 |
| ### | May 8, 2012 | 10:50:51 AM | 14:59 | 3.999 | 5.4961 | 3.648 | 58.345 | 0.081 | 83.55 | 14.640 | 3.9990 | 58.545 | 0.081 | 83.83 | 14.59 | −0.005 |
| ### | May 8, 2012 | 10:50:56 AM | 14:59 | 3.999 | 5.5017 | 3.648 | 58.345 | 0.081 | 83.63 | 14.640 | 3.9990 | 58.545 | 0.081 | 83.91 | 14.59 | −0.004 |
| ### | May 8, 2012 | 10:51:01 AM | 14:59 | 3.999 | 5.5072 | 3.648 | 58.345 | 0.081 | 83.71 | 14.640 | 3.9990 | 58.545 | 0.081 | 83.99 | 14.59 | −0.003 |
| ### | May 8, 2012 | 10:51:06 AM | 14:59 | 3.999 | 5.5128 | 3.648 | 58.345 | 0.081 | 83.80 | 14.640 | 3.9990 | 58.545 | 0.081 | 84.07 | 14.59 | −0.002 |
| ### | May 8, 2012 | 10:51:11 AM | 14:59 | 3.999 | 5.5183 | 3.648 | 58.345 | 0.081 | 83.88 | 14.640 | 3.9990 | 58.545 | 0.081 | 84.15 | 14.59 | −0.001 |
| ### | May 8, 2012 | 10:51:16 AM | 14:59 | 3.999 | 5.5238 | 3.648 | 58.345 | 0.081 | 83.96 | 14.640 | 3.9990 | 58.545 | 0.081 | 84.23 | 14.59 | 0.001 |
| ### | May 8, 2012 | 10:51:21 AM | 14:59 | 3.999 | 5.5294 | 3.648 | 58.345 | 0.081 | 84.04 | 14.640 | 3.9990 | 58.545 | 0.081 | 84.32 | 14.59 | 0.002 |
| ### | May 8, 2012 | 10:51:26 AM | 14:59 | 3.999 | 5.5349 | 3.648 | 58.345 | 0.081 | 84.12 | 14.640 | 3.9990 | 58.545 | 0.081 | 84.40 | 14.59 | 0.003 |
| ### | May 8, 2012 | 10:51:31 AM | 14:59 | 3.999 | 5.5405 | 3.648 | 58.345 | 0.081 | 84.20 | 14.640 | 3.9990 | 58.545 | 0.081 | 84.48 | 14.59 | 0.004 |
| ### | May 8, 2012 | 10:51:36 AM | 14:59 | 3.999 | 5.5460 | 3.648 | 58.345 | 0.081 | 84.28 | 14.640 | 3.9990 | 58.545 | 0.081 | 84.56 | 14.59 | 0.005 |
| ### | May 8, 2012 | 10:51:41 AM | 14:58 | 3.999 | 5.5516 | 3.645 | 58.305 | 0.081 | 84.36 | 14.630 | 3.9990 | 58.505 | 0.081 | 84.64 | 14.58 | −0.005 |
| ### | May 8, 2012 | 10:51:46 AM | 14:58 | 3.999 | 5.5571 | 3.645 | 58.305 | 0.081 | 84.44 | 14.630 | 3.9990 | 58.505 | 0.081 | 84.72 | 14.58 | −0.004 |
| ### | May 8, 2012 | 10:51:51 AM | 14:58 | 3.999 | 5.5627 | 3.645 | 58.305 | 0.081 | 84.52 | 14.630 | 3.9990 | 58.505 | 0.081 | 84.80 | 14.58 | −0.003 |
| ### | May 8, 2012 | 10:51:56 AM | 14:58 | 3.999 | 5.5680 | 3.645 | 58.305 | 0.081 | 84.61 | 14.630 | 3.9990 | 58.505 | 0.081 | 84.88 | 14.58 | −0.001 |
| ### | May 8, 2012 | 10:52:01 AM | 14:58 | 3.999 | 5.5736 | 3.645 | 58.305 | 0.081 | 84.69 | 14.630 | 3.9990 | 58.505 | 0.081 | 84.97 | 14.58 | 0.001 |
| ### | May 8, 2012 | 10:52:06 AM | 14:58 | 3.999 | 5.5791 | 3.645 | 58.305 | 0.081 | 84.77 | 14.630 | 3.9990 | 58.505 | 0.081 | 85.05 | 14.58 | 0.003 |
| ### | May 8, 2012 | 10:52:11 AM | 14:58 | 3.999 | 5.5846 | 3.645 | 58.305 | 0.081 | 84.85 | 14.630 | 3.9990 | 58.505 | 0.081 | 85.13 | 14.58 | 0.004 |
| ### | May 8, 2012 | 10:52:16 AM | 14:58 | 3.999 | 5.5902 | 3.645 | 58.305 | 0.081 | 84.93 | 14.630 | 3.9990 | 58.505 | 0.081 | 85.21 | 14.58 | 0.005 |
| ### | May 8, 2012 | 10:52:21 AM | 14:57 | 3.999 | 5.5957 | 3.643 | 58.265 | 0.081 | 85.01 | 14.620 | 3.9990 | 58.465 | 0.081 | 85.29 | 14.57 | −0.005 |
| ### | May 8, 2012 | 10:52:26 AM | 14:57 | 3.999 | 5.6013 | 3.643 | 58.265 | 0.081 | 85.09 | 14.620 | 3.9990 | 58.465 | 0.081 | 85.37 | 14.57 | −0.004 |
| ### | May 8, 2012 | 10:52:31 AM | 14:57 | 3.999 | 5.6068 | 3.643 | 58.265 | 0.081 | 85.17 | 14.620 | 3.9990 | 58.465 | 0.081 | 85.45 | 14.57 | −0.003 |
| ### | May 8, 2012 | 10:52:36 AM | 14:57 | 3.999 | 5.6124 | 3.643 | 58.265 | 0.081 | 85.25 | 14.620 | 3.9990 | 58.465 | 0.081 | 85.53 | 14.57 | −0.002 |
| ### | May 8, 2012 | 10:52:41 AM | 14:57 | 3.999 | 5.6179 | 3.643 | 58.265 | 0.081 | 85.33 | 14.620 | 3.9990 | 58.465 | 0.081 | 85.62 | 14.57 | −0.001 |
| ### | May 8, 2012 | 10:52:46 AM | 14:57 | 3.999 | 5.6236 | 3.643 | 58.265 | 0.081 | 85.41 | 14.620 | 3.9990 | 58.465 | 0.081 | 85.70 | 14.57 | 0.001 |
| ### | May 8, 2012 | 10:52:51 AM | 14:57 | 3.999 | 5.6292 | 3.643 | 58.265 | 0.081 | 85.50 | 14.620 | 3.9990 | 58.465 | 0.081 | 85.78 | 14.57 | 0.002 |
| ### | May 8, 2012 | 10:52:56 AM | 14:57 | 3.999 | 5.6345 | 3.643 | 58.265 | 0.081 | 85.58 | 14.620 | 3.9990 | 58.465 | 0.081 | 85.86 | 14.57 | 0.003 |
| ### | May 8, 2012 | 10:53:01 AM | 14:57 | 3.999 | 5.6401 | 3.643 | 58.265 | 0.081 | 85.66 | 14.620 | 3.9990 | 58.465 | 0.081 | 85.94 | 14.57 | 0.004 |
| ### | May 8, 2012 | 10:53:06 AM | 14:57 | 3.999 | 5.6456 | 3.643 | 58.265 | 0.081 | 85.74 | 14.620 | 3.9990 | 58.465 | 0.081 | 86.02 | 14.57 | 0.005 |
| ### | May 8, 2012 | 10:53:11 AM | 14:56 | 3.999 | 5.6512 | 3.640 | 58.225 | 0.081 | 85.82 | 14.610 | 3.9990 | 58.425 | 0.081 | 86.10 | 14.56 | −0.005 |
| ### | May 8, 2012 | 10:53:16 AM | 14:56 | 3.999 | 5.6567 | 3.640 | 58.225 | 0.081 | 85.90 | 14.610 | 3.9990 | 58.425 | 0.081 | 86.18 | 14.56 | −0.004 |
| ### | May 8, 2012 | 10:53:21 AM | 14:56 | 3.999 | 5.6623 | 3.640 | 58.225 | 0.081 | 85.98 | 14.610 | 3.9990 | 58.425 | 0.081 | 86.26 | 14.56 | −0.003 |
| ### | May 8, 2012 | 10:53:26 AM | 14:56 | 3.999 | 5.6678 | 3.640 | 58.225 | 0.081 | 86.06 | 14.610 | 3.9990 | 58.425 | 0.081 | 86.35 | 14.56 | −0.002 |
| ### | May 8, 2012 | 10:53:31 AM | 14:56 | 3.999 | 5.6733 | 3.640 | 58.225 | 0.081 | 86.14 | 14.610 | 3.9990 | 58.425 | 0.081 | 86.43 | 14.56 | −0.001 |
| ### | May 8, 2012 | 10:53:36 AM | 14:56 | 3.999 | 5.6789 | 3.640 | 58.225 | 0.081 | 86.22 | 14.610 | 3.9990 | 58.425 | 0.081 | 86.51 | 14.56 | 0.000 |
| ### | May 8, 2012 | 10:53:41 AM | 14:56 | 3.999 | 5.6844 | 3.640 | 58.225 | 0.081 | 86.30 | 14.610 | 3.9990 | 58.425 | 0.081 | 86.59 | 14.56 | 0.000 |
| ### | May 8, 2012 | 10:53:46 AM | 14:56 | 3.999 | 5.6900 | 3.640 | 58.225 | 0.081 | 86.39 | 14.610 | 3.9990 | 58.425 | 0.081 | 86.67 | 14.56 | 0.000 |
| ### | May 8, 2012 | 10:53:51 AM | 14:56 | 3.999 | 5.6955 | 3.640 | 58.225 | 0.081 | 86.47 | 14.610 | 3.9990 | 58.425 | 0.081 | 86.75 | 14.56 | 0.001 |
| ### | May 8, 2012 | 10:53:56 AM | 14:56 | 3.999 | 5.7011 | 3.640 | 58.225 | 0.081 | 86.55 | 14.610 | 3.9990 | 58.425 | 0.081 | 86.83 | 14.56 | 0.002 |
| ### | May 8, 2012 | 10:54:01 AM | 14:56 | 3.999 | 5.7066 | 3.640 | 58.225 | 0.081 | 86.63 | 14.610 | 3.9990 | 58.425 | 0.081 | 86.91 | 14.56 | 0.003 |
| ### | May 8, 2012 | 10:54:06 AM | 14:56 | 3.999 | 5.7122 | 3.640 | 58.225 | 0.081 | 86.71 | 14.610 | 3.9990 | 58.425 | 0.081 | 87.00 | 14.56 | 0.004 |
| ### | May 8, 2012 | 10:54:11 AM | 14:56 | 3.999 | 5.7177 | 3.640 | 58.225 | 0.081 | 86.79 | 14.610 | 3.9990 | 58.425 | 0.081 | 87.08 | 14.56 | 0.005 |
| ### | May 8, 2012 | 10:54:16 AM | 14:55 | 3.999 | 5.7233 | 3.638 | 58.185 | 0.081 | 86.87 | 14.600 | 3.9990 | 58.385 | 0.081 | 87.16 | 14.55 | −0.005 |
| ### | May 8, 2012 | 10:54:21 AM | 14:55 | 3.999 | 5.7288 | 3.638 | 58.185 | 0.081 | 86.95 | 14.600 | 3.9990 | 58.385 | 0.081 | 87.24 | 14.55 | −0.004 |
| ### | May 8, 2012 | 10:54:26 AM | 14:55 | 3.999 | 5.7343 | 3.638 | 58.185 | 0.081 | 87.03 | 14.600 | 3.9990 | 58.385 | 0.081 | 87.32 | 14.55 | −0.003 |
| ### | May 8, 2012 | 10:54:31 AM | 14:55 | 3.999 | 5.7399 | 3.638 | 58.185 | 0.081 | 87.11 | 14.600 | 3.9990 | 58.385 | 0.081 | 87.40 | 14.55 | −0.002 |
| ### | May 8, 2012 | 10:54:36 AM | 14:55 | 3.999 | 5.7454 | 3.638 | 58.185 | 0.081 | 87.19 | 14.600 | 3.9990 | 58.385 | 0.081 | 87.48 | 14.55 | 0.000 |
| ### | May 8, 2012 | 10:54:41 AM | 14:55 | 3.999 | 5.7510 | 3.638 | 58.185 | 0.081 | 87.27 | 14.600 | 3.9990 | 58.385 | 0.081 | 87.56 | 14.55 | 0.002 |
| ### | May 8, 2012 | 10:54:46 AM | 14:55 | 3.999 | 5.7565 | 3.638 | 58.185 | 0.081 | 87.36 | 14.600 | 3.9990 | 58.385 | 0.081 | 87.64 | 14.55 | 0.003 |
| ### | May 8, 2012 | 10:54:51 AM | 14:55 | 3.999 | 5.7620 | 3.638 | 58.185 | 0.081 | 87.44 | 14.600 | 3.9990 | 58.385 | 0.081 | 87.73 | 14.55 | 0.004 |
| ### | May 8, 2012 | 10:54:56 AM | 14:55 | 3.999 | 5.7676 | 3.638 | 58.185 | 0.081 | 87.52 | 14.600 | 3.9990 | 58.385 | 0.081 | 87.81 | 14.55 | 0.005 |
| ### | May 8, 2012 | 10:55:01 AM | 14:54 | 3.999 | 5.7731 | 3.635 | 58.145 | 0.081 | 87.60 | 14.590 | 3.9990 | 58.345 | 0.081 | 87.89 | 14.54 | −0.005 |
| ### | May 8, 2012 | 10:55:06 AM | 14:54 | 3.999 | 5.7787 | 3.635 | 58.145 | 0.081 | 87.68 | 14.590 | 3.9990 | 58.345 | 0.081 | 87.97 | 14.54 | −0.004 |
| ### | May 8, 2012 | 10:55:11 AM | 14:54 | 3.999 | 5.7842 | 3.635 | 58.145 | 0.081 | 87.76 | 14.590 | 3.9990 | 58.345 | 0.081 | 88.05 | 14.54 | −0.003 |
| ### | May 8, 2012 | 10:55:16 AM | 14:54 | 3.999 | 5.7898 | 3.635 | 58.145 | 0.081 | 87.84 | 14.590 | 3.9990 | 58.345 | 0.081 | 88.13 | 14.54 | −0.002 |
| ### | May 8, 2012 | 10:55:21 AM | 14:54 | 3.999 | 5.7953 | 3.635 | 58.145 | 0.081 | 87.92 | 14.590 | 3.9990 | 58.345 | 0.081 | 88.21 | 14.54 | −0.001 |
| ### | May 8, 2012 | 10:55:26 AM | 14:54 | 3.999 | 5.8009 | 3.635 | 58.145 | 0.081 | 88.00 | 14.590 | 3.9990 | 58.345 | 0.081 | 88.29 | 14.54 | 0.000 |
| ### | May 8, 2012 | 10:55:31 AM | 14:54 | 3.999 | 5.8064 | 3.635 | 58.145 | 0.081 | 88.08 | 14.590 | 3.9990 | 58.345 | 0.081 | 88.37 | 14.54 | 0.001 |
| ### | May 8, 2012 | 10:55:36 AM | 14:54 | 3.999 | 5.8119 | 3.635 | 58.145 | 0.081 | 88.16 | 14.590 | 3.9990 | 58.345 | 0.081 | 88.45 | 14.54 | 0.002 |
| ### | May 8, 2012 | 10:55:41 AM | 14:54 | 3.999 | 5.8175 | 3.635 | 58.145 | 0.081 | 88.24 | 14.590 | 3.9990 | 58.345 | 0.081 | 88.54 | 14.54 | 0.003 |
| ### | May 8, 2012 | 10:55:46 AM | 14:54 | 3.999 | 5.8230 | 3.635 | 58.145 | 0.081 | 88.32 | 14.590 | 3.9990 | 58.345 | 0.081 | 88.62 | 14.54 | 0.004 |
| ### | May 8, 2012 | 10:55:51 AM | 14:54 | 3.999 | 5.8286 | 3.635 | 58.145 | 0.081 | 88.41 | 14.590 | 3.9990 | 58.345 | 0.081 | 88.70 | 14.54 | 0.005 |
| ### | May 8, 2012 | 10:55:56 AM | 14:53 | 3.999 | 5.8341 | 3.633 | 58.105 | 0.081 | 88.49 | 14.580 | 3.9990 | 58.305 | 0.081 | 88.78 | 14.53 | −0.005 |
| ### | May 8, 2012 | 10:56:01 AM | 14:53 | 3.999 | 5.8397 | 3.633 | 58.105 | 0.081 | 88.57 | 14.580 | 3.9990 | 58.305 | 0.081 | 88.86 | 14.53 | −0.004 |
| ### | May 8, 2012 | 10:56:06 AM | 14:53 | 3.999 | 5.8452 | 3.633 | 58.105 | 0.081 | 88.65 | 14.580 | 3.9990 | 58.305 | 0.081 | 88.94 | 14.53 | −0.003 |
| ### | May 8, 2012 | 10:56:11 AM | 14:53 | 3.999 | 5.8507 | 3.633 | 58.105 | 0.081 | 88.73 | 14.580 | 3.9990 | 58.305 | 0.081 | 89.02 | 14.53 | −0.001 |
| ### | May 8, 2012 | 10:56:16 AM | 14:53 | 3.999 | 5.8563 | 3.633 | 58.105 | 0.081 | 88.81 | 14.580 | 3.9990 | 58.305 | 0.081 | 89.10 | 14.53 | 0.001 |
| ### | May 8, 2012 | 10:56:21 AM | 14.53 | 3.999 | 5.8618 | 3.633 | 58.105 | 0.081 | [symbol] | 14.580 | 3.9990 | 58.305 | 0.081 | 89.18 | 14.53 | 0.003 |
| ### | May 8, 2012 | 10:56:26 AM | 14.53 | 3.999 | 5.8674 | 3.633 | 58.105 | 0.081 | 88.97 | 14.580 | 3.9990 | 58.305 | 0.081 | 89.26 | 14.53 | 0.004 |
| ### | May 8, 2012 | 10:56:31 AM | 14.53 | 3.999 | 5.8729 | 3.633 | 58.105 | 0.081 | 89.05 | 14.580 | 3.9990 | 58.305 | 0.081 | 89.35 | 14.53 | 0.005 |
| ### | May 8, 2012 | 10:56:36 AM | 14.52 | 3.999 | 5.8785 | 3.630 | 58.065 | 0.081 | 89.13 | 14.570 | 3.9990 | 58.265 | 0.081 | 89.43 | 14.52 | −0.005 |
| ### | May 8, 2012 | 10:56:41 AM | 14.52 | 3.999 | 5.8840 | 3.630 | 58.065 | 0.081 | 89.21 | 14.570 | 3.9990 | 58.265 | 0.081 | 89.51 | 14.52 | −0.004 |
| ### | May 8, 2012 | 10:56:46 AM | 14.52 | 3.999 | 5.8896 | 3.630 | 58.065 | 0.081 | 89.29 | 14.570 | 3.9990 | 58.265 | 0.081 | 89.59 | 14.52 | −0.003 |
| ### | May 8, 2012 | 10:56:51 AM | 14.52 | 3.999 | 5.8951 | 3.630 | 58.065 | 0.081 | 89.37 | 14.570 | 3.9990 | 58.265 | 0.081 | 89.67 | 14.52 | −0.001 |
| ### | May 8, 2012 | 10:56:56 AM | 14.52 | 3.999 | 5.9006 | 3.630 | 58.065 | 0.081 | 89.45 | 14.570 | 3.9990 | 58.265 | 0.081 | 89.75 | 14.52 | 0.001 |
| ### | May 8, 2012 | 10:57:01 AM | 14.52 | 3.999 | 5.9062 | 3.630 | 58.065 | 0.081 | 89.54 | 14.570 | 3.9990 | 58.265 | 0.081 | 89.83 | 14.52 | 0.003 |
| ### | May 8, 2012 | 10:57:06 AM | 14.52 | 3.999 | 5.9117 | 3.630 | 58.065 | 0.081 | 89.62 | 14.570 | 3.9990 | 58.265 | 0.081 | 89.91 | 14.52 | 0.004 |
| ### | May 8, 2012 | 10:57:11 AM | 14.52 | 3.999 | 5.9173 | 3.630 | 58.065 | 0.081 | 89.70 | 14.570 | 3.9990 | 58.265 | 0.081 | 89.99 | 14.52 | 0.005 |
| ### | May 8, 2012 | 10:57:16 AM | 14.51 | 3.999 | 5.9228 | 3.628 | 58.025 | 0.081 | 89.78 | 14.560 | 3.9990 | 58.225 | 0.081 | 90.07 | 14.51 | −0.005 |
| ### | May 8, 2012 | 10:57:21 AM | 14.51 | 3.999 | 5.9284 | 3.628 | 58.025 | 0.081 | 89.86 | 14.560 | 3.9990 | 58.225 | 0.081 | 90.15 | 14.51 | −0.004 |
| ### | May 8, 2012 | 10:57:26 AM | 14.51 | 3.999 | 5.9339 | 3.628 | 58.025 | 0.081 | 89.94 | 14.560 | 3.9990 | 58.225 | 0.081 | 90.24 | 14.51 | −0.003 |
| ### | May 8, 2012 | 10:57:31 AM | 14.51 | 3.999 | 5.9395 | 3.628 | 58.025 | 0.081 | 90.02 | 14.560 | 3.9990 | 58.225 | 0.081 | 90.32 | 14.51 | −0.002 |
| ### | May 8, 2012 | 10:57:36 AM | 14.51 | 3.999 | 5.9450 | 3.628 | 58.025 | 0.081 | 90.10 | 14.560 | 3.9990 | 58.225 | 0.081 | 90.40 | 14.51 | −0.001 |
| ### | May 8, 2012 | 10:57:41 AM | 14.51 | 3.999 | 5.9505 | 3.628 | 58.025 | 0.081 | 90.18 | 14.560 | 3.9990 | 58.225 | 0.081 | 90.48 | 14.51 | 0.000 |
| ### | May 8, 2012 | 10:57:46 AM | 14.51 | 3.999 | 5.9561 | 3.628 | 58.025 | 0.081 | 90.26 | 14.560 | 3.9990 | 58.225 | 0.081 | 90.56 | 14.51 | 0.000 |
| ### | May 8, 2012 | 10:57:51 AM | 14.51 | 3.999 | 5.9616 | 3.628 | 58.025 | 0.081 | 90.34 | 14.560 | 3.9990 | 58.225 | 0.081 | 90.64 | 14.51 | 0.000 |
| ### | May 8, 2012 | 10:57:56 AM | 14.51 | 3.999 | 5.9672 | 3.628 | 58.025 | 0.081 | 90.42 | 14.560 | 3.9990 | 58.225 | 0.081 | 90.72 | 14.51 | 0.000 |
| ### | May 8, 2012 | 10:58:01 AM | 14.51 | 3.999 | 5.9727 | 3.628 | 58.025 | 0.081 | 90.50 | 14.560 | 3.9990 | 58.225 | 0.081 | 90.80 | 14.51 | 0.001 |
| ### | May 8, 2012 | 10:58:06 AM | 14.51 | 3.999 | 5.9782 | 3.628 | 58.025 | 0.081 | 90.58 | 14.560 | 3.9990 | 58.225 | 0.081 | 90.88 | 14.51 | 0.002 |
| ### | May 8, 2012 | 10:58:11 AM | 14.51 | 3.999 | 5.9838 | 3.628 | 58.025 | 0.081 | 90.66 | 14.560 | 3.9990 | 58.225 | 0.081 | 90.96 | 14.51 | 0.003 |
| ### | May 8, 2012 | 10:58:16 AM | 14.51 | 3.999 | 5.9893 | 3.628 | 58.025 | 0.081 | 90.74 | 14.560 | 3.9990 | 58.225 | 0.081 | 91.04 | 14.51 | 0.004 |
| ### | May 8, 2012 | 10:58:21 AM | 14.51 | 3.999 | 5.9949 | 3.628 | 58.025 | 0.081 | 90.82 | 14.560 | 3.9990 | 58.225 | 0.081 | 91.12 | 14.51 | 0.005 |
| ### | May 8, 2012 | 10:58:26 AM | 14.50 | 4.000 | 6.0004 | 3.625 | 58.000 | 0.081 | 90.91 | 14.550 | 4.0000 | 58.200 | 0.081 | 91.21 | 14.50 | −0.005 |
| ### | May 8, 2012 | 10:58:31 AM | 14.50 | 3.999 | 6.0060 | 3.625 | 57.986 | 0.081 | 90.99 | 14.550 | 3.9990 | 58.185 | 0.081 | 91.29 | 14.50 | −0.004 |
| ### | May 8, 2012 | 10:58:36 AM | 14.50 | 3.999 | 6.0115 | 3.625 | 57.986 | 0.081 | 91.07 | 14.550 | 3.9990 | 58.185 | 0.081 | 91.37 | 14.50 | −0.003 |
| ### | May 8, 2012 | 10:58:41 AM | 14.50 | 3.999 | 6.0171 | 3.625 | 57.986 | 0.081 | 91.15 | 14.550 | 3.9990 | 58.185 | 0.081 | 91.45 | 14.50 | −0.002 |
| ### | May 8, 2012 | 10:58:46 AM | 14.50 | 3.999 | 6.0226 | 3.625 | 57.986 | 0.081 | 91.23 | 14.550 | 3.9990 | 58.185 | 0.081 | 91.53 | 14.50 | −0.001 |
| ### | May 8, 2012 | 10:58:51 AM | 14.50 | 3.999 | 6.0281 | 3.625 | 57.986 | 0.081 | 91.31 | 14.550 | 3.9990 | 58.185 | 0.081 | 91.61 | 14.50 | 0.001 |
| ### | May 8, 2012 | 10:58:56 AM | 14.50 | 3.999 | 6.0337 | 3.625 | 57.986 | 0.081 | 91.39 | 14.550 | 3.9990 | 58.185 | 0.081 | 91.69 | 14.50 | 0.002 |
| ### | May 8, 2012 | 10:59:01 AM | 14.50 | 3.999 | 6.0392 | 3.625 | 57.986 | 0.081 | 91.47 | 14.550 | 3.9990 | 58.185 | 0.081 | 91.77 | 14.50 | 0.003 |
| ### | May 8, 2012 | 10:59:06 AM | 14.50 | 3.999 | 6.0448 | 3.625 | 57.986 | 0.081 | 91.55 | 14.550 | 3.9990 | 58.185 | 0.081 | 91.85 | 14.50 | 0.004 |
| ### | May 8, 2012 | 10:59:11 AM | 14.50 | 3.999 | 6.0503 | 3.625 | 57.986 | 0.081 | 91.63 | 14.550 | 3.9990 | 58.185 | 0.081 | 91.93 | 14.50 | 0.005 |
| ### | May 8, 2012 | 10:59:16 AM | 14.49 | 3.999 | 6.0559 | 3.623 | 57.946 | 0.080 | 91.71 | 14.540 | 3.9990 | 58.145 | 0.081 | 92.01 | 14.49 | −0.005 |
| ### | May 8, 2012 | 10:59:21 AM | 14.49 | 3.999 | 6.0614 | 3.623 | 57.946 | 0.080 | 91.79 | 14.540 | 3.9990 | 58.145 | 0.081 | 92.09 | 14.49 | −0.004 |
| ### | May 8, 2012 | 10:59:26 AM | 14.49 | 3.999 | 6.0670 | 3.623 | 57.946 | 0.080 | 91.87 | 14.540 | 3.9990 | 58.145 | 0.081 | 92.18 | 14.49 | −0.003 |
| ### | May 8, 2012 | 10:59:31 AM | 14.49 | 3.999 | 6.0725 | 3.623 | 57.946 | 0.080 | 91.95 | 14.540 | 3.9990 | 58.145 | 0.081 | 92.26 | 14.49 | −0.002 |
| ### | May 8, 2012 | 10:59:36 AM | 14.49 | 3.999 | 6.0780 | 3.623 | 57.946 | 0.080 | 92.03 | 14.540 | 3.9990 | 58.145 | 0.081 | 92.34 | 14.49 | 0.000 |
| ### | May 8, 2012 | 10:59:41 AM | 14.49 | 3.999 | 6.0836 | 3.623 | 57.946 | 0.080 | 92.11 | 14.540 | 3.9990 | 58.145 | 0.081 | 92.42 | 14.49 | 0.001 |
| ### | May 8, 2012 | 10:59:46 AM | 14.49 | 3.999 | 6.0893 | 3.623 | 57.946 | 0.080 | 92.19 | 14.540 | 3.9990 | 58.145 | 0.081 | 92.50 | 14.49 | 0.001 |
| ### | May 8, 2012 | 10:59:51 AM | 14.49 | 3.999 | 6.0949 | 3.623 | 57.946 | 0.080 | 92.27 | 14.540 | 3.9990 | 58.145 | 0.081 | 92.58 | 14.49 | 0.002 |
| ### | May 8, 2012 | 10:59:56 AM | 14.49 | 3.999 | 6.1004 | 3.623 | 57.946 | 0.080 | 92.35 | 14.540 | 3.9990 | 58.145 | 0.081 | 92.66 | 14.49 | 0.003 |
| ### | May 8, 2012 | 11:00:01 AM | 14.48 | 3.999 | 6.1060 | 3.623 | 57.946 | 0.080 | 92.43 | 14.530 | 3.9990 | 58.105 | 0.081 | 92.74 | 14.49 | −0.006 |
| ### | May 8, 2012 | 11:00:06 AM | 14.49 | 3.999 | 6.1115 | 3.623 | 57.946 | 0.080 | 92.52 | 14.540 | 3.9990 | 58.145 | 0.081 | 92.82 | 14.49 | 0.005 |
| ### | May 8, 2012 | 11:00:11 AM | 14.49 | 3.999 | 6.1170 | 3.623 | 57.946 | 0.080 | 92.60 | 14.540 | 3.9990 | 58.145 | 0.081 | 92.90 | 14.48 | 0.005 |
| ### | May 8, 2012 | 11:00:16 AM | 14.48 | 3.999 | 6.1226 | 3.620 | 57.906 | 0.080 | 92.68 | 14.530 | 3.9990 | 58.105 | 0.081 | 92.98 | 14.48 | −0.004 |
| ### | May 8, 2012 | 11:00:21 AM | 14.48 | 3.999 | 6.1281 | 3.620 | 57.946 | 0.080 | 92.76 | 14.530 | 3.9990 | 58.105 | 0.081 | 93.06 | 14.48 | −0.003 |
| ### | May 8, 2012 | 11:00:26 AM | 14.48 | 3.999 | 6.1337 | 3.620 | 57.946 | 0.080 | 92.84 | 14.530 | 3.9990 | 58.105 | 0.081 | 93.14 | 14.48 | −0.002 |
| ### | May 8, 2012 | 11:00:31 AM | 14.48 | 3.999 | 6.1392 | 3.620 | 57.906 | 0.080 | 92.92 | 14.530 | 3.9990 | 58.105 | 0.081 | 93.22 | 14.48 | −0.001 |
| ### | May 8, 2012 | 11:00:36 AM | 14.48 | 3.999 | 6.1448 | 3.620 | 57.906 | 0.080 | 93.00 | 14.530 | 3.9990 | 58.105 | 0.081 | 93.31 | 14.48 | 0.001 |
| ### | May 8, 2012 | 11:00:41 AM | 14.48 | 3.999 | 6.1503 | 3.620 | 57.906 | 0.080 | 93.08 | 14.530 | 3.9990 | 58.105 | 0.081 | 93.39 | 14.48 | 0.003 |
| ### | May 8, 2012 | 11:00:46 AM | 14.48 | 3.999 | 6.1557 | 3.620 | 57.906 | 0.080 | 93.16 | 14.530 | 3.9990 | 58.105 | 0.081 | 93.47 | 14.48 | 0.004 |
| ### | May 8, 2012 | 11:00:51 AM | 14.48 | 3.999 | 6.1612 | 3.620 | 57.906 | 0.080 | 93.24 | 14.530 | 3.9990 | 58.105 | 0.081 | 93.55 | 14.48 | 0.005 |
| ### | May 8, 2012 | 11:00:56 AM | 14.47 | 3.999 | 6.1667 | 3.618 | 57.866 | 0.080 | 93.32 | 14.520 | 3.9990 | 58.065 | 0.081 | 93.63 | 14.47 | −0.005 |
| ### | May 8, 2012 | 11:01:01 AM | 14.47 | 3.999 | 6.1723 | 3.618 | 57.866 | 0.080 | 93.40 | 14.520 | 3.9990 | 58.065 | 0.081 | 93.71 | 14.47 | −0.004 |
| ### | May 8, 2012 | 11:01:06 AM | 14.47 | 3.999 | 6.1780 | 3.618 | 57.866 | 0.080 | 93.48 | 14.520 | 3.9990 | 58.065 | 0.081 | 93.79 | 14.47 | −0.003 |
| ### | May 8, 2012 | 11:01:11 AM | 14.47 | 3.999 | 6.1836 | 3.618 | 57.866 | 0.080 | 93.56 | 14.520 | 3.9990 | 58.065 | 0.081 | 93.87 | 14.47 | −0.002 |
| ### | May 8, 2012 | 11:01:16 AM | 14.47 | 3.999 | 6.1889 | 3.618 | 57.866 | 0.080 | 93.64 | 14.520 | 3.9990 | 58.065 | 0.081 | 93.95 | 14.47 | −0.001 |
| ### | May 8, 2012 | 11:01:21 AM | 14.47 | 3.999 | 6.1945 | 3.618 | 57.866 | 0.080 | 93.72 | 14.520 | 3.9990 | 58.065 | 0.081 | 94.03 | 14.47 | 0.000 |
| ### | May 8, 2012 | 11:01:26 AM | 14.47 | 3.999 | 6.2000 | 3.618 | 57.866 | 0.080 | 93.80 | 14.520 | 3.9990 | 58.065 | 0.081 | 94.11 | 14.47 | 0.000 |
| ### | May 8, 2012 | 11:01:31 AM | 14.47 | 3.999 | 6.2056 | 3.618 | 57.866 | 0.080 | 93.88 | 14.520 | 3.9990 | 58.065 | 0.081 | 94.19 | 14.47 | 0.001 |
| ### | May 8, 2012 | 11:01:36 AM | 14.47 | 3.999 | 6.2111 | 3.618 | 57.866 | 0.080 | 93.96 | 14.520 | 3.9990 | 58.065 | 0.081 | 94.27 | 14.47 | 0.002 |
| ### | May 8, 2012 | 11:01:41 AM | 14.47 | 3.999 | 6.2166 | 3.618 | 57.866 | 0.080 | 94.04 | 14.520 | 3.9990 | 58.065 | 0.081 | 94.35 | 14.47 | 0.003 |
| ### | May 8, 2012 | 11:01:46 AM | 14.47 | 3.999 | 6.2222 | 3.618 | 57.866 | 0.080 | 94.12 | 14.520 | 3.9990 | 58.065 | 0.081 | 94.43 | 14.47 | 0.004 |
| ### | May 8, 2012 | 11:01:51 AM | 14.47 | 3.999 | 6.2277 | 3.618 | 57.866 | 0.080 | 94.20 | 14.520 | 3.9990 | 58.065 | 0.081 | 94.52 | 14.47 | 0.005 |
| ### | May 8, 2012 | 11:01:56 AM | 14.46 | 3.999 | 6.2333 | 3.615 | 57.826 | 0.080 | 94.28 | 14.510 | 3.9990 | 58.025 | 0.081 | 94.60 | 14.46 | −0.005 |
| ### | May 8, 2012 | 11:02:01 AM | 14.46 | 3.999 | 6.2388 | 3.615 | 57.826 | 0.080 | 94.36 | 14.510 | 3.9990 | 58.025 | 0.081 | 94.68 | 14.46 | −0.004 |
| ### | May 8, 2012 | 11:02:06 AM | 14.46 | 3.999 | 6.2444 | 3.615 | 57.826 | 0.080 | 94.44 | 14.510 | 3.9990 | 58.025 | 0.081 | 94.76 | 14.46 | −0.003 |
| ### | May 8, 2012 | 11:02:11 AM | 14.46 | 3.999 | 6.2499 | 3.615 | 57.826 | 0.080 | 94.52 | 14.510 | 3.9990 | 58.025 | 0.081 | 94.84 | 14.46 | −0.002 |
| ### | May 8, 2012 | 11:02:16 AM | 14.46 | 3.999 | 6.2555 | 3.615 | 57.826 | 0.080 | 94.61 | 14.510 | 3.9990 | 58.025 | 0.081 | 94.92 | 14.46 | −0.001 |
| ### | May 8, 2012 | 11:02:21 AM | 14.46 | 3.999 | 6.2610 | 3.615 | 57.826 | 0.080 | 94.69 | 14.510 | 3.9990 | 58.025 | 0.081 | 95.00 | 14.46 | 0.001 |
| ### | May 8, 2012 | 11:02:26 AM | 14.46 | 3.999 | 6.2665 | 3.615 | 57.826 | 0.080 | 94.77 | 14.510 | 3.9990 | 58.025 | 0.081 | 95.08 | 14.46 | 0.002 |
| ### | May 8, 2012 | 11:02:31 AM | 14.46 | 3.999 | 6.2721 | 3.615 | 57.826 | 0.080 | 94.85 | 14.510 | 3.9990 | 58.025 | 0.081 | 95.16 | 14.46 | 0.003 |
| ### | May 8, 2012 | 11:02:36 AM | 14.46 | 3.999 | 6.2776 | 3.615 | 57.826 | 0.080 | 94.93 | 14.510 | 3.9990 | 58.025 | 0.081 | 95.24 | 14.46 | 0.004 |
| ### | May 8, 2012 | 11:02:41 AM | 14.46 | 3.999 | 6.2832 | 3.615 | 57. [symbol] | 0.080 | [symbol] | [symbol] | 3.9990 | 58.025 | 0.081 | 95.32 | 14.46 | 0.005 |
| ### | May 8, 2012 | 11:02:46 AM | 14.45 | 3.999 | 6.2887 | 3.613 | 57.786 | 0.080 | 95.09 | 14.500 | 3.9990 | 57.986 | 0.081 | 95.40 | 14.45 | −0.005 |
| ### | May 8, 2012 | 11:02:51 AM | 14.45 | 3.999 | 6.2944 | 3.613 | 57.786 | 0.080 | 95.17 | 14.500 | 3.9990 | 57.986 | 0.081 | 95.48 | 14.45 | −0.004 |
| ### | May 8, 2012 | 11:02:56 AM | 14.45 | 3.999 | 6.3000 | 3.613 | 57.786 | 0.080 | 95.25 | 14.500 | 3.9990 | 57.986 | 0.081 | 95.56 | 14.45 | −0.003 |
| ### | May 8, 2012 | 11:03:01 AM | 14.45 | 3.999 | 6.3056 | 3.613 | 57.786 | 0.080 | 95.23 | 14.500 | 3.9990 | 57.986 | 0.081 | 95.64 | 14.45 | −0.002 |
| ### | May 8, 2012 | 11:03:06 AM | 14.45 | 3.999 | 6.3111 | 3.613 | 57.786 | 0.080 | 95.41 | 14.500 | 3.9990 | 57.986 | 0.081 | 95.72 | 14.45 | −0.001 |
| ### | May 8, 2012 | 11:03:11 AM | 14.45 | 3.999 | 6.3166 | 3.613 | 57.786 | 0.080 | 95.49 | 14.500 | 3.9990 | 57.986 | 0.081 | 95.80 | 14.45 | 0.001 |
| ### | May 8, 2012 | 11:03:16 AM | 14.45 | 3.999 | 6.3222 | 3.613 | 57.786 | 0.080 | 95.57 | 14.500 | 3.9990 | 57.986 | 0.081 | 95.89 | 14.45 | 0.002 |
| ### | May 8, 2012 | 11:03:21 AM | 14.45 | 3.999 | 6.3277 | 3.613 | 57.786 | 0.080 | 95.65 | 14.500 | 3.9990 | 57.986 | 0.081 | 95.97 | 14.45 | 0.003 |
| ### | May 8, 2012 | 11:03:26 AM | 14.45 | 3.999 | 6.3333 | 3.613 | 57.786 | 0.080 | 95.73 | 14.500 | 3.9990 | 57.986 | 0.081 | 96.05 | 14.45 | 0.004 |
| ### | May 8, 2012 | 11:03:31 AM | 14.45 | 3.999 | 6.3388 | 3.613 | 57.786 | 0.080 | 95.81 | 14.500 | 3.9990 | 57.986 | 0.081 | 96.13 | 14.45 | 0.005 |
| ### | May 8, 2012 | 11:03:36 AM | 14.44 | 3.999 | 6.3444 | 3.610 | 57.746 | 0.080 | 95.89 | 14.490 | 3.9990 | 57.946 | 0.080 | 96.21 | 14.44 | −0.005 |
| ### | May 8, 2012 | 11:03:41 AM | 14.44 | 3.999 | 6.3499 | 3.610 | 57.746 | 0.080 | 95.97 | 14.490 | 3.9990 | 57.946 | 0.080 | 96.29 | 14.44 | −0.004 |
| ### | May 8, 2012 | 11:03:46 AM | 14.44 | 3.999 | 6.3554 | 3.610 | 57.746 | 0.080 | 96.05 | 14.490 | 3.9990 | 57.946 | 0.080 | 96.37 | 14.44 | −0.003 |
| ### | May 8, 2012 | 11:03:51 AM | 14.44 | 3.999 | 6.3610 | 3.610 | 57.746 | 0.080 | 96.13 | 14.490 | 3.9990 | 57.946 | 0.080 | 96.45 | 14.44 | −0.002 |
| ### | May 8, 2012 | 11:03:56 AM | 14.44 | 3.999 | 6.3665 | 3.610 | 57.746 | 0.080 | 96.21 | 14.490 | 3.9990 | 57.946 | 0.080 | 96.53 | 14.44 | −0.001 |
| ### | May 8, 2012 | 11:04:01 AM | 14.44 | 3.999 | 6.3721 | 3.610 | 57.746 | 0.080 | 96.29 | 14.490 | 3.9990 | 57.946 | 0.080 | 96.61 | 14.44 | 0.000 |
| ### | May 8, 2012 | 11:04:06 AM | 14.44 | 3.999 | 6.3776 | 3.610 | 57.746 | 0.080 | 96.37 | 14.490 | 3.9990 | 57.946 | 0.080 | 96.69 | 14.44 | 0.000 |
| ### | May 8, 2012 | 11:04:11 AM | 14.44 | 3.999 | 6.3832 | 3.610 | 57.746 | 0.080 | 96.45 | 14.490 | 3.9990 | 57.946 | 0.080 | 96.77 | 14.44 | 0.000 |
| ### | May 8, 2012 | 11:04:16 AM | 14.44 | 3.999 | 6.3887 | 3.610 | 57.746 | 0.080 | 96.53 | 14.490 | 3.9990 | 57.946 | 0.080 | 96.85 | 14.44 | 0.001 |
| ### | May 8, 2012 | 11:04:21 AM | 14.44 | 3.999 | 6.3942 | 3.610 | 57.746 | 0.080 | 96.61 | 14.490 | 3.9990 | 57.946 | 0.080 | 96.93 | 14.44 | 0.002 |
| ### | May 8, 2012 | 11:04:26 AM | 14.44 | 3.999 | 6.3998 | 3.610 | 57.746 | 0.080 | 96.69 | 14.490 | 3.9990 | 57.946 | 0.080 | 97.01 | 14.44 | 0.003 |
| ### | May 8, 2012 | 11:04:31 AM | 14.44 | 3.999 | 6.4053 | 3.610 | 57.746 | 0.080 | 96.77 | 14.490 | 3.9990 | 57.946 | 0.080 | 97.09 | 14.44 | 0.004 |
| ### | May 8, 2012 | 11:04:36 AM | 14.44 | 3.999 | 6.4109 | 3.610 | 57.746 | 0.080 | 96.85 | 14.490 | 3.9990 | 57.946 | 0.080 | 97.17 | 14.44 | 0.005 |
| ### | May 8, 2012 | 11:04:41 AM | 14.43 | 3.999 | 6.4164 | 3.608 | 57.706 | 0.080 | 96.93 | 14.480 | 3.9990 | 57.906 | 0.080 | 97.25 | 14.43 | −0.005 |
| ### | May 8, 2012 | 11:04:46 AM | 14.43 | 3.999 | 6.4220 | 3.608 | 57.706 | 0.080 | 97.01 | 14.480 | 3.9990 | 57.906 | 0.080 | 97.33 | 14.43 | −0.004 |
| ### | May 8, 2012 | 11:04:51 AM | 14.43 | 3.999 | 6.4275 | 3.608 | 57.706 | 0.080 | 97.09 | 14.480 | 3.9990 | 57.906 | 0.080 | 97.41 | 14.43 | −0.003 |
| ### | May 8, 2012 | 11:04:56 AM | 14.43 | 3.999 | 6.4331 | 3.608 | 57.706 | 0.080 | 97.17 | 14.480 | 3.9990 | 57.906 | 0.080 | 97.49 | 14.43 | −0.002 |
| ### | May 8, 2012 | 11:05:01 AM | 14.43 | 3.999 | 6.4386 | 3.608 | 57.706 | 0.080 | 97.25 | 14.480 | 3.9990 | 57.906 | 0.080 | 97.58 | 14.43 | −0.001 |
| ### | May 8, 2012 | 11:05:06 AM | 14.43 | 3.999 | 6.4442 | 3.608 | 57.706 | 0.080 | 97.33 | 14.480 | 3.9990 | 57.906 | 0.080 | 97.66 | 14.43 | 0.001 |
| ### | May 8, 2012 | 11:05:11 AM | 14.43 | 3.999 | 6.4497 | 3.608 | 57.706 | 0.080 | 97.41 | 14.480 | 3.9990 | 57.906 | 0.080 | 97.74 | 14.43 | 0.002 |
| ### | May 8, 2012 | 11:05:16 AM | 14.43 | 3.999 | 6.4552 | 3.608 | 57.706 | 0.080 | 97.49 | 14.480 | 3.9990 | 57.906 | 0.080 | 97.82 | 14.43 | 0.003 |
| ### | May 8, 2012 | 11:05:21 AM | 14.43 | 3.999 | 6.4608 | 3.608 | 57.706 | 0.080 | 97.57 | 14.480 | 3.9990 | 57.906 | 0.080 | 97.90 | 14.43 | 0.004 |
| ### | May 8, 2012 | 11:05:26 AM | 14.43 | 3.999 | 6.4663 | 3.608 | 57.706 | 0.080 | 97.65 | 14.480 | 3.9990 | 57.906 | 0.080 | 97.98 | 14.43 | 0.005 |
| ### | May 8, 2012 | 11:05:31 AM | 14.42 | 3.999 | 6.4719 | 3.605 | 57.666 | 0.080 | 97.73 | 14.470 | 3.9990 | 57.866 | 0.080 | 98.06 | 14.42 | −0.005 |
| ### | May 8, 2012 | 11:05:36 AM | 14.42 | 3.999 | 6.4774 | 3.605 | 57.666 | 0.080 | 97.81 | 14.470 | 3.9990 | 57.866 | 0.080 | 98.14 | 14.42 | −0.004 |
| ### | May 8, 2012 | 11:05:41 AM | 14.42 | 3.999 | 6.4830 | 3.605 | 57.666 | 0.080 | 97.89 | 14.470 | 3.9990 | 57.866 | 0.080 | 98.22 | 14.42 | −0.002 |
| ### | May 8, 2012 | 11:05:46 AM | 14.42 | 3.999 | 6.4885 | 3.605 | 57.666 | 0.080 | 97.97 | 14.470 | 3.9990 | 57.866 | 0.080 | 98.30 | 14.42 | 0.000 |
| ### | May 8, 2012 | 11:05:51 AM | 14.42 | 3.999 | 6.4940 | 3.605 | 57.666 | 0.080 | 98.05 | 14.470 | 3.9990 | 57.866 | 0.080 | 98.38 | 14.42 | 0.001 |
| ### | May 8, 2012 | 11:05:56 AM | 14.42 | 3.999 | 6.4996 | 3.605 | 57.666 | 0.080 | 98.13 | 14.470 | 3.9990 | 57.866 | 0.080 | 98.46 | 14.42 | 0.003 |
| ### | May 8, 2012 | 11:06:01 AM | 14.42 | 3.999 | 6.5052 | 3.605 | 57.666 | 0.080 | 98.21 | 14.470 | 3.9990 | 57.866 | 0.080 | 98.54 | 14.42 | 0.004 |
| ### | May 8, 2012 | 11:06:06 AM | 14.41 | 3.999 | 6.5107 | 3.603 | 57.626 | 0.080 | 98.29 | 14.460 | 3.9990 | 57.826 | 0.080 | 98.62 | 14.42 | −0.005 |
| ### | May 8, 2012 | 11:06:11 AM | 14.41 | 3.999 | 6.5162 | 3.603 | 57.626 | 0.080 | 98.37 | 14.460 | 3.9990 | 57.826 | 0.080 | 98.70 | 14.41 | −0.005 |
| ### | May 8, 2012 | 11:06:16 AM | 14.42 | 3.999 | 6.5218 | 3.605 | 57.666 | 0.080 | 98.45 | 14.470 | 3.9990 | 57.866 | 0.080 | 98.78 | 14.41 | 0.006 |
| ### | May 8, 2012 | 11:06:21 AM | 14.41 | 3.999 | 6.5273 | 3.603 | 57.626 | 0.080 | 98.53 | 14.460 | 3.9990 | 57.826 | 0.080 | 98.86 | 14.41 | −0.003 |
| ### | May 8, 2012 | 11:06:26 AM | 14.41 | 3.999 | 6.5329 | 3.603 | 57.626 | 0.080 | 98.61 | 14.460 | 3.9990 | 57.826 | 0.080 | 98.94 | 14.41 | −0.002 |
| ### | May 8, 2012 | 11:06:31 AM | 14.41 | 3.999 | 6.5384 | 3.603 | 57.626 | 0.080 | 98.69 | 14.460 | 3.9990 | 57.826 | 0.080 | 99.02 | 14.41 | −0.001 |
| ### | May 8, 2012 | 11:06:36 AM | 14.41 | 3.999 | 6.5439 | 3.603 | 57.626 | 0.080 | 98.77 | 14.460 | 3.9990 | 57.826 | 0.080 | 99.10 | 14.41 | 0.000 |
| ### | May 8, 2012 | 11:06:41 AM | 14.41 | 3.999 | 6.5495 | 3.603 | 57.626 | 0.080 | 98.85 | 14.460 | 3.9990 | 57.826 | 0.080 | 99.18 | 14.41 | 0.000 |
| ### | May 8, 2012 | 11:06:46 AM | 14.41 | 3.999 | 6.5550 | 3.603 | 57.626 | 0.080 | 98.93 | 14.460 | 3.9990 | 57.826 | 0.080 | 99.26 | 14.41 | 0.002 |
| ### | May 8, 2012 | 11:06:51 AM | 14.41 | 3.999 | 6.5606 | 3.603 | 57.626 | 0.080 | 99.01 | 14.460 | 3.9990 | 57.826 | 0.080 | 99.34 | 14.41 | 0.003 |
| ### | May 8, 2012 | 11:06:56 AM | 14.41 | 3.999 | 6.5661 | 3.603 | 57.626 | 0.080 | 99.09 | 14.460 | 3.9990 | 57.826 | 0.080 | 99.42 | 14.41 | 0.004 |
| ### | May 8, 2012 | 11:07:01 AM | 14.40 | 3.999 | 6.5717 | 3.600 | 57.586 | 0.080 | 99.17 | 14.450 | 3.9990 | 57.786 | 0.080 | 99.50 | 14.41 | −0.005 |
| ### | May 8, 2012 | 11:07:06 AM | 14.41 | 3.999 | 6.5772 | 3.603 | 57.626 | 0.080 | 99.25 | 14.460 | 3.9990 | 57.826 | 0.080 | 99.58 | 14.40 | 0.005 |
| ### | May 8, 2012 | 11:07:11 AM | 14.40 | 3.999 | 6.5828 | 3.600 | 57.586 | 0.080 | 99.33 | 14.450 | 3.9990 | 57.786 | 0.080 | 99.66 | 14.40 | −0.004 |
| ### | May 8, 2012 | 11:07:16 AM | 14.40 | 3.999 | 6.5883 | 3.600 | 57.586 | 0.080 | 99.41 | 14.450 | 3.9990 | 57.786 | 0.080 | 99.74 | 14.40 | −0.003 |
| ### | May 8, 2012 | 11:07:21 AM | 14.40 | 3.999 | 6.5939 | 3.600 | 57.586 | 0.080 | 99.49 | 14.450 | 3.9990 | 57.786 | 0.080 | 99.82 | 14.40 | −0.001 |
| ### | May 8, 2012 | 11:07:26 AM | 14.40 | 3.999 | 6.5994 | 3.600 | 57.586 | 0.080 | 99.57 | 14.450 | 3.9990 | 57.786 | 0.080 | 99.90 | 14.40 | 0.001 |
| ### | May 8, 2012 | 11:07:31 AM | 14.40 | 3.999 | 6.6050 | 3.600 | 57.586 | 0.080 | 99.65 | 14.450 | 3.9990 | 57.786 | 0.080 | 99.99 | 14.40 | 0.002 |
| ### | May 8, 2012 | 11:07:36 AM | 14.40 | 3.999 | 6.6105 | 3.600 | 57.586 | 0.080 | 99.73 | 14.450 | 3.9990 | 57.786 | 0.080 | 100.07 | 14.40 | 0.004 |
| ### | May 8, 2012 | 11:07:41 AM | 14.40 | 3.999 | 6.6161 | 3.600 | 57.586 | 0.080 | 99.81 | 14.450 | 3.9990 | 57.786 | 0.080 | 100.15 | 14.40 | 0.005 |
| ### | May 8, 2012 | 11:07:46 AM | 14.39 | 3.999 | 6.6216 | 3.598 | 57.546 | 0.080 | 99.89 | 14.440 | 3.9990 | 57.746 | 0.080 | 100.23 | 14.39 | −0.005 |
| ### | May 8, 2012 | 11:07:51 AM | 14.39 | 3.999 | 6.6272 | 3.598 | 57.546 | 0.080 | 99.97 | 14.440 | 3.9990 | 57.746 | 0.080 | 100.31 | 14.39 | −0.004 |
| ### | May 8, 2012 | 11:07:56 AM | 14.39 | 3.999 | 6.6327 | 3.598 | 57.546 | 0.080 | 100.05 | 14.440 | 3.9990 | 57.746 | 0.080 | 100.39 | 14.39 | −0.003 |
| ### | May 8, 2012 | 11:08:01 AM | 14.39 | 3.999 | 6.6382 | 3.598 | 57.546 | 0.080 | 100.13 | 14.440 | 3.9990 | 57.746 | 0.080 | 100.47 | 14.39 | −0.002 |
| ### | May 8, 2012 | 11:08:06 AM | 14.39 | 3.999 | 6.6436 | 3.598 | 57.546 | 0.080 | 100.21 | 14.440 | 3.9990 | 57.746 | 0.080 | 100.55 | 14.39 | 0.000 |
| ### | May 8, 2012 | 11:08:11 AM | 14.39 | 3.999 | 6.6492 | 3.598 | 57.546 | 0.080 | 100.29 | 14.440 | 3.9990 | 57.746 | 0.080 | 100.63 | 14.39 | 0.002 |
| ### | May 8, 2012 | 11:08:16 AM | 14.39 | 3.999 | 6.6547 | 3.598 | 57.546 | 0.080 | 100.37 | 14.440 | 3.9990 | 57.746 | 0.080 | 100.71 | 14.39 | 0.003 |
| ### | May 8, 2012 | 11:08:21 AM | 14.39 | 3.999 | 6.6605 | 3.598 | 57.546 | 0.080 | 100.45 | 14.440 | 3.9990 | 57.746 | 0.080 | 100.79 | 14.39 | 0.004 |
| ### | May 8, 2012 | 11:08:26 AM | 14.39 | 3.999 | 6.6660 | 3.598 | 57.546 | 0.080 | 100.53 | 14.440 | 3.9990 | 57.746 | 0.080 | 100.87 | 14.39 | 0.005 |
| ### | May 8, 2012 | 11:08:31 AM | 14.38 | 3.999 | 6.6715 | 3.595 | 57.506 | 0.080 | 100.61 | 14.430 | 3.9990 | 57.706 | 0.080 | 100.95 | 14.38 | −0.005 |
| ### | May 8, 2012 | 11:08:36 AM | 14.38 | 3.999 | 6.6771 | 3.595 | 57.506 | 0.080 | 100.69 | 14.430 | 3.9990 | 57.706 | 0.080 | 101.03 | 14.38 | −0.004 |
| ### | May 8, 2012 | 11:08:41 AM | 14.38 | 3.999 | 6.6826 | 3.595 | 57.506 | 0.080 | 100.77 | 14.430 | 3.9990 | 57.706 | 0.080 | 101.11 | 14.38 | −0.003 |
| ### | May 8, 2012 | 11:08:46 AM | 14.38 | 3.999 | 6.6882 | 3.595 | 57.506 | 0.080 | 100.85 | 14.430 | 3.9990 | 57.706 | 0.080 | 101.19 | 14.38 | −0.002 |
| ### | May 8, 2012 | 11:08:51 AM | 14.38 | 3.999 | 6.6937 | 3.595 | 57.506 | 0.080 | 100.93 | 14.430 | 3.9990 | 57.706 | 0.080 | 101.27 | 14.38 | −0.001 |
| ### | May 8, 2012 | 11:08:56 AM | 14.38 | 3.999 | 6.6993 | 3.595 | 57.506 | 0.080 | 101.01 | 14.430 | 3.9990 | 57.706 | 0.080 | 101.35 | 14.38 | 0.001 |
| ### | May 8, 2012 | 11:09:01 AM | 14.38 | 3.999 | 6.7048 | 3.595 | 57.506 | 0.080 | 101.09 | 14.430 | 3.9990 | 57.706 | 0.080 | 104.43 | 14.38 | 0.002 |
| ### | May 8, 2012 | 11:09:06 AM | 14.38 | 3.999 | 6.7102 | 3.595 | 57.506 | 0.080 | 101.17 | 14.430 | 3.9990 | 57.706 | 0.080 | 101.51 | 14.38 | 0.003 |
| ### | May 8, 2012 | 11:09:11 AM | 14.38 | 3.999 | 6.7157 | 3.595 | 57.506 | 0.080 | 101.25 | 14.430 | 3.9990 | 57.706 | 0.080 | 101.59 | 14.38 | 0.004 |
| ### | May 8, 2012 | 11:09:16 AM | 14.38 | 3.999 | 6.7213 | 3.595 | 57.506 | 0.080 | 101.33 | 14.430 | 3.9990 | 57.706 | 0.080 | 101.67 | 14.38 | 0.005 |
| ### | May 8, 2012 | 11:09:21 AM | 14.37 | 3.999 | 6.7270 | 3.593 | 57.466 | 0.080 | 101.41 | 14.420 | 3.9990 | 57.666 | 0.080 | 101.75 | 14.37 | −0.005 |
| ### | May 8, 2012 | 11:09:26 AM | 14.37 | 3.999 | 6.7325 | 3.593 | 57.466 | 0.080 | 101.49 | 14.420 | 3.9990 | 57.666 | 0.080 | 101.83 | 14.37 | −0.003 |
| ### | May 8, 2012 | 11:09:31 AM | 14.37 | 3.999 | 6.7379 | 3.593 | 57.466 | 0.080 | 101.57 | 14.420 | 3.9990 | 57.666 | 0.080 | 101.91 | 14.37 | −0.001 |
| ### | May 8, 2012 | 11:09:36 AM | 14.37 | 3.999 | 6.7434 | 3.593 | 57.466 | 0.080 | 101.65 | 14.420 | 3.9990 | 57.666 | 0.080 | 101.99 | 14.37 | 0.001 |
| ### | May 8, 2012 | 11:09:41 AM | 14.37 | 3.999 | 6.7491 | 3.593 | 57.466 | 0.080 | 101.73 | 14.420 | 3.9990 | 57.666 | 0.080 | 102.07 | 14.37 | 0.003 |
| ### | May 8, 2012 | 11:09:46 AM | 14.37 | 3.999 | 6.7547 | 3.593 | 57.466 | 0.080 | 101.81 | 14.420 | 3.9990 | 57.666 | 0.080 | 102.15 | 14.37 | 0.005 |
| ### | May 8, 2012 | 11:09:51 AM | 14.36 | 3.999 | 6.7602 | 3.590 | 57.426 | 0.080 | 101.89 | 14.410 | 3.9990 | 57.626 | 0.080 | 102.23 | 14.36 | −0.005 |
| ### | May 8, 2012 | 11:09:56 AM | 14.36 | 3.999 | 6.7658 | 3.590 | 57.426 | 0.080 | 101.97 | 14.410 | 3.9990 | 57.626 | 0.080 | 102.31 | 14.36 | −0.004 |
| ### | May 8, 2012 | 11:10:01 AM | 14.36 | 3.999 | 6.7714 | 3.590 | 57.426 | 0.080 | 102.05 | 14.410 | 3.9990 | 57.626 | 0.080 | 102.39 | 14.36 | −0.003 |
| ### | May 8, 2012 | 11:10:06 AM | 14.36 | 3.999 | 6.7769 | 3.590 | 57.426 | 0.080 | 102.13 | 14.410 | 3.9990 | 57.626 | 0.080 | 102.47 | 14.36 | −0.002 |
| ### | May 8, 2012 | 11:10:11 AM | 14.36 | 3.999 | 6.7824 | 3.590 | 57.426 | 0.080 | 102.21 | 14.410 | 3.9990 | 57.626 | 0.080 | 102.55 | 14.36 | −0.001 |
| ### | May 8, 2012 | 11:10:16 AM | 14.36 | 3.999 | 6.7880 | 3.590 | 57.426 | 0.080 | 102.29 | 14.410 | 3.9990 | 57.626 | 0.080 | 102.63 | 14.36 | 0.000 |
| ### | May 8, 2012 | 11:10:21 AM | 14.36 | 3.999 | 6.7935 | 3.590 | 57.426 | 0.080 | 102.37 | 14.410 | 3.9990 | 57.626 | 0.080 | 102.71 | 14.36 | 0.000 |
| ### | May 8, 2012 | 11:10:26 AM | 14.36 | 3.999 | 6.7990 | 3.590 | 57.426 | 0.080 | 102.45 | 14.410 | 3.9990 | 57.626 | 0.080 | 102.79 | 14.36 | 0.000 |
| ### | May 8, 2012 | 11:10:31 AM | 14.36 | 3.999 | 6.8046 | 3.590 | 57.426 | 0.080 | 102.53 | 14.410 | 3.9990 | 57.626 | 0.080 | 102.87 | 14.36 | 0.000 |
| ### | May 8, 2012 | 11:10:36 AM | 14.36 | 3.999 | 6.8102 | 3.590 | 57.426 | 0.080 | 102.61 | 14.410 | 3.9990 | 57.626 | 0.080 | 102.95 | 14.36 | 0.001 |
| ### | May 8, 2012 | 11:10:41 AM | 14.36 | 3.999 | 6.8157 | 3.590 | 57.426 | 0.080 | 102.69 | 14.410 | 3.9990 | 57.626 | 0.080 | 103.03 | 14.36 | 0.001 |
| ### | May 8, 2012 | 11:10:46 AM | 14.36 | 3.999 | 6.8212 | 3.590 | 57.426 | 0.080 | 102.77 | 14.410 | 3.9990 | 57.626 | 0.080 | 103.11 | 14.36 | 0.002 |
| ### | May 8, 2012 | 11:10:51 AM | 14.36 | 3.999 | 6.8267 | 3.590 | 57.426 | 0.080 | 102.85 | 14.410 | 3.9990 | 57.626 | 0.080 | 103.19 | 14.36 | 0.003 |
| ### | May 8, 2012 | 11:10:56 AM | 14.36 | 3.999 | 6.8323 | 3.590 | 57.426 | 0.080 | 102.93 | 14.410 | 3.9990 | 57.626 | 0.080 | 103.27 | 14.36 | 0.004 |
| ### | May 8, 2012 | 11:11:01 AM | 14.35 | 3.999 | 6.8378 | 3.588 | 57.386 | 0.080 | 103.01 | 14.400 | 3.9990 | 57.586 | 0.080 | 103.35 | 14.36 | −0.005 |
| ### | May 8, 2012 | 11:11:06 AM | 14.36 | 3.999 | 6.8434 | 3.590 | 57.426 | 0.080 | 103.09 | 14.410 | 3.9990 | 57.626 | 0.080 | 103.43 | 14.35 | 0.005 |
| ### | May 8, 2012 | 11:11:11 AM | 14.35 | 3.999 | 6.8490 | 3.588 | 57.386 | 0.080 | 103.17 | 14.400 | 3.9990 | 57.586 | 0.080 | 103.51 | 14.35 | −0.004 |
| ### | May 8, 2012 | 11:11:16 AM | 14.35 | 3.999 | 6.8543 | 3.588 | 57.386 | 0.080 | 103.25 | 14.400 | 3.9990 | 57.586 | 0.080 | 103.59 | 14.35 | −0.003 |
| ### | May 8, 2012 | 11:11:21 AM | 14.35 | 3.999 | 6.8599 | 3.588 | 57.386 | 0.080 | 103.33 | 14.400 | 3.9990 | 57.586 | 0.080 | 103.67 | 14.35 | −0.002 |
| ### | May 8, 2012 | 11:11:26 AM | 14.35 | 3.999 | 6.8654 | 3.588 | 57.386 | 0.080 | 103.41 | 14.400 | 3.9990 | 57.586 | 0.080 | 103.75 | 14.35 | −0.001 |
| ### | May 8, 2012 | 11:11:31 AM | 14.35 | 3.999 | 6.8709 | 3.588 | 57.386 | 0.080 | 103.49 | 14.400 | 3.9990 | 57.586 | 0.080 | 103.83 | 14.35 | −0.001 |
| ### | May 8, 2012 | 11:11:36 AM | 14.35 | 3.999 | 6.8765 | 3.588 | 57.386 | 0.080 | 103.57 | 14.400 | 3.9990 | 57.586 | 0.080 | 103.91 | 14.35 | 0.001 |
| ### | May 8, 2012 | 11:11:41 AM | 14.35 | 3.999 | 6.8820 | 3.588 | 57.386 | 0.080 | 103.65 | 14.400 | 3.9990 | 57.586 | 0.080 | 103.99 | 14.35 | 0.002 |
| ### | May 8, 2012 | 11:11:46 AM | 14.35 | 3.999 | 6.8876 | 3.588 | 57.386 | 0.080 | 103.72 | 14.400 | 3.9990 | 57.586 | 0.080 | 104.07 | 14.35 | 0.003 |
| ### | May 8, 2012 | 11:11:51 AM | 14.35 | 3.999 | 6.8931 | 3.588 | 57.386 | 0.080 | 103.80 | 14.400 | 3.9990 | 57.586 | 0.080 | 104.15 | 14.35 | 0.004 |
| ### | May 8, 2012 | 11:11:56 AM | 14.35 | 3.999 | 6.8987 | 3.588 | 57.386 | 0.080 | 103.88 | 14.400 | 3.9990 | 57.586 | 0.080 | 104.23 | 14.35 | 0.005 |
| ### | May 8, 2012 | 11:12:01 AM | 14.34 | 3.999 | 6.9042 | 3.585 | 57.346 | 0.080 | 103.96 | 14.390 | 3.9990 | 57.546 | 0.080 | 104.31 | 14.34 | −0.005 |
| ### | May 8, 2012 | 11:12:06 AM | 14.34 | 3.999 | 6.9098 | 3.585 | 57.346 | 0.080 | 104.04 | 14.390 | 3.9990 | 57.546 | 0.080 | 104.39 | 14.34 | −0.004 |
| ### | May 8, 2012 | 11:12:11 AM | 14.34 | 3.999 | 6.9153 | 3.585 | 57.346 | 0.080 | 104.12 | 14.390 | 3.9990 | 57.546 | 0.080 | 104.47 | 14.34 | −0.003 |
| ### | May 8, 2012 | 11:12:16 AM | 14.34 | 3.999 | 6.9209 | 3.585 | 57.346 | 0.080 | 104.20 | 14.390 | 3.9990 | 57.546 | 0.080 | 104.55 | 14.34 | −0.002 |
| ### | May 8, 2012 | 11:12:21 AM | 14.34 | 3.999 | 6.9264 | 3.585 | 57.346 | 0.080 | 104.28 | 14.390 | 3.9990 | 57.546 | 0.080 | 104.63 | 14.34 | 0.000 |
| ### | May 8, 2012 | 11:12:26 AM | 14.34 | 3.999 | 6.9319 | 3.585 | 57.346 | 0.080 | 104.36 | 14.390 | 3.9990 | 57.546 | 0.080 | 104.71 | 14.34 | 0.002 |
| ### | May 8, 2012 | 11:12:31 AM | 14.34 | 3.999 | 6.9375 | 3.585 | 57.346 | 0.080 | 104.44 | 14.390 | 3.9990 | 57.546 | 0.080 | 104.79 | 14.34 | 0.003 |
| ### | May 8, 2012 | 11:12:36 AM | 14.34 | 3.999 | 6.9430 | 3.585 | 57.346 | 0.080 | 104.52 | 14.390 | 3.9990 | 57.546 | 0.080 | 104.87 | 14.34 | 0.004 |
| ### | May 8, 2012 | 11:12:41 AM | 14.34 | 3.999 | 6.9486 | 3.585 | 57.346 | 0.080 | 104.60 | 14.390 | 3.9990 | 57.546 | 0.080 | 104.95 | 14.34 | 0.005 |
| ### | May 8, 2012 | 11:12:46 AM | 14.33 | 3.999 | 6.9541 | 3.583 | 57.306 | 0.080 | 104.68 | 14.380 | 3.9990 | 57.506 | 0.080 | 105.03 | 14.33 | −0.005 |
| ### | May 8, 2012 | 11:12:51 AM | 14.33 | 3.999 | 6.9597 | 3.583 | 57.306 | 0.080 | 104.76 | 14.380 | 3.9990 | 57.506 | 0.080 | 105.11 | 14.33 | −0.004 |
| ### | May 8, 2012 | 11:12:56 AM | 14.33 | 3.999 | 6.9652 | 3.583 | 57.306 | 0.080 | 104.84 | 14.380 | 3.9990 | 57.506 | 0.080 | 105.19 | 14.33 | −0.003 |
| ### | May 8, 2012 | 11:13:01 AM | 14.33 | 3.999 | 6.9707 | 3.583 | 57.306 | 0.080 | 104.92 | 14.380 | 3.9990 | 57.506 | 0.080 | 105.27 | 14.33 | −0.002 |
| ### | May 8, 2012 | 11:13:06 AM | 14.33 | 3.999 | 6.9763 | 3.583 | 57.306 | 0.080 | 105.00 | 14.380 | 3.9990 | 57.506 | 0.080 | 105.35 | 14.33 | −0.001 |
| ### | May 8, 2012 | 11:13:11 AM | 14.33 | 3.999 | 6.9819 | 3.583 | 57.306 | 0.080 | 105.08 | 14.380 | 3.9990 | 57.506 | 0.080 | 105.43 | 14.33 | 0.000 |
| ### | May 8, 2012 | 11:13:16 AM | 14.33 | 3.999 | 6.9874 | 3.583 | 57.306 | 0.080 | 105.16 | 14.380 | 3.9990 | 57.506 | 0.080 | 105.51 | 14.33 | 0.000 |
| ### | May 8, 2012 | 11:13:21 AM | 14.33 | 3.999 | 6.9929 | 3.583 | 57.306 | 0.080 | 105.24 | 14.380 | 3.9990 | 57.506 | 0.080 | 105.59 | 14.33 | 0.001 |
| ### | May 8, 2012 | 11:13:26 AM | 14.33 | 3.999 | 6.9986 | 3.583 | 57.306 | 0.080 | 105.32 | 14.380 | 3.9990 | 57.506 | 0.080 | 105.67 | 14.33 | 0.002 |
| ### | May 8, 2012 | 11:13:31 AM | 14.33 | 3.999 | 7.0042 | 3.583 | 57.306 | 0.080 | 105.40 | 14.380 | 3.9990 | 57.506 | 0.080 | 105.75 | 14.33 | 0.003 |
| ### | May 8, 2012 | 11:13:36 AM | 14.33 | 3.999 | 7.0096 | 3.583 | 57.306 | 0.080 | 105.48 | 14.380 | 3.9990 | 57.506 | 0.080 | 105.83 | 14.33 | 0.004 |
| ### | May 8, 2012 | 11:13:41 AM | 14.33 | 3.999 | 7.0151 | 3.583 | 57.306 | 0.080 | 105.56 | 14.380 | 3.9990 | 57.506 | 0.080 | 105.91 | 14.33 | 0.005 |
| ### | May 8, 2012 | 11:13:46 AM | 14.32 | 3.999 | 7.0207 | 3.580 | 57.266 | 0.080 | 105.64 | 14.370 | 3.9990 | 57.466 | 0.080 | 105.99 | 14.32 | −0.005 |
| ### | May 8, 2012 | 11:13:51 AM | 14.32 | 3.999 | 7.0264 | 3.580 | 57.266 | 0.080 | 105.72 | 14.370 | 3.9990 | 57.466 | 0.080 | 106.07 | 14.32 | −0.004 |
| ### | May 8, 2012 | 11:13:56 AM | 14.32 | 3.999 | 7.0319 | 3.580 | 57.266 | 0.080 | 105.79 | 14.370 | 3.9990 | 57.466 | 0.080 | 106.15 | 14.32 | −0.003 |
| ### | May 8, 2012 | 11:14:01 AM | 14.32 | 3.999 | 7.0375 | 3.580 | 57.266 | 0.080 | 105.87 | 14.370 | 3.9990 | 57.466 | 0.080 | 106.23 | 14.32 | −0.002 |
| ### | May 8, 2012 | 11:14:06 AM | 14.32 | 3.999 | 7.0430 | 3.580 | 57.266 | 0.080 | 105.95 | 14.370 | 3.9990 | 57.466 | 0.080 | 106.31 | 14.32 | 0.000 |
| ### | May 8, 2012 | 11:14:11 AM | 14.32 | 3.999 | 7.0485 | 3.580 | 57.266 | 0.080 | 106.03 | 14.370 | 3.9990 | 57.466 | 0.080 | 106.39 | 14.32 | 0.002 |
| ### | May 8, 2012 | 11:14:16 AM | 14.32 | 3.999 | 7.0539 | 3.580 | 57.266 | 0.080 | 106.11 | 14.370 | 3.9990 | 57.466 | 0.080 | 106.47 | 14.32 | 0.003 |
| ### | May 8, 2012 | 11:14:21 AM | 14.32 | 3.999 | 7.0595 | 3.580 | 57.266 | 0.080 | 106.19 | 14.370 | 3.9990 | 57.466 | 0.080 | 106.55 | 14.32 | 0.004 |
| ### | May 8, 2012 | 11:14:26 AM | 14.32 | 3.999 | 7.0650 | 3.580 | 57.266 | 0.080 | 106.27 | 14.370 | 3.9990 | 57.466 | 0.080 | 106.63 | 14.32 | 0.005 |
| ### | May 8, 2012 | 11:14:31 AM | 14.31 | 3.999 | 7.0705 | 3.578 | 57.226 | 0.079 | 106.35 | 14.360 | 3.9990 | 57.426 | 0.080 | 106.71 | 14.31 | −0.005 |
| ### | May 8, 2012 | 11:14:36 AM | 14.31 | 3.999 | 7.0761 | 3.578 | 57.226 | 0.079 | 106.43 | 14.360 | 3.9990 | 57.426 | 0.080 | 106.79 | 14.31 | −0.004 |
| ### | May 8, 2012 | 11:14:41 AM | 14.31 | 3.999 | 7.0816 | 3.578 | 57.226 | 0.079 | 106.51 | 14.360 | 3.9990 | 57.426 | 0.080 | 106.87 | 14.31 | −0.003 |
| ### | May 8, 2012 | 11:14:46 AM | 14.31 | 3.999 | 7.0872 | 3.578 | 57.226 | 0.079 | 106.59 | 14.360 | 3.9990 | 57.426 | 0.080 | 106.94 | 14.31 | −0.002 |
| ### | May 8, 2012 | 11:14:51 AM | 14.31 | 3.999 | 7.0927 | 3.578 | 57.226 | 0.079 | 106.67 | 14.360 | 3.9990 | 57.426 | 0.080 | 107.02 | 14.31 | −0.001 |
| ### | May 8, 2012 | 11:14:56 AM | 14.31 | 3.999 | 7.0983 | 3.578 | 57.226 | 0.079 | 106.75 | 14.360 | 3.9990 | 57.426 | 0.080 | 107.10 | 14.31 | 0.000 |
| ### | May 8, 2012 | 11:15:01 AM | 14.31 | 3.999 | 7.1038 | 3.578 | 57.226 | 0.079 | 106.83 | 14.360 | 3.9990 | 57.426 | 0.080 | 107.18 | 14.31 | 0.000 |
| ### | May 8, 2012 | 11:15:06 AM | 14.31 | 3.999 | 7.1094 | 3.578 | 57.226 | 0.079 | 106.91 | 14.360 | 3.9990 | 57.426 | 0.080 | 107.26 | 14.31 | 0.000 |
| ### | May 8, 2012 | 11:15:11 AM | 14.31 | 3.999 | 7.1149 | 3.578 | 57.226 | 0.079 | 106.99 | 14.360 | 3.9990 | 57.426 | 0.080 | 107.34 | 14.31 | 0.000 |
| ### | May 8, 2012 | 11:15:16 AM | 14.31 | 3.999 | 7.1205 | 3.578 | 57.226 | 0.079 | 107.07 | 14.360 | 3.9990 | 57.426 | 0.080 | 107.42 | 14.31 | 0.001 |
| ### | May 8, 2012 | 11:15:21 AM | 14.31 | 3.999 | 7.1260 | 3.578 | 57.226 | 0.079 | 107.15 | 14.360 | 3.9990 | 57.426 | 0.080 | 107.50 | 14.31 | 0.002 |
| ### | May 8, 2012 | 11:15:26 AM | 14.31 | 3.999 | 7.1316 | 3.578 | 57.226 | 0.079 | 107.23 | 14.360 | 3.9990 | 57.426 | 0.080 | 107.58 | 14.31 | 0.003 |
| ### | May 8, 2012 | 11:15:31 AM | 14.31 | 3.999 | 7.1371 | 3.578 | 57.226 | 0.079 | 107.31 | 14.360 | 3.9990 | 57.426 | 0.080 | 107.66 | 14.31 | 0.004 |
| ### | May 8, 2012 | 11:15:36 AM | 14.31 | 3.999 | 7.1427 | 3.578 | 57.226 | 0.079 | 107.38 | 14.360 | 3.9990 | 57.426 | 0.080 | 107.74 | 14.31 | 0.005 |
| ### | May 8, 2012 | 11:15:41 AM | 14.30 | 3.999 | 7.1482 | 3.575 | 57.186 | 0.079 | 107.46 | 14.350 | 3.9990 | 57.386 | 0.080 | 107.82 | 14.30 | −0.005 |
| ### | May 8, 2012 | 11:15:46 AM | 14.30 | 3.999 | 7.1537 | 3.575 | 57.186 | 0.079 | 107.54 | 14.350 | 3.9990 | 57.386 | 0.080 | 107.90 | 14.30 | −0.004 |
| ### | May 8, 2012 | 11:15:51 AM | 14.30 | 3.999 | 7.1593 | 3.575 | 57.186 | 0.079 | 107.62 | 14.350 | 3.9990 | 57.386 | 0.080 | 107.98 | 14.30 | −0.003 |
| ### | May 8, 2012 | 11:15:56 AM | 14.30 | 3.999 | 7.1648 | 3.575 | 57.186 | 0.079 | 107.70 | 14.350 | 3.9990 | 57.386 | 0.080 | 108.06 | 14.30 | −0.002 |
| ### | May 8, 2012 | 11:16:01 AM | 14.30 | 3.999 | 7.1704 | 3.575 | 57.186 | 0.079 | 107.78 | 14.350 | 3.9990 | 57.386 | 0.080 | 108.14 | 14.30 | −0.001 |
| ### | May 8, 2012 | 11:16:06 AM | 14.30 | 3.999 | 7.1759 | 3.575 | 57.186 | 0.079 | 107.86 | 14.350 | 3.9990 | 57.386 | 0.080 | 108.22 | 14.30 | 0.000 |
| ### | May 8, 2012 | 11:16:11 AM | 14.30 | 3.999 | 7.1815 | 3.575 | 57.186 | 0.079 | 107.94 | 14.350 | 3.9990 | 57.386 | 0.080 | 108.30 | 14.30 | 0.000 |
| ### | May 8, 2012 | 11:16:16 AM | 14.30 | 3.999 | 7.1870 | 3.575 | 57.186 | 0.079 | 108.02 | 14.350 | 3.9990 | 57.386 | 0.080 | 108.38 | 14.30 | 0.001 |
| ### | May 8, 2012 | 11:16:21 AM | 14.30 | 3.999 | 7.1927 | 3.575 | 57.186 | 0.079 | 108.10 | 14.350 | 3.9990 | 57.386 | 0.080 | 108.46 | 14.30 | 0.002 |
| ### | May 8, 2012 | 11:16:26 AM | 14.30 | 3.999 | 7.1983 | 3.575 | 57.186 | 0.079 | 108.18 | 14.350 | 3.9990 | 57.386 | 0.080 | 108.54 | 14.30 | 0.003 |
| ### | May 8, 2012 | 11:16:31 AM | 14.30 | 3.999 | 7.2038 | 3.575 | 57.186 | 0.079 | 108.26 | 14.350 | 3.9990 | 57.386 | 0.080 | 108.62 | 14.30 | 0.004 |
| ### | May 8, 2012 | 11:16:36 AM | 14.30 | 3.999 | 7.2093 | 3.575 | 57.186 | 0.079 | 108.34 | 14.350 | 3.9990 | 57.386 | 0.080 | 108.70 | 14.30 | 0.005 |
| ### | May 8, 2012 | 11:16:41 AM | 14.29 | 3.999 | 7.2147 | 3.573 | 57.146 | 0.079 | 108.42 | 14.340 | 3.9990 | 57.346 | 0.080 | 108.78 | 14.29 | −0.005 |
| ### | May 8, 2012 | 11:16:46 AM | 14.29 | 3.999 | 7.2203 | 3.573 | 57.146 | 0.079 | 108.50 | 14.340 | 3.9990 | 57.346 | 0.080 | 108.86 | 14.29 | −0.004 |
| ### | May 8, 2012 | 11:16:51 AM | 14.29 | 3.999 | 7.2258 | 3.573 | 57.146 | 0.079 | 108.58 | 14.340 | 3.9990 | 57.346 | 0.080 | 108.94 | 14.29 | −0.003 |
| ### | May 8, 2012 | 11:16:56 AM | 14.29 | 3.999 | 7.2314 | 3.573 | 57.146 | 0.079 | 108.66 | 14.340 | 3.9990 | 57.346 | 0.080 | 109.02 | 14.29 | −0.002 |
| ### | May 8, 2012 | 11:17:01 AM | 14.29 | 3.999 | 7.2369 | 3.573 | 57.146 | 0.079 | 108.73 | 14.340 | 3.9990 | 57.346 | 0.080 | 109.10 | 14.29 | −0.001 |
| ### | May 8, 2012 | 11:17:06 AM | 14.29 | 3.999 | 7.2425 | 3.573 | 57.146 | 0.079 | 108.81 | 14.340 | 3.9990 | 57.346 | 0.080 | 109.18 | 14.29 | 0.001 |
| ### | May 8, 2012 | 11:17:11 AM | 14.29 | 3.999 | 7.2480 | 3.573 | 57.146 | 0.079 | 108.89 | 14.340 | 3.9990 | 57.346 | 0.080 | 109.26 | 14.29 | 0.002 |
| ### | May 8, 2012 | 11:17:16 AM | 14.29 | 3.999 | 7.2536 | 3.573 | 57.146 | 0.079 | 108.97 | 14.340 | 3.9990 | 57.346 | 0.080 | 109.34 | 14.29 | 0.003 |
| ### | May 8, 2012 | 11:17:21 AM | 14.29 | 3.999 | 7.2591 | 3.573 | 57.146 | 0.079 | 109.05 | 14.340 | 3.9990 | 57.346 | 0.080 | 109.42 | 14.29 | 0.004 |
| ### | May 8, 2012 | 11:17:26 AM | 14.29 | 3.999 | 7.2647 | 3.573 | 57.146 | 0.079 | 109.13 | 14.340 | 3.9990 | 57.346 | 0.080 | 109.50 | 14.29 | 0.005 |
| ### | May 8, 2012 | 11:17:31 AM | 14.28 | 3.999 | 7.2702 | 3.570 | 57.106 | 0.079 | 109.21 | 14.330 | 3.9990 | 57.306 | 0.080 | 109.57 | 14.28 | −0.005 |
| ### | May 8, 2012 | 11:17:36 AM | 14.28 | 3.999 | 7.2757 | 3.570 | 57.106 | 0.079 | 109.29 | 14.330 | 3.9990 | 57.306 | 0.080 | 109.65 | 14.28 | −0.004 |
| ### | May 8, 2012 | 11:17:41 AM | 14.28 | 3.999 | 7.2813 | 3.570 | 57.106 | 0.079 | 109.37 | 14.330 | 3.9990 | 57.306 | 0.080 | 109.73 | 14.28 | −0.002 |
| ### | May 8, 2012 | 11:17:46 AM | 14.28 | 3.999 | 7.2868 | 3.570 | 57.106 | 0.079 | 109.45 | 14.330 | 3.9990 | 57.306 | 0.080 | 109.81 | 14.28 | 0.000 |
| ### | May 8, 2012 | 11:17:51 AM | 14.28 | 3.999 | 7.2924 | 3.570 | 57.106 | 0.079 | 109.53 | 14.330 | 3.9990 | 57.306 | 0.080 | 109.89 | 14.28 | 0.002 |
| ### | May 8, 2012 | 11:17:56 AM | 14.28 | 3.999 | 7.2979 | 3.570 | 57.106 | 0.079 | 109.61 | 14.330 | 3.9990 | 57.306 | 0.080 | 109.97 | 14.28 | 0.004 |
| ### | May 8, 2012 | 11:18:01 AM | 14.28 | 3.999 | 7.3035 | 3.570 | 57.106 | 0.079 | 109.69 | 14.330 | 3.9990 | 57.306 | 0.080 | 110.05 | 14.28 | 0.005 |
| ### | May 8, 2012 | 11:18:06 AM | 14.27 | 3.999 | 7.3090 | 3.568 | 57.066 | 0.079 | 109.77 | 14.320 | 3.9990 | 57.266 | 0.080 | 110.13 | 14.27 | −0.005 |
| ### | May 8, 2012 | 11:18:11 AM | 14.27 | 3.999 | 7.3146 | 3.568 | 57.066 | 0.079 | 109.85 | 14.320 | 3.9990 | 57.266 | 0.080 | 110.21 | 14.27 | −0.004 |
| ### | May 8, 2012 | 11:18:16 AM | 14.27 | 3.999 | 7.3201 | 3.568 | 57.066 | 0.079 | 109.92 | 14.320 | 3.9990 | 57.266 | 0.080 | 110.29 | 14.27 | −0.002 |
| ### | May 8, 2012 | 11:18:21 AM | 14.27 | 3.999 | 7.3256 | 3.568 | 57.066 | 0.079 | 110.00 | 14.320 | 3.9990 | 57.266 | 0.080 | 110.37 | 14.27 | 0.000 |
| ### | May 8, 2012 | 11:18:26 AM | 14.27 | 3.999 | 7.3312 | 3.568 | 57.066 | 0.079 | 110.08 | 14.320 | 3.9990 | 57.266 | 0.080 | 110.45 | 14.27 | 0.002 |
| ### | May 8, 2012 | 11:18:31 AM | 14.27 | 3.999 | 7.3368 | 3.568 | 57.066 | 0.079 | 110.16 | 14.320 | 3.9990 | 57.266 | 0.080 | 110.53 | 14.27 | 0.004 |
| ### | May 8, 2012 | 11:18:36 AM | 14.27 | 3.999 | 7.3423 | 3.568 | 57.066 | 0.079 | 110.24 | 14.320 | 3.9990 | 57.266 | 0.080 | 110.61 | 14.27 | 0.005 |
| ### | May 8, 2012 | 11:18:41 AM | 14.26 | 4.000 | 7.3478 | 3.565 | 57.040 | 0.079 | 110.32 | 14.310 | 4.0000 | 57.240 | 0.080 | 110.69 | 14.26 | −0.005 |
| ### | May 8, 2012 | 11:18:46 AM | 14.26 | 3.999 | 7.3534 | 3.565 | 57.026 | 0.079 | 110.40 | 14.310 | 3.9990 | 57.226 | 0.079 | 110.77 | 14.26 | −0.004 |
| ### | May 8, 2012 | 11:18:51 AM | 14.26 | 3.999 | 7.3589 | 3.565 | 57.026 | 0.079 | 110.48 | 14.310 | 3.9990 | 57.226 | 0.079 | 110.85 | 14.26 | −0.003 |
| ### | May 8, 2012 | 11:18:56 AM | 14.26 | 3.999 | 7.3645 | 3.565 | 57.026 | 0.079 | 110.56 | 14.310 | 3.9990 | 57.226 | 0.079 | 110.93 | 14.26 | −0.001 |
| ### | May 8, 2012 | 11:19:01 AM | 14.26 | 3.999 | 7.3700 | 3.565 | 57.026 | 0.079 | 110.64 | 14.310 | 3.9990 | 57.226 | 0.079 | 111.01 | 14.26 | 0.001 |
| ### | May 8, 2012 | 11:19:06 AM | 14.26 | 3.999 | 7.3756 | 3.565 | 57.026 | 0.079 | 110.72 | 14.310 | 3.9990 | 57.226 | 0.079 | 111.09 | 14.26 | 0.003 |
| ### | May 8, 2012 | 11:19:11 AM | 14.26 | 3.999 | 7.3811 | 3.565 | 57.026 | 0.079 | 110.80 | 14.310 | 3.9990 | 57.226 | 0.079 | 111.17 | 14.26 | 0.004 |
| ### | May 8, 2012 | 11:19:16 AM | 14.26 | 4.000 | 7.3866 | 3.565 | 56.040 | 0.079 | 110.88 | 14.310 | 4.0000 | 57.240 | 0.080 | 111.25 | 14.26 | 0.005 |
| ### | May 8, 2012 | 11:19:21 AM | 14.25 | 3.999 | 7.3922 | 3.563 | 56.986 | 0.079 | 110.95 | 14.300 | 3.9990 | 57.186 | 0.079 | 111.32 | 14.25 | −0.005 |
| ### | May 8, 2012 | 11:19:26 AM | 14.25 | 3.999 | 7.3977 | 3.563 | 56.986 | 0.079 | 111.03 | 14.300 | 3.9990 | 57.186 | 0.079 | 111.40 | 14.25 | −0.004 |
| ### | May 8, 2012 | 11:19:31 AM | 14.25 | 3.999 | 7.4033 | 3.563 | 56.986 | 0.079 | 111.11 | 14.300 | 3.9990 | 57.186 | 0.079 | 111.48 | 14.25 | −0.003 |
| ### | May 8, 2012 | 11:19:36 AM | 14.25 | 3.999 | 7.4088 | 3.563 | 56.986 | 0.079 | 111.19 | 14.300 | 3.9990 | 57.186 | 0.079 | 111.56 | 14.25 | −0.002 |
| ### | May 8, 2012 | 11:19:41 AM | 14.25 | 3.999 | 7.4144 | 3.563 | 56.986 | 0.079 | 111.27 | 14.300 | 3.9990 | 57.186 | 0.079 | 111.64 | 14.25 | −0.001 |
| ### | May 8, 2012 | 11:19:46 AM | 14.25 | 3.999 | 7.4199 | 3.563 | 56.986 | 0.079 | 111.35 | 14.300 | 3.9990 | 57.186 | 0.079 | 111.72 | 14.25 | 0.000 |
| ### | May 8, 2012 | 11:19:51 AM | 14.25 | 3.999 | 7.4255 | 3.563 | 56.986 | 0.079 | 111.43 | 14.300 | 3.9990 | 57.186 | 0.079 | 111.80 | 14.25 | 0.000 |
| ### | May 8, 2012 | 11:19:56 AM | 14.25 | 3.999 | 7.4310 | 3.563 | 56.986 | 0.079 | 111.51 | 14.300 | 3.9990 | 57.186 | 0.079 | 111.88 | 14.25 | 0.000 |
| ### | May 8, 2012 | 11:20:01 AM | 14.25 | 3.999 | 7.4365 | 3.563 | 56.986 | 0.079 | 111.59 | 14.300 | 3.9990 | 57.186 | 0.079 | 111.96 | 14.25 | 0.001 |
| ### | May 8, 2012 | 11:20:06 AM | 14.25 | 3.999 | 7.4421 | 3.563 | 56.986 | 0.079 | 111.67 | 14.300 | 3.9990 | 57.186 | 0.079 | 112.04 | 14.25 | 0.002 |
| ### | May 8, 2012 | 11:20:11 AM | 14.25 | 3.999 | 7.4476 | 3.563 | 56.986 | 0.079 | 111.75 | 14.300 | 3.9990 | 57.186 | 0.079 | 112.12 | 14.25 | 0.003 |
| ### | May 8, 2012 | 11:20:16 AM | 14.25 | 3.999 | 7.4532 | 3.563 | 56.986 | 0.079 | 111.82 | 14.300 | 3.9990 | 57.186 | 0.079 | 112.20 | 14.25 | 0.004 |
| ### | May 8, 2012 | 11:20:21 AM | 14.25 | 3.999 | 7.4587 | 3.563 | 56.986 | 0.079 | 111.90 | 14.300 | 3.9990 | 57.186 | 0.079 | 112.28 | 14.25 | 0.005 |
| ### | May 8, 2012 | 11:20:26 AM | 14.24 | 3.999 | 7.4643 | 3.560 | 56.946 | 0.079 | 111.98 | 14.290 | 3.9990 | 57.146 | 0.079 | 112.36 | 14.24 | −0.005 |
| ### | May 8, 2012 | 11:20:31 AM | 14.24 | 3.999 | 7.4700 | 3.560 | 56.946 | 0.079 | 112.06 | 14.290 | 3.9990 | 57.146 | 0.079 | 112.44 | 14.24 | −0.004 |
| ### | May 8, 2012 | 11:20:36 AM | 14.24 | 3.999 | 7.4754 | 3.560 | 56.946 | 0.079 | 112.14 | 14.290 | 3.9990 | 57.146 | 0.079 | 112.52 | 14.24 | −0.003 |
| ### | May 8, 2012 | 11:20:41 AM | 14.24 | 3.999 | 7.4809 | 3.560 | 56.946 | 0.079 | 112.22 | 14.290 | 3.9990 | 57.146 | 0.079 | 112.60 | 14.24 | −0.002 |
| ### | May 8, 2012 | 11:20:46 AM | 14.24 | 3.999 | 7.4865 | 3.560 | 56.946 | 0.079 | 112.30 | 14.290 | 3.9990 | 57.146 | 0.079 | 112.67 | 14.24 | 0.000 |
| ### | May 8, 2012 | 11:20:51 AM | 14.24 | 3.999 | 7.4920 | 3.560 | 56.946 | 0.079 | 112.38 | 14.290 | 3.9990 | 57.146 | 0.079 | 112.75 | 14.24 | 0.002 |
| ### | May 8, 2012 | 11:20:56 AM | 14.24 | 3.999 | 7.4976 | 3.560 | 56.946 | 0.079 | 112.46 | 14.290 | 3.9990 | 57.146 | 0.079 | 112.83 | 14.24 | 0.003 |
| ### | May 8, 2012 | 11:21:01 AM | 14.24 | 3.999 | 7.5031 | 3.560 | 56.946 | 0.079 | 112.54 | 14.290 | 3.9990 | 57.146 | 0.079 | 112.91 | 14.24 | 0.004 |
| ### | May 8, 2012 | 11:21:06 AM | 14.24 | 3.999 | 7.5087 | 3.560 | 56.946 | 0.079 | 112.62 | 14.290 | 3.9990 | 57.146 | 0.079 | 112.99 | 14.24 | 0.005 |
| ### | May 8, 2012 | 11:21:11 AM | 14.23 | 3.999 | 7.5142 | 3.558 | 56.946 | 0.079 | 112.69 | 14.280 | 3.9990 | 57.106 | 0.079 | 113.07 | 14.23 | −0.005 |
| ### | May 8, 2012 | 11:21:16 AM | 14.23 | 3.999 | 7.5197 | 3.558 | 56.946 | 0.079 | 112.77 | 14.280 | 3.9990 | 57.106 | 0.079 | 113.15 | 14.23 | −0.004 |
| ### | May 8, 2012 | 11:21:21 AM | 14.23 | 3.999 | 7.5253 | 3.558 | 56.946 | 0.079 | 112.85 | 14.280 | 3.9990 | 57.106 | 0.079 | 113.23 | 14.23 | −0.003 |
| ### | May 8, 2012 | 11:21:26 AM | 14.23 | 3.999 | 7.5308 | 3.558 | 56.946 | 0.079 | 112.93 | 14.280 | 3.9990 | 57.106 | 0.079 | 113.31 | 14.23 | −0.002 |
| ### | May 8, 2012 | 11:21:31 AM | 14.23 | 3.999 | 7.5364 | 3.558 | 56.946 | 0.079 | 113.01 | 14.280 | 3.9990 | 57.106 | 0.079 | 113.39 | 14.23 | 0.000 |
| ### | May 8, 2012 | 11:21:36 AM | 14.23 | 3.999 | 7.5419 | 3.558 | 56.946 | 0.079 | 113.09 | 14.280 | 3.9990 | 57.106 | 0.079 | 113.47 | 14.23 | 0.002 |
| ### | May 8, 2012 | 11:21:41 AM | 14.23 | 3.999 | 7.5475 | 3.558 | 56.906 | 0.079 | 113.17 | 14.280 | 3.9990 | 57.106 | 0.079 | 113.55 | 14.23 | 0.003 |
| ### | May 8, 2012 | 11:21:46 AM | 14.23 | 3.999 | 7.5530 | 3.558 | 56.906 | 0.079 | 113.25 | 14.280 | 3.9990 | 57.106 | 0.079 | 113.63 | 14.23 | 0.004 |
| ### | May 8, 2012 | 11:21:51 AM | 14.23 | 3.999 | 7.5585 | 3.558 | 56.906 | 0.079 | 113.33 | 14.280 | 3.9990 | 57.106 | 0.079 | 113.71 | 14.23 | 0.005 |
| ### | May 8, 2012 | 11:21:56 AM | 14.22 | 4.000 | 7.5641 | 3.555 | 56.880 | 0.079 | 113.41 | 14.270 | 4.0000 | 57.080 | 0.079 | 113.79 | 14.22 | −0.005 |
| ### | May 8, 2012 | 11:22:01 AM | 14.22 | 3.999 | 7.5696 | 3.555 | 56.866 | 0.079 | 113.49 | 14.270 | 3.9990 | 57.066 | 0.079 | 113.86 | 14.22 | −0.004 |
| ### | May 8, 2012 | 11:22:06 AM | 14.22 | 3.999 | 7.5752 | 3.555 | 56.866 | 0.079 | 113.56 | 14.270 | 3.9990 | 57.066 | 0.079 | 113.94 | 14.22 | −0.003 |
| ### | May 8, 2012 | 11:22:11 AM | 14.22 | 3.999 | 7.5807 | 3.555 | 56.866 | 0.079 | 113.64 | 14.270 | 3.9990 | 57.066 | 0.079 | 114.02 | 14.22 | −0.002 |
| ### | May 8, 2012 | 11:22:16 AM | 14.22 | 3.999 | 7.5863 | 3.555 | 56.866 | 0.079 | 113.72 | 14.270 | 3.9990 | 57.066 | 0.079 | 114.10 | 14.22 | −0.001 |
| ### | May 8, 2012 | 11:22:21 AM | 14.22 | 3.999 | 7.5918 | 3.555 | 56.866 | 0.079 | 113.80 | 14.270 | 3.9990 | 57.066 | 0.079 | 114.18 | 14.22 | 0.000 |
| ### | May 8, 2012 | 11:22:26 AM | 14.22 | 3.999 | 7.5974 | 3.555 | 56.866 | 0.079 | 113.88 | 14.270 | 3.9990 | 57.066 | 0.079 | 114.26 | 14.22 | 0.000 |
| ### | May 8, 2012 | 11:22:31 AM | 14.22 | 3.999 | 7.6031 | 3.555 | 56.866 | 0.079 | 113.96 | 14.270 | 3.9990 | 57.066 | 0.079 | 114.34 | 14.22 | 0.001 |
| ### | May 8, 2012 | 11:22:36 AM | 14.22 | 3.999 | 7.6085 | 3.555 | 56.866 | 0.079 | 114.04 | 14.270 | 3.9990 | 57.066 | 0.079 | 114.42 | 14.22 | 0.002 |
| ### | May 8, 2012 | 11:22:41 AM | 14.22 | 4.000 | 7.6140 | 3.555 | 56.880 | 0.079 | 114.12 | 14.270 | 4.0000 | 57.080 | 0.079 | 114.50 | 14.22 | 0.003 |
| ### | May 8, 2012 | 11:22:46 AM | 14.22 | 3.999 | 7.6195 | 3.555 | 56.866 | 0.079 | 114.20 | 14.270 | 3.9990 | 57.066 | 0.079 | 114.58 | 14.22 | 0.004 |
| ### | May 8, 2012 | 11:22:51 AM | 14.22 | 3.999 | 7.6251 | 3.555 | 56.866 | 0.079 | 114.28 | 14.270 | 3.9990 | 57.066 | 0.079 | 114.66 | 14.22 | 0.005 |
| ### | May 8, 2012 | 11:22:56 AM | 14.21 | 3.999 | 7.6306 | 3.553 | 56.826 | 0.079 | 114.35 | 14.260 | 3.9990 | 57.026 | 0.079 | 114.74 | 14.21 | −0.005 |
| ### | May 8, 2012 | 11:23:01 AM | 14.21 | 3.999 | 7.6362 | 3.553 | 56.826 | 0.079 | 114.43 | 14.260 | 3.9990 | 57.026 | 0.079 | 114.82 | 14.21 | −0.004 |
| ### | May 8, 2012 | 11:23:06 AM | 14.21 | 4.000 | 7.6417 | 3.553 | 56.840 | 0.079 | 114.51 | 14.260 | 4.0000 | 57.040 | 0.079 | 114.89 | 14.21 | −0.003 |
| ### | May 8, 2012 | 11:23:11 AM | 14.21 | 3.999 | 7.6473 | 3.553 | 56.826 | 0.079 | 114.59 | 14.260 | 3.9990 | 57.026 | 0.079 | 114.97 | 14.21 | −0.001 |
| ### | May 8, 2012 | 11:23:16 AM | 14.21 | 3.999 | 7.6528 | 3.553 | 56.826 | 0.079 | 114.67 | 14.260 | 3.9990 | 57.026 | 0.079 | 115.05 | 14.21 | 0.001 |
| ### | May 8, 2012 | 11:23:21 AM | 14.21 | 3.999 | 7.6584 | 3.553 | 56.826 | 0.079 | 114.57 | 14.260 | 3.9990 | 57.026 | 0.079 | 115.13 | 14.21 | 0.003 |
| ### | May 8, 2012 | 11:23:26 AM | 14.21 | 3.999 | 7.6639 | 3.553 | 56.826 | 0.079 | 114.83 | 14.260 | 3.9990 | 57.026 | 0.079 | 115.21 | 14.21 | 0.004 |
| ### | May 8, 2012 | 11:23:31 AM | 14.21 | 3.999 | 7.6695 | 3.553 | 56.826 | 0.079 | 114.91 | 14.260 | 3.9990 | 57.026 | 0.079 | 115.29 | 14.21 | 0.005 |
| ### | May 8, 2012 | 11:23:36 AM | 14.20 | 3.999 | 7.6750 | 3.550 | 56.786 | 0.079 | 114.99 | 14.250 | 3.9990 | 56.986 | 0.079 | 115.37 | 14.20 | −0.005 |
| ### | May 8, 2012 | 11:23:41 AM | 14.20 | 4.000 | 7.6806 | 3.550 | 56.800 | 0.079 | 115.06 | 14.250 | 4.0000 | 57.000 | 0.079 | 115.45 | 14.20 | −0.004 |
| ### | May 8, 2012 | 11:23:46 AM | 14.20 | 3.999 | 7.6861 | 3.550 | 56.786 | 0.079 | 115.14 | 14.250 | 3.9990 | 56.986 | 0.079 | 115.53 | 14.20 | −0.003 |
| ### | May 8, 2012 | 11:23:51 AM | 14.20 | 3.999 | 7.6916 | 3.550 | 56.786 | 0.079 | 115.22 | 14.250 | 3.9990 | 56.986 | 0.079 | 115.61 | 14.20 | −0.002 |
| ### | May 8, 2012 | 11:23:56 AM | 14.20 | 3.999 | 7.6972 | 3.550 | 56.786 | 0.079 | 115.30 | 14.250 | 3.9990 | 56.986 | 0.079 | 115.69 | 14.20 | −0.001 |
| ### | May 8, 2012 | 11:24:01 AM | 14.20 | 4.000 | 7.7027 | 3.550 | 56.800 | 0.079 | 115.38 | 14.250 | 4.0000 | 57.000 | 0.079 | 115.77 | 14.20 | 0.000 |
| ### | May 8, 2012 | 11:24:06 AM | 14.20 | 3.999 | 7.7083 | 3.550 | 56.786 | 0.079 | 115.46 | 14.250 | 3.9990 | 56.986 | 0.079 | 115.84 | 14.20 | 0.001 |
| ### | May 8, 2012 | 11:24:11 AM | 14.20 | 3.999 | 7.7138 | 3.550 | 56.786 | 0.079 | 115.54 | 14.250 | 3.9990 | 56.986 | 0.079 | 115.92 | 14.20 | 0.002 |
| ### | May 8, 2012 | 11:24:16 AM | 14.20 | 3.999 | 7.7194 | 3.550 | 56.786 | 0.079 | 115.62 | 14.250 | 3.9990 | 56.986 | 0.079 | 116.00 | 14.20 | 0.003 |
| ### | May 8, 2012 | 11:24:21 AM | 14.20 | 3.999 | 7.7249 | 3.550 | 56.786 | 0.079 | 115.70 | 14.250 | 3.9990 | 56.986 | 0.079 | 116.08 | 14.20 | 0.004 |
| ### | May 8, 2012 | 11:24:26 AM | 14.20 | 3.999 | 7.7305 | 3.550 | 56.786 | 0.079 | 115.77 | 14.250 | 3.9990 | 56.986 | 0.079 | 116.16 | 14.20 | 0.005 |
| ### | May 8, 2012 | 11:24:31 AM | 14.19 | 3.999 | 7.7360 | 3.548 | 56.746 | 0.079 | 115.85 | 14.240 | 3.9990 | 56.946 | 0.079 | 116.24 | 14.19 | −0.005 |
| ### | May 8, 2012 | 11:24:36 AM | 14.19 | 3.999 | 7.7416 | 3.548 | 56.746 | 0.079 | 115.93 | 14.240 | 3.9990 | 56.946 | 0.079 | 116.32 | 14.19 | −0.004 |
| ### | May 8, 2012 | 11:24:41 AM | 14.19 | 3.999 | 7.7473 | 3.548 | 56.746 | 0.079 | 116.01 | 14.240 | 3.9990 | 56.946 | 0.079 | 116.40 | 14.19 | −0.003 |
| ### | May 8, 2012 | 11:24:46 AM | 14.19 | 3.999 | 7.7528 | 3.548 | 56.746 | 0.079 | 116.09 | 14.240 | 3.9990 | 56.946 | 0.079 | 116.48 | 14.19 | −0.002 |
| ### | May 8, 2012 | 11:24:51 AM | 14.19 | 3.999 | 7.7584 | 3.548 | 56.746 | 0.079 | 116.17 | 14.240 | 3.9990 | 56.946 | 0.079 | 116.56 | 14.19 | −0.001 |
| ### | May 8, 2012 | 11:24:56 AM | 14.19 | 3.999 | 7.7639 | 3.548 | 56.746 | 0.079 | 116.25 | 14.240 | 3.9990 | 56.946 | 0.079 | 116.64 | 14.19 | 0.001 |
| ### | May 8, 2012 | 11:25:01 AM | 14.19 | 3.999 | 7.7695 | 3.548 | 56.746 | 0.079 | 116.33 | 14.240 | 3.9990 | 56.946 | 0.079 | 116.71 | 14.19 | 0.002 |
| ### | May 8, 2012 | 11:25:06 AM | 14.19 | 3.999 | 7.7750 | 3.548 | 56.746 | 0.079 | 116.40 | 14.240 | 3.9990 | 56.946 | 0.079 | 116.79 | 14.19 | 0.003 |
| ### | May 8, 2012 | 11:25:11 AM | 14.19 | 3.999 | 7.7806 | 3.548 | 56.746 | 0.079 | 116.48 | 14.240 | 3.9990 | 56.946 | 0.079 | 116.87 | 14.19 | 0.004 |
| ### | May 8, 2012 | 11:25:16 AM | 14.19 | 3.999 | 7.7861 | 3.548 | 56.746 | 0.079 | 116.56 | 14.240 | 3.9990 | 56.946 | 0.079 | 116.95 | 14.19 | 0.005 |
| ### | May 8, 2012 | 11:25:21 AM | 14.18 | 3.999 | 7.7916 | 3.545 | 56.706 | 0.079 | 116.64 | 14.230 | 3.9990 | 56.906 | 0.079 | 117.03 | 14.18 | −0.005 |
| ### | May 8, 2012 | 11:25:26 AM | 14.18 | 3.999 | 7.7972 | 3.545 | 56.706 | 0.079 | 116.72 | 14.230 | 3.9990 | 56.906 | 0.079 | 117.11 | 14.18 | −0.004 |
| ### | May 8, 2012 | 11:25:31 AM | 14.18 | 3.999 | 7.8027 | 3.545 | 56.706 | 0.079 | 116.80 | 14.230 | 3.9990 | 56.906 | 0.079 | 117.19 | 14.18 | −0.002 |
| ### | May 8, 2012 | 11:25:36 AM | 14.18 | 3.999 | 7.8083 | 3.545 | 56.706 | 0.079 | 116.88 | 14.230 | 3.9990 | 56.906 | 0.079 | 117.27 | 14.18 | 0.000 |
| ### | May 8, 2012 | 11:25:41 AM | 14.18 | 3.999 | 7.8138 | 3.545 | 56.706 | 0.079 | 116.96 | 14.230 | 3.9990 | 56.906 | 0.079 | 117.35 | 14.18 | 0.002 |
| ### | May 8, 2012 | 11:25:46 AM | 14.18 | 3.999 | 7.8194 | 3.545 | 56.706 | 0.079 | 117.03 | 14.230 | 3.9990 | 56.906 | 0.079 | 117.43 | 14.18 | 0.004 |
| ### | May 8, 2012 | 11:25:51 AM | 14.18 | 3.999 | 7.8249 | 3.545 | 56.706 | 0.079 | 117.11 | 14.230 | 3.9990 | 56.906 | 0.079 | 117.51 | 14.18 | 0.005 |
| ### | May 8, 2012 | 11:25:56 AM | 14.17 | 3.999 | 7.8305 | 3.543 | 56.666 | 0.079 | 117.19 | 14.220 | 3.9990 | 56.866 | 0.079 | 117.58 | 14.17 | −0.005 |
| ### | May 8, 2012 | 11:26:01 AM | 14.17 | 3.999 | 7.8360 | 3.543 | 56.666 | 0.079 | 117.27 | 14.220 | 3.9990 | 56.866 | 0.079 | 117.66 | 14.17 | −0.004 |
| ### | May 8, 2012 | 11:26:06 AM | 14.17 | 3.999 | 7.8416 | 3.543 | 56.666 | 0.079 | 117.35 | 14.220 | 3.9990 | 56.866 | 0.079 | 117.74 | 14.17 | −0.003 |
| ### | May 8, 2012 | 11:26:11 AM | 14.17 | 4.000 | 7.8471 | 3.543 | 56.680 | 0.079 | 117.43 | 14.220 | 4.0000 | 56.880 | 0.079 | 117.82 | 14.17 | −0.002 |
| ### | May 8, 2012 | 11:26:16 AM | 14.17 | 3.999 | 7.8527 | 3.543 | 56.666 | 0.079 | 117.51 | 14.220 | 3.9990 | 56.866 | 0.079 | 117.90 | 14.17 | −0.001 |
| ### | May 8, 2012 | 11:26:21 AM | 14.17 | 4.000 | 7.8582 | 3.543 | 56.680 | 0.079 | 117.59 | 14.220 | 4.0000 | 56.880 | 0.079 | 117.98 | 14.17 | 0.001 |
| ### | May 8, 2012 | 11:26:26 AM | 14.17 | 3.999 | 7.8638 | 3.543 | 56.666 | 0.079 | 117.66 | 14.220 | 3.9990 | 56.866 | 0.079 | 118.06 | 14.17 | 0.002 |
| ### | May 8, 2012 | 11:26:31 AM | 14.17 | 3.999 | 7.8693 | 3.543 | 56.666 | 0.079 | 117.74 | 14.220 | 3.9990 | 56.866 | 0.079 | 118.14 | 14.17 | 0.003 |
| ### | May 8, 2012 | 11:26:36 AM | 14.17 | 3.999 | 7.8749 | 3.543 | 56.666 | 0.079 | 117.82 | 14.220 | 3.9990 | 56.866 | 0.079 | 118.22 | 14.17 | 0.004 |
| ### | May 8, 2012 | 11:26:41 AM | 14.17 | 3.999 | 7.8804 | 3.543 | 56.666 | 0.079 | 117.90 | 14.220 | 3.9990 | 56.866 | 0.079 | 118.30 | 14.17 | 0.005 |
| ### | May 8, 2012 | 11:26:46 AM | 14.16 | 3.999 | 7.8859 | 3.540 | 56.626 | 0.079 | 117.98 | 14.210 | 3.9990 | 56.826 | 0.079 | 118.37 | 14.16 | −0.005 |
| ### | May 8, 2012 | 11:26:51 AM | 14.16 | 4.000 | 7.8911 | 3.540 | 56.640 | 0.079 | 118.06 | 14.210 | 4.0000 | 56.840 | 0.079 | 118.45 | 14.16 | −0.004 |
| ### | May 8, 2012 | 11:26:56 AM | 14.16 | 3.999 | 7.8968 | 3.540 | 56.626 | 0.079 | 118.14 | 14.210 | 3.9990 | 56.826 | 0.079 | 118.53 | 14.16 | −0.003 |
| ### | May 8, 2012 | 11:27:01 AM | 14.16 | 3.999 | 7.9024 | 3.540 | 56.626 | 0.079 | 118.22 | 14.210 | 3.9990 | 56.826 | 0.079 | 118.61 | 14.16 | −0.001 |
| ### | May 8, 2012 | 11:27:06 AM | 14.16 | 3.999 | 7.9079 | 3.540 | 56.626 | 0.079 | 118.29 | 14.210 | 3.9990 | 56.826 | 0.079 | 118.69 | 14.16 | 0.001 |
| ### | May 8, 2012 | 11:27:11 AM | 14.16 | 3.999 | 7.9135 | 3.540 | 56.626 | 0.079 | 118.37 | 14.210 | 3.9990 | 56.826 | 0.079 | 118.77 | 14.16 | 0.003 |
| ### | May 8, 2012 | 11:27:16 AM | 14.16 | 4.000 | 7.9190 | 3.540 | 56.640 | 0.079 | 118.45 | 14.210 | 4.0000 | 56.840 | 0.079 | 118.85 | 14.16 | 0.004 |
| ### | May 8, 2012 | 11:27:21 AM | 14.16 | 4.000 | 7.9248 | 3.540 | 56.640 | 0.079 | 118.53 | 14.210 | 4.0000 | 56.840 | 0.079 | 118.93 | 14.16 | 0.005 |
| ### | May 8, 2012 | 11:27:26 AM | 14.15 | 3.999 | 7.9303 | 3.538 | 56.586 | 0.079 | 118.61 | 14.200 | 3.9990 | 56.786 | 0.079 | 119.01 | 14.15 | −0.005 |
| ### | May 8, 2012 | 11:27:31 AM | 14.15 | 4.000 | 7.9358 | 3.538 | 56.600 | 0.079 | 118.69 | 14.200 | 4.0000 | 56.800 | 0.079 | 119.08 | 14.15 | −0.004 |
| ### | May 8, 2012 | 11:27:36 AM | 14.15 | 3.999 | 7.9414 | 3.538 | 56.586 | 0.079 | 118.77 | 14.200 | 3.9990 | 56.786 | 0.079 | 119.16 | 14.15 | −0.003 |
| ### | May 8, 2012 | 11:27:41 AM | 14.15 | 3.999 | 7.9469 | 3.538 | 56.586 | 0.079 | 118.84 | 14.200 | 3.9990 | 56.786 | 0.079 | 119.24 | 14.15 | −0.002 |
| ### | May 8, 2012 | 11:27:46 AM | 14.15 | 3.999 | 7.9523 | 3.538 | 56.586 | 0.079 | 118.92 | 14.200 | 3.9990 | 56.786 | 0.079 | 119.32 | 14.15 | −0.001 |
| ### | May 8, 2012 | 11:27:51 AM | 14.15 | 3.999 | 7.9578 | 3.538 | 56.586 | 0.079 | 119.00 | 14.200 | 3.9990 | 56.786 | 0.079 | 119.40 | 14.15 | 0.000 |
| ### | May 8, 2012 | 11:27:56 AM | 14.15 | 3.999 | 7.9634 | 3.538 | 56.586 | 0.079 | 119.08 | 14.200 | 3.9990 | 56.786 | 0.079 | 119.48 | 14.15 | 0.000 |
| ### | May 8, 2012 | 11:28:01 AM | 14.15 | 3.999 | 7.9689 | 3.538 | 56.586 | 0.079 | 119. [symbol] | 14.200 | 3.9990 | 56.786 | 0.079 | 119.56 | 14.15 | 0.000 |
| ### | May 8, 2012 | 11:28:06 AM | 14.15 | 3.999 | 7.9745 | 3.538 | 56.586 | 0.079 | 119.24 | 14.200 | 3.9990 | 56.786 | 0.079 | 119.64 | 14.15 | 0.001 |
| ### | May 8, 2012 | 11:28:11 AM | 14.15 | 3.999 | 7.9800 | 3.538 | 56.586 | 0.079 | 119.32 | 14.200 | 3.9990 | 56.786 | 0.079 | 119.72 | 14.15 | 0.002 |
| ### | May 8, 2012 | 11:28:16 AM | 14.15 | 3.999 | 7.9855 | 3.538 | 56.586 | 0.079 | 119.39 | 14.200 | 3.9990 | 56.786 | 0.079 | 119.79 | 14.15 | 0.003 |
| ### | May 8, 2012 | 11:28:21 AM | 14.15 | 3.999 | 7.9911 | 3.538 | 56.586 | 0.079 | 119.47 | 14.200 | 3.9990 | 56.786 | 0.079 | 119.87 | 14.15 | 0.004 |
| ### | May 8, 2012 | 11:28:26 AM | 14.15 | 3.999 | 7.9967 | 3.538 | 56.586 | 0.079 | 119.55 | 14.200 | 3.9990 | 56.786 | 0.079 | 119.95 | 14.15 | 0.005 |
| ### | May 8, 2012 | 11:28:31 AM | 14.14 | 3.999 | 8.0022 | 3.535 | 56.546 | 0.079 | 119.63 | 14.190 | 3.9990 | 56.746 | 0.079 | 120.03 | 14.14 | −0.005 |
| ### | May 8, 2012 | 11:28:36 AM | 14.14 | 3.999 | 8.0077 | 3.535 | 56.546 | 0.079 | 119.71 | 14.190 | 3.9990 | 56.746 | 0.079 | 120.11 | 14.14 | −0.004 |
| ### | May 8, 2012 | 11:28:41 AM | 14.14 | 3.999 | 8.0133 | 3.535 | 56.546 | 0.079 | 119.79 | 14.190 | 3.9990 | 56.746 | 0.079 | 120.19 | 14.14 | −0.003 |
| ### | May 8, 2012 | 11:28:46 AM | 14.14 | 3.999 | 8.0190 | 3.535 | 56.546 | 0.079 | 119.87 | 14.190 | 3.9990 | 56.746 | 0.079 | 120.27 | 14.14 | −0.002 |
| ### | May 8, 2012 | 11:28:51 AM | 14.14 | 3.999 | 8.0245 | 3.535 | 56.546 | 0.079 | 119.94 | 14.190 | 3.9990 | 56.746 | 0.079 | 120.35 | 14.14 | 0.000 |
| ### | May 8, 2012 | 11:28:56 AM | 14.14 | 3.999 | 8.0301 | 3.535 | 56.546 | 0.079 | 120.02 | 14.190 | 3.9990 | 56.746 | 0.079 | 120.42 | 14.14 | 0.002 |
| ### | May 8, 2012 | 11:29:01 AM | 14.14 | 3.999 | 8.0356 | 3.535 | 56.546 | 0.079 | 120.10 | 14.190 | 3.9990 | 56.746 | 0.079 | 120.50 | 14.14 | 0.003 |
| ### | May 8, 2012 | 11:29:06 AM | 14.14 | 3.999 | 8.0410 | 3.535 | 56.546 | 0.079 | 120.18 | 14.190 | 3.9990 | 56.746 | 0.079 | 120.58 | 14.14 | 0.004 |
| ### | May 8, 2012 | 11:29:11 AM | 14.14 | 4.000 | 8.0466 | 3.535 | 56.560 | 0.079 | 120.26 | 14.190 | 4.0000 | 56.760 | 0.079 | 120.66 | 14.14 | 0.005 |
| ### | May 8, 2012 | 11:29:16 AM | 14.13 | 3.999 | 8.0521 | 3.533 | 56.506 | 0.078 | 120.34 | 14.180 | 3.9990 | 56.706 | 0.079 | 120.74 | 14.13 | −0.005 |
| ### | May 8, 2012 | 11:29:21 AM | 14.13 | 3.999 | 8.0576 | 3.533 | 56.506 | 0.078 | 120.42 | 14.180 | 3.9990 | 56.706 | 0.079 | 120.82 | 14.13 | −0.004 |
| ### | May 8, 2012 | 11:29:26 AM | 14.13 | 3.999 | 8.0632 | 3.533 | 56.506 | 0.078 | 120.49 | 14.180 | 3.9990 | 56.706 | 0.079 | 120.90 | 14.13 | −0.003 |
| ### | May 8, 2012 | 11:29:31 AM | 14.13 | 3.999 | 8.0687 | 3.533 | 56.506 | 0.078 | 120.57 | 14.180 | 3.9990 | 56.706 | 0.079 | 120.98 | 14.13 | −0.002 |
| ### | May 8, 2012 | 11:29:36 AM | 14.13 | 3.999 | 8.0743 | 3.533 | 56.506 | 0.078 | 120.65 | 14.180 | 3.9990 | 56.706 | 0.079 | 121.06 | 14.13 | −0.001 |
| ### | May 8, 2012 | 11:29:41 AM | 14.13 | 3.999 | 8.0798 | 3.533 | 56.506 | 0.078 | 120.73 | 14.180 | 3.9990 | 56.706 | 0.079 | 121.13 | 14.13 | 0.001 |
| ### | May 8, 2012 | 11:29:46 AM | 14.13 | 4.000 | 8.0854 | 3.533 | 56.520 | 0.079 | 120.81 | 14.180 | 4.0000 | 56.720 | 0.079 | 121.21 | 14.13 | 0.002 |
| ### | May 8, 2012 | 11:29:51 AM | 14.13 | 3.999 | 8.0909 | 3.533 | 56.506 | 0.078 | 120.89 | 14.180 | 3.9990 | 56.706 | 0.079 | 121.29 | 14.13 | 0.003 |
| ### | May 8, 2012 | 11:29:56 AM | 14.13 | 3.999 | 8.0965 | 3.533 | 56.506 | 0.078 | 120.96 | 14.180 | 3.9990 | 56.706 | 0.079 | 121.37 | 14.13 | 0.003 |
| ### | May 8, 2012 | 11:30:01 AM | 14.13 | 3.999 | 8.1020 | 3.533 | 56.506 | 0.078 | 121.04 | 14.180 | 3.9990 | 56.706 | 0.079 | 121.45 | 14.13 | 0.004 |
| ### | May 8, 2012 | 11:30:06 AM | 14.12 | 3.999 | 8.1076 | 3.530 | 56.466 | 0.078 | 121.12 | 14.170 | 3.9990 | 56.666 | 0.079 | 121.53 | 14.13 | −0.005 |
| ### | May 8, 2012 | 11:30:11 AM | 14.12 | 3.999 | 8.1131 | 3.530 | 56.466 | 0.078 | 121.20 | 14.170 | 3.9990 | 56.666 | 0.079 | 121.61 | 14.12 | −0.005 |
| ### | May 8, 2012 | 11:30:16 AM | 14.12 | 3.999 | 8.1186 | 3.530 | 56.466 | 0.078 | 121.28 | 14.170 | 3.9990 | 56.666 | 0.079 | 121.69 | 14.12 | −0.004 |
| ### | May 8, 2012 | 11:30:21 AM | 14.13 | 3.999 | 8.1242 | 3.533 | 56.506 | 0.078 | 121.36 | 14.180 | 3.9990 | 56.706 | 0.079 | 121.76 | 14.12 | 0.007 |
| ### | May 8, 2012 | 11:30:26 AM | 14.12 | 3.999 | 8.1297 | 3.530 | 56.466 | 0.078 | 121.44 | 14.170 | 3.9990 | 56.666 | 0.079 | 121.84 | 14.12 | −0.002 |
| ### | May 8, 2012 | 11:30:31 AM | 14.12 | 3.999 | 8.1353 | 3.530 | 56.466 | 0.078 | 121.51 | 14.170 | 3.9990 | 56.666 | 0.079 | 121.92 | 14.12 | −0.001 |
| ### | May 8, 2012 | 11:30:36 AM | 14.12 | 3.999 | 8.1408 | 3.530 | 56.466 | 0.078 | 121.59 | 14.170 | 3.9990 | 56.666 | 0.079 | 122.00 | 14.12 | 0.000 |
| ### | May 8, 2012 | 11:30:41 AM | 14.12 | 3.999 | 8.1464 | 3.530 | 56.466 | 0.078 | 121.67 | 14.170 | 3.9990 | 56.666 | 0.079 | 122.08 | 14.12 | 0.001 |
| ### | May 8, 2012 | 11:30:46 AM | 14.12 | 3.999 | 8.1519 | 3.530 | 56.466 | 0.078 | 121.75 | 14.170 | 3.9990 | 56.666 | 0.079 | 122.16 | 14.12 | 0.002 |
| ### | May 8, 2012 | 11:30:51 AM | 14.12 | 3.999 | 8.1575 | 3.530 | 56.466 | 0.078 | 121.83 | 14.170 | 3.9990 | 56.666 | 0.079 | 122.24 | 14.12 | 0.004 |
| ### | May 8, 2012 | 11:30:56 AM | 14.12 | 3.999 | 8.1630 | 3.530 | 56.466 | 0.078 | 121.91 | 14.170 | 3.9990 | 56.666 | 0.079 | 122.31 | 14.12 | 0.005 |
| ### | May 8, 2012 | 11:31:01 AM | 14.11 | 3.999 | 8.1686 | 3.528 | 56.426 | 0.078 | 121.98 | 14.160 | 3.9990 | 56.626 | 0.079 | 122.39 | 14.11 | −0.005 |
| ### | May 8, 2012 | 11:31:06 AM | 14.11 | 3.999 | 8.1741 | 3.528 | 56.426 | 0.078 | 122.06 | 14.160 | 3.9990 | 56.626 | 0.079 | 122.47 | 14.11 | −0.004 |
| ### | May 8, 2012 | 11:31:11 AM | 14.11 | 3.999 | 8.1797 | 3.528 | 56.426 | 0.078 | 122.14 | 14.160 | 3.9990 | 56.626 | 0.079 | 122.55 | 14.11 | −0.003 |
| ### | May 8, 2012 | 11:31:16 AM | 14.11 | 3.999 | 8.1852 | 3.528 | 56.426 | 0.078 | 122.22 | 14.160 | 3.9990 | 56.626 | 0.079 | 122.63 | 14.11 | −0.002 |
| ### | May 8, 2012 | 11:31:21 AM | 14.11 | 3.999 | 8.1907 | 3.528 | 56.426 | 0.078 | 122.30 | 14.160 | 3.9990 | 56.626 | 0.079 | 122.71 | 14.11 | −0.001 |
| ### | May 8, 2012 | 11:31:26 AM | 14.11 | 3.999 | 8.1963 | 3.528 | 56.426 | 0.078 | 122.38 | 14.160 | 3.9990 | 56.626 | 0.079 | 122.79 | 14.11 | 0.001 |
| ### | May 8, 2012 | 11:31:31 AM | 14.11 | 3.999 | 8.2018 | 3.528 | 56.426 | 0.078 | 122.45 | 14.160 | 3.9990 | 56.626 | 0.079 | 122.87 | 14.11 | 0.002 |
| ### | May 8, 2012 | 11:31:36 AM | 14.11 | 3.999 | 8.2074 | 3.528 | 56.426 | 0.078 | 122.53 | 14.160 | 3.9990 | 56.626 | 0.079 | 122.94 | 14.11 | 0.003 |
| ### | May 8, 2012 | 11:31:41 AM | 14.11 | 4.000 | 8.2129 | 3.528 | 56.440 | 0.078 | 122.61 | 14.160 | 4.0000 | 56.640 | 0.079 | 123.02 | 14.11 | 0.004 |
| ### | May 8, 2012 | 11:31:46 AM | 14.11 | 3.999 | 8.2184 | 3.528 | 56.426 | 0.078 | 122.69 | 14.160 | 3.9990 | 56.626 | 0.079 | 123.10 | 14.11 | 0.005 |
| ### | May 8, 2012 | 11:31:51 AM | 14.10 | 3.999 | 8.2240 | 3.525 | 56.386 | 0.078 | 122.77 | 14.150 | 3.9990 | 56.586 | 0.079 | 123.18 | 14.10 | −0.005 |
| ### | May 8, 2012 | 11:31:56 AM | 14.10 | 3.999 | 8.2296 | 3.525 | 56.386 | 0.078 | 122.85 | 14.150 | 3.9990 | 56.586 | 0.079 | 123.26 | 14.10 | −0.004 |
| ### | May 8, 2012 | 11:32:01 AM | 14.10 | 3.999 | 8.2351 | 3.525 | 56.386 | 0.078 | 122.92 | 14.150 | 3.9990 | 56.586 | 0.079 | 123.34 | 14.10 | −0.003 |
| ### | May 8, 2012 | 11:32:06 AM | 14.10 | 3.999 | 8.2406 | 3.525 | 56.386 | 0.078 | 123.00 | 14.150 | 3.9990 | 56.586 | 0.079 | 123.42 | 14.10 | −0.002 |
| ### | May 8, 2012 | 11:32:11 AM | 14.10 | 3.999 | 8.2462 | 3.525 | 56.386 | 0.078 | 123.08 | 14.150 | 3.9990 | 56.586 | 0.079 | 123.49 | 14.10 | −0.001 |
| ### | May 8, 2012 | 11:32:16 AM | 14.10 | 3.999 | 8.2517 | 3.525 | 56.386 | 0.078 | 123.16 | 14.150 | 3.9990 | 56.586 | 0.079 | 123.57 | 14.10 | 0.000 |
| ### | May 8, 2012 | 11:32:21 AM | 14.10 | 3.999 | 8.2573 | 3.525 | 56.386 | 0.078 | 123.24 | 14.150 | 3.9990 | 56.586 | 0.079 | 123.65 | 14.10 | 0.001 |
| ### | May 8, 2012 | 11:32:26 AM | 14.10 | 3.999 | 8.2628 | 3.525 | 56.386 | 0.078 | 123.32 | 14.150 | 3.9990 | 56.586 | 0.079 | 123.73 | 14.10 | 0.002 |
| ### | May 8, 2012 | 11:32:31 AM | 14.10 | 3.999 | 8.2684 | 3.525 | 56.386 | 0.078 | 123.39 | 14.150 | 3.9990 | 56.586 | 0.079 | 123.81 | 14.10 | 0.003 |
| ### | May 8, 2012 | 11:32:36 AM | 14.10 | 3.999 | 8.2739 | 3.525 | 56.386 | 0.078 | 123.47 | 14.150 | 3.9990 | 56.586 | 0.079 | 123.89 | 14.10 | 0.004 |
| ### | May 8, 2012 | 11:32:41 AM | 14.10 | 3.999 | 8.2794 | 3.525 | 56.386 | 0.078 | 123.55 | 14.150 | 3.9990 | 56.586 | 0.079 | 123.97 | 14.10 | 0.005 |
| ### | May 8, 2012 | 11:32:46 AM | 14.09 | 3.999 | 8.2850 | 3.523 | 56.346 | 0.078 | 123.63 | 14.140 | 3.9990 | 56.546 | 0.079 | 124.04 | 14.09 | −0.005 |
| ### | May 8, 2012 | 11:32:51 AM | 14.09 | 3.999 | 8.2905 | 3.523 | 56.346 | 0.078 | 123.71 | 14.140 | 3.9990 | 56.546 | 0.079 | 124.12 | 14.09 | −0.004 |
| ### | May 8, 2012 | 11:32:56 AM | 14.09 | 3.999 | 8.2961 | 3.523 | 56.346 | 0.078 | 123.79 | 14.140 | 3.9990 | 56.546 | 0.079 | 124.20 | 14.09 | −0.003 |
| ### | May 8, 2012 | 11:33:01 AM | 14.09 | 3.999 | 8.3016 | 3.523 | 56.346 | 0.078 | 123.86 | 14.140 | 3.9990 | 56.546 | 0.079 | 124.28 | 14.09 | −0.001 |
| ### | May 8, 2012 | 11:33:06 AM | 14.09 | 3.999 | 8.3072 | 3.523 | 56.346 | 0.078 | 123.94 | 14.140 | 3.9990 | 56.546 | 0.079 | 124.36 | 14.09 | 0.001 |
| ### | May 8, 2012 | 11:33:11 AM | 14.09 | 3.999 | 8.3127 | 3.523 | 56.346 | 0.078 | 124.02 | 14.140 | 3.9990 | 56.546 | 0.079 | 124.44 | 14.09 | 0.003 |
| ### | May 8, 2012 | 11:33:16 AM | 14.09 | 3.999 | 8.3183 | 3.523 | 56.346 | 0.078 | 124.10 | 14.140 | 3.9990 | 56.546 | 0.079 | 124.52 | 14.09 | 0.004 |
| ### | May 8, 2012 | 11:33:21 AM | 14.09 | 3.999 | 8.3238 | 3.523 | 56.346 | 0.078 | 124.18 | 14.140 | 3.9990 | 56.546 | 0.079 | 124.59 | 14.09 | 0.005 |
| ### | May 8, 2012 | 11:33:26 AM | 14.08 | 3.999 | 8.3294 | 3.520 | 56.306 | 0.078 | 124.26 | 14.130 | 3.9990 | 56.506 | 0.078 | 124.67 | 14.08 | −0.005 |
| ### | May 8, 2012 | 11:33:31 AM | 14.08 | 3.999 | 8.3349 | 3.520 | 56.306 | 0.079 | 124.33 | 14.130 | 3.9990 | 56.506 | 0.078 | 124.75 | 14.08 | −0.004 |
| ### | May 8, 2012 | 11:33:36 AM | 14.08 | 3.999 | 8.3404 | 3.520 | 56.306 | 0.078 | 124.41 | 14.130 | 3.9990 | 56.506 | 0.078 | 124.83 | 14.08 | −0.003 |
| ### | May 8, 2012 | 11:33:41 AM | 14.08 | 3.999 | 8.3460 | 3.520 | 56.306 | 0.078 | 124.49 | 14.130 | 3.9990 | 56.506 | 0.078 | 124.91 | 14.08 | −0.002 |
| ### | May 8, 2012 | 11:33:46 AM | 14.08 | 3.999 | 8.3515 | 3.520 | 56.306 | 0.078 | 124.57 | 14.130 | 3.9990 | 56.506 | 0.078 | 124.99 | 14.08 | −0.001 |
| ### | May 8, 2012 | 11:33:51 AM | 14.08 | 3.999 | 8.3571 | 3.520 | 56.306 | 0.078 | 124.65 | 14.130 | 3.9990 | 56.506 | 0.078 | 125.06 | 14.08 | 0.000 |
| ### | May 8, 2012 | 11:33:56 AM | 14.08 | 3.999 | 8.3626 | 3.520 | 56.306 | 0.078 | 124.72 | 14.130 | 3.9990 | 56.506 | 0.078 | 125.14 | 14.08 | 0.000 |
| ### | May 8, 2012 | 11:34:01 AM | 14.08 | 3.999 | 8.3682 | 3.520 | 56.306 | 0.078 | 124.80 | 14.130 | 3.9990 | 56.506 | 0.078 | 125.22 | 14.08 | 0.001 |
| ### | May 8, 2012 | 11:34:06 AM | 14.08 | 3.999 | 8.3737 | 3.520 | 56.306 | 0.078 | 124.88 | 14.130 | 3.9990 | 56.506 | 0.078 | 125.30 | 14.08 | 0.002 |
| ### | May 8, 2012 | 11:34:11 AM | 14.08 | 3.999 | 8.3793 | 3.520 | 56.306 | 0.078 | 124.96 | 14.130 | 3.9990 | 56.506 | 0.078 | 125.38 | 14.08 | 0.003 |
| ### | May 8, 2012 | 11:34:16 AM | 14.08 | 3.999 | 8.3848 | 3.520 | 56.306 | 0.078 | 125.04 | 14.130 | 3.9990 | 56.506 | 0.078 | 125.46 | 14.08 | 0.004 |
| ### | May 8, 2012 | 11:34:21 AM | 14.08 | 3.999 | 8.3903 | 3.520 | 56.266 | 0.078 | [symbol] | 14.130 | 3.9990 | 56.506 | 0.078 | 125.54 | 14.08 | 0.005 |
| ### | May 8, 2012 | 11:34:26 AM | 14.07 | 3.999 | 8.3959 | 3.518 | 56.266 | 0.078 | 125.19 | 14.120 | 3.9990 | 56.466 | 0.078 | 125.61 | 14.07 | −0.005 |
| ### | May 8, 2012 | 11:34:31 AM | 14.07 | 3.999 | 8.4014 | 3.518 | 56.266 | 0.078 | 125.27 | 14.120 | 3.9990 | 56.466 | 0.078 | 125.69 | 14.07 | −0.004 |
| ### | May 8, 2012 | 11:34:36 AM | 14.07 | 3.999 | 8.4070 | 3.518 | 56.266 | 0.078 | 125.35 | 14.120 | 3.9990 | 56.466 | 0.078 | 125.77 | 14.07 | −0.003 |
| ### | May 8, 2012 | 11:34:41 AM | 14.07 | 3.999 | 8.4125 | 3.518 | 56.266 | 0.078 | 125.43 | 14.120 | 3.9990 | 56.466 | 0.078 | 125.85 | 14.07 | −0.002 |
| ### | May 8, 2012 | 11:34:46 AM | 14.07 | 3.999 | 8.4181 | 3.518 | 56.266 | 0.078 | 125.51 | 14.120 | 3.9990 | 56.466 | 0.078 | 125.93 | 14.07 | −0.001 |
| ### | May 8, 2012 | 11:34:51 AM | 14.07 | 3.999 | 8.4237 | 3.518 | 56.266 | 0.078 | 125.58 | 14.120 | 3.9990 | 56.466 | 0.078 | 126.01 | 14.07 | −0.001 |
| ### | May 8, 2012 | 11:34:56 AM | 14.07 | 3.999 | 8.4292 | 3.518 | 56.266 | 0.078 | 125.66 | 14.120 | 3.9990 | 56.466 | 0.078 | 126.08 | 14.07 | 0.002 |
| ### | May 8, 2012 | 11:35:01 AM | 14.07 | 3.999 | 8.4347 | 3.518 | 56.266 | 0.078 | 125.74 | 14.120 | 3.9990 | 56.466 | 0.078 | 126.16 | 14.07 | 0.003 |
| ### | May 8, 2012 | 11:35:06 AM | 14.07 | 3.999 | 8.4402 | 3.518 | 56.266 | 0.078 | 125.82 | 14.120 | 3.9990 | 56.466 | 0.078 | 126.24 | 14.07 | 0.004 |
| ### | May 8, 2012 | 11:35:11 AM | 14.07 | 3.999 | 8.4458 | 3.518 | 56.266 | 0.078 | 125.90 | 14.120 | 3.9990 | 56.466 | 0.078 | 126.32 | 14.07 | 0.005 |
| ### | May 8, 2012 | 11:35:16 AM | 14.06 | 3.999 | 8.4513 | 3.515 | 56.266 | 0.078 | 125.98 | 14.110 | 3.9990 | 56.426 | 0.078 | 126.40 | 14.06 | −0.005 |
| ### | May 8, 2012 | 11:35:21 AM | 14.06 | 3.999 | 8.4569 | 3.515 | 56.266 | 0.078 | 126.05 | 14.110 | 3.9990 | 56.426 | 0.078 | 126.48 | 14.06 | −0.004 |
| ### | May 8, 2012 | 11:35:26 AM | 14.06 | 3.999 | 8.4626 | 3.515 | 56.266 | 0.078 | 126.13 | 14.110 | 3.9990 | 56.426 | 0.078 | 126.56 | 14.06 | −0.003 |
| ### | May 8, 2012 | 11:35:31 AM | 14.06 | 3.999 | 8.4681 | 3.515 | 56.266 | 0.078 | 126.21 | 14.110 | 3.9990 | 56.426 | 0.078 | 126.63 | 14.06 | −0.002 |
| ### | May 8, 2012 | 11:35:36 AM | 14.06 | 3.999 | 8.4735 | 3.515 | 56.266 | 0.078 | 126.29 | 14.110 | 3.9990 | 56.426 | 0.078 | 126.71 | 14.06 | 0.000 |
| ### | May 8, 2012 | 11:35:41 AM | 14.06 | 3.999 | 8.4791 | 3.515 | 56.266 | 0.078 | 126.37 | 14.110 | 3.9990 | 56.426 | 0.078 | 126.79 | 14.06 | 0.002 |
| ### | May 8, 2012 | 11:35:46 AM | 14.06 | 3.999 | 8.4846 | 3.515 | 56.266 | 0.078 | 126.44 | 14.110 | 3.9990 | 56.426 | 0.078 | 126.87 | 14.06 | 0.003 |
| ### | May 8, 2012 | 11:35:51 AM | 14.06 | 3.999 | 8.4901 | 3.515 | 56.266 | 0.078 | 126.52 | 14.110 | 3.9990 | 56.426 | 0.078 | 126.95 | 14.06 | 0.004 |
| ### | May 8, 2012 | 11:35:56 AM | 14.06 | 3.999 | 8.4957 | 3.515 | 56.266 | 0.078 | 126.60 | 14.110 | 3.9990 | 56.426 | 0.078 | 127.03 | 14.06 | 0.005 |
| ### | May 8, 2012 | 11:36:01 AM | 14.05 | 3.999 | 8.5012 | 3.513 | 56.186 | 0.078 | 126.68 | 14.100 | 3.9990 | 56.386 | 0.078 | 127.10 | 14.05 | −0.005 |
| ### | May 8, 2012 | 11:36:06 AM | 14.05 | 3.999 | 8.5068 | 3.513 | 56.186 | 0.078 | 126.76 | 14.100 | 3.9990 | 56.386 | 0.078 | 127.18 | 14.05 | −0.004 |
| ### | May 8, 2012 | 11:36:11 AM | 14.05 | 3.999 | 8.5123 | 3.513 | 56.186 | 0.078 | 126.83 | 14.100 | 3.9990 | 56.386 | 0.078 | 127.26 | 14.05 | −0.003 |
| ### | May 8, 2012 | 11:36:16 AM | 14.05 | 3.999 | 8.5179 | 3.513 | 56.186 | 0.078 | 126.91 | 14.100 | 3.9990 | 56.386 | 0.078 | 127.34 | 14.05 | −0.002 |
| ### | May 8, 2012 | 11:36:21 AM | 14.05 | 3.999 | 8.5234 | 3.513 | 56.186 | 0.078 | 126.99 | 14.100 | 3.9990 | 56.386 | 0.078 | 127.42 | 14.05 | −0.001 |
| ### | May 8, 2012 | 11:36:26 AM | 14.05 | 3.999 | 8.5290 | 3.513 | 56.186 | 0.078 | 127.07 | 14.100 | 3.9990 | 56.386 | 0.078 | 127.50 | 14.05 | 0.001 |
| ### | May 8, 2012 | 11:36:31 AM | 14.05 | 3.999 | 8.5345 | 3.513 | 56.186 | 0.078 | 127.15 | 14.100 | 3.9990 | 56.386 | 0.078 | 127.57 | 14.05 | 0.002 |
| ### | May 8, 2012 | 11:36:36 AM | 14.05 | 3.999 | 8.5401 | 3.513 | 56.186 | 0.078 | 127.22 | 14.100 | 3.9990 | 56.386 | 0.078 | 127.65 | 14.05 | 0.003 |
| ### | May 8, 2012 | 11:36:41 AM | 14.05 | 3.999 | 8.5456 | 3.513 | 56.186 | 0.078 | 127.30 | 14.100 | 3.9990 | 56.386 | 0.078 | 127.73 | 14.05 | 0.004 |
| ### | May 8, 2012 | 11:36:46 AM | 14.05 | 3.999 | 8.5512 | 3.513 | 56.186 | 0.078 | 127.38 | 14.100 | 3.9990 | 56.386 | 0.078 | 127.81 | 14.05 | 0.005 |
| ### | May 8, 2012 | 11:36:51 AM | 14.04 | 3.999 | 8.5567 | 3.510 | 56.146 | 0.078 | 127.46 | 14.090 | 3.9990 | 56.346 | 0.078 | 127.89 | 14.04 | −0.005 |
| ### | May 8, 2012 | 11:36:56 AM | 14.04 | 3.999 | 8.5622 | 3.510 | 56.146 | 0.078 | 127.54 | 14.090 | 3.9990 | 56.346 | 0.078 | 127.97 | 14.04 | −0.004 |
| ### | May 8, 2012 | 11:37:01 AM | 14.04 | 3.999 | 8.5678 | 3.510 | 56.146 | 0.078 | 127.61 | 14.090 | 3.9990 | 56.346 | 0.078 | 128.04 | 14.04 | −0.003 |
| ### | May 8, 2012 | 11:37:06 AM | 14.04 | 3.999 | 8.5733 | 3.510 | 56.146 | 0.078 | 127.69 | 14.090 | 3.9990 | 56.346 | 0.078 | 128.12 | 14.04 | −0.001 |
| ### | May 8, 2012 | 11:37:11 AM | 14.04 | 3.999 | 8.5789 | 3.510 | 56.146 | 0.078 | 127.77 | 14.090 | 3.9990 | 56.346 | 0.078 | 128.20 | 14.04 | 0.001 |
| ### | May 8, 2012 | 11:37:16 AM | 14.04 | 3.999 | 8.5844 | 3.510 | 56.146 | 0.078 | 127.85 | 14.090 | 3.9990 | 56.346 | 0.078 | 128.28 | 14.04 | 0.003 |
| ### | May 8, 2012 | 11:37:21 AM | 14.04 | 3.999 | 8.5900 | 3.510 | 56.146 | 0.078 | 127.93 | 14.090 | 3.9990 | 56.346 | 0.078 | 128.36 | 14.04 | 0.004 |
| ### | May 8, 2012 | 11:37:26 AM | 14.04 | 3.999 | 8.5955 | 3.510 | 56.146 | 0.078 | 128.00 | 14.090 | 3.9990 | 56.346 | 0.078 | 128.43 | 14.04 | 0.005 |
| ### | May 8, 2012 | 11:37:31 AM | 14.03 | 3.999 | 8.6011 | 3.508 | 56.106 | 0.078 | 128.08 | 14.080 | 3.9990 | 56.306 | 0.078 | 128.51 | 14.03 | −0.005 |
| ### | May 8, 2012 | 11:37:36 AM | 14.03 | 3.999 | 8.6066 | 3.508 | 56.106 | 0.078 | 128.16 | 14.080 | 3.9990 | 56.306 | 0.078 | 128.59 | 14.03 | −0.004 |
| ### | May 8, 2012 | 11:37:41 AM | 14.03 | 3.999 | 8.6122 | 3.508 | 56.106 | 0.078 | 128.24 | 14.080 | 3.9990 | 56.306 | 0.078 | 128.67 | 14.03 | −0.003 |
| ### | May 8, 2012 | 11:37:46 AM | 14.03 | 3.999 | 8.6177 | 3.508 | 56.106 | 0.078 | 128.32 | 14.080 | 3.9990 | 56.306 | 0.078 | 128.75 | 14.03 | −0.002 |
| ### | May 8, 2012 | 11:37:51 AM | 14.03 | 3.999 | 8.6233 | 3.508 | 56.106 | 0.078 | 128.39 | 14.080 | 3.9990 | 56.306 | 0.078 | 128.83 | 14.03 | −0.001 |
| ### | May 8, 2012 | 11:37:56 AM | 14.03 | 3.999 | 8.6288 | 3.508 | 56.106 | 0.078 | 128.47 | 14.080 | 3.9990 | 56.306 | 0.078 | 128.90 | 14.03 | 0.001 |
| ### | May 8, 2012 | 11:38:01 AM | 14.03 | 3.999 | 8.6343 | 3.508 | 56.106 | 0.078 | 128.55 | 14.080 | 3.9990 | 56.306 | 0.078 | 128.98 | 14.03 | 0.002 |
| ### | May 8, 2012 | 11:38:06 AM | 14.03 | 3.999 | 8.6399 | 3.508 | 56.106 | 0.078 | 128.63 | 14.080 | 3.9990 | 56.306 | 0.078 | 129.06 | 14.03 | 0.003 |
| ### | May 8, 2012 | 11:38:11 AM | 14.03 | 3.999 | 8.6454 | 3.508 | 56.106 | 0.078 | 128.71 | 14.080 | 3.9990 | 56.306 | 0.078 | 129.14 | 14.03 | 0.004 |
| ### | May 8, 2012 | 11:38:16 AM | 14.03 | 3.999 | 8.6510 | 3.508 | 56.106 | 0.078 | 128.78 | 14.080 | 3.9990 | 56.306 | 0.078 | 129.22 | 14.03 | 0.005 |
| ### | May 8, 2012 | 11:38:21 AM | 14.02 | 3.999 | 8.6565 | 3.505 | 56.066 | 0.078 | 128.86 | 14.070 | 3.9990 | 56.266 | 0.078 | 129.29 | 14.02 | −0.005 |
| ### | May 8, 2012 | 11:38:26 AM | 14.02 | 3.999 | 8.6621 | 3.505 | 56.066 | 0.078 | 128.94 | 14.070 | 3.9990 | 56.266 | 0.078 | 129.37 | 14.02 | −0.004 |
| ### | May 8, 2012 | 11:38:31 AM | 14.02 | 3.999 | 8.6676 | 3.505 | 56.066 | 0.078 | 129.02 | 14.070 | 3.9990 | 56.266 | 0.078 | 129.45 | 14.02 | −0.003 |
| ### | May 8, 2012 | 11:38:36 AM | 14.02 | 3.999 | 8.6732 | 3.505 | 56.066 | 0.078 | 129.09 | 14.070 | 3.9990 | 56.266 | 0.078 | 129.53 | 14.02 | −0.002 |
| ### | May 8, 2012 | 11:38:41 AM | 14.02 | 3.999 | 8.6787 | 3.505 | 56.066 | 0.078 | 129.17 | 14.070 | 3.9990 | 56.266 | 0.078 | 129.61 | 14.02 | 0.000 |
| ### | May 8, 2012 | 11:38:46 AM | 14.02 | 3.999 | 8.6842 | 3.505 | 56.066 | 0.078 | 129.25 | 14.070 | 3.9990 | 56.266 | 0.078 | 129.69 | 14.02 | 0.002 |
| ### | May 8, 2012 | 11:38:51 AM | 14.02 | 3.999 | 8.6898 | 3.505 | 56.066 | 0.078 | 129.33 | 14.070 | 3.9990 | 56.266 | 0.078 | 129.76 | 14.02 | 0.003 |
| ### | May 8, 2012 | 11:38:56 AM | 14.02 | 3.999 | 8.6953 | 3.505 | 56.066 | 0.078 | 129.41 | 14.070 | 3.9990 | 56.266 | 0.078 | 129.84 | 14.02 | 0.004 |
| ### | May 8, 2012 | 11:39:01 AM | 14.02 | 3.999 | 8.7009 | 3.505 | 56.066 | 0.078 | 129.48 | 14.070 | 3.9990 | 56.266 | 0.078 | 129.92 | 14.02 | 0.005 |
| ### | May 8, 2012 | 11:39:06 AM | 14.01 | 3.999 | 8.7064 | 3.503 | 56.026 | 0.078 | 129.56 | 14.060 | 3.9990 | 56.266 | 0.078 | 130.00 | 14.01 | −0.005 |
| ### | May 8, 2012 | 11:39:11 AM | 14.01 | 3.999 | 8.7120 | 3.503 | 56.026 | 0.078 | 129.64 | 14.060 | 3.9990 | 56.266 | 0.078 | 130.08 | 14.01 | −0.004 |
| ### | May 8, 2012 | 11:39:16 AM | 14.01 | 3.999 | 8.7175 | 3.503 | 56.026 | 0.078 | 129.72 | 14.060 | 3.9990 | 56.266 | 0.078 | 130.15 | 14.01 | −0.003 |
| ### | May 8, 2012 | 11:39:21 AM | 14.01 | 3.999 | 8.7230 | 3.503 | 56.026 | 0.078 | 129.80 | 14.060 | 3.9990 | 56.266 | 0.078 | 130.23 | 14.01 | −0.002 |
| ### | May 8, 2012 | 11:39:26 AM | 14.01 | 3.999 | 8.7286 | 3.503 | 56.026 | 0.078 | 129.87 | 14.060 | 3.9990 | 56.266 | 0.078 | 130.31 | 14.01 | −0.001 |
| ### | May 8, 2012 | 11:39:31 AM | 14.01 | 3.999 | 8.7341 | 3.503 | 56.026 | 0.078 | 129.95 | 14.060 | 3.9990 | 56.266 | 0.078 | 130.39 | 14.01 | 0.000 |
| ### | May 8, 2012 | 11:39:36 AM | 14.01 | 3.999 | 8.7397 | 3.503 | 56.026 | 0.078 | 130.03 | 14.060 | 3.9990 | 56.266 | 0.078 | 130.47 | 14.01 | 0.001 |
| ### | May 8, 2012 | 11:39:41 AM | 14.01 | 3.999 | 8.7452 | 3.503 | 56.026 | 0.078 | 130.11 | 14.060 | 3.9990 | 56.266 | 0.078 | 130.54 | 14.01 | 0.002 |
| ### | May 8, 2012 | 11:39:46 AM | 14.01 | 3.999 | 8.7508 | 3.503 | 56.026 | 0.078 | 130.18 | 14.060 | 3.9990 | 56.266 | 0.078 | 130.62 | 14.01 | 0.003 |
| ### | May 8, 2012 | 11:39:51 AM | 14.01 | 3.999 | 8.7563 | 3.503 | 56.026 | 0.078 | 130.26 | 14.060 | 3.9990 | 56.266 | 0.078 | 130.70 | 14.01 | 0.004 |
| ### | May 8, 2012 | 11:39:56 AM | 14.01 | 3.999 | 8.7619 | 3.503 | 56.026 | 0.078 | 130.34 | 14.060 | 3.9990 | 56.266 | 0.078 | 130.78 | 14.01 | 0.005 |
| ### | May 8, 2012 | 11:40:01 AM | 14.00 | 3.999 | 8.7674 | 3.500 | 56.986 | 0.078 | 130.42 | 14.050 | 3.9990 | 56.186 | 0.078 | 130.86 | 14.00 | −0.005 |
| ### | May 8, 2012 | 11:40:06 AM | 14.00 | 3.999 | 8.7730 | 3.500 | 56.986 | 0.078 | 130.50 | 14.050 | 3.9990 | 56.186 | 0.078 | 130.93 | 14.00 | −0.004 |
| ### | May 8, 2012 | 11:40:11 AM | 14.00 | 3.999 | 8.7785 | 3.500 | 56.986 | 0.078 | 130.57 | 14.050 | 3.9990 | 56.186 | 0.078 | 131.01 | 14.00 | −0.003 |
| ### | May 8, 2012 | 11:40:16 AM | 14.00 | 3.999 | 8.7840 | 3.500 | 56.986 | 0.078 | 130.65 | 14.050 | 3.9990 | 56.186 | 0.078 | 131.09 | 14.00 | −0.002 |
| ### | May 8, 2012 | 11:40:21 AM | 14.00 | 3.999 | 8.7896 | 3.500 | 56.986 | 0.078 | 130.73 | 14.050 | 3.9990 | 56.186 | 0.078 | 131.17 | 14.00 | −0.001 |
| ### | May 8, 2012 | 11:40:26 AM | 14.00 | 3.999 | 8.7951 | 3.500 | 56.986 | 0.078 | 130.81 | 14.050 | 3.9990 | 56.186 | 0.078 | 131.25 | 14.00 | 0.001 |
| ### | May 8, 2012 | 11:40:31 AM | 14.00 | 3.999 | 8.8007 | 3.500 | 56.986 | 0.078 | 130.88 | 14.050 | 3.9990 | 56.186 | 0.078 | 131.33 | 14.00 | 0.002 |
| ### | May 8, 2012 | 11:40:36 AM | 14.00 | 3.999 | 8.8062 | 3.500 | 56.986 | 0.078 | 130.96 | 14.050 | 3.9990 | 56.186 | 0.078 | 131.40 | 14.00 | 0.003 |
| ### | May 8, 2012 | 11:40:41 AM | 14.00 | 3.999 | 8.8118 | 3.500 | 55.986 | 0.078 | 13 [symbol] | 14.050 | 3.9990 | 56.186 | 0.078 | 131.48 | 14.00 | 0.004 |
| ### | May 8, 2012 | 11:40:46 AM | 14.00 | 3.999 | 8.8173 | 3.500 | 55.986 | 0.078 | 131.12 | 14.050 | 3.9990 | 56.186 | 0.078 | 131.56 | 14.00 | 0.005 |
| ### | May 8, 2012 | 11:40:51 AM | 13.99 | 3.999 | 8.8229 | 3.498 | 55.946 | 0.078 | 131.20 | 14.040 | 3.9990 | 56.146 | 0.078 | 131.64 | 13.99 | −0.005 |
| ### | May 8, 2012 | 11:40:56 AM | 13.99 | 3.999 | 8.8284 | 3.498 | 55.946 | 0.078 | 131.27 | 14.040 | 3.9990 | 56.146 | 0.078 | 131.72 | 13.99 | −0.004 |
| ### | May 8, 2012 | 11:41:01 AM | 13.99 | 3.999 | 8.8341 | 3.498 | 55.946 | 0.078 | 131.35 | 14.040 | 3.9990 | 56.146 | 0.078 | 131.79 | 13.99 | −0.003 |
| ### | May 8, 2012 | 11:41:06 AM | 13.99 | 3.999 | 8.8395 | 3.498 | 55.946 | 0.078 | 131.43 | 14.040 | 3.9990 | 56.146 | 0.078 | 131.87 | 13.99 | −0.002 |
| ### | May 8, 2012 | 11:41:11 AM | 13.99 | 3.999 | 8.8450 | 3.498 | 55.946 | 0.078 | 131.51 | 14.040 | 3.9990 | 56.146 | 0.078 | 131.95 | 13.99 | 0.000 |
| ### | May 8, 2012 | 11:41:16 AM | 13.99 | 3.999 | 8.8506 | 3.498 | 55.946 | 0.078 | 131.58 | 14.040 | 3.9990 | 56.146 | 0.078 | 132.03 | 13.99 | 0.002 |
| ### | May 8, 2012 | 11:41:21 AM | 13.99 | 3.999 | 8.8561 | 3.498 | 55.946 | 0.078 | 131.66 | 14.040 | 3.9990 | 56.146 | 0.078 | 132.11 | 13.99 | 0.003 |
| ### | May 8, 2012 | 11:41:26 AM | 13.99 | 3.999 | 8.8617 | 3.498 | 55.946 | 0.078 | 131.74 | 14.040 | 3.9990 | 56.146 | 0.078 | 132.18 | 13.99 | 0.004 |
| ### | May 8, 2012 | 11:41:31 AM | 13.99 | 3.999 | 8.8672 | 3.498 | 55.946 | 0.078 | 131.82 | 14.040 | 3.9990 | 56.146 | 0.078 | 132.26 | 13.99 | 0.005 |
| ### | May 8, 2012 | 11:41:36 AM | 13.98 | 3.999 | 8.8728 | 3.495 | 55.906 | 0.078 | 131.89 | 14.030 | 3.9990 | 56.106 | 0.078 | 132.34 | 13.98 | −0.005 |
| ### | May 8, 2012 | 11:41:41 AM | 13.98 | 3.999 | 8.8783 | 3.495 | 55.906 | 0.078 | 131.97 | 14.030 | 3.9990 | 56.106 | 0.078 | 132.42 | 13.98 | −0.004 |
| ### | May 8, 2012 | 11:41:46 AM | 13.98 | 3.999 | 8.8839 | 3.495 | 55.906 | 0.078 | 132.05 | 14.030 | 3.9990 | 56.106 | 0.078 | 132.49 | 13.98 | −0.003 |
| ### | May 8, 2012 | 11:41:51 AM | 13.98 | 3.999 | 8.8894 | 3.495 | 55.906 | 0.078 | 132.13 | 14.030 | 3.9990 | 56.106 | 0.078 | 132.57 | 13.98 | −0.002 |
| ### | May 8, 2012 | 11:41:56 AM | 13.98 | 3.999 | 8.8949 | 3.495 | 55.906 | 0.078 | 132.21 | 14.030 | 3.9990 | 56.106 | 0.078 | 132.65 | 13.98 | −0.001 |
| ### | May 8, 2012 | 11:42:01 AM | 13.98 | 3.999 | 8.9005 | 3.495 | 55.906 | 0.078 | 132.28 | 14.030 | 3.9990 | 56.106 | 0.078 | 132.73 | 13.98 | 0.001 |
| ### | May 8, 2012 | 11:42:06 AM | 13.98 | 3.999 | 8.9060 | 3.495 | 55.906 | 0.078 | 132.36 | 14.030 | 3.9990 | 56.106 | 0.078 | 132.81 | 13.98 | 0.002 |
| ### | May 8, 2012 | 11:42:11 AM | 13.98 | 3.999 | 8.9116 | 3.495 | 55.906 | 0.078 | 132.44 | 14.030 | 3.9990 | 56.106 | 0.078 | 132.88 | 13.98 | 0.003 |
| ### | May 8, 2012 | 11:42:16 AM | 13.98 | 3.999 | 8.9171 | 3.495 | 55.906 | 0.078 | 132.52 | 14.030 | 3.9990 | 56.106 | 0.078 | 132.96 | 13.98 | 0.004 |
| ### | May 8, 2012 | 11:42:21 AM | 13.98 | 3.999 | 8.9227 | 3.495 | 55.906 | 0.078 | 132.59 | 14.030 | 3.9990 | 56.106 | 0.078 | 133.04 | 13.98 | 0.005 |
| ### | May 8, 2012 | 11:42:26 AM | 13.97 | 3.999 | 8.9282 | 3.493 | 55.866 | 0.078 | 132.67 | 14.020 | 3.9990 | 56.066 | 0.078 | 133.12 | 13.97 | −0.005 |
| ### | May 8, 2012 | 11:42:31 AM | 13.97 | 3.999 | 8.9338 | 3.493 | 55.866 | 0.078 | 132.75 | 14.020 | 3.9990 | 56.066 | 0.078 | 133.20 | 13.97 | −0.004 |
| ### | May 8, 2012 | 11:42:36 AM | 13.97 | 3.999 | 8.9393 | 3.493 | 55.866 | 0.078 | 132.83 | 14.020 | 3.9990 | 56.066 | 0.078 | 133.27 | 13.97 | −0.003 |
| ### | May 8, 2012 | 11:42:41 AM | 13.97 | 3.999 | 8.9449 | 3.493 | 55.866 | 0.078 | 132.90 | 14.020 | 3.9990 | 56.066 | 0.078 | 133.35 | 13.97 | −0.002 |
| ### | May 8, 2012 | 11:42:46 AM | 13.97 | 3.999 | 8.9504 | 3.493 | 55.866 | 0.078 | 132.98 | 14.020 | 3.9990 | 56.066 | 0.078 | 133.43 | 13.97 | −0.001 |
| ### | May 8, 2012 | 11:42:51 AM | 13.97 | 3.999 | 8.9560 | 3.493 | 55.866 | 0.078 | 133.06 | 14.020 | 3.9990 | 56.066 | 0.078 | 133.51 | 13.97 | 0.001 |
| ### | May 8, 2012 | 11:42:56 AM | 13.97 | 3.999 | 8.9615 | 3.493 | 55.866 | 0.078 | 133.14 | 14.020 | 3.9990 | 56.066 | 0.078 | 133.59 | 13.97 | 0.002 |
| ### | May 8, 2012 | 11:43:01 AM | 13.97 | 3.999 | 8.9671 | 3.493 | 55.866 | 0.078 | 133.21 | 14.020 | 3.9990 | 56.066 | 0.078 | 133.66 | 13.97 | 0.003 |
| ### | May 8, 2012 | 11:43:06 AM | 13.97 | 3.999 | 8.9726 | 3.493 | 55.866 | 0.078 | 133.29 | 14.020 | 3.9990 | 56.066 | 0.078 | 133.74 | 13.97 | 0.004 |
| ### | May 8, 2012 | 11:43:11 AM | 13.97 | 3.999 | 8.9781 | 3.493 | 55.866 | 0.078 | 133.37 | 14.020 | 3.9990 | 56.066 | 0.078 | 133.82 | 13.97 | 0.005 |
| ### | May 8, 2012 | 11:43:16 AM | 13.96 | 3.999 | 8.9837 | 3.490 | 55.826 | 0.078 | 133.45 | 14.010 | 3.9990 | 56.026 | 0.078 | 133.90 | 13.96 | −0.005 |
| ### | May 8, 2012 | 11:43:21 AM | 13.96 | 3.999 | 8.9892 | 3.490 | 55.826 | 0.078 | 133.52 | 14.010 | 3.9990 | 56.026 | 0.078 | 133.97 | 13.96 | −0.004 |
| ### | May 8, 2012 | 11:43:26 AM | 13.96 | 3.999 | 8.9948 | 3.490 | 55.826 | 0.078 | 133.60 | 14.010 | 3.9990 | 56.026 | 0.078 | 134.05 | 13.96 | −0.003 |
| ### | May 8, 2012 | 11:43:31 AM | 13.96 | 3.999 | 9.0003 | 3.490 | 55.826 | 0.078 | 133.68 | 14.010 | 3.9990 | 56.026 | 0.078 | 134.13 | 13.96 | −0.002 |
| ### | May 8, 2012 | 11:43:36 AM | 13.96 | 3.999 | 9.0059 | 3.490 | 55.826 | 0.078 | 133.76 | 14.010 | 3.9990 | 56.026 | 0.078 | 134.21 | 13.96 | −0.001 |
| ### | May 8, 2012 | 11:43:41 AM | 13.96 | 3.999 | 9.0114 | 3.490 | 55.826 | 0.078 | 133.83 | 14.010 | 3.9990 | 56.026 | 0.078 | 134.29 | 13.96 | 0.001 |
| ### | May 8, 2012 | 11:43:46 AM | 13.96 | 3.999 | 9.0169 | 3.490 | 55.826 | 0.078 | 133.91 | 14.010 | 3.9990 | 56.026 | 0.078 | 134.36 | 13.96 | 0.002 |
| ### | May 8, 2012 | 11:43:51 AM | 13.96 | 3.999 | 9.0225 | 3.490 | 55.826 | 0.078 | 133.99 | 14.010 | 3.9990 | 56.026 | 0.078 | 134.44 | 13.96 | 0.003 |
| ### | May 8, 2012 | 11:43:56 AM | 13.96 | 3.999 | 9.0280 | 3.490 | 55.826 | 0.078 | 134.07 | 14.010 | 3.9990 | 56.026 | 0.078 | 134.52 | 13.96 | 0.004 |
| ### | May 8, 2012 | 11:44:01 AM | 13.96 | 3.999 | 9.0336 | 3.490 | 55.826 | 0.078 | 134.14 | 14.010 | 3.9990 | 56.026 | 0.078 | 134.60 | 13.96 | 0.005 |
| ### | May 8, 2012 | 11:44:06 AM | 13.95 | 3.999 | 9.0391 | 3.488 | 55.786 | 0.077 | 134.22 | 14.000 | 3.9990 | 55.986 | 0.078 | 134.67 | 13.95 | −0.005 |
| ### | May 8, 2012 | 11:44:11 AM | 13.95 | 3.999 | 9.0447 | 3.488 | 55.786 | 0.077 | 134.30 | 14.000 | 3.9990 | 55.986 | 0.078 | 134.75 | 13.95 | −0.004 |
| ### | May 8, 2012 | 11:44:16 AM | 13.95 | 3.999 | 9.0502 | 3.488 | 55.786 | 0.077 | 134.38 | 14.000 | 3.9990 | 55.986 | 0.078 | 134.83 | 13.95 | −0.003 |
| ### | May 8, 2012 | 11:44:21 AM | 13.95 | 3.999 | 9.0557 | 3.488 | 55.786 | 0.077 | 134.45 | 14.000 | 3.9990 | 55.986 | 0.078 | 134.91 | 13.95 | −0.002 |
| ### | May 8, 2012 | 11:44:26 AM | 13.95 | 3.999 | 9.0613 | 3.488 | 55.786 | 0.077 | 134.53 | 14.000 | 3.9990 | 55.986 | 0.078 | 134.99 | 13.95 | −0.001 |
| ### | May 8, 2012 | 11:44:31 AM | 13.95 | 3.999 | 9.0668 | 3.488 | 55.786 | 0.077 | 134.61 | 14.000 | 3.9990 | 55.986 | 0.078 | 135.06 | 13.95 | 0.000 |
| ### | May 8, 2012 | 11:44:36 AM | 13.95 | 3.999 | 9.0724 | 3.488 | 55.786 | 0.077 | 134.69 | 14.000 | 3.9990 | 55.986 | 0.078 | 135.14 | 13.95 | 0.000 |
| ### | May 8, 2012 | 11:44:41 AM | 13.95 | 3.999 | 9.0779 | 3.488 | 55.786 | 0.077 | 134.76 | 14.000 | 3.9990 | 55.986 | 0.078 | 135.22 | 13.95 | 0.000 |
| ### | May 8, 2012 | 11:44:46 AM | 13.95 | 3.999 | 9.0835 | 3.488 | 55.786 | 0.077 | 134.84 | 14.000 | 3.9990 | 55.986 | 0.078 | 135.30 | 13.95 | 0.001 |
| ### | May 8, 2012 | 11:44:51 AM | 13.95 | 3.999 | 9.0890 | 3.488 | 55.786 | 0.077 | 134.92 | 14.000 | 3.9990 | 55.986 | 0.078 | 135.37 | 13.95 | 0.002 |
| ### | May 8, 2012 | 11:44:56 AM | 13.95 | 3.999 | 9.0946 | 3.488 | 55.786 | 0.077 | 135.00 | 14.000 | 3.9990 | 55.986 | 0.078 | 135.45 | 13.95 | 0.003 |
| ### | May 8, 2012 | 11:45:01 AM | 13.95 | 3.999 | 9.1001 | 3.488 | 55.786 | 0.077 | 135.07 | 14.000 | 3.9990 | 55.986 | 0.078 | 135.53 | 13.95 | 0.004 |
| ### | May 8, 2012 | 11:45:06 AM | 13.95 | 3.999 | 9.1057 | 3.488 | 55.786 | 0.077 | 135.15 | 14.000 | 3.9990 | 55.986 | 0.078 | 135.61 | 13.95 | 0.005 |
| ### | May 8, 2012 | 11:45:11 AM | 13.94 | 3.999 | 9.1112 | 3.485 | 55.746 | 0.077 | 135.23 | 13.990 | 3.9990 | 55.946 | 0.078 | 135.69 | 13.94 | −0.005 |
| ### | May 8, 2012 | 11:45:16 AM | 13.94 | 3.999 | 9.1167 | 3.485 | 55.746 | 0.077 | 135.31 | 13.990 | 3.9990 | 55.946 | 0.078 | 135.76 | 13.94 | −0.004 |
| ### | May 8, 2012 | 11:45:21 AM | 13.94 | 3.999 | 9.1223 | 3.485 | 55.746 | 0.077 | 135.38 | 13.990 | 3.9990 | 55.946 | 0.078 | 135.84 | 13.94 | −0.003 |
| ### | May 8, 2012 | 11:45:26 AM | 13.94 | 3.999 | 9.1278 | 3.485 | 55.746 | 0.077 | 135.46 | 13.990 | 3.9990 | 55.946 | 0.078 | 135.92 | 13.94 | −0.002 |
| ### | May 8, 2012 | 11:45:31 AM | 13.94 | 3.999 | 9.1334 | 3.485 | 55.746 | 0.077 | 135.54 | 13.990 | 3.9990 | 55.946 | 0.078 | 136.00 | 13.94 | −0.001 |
| ### | May 8, 2012 | 11:45:36 AM | 13.94 | 3.999 | 9.1389 | 3.485 | 55.746 | 0.077 | 135.62 | 13.990 | 3.9990 | 55.946 | 0.078 | 136.07 | 13.94 | 0.001 |
| ### | May 8, 2012 | 11:45:41 AM | 13.94 | 3.999 | 9.1445 | 3.485 | 55.746 | 0.077 | 135.69 | 13.990 | 3.9990 | 55.946 | 0.078 | 136.15 | 13.94 | 0.002 |
| ### | May 8, 2012 | 11:45:46 AM | 13.94 | 3.999 | 9.1500 | 3.485 | 55.746 | 0.077 | 135.77 | 13.990 | 3.9990 | 55.946 | 0.078 | 136.23 | 13.94 | 0.003 |
| ### | May 8, 2012 | 11:45:51 AM | 13.94 | 3.999 | 9.1556 | 3.485 | 55.746 | 0.077 | 135.85 | 13.990 | 3.9990 | 55.946 | 0.078 | 136.31 | 13.94 | 0.004 |
| ### | May 8, 2012 | 11:45:56 AM | 13.94 | 3.999 | 9.1611 | 3.485 | 55.746 | 0.077 | 135.93 | 13.990 | 3.9990 | 55.946 | 0.078 | 136.39 | 13.94 | 0.005 |
| ### | May 8, 2012 | 11:46:01 AM | 13.93 | 3.999 | 9.1666 | 3.483 | 55.706 | 0.077 | 136.00 | 13.980 | 3.9990 | 55.906 | 0.078 | 136.46 | 13.93 | −0.005 |
| ### | May 8, 2012 | 11:46:06 AM | 13.93 | 3.999 | 9.1722 | 3.483 | 55.706 | 0.077 | 136.08 | 13.980 | 3.9990 | 55.906 | 0.078 | 136.54 | 13.93 | −0.004 |
| ### | May 8, 2012 | 11:46:11 AM | 13.93 | 3.999 | 9.1777 | 3.483 | 55.706 | 0.077 | 136.16 | 13.980 | 3.9990 | 55.906 | 0.078 | 136.62 | 13.93 | −0.003 |
| ### | May 8, 2012 | 11:46:16 AM | 13.93 | 3.999 | 9.1833 | 3.483 | 55.706 | 0.077 | 136.24 | 13.980 | 3.9990 | 55.906 | 0.078 | 136.70 | 13.93 | −0.002 |
| ### | May 8, 2012 | 11:46:21 AM | 13.93 | 3.999 | 9.1888 | 3.483 | 55.706 | 0.077 | 136.31 | 13.980 | 3.9990 | 55.906 | 0.078 | 136.77 | 13.93 | −0.001 |
| ### | May 8, 2012 | 11:46:26 AM | 13.93 | 3.999 | 9.1944 | 3.483 | 55.706 | 0.077 | 136.39 | 13.980 | 3.9990 | 55.906 | 0.078 | 136.85 | 13.93 | 0.000 |
| ### | May 8, 2012 | 11:46:31 AM | 13.93 | 3.999 | 9.1999 | 3.483 | 55.706 | 0.077 | 136.47 | 13.980 | 3.9990 | 55.906 | 0.078 | 136.93 | 13.93 | 0.001 |
| ### | May 8, 2012 | 11:46:36 AM | 13.93 | 3.999 | 9.2055 | 3.483 | 55.706 | 0.077 | 136.55 | 13.980 | 3.9990 | 55.906 | 0.078 | 137.01 | 13.93 | 0.002 |
| ### | May 8, 2012 | 11:46:41 AM | 13.93 | 3.999 | 9.2110 | 3.483 | 55.706 | 0.077 | 136.62 | 13.980 | 3.9990 | 55.906 | 0.078 | 137.08 | 13.93 | 0.003 |
| ### | May 8, 2012 | 11:46:46 AM | 13.93 | 3.999 | 9.2166 | 3.483 | 55.706 | 0.077 | 136.70 | 13.980 | 3.9990 | 55.906 | 0.078 | 137.16 | 13.93 | 0.004 |
| ### | May 8, 2012 | 11:46:51 AM | 13.93 | 3.999 | 9.2221 | 3.483 | 55.706 | 0.077 | 136.78 | 13.980 | 3.9990 | 55.906 | 0.078 | 137.24 | 13.93 | 0.005 |
| ### | May 8, 2012 | 11:46:56 AM | 13.92 | 3.999 | 9.2276 | 3.480 | 55.666 | 0.077 | 136.85 | 13.970 | 3.9990 | 55.866 | 0.078 | 137.32 | 13.92 | −0.005 |
| ### | May 8, 2012 | 11:47:01 AM | 13.92 | 3.999 | 9.2332 | 3.480 | 55.666 | 0.077 | 136.93 | 13.970 | 3.9990 | 55.866 | 0.078 | 137.39 | 13.92 | −0.004 |
| ### | May 8, 2012 | 11:47:06 AM | 13.92 | 3.999 | 9.2387 | 3.480 | 55.666 | 0.077 | 137.01 | 13.970 | 3.9990 | 55.866 | 0.078 | 137.47 | 13.92 | −0.003 |
| ### | May 8, 2012 | 11:47:11 AM | 13.92 | 3.999 | 9.2443 | 3.480 | 55.666 | 0.077 | 137.09 | 13.970 | 3.9990 | 55.866 | 0.078 | 137.55 | 13.92 | −0.002 |
| ### | May 8, 2012 | 11:47:16 AM | 13.92 | 3.999 | 9.2498 | 3.480 | 55.666 | 0.077 | 137.16 | 13.970 | 3.9990 | 55.866 | 0.078 | 137.63 | 13.92 | 0.000 |
| ### | May 8, 2012 | 11:47:21 AM | 13.92 | 3.999 | 9.2554 | 3.480 | 55.666 | 0.077 | 137.24 | 13.970 | 3.9990 | 55.866 | 0.078 | 137.70 | 13.92 | 0.002 |
| ### | May 8, 2012 | 11:47:26 AM | 13.92 | 3.999 | 9.2609 | 3.480 | 55.666 | 0.077 | 137.32 | 13.970 | 3.9990 | 55.866 | 0.078 | 137.78 | 13.92 | 0.003 |
| ### | May 8, 2012 | 11:47:31 AM | 13.92 | 3.999 | 9.2665 | 3.480 | 55.666 | 0.077 | 137.40 | 13.970 | 3.9990 | 55.866 | 0.078 | 137.86 | 13.92 | 0.004 |
| ### | May 8, 2012 | 11:47:36 AM | 13.92 | 3.999 | 9.2720 | 3.480 | 55.666 | 0.077 | 137.47 | 13.970 | 3.9990 | 55.866 | 0.078 | 137.94 | 13.92 | 0.005 |
| ### | May 8, 2012 | 11:47:41 AM | 13.91 | 3.999 | 9.2776 | 3.478 | 55.626 | 0.077 | 137.55 | 13.960 | 3.9990 | 55.826 | 0.078 | 138.02 | 13.91 | −0.005 |
| ### | May 8, 2012 | 11:47:46 AM | 13.91 | 3.999 | 9.2831 | 3.478 | 55.626 | 0.077 | 137.63 | 13.960 | 3.9990 | 55.826 | 0.078 | 138.09 | 13.91 | −0.004 |
| ### | May 8, 2012 | 11:47:51 AM | 13.91 | 3.999 | 9.2887 | 3.478 | 55.626 | 0.077 | 137.70 | 13.960 | 3.9990 | 55.826 | 0.078 | 138.17 | 13.91 | −0.003 |
| ### | May 8, 2012 | 11:47:56 AM | 13.91 | 3.999 | 9.2942 | 3.478 | 55.626 | 0.077 | 137.78 | 13.960 | 3.9990 | 55.826 | 0.078 | 138.25 | 13.91 | −0.002 |
| ### | May 8, 2012 | 11:48:01 AM | 13.91 | 3.999 | 9.2997 | 3.478 | 55.626 | 0.077 | 137.86 | 13.960 | 3.9990 | 55.826 | 0.078 | 138.33 | 13.91 | 0.000 |
| ### | May 8, 2012 | 11:48:06 AM | 13.91 | 3.999 | 9.3053 | 3.478 | 55.626 | 0.077 | 137.94 | 13.960 | 3.9990 | 55.826 | 0.078 | 138.40 | 13.91 | 0.002 |
| ### | May 8, 2012 | 11:48:11 AM | 13.91 | 3.999 | 9.3108 | 3.478 | 55.626 | 0.077 | 138.01 | 13.960 | 3.9990 | 55.826 | 0.078 | 138.48 | 13.91 | 0.003 |
| ### | May 8, 2012 | 11:48:16 AM | 13.91 | 3.999 | 9.3164 | 3.478 | 55.626 | 0.077 | 138.09 | 13.960 | 3.9990 | 55.826 | 0.078 | 138.56 | 13.91 | 0.004 |
| ### | May 8, 2012 | 11:48:21 AM | 13.91 | 3.999 | 9.3219 | 3.478 | 55.626 | 0.077 | 138.17 | 13.960 | 3.9990 | 55.826 | 0.078 | 138.64 | 13.91 | 0.005 |
| ### | May 8, 2012 | 11:48:26 AM | 13.90 | 3.999 | 9.3275 | 3.475 | 55.586 | 0.077 | 138.25 | 13.950 | 3.9990 | 55.786 | 0.077 | 138.71 | 13.90 | −0.005 |
| ### | May 8, 2012 | 11:48:31 AM | 13.90 | 3.999 | 9.3330 | 3.475 | 55.586 | 0.077 | 138.32 | 13.950 | 3.9990 | 55.786 | 0.077 | 138.79 | 13.90 | −0.004 |
| ### | May 8, 2012 | 11:48:36 AM | 13.90 | 3.999 | 9.3385 | 3.475 | 55.586 | 0.077 | 138.40 | 13.950 | 3.9990 | 55.786 | 0.077 | 138.87 | 13.90 | −0.003 |
| ### | May 8, 2012 | 11:48:41 AM | 13.90 | 3.999 | 9.3441 | 3.475 | 55.586 | 0.077 | 138.48 | 13.950 | 3.9990 | 55.786 | 0.077 | 138.95 | 13.90 | −0.002 |
| ### | May 8, 2012 | 11:48:46 AM | 13.90 | 3.999 | 9.3497 | 3.475 | 55.586 | 0.077 | 138.55 | 13.950 | 3.9990 | 55.786 | 0.077 | 139.02 | 13.90 | −0.001 |
| ### | May 8, 2012 | 11:48:51 AM | 13.90 | 3.999 | 9.3552 | 3.475 | 55.586 | 0.077 | 138.63 | 13.950 | 3.9990 | 55.786 | 0.077 | 139.10 | 13.90 | 0.001 |
| ### | May 8, 2012 | 11:48:56 AM | 13.90 | 3.999 | 9.3607 | 3.475 | 55.586 | 0.077 | 138.71 | 13.950 | 3.9990 | 55.786 | 0.077 | 139.18 | 13.90 | 0.002 |
| ### | May 8, 2012 | 11:49:01 AM | 13.90 | 3.999 | 9.3663 | 3.475 | 55.586 | 0.077 | 138.79 | 13.950 | 3.9990 | 55.786 | 0.077 | 139.26 | 13.90 | 0.003 |
| ### | May 8, 2012 | 11:49:06 AM | 13.90 | 3.999 | 9.3718 | 3.475 | 55.586 | 0.077 | 138.86 | 13.950 | 3.9990 | 55.786 | 0.077 | 139.33 | 13.90 | 0.004 |
| ### | May 8, 2012 | 11:49:11 AM | 13.90 | 3.999 | 9.3774 | 3.475 | 55.586 | 0.077 | 138.94 | 13.950 | 3.9990 | 55.786 | 0.077 | 139.41 | 13.90 | 0.005 |
| ### | May 8, 2012 | 11:49:16 AM | 13.89 | 3.999 | 9.3829 | 3.473 | 55.546 | 0.077 | 139.02 | 13.940 | 3.9990 | 55.746 | 0.077 | 139.49 | 13.89 | −0.005 |
| ### | May 8, 2012 | 11:49:21 AM | 13.89 | 3.999 | 9.3885 | 3.473 | 55.546 | 0.077 | 139.09 | 13.940 | 3.9990 | 55.746 | 0.077 | 139.56 | 13.89 | −0.004 |
| ### | May 8, 2012 | 11:49:26 AM | 13.89 | 3.999 | 9.3940 | 3.473 | 55.546 | 0.077 | 139.17 | 13.940 | 3.9990 | 55.746 | 0.077 | 139.64 | 13.89 | −0.003 |
| ### | May 8, 2012 | 11:49:31 AM | 13.89 | 3.999 | 9.3995 | 3.473 | 55.546 | 0.077 | 139.25 | 13.940 | 3.9990 | 55.746 | 0.077 | 139.72 | 13.89 | −0.002 |
| ### | May 8, 2012 | 11:49:36 AM | 13.89 | 3.999 | 9.4051 | 3.473 | 55.546 | 0.077 | 139.33 | 13.940 | 3.9990 | 55.746 | 0.077 | 139.80 | 13.89 | 0.000 |
| ### | May 8, 2012 | 11:49:41 AM | 13.89 | 3.999 | 9.4106 | 3.473 | 55.546 | 0.077 | 139.40 | 13.940 | 3.9990 | 55.746 | 0.077 | 139.87 | 13.89 | 0.002 |
| ### | May 8, 2012 | 11:49:46 AM | 13.89 | 3.999 | 9.4162 | 3.473 | 55.546 | 0.077 | 139.48 | 13.940 | 3.9990 | 55.746 | 0.077 | 139.95 | 13.89 | 0.003 |
| ### | May 8, 2012 | 11:49:51 AM | 13.89 | 3.999 | 9.4217 | 3.473 | 55.546 | 0.077 | 139.56 | 13.940 | 3.9990 | 55.746 | 0.077 | 140.03 | 13.89 | 0.004 |
| ### | May 8, 2012 | 11:49:56 AM | 13.89 | 3.999 | 9.4273 | 3.473 | 55.546 | 0.077 | 139.63 | 13.940 | 3.9990 | 55.746 | 0.077 | 140.11 | 13.89 | 0.005 |
| ### | May 8, 2012 | 11:50:01 AM | 13.88 | 3.999 | 9.4328 | 3.470 | 55.506 | 0.077 | 139.71 | 13.930 | 3.9990 | 55.706 | 0.077 | 140.18 | 13.88 | −0.005 |
| ### | May 8, 2012 | 11:50:06 AM | 13.88 | 3.999 | 9.4384 | 3.470 | 55.506 | 0.077 | 139.79 | 13.930 | 3.9990 | 55.706 | 0.077 | 140.26 | 13.88 | −0.004 |
| ### | May 8, 2012 | 11:50:11 AM | 13.88 | 3.999 | 9.4439 | 3.470 | 55.506 | 0.077 | 139.87 | 13.930 | 3.9990 | 55.706 | 0.077 | 140.34 | 13.88 | −0.003 |
| ### | May 8, 2012 | 11:50:16 AM | 13.88 | 3.999 | 9.4494 | 3.470 | 55.506 | 0.077 | 139.94 | 13.930 | 3.9990 | 55.706 | 0.077 | 140.42 | 13.88 | −0.002 |
| ### | May 8, 2012 | 11:50:21 AM | 13.88 | 3.999 | 9.4550 | 3.470 | 55.506 | 0.077 | 140.02 | 13.930 | 3.9990 | 55.706 | 0.077 | 140.49 | 13.88 | −0.001 |
| ### | May 8, 2012 | 11:50:26 AM | 13.88 | 3.999 | 9.4605 | 3.470 | 55.506 | 0.077 | 140.10 | 13.930 | 3.9990 | 55.706 | 0.077 | 140.57 | 13.88 | 0.000 |
| ### | May 8, 2012 | 11:50:31 AM | 13.88 | 3.999 | 9.4661 | 3.470 | 55.506 | 0.077 | 140.17 | 13.930 | 3.9990 | 55.706 | 0.077 | 140.65 | 13.88 | 0.000 |
| ### | May 8, 2012 | 11:50:36 AM | 13.88 | 3.999 | 9.4716 | 3.470 | 55.506 | 0.077 | 140.25 | 13.930 | 3.9990 | 55.706 | 0.077 | 140.73 | 13.88 | 0.000 |
| ### | May 8, 2012 | 11:50:41 AM | 13.88 | 3.999 | 9.4772 | 3.470 | 55.506 | 0.077 | 140.33 | 13.930 | 3.9990 | 55.706 | 0.077 | 140.80 | 13.88 | 0.001 |
| ### | May 8, 2012 | 11:50:46 AM | 13.88 | 3.999 | 9.4827 | 3.470 | 55.506 | 0.077 | 140.41 | 13.930 | 3.9990 | 55.706 | 0.077 | 140.88 | 13.88 | 0.002 |
| ### | May 8, 2012 | 11:50:51 AM | 13.88 | 3.999 | 9.4883 | 3.470 | 55.506 | 0.077 | 140.48 | 13.930 | 3.9990 | 55.706 | 0.077 | 140.96 | 13.88 | 0.003 |
| ### | May 8, 2012 | 11:50:56 AM | 13.88 | 3.999 | 9.4940 | 3.470 | 55.506 | 0.077 | 140.56 | 13.930 | 3.9990 | 55.706 | 0.077 | 141.04 | 13.88 | 0.004 |
| ### | May 8, 2012 | 11:51:01 AM | 13.88 | 3.999 | 9.4995 | 3.470 | 55.506 | 0.077 | 140.64 | 13.930 | 3.9990 | 55.706 | 0.077 | 141.11 | 13.88 | 0.005 |
| ### | May 8, 2012 | 11:51:06 AM | 13.87 | 3.999 | 9.5051 | 3.468 | 55.466 | 0.077 | 140.71 | 13.920 | 3.9990 | 55.666 | 0.077 | 141.19 | 13.87 | −0.005 |
| ### | May 8, 2012 | 11:51:11 AM | 13.87 | 3.999 | 9.5106 | 3.468 | 55.466 | 0.077 | 140.79 | 13.920 | 3.9990 | 55.666 | 0.078 | 141.27 | 13.87 | −0.004 |
| ### | May 8, 2012 | 11:51:16 AM | 13.87 | 3.999 | 9.5162 | 3.468 | 55.466 | 0.077 | 140.87 | 13.920 | 3.9990 | 55.666 | 0.078 | 141.34 | 13.87 | −0.003 |
| ### | May 8, 2012 | 11:51:21 AM | 13.87 | 3.999 | 9.5217 | 3.468 | 55.466 | 0.077 | 140.95 | 13.920 | 3.9990 | 55.666 | 0.078 | 141.42 | 13.87 | −0.001 |
| ### | May 8, 2012 | 11:51:26 AM | 13.87 | 3.999 | 9.5273 | 3.468 | 55.466 | 0.077 | 141.02 | 13.920 | 3.9990 | 55.666 | 0.078 | 141.50 | 13.87 | 0.001 |
| ### | May 8, 2012 | 11:51:31 AM | 13.87 | 3.999 | 9.5328 | 3.468 | 55.466 | 0.077 | 141.10 | 13.920 | 3.9990 | 55.666 | 0.078 | 141.58 | 13.87 | 0.003 |
| ### | May 8, 2012 | 11:51:36 AM | 13.87 | 3.999 | 9.5383 | 3.468 | 55.466 | 0.077 | 141.18 | 13.920 | 3.9990 | 55.666 | 0.078 | 141.65 | 13.87 | 0.004 |
| ### | May 8, 2012 | 11:51:41 AM | 13.87 | 3.999 | 9.5439 | 3.468 | 55.466 | 0.077 | 141.25 | 13.920 | 3.9990 | 55.666 | 0.078 | 141.73 | 13.87 | 0.005 |
| ### | May 8, 2012 | 11:51:46 AM | 13.86 | 3.999 | 9.5494 | 3.465 | 55.426 | 0.077 | 141.33 | 13.910 | 3.9990 | 55.626 | 0.078 | 141.81 | 13.86 | −0.005 |
| ### | May 8, 2012 | 11:51:51 AM | 13.86 | 3.999 | 9.5550 | 3.465 | 55.426 | 0.077 | 141.41 | 13.910 | 3.9990 | 55.626 | 0.078 | 141.89 | 13.86 | −0.004 |
| ### | May 8, 2012 | 11:51:56 AM | 13.86 | 3.999 | 9.5605 | 3.465 | 55.426 | 0.077 | 141.48 | 13.910 | 3.9990 | 55.626 | 0.078 | 141.96 | 13.86 | −0.003 |
| ### | May 8, 2012 | 11:52:01 AM | 13.86 | 4.000 | 9.5661 | 3.465 | 55.440 | 0.077 | 141.56 | 13.910 | 4.0000 | 55.640 | 0.078 | 142.04 | 13.86 | −0.002 |
| ### | May 8, 2012 | 11:52:06 AM | 13.86 | 3.999 | 9.5716 | 3.465 | 55.426 | 0.077 | 141.64 | 13.910 | 3.9990 | 55.626 | 0.078 | 142.12 | 13.86 | −0.001 |
| ### | May 8, 2012 | 11:52:11 AM | 13.86 | 3.999 | 9.5772 | 3.465 | 55.426 | 0.077 | 141.72 | 13.910 | 3.9990 | 55.626 | 0.078 | 142.19 | 13.86 | 0.000 |
| ### | May 8, 2012 | 11:52:16 AM | 13.86 | 3.999 | 9.5827 | 3.465 | 55.426 | 0.077 | 141.79 | 13.910 | 3.9990 | 55.626 | 0.078 | 142.27 | 13.86 | 0.001 |
| ### | May 8, 2012 | 11:52:21 AM | 13.86 | 4.000 | 9.5882 | 3.465 | 55.440 | 0.077 | 141.87 | 13.910 | 4.0000 | 55.640 | 0.078 | 142.35 | 13.86 | 0.001 |
| ### | May 8, 2012 | 11:52:26 AM | 13.86 | 3.999 | 9.5938 | 3.465 | 55.426 | 0.077 | 141.95 | 13.910 | 3.9990 | 55.626 | 0.078 | 142.43 | 13.86 | 0.002 |
| ### | May 8, 2012 | 11:52:31 AM | 13.86 | 3.999 | 9.5993 | 3.465 | 55.426 | 0.077 | 142.02 | 13.910 | 3.9990 | 55.626 | 0.078 | 142.50 | 13.86 | 0.003 |
| ### | May 8, 2012 | 11:52:36 AM | 13.86 | 3.999 | 9.6049 | 3.465 | 55.426 | 0.077 | 142.10 | 13.910 | 3.9990 | 55.626 | 0.078 | 142.58 | 13.86 | 0.004 |
| ### | May 8, 2012 | 11:52:41 AM | 13.85 | 3.999 | 9.6102 | 3.463 | 55.386 | 0.077 | 142.18 | 13.900 | 3.9990 | 55.586 | 0.078 | 142.66 | 13.86 | −0.005 |
| ### | May 8, 2012 | 11:52:46 AM | 13.86 | 3.999 | 9.6158 | 3.463 | 55.426 | 0.077 | 142.25 | 13.910 | 3.9990 | 55.626 | 0.078 | 142.74 | 13.85 | 0.005 |
| ### | May 8, 2012 | 11:52:51 AM | 13.85 | 3.999 | 9.6213 | 3.463 | 55.386 | 0.077 | 142.33 | 13.900 | 3.9990 | 55.586 | 0.078 | 142.81 | 13.85 | −0.004 |
| ### | May 8, 2012 | 11:52:56 AM | 13.85 | 3.999 | 9.6269 | 3.463 | 55.386 | 0.077 | 142.41 | 13.900 | 3.9990 | 55.586 | 0.078 | 142.89 | 13.85 | −0.003 |
| ### | May 8, 2012 | 11:53:01 AM | 13.85 | 3.999 | 9.6324 | 3.463 | 55.386 | 0.077 | 142.48 | 13.900 | 3.9990 | 55.586 | 0.078 | 142.97 | 13.85 | −0.002 |
| ### | May 8, 2012 | 11:53:06 AM | 13.85 | 3.999 | 9.6380 | 3.463 | 55.386 | 0.077 | 142.56 | 13.900 | 3.9990 | 55.586 | 0.078 | 143.04 | 13.85 | −0.001 |
| ### | May 8, 2012 | 11:53:11 AM | 13.85 | 3.999 | 9.6435 | 3.463 | 55.386 | 0.077 | 142.64 | 13.900 | 3.9990 | 55.586 | 0.078 | 143.12 | 13.85 | −0.001 |
| ### | May 8, 2012 | 11:53:16 AM | 13.85 | 3.999 | 9.6490 | 3.463 | 55.386 | 0.077 | 142.72 | 13.900 | 3.9990 | 55.586 | 0.078 | 143.20 | 13.85 | 0.001 |
| ### | May 8, 2012 | 11:53:21 AM | 13.85 | 3.999 | 9.6546 | 3.463 | 55.386 | 0.077 | 142.87 | 13.900 | 3.9990 | 55.586 | 0.077 | 143.28 | 13.85 | 0.002 |
| ### | May 8, 2012 | 11:53:26 AM | 13.85 | 3.999 | 9.6601 | 3.463 | 55.386 | 0.077 | 142.87 | 13.900 | 3.9990 | 55.586 | 0.077 | 143.35 | 13.85 | 0.003 |
| ### | May 8, 2012 | 11:53:31 AM | 13.85 | 3.999 | 9.6657 | 3.463 | 55.386 | 0.077 | 142.95 | 13.900 | 3.9990 | 55.586 | 0.077 | 143.43 | 13.85 | 0.004 |
| ### | May 8, 2012 | 11:53:36 AM | 13.85 | 3.999 | 9.6712 | 3.463 | 55.346 | 0.077 | 143.02 | 13.900 | 3.9990 | 55.586 | 0.077 | 143.51 | 13.84 | 0.005 |
| ### | May 8, 2012 | 11:53:41 AM | 13.84 | 3.999 | 9.6823 | 3.460 | 55.346 | 0.077 | 143.10 | 13.890 | 3.9990 | 55.546 | 0.077 | 143.58 | 13.84 | −0.005 |
| ### | May 8, 2012 | 11:53:45 AM | 13.84 | 3.999 | 9.6879 | 3.460 | 55.346 | 0.077 | 143.18 | 13.890 | 3.9990 | 55.546 | 0.077 | 143.66 | 13.84 | −0.004 |
| ### | May 8, 2012 | 11:53:51 AM | 13.84 | 3.999 | 9.6934 | 3.460 | 55.346 | 0.077 | 143.25 | 13.890 | 3.9990 | 55.546 | 0.077 | 143.74 | 13.84 | −0.003 |
| ### | May 8, 2012 | 11:53:56 AM | 13.84 | 3.999 | 9.6990 | 3.460 | 55.346 | 0.077 | 143.33 | 13.890 | 3.9990 | 55.546 | 0.077 | 143.82 | 13.84 | −0.002 |
| ### | May 8, 2012 | 11:54:01 AM | 13.84 | 3.999 | 9.7045 | 3.460 | 55.346 | 0.077 | 143.41 | 13.890 | 3.9990 | 55.546 | 0.077 | 143.89 | 13.84 | −0.001 |
| ### | May 8, 2012 | 11:54:06 AM | 13.84 | 3.999 | 9.7100 | 3.460 | 55.346 | 0.077 | 143.48 | 13.890 | 3.9990 | 55.546 | 0.077 | 143.97 | 13.84 | 0.000 |
| ### | May 8, 2012 | 11:54:11 AM | 13.84 | 3.999 | 9.7156 | 3.460 | 55.346 | 0.077 | 143.56 | 13.890 | 3.9990 | 55.546 | 0.077 | 144.05 | 13.84 | 0.000 |
| ### | May 8, 2012 | 11:54:16 AM | 13.84 | 3.999 | 9.7211 | 3.460 | 55.346 | 0.077 | 143.64 | 13.890 | 3.9990 | 55.546 | 0.077 | 144.12 | 13.84 | 0.001 |
| ### | May 8, 2012 | 11:54:21 AM | 13.84 | 3.999 | 9.7267 | 3.460 | 55.346 | 0.077 | 143.72 | 13.890 | 3.9990 | 55.546 | 0.077 | 144.20 | 13.84 | 0.002 |
| ### | May 8, 2012 | 11:54:26 AM | 13.84 | 3.999 | 9.7322 | 3.460 | 55.346 | 0.077 | 143.79 | 13.890 | 3.9990 | 55.546 | 0.077 | 144.28 | 13.84 | 0.003 |
| ### | May 8, 2012 | 11:54:31 AM | 13.84 | 3.999 | 9.7378 | 3.460 | 55.346 | 0.077 | 143.87 | 13.890 | 3.9990 | 55.546 | 0.077 | 144.36 | 13.84 | 0.004 |
| ### | May 8, 2012 | 11:54:36 AM | 13.84 | 3.999 | 9.7434 | 3.460 | 55.346 | 0.077 | 143.95 | 13.890 | 3.9990 | 55.546 | 0.077 | 144.43 | 13.84 | 0.005 |
| ### | May 8, 2012 | 11:54:41 AM | 13.83 | 3.999 | 9.7489 | 3.458 | 55.306 | 0.077 | 143.02 | 13.880 | 3.9990 | 55.506 | 0.077 | 144.51 | 13.83 | −0.005 |
| ### | May 8, 2012 | 11:54:46 AM | 13.83 | 3.999 | 9.7544 | 3.458 | 55.306 | 0.077 | 144.10 | 13.880 | 3.9990 | 55.506 | 0.077 | 144.59 | 13.83 | −0.004 |
| ### | May 8, 2012 | 11:54:51 AM | 13.83 | 3.999 | 9.7600 | 3.458 | 55.306 | 0.077 | 144.18 | 13.880 | 3.9990 | 55.506 | 0.077 | 144.66 | 13.83 | −0.003 |
| ### | May 8, 2012 | 11:54:56 AM | 13.83 | 3.999 | 9.7655 | 3.458 | 55.306 | 0.077 | 144.25 | 13.880 | 3.9990 | 55.506 | 0.077 | 143.74 | 13.83 | −0.002 |
| ### | May 8, 2012 | 11:55:01 AM | 13.83 | 3.999 | 9.7710 | 3.458 | 55.306 | 0.077 | 144.33 | 13.880 | 3.9990 | 55.506 | 0.077 | 144.82 | 13.83 | 0.001 |
| ### | May 8, 2012 | 11:55:06 AM | 13.83 | 3.999 | 9.7766 | 3.458 | 55.306 | 0.077 | 144.41 | 13.880 | 3.9990 | 55.506 | 0.077 | 144.90 | 13.83 | 0.000 |
| ### | May 8, 2012 | 11:55:11 AM | 13.83 | 3.999 | 9.7822 | 3.458 | 55.306 | 0.077 | 144.48 | 13.880 | 3.9990 | 55.506 | 0.077 | 143.97 | 13.83 | 0.000 |
| ### | May 8, 2012 | 11:55:16 AM | 13.83 | 3.999 | 9.7877 | 3.458 | 55.306 | 0.077 | 144.56 | 13.880 | 3.9990 | 55.506 | 0.077 | 145.05 | 13.83 | 0.000 |
| ### | May 8, 2012 | 11:55:21 AM | 13.83 | 3.999 | 9.7932 | 3.458 | 55.306 | 0.077 | 144.64 | 13.880 | 3.9990 | 55.506 | 0.077 | 145.13 | 13.83 | 0.001 |
| ### | May 8, 2012 | 11:55:26 AM | 13.83 | 3.999 | 9.7988 | 3.458 | 55.306 | 0.077 | 144.71 | 13.880 | 3.9990 | 55.506 | 0.077 | 145.20 | 13.83 | 0.002 |
| ### | May 8, 2012 | 11:55:31 AM | 13.83 | 3.999 | 9.8043 | 3.458 | 55.306 | 0.077 | 144.79 | 13.880 | 3.9990 | 55.506 | 0.077 | 145.28 | 13.83 | 0.003 |
| ### | May 8, 2012 | 11:55:36 AM | 13.83 | 3.999 | 9.8099 | 3.458 | 55.306 | 0.077 | 144.87 | 13.880 | 3.9990 | 55.506 | 0.077 | 145.36 | 13.83 | 0.004 |
| ### | May 8, 2012 | 11:55:41 AM | 13.83 | 3.999 | 9.8154 | 3.458 | 55.306 | 0.077 | 144.94 | 13.880 | 3.9990 | 55.506 | 0.077 | 145.44 | 13.83 | 0.005 |
| ### | May 8, 2012 | 11:55:46 AM | 13.83 | 3.999 | 9.8210 | 3.458 | 55.266 | 0.077 | 145.02 | 13.870 | 3.9990 | 55.466 | 0.077 | 144.51 | 13.82 | −0.005 |
| ### | May 8, 2012 | 11:55:51 AM | 13.82 | 3.999 | 9.8265 | 3.455 | 55.266 | 0.077 | 145.10 | 13.870 | 3.9990 | 55.466 | 0.077 | 144.59 | 13.82 | −0.004 |
| ### | May 8, 2012 | 11:55:56 AM | 13.82 | 3.999 | 9.8321 | 3.455 | 55.266 | 0.077 | 145.17 | 13.870 | 3.9990 | 55.466 | 0.077 | 143.67 | 13.82 | −0.003 |
| ### | May 8, 2012 | 11:56:01 AM | 13.82 | 3.999 | 9.8376 | 3.455 | 55.266 | 0.077 | 145.25 | 13.870 | 3.9990 | 55.466 | 0.077 | 145.74 | 13.82 | −0.002 |
| ### | May 8, 2012 | 11:56:01 AM | 13.82 | 3.999 | 9.8434 | 3.455 | 55.266 | 0.077 | 145.33 | 13.870 | 3.9990 | 55.466 | 0.077 | 145.82 | 13.82 | −0.001 |
| ### | May 8, 2012 | 11:56:01 AM | 13.82 | 3.999 | 9.8489 | 3.455 | 55.266 | 0.077 | 145.48 | 13.870 | 3.9990 | 55.466 | 0.077 | 145.90 | 13.82 | 0.001 |
| ### | May 8, 2012 | 11:56:21 AM | 13.82 | 3.999 | 9.8541 | 3.455 | 55.266 | 0.077 | 145.56 | 13.870 | 3.9990 | 55.466 | 0.077 | 145.97 | 13.82 | 0.002 |
| ### | May 8, 2012 | 11:56:26 AM | 13.82 | 3.999 | 9.8596 | 3.455 | 55.266 | 0.077 | 145.64 | 13.870 | 3.9990 | 55.466 | 0.077 | 146.05 | 13.82 | 0.003 |
| ### | May 8, 2012 | 11:56:31 AM | 13.82 | 3.999 | 9.8652 | 3.455 | 55.266 | 0.077 | 145.71 | 13.870 | 3.9990 | 55.466 | 0.077 | 146.13 | 13.82 | 0.004 |
| ### | May 8, 2012 | 11:56:36 AM | 13.81 | 3.999 | 9.8707 | 3.455 | 55.226 | 0.077 | 145.79 | 13.860 | 3.9990 | 55.426 | 0.077 | 145.21 | 13.82 | 0.005 |
| ### | May 8, 2012 | 11:56:41 AM | 13.81 | 3.999 | 9.8763 | 3.453 | 55.226 | 0.077 | 145.87 | 13.860 | 3.9990 | 55.426 | 0.077 | 146.28 | 13.82 | −0.005 |
| ### | May 8, 2012 | 11:56:46 AM | 13.81 | 3.999 | 9.8818 | 3.453 | 55.226 | 0.077 | 145.94 | 13.860 | 3.9990 | 55.426 | 0.077 | 145.36 | 13.82 | −0.004 |
| ### | May 8, 2012 | 11:56:51 AM | 13.81 | 3.999 | 9.8874 | 3.453 | 55.226 | 0.077 | 146.02 | 13.860 | 3.9990 | 55.426 | 0.077 | 146.44 | 13.82 | −0.003 |
| ### | May 8, 2012 | 11:56:56 AM | 13.81 | 3.999 | 9.8929 | 3.453 | 55.226 | 0.077 | 146.10 | 13.860 | 3.9990 | 55.426 | 0.077 | 145.51 | 13.81 | −0.002 |
| ### | May 8, 2012 | 11:57:01 AM | 13.81 | 3.999 | 9.8984 | 3.453 | 55.226 | 0.077 | 146.17 | 13.860 | 3.9990 | 55.426 | 0.077 | 145.59 | 13.81 | −0.001 |
| ### | May 8, 2012 | 11:57:06 AM | 13.81 | 3.999 | 9.9040 | 3.453 | 55.226 | 0.077 | 146.25 | 13.860 | 3.9990 | 55.426 | 0.077 | 145.67 | 13.81 | 0.001 |
| ### | May 8, 2012 | 11:57:11 AM | 13.81 | 3.999 | 9.9097 | 3.453 | 55.226 | 0.077 | 146.33 | 13.860 | 3.9990 | 55.426 | 0.077 | 145.74 | 13.81 | 0.002 |
| ### | May 8, 2012 | 11:57:16 AM | 13.81 | 3.999 | 9.9152 | 3.453 | 55.226 | 0.077 | 146.40 | 13.860 | 3.9990 | 55.426 | 0.077 | 145.82 | 13.81 | 0.003 |
| ### | May 8, 2012 | 11:57:21 AM | 13.81 | 3.999 | 9.9208 | 3.453 | 55.226 | 0.077 | 146.48 | 13.850 | 3.9990 | 55.426 | 0.077 | 145.90 | 13.81 | 0.004 |
| ### | May 8, 2012 | 11:57:26 AM | 13.80 | 3.999 | 9.9263 | 3.450 | 55.186 | 0.077 | 146.56 | 13.850 | 3.9990 | 55.386 | 0.077 | 145.98 | 13.80 | 0.005 |
| ### | May 8, 2012 | 11:57:31 AM | 13.80 | 3.999 | 9.9319 | 3.450 | 55.186 | 0.077 | 146.63 | 13.850 | 3.9990 | 55.386 | 0.077 | 147.05 | 13.80 | −0.005 |
| ### | May 8, 2012 | 11:57:36 AM | 13.80 | 3.999 | 9.9374 | 3.450 | 55.186 | 0.077 | 146.71 | 13.850 | 3.9990 | 55.386 | 0.077 | 147.13 | 13.80 | −0.004 |
| ### | May 8, 2012 | 11:57:41 AM | 13.80 | 3.999 | 9.9430 | 3.450 | 55.186 | 0.077 | 146.79 | 13.850 | 3.9990 | 55.386 | 0.077 | 147.21 | 13.80 | −0.003 |
| ### | May 8, 2012 | 11:57:46 AM | 13.80 | 3.999 | 9.9485 | 3.450 | 55.186 | 0.077 | 146.86 | 13.850 | 3.9990 | 55.386 | 0.077 | 147.28 | 13.80 | 0.002 |
| ### | May 8, 2012 | 11:57:51 AM | 13.80 | 3.999 | 9.9541 | 3.450 | 55.186 | 0.077 | 146.94 | 13.850 | 3.9990 | 55.386 | 0.077 | 147.36 | 13.80 | −0.001 |
| ### | May 8, 2012 | 11:57:56 AM | 13.80 | 3.999 | 9.9596 | 3.450 | 55.186 | 0.077 | 147.02 | 13.850 | 3.9990 | 55.386 | 0.077 | 147.44 | 13.80 | 0.000 |
| ### | May 8, 2012 | 11:58:01 AM | 13.80 | 3.999 | 9.9652 | 3.450 | 55.186 | 0.077 | 147.09 | 13.850 | 3.9990 | 55.386 | 0.077 | 147.51 | 13.80 | 0.001 |
| ### | May 8, 2012 | 11:58:06 AM | 13.80 | 3.999 | 9.9707 | 3.450 | 55.186 | 0.077 | 147.17 | 13.850 | 3.9990 | 55.386 | 0.077 | 147.59 | 13.80 | 0.002 |
| ### | May 8, 2012 | 11:58:11 AM | 13.80 | 3.999 | 9.9762 | 3.450 | 55.186 | 0.077 | 147.25 | 13.850 | 3.9990 | 55.386 | 0.077 | 147.67 | 13.80 | 0.003 |
| ### | May 8, 2012 | 11:58:16 AM | 13.80 | 3.999 | 9.9818 | 3.450 | 55.186 | 0.077 | 147.32 | 13.850 | 3.9990 | 55.386 | 0.077 | 147.75 | 13.80 | 0.004 |
| ### | May 8, 2012 | 11:58:21 AM | 13.79 | 3.999 | 9.9873 | 3.448 | 55.146 | 0.077 | 147.40 | 13.850 | 3.9990 | 55.386 | 0.077 | 147.82 | 13.80 | 0.005 |
| ### | May 8, 2012 | 11:58:26 AM | 13.79 | 3.999 | 9.9929 | 3.448 | 55.146 | 0.077 | 147.48 | 13.850 | 3.9990 | 55.386 | 0.077 | 147.90 | 13.79 | −0.005 |
| ### | May 8, 2012 | 11:58:31 AM | 13.79 | 3.999 | 9.9984 | 3.448 | 55.146 | 0.077 | 147.55 | 13.850 | 3.9990 | 55.386 | 0.077 | 147.98 | 13.79 | −0.004 |
| ### | May 8, 2012 | 11:58:31 AM | 13.79 | 3.999 | 9.9984 | 3.448 | 55.146 | 0.077 | 147.63 | 13.850 | 3.9990 | 55.386 | 0.077 | 148.05 | 13.79 | −0.003 |
| ### | May 8, 2012 | 11:58:36 AM | 13.79 | 3.999 | 10.0040 | 3.448 | 55.160 | 0.077 | 147.63 | 13.850 | 3.9990 | 55.386 | 0.077 | 148.13 | 13.79 | −0.002 |
| ### | May 8, 2012 | 11:58:41 AM | 13.79 | 3.999 | 10.0095 | 3.448 | 55.160 | 0.077 | 147.63 | 13.840 | 3.9990 | 55.346 | 0.077 | 148.21 | 13.79 | −0.001 |
| ### | May 8, 2012 | 11:58:46 AM | 13.79 | 3.999 | 10.0151 | 3.448 | 55.146 | 0.077 | 147.55 | 13.840 | 3.9990 | 55.346 | 0.077 | 148.28 | 13.79 | −0.000 |
| ### | May 8, 2012 | 11:58:51 AM | 13.79 | 3.999 | 10.0206 | 3.448 | 55.146 | 0.077 | 147.63 | 13.840 | 3.9990 | 55.346 | 0.077 | 148.36 | 13.79 | 0.000 |
| ### | May 8, 2012 | 11:58:56 AM | 13.79 | 3.999 | 10.0262 | 3.448 | 55.146 | 0.077 | 147.55 | 13.840 | 3.9990 | 55.346 | 0.077 | 148.44 | 13.79 | 0.000 |
| ### | May 8, 2012 | 11:59:01 AM | 13.79 | 3.999 | 10.0317 | 3.448 | 55.146 | 0.077 | 148.01 | 13.840 | 3.9990 | 55.346 | 0.077 | 148.51 | 13.79 | 0.001 |
| ### | May 8, 2012 | 11:59:06 AM | 13.79 | 3.999 | 10.0372 | 3.448 | 55.146 | 0.077 | 148.09 | 13.840 | 3.9990 | 55.346 | 0.077 | 148.59 | 13.79 | 0.002 |
| ### | May 8, 2012 | 11:59:11 AM | 13.79 | 3.999 | 10.0428 | 3.448 | 55.146 | 0.077 | 148.16 | 13.840 | 3.9990 | 55.346 | 0.077 | 148.67 | 13.79 | 0.003 |
| ### | May 8, 2012 | 11:59:16 AM | 13.79 | 3.999 | 10.0483 | 3.448 | 55.146 | 0.077 | 148.24 | 13.840 | 3.9990 | 55.346 | 0.077 | 148.74 | 13.79 | 0.004 |
| ### | May 8, 2012 | 11:59:21 AM | 13.79 | 3.999 | 10.0539 | 3.448 | 55.106 | 0.077 | 148.32 | 13.840 | 3.9990 | 55.306 | 0.077 | 148.82 | 13.79 | −0.005 |
| ### | May 8, 2012 | 11:59:26 AM | 13.78 | 3.999 | 10.0594 | 3.445 | 55.106 | 0.077 | 148.39 | 13.830 | 3.9990 | 55.306 | 0.077 | 148.90 | 13.78 | −0.005 |
| ### | May 8, 2012 | 11:59:31 AM | 13.78 | 3.999 | 10.0650 | 3.448 | 55.106 | 0.077 | 148.47 | 13.830 | 3.9990 | 55.306 | 0.077 | 148.90 | 13.78 | −0.004 |
| ### | May 8, 2012 | 11:59:21 AM | 13.79 | 3.999 | 10.0539 | 3.448 | 55.106 | 0.077 | 148.55 | 13.830 | 3.9990 | 55.306 | 0.077 | 149.05 | 13.78 | −0.003 |
| ### | May 8, 2012 | 11:59:41 AM | 13.78 | 3.999 | 10.0761 | 3.445 | 55.106 | 0.077 | 148.62 | 13.830 | 3.9990 | 55.306 | 0.077 | 149.15 | 13.78 | 0.002 |
| ### | May 8, 2012 | 11:59:46 AM | 13.78 | 3.999 | 10.0816 | 3.445 | 55.106 | 0.077 | 148.70 | 13.830 | 3.9990 | 55.306 | 0.077 | 149.21 | 13.78 | −0.001 |
| ### | May 8, 2012 | 11:59:51 AM | 13.78 | 3.999 | 10.0872 | 3.445 | 55.106 | 0.077 | 148.78 | 13.830 | 3.9990 | 55.306 | 0.077 | 149.28 | 13.78 | 0.000 |
| ### | May 8, 2012 | 11:59:56 AM | 13.78 | 3.999 | 10.0927 | 3.445 | 55.106 | 0.077 | 148.85 | 13.830 | 3.9990 | 55.306 | 0.077 | 149.36 | 13.78 | 0.000 |
| ### | May 8, 2012 | 12:00:01 PM | 13.78 | 3.999 | 10.0982 | 3.445 | 55.106 | 0.077 | 148.93 | 13.830 | 3.9990 | 55.306 | 0.077 | 149.44 | 13.78 | 0.001 |
| ### | May 8, 2012 | 12:00:06 PM | 13.78 | 3.999 | 10.1038 | 3.445 | 55.106 | 0.077 | 149.01 | 13.830 | 3.9990 | 55.306 | 0.077 | 149.51 | 13.78 | 0.002 |
| ### | May 8, 2012 | 12:00:11 PM | 13.78 | 3.999 | 10.1093 | 3.445 | 55.106 | 0.077 | 149.08 | 13.830 | 3.9990 | 55.306 | 0.077 | 149.59 | 13.78 | 0.003 |
| ### | May 8, 2012 | 12:00:16 PM | 13.78 | 3.999 | 10.1149 | 3.445 | 55.106 | 0.077 | 149.16 | 13.830 | 3.9990 | 55.306 | 0.077 | 149.67 | 13.78 | 0.004 |
| ### | May 8, 2012 | 12:00:21 PM | 13.78 | 3.999 | 10.1204 | 3.445 | 55.106 | 0.077 | 149.24 | 13.830 | 3.9990 | 55.306 | 0.077 | 149.74 | 13.78 | 0.005 |
| ### | May 8, 2012 | 12:00:26 PM | 13.77 | 3.999 | 10.1260 | 3.443 | 55.066 | 0.077 | 149.31 | 13.820 | 3.9990 | 55.266 | 0.077 | 149.82 | 13.77 | −0.005 |
| ### | May 8, 2012 | 12:00:31 PM | 13.77 | 3.999 | 10.1316 | 3.443 | 55.066 | 0.076 | 149.39 | 13.820 | 3.9990 | 55.266 | 0.077 | 149.90 | 13.77 | −0.004 |
| ### | May 8, 2012 | 12:00:36 PM | 13.77 | 3.999 | 10.1371 | 3.443 | 55.066 | 0.076 | 149.47 | 13.820 | 3.9990 | 55.266 | 0.077 | 149.97 | 13.77 | −0.003 |
| ### | May 8, 2012 | 12:00:41 PM | 13.77 | 3.999 | 10.1426 | 3.443 | 55.066 | 0.076 | 149.54 | 13.820 | 3.9990 | 55.266 | 0.077 | 150.05 | 13.77 | −0.002 |
| ### | May 8, 2012 | 12:00:46 PM | 13.77 | 3.999 | 10.1482 | 3.443 | 55.066 | 0.076 | 149.62 | 13.820 | 3.9990 | 55.266 | 0.077 | 150.13 | 13.77 | −0.001 |
| ### | May 8, 2012 | 12:00:51 PM | 13.77 | 3.999 | 10.1537 | 3.443 | 55.066 | 0.076 | 149.70 | 13.820 | 3.9990 | 55.266 | 0.077 | 150.20 | 13.77 | 0.000 |
| ### | May 8, 2012 | 12:00:56 PM | 13.77 | 3.999 | 10.1593 | 3.443 | 55.066 | 0.076 | 149.77 | 13.820 | 3.9990 | 55.266 | 0.077 | 150.28 | 13.77 | 0.000 |
| ### | May 8, 2012 | 12:01:01 PM | 13.77 | 3.999 | 10.1648 | 3.443 | 55.066 | 0.076 | 149.85 | 13.820 | 3.9990 | 55.266 | 0.077 | 150.36 | 13.77 | 0.000 |
| ### | May 8, 2012 | 12:01:06 PM | 13.77 | 3.999 | 10.1704 | 3.443 | 55.066 | 0.076 | 149.92 | 13.820 | 3.9990 | 55.266 | 0.077 | 150.43 | 13.77 | 0.000 |
| ### | May 8, 2012 | 12:01:11 PM | 13.77 | 3.999 | 10.1759 | 3.443 | 55.066 | 0.076 | 150.00 | 13.820 | 3.9990 | 55.266 | 0.077 | 150.51 | 13.77 | 0.000 |
| ### | May 8, 2012 | 12:01:16 PM | 13.77 | 3.999 | 10.1814 | 3.443 | 55.066 | 0.076 | 150.08 | 13.820 | 3.9990 | 55.266 | 0.077 | 150.59 | 13.76 | −0.005 |
| ### | May 8, 2012 | 12:01:21 PM | 13.76 | 3.999 | 10.1870 | 3.440 | 55.026 | 0.076 | 150.15 | 13.810 | 3.9990 | 55.226 | 0.077 | 150.66 | 13.76 | −0.005 |
| ### | May 8, 2012 | 12:01:26 PM | 13.76 | 3.999 | 10.1925 | 3.440 | 55.026 | 0.076 | 150.23 | 13.810 | 3.9990 | 55.226 | 0.077 | 150.74 | 13.76 | −0.004 |
| ### | May 8, 2012 | 12:01:31 PM | 13.76 | 3.999 | 10.1981 | 3.440 | 55.026 | 0.076 | 150.31 | 13.810 | 3.9990 | 55.226 | 0.077 | 150.82 | 13.76 | −0.003 |
| ### | May 8, 2012 | 12:01:36 PM | 13.76 | 3.999 | 10.2036 | 3.440 | 55.026 | 0.076 | 150.38 | 13.810 | 3.9990 | 55.226 | 0.077 | 150.99 | 13.76 | −0.002 |
| ### | May 8, 2012 | 12:01:41 PM | 13.76 | 3.999 | 10.2092 | 3.440 | 55.026 | 0.076 | 150.46 | 13.810 | 3.9990 | 55.226 | 0.077 | 151.97 | 13.76 | −0.001 |
| ### | May 8, 2012 | 12:01:46 PM | 13.76 | 3.999 | 10.2147 | 3.440 | 55.026 | 0.076 | 150.54 | 13.810 | 3.9990 | 55.226 | 0.077 | 151.05 | 13.76 | 0.000 |
| ### | May 8, 2012 | 12:01:51 PM | 13.76 | 3.999 | 10.2202 | 3.440 | 55.026 | 0.076 | 150.61 | 13.810 | 3.9990 | 55.226 | 0.077 | 151.12 | 13.76 | 0.000 |
| ### | May 8, 2012 | 12:01:56 PM | 13.76 | 3.999 | 10.2258 | 3.440 | 55.026 | 0.076 | 150.69 | 13.810 | 3.9990 | 55.226 | 0.077 | 151.20 | 13.76 | 0.001 |
| ### | May 8, 2012 | 12:02:01 PM | 13.76 | 3.999 | 10.2314 | 3.440 | 55.026 | 0.076 | 150.77 | 13.810 | 3.9990 | 55.226 | 0.077 | 151.28 | 13.76 | 0.002 |
| ### | May 8, 2012 | 12:02:06 PM | 13.76 | 3.999 | 10.2369 | 3.440 | 55.026 | 0.076 | 150.84 | 13.810 | 3.9990 | 55.226 | 0.077 | 151.35 | 13.76 | 0.003 |
| ### | May 8, 2012 | 12:02:11 PM | 13.76 | 3.999 | 10.2425 | 3.440 | 55.026 | 0.076 | 150.92 | 13.810 | 3.9990 | 55.226 | 0.077 | 151.43 | 13.76 | 0.004 |
| ### | May 8, 2012 | 12:02:16 PM | 13.76 | 3.999 | 10.2480 | 3.440 | 55.026 | 0.076 | 150.99 | 13.810 | 3.9990 | 55.226 | 0.077 | 151.51 | 13.76 | 0.005 |
| ### | May 8, 2012 | 12:02:21 PM | 13.75 | 3.999 | 10.2535 | 3.438 | 54.986 | 0.076 | 151.07 | 13.800 | 3.9990 | 55.186 | 0.077 | 151.58 | 13.75 | −0.005 |
| ### | May 8, 2012 | 12:02:26 PM | 13.75 | 3.999 | 10.2591 | 3.438 | 54.986 | 0.076 | 151.15 | 13.800 | 3.9990 | 55.186 | 0.077 | 151.66 | 13.75 | −0.004 |
| ### | May 8, 2012 | 12:02:31 PM | 13.75 | 3.999 | 10.2646 | 3.438 | 54.986 | 0.076 | 151.22 | 13.800 | 3.9990 | 55.186 | 0.077 | 151.74 | 13.75 | −0.003 |
| ### | May 8, 2012 | 12:02:36 PM | 13.75 | 3.999 | 10.2702 | 3.438 | 54.986 | 0.076 | 151.30 | 13.800 | 3.9990 | 55.186 | 0.077 | 151.81 | 13.75 | −0.002 |
| ### | May 8, 2012 | 12:02:41 PM | 13.75 | 3.999 | 10.2757 | 3.438 | 54.986 | 0.076 | 151.38 | 13.800 | 3.9990 | 55.186 | 0.077 | 151.89 | 13.75 | −0.001 |
| ### | May 8, 2012 | 12:02:46 PM | 13.75 | 3.999 | 10.2812 | 3.438 | 54.986 | 0.076 | 151.45 | 13.800 | 3.9990 | 55.186 | 0.077 | 151.97 | 13.75 | 0.001 |
| ### | May 8, 2012 | 12:02:51 PM | 13.75 | 3.999 | 10.2868 | 3.438 | 54.986 | 0.076 | 151.53 | 13.800 | 3.9990 | 55.186 | 0.077 | 152.04 | 13.75 | 0.002 |
| ### | May 8, 2012 | 12:02:56 PM | 13.75 | 3.999 | 10.2923 | 3.438 | 54.986 | 0.076 | 151.61 | 13.800 | 3.9990 | 55.186 | 0.077 | 152.12 | 13.75 | 0.003 |
| ### | May 8, 2012 | 12:03:01 PM | 13.75 | 3.999 | 10.2977 | 3.438 | 54.986 | 0.076 | 151.68 | 13.800 | 3.9990 | 55.186 | 0.077 | 152.20 | 13.75 | 0.004 |
| ### | May 8, 2012 | 12:03:06 PM | 13.75 | 3.999 | 10.3033 | 3.438 | 54.986 | 0.076 | 151.76 | 13.800 | 3.9990 | 55.186 | 0.077 | 152.27 | 13.75 | 0.005 |
| ### | May 8, 2012 | 12:03:11 PM | 13.74 | 3.999 | 10.3088 | 3.435 | 54.946 | 0.076 | 151.83 | 13.790 | 3.9990 | 55.146 | 0.077 | 152.35 | 13.74 | −0.005 |
| ### | May 8, 2012 | 12:03:16 PM | 13.74 | 3.999 | 10.3144 | 3.435 | 54.946 | 0.076 | 151.91 | 13.790 | 3.9990 | 55.146 | 0.077 | 152.43 | 13.74 | −0.004 |
| ### | May 8, 2012 | 12:03:21 PM | 13.74 | 3.999 | 10.3202 | 3.435 | 54.946 | 0.076 | 151.99 | 13.790 | 3.9990 | 55.146 | 0.077 | 152.50 | 13.74 | −0.003 |
| ### | May 8, 2012 | 12:03:26 PM | 13.74 | 4.000 | 10.3258 | 3.435 | 54.960 | 0.076 | 152.06 | 13.790 | 3.9990 | 55.146 | 0.077 | 152.58 | 13.74 | −0.002 |
| ### | May 8, 2012 | 12:03:31 PM | 13.74 | 3.999 | 10.3313 | 3.435 | 54.946 | 0.076 | 152.14 | 13.790 | 3.9990 | 55.146 | 0.077 | 152.66 | 13.74 | −0.001 |
| ### | May 8, 2012 | 12:03:36 PM | 13.74 | 3.999 | 10.3367 | 3.435 | 54.946 | 0.076 | 152.22 | 13.790 | 3.9990 | 55.146 | 0.077 | 152.73 | 13.74 | 0.000 |
| ### | May 8, 2012 | 12:03:41 PM | 13.74 | 3.999 | 10.3422 | 3.435 | 54.946 | 0.076 | 152.29 | 13.790 | 3.9990 | 55.146 | 0.077 | 152.81 | 13.74 | 0.000 |
| ### | May 8, 2012 | 12:03:46 PM | 13.74 | 3.999 | 10.3478 | 3.435 | 54.946 | 0.076 | 152.37 | 13.790 | 3.9990 | 55.146 | 0.077 | 152.89 | 13.74 | 0.000 |
| ### | May 8, 2012 | 12:03:51 PM | 13.74 | 3.999 | 10.3533 | 3.435 | 54.946 | 0.076 | 152.37 | 13.790 | 3.9990 | 55.146 | 0.077 | 152.96 | 13.74 | 0.001 |
| ### | May 8, 2012 | 12:03:56 PM | 13.74 | 3.999 | 10.3589 | 3.435 | 54.946 | 0.076 | 152.45 | 13.790 | 3.9990 | 55.146 | 0.077 | 153.04 | 13.74 | 0.002 |
| ### | May 8, 2012 | 12:04:01 PM | 13.74 | 3.999 | 10.3589 | 3.435 | 54.946 | 0.076 | 152.52 | 13.790 | 3.9990 | 55.146 | 0.077 | 153.12 | 13.74 | 0.003 |
| ### | May 8, 2012 | 12:04:06 PM | 13.74 | 3.999 | 10.3644 | 3.435 | 54.946 | 0.076 | 152.60 | 13.790 | 3.9990 | 55.146 | 0.077 | 153.19 | 13.74 | 0.004 |
| ### | May 8, 2012 | 12:04:11 PM | 13.74 | 3.999 | 10.3700 | 3.435 | 54.946 | 0.076 | 152.67 | 13.790 | 3.9990 | 55.146 | 0.077 | 153.27 | 13.74 | 0.005 |
| ### | May 8, 2012 | 12:04:16 PM | 13.73 | 3.999 | 10.3811 | 3.433 | 54.906 | 0.076 | 152.83 | 13.780 | 3.9990 | 55.106 | 0.077 | 153.35 | 13.73 | −0.005 |
| ### | May 8, 2012 | 12:04:21 PM | 13.73 | 3.999 | 10.3866 | 3.433 | 54.906 | 0.076 | 152.90 | 13.780 | 3.9990 | 55.106 | 0.077 | 153.42 | 13.73 | −0.004 |
| ### | May 8, 2012 | 12:04:26 PM | 13.73 | 3.999 | 10.3921 | 3.433 | 54.906 | 0.076 | 152.98 | 13.780 | 3.9990 | 55.106 | 0.077 | 153.50 | 13.73 | −0.003 |
| ### | May 8, 2012 | 12:04:31 PM | 13.73 | 3.999 | 10.3977 | 3.433 | 54.906 | 0.076 | 153.06 | 13.780 | 3.9990 | 55.106 | 0.077 | 153.58 | 13.73 | −0.002 |
| ### | May 8, 2012 | 12:04:36 PM | 13.73 | 3.999 | 10.4032 | 3.433 | 54.906 | 0.076 | 153.13 | 13.780 | 3.9990 | 55.106 | 0.077 | 153.65 | 13.73 | −0.001 |
| ### | May 8, 2012 | 12:04:41 PM | 13.73 | 3.999 | 10.4088 | 3.433 | 54.906 | 0.076 | 153.21 | 13.780 | 3.9990 | 55.106 | 0.077 | 153.73 | 13.73 | 0.000 |
| ### | May 8, 2012 | 12:04:46 PM | 13.73 | 3.999 | 10.4143 | 3.433 | 54.906 | 0.076 | 153.28 | 13.780 | 3.9990 | 55.106 | 0.077 | 153.81 | 13.73 | 0.000 |
| ### | May 8, 2012 | 12:04:51 PM | 13.73 | 3.999 | 10.4199 | 3.433 | 54.906 | 0.076 | 153.36 | 13.780 | 3.9990 | 55.106 | 0.077 | 153.88 | 13.73 | 0.000 |
| ### | May 8, 2012 | 12:04:56 PM | 13.73 | 3.999 | 10.4254 | 3.433 | 54.906 | 0.076 | 153.44 | 13.780 | 3.9990 | 55.106 | 0.077 | 153.96 | 13.73 | 0.001 |
| ### | May 8, 2012 | 12:05:01 PM | 13.73 | 3.999 | 10.4310 | 3.433 | 54.906 | 0.076 | 153.51 | 13.780 | 3.9990 | 55.106 | 0.077 | 154.04 | 13.73 | 0.002 |
| ### | May 8, 2012 | 12:05:06 PM | 13.73 | 3.999 | 10.4365 | 3.433 | 54.906 | 0.076 | 153.59 | 13.780 | 3.9990 | 55.106 | 0.077 | 154.11 | 13.73 | 0.003 |
| ### | May 8, 2012 | 12:05:11 PM | 13.73 | 3.999 | 10.4420 | 3.433 | 54.906 | 0.076 | 153.67 | 13.780 | 3.9990 | 55.106 | 0.077 | 154.19 | 13.73 | 0.004 |
| ### | May 8, 2012 | 12:05:16 PM | 13.73 | 3.999 | 10.4476 | 3.433 | 54.906 | 0.076 | 153.74 | 13.780 | 3.9990 | 55.106 | 0.077 | 154.27 | 13.73 | 0.005 |
| ### | May 8, 2012 | 12:05:21 PM | 13.72 | 3.999 | 10.4531 | 3.430 | 54.866 | 0.076 | 153.82 | 13.770 | 3.9990 | 55.066 | 0.076 | 154.34 | 13.72 | −0.005 |
| ### | May 8, 2012 | 12:05:26 PM | 13.72 | 3.999 | 10.4587 | 3.430 | 54.880 | 0.076 | 153.89 | 13.770 | 3.9990 | 55.080 | 0.077 | 154.42 | 13.72 | −0.004 |
| ### | May 8, 2012 | 12:05:31 PM | 13.72 | 3.999 | 10.4541 | 3.430 | 54.866 | 0.076 | 153.97 | 13.770 | 3.9990 | 55.066 | 0.076 | 154.49 | 13.72 | −0.003 |
| ### | May 8, 2012 | 12:05:36 PM | 13.72 | 3.999 | 10.4698 | 3.430 | 54.866 | 0.076 | 154.05 | 13.770 | 3.9990 | 55.066 | 0.076 | 154.57 | 13.72 | −0.002 |
| ### | May 8, 2012 | 12:05:41 PM | 13.72 | 3.999 | 10.4753 | 3.430 | 54.866 | 0.076 | 154.12 | 13.770 | 3.9990 | 55.066 | 0.076 | 154.65 | 13.72 | −0.001 |
| ### | May 8, 2012 | 12:05:46 PM | 13.72 | 3.999 | 10.4809 | 3.430 | 54.866 | 0.076 | 154.20 | 13.770 | 3.9990 | 55.066 | 0.076 | 154.72 | 13.72 | 0.001 |
| ### | May 8, 2012 | 12:05:51 PM | 13.72 | 3.999 | 10.4865 | 3.430 | 54.866 | 0.076 | 154.28 | 13.770 | 3.9990 | 55.066 | 0.076 | 154.80 | 13.72 | 0.002 |
| ### | May 8, 2012 | 12:05:56 PM | 13.72 | 3.999 | 10.4920 | 3.430 | 54.866 | 0.076 | 154.35 | 13.770 | 3.9990 | 55.066 | 0.076 | 154.88 | 13.72 | 0.003 |
| ### | May 8, 2012 | 12:06:01 PM | 13.72 | 3.999 | 10.4975 | 3.430 | 54.866 | 0.076 | 154.45 | 13.770 | 3.9990 | 55.066 | 0.076 | 154.95 | 13.72 | 0.004 |
| ### | May 8, 2012 | 12:06:06 PM | 13.72 | 3.999 | 10.5031 | 3.430 | 54.866 | 0.076 | 154.50 | 13.770 | 3.9990 | 55.066 | 0.076 | 155.03 | 13.72 | 0.005 |
| ### | May 8, 2012 | 12:06:11 PM | 13.71 | 3.999 | 10.5085 | 3.428 | 54.826 | 0.076 | 154.58 | 13.760 | 3.9990 | 55.026 | 0.076 | 155.11 | 13.71 | −0.005 |
| ### | May 8, 2012 | 12:06:16 PM | 13.71 | 3.999 | 10.5140 | 3.428 | 54.826 | 0.076 | 154.66 | 13.760 | 3.9990 | 55.026 | 0.076 | 155.18 | 13.71 | −0.004 |
| ### | May 8, 2012 | 12:06:21 PM | 13.71 | 3.999 | 10.5156 | 3.428 | 54.826 | 0.076 | 154.73 | 13.760 | 3.9990 | 55.026 | 0.076 | 155.26 | 13.71 | −0.003 |
| ### | May 8, 2012 | 12:06:26 PM | 13.71 | 3.999 | 10.5251 | 3.428 | 54.826 | 0.076 | 154.81 | 13.760 | 3.9990 | 55.026 | 0.076 | 155.34 | 13.71 | −0.002 |
| ### | May 8, 2012 | 12:06:31 PM | 13.71 | 3.999 | 10.5308 | 3.428 | 54.826 | 0.076 | 154.88 | 13.760 | 3.9990 | 55.026 | 0.076 | 155.41 | 13.71 | −0.001 |
| ### | May 8, 2012 | 12:06:36 PM | 13.71 | 3.999 | 10.5364 | 3.428 | 54.826 | 0.076 | 154.96 | 13.760 | 3.9990 | 55.026 | 0.076 | 155.49 | 13.71 | 0.000 |
| ### | May 8, 2012 | 12:06:41 PM | 13.71 | 3.999 | 10.5419 | 3.428 | 54.826 | 0.076 | 155.04 | 13.760 | 3.9990 | 55.026 | 0.076 | 155.56 | 13.71 | 0.000 |
| ### | May 8, 2012 | 12:06:46 PM | 13.71 | 3.999 | 10.5475 | 3.428 | 54.826 | 0.076 | 155.11 | 13.760 | 3.9990 | 55.026 | 0.076 | 155.64 | 13.71 | 0.000 |
| ### | May 8, 2012 | 12:06:51 PM | 13.71 | 3.999 | 10.5530 | 3.428 | 54.826 | 0.076 | 155.19 | 13.760 | 3.9990 | 55.026 | 0.076 | 155.72 | 13.71 | 0.000 |
| ### | May 8, 2012 | 12:06:56 PM | 13.71 | 3.999 | 10.5585 | 3.428 | 54.826 | 0.076 | 155.27 | 13.760 | 3.9990 | 55.026 | 0.076 | 155.79 | 13.71 | 0.000 |
| ### | May 8, 2012 | 12:07:01 PM | 13.71 | 3.999 | 10.5641 | 3.428 | 54.826 | 0.076 | 155.34 | 13.760 | 3.9990 | 55.026 | 0.076 | 155.87 | 13.71 | 0.000 |
| ### | May 8, 2012 | 12:07:06 PM | 13.71 | 3.999 | 10.5696 | 3.428 | 54.826 | 0.076 | 155.42 | 13.760 | 3.9990 | 55.026 | 0.076 | 155.95 | 13.71 | 0.000 |
| ### | May 8, 2012 | 12:07:11 PM | 13.71 | 3.999 | 10.5752 | 3.428 | 54.826 | 0.076 | 155.49 | 13.760 | 3.9990 | 55.026 | 0.076 | 156.02 | 13.71 | 0.001 |
| ### | May 8, 2012 | 12:07:16 PM | 13.71 | 3.999 | 10.5807 | 3.428 | 54.826 | 0.076 | 155.57 | 13.760 | 3.9990 | 55.026 | 0.076 | 156.10 | 13.71 | 0.001 |
| ### | May 8, 2012 | 12:07:21 PM | 13.71 | 3.999 | 10.5863 | 3.428 | 54.826 | 0.076 | 155.65 | 13.760 | 3.9990 | 55.026 | 0.076 | 156.18 | 13.71 | 0.002 |
| ### | May 8, 2012 | 12:07:26 PM | 13.71 | 3.999 | 10.5918 | 3.428 | 54.826 | 0.076 | 155.72 | 13.760 | 3.9990 | 55.026 | 0.076 | 156.25 | 13.71 | 0.003 |
| ### | May 8, 2012 | 12:07:31 PM | 13.71 | 3.999 | 10.5972 | 3.428 | 54.826 | 0.076 | 155.80 | 13.760 | 3.9990 | 55.026 | 0.076 | 156.33 | 13.71 | 0.004 |
| ### | May 8, 2012 | 12:07:36 PM | 13.70 | 3.999 | 10.6028 | 3.425 | 54.786 | 0.076 | 155.87 | 13.750 | 3.9990 | 54.986 | 0.076 | 156.41 | 13.71 | −0.005 |
| ### | May 8, 2012 | 12:07:41 PM | 13.71 | 3.999 | 10.6083 | 3.425 | 54.786 | 0.076 | 155.95 | 13.760 | 3.9990 | 55.026 | 0.076 | 156.48 | 13.70 | 0.005 |
| ### | May 8, 2012 | 12:07:46 PM | 13.70 | 3.999 | 10.6140 | 3.425 | 54.786 | 0.076 | 156.03 | 13.750 | 3.9990 | 55.026 | 0.076 | 156.56 | 13.70 | −0.004 |
| ### | May 8, 2012 | 12:07:51 PM | 13.70 | 3.999 | 10.6196 | 3.425 | 54.786 | 0.076 | 156.10 | 13.750 | 3.9990 | 54.986 | 0.076 | 156.63 | 13.70 | −0.003 |
| ### | May 8, 2012 | 12:07:56 PM | 13.70 | 3.999 | 10.6251 | 3.425 | 54.786 | 0.076 | 156.18 | 13.750 | 3.9990 | 54.986 | 0.076 | 156.71 | 13.70 | −0.002 |
| ### | May 8, 2012 | 12:08:01 PM | 13.70 | 3.999 | 10.6306 | 3.425 | 54.786 | 0.076 | 156.25 | 13.750 | 3.9990 | 54.986 | 0.076 | 156.79 | 13.70 | −0.001 |
| ### | May 8, 2012 | 12:08:06 PM | 13.70 | 3.999 | 10.6362 | 3.425 | 54.786 | 0.076 | 156.33 | 13.750 | 3.9990 | 54.986 | 0.076 | 156.86 | 13.70 | −0.001 |
| ### | May 8, 2012 | 12:08:11 PM | 13.70 | 3.999 | 10.6417 | 3.425 | 54.786 | 0.076 | 156.41 | 13.750 | 3.9990 | 54.986 | 0.076 | 156.94 | 13.70 | 0.000 |
| ### | May 8, 2012 | 12:08:16 PM | 13.70 | 3.999 | 10.6473 | 3.425 | 54.786 | 0.076 | 156.48 | 13.750 | 3.9990 | 54.986 | 0.076 | 157.02 | 13.70 | 0.000 |
| ### | May 8, 2012 | 12:08:21 PM | 13.70 | 3.999 | 10.6528 | 3.425 | 54.786 | 0.076 | 156.56 | 13.750 | 3.9990 | 54.986 | 0.076 | 157.09 | 13.70 | 0.001 |
| ### | May 8, 2012 | 12:08:26 PM | 13.70 | 3.999 | 10.6584 | 3.425 | 54.786 | 0.076 | 156.64 | 13.750 | 3.9990 | 54.986 | 0.076 | 157.17 | 13.70 | 0.002 |
| ### | May 8, 2012 | 12:08:31 PM | 13.70 | 3.999 | 10.6639 | 3.425 | 54.786 | 0.076 | 156.71 | 13.750 | 3.9990 | 54.986 | 0.076 | 157.25 | 13.70 | 0.003 |
| ### | May 8, 2012 | 12:08:36 PM | 13.70 | 3.999 | 10.6694 | 3.425 | 54.786 | 0.076 | 156.79 | 13.750 | 3.9990 | 54.986 | 0.076 | 157.32 | 13.70 | 0.004 |
| ### | May 8, 2012 | 12:08:41 PM | 13.70 | 3.999 | 10.6750 | 3.425 | 54.786 | 0.076 | 156.86 | 13.750 | 3.9990 | 54.986 | 0.076 | 157.40 | 13.70 | 0.005 |
| ### | May 8, 2012 | 12:08:46 PM | 13.69 | 3.999 | 10.6806 | 3.423 | 54.746 | 0.076 | 156.94 | 13.740 | 3.9990 | 54.946 | 0.076 | 157.47 | 13.69 | −0.005 |
| ### | May 8, 2012 | 12:08:51 PM | 13.69 | 3.999 | 10.6861 | 3.423 | 54.746 | 0.076 | 157.02 | 13.740 | 3.9990 | 54.946 | 0.076 | 157.55 | 13.69 | −0.004 |
| ### | May 8, 2012 | 12:08:56 PM | 13.69 | 3.999 | 10.6916 | 3.423 | 54.746 | 0.076 | 157.09 | 13.740 | 3.9990 | 54.946 | 0.076 | 157.63 | 13.69 | −0.003 |
| ### | May 8, 2012 | 12:09:01 PM | 13.69 | 3.999 | 10.6972 | 3.423 | 54.746 | 0.076 | 157.17 | 13.740 | 3.9990 | 54.946 | 0.076 | 157.70 | 13.69 | −0.002 |
| ### | May 8, 2012 | 12:09:06 PM | 13.69 | 3.999 | 10.7027 | 3.423 | 54.746 | 0.076 | 157.24 | 13.740 | 3.9990 | 54.946 | 0.076 | 157.78 | 13.69 | −0.001 |
| ### | May 8, 2012 | 12:09:11 PM | 13.69 | 3.999 | 10.7083 | 3.423 | 54.746 | 0.076 | 157.32 | 13.740 | 3.9990 | 54.946 | 0.076 | 157.86 | 13.69 | 0.000 |
| ### | May 8, 2012 | 12:09:16 PM | 13.69 | 3.999 | 10.7138 | 3.423 | 54.746 | 0.076 | 157.40 | 13.740 | 3.9990 | 54.946 | 0.076 | 157.93 | 13.69 | 0.001 |
| ### | May 8, 2012 | 12:09:21 PM | 13.69 | 3.999 | 10.7194 | 3.423 | 54.746 | 0.076 | 157.47 | 13.740 | 3.9990 | 54.946 | 0.076 | 158.01 | 13.69 | 0.002 |
| ### | May 8, 2012 | 12:09:26 PM | 13.69 | 3.999 | 10.7249 | 3.423 | 54.746 | 0.076 | 157.55 | 13.740 | 3.9990 | 54.946 | 0.076 | 158.09 | 13.69 | 0.003 |
| ### | May 8, 2012 | 12:09:31 PM | 13.69 | 3.999 | 10.7304 | 3.423 | 54.746 | 0.076 | 157.62 | 13.740 | 3.9990 | 54.946 | 0.076 | 158.16 | 13.69 | 0.004 |
| ### | May 8, 2012 | 12:09:36 PM | 13.69 | 3.999 | 10.7360 | 3.423 | 54.746 | 0.076 | 157.70 | 13.740 | 3.9990 | 54.946 | 0.076 | 158.24 | 13.69 | 0.005 |
| ### | May 8, 2012 | 12:09:41 PM | 13.68 | 3.999 | 10.7415 | 3.420 | 54.706 | 0.076 | 157.78 | 13.730 | 3.9990 | 54.946 | 0.076 | 158.31 | 13.68 | −0.005 |
| ### | May 8, 2012 | 12:09:46 PM | 13.68 | 3.999 | 10.7471 | 3.420 | 54.706 | 0.076 | 157.85 | 13.730 | 3.9990 | 54.946 | 0.076 | 158.39 | 13.68 | −0.004 |
| ### | May 8, 2012 | 12:09:51 PM | 13.68 | 3.999 | 10.7526 | 3.420 | 54.706 | 0.076 | 157.93 | 13.730 | 3.9990 | 54.946 | 0.076 | 158.47 | 13.68 | −0.003 |
| ### | May 8, 2012 | 12:09:56 PM | 13.68 | 3.999 | 10.7582 | 3.420 | 54.706 | 0.076 | 158.00 | 13.730 | 3.9990 | 54.946 | 0.076 | 158.54 | 13.68 | −0.002 |
| ### | May 8, 2012 | 12:10:01 PM | 13.68 | 3.999 | 10.7637 | 3.420 | 54.706 | 0.076 | 158.08 | 13.730 | 3.9990 | 54.946 | 0.076 | 158.62 | 13.68 | −0.001 |
| ### | May 8, 2012 | 12:10:06 PM | 13.68 | 3.999 | 10.7693 | 3.420 | 54.706 | 0.076 | 158.16 | 13.730 | 3.9990 | 54.906 | 0.076 | 158.70 | 13.68 | 0.000 |
| ### | May 8, 2012 | 12:10:11 PM | 13.68 | 3.999 | 10.7748 | 3.420 | 54.706 | 0.076 | 158.23 | 13.730 | 3.9990 | 54.906 | 0.076 | 158.77 | 13.68 | 0.001 |
| ### | May 8, 2012 | 12:10:16 PM | 13.68 | 3.999 | 10.7804 | 3.420 | 54.706 | 0.076 | 158.31 | 13.730 | 3.9990 | 54.906 | 0.076 | 158.85 | 13.68 | 0.002 |
| ### | May 8, 2012 | 12:10:21 PM | 13.68 | 3.999 | 10.7859 | 3.420 | 54.706 | 0.076 | 158.38 | 13.730 | 3.9990 | 54.906 | 0.076 | 158.92 | 13.68 | 0.003 |
| ### | May 8, 2012 | 12:10:26 PM | 13.68 | 3.999 | 10.7914 | 3.420 | 54.706 | 0.076 | 158.46 | 13.730 | 3.9990 | 54.906 | 0.076 | 159.00 | 13.68 | 0.003 |
| ### | May 8, 2012 | 12:10:31 PM | 13.68 | 3.999 | 10.7970 | 3.420 | 54.706 | 0.076 | 158.54 | 13.730 | 3.9990 | 54.906 | 0.076 | 159.08 | 13.68 | 0.003 |
| ### | May 8, 2012 | 12:10:36 PM | 13.67 | 3.999 | 10.8026 | 3.418 | 54.666 | 0.076 | 158.61 | 13.720 | 3.9990 | 54.866 | 0.076 | 159.15 | 13.68 | −0.007 |
| ### | May 8, 2012 | 12:10:41 PM | 13.67 | 3.999 | 10.8081 | 3.418 | 54.666 | 0.076 | 158.69 | 13.720 | 3.9990 | 54.866 | 0.076 | 159.23 | 13.68 | −0.007 |
| ### | May 8, 2012 | 12:10:46 PM | 13.67 | 3.999 | 10.8136 | 3.418 | 54.666 | 0.076 | 158.76 | 13.720 | 3.9990 | 54.866 | 0.076 | 159.31 | 13.68 | −0.007 |
| ### | May 8, 2012 | 12:10:51 PM | 13.68 | 3.999 | 10.8192 | 3.420 | 54.706 | 0.076 | 158.84 | 13.730 | 3.9990 | 54.906 | 0.076 | 159.38 | 13.68 | 0.003 |
| ### | May 8, 2012 | 12:10:56 PM | 13.68 | 3.999 | 10.8248 | 3.420 | 54.706 | 0.076 | 158.92 | 13.730 | 3.9990 | 54.906 | 0.076 | 159.46 | 13.68 | 0.003 |
| ### | May 8, 2012 | 12:11:01 PM | 13.68 | 3.999 | 10.8303 | 3.420 | 54.706 | 0.076 | 158.99 | 13.730 | 3.9990 | 54.906 | 0.076 | 159.53 | 13.68 | 0.003 |
| ### | May 8, 2012 | 12:11:06 PM | 13.68 | 3.999 | 10.8358 | 3.420 | 54.706 | 0.076 | 159.07 | 13.730 | 3.9990 | 54.906 | 0.076 | 159.61 | 13.68 | 0.002 |
| ### | May 8, 2012 | 12:11:11 PM | 13.68 | 3.999 | 10.8412 | 3.420 | 54.706 | 0.076 | 159.14 | 13.730 | 3.9990 | 54.906 | 0.076 | 159.69 | 13.68 | 0.001 |
| ### | May 8, 2012 | 12:11:16 PM | 13.68 | 3.999 | 10.8467 | 3.420 | 54.706 | 0.076 | 159.22 | 13.730 | 3.9990 | 54.906 | 0.076 | 159.76 | 13.68 | 0.000 |
| ### | May 8, 2012 | 12:11:21 PM | 13.68 | 3.999 | 10.8523 | 3.420 | 54.706 | 0.076 | 159.30 | 13.730 | 3.9990 | 54.906 | 0.076 | 159.84 | 13.68 | 0.001 |
| ### | May 8, 2012 | 12:11:26 PM | 13.68 | 3.999 | 10.8578 | 3.420 | 54.706 | 0.076 | 159.37 | 13.730 | 3.9990 | 54.906 | 0.076 | 159.92 | 13.68 | 0.002 |
| ### | May 8, 2012 | 12:11:31 PM | 13.68 | 3.999 | 10.8634 | 3.420 | 54.706 | 0.076 | 159.45 | 13.730 | 3.9990 | 54.906 | 0.076 | 159.99 | 13.68 | 0.003 |
| ### | May 8, 2012 | 12:11:36 PM | 13.68 | 3.999 | 10.8689 | 3.420 | 54.706 | 0.076 | 159.52 | 13.730 | 3.9990 | 54.906 | 0.076 | 160.07 | 13.68 | 0.004 |
| ### | May 8, 2012 | 12:11:41 PM | 13.68 | 3.999 | 10.8745 | 3.420 | 54.706 | 0.076 | 159.60 | 13.730 | 3.9990 | 54.906 | 0.076 | 160.14 | 13.68 | 0.005 |
| ### | May 8, 2012 | 12:11:46 PM | 13.68 | 3.999 | 10.8800 | 3.418 | 54.706 | 0.076 | 159.68 | 13.720 | 3.9990 | 54.866 | 0.076 | 160.22 | 13.67 | −0.005 |
| ### | May 8, 2012 | 12:11:51 PM | 13.68 | 3.999 | 10.8855 | 3.418 | 54.666 | 0.076 | 159.75 | 13.720 | 3.9990 | 54.866 | 0.076 | 160.30 | 13.67 | −0.004 |
| ### | May 8, 2012 | 12:11:56 PM | 13.68 | 3.999 | 10.8911 | 3.418 | 54.666 | 0.076 | 159.83 | 13.720 | 3.9990 | 54.866 | 0.076 | 160.37 | 13.67 | −0.003 |
| ### | May 8, 2012 | 12:12:01 PM | 13.68 | 3.999 | 10.8967 | 3.418 | 54.666 | 0.076 | 159.90 | 13.720 | 3.9990 | 54.866 | 0.076 | 160.45 | 13.67 | −0.002 |
| ### | May 8, 2012 | 12:12:06 PM | 13.68 | 3.999 | 10.9022 | 3.418 | 54.666 | 0.076 | 159.98 | 13.720 | 3.9990 | 54.866 | 0.076 | 160.53 | 13.67 | 0.000 |
| ### | May 8, 2012 | 12:12:11 PM | 13.67 | 3.999 | 10.9077 | 3.418 | 54.666 | 0.076 | 160.06 | 13.720 | 3.9990 | 54.866 | 0.076 | 160.60 | 13.67 | 0.002 |
| ### | May 8, 2012 | 12:12:16 PM | 13.67 | 3.999 | 10.9133 | 3.418 | 54.666 | 0.076 | 160.13 | 13.720 | 3.9990 | 54.866 | 0.076 | 160.68 | 13.67 | 0.003 |
| ### | May 8, 2012 | 12:12:21 PM | 13.67 | 3.999 | 10.9188 | 3.418 | 54.666 | 0.076 | [symbol] | 13.720 | 3.9990 | 54.866 | 0.076 | 160.75 | 13.67 | 0.004 |
| ### | May 8, 2012 | 12:12:26 PM | 13.67 | 3.999 | 10.9244 | 3.418 | 54.666 | 0.076 | 160.28 | 13.720 | 3.9990 | 54.866 | 0.076 | 160.83 | 13.67 | 0.005 |
| ### | May 8, 2012 | 12:12:31 PM | 13.66 | 3.999 | 10.9299 | 3.415 | 54.626 | 0.076 | 160.36 | 13.710 | 3.9990 | 54.826 | 0.076 | 160.91 | 13.66 | −0.005 |
| ### | May 8, 2012 | 12:12:36 PM | 13.66 | 3.999 | 10.9355 | 3.415 | 54.626 | 0.076 | 160.43 | 13.710 | 3.9990 | 54.826 | 0.076 | 160.58 | 13.66 | −0.004 |
| ### | May 8, 2012 | 12:12:41 PM | 13.66 | 3.999 | 10.9410 | 3.415 | 54.626 | 0.076 | 160.51 | 13.710 | 3.9990 | 54.826 | 0.076 | 161.05 | 13.66 | −0.003 |
| ### | May 8, 2012 | 12:12:46 PM | 13.66 | 3.999 | 10.9465 | 3.415 | 54.626 | 0.076 | 160.59 | 13.710 | 3.9990 | 54.826 | 0.076 | 161.13 | 13.66 | −0.002 |
| ### | May 8, 2012 | 12:12:51 PM | 13.66 | 3.999 | 10.9521 | 3.415 | 54.626 | 0.076 | 160.66 | 13.710 | 3.9990 | 54.826 | 0.076 | 161.21 | 13.66 | 0.000 |
| ### | May 8, 2012 | 12:12:56 PM | 13.66 | 3.999 | 10.9576 | 3.415 | 54.626 | 0.076 | 160.74 | 13.710 | 3.9990 | 54.826 | 0.076 | 161.29 | 13.66 | 0.002 |
| ### | May 8, 2012 | 12:13:01 PM | 13.66 | 3.999 | 10.9632 | 3.415 | 54.626 | 0.076 | 160.81 | 13.710 | 3.9990 | 54.826 | 0.076 | 161.36 | 13.66 | 0.003 |
| ### | May 8, 2012 | 12:13:06 PM | 13.66 | 3.999 | 10.9687 | 3.415 | 54.626 | 0.076 | 160.89 | 13.710 | 3.9990 | 54.826 | 0.076 | 161.44 | 13.66 | 0.004 |
| ### | May 8, 2012 | 12:13:11 PM | 13.66 | 3.999 | 10.9743 | 3.415 | 54.626 | 0.076 | 160.97 | 13.710 | 3.9990 | 54.826 | 0.076 | 161.52 | 13.66 | 0.005 |
| ### | May 8, 2012 | 12:13:16 PM | 13.65 | 3.999 | 10.9798 | 3.413 | 54.586 | 0.076 | 161.04 | 13.700 | 3.9990 | 54.786 | 0.076 | 161.59 | 13.65 | −0.005 |
| ### | May 8, 2012 | 12:13:21 PM | 13.65 | 3.999 | 10.9854 | 3.413 | 54.586 | 0.076 | 161.12 | 13.700 | 3.9990 | 54.786 | 0.076 | 161.67 | 13.65 | −0.004 |
| ### | May 8, 2012 | 12:13:26 PM | 13.65 | 3.999 | 10.9909 | 3.413 | 54.586 | 0.076 | 161.19 | 13.700 | 3.9990 | 54.786 | 0.076 | 161.74 | 13.65 | −0.003 |
| ### | May 8, 2012 | 12:13:31 PM | 13.65 | 3.999 | 11.9965 | 3.413 | 54.586 | 0.076 | 161.27 | 13.700 | 3.9990 | 54.786 | 0.076 | 161.82 | 13.65 | −0.002 |
| ### | May 8, 2012 | 12:13:36 PM | 13.65 | 3.999 | 11.0020 | 3.413 | 54.586 | 0.076 | 161.34 | 13.700 | 3.9990 | 54.786 | 0.076 | 161.90 | 13.65 | 0.000 |
| ### | May 8, 2012 | 12:13:41 PM | 13.65 | 3.999 | 11.0075 | 3.413 | 54.586 | 0.076 | 161.42 | 13.700 | 3.9990 | 54.786 | 0.076 | 161.97 | 13.65 | 0.002 |
| ### | May 8, 2012 | 12:13:46 PM | 13.65 | 3.999 | 11.0131 | 3.413 | 54.586 | 0.076 | 161.50 | 13.700 | 3.9990 | 54.786 | 0.076 | 162.05 | 13.65 | 0.003 |
| ### | May 8, 2012 | 12:13:51 PM | 13.65 | 3.999 | 11.0186 | 3.413 | 54.586 | 0.076 | 161.57 | 13.700 | 3.9990 | 54.786 | 0.076 | 162.12 | 13.65 | 0.004 |
| ### | May 8, 2012 | 12:13:56 PM | 13.65 | 3.999 | 11.0242 | 3.413 | 54.586 | 0.076 | 161.65 | 13.700 | 3.9990 | 54.786 | 0.076 | 162.20 | 13.65 | 0.005 |
| ### | May 8, 2012 | 12:14:01 PM | 13.64 | 3.999 | 11.0297 | 3.410 | 54.546 | 0.076 | 161.72 | 13.690 | 3.9990 | 54.786 | 0.076 | 162.28 | 13.64 | −0.005 |
| ### | May 8, 2012 | 12:14:06 PM | 13.64 | 3.999 | 11.0353 | 3.410 | 54.546 | 0.076 | 161.80 | 13.690 | 3.9990 | 54.786 | 0.076 | 162.35 | 13.64 | −0.004 |
| ### | May 8, 2012 | 12:14:11 PM | 13.64 | 3.999 | 11.0408 | 3.410 | 54.546 | 0.076 | 161.88 | 13.690 | 3.9990 | 54.786 | 0.076 | 162.43 | 13.64 | −0.003 |
| ### | May 8, 2012 | 12:14:16 PM | 13.64 | 3.999 | 11.0464 | 3.410 | 54.546 | 0.076 | 161.95 | 13.690 | 3.9990 | 54.786 | 0.076 | 162.50 | 13.64 | −0.002 |
| ### | May 8, 2012 | 12:14:21 PM | 13.64 | 3.999 | 11.0519 | 3.410 | 54.546 | 0.076 | 162.03 | 13.690 | 3.9990 | 54.786 | 0.076 | 162.58 | 13.64 | −0.001 |
| ### | May 8, 2012 | 12:14:26 PM | 13.64 | 3.999 | 11.0575 | 3.410 | 54.546 | 0.076 | 162.10 | 13.690 | 3.9990 | 54.786 | 0.076 | 162.66 | 13.64 | 0.000 |
| ### | May 8, 2012 | 12:14:31 PM | 13.64 | 3.999 | 11.0630 | 3.410 | 54.546 | 0.076 | 162.18 | 13.690 | 3.9990 | 54.786 | 0.076 | 162.73 | 13.64 | 0.000 |
| ### | May 8, 2012 | 12:14:36 PM | 13.64 | 3.999 | 11.0686 | 3.410 | 54.546 | 0.076 | 162.25 | 13.690 | 3.9990 | 54.786 | 0.076 | 162.81 | 13.64 | 0.000 |
| ### | May 8, 2012 | 12:14:41 PM | 13.64 | 3.999 | 11.0741 | 3.410 | 54.546 | 0.076 | 162.33 | 13.690 | 3.9990 | 54.786 | 0.076 | 162.88 | 13.64 | 0.000 |
| ### | May 8, 2012 | 12:14:46 PM | 13.64 | 3.999 | 11.0797 | 3.410 | 54.546 | 0.076 | 162.41 | 13.690 | 3.9990 | 54.786 | 0.076 | 162.96 | 13.64 | 0.001 |
| ### | May 8, 2012 | 12:14:51 PM | 13.64 | 3.999 | 11.0852 | 3.410 | 54.546 | 0.076 | 162.48 | 13.690 | 3.9990 | 54.786 | 0.076 | 163.04 | 13.64 | 0.002 |
| ### | May 8, 2012 | 12:14:56 PM | 13.64 | 3.999 | 11.0908 | 3.410 | 54.546 | 0.076 | 162.56 | 13.690 | 3.9990 | 54.786 | 0.076 | 163.11 | 13.64 | 0.003 |
| ### | May 8, 2012 | 12:15:01 PM | 13.64 | 3.999 | 11.0965 | 3.410 | 54.546 | 0.076 | 162.63 | 13.690 | 3.9990 | 54.786 | 0.076 | 163.19 | 13.64 | 0.004 |
| ### | May 8, 2012 | 12:15:06 PM | 13.64 | 3.999 | 11.1020 | 3.410 | 54.546 | 0.076 | 162.71 | 13.690 | 3.9990 | 54.786 | 0.076 | 163.26 | 13.64 | 0.005 |
| ### | May 8, 2012 | 12:15:11 PM | 13.63 | 3.999 | 11.1076 | 3.408 | 54.506 | 0.076 | 162.78 | 13.680 | 3.9990 | 54.706 | 0.076 | 163.34 | 13.63 | −0.005 |
| ### | May 8, 2012 | 12:15:16 PM | 13.63 | 3.999 | 11.1129 | 3.408 | 54.506 | 0.076 | 162.86 | 13.680 | 3.9990 | 54.706 | 0.076 | 163.42 | 13.63 | −0.004 |
| ### | May 8, 2012 | 12:15:21 PM | 13.63 | 3.999 | 11.1185 | 3.408 | 54.506 | 0.076 | 162.94 | 13.680 | 3.9990 | 54.706 | 0.076 | 163.49 | 13.63 | −0.003 |
| ### | May 8, 2012 | 12:15:26 PM | 13.63 | 3.999 | 11.1240 | 3.408 | 54.506 | 0.076 | 163.01 | 13.680 | 3.9990 | 54.706 | 0.076 | 163.57 | 13.63 | −0.002 |
| ### | May 8, 2012 | 12:15:31 PM | 13.63 | 3.999 | 11.1296 | 3.408 | 54.506 | 0.076 | 163.09 | 13.680 | 3.9990 | 54.706 | 0.076 | 163.64 | 13.63 | −0.001 |
| ### | May 8, 2012 | 12:15:36 PM | 13.63 | 3.999 | 11.1351 | 3.408 | 54.506 | 0.076 | 163.16 | 13.680 | 3.9990 | 54.706 | 0.076 | 163.72 | 13.63 | 0.000 |
| ### | May 8, 2012 | 12:15:41 PM | 13.63 | 3.999 | 11.1406 | 3.408 | 54.506 | 0.076 | 163.24 | 13.680 | 3.9990 | 54.706 | 0.076 | 163.80 | 13.63 | 0.000 |
| ### | May 8, 2012 | 12:15:46 PM | 13.63 | 3.999 | 11.1462 | 3.408 | 54.506 | 0.076 | 163.31 | 13.680 | 3.9990 | 54.706 | 0.076 | 163.87 | 13.63 | 0.001 |
| ### | May 8, 2012 | 12:15:51 PM | 13.63 | 3.999 | 11.1518 | 3.408 | 54.506 | 0.076 | 163.39 | 13.680 | 3.9990 | 54.706 | 0.076 | 163.95 | 13.63 | 0.002 |
| ### | May 8, 2012 | 12:15:56 PM | 13.63 | 3.999 | 11.1573 | 3.408 | 54.506 | 0.076 | 163.47 | 13.680 | 3.9990 | 54.706 | 0.076 | 164.02 | 13.63 | 0.003 |
| ### | May 8, 2012 | 12:16:01 PM | 13.63 | 3.999 | 11.1628 | 3.408 | 54.506 | 0.076 | 163.54 | 13.680 | 3.9990 | 54.706 | 0.076 | 164.10 | 13.63 | 0.004 |
| ### | May 8, 2012 | 12:16:06 PM | 13.63 | 4.000 | 11.1684 | 3.408 | 54.520 | 0.076 | 163.62 | 13.680 | 4.0000 | 54.720 | 0.076 | 164.18 | 13.63 | 0.005 |
| ### | May 8, 2012 | 12:16:11 PM | 13.62 | 3.999 | 11.1739 | 3.405 | 54.466 | 0.076 | 163.69 | 13.670 | 3.9990 | 54.666 | 0.076 | 164.25 | 13.62 | −0.005 |
| ### | May 8, 2012 | 12:16:16 PM | 13.62 | 3.999 | 11.1795 | 3.405 | 54.466 | 0.076 | 163.77 | 13.670 | 3.9990 | 54.666 | 0.076 | 164.33 | 13.62 | −0.004 |
| ### | May 8, 2012 | 12:16:21 PM | 13.62 | 3.999 | 11.1850 | 3.405 | 54.466 | 0.076 | 163.84 | 13.670 | 3.9990 | 54.666 | 0.076 | 164.40 | 13.62 | −0.003 |
| ### | May 8, 2012 | 12:16:26 PM | 13.62 | 3.999 | 11.1906 | 3.405 | 54.466 | 0.076 | 163.92 | 13.670 | 3.9990 | 54.666 | 0.076 | 164.48 | 13.62 | −0.002 |
| ### | May 8, 2012 | 12:16:31 PM | 13.62 | 3.999 | 11.1961 | 3.405 | 54.466 | 0.076 | 164.00 | 13.670 | 3.9990 | 54.666 | 0.076 | 164.56 | 13.62 | −0.001 |
| ### | May 8, 2012 | 12:16:36 PM | 13.62 | 3.999 | 11.2016 | 3.405 | 54.466 | 0.076 | 164.07 | 13.670 | 3.9990 | 54.666 | 0.076 | 164.63 | 13.62 | 0.000 |
| ### | May 8, 2012 | 12:16:41 PM | 13.62 | 3.999 | 11.2072 | 3.405 | 54.466 | 0.076 | 164.15 | 13.670 | 3.9990 | 54.666 | 0.076 | 164.71 | 13.62 | 0.000 |
| ### | May 8, 2012 | 12:16:46 PM | 13.62 | 3.999 | 11.2128 | 3.405 | 54.466 | 0.076 | 164.22 | 13.670 | 3.9990 | 54.666 | 0.076 | 164.78 | 13.62 | 0.000 |
| ### | May 8, 2012 | 12:16:51 PM | 13.62 | 3.999 | 11.2183 | 3.405 | 54.466 | 0.076 | 164.30 | 13.670 | 3.9990 | 54.666 | 0.076 | 164.86 | 13.62 | 0.000 |
| ### | May 8, 2012 | 12:16:56 PM | 13.62 | 4.000 | 11.2238 | 3.405 | 54.466 | 0.076 | 164.37 | 13.670 | 4.0000 | 54.680 | 0.076 | 164.94 | 13.62 | 0.000 |
| ### | May 8, 2012 | 12:17:01 PM | 13.62 | 3.999 | 11.2294 | 3.405 | 54.466 | 0.076 | 164.45 | 13.670 | 3.9990 | 54.666 | 0.076 | 165.01 | 13.62 | 0.000 |
| ### | May 8, 2012 | 12:17:06 PM | 13.62 | 4.000 | 11.2349 | 3.405 | 54.466 | 0.076 | 164.52 | 13.670 | 4.0000 | 54.680 | 0.076 | 165.09 | 13.62 | 0.000 |
| ### | May 8, 2012 | 12:17:11 PM | 13.62 | 3.999 | 11.2405 | 3.405 | 54.466 | 0.076 | 164.60 | 13.670 | 3.9990 | 54.666 | 0.076 | 165.16 | 13.62 | 0.000 |
| ### | May 8, 2012 | 12:17:16 PM | 13.62 | 3.999 | 11.2460 | 3.405 | 54.466 | 0.076 | 164.68 | 13.670 | 3.9990 | 54.666 | 0.076 | 165.24 | 13.62 | 0.000 |
| ### | May 8, 2012 | 12:17:21 PM | 13.62 | 3.999 | 11.2516 | 3.405 | 54.466 | 0.076 | 164.75 | 13.670 | 3.9990 | 54.666 | 0.076 | 165.32 | 13.62 | 0.000 |
| ### | May 8, 2012 | 12:17:26 PM | 13.62 | 3.999 | 11.2571 | 3.405 | 54.466 | 0.076 | 164.83 | 13.670 | 3.9990 | 54.666 | 0.076 | 165.39 | 13.62 | 0.001 |
| ### | May 8, 2012 | 12:17:31 PM | 13.62 | 3.999 | 11.2627 | 3.405 | 54.466 | 0.076 | 164.90 | 13.670 | 3.9990 | 54.666 | 0.076 | 165.47 | 13.62 | 0.002 |
| ### | May 8, 2012 | 12:17:36 PM | 13.62 | 3.999 | 11.2682 | 3.405 | 54.466 | 0.076 | 164.98 | 13.670 | 3.9990 | 54.666 | 0.076 | 165.54 | 13.62 | 0.003 |
| ### | May 8, 2012 | 12:17:41 PM | 13.62 | 3.999 | 11.2738 | 3.405 | 54.466 | 0.076 | 165.05 | 13.670 | 3.9990 | 54.666 | 0.076 | 165.62 | 13.62 | 0.004 |
| ### | May 8, 2012 | 12:17:46 PM | 13.62 | 3.999 | 11.2793 | 3.405 | 54.466 | 0.076 | 165.13 | 13.670 | 3.9990 | 54.666 | 0.076 | 165.69 | 13.62 | 0.0005 |
| ### | May 8, 2012 | 12:17:51 PM | 13.61 | 3.999 | 11.2849 | 3.403 | 54.466 | 0.076 | 165.21 | 13.660 | 3.9990 | 54.666 | 0.076 | 165.77 | 13.61 | −0.0005 |
| ### | May 8, 2012 | 12:17:56 PM | 13.61 | 3.999 | 11.2904 | 3.403 | 54.440 | 0.076 | 165.28 | 13.660 | 3.9990 | 54.666 | 0.076 | 165.85 | 13.61 | −0.004 |
| ### | May 8, 2012 | 12:18:01 PM | 13.61 | 3.999 | 11.2959 | 3.403 | 54.426 | 0.076 | 165.36 | 13.660 | 3.9990 | 54.666 | 0.076 | 165.92 | 13.61 | −0.003 |
| ### | May 8, 2012 | 12:18:06 PM | 13.61 | 3.999 | 11.3015 | 3.403 | 54.426 | 0.076 | 165.43 | 13.660 | 3.9990 | 54.666 | 0.076 | 166.00 | 13.61 | −0.002 |
| ### | May 8, 2012 | 12:18:11 PM | 13.61 | 3.999 | 11.3070 | 3.403 | 54.426 | 0.076 | 165.51 | 13.660 | 3.9990 | 54.666 | 0.076 | 166.07 | 13.61 | −0.001 |
| ### | May 8, 2012 | 12:18:16 PM | 13.61 | 3.999 | 11.3128 | 3.403 | 54.426 | 0.076 | 165.58 | 13.660 | 3.9990 | 54.666 | 0.076 | 166.15 | 13.61 | 0.000 |
| ### | May 8, 2012 | 12:18:21 PM | 13.61 | 3.999 | 11.3181 | 3.403 | 54.426 | 0.076 | 165.66 | 13.660 | 3.9990 | 54.666 | 0.076 | 166.23 | 13.61 | 0.000 |
| ### | May 8, 2012 | 12:18:26 PM | 13.61 | 3.999 | 11.3237 | 3.403 | 54.426 | 0.076 | 165.73 | 13.660 | 3.9990 | 54.666 | 0.076 | 166.30 | 13.61 | 0.000 |
| ### | May 8, 2012 | 12:18:31 PM | 13.61 | 3.999 | 11.3292 | 3.403 | 54.426 | 0.076 | 165.81 | 13.660 | 3.9990 | 54.666 | 0.076 | 166.38 | 13.61 | 0.000 |
| ### | May 8, 2012 | 12:18:36 PM | 13.61 | 3.999 | 11.3348 | 3.403 | 54.426 | 0.076 | 165.89 | 13.660 | 3.9990 | 54.666 | 0.076 | 166.45 | 13.61 | 0.000 |
| ### | May 8, 2012 | 12:18:41 PM | 13.61 | 3.999 | 11.3403 | 3.403 | 54.426 | 0.076 | 165.96 | 13.660 | 3.9990 | 54.626 | 0.076 | 166.53 | 13.61 | 0.001 |
| ### | May 8, 2012 | 12:18:46 PM | 13.61 | 3.999 | 11.3459 | 3.403 | 54.426 | 0.076 | 166.04 | 13.660 | 3.9990 | 54.626 | 0.076 | 166.61 | 13.61 | 0.001 |
| ### | May 8, 2012 | 12:18:51 PM | 13.61 | 3.999 | 11.3516 | 3.403 | 54.426 | 0.076 | 166.11 | 13.660 | 3.9990 | 54.626 | 0.076 | 166.68 | 13.61 | 0.002 |
| ### | May 8, 2012 | 12:18:56 PM | 13.61 | 3.999 | 11.3569 | 3.403 | 54.426 | 0.076 | 166.19 | 13.660 | 3.9990 | 54.626 | 0.076 | 166.76 | 13.61 | 0.003 |
| ### | May 8, 2012 | 12:19:01 PM | 13.61 | 3.999 | 11.3625 | 3.403 | 54.426 | 0.076 | 165.26 | 13.660 | 3.9990 | 54.626 | 0.076 | 166.83 | 13.61 | 0.004 |
| ### | May 8, 2012 | 12:19:06 PM | 13.60 | 3.999 | 11.3680 | 3.400 | 54.426 | 0.076 | 166.34 | 13.660 | 3.9990 | 54.586 | 0.076 | 166.91 | 13.61 | 0.005 |
| ### | May 8, 2012 | 12:19:11 PM | 13.61 | 3.999 | 11.3736 | 3.403 | 54.426 | 0.076 | 166.42 | 13.660 | 3.9990 | 54.626 | 0.076 | 166.98 | 13.60 | −0.005 |
| ### | May 8, 2012 | 12:19:16 PM | 13.60 | 3.999 | 11.3791 | 3.400 | 54.400 | 0.076 | 166.49 | 13.650 | 4.0000 | 54.600 | 0.076 | 167.06 | 13.60 | −0.004 |
| ### | May 8, 2012 | 12:19:21 PM | 13.60 | 3.999 | 11.3847 | 3.400 | 54.386 | 0.076 | 166.57 | 13.650 | 3.9990 | 54.586 | 0.076 | 167.14 | 13.60 | −0.003 |
| ### | May 8, 2012 | 12:19:26 PM | 13.60 | 3.999 | 11.3902 | 3.400 | 54.386 | 0.076 | 166.64 | 13.650 | 3.9990 | 54.586 | 0.076 | 167.21 | 13.60 | −0.002 |
| ### | May 8, 2012 | 12:19:31 PM | 13.60 | 3.999 | 11.3957 | 3.400 | 54.386 | 0.076 | 166.72 | 13.650 | 3.9990 | 54.586 | 0.076 | 167.29 | 13.60 | −0.001 |
| ### | May 8, 2012 | 12:19:36 PM | 13.60 | 3.999 | 11.4013 | 3.400 | 54.386 | 0.076 | 166.79 | 13.650 | 3.9990 | 54.586 | 0.076 | 167.36 | 13.60 | 0.000 |
| ### | May 8, 2012 | 12:19:41 PM | 13.60 | 3.999 | 11.4068 | 3.400 | 54.386 | 0.076 | 166.87 | 13.650 | 3.9990 | 54.586 | 0.076 | 167.44 | 13.60 | 0.000 |
| ### | May 8, 2012 | 12:19:46 PM | 13.60 | 3.999 | 11.4124 | 3.400 | 54.386 | 0.076 | 166.94 | 13.650 | 3.9990 | 54.586 | 0.076 | 167.52 | 13.60 | 0.000 |
| ### | May 8, 2012 | 12:19:51 PM | 13.60 | 3.999 | 11.4179 | 3.400 | 54.386 | 0.076 | 167.02 | 13.650 | 3.9990 | 54.586 | 0.076 | 167.67 | 13.60 | 0.000 |
| ### | May 8, 2012 | 12:19:56 PM | 13.60 | 3.999 | 11.4235 | 3.400 | 54.400 | 0.076 | 167.09 | 13.650 | 4.0000 | 54.600 | 0.076 | 167.74 | 13.60 | 0.001 |
| ### | May 8, 2012 | 12:20:01 PM | 13.60 | 3.999 | 11.4290 | 3.400 | 54.386 | 0.076 | 167.17 | 13.650 | 3.9990 | 54.586 | 0.076 | 167.82 | 13.60 | 0.002 |
| ### | May 8, 2012 | 12:20:06 PM | 13.60 | 3.999 | 11.4346 | 3.400 | 54.386 | 0.076 | 167.25 | 13.650 | 3.9990 | 54.586 | 0.076 | 167.89 | 13.60 | 0.003 |
| ### | May 8, 2012 | 12:20:11 PM | 13.60 | 3.999 | 11.4401 | 3.400 | 54.386 | 0.076 | 167.32 | 13.650 | 3.9990 | 54.586 | 0.076 | 167.97 | 13.60 | 0.004 |
| ### | May 8, 2012 | 12:20:16 PM | 13.60 | 3.999 | 11.4457 | 3.400 | 54.386 | 0.076 | 167.40 | 13.650 | 3.9990 | 54.586 | 0.076 | 168.05 | 13.60 | 0.005 |
| ### | May 8, 2012 | 12:20:21 PM | 13.60 | 3.999 | 11.4512 | 3.400 | 54.386 | 0.076 | 167.47 | 13.650 | 3.9990 | 54.586 | 0.076 | 168.12 | 13.59 | −0.005 |
| ### | May 8, 2012 | 12:20:26 PM | 13.59 | 3.999 | 11.4567 | 3.398 | 54.346 | 0.075 | 167.55 | 13.640 | 3.9990 | 54.546 | 0.076 | 168.20 | 13.59 | −0.003 |
| ### | May 8, 2012 | 12:20:31 PM | 13.59 | 3.999 | 11.4623 | 3.398 | 54.346 | 0.075 | 167.62 | 13.640 | 3.9990 | 54.546 | 0.076 | 168.27 | 13.59 | −0.001 |
| ### | May 8, 2012 | 12:20:36 PM | 13.59 | 3.999 | 11.4678 | 3.398 | 54.360 | 0.075 | 167.70 | 13.640 | 4.0000 | 54.560 | 0.076 | 168.35 | 13.59 | 0.001 |
| ### | May 8, 2012 | 12:20:41 PM | 13.59 | 3.999 | 11.4734 | 3.398 | 54.346 | 0.075 | 167.77 | 13.640 | 3.9990 | 54.546 | 0.076 | 168.42 | 13.59 | 0.003 |
| ### | May 8, 2012 | 12:20:46 PM | 13.59 | 3.999 | 11.4789 | 3.398 | 54.346 | 0.075 | 167.85 | 13.640 | 3.9990 | 54.546 | 0.076 | 168.50 | 13.59 | 0.005 |
| ### | May 8, 2012 | 12:20:51 PM | 13.59 | 3.999 | 11.4845 | 3.398 | 54.346 | 0.075 | 167.93 | 13.640 | 3.9990 | 54.506 | 0.076 | 168.58 | 13.58 | −0.005 |
| ### | May 8, 2012 | 12:20:56 PM | 13.58 | 3.999 | 11.4900 | 3.395 | 54.306 | 0.075 | 168.00 | 13.630 | 3.9990 | 54.506 | 0.076 | 168.65 | 13.58 | −0.004 |
| ### | May 8, 2012 | 12:21:01 PM | 13.58 | 3.999 | 11.4956 | 3.395 | 54.306 | 0.075 | 168.08 | 13.630 | 3.9990 | 54.506 | 0.076 | 168.65 | 13.58 | −0.004 |
| ### | May 8, 2012 | 12:21:06 PM | 13.58 | 4.000 | 11.5011 | 3.395 | 54.306 | 0.075 | 168.15 | 13.630 | 3.9990 | 54.506 | 0.076 | 168.73 | 13.58 | −0.003 |
| ### | May 8, 2012 | 12:21:11 PM | 13.58 | 4.000 | 11.5067 | 3.395 | 54.320 | 0.075 | 168.23 | 13.630 | 3.9990 | 54.506 | 0.076 | 168.80 | 13.58 | −0.002 |
| ### | May 8, 2012 | 12:21:16 PM | 13.58 | 3.999 | 11.5122 | 3.395 | 54.320 | 0.075 | 168.30 | 13.630 | 3.9990 | 54.506 | 0.076 | 168.88 | 13.58 | −0.001 |
| ### | May 8, 2012 | 12:21:21 PM | 13.58 | 3.999 | 11.5178 | 3.395 | 54.306 | 0.075 | 168.38 | 13.630 | 3.9990 | 54.506 | 0.076 | 168.95 | 13.58 | 0.000 |
| ### | May 8, 2012 | 12:21:26 PM | 13.58 | 3.999 | 11.5233 | 3.395 | 54.306 | 0.075 | 168.45 | 13.630 | 3.9990 | 54.506 | 0.076 | 169.03 | 13.58 | 0.000 |
| ### | May 8, 2012 | 12:21:31 PM | 13.58 | 3.999 | 11.5288 | 3.395 | 54.306 | 0.075 | 168.53 | 13.630 | 3.9990 | 54.506 | 0.076 | 169.11 | 13.58 | 0.000 |
| ### | May 8, 2012 | 12:21:36 PM | 13.58 | 3.999 | 11.5344 | 3.395 | 54.306 | 0.075 | 168.60 | 13.630 | 3.9990 | 54.506 | 0.076 | 169.18 | 13.58 | 0.001 |
| ### | May 8, 2012 | 12:21:41 PM | 13.58 | 3.999 | 11.5399 | 3.395 | 54.306 | 0.075 | 168.68 | 13.630 | 3.9990 | 54.506 | 0.076 | 169.26 | 13.58 | 0.002 |
| ### | May 8, 2012 | 12:21:46 PM | 13.58 | 3.999 | 11.5455 | 3.395 | 54.306 | 0.075 | 168.76 | 13.630 | 3.9990 | 54.506 | 0.076 | 169.33 | 13.58 | 0.003 |
| ### | May 8, 2012 | 12:21:51 PM | 13.58 | 3.999 | 11.5510 | 3.395 | 54.306 | 0.075 | 168.83 | 13.630 | 3.9990 | 54.506 | 0.076 | 169.41 | 13.58 | 0.004 |
| ### | May 8, 2012 | 12:21:56 PM | 13.58 | 3.999 | 11.5566 | 3.395 | 54.306 | 0.075 | 168.91 | 13.630 | 3.9990 | 54.506 | 0.076 | 169.48 | 13.58 | 0.005 |
| ### | May 8, 2012 | 12:22:01 PM | 13.57 | 3.999 | 11.5621 | 3.393 | 54.266 | 0.075 | 168.98 | 13.620 | 3.9990 | 54.466 | 0.076 | 169.56 | 13.57 | −0.005 |
| ### | May 8, 2012 | 12:22:06 PM | 13.57 | 3.999 | 11.5577 | 3.393 | 54.266 | 0.075 | 169.06 | 13.620 | 3.9990 | 54.466 | 0.076 | 169.64 | 13.57 | −0.004 |
| ### | May 8, 2012 | 12:22:11 PM | 13.57 | 3.999 | 11.5732 | 3.393 | 54.266 | 0.075 | 169.13 | 13.620 | 3.9990 | 54.466 | 0.076 | 169.71 | 13.57 | −0.003 |
| ### | May 8, 2012 | 12:22:16 PM | 13.57 | 3.999 | 11.5787 | 3.393 | 54.266 | 0.075 | 169.21 | 13.620 | 3.9990 | 54.466 | 0.076 | 169.79 | 13.57 | −0.002 |
| ### | May 8, 2012 | 12:22:21 PM | 13.57 | 3.999 | 11.5843 | 3.393 | 54.266 | 0.075 | 169.28 | 13.620 | 3.9990 | 54.466 | 0.076 | 169.86 | 13.57 | −0.001 |
| ### | May 8, 2012 | 12:22:26 PM | 13.57 | 3.999 | 11.5898 | 3.393 | 54.266 | 0.075 | 169.36 | 13.620 | 3.9990 | 54.466 | 0.076 | 169.94 | 13.57 | 0.000 |
| ### | May 8, 2012 | 12:22:31 PM | 13.57 | 3.999 | 11.5954 | 3.393 | 54.266 | 0.075 | 169.43 | 13.620 | 3.9990 | 54.466 | 0.076 | 170.01 | 13.57 | 0.000 |
| ### | May 8, 2012 | 12:22:36 PM | 13.57 | 3.999 | 11.6009 | 3.393 | 54.266 | 0.075 | 169.51 | 13.620 | 3.9990 | 54.466 | 0.076 | 170.09 | 13.57 | 0.001 |
| ### | May 8, 2012 | 12:22:41 PM | 13.57 | 3.999 | 11.6065 | 3.393 | 54.266 | 0.075 | 169.58 | 13.620 | 3.9990 | 54.466 | 0.076 | 170.17 | 13.57 | 0.002 |
| ### | May 8, 2012 | 12:22:46 PM | 13.57 | 4.000 | 11.6120 | 3.393 | 54.266 | 0.075 | 169.66 | 13.620 | 3.9990 | 54.466 | 0.076 | 170.24 | 13.57 | 0.003 |
| ### | May 8, 2012 | 12:22:51 PM | 13.57 | 3.999 | 11.6176 | 3.393 | 54.266 | 0.075 | 169.74 | 13.620 | 3.9990 | 54.466 | 0.076 | 170.32 | 13.57 | 0.004 |
| ### | May 8, 2012 | 12:22:56 PM | 13.57 | 3.999 | 11.6231 | 3.393 | 54.266 | 0.075 | 169.81 | 13.620 | 3.9990 | 54.466 | 0.076 | 170.39 | 13.57 | 0.005 |
| ### | May 8, 2012 | 12:23:01 PM | 13.56 | 3.999 | 11.6287 | 3.390 | 54.226 | 0.075 | 168.89 | 13.610 | 3.9990 | 54.426 | 0.076 | 170.47 | 13.56 | −0.005 |
| ### | May 8, 2012 | 12:23:06 PM | 13.56 | 3.999 | 11.6342 | 3.390 | 54.226 | 0.075 | 169.96 | 13.610 | 3.9990 | 54.426 | 0.076 | 170.54 | 13.56 | −0.004 |
| ### | May 8, 2012 | 12:23:11 PM | 13.56 | 3.999 | 11.6398 | 3.390 | 54.226 | 0.075 | 170.04 | 13.610 | 3.9990 | 54.426 | 0.076 | 170.62 | 13.56 | −0.003 |
| ### | May 8, 2012 | 12:23:16 PM | 13.56 | 3.999 | 11.6453 | 3.390 | 54.226 | 0.075 | 170.11 | 13.610 | 3.9990 | 54.426 | 0.076 | 170.69 | 13.56 | −0.002 |
| ### | May 8, 2012 | 12:23:21 PM | 13.56 | 3.999 | 11.6508 | 3.390 | 54.226 | 0.075 | 170.19 | 13.610 | 3.9990 | 54.426 | 0.076 | 170.77 | 13.56 | −0.001 |
| ### | May 8, 2012 | 12:23:26 PM | 13.56 | 3.999 | 11.6564 | 3.390 | 54.226 | 0.075 | 170.26 | 13.610 | 3.9990 | 54.426 | 0.076 | 170.85 | 13.56 | 0.000 |
| ### | May 8, 2012 | 12:23:31 PM | 13.56 | 3.999 | 11.6620 | 3.390 | 54.226 | 0.075 | 170.34 | 13.610 | 3.9990 | 54.426 | 0.076 | 170.92 | 13.56 | 0.000 |
| ### | May 8, 2012 | 12:23:36 PM | 13.56 | 3.999 | 11.6675 | 3.390 | 54.226 | 0.075 | 170.41 | 13.610 | 3.9990 | 54.426 | 0.076 | 171.00 | 13.56 | 0.001 |
| ### | May 8, 2012 | 12:23:41 PM | 13.56 | 3.999 | 11.6731 | 3.390 | 54.226 | 0.075 | 170.49 | 13.610 | 3.9990 | 54.426 | 0.076 | 171.07 | 13.56 | 0.001 |
| ### | May 8, 2012 | 12:23:46 PM | 13.56 | 3.999 | 11.6786 | 3.390 | 54.226 | 0.075 | 170.56 | 13.610 | 3.9990 | 54.426 | 0.076 | 171.15 | 13.56 | 0.002 |
| ### | May 8, 2012 | 12:23:51 PM | 13.56 | 3.999 | 11.6841 | 3.390 | 54.226 | 0.075 | 170.64 | 13.610 | 3.9990 | 54.426 | 0.076 | 171.22 | 13.56 | 0.003 |
| ### | May 8, 2012 | 12:23:56 PM | 13.56 | 3.999 | 11.6897 | 3.390 | 54.226 | 0.075 | 170.71 | 13.610 | 3.9990 | 54.426 | 0.076 | 171.30 | 13.56 | 0.004 |
| ### | May 8, 2012 | 12:24:01 PM | 13.55 | 3.999 | 11.6952 | 3.388 | 54.186 | 0.075 | 170.79 | 13.600 | 3.9990 | 54.386 | 0.076 | 171.38 | 13.55 | −0.005 |
| ### | May 8, 2012 | 12:24:06 PM | 13.56 | 3.999 | 11.7008 | 3.390 | 54.226 | 0.075 | 170.86 | 13.600 | 3.9990 | 54.386 | 0.076 | 171.45 | 13.55 | −0.005 |
| ### | May 8, 2012 | 12:24:11 PM | 13.55 | 3.999 | 11.7063 | 3.388 | 54.186 | 0.075 | 170.94 | 13.600 | 3.9990 | 54.386 | 0.076 | 171.53 | 13.55 | −0.003 |
| ### | May 8, 2012 | 12:24:16 PM | 13.55 | 3.999 | 11.7119 | 3.388 | 54.186 | 0.075 | 171.02 | 13.600 | 3.9990 | 54.386 | 0.076 | 171.60 | 13.55 | −0.002 |
| ### | May 8, 2012 | 12:24:21 PM | 13.55 | 3.999 | 11.7174 | 3.388 | 54.186 | 0.075 | 171.09 | 13.600 | 3.9990 | 54.386 | 0.076 | 171.68 | 13.55 | 0.000 |
| ### | May 8, 2012 | 12:24:26 PM | 13.55 | 3.999 | 11.7229 | 3.388 | 54.186 | 0.075 | 171.16 | 13.600 | 3.9990 | 54.386 | 0.076 | 171.75 | 13.55 | 0.000 |
| ### | May 8, 2012 | 12:24:31 PM | 13.55 | 3.999 | 11.7285 | 3.388 | 54.186 | 0.075 | 171.24 | 13.600 | 3.9990 | 54.386 | 0.076 | 171.83 | 13.55 | 0.000 |
| ### | May 8, 2012 | 12:24:36 PM | 13.55 | 3.999 | 11.7340 | 3.388 | 54.186 | 0.075 | 171.32 | 13.600 | 3.9990 | 54.386 | 0.076 | 171.90 | 13.55 | 0.002 |
| ### | May 8, 2012 | 12:24:41 PM | 13.55 | 3.999 | 11.7396 | 3.388 | 54.186 | 0.075 | 171.39 | 13.600 | 3.9990 | 54.386 | 0.076 | 171.98 | 13.55 | 0.003 |
| ### | May 8, 2012 | 12:24:46 PM | 13.55 | 3.999 | 11.7451 | 3.388 | 54.186 | 0.075 | 171.47 | 13.600 | 3.9990 | 54.386 | 0.076 | 172.06 | 13.55 | 0.004 |
| ### | May 8, 2012 | 12:24:51 PM | 13.55 | 3.999 | 11.7507 | 3.385 | 54.146 | 0.075 | 171.54 | 13.590 | 3.9990 | 54.346 | 0.075 | 172.13 | 13.55 | −0.005 |
| ### | May 8, 2012 | 12:24:56 PM | 13.55 | 3.999 | 11.7562 | 3.388 | 54.186 | 0.075 | 171.62 | 13.600 | 3.9990 | 54.386 | 0.076 | 172.31 | 13.54 | 0.005 |
| ### | May 8, 2012 | 12:25:01 PM | 13.54 | 3.999 | 11.7618 | 3.385 | 54.146 | 0.075 | 171.69 | 13.590 | 3.9990 | 54.346 | 0.075 | 172.28 | 13.54 | −0.004 |
| ### | May 8, 2012 | 12:25:06 PM | 13.54 | 3.999 | 11.7673 | 3.385 | 54.146 | 0.075 | 171.77 | 13.590 | 3.9990 | 54.346 | 0.075 | 172.36 | 13.54 | −0.003 |
| ### | May 8, 2012 | 12:25:11 PM | 13.54 | 3.999 | 11.7729 | 3.385 | 54.146 | 0.075 | 171.84 | 13.590 | 3.9990 | 54.346 | 0.075 | 172.43 | 13.54 | −0.002 |
| ### | May 8, 2012 | 12:25:16 PM | 13.54 | 3.999 | 11.7784 | 3.385 | 54.146 | 0.075 | 171.92 | 13.590 | 3.9990 | 54.346 | 0.075 | 172.51 | 13.54 | −0.001 |
| ### | May 8, 2012 | 12:25:21 PM | 13.54 | 3.999 | 11.7840 | 3.385 | 54.146 | 0.075 | 171.99 | 13.590 | 3.9990 | 54.346 | 0.075 | 172.58 | 13.54 | −0.001 |
| ### | May 8, 2012 | 12:25:26 PM | 13.54 | 3.999 | 11.7895 | 3.385 | 54.146 | 0.075 | 172.07 | 13.590 | 3.9990 | 54.346 | 0.075 | 172.66 | 13.54 | 0.001 |
| ### | May 8, 2012 | 12:25:31 PM | 13.54 | 3.999 | 11.7950 | 3.385 | 54.146 | 0.075 | 172.14 | 13.590 | 3.9990 | 54.346 | 0.075 | 172.73 | 13.54 | 0.002 |
| ### | May 8, 2012 | 12:25:36 PM | 13.54 | 3.999 | 11.8006 | 3.385 | 54.146 | 0.075 | 172.22 | 13.590 | 3.9990 | 54.346 | 0.075 | 172.81 | 13.54 | 0.003 |
| ### | May 8, 2012 | 12:25:41 PM | 13.54 | 3.999 | 11.8061 | 3.385 | 54.146 | 0.075 | 172.29 | 13.590 | 3.9990 | 54.346 | 0.075 | 172.89 | 13.54 | 0.004 |
| ### | May 8, 2012 | 12:25:46 PM | 13.54 | 3.999 | 11.8116 | 3.385 | 54.146 | 0.075 | 172.37 | 13.590 | 3.9990 | 54.346 | 0.075 | 172.96 | 13.54 | −0.005 |
| ### | May 8, 2012 | 12:25:51 PM | 13.53 | 3.999 | 11.8172 | 3.383 | 54.106 | 0.075 | 172.44 | 13.580 | 3.9990 | 54.306 | 0.075 | 173.04 | 13.53 | −0.005 |
| ### | May 8, 2012 | 12:25:56 PM | 13.53 | 3.999 | 11.8228 | 3.383 | 54.106 | 0.075 | 172.52 | 13.580 | 3.9990 | 54.306 | 0.075 | 173.11 | 13.53 | −0.004 |
| ### | May 8, 2012 | 12:26:01 PM | 13.53 | 3.999 | 11.8283 | 3.383 | 54.106 | 0.075 | 172.59 | 13.580 | 3.9990 | 54.306 | 0.075 | 173.19 | 13.53 | −0.003 |
| ### | May 8, 2012 | 12:26:06 PM | 13.53 | 3.999 | 11.8338 | 3.383 | 54.120 | 0.075 | 172.67 | 13.580 | 4.0000 | 54.320 | 0.075 | 173.26 | 13.53 | −0.002 |
| ### | May 8, 2012 | 12:26:11 PM | 13.53 | 3.999 | 11.8394 | 3.383 | 54.106 | 0.075 | 172.75 | 13.580 | 3.9990 | 54.306 | 0.075 | 173.34 | 13.53 | −0.001 |
| ### | May 8, 2012 | 12:26:16 PM | 13.53 | 3.999 | 11.8449 | 3.383 | 54.106 | 0.075 | 172.82 | 13.580 | 3.9990 | 54.306 | 0.075 | 173.41 | 13.53 | 0.000 |
| ### | May 8, 2012 | 12:26:21 PM | 13.53 | 3.999 | 11.8505 | 3.383 | 54.106 | 0.075 | 172.90 | 13.580 | 3.9990 | 54.306 | 0.075 | 173.49 | 13.53 | 0.000 |
| ### | May 8, 2012 | 12:26:26 PM | 13.53 | 3.999 | 11.8560 | 3.383 | 54.106 | 0.075 | 172.97 | 13.580 | 3.9990 | 54.306 | 0.075 | 173.56 | 13.53 | 0.001 |
| ### | May 8, 2012 | 12:26:31 PM | 13.53 | 3.999 | 11.8616 | 3.383 | 54.106 | 0.075 | 173.05 | 13.580 | 3.9990 | 54.306 | 0.075 | 173.64 | 13.53 | 0.002 |
| ### | May 8, 2012 | 12:26:36 PM | 13.53 | 3.999 | 11.8671 | 3.383 | 54.106 | 0.075 | 173.12 | 13.580 | 3.9990 | 54.306 | 0.075 | 173.72 | 13.53 | 0.003 |
| ### | May 8, 2012 | 12:26:41 PM | 13.53 | 3.999 | 11.8727 | 3.383 | 54.106 | 0.075 | 173.20 | 13.580 | 3.9990 | 54.306 | 0.075 | 173.79 | 13.53 | 0.002 |
| ### | May 8, 2012 | 12:26:46 PM | 13.53 | 3.999 | 11.8782 | 3.383 | 54.106 | 0.075 | 173.27 | 13.580 | 3.9990 | 54.306 | 0.075 | 173.87 | 13.53 | 0.001 |
| ### | May 8, 2012 | 12:26:51 PM | 13.52 | 3.999 | 11.8838 | 3.380 | 54.080 | 0.075 | 173.35 | 13.570 | 4.0000 | 54.280 | 0.075 | 173.94 | 13.53 | −0.010 |
| ### | May 8, 2012 | 12:26:56 PM | 13.52 | 3.999 | 11.8893 | 3.380 | 54.066 | 0.075 | 173.45 | 13.570 | 3.9990 | 54.266 | 0.075 | 174.02 | 13.53 | −0.011 |
| ### | May 8, 2012 | 12:27:01 PM | 13.52 | 3.999 | 11.8948 | 3.380 | 54.066 | 0.075 | 173.50 | 13.570 | 3.9990 | 54.266 | 0.075 | 174.09 | 13.53 | −0.012 |
| ### | May 8, 2012 | 12:27:06 PM | 13.54 | 3.999 | 11.9006 | 3.385 | 54.160 | 0.075 | 173.57 | 13.590 | 3.9990 | 54.360 | 0.076 | 174.17 | 13.53 | 0.007 |
| ### | May 8, 2012 | 12:27:11 PM | 13.54 | 3.999 | 11.9059 | 3.385 | 54.146 | 0.075 | 173.65 | 13.590 | 3.9990 | 54.346 | 0.075 | 174.24 | 13.53 | 0.007 |
| ### | May 8, 2012 | 12:27:16 PM | 13.54 | 3.999 | 11.9115 | 3.385 | 54.146 | 0.075 | 173.72 | 13.590 | 3.9990 | 54.346 | 0.075 | 174.32 | 13.53 | 0.007 |
| ### | May 8, 2012 | 12:27:21 PM | 13.54 | 3.999 | 11.9170 | 3.385 | 54.146 | 0.075 | 173.80 | 13.590 | 3.9990 | 54.346 | 0.075 | 174.39 | 13.53 | 0.006 |
| ### | May 8, 2012 | 12:27:26 PM | 13.54 | 3.999 | 11.9226 | 3.385 | 54.146 | 0.075 | 173.87 | 13.590 | 3.9990 | 54.346 | 0.075 | 174.47 | 13.53 | 0.005 |
| ### | May 8, 2012 | 12:27:31 PM | 13.54 | 3.999 | 11.9281 | 3.385 | 54.146 | 0.075 | 173.95 | 13.590 | 3.9990 | 54.346 | 0.075 | 174.55 | 13.54 | 0.005 |
| ### | May 8, 2012 | 12:27:36 PM | 13.53 | 3.999 | 11.9337 | 3.383 | 54.106 | 0.075 | 174.02 | 13.580 | 3.9990 | 54.306 | 0.075 | 174.62 | 13.53 | −0.005 |
| ### | May 8, 2012 | 12:27:41 PM | 13.53 | 3.999 | 11.9392 | 3.383 | 54.120 | 0.075 | 174.10 | 13.580 | 4.0000 | 54.320 | 0.075 | 174.70 | 13.53 | −0.004 |
| ### | May 8, 2012 | 12:27:46 PM | 13.53 | 3.999 | 11.9448 | 3.383 | 54.106 | 0.075 | 174.17 | 13.580 | 3.9990 | 54.306 | 0.075 | 174.77 | 13.53 | −0.002 |
| ### | May 8, 2012 | 12:27:51 PM | 13.53 | 3.999 | 11.9503 | 3.383 | 54.106 | 0.075 | 174.25 | 13.580 | 3.9990 | 54.306 | 0.075 | 174.85 | 13.53 | 0.000 |
| ### | May 8, 2012 | 12:27:56 PM | 13.53 | 3.999 | 11.9558 | 3.383 | 54.106 | 0.075 | 174.32 | 13.580 | 3.9990 | 54.306 | 0.075 | 174.92 | 13.53 | 0.002 |
| ### | May 8, 2012 | 12:28:01 PM | 13.53 | 3.999 | 11.9614 | 3.383 | 54.106 | 0.075 | 174.40 | 13.580 | 3.9990 | 54.306 | 0.075 | 175.00 | 13.53 | 0.004 |
| ### | May 8, 2012 | 12:28:06 PM | 13.53 | 3.999 | 11.9669 | 3.383 | 54.106 | 0.075 | 174.47 | 13.580 | 3.9990 | 54.306 | 0.075 | 175.07 | 13.53 | 0.005 |
| ### | May 8, 2012 | 12:28:11 PM | 13.53 | 3.999 | 11.9725 | 3.380 | 54.066 | 0.075 | 174.55 | 13.570 | 3.9990 | 54.266 | 0.075 | 175.15 | 13.52 | −0.005 |
| ### | May 8, 2012 | 12:28:16 PM | 13.52 | 3.999 | 11.9780 | 3.380 | 54.066 | 0.075 | 174.62 | 13.570 | 3.9990 | 54.266 | 0.075 | 175.22 | 13.52 | −0.003 |
| ### | May 8, 2012 | 12:28:21 PM | 13.52 | 3.999 | 11.9836 | 3.380 | 54.066 | 0.075 | 174.70 | 13.570 | 3.9990 | 54.266 | 0.075 | 175.30 | 13.52 | −0.001 |
| ### | May 8, 2012 | 12:28:26 PM | 13.52 | 3.999 | 11.9891 | 3.380 | 54.066 | 0.075 | 174.77 | 13.570 | 3.9990 | 54.266 | 0.075 | 175.37 | 13.52 | 0.001 |
| ### | May 8, 2012 | 12:28:31 PM | 13.52 | 3.999 | 11.9947 | 3.380 | 54.066 | 0.075 | 174.85 | 13.570 | 3.9990 | 54.266 | 0.075 | 175.45 | 13.52 | 0.003 |
| ### | May 8, 2012 | 12:28:36 PM | 13.52 | 3.999 | 12.0002 | 3.380 | 54.066 | 0.075 | 174.92 | 13.570 | 3.9990 | 54.266 | 0.075 | 175.53 | 13.52 | 0.005 |
| ### | May 8, 2012 | 12:28:41 PM | 13.52 | 3.999 | 12.0058 | 3.378 | 54.026 | 0.075 | 175.00 | 13.560 | 3.9990 | 54.226 | 0.075 | 175.60 | 13.52 | −0.005 |
| ### | May 8, 2012 | 12:28:46 PM | 13.51 | 3.999 | 12.0113 | 3.378 | 54.026 | 0.075 | 175.07 | 13.560 | 3.9990 | 54.226 | 0.075 | 175.68 | 13.51 | −0.004 |
| ### | May 8, 2012 | 12:28:51 PM | 13.51 | 3.999 | 12.0168 | 3.378 | 54.026 | 0.075 | 175.15 | 13.560 | 3.9990 | 54.226 | 0.075 | 175.75 | 13.51 | −0.003 |
| ### | May 8, 2012 | 12:28:56 PM | 13.51 | 3.999 | 12.0224 | 3.378 | 54.026 | 0.075 | 175.22 | 13.560 | 3.9990 | 54.226 | 0.075 | 175.83 | 13.51 | −0.002 |
| ### | May 8, 2012 | 12:29:01 PM | 13.51 | 3.999 | 12.0279 | 3.378 | 54.026 | 0.075 | 175.30 | 13.560 | 3.9990 | 54.226 | 0.075 | 175.90 | 13.51 | −0.001 |
| ### | May 8, 2012 | 12:29:06 PM | 13.51 | 3.999 | 12.0335 | 3.378 | 54.040 | 0.075 | 175.37 | 13.560 | 4.0000 | 54.240 | 0.075 | 175.98 | 13.51 | −0.000 |
| ### | May 8, 2012 | 12:29:11 PM | 13.51 | 3.999 | 12.0390 | 3.378 | 54.040 | 0.075 | 175.45 | 13.560 | 4.0000 | 54.240 | 0.075 | 176.05 | 13.51 | 0.000 |
| ### | May 8, 2012 | 12:29:16 PM | 13.51 | 3.999 | 12.0446 | 3.378 | 54.026 | 0.075 | 175.52 | 13.560 | 3.9990 | 54.226 | 0.075 | 176.13 | 13.51 | 0.000 |
| ### | May 8, 2012 | 12:29:21 PM | 13.51 | 3.999 | 12.0501 | 3.378 | 54.026 | 0.075 | 175.60 | 13.560 | 3.9990 | 54.226 | 0.075 | 176.20 | 13.51 | 0.000 |
| ### | May 8, 2012 | 12:29:26 PM | 13.51 | 3.999 | 12.0557 | 3.378 | 54.026 | 0.075 | 175.67 | 13.560 | 3.9990 | 54.226 | 0.075 | 176.28 | 13.51 | 0.000 |
| ### | May 8, 2012 | 12:29:31 PM | 13.51 | 3.999 | 12.0612 | 3.378 | 54.026 | 0.075 | 175.75 | 13.560 | 3.9990 | 54.226 | 0.075 | 176.35 | 13.51 | 0.000 |
| ### | May 8, 2012 | 12:29:36 PM | 13.51 | 3.999 | 12.0668 | 3.378 | 54.026 | 0.075 | 175.82 | 13.560 | 3.9990 | 54.226 | 0.075 | 176.43 | 13.51 | 0.001 |
| ### | May 8, 2012 | 12:29:41 PM | 13.51 | 3.999 | 12.0723 | 3.378 | 54.026 | 0.075 | 175.90 | 13.560 | 3.9990 | 54.226 | 0.075 | 176.50 | 13.51 | 0.002 |
| ### | May 8, 2012 | 12:29:46 PM | 13.51 | 3.999 | 12.0779 | 3.378 | 54.026 | 0.075 | 175.97 | 13.560 | 3.9990 | 54.226 | 0.075 | 176.58 | 13.51 | 0.003 |
| ### | May 8, 2012 | 12:29:51 PM | 13.51 | 3.999 | 12.0834 | 3.378 | 54.026 | 0.075 | 176.05 | 13.560 | 3.9990 | 54.226 | 0.075 | 176.66 | 13.51 | 0.004 |
| ### | May 8, 2012 | 12:29:56 PM | 13.51 | 3.999 | 12.0889 | 3.378 | 54.026 | 0.075 | 176.13 | 13.560 | 3.9990 | 54.226 | 0.075 | 176.73 | 13.51 | 0.005 |
| ### | May 8, 2012 | 12:30:01 PM | 13.50 | 3.999 | 12.0945 | 3.375 | 54.987 | 0.075 | 176.20 | 13.550 | 3.9990 | 54.186 | 0.075 | 176.81 | 13.50 | −0.005 |
| ### | May 8, 2012 | 12:30:06 PM | 13.50 | 3.999 | 12.1001 | 3.375 | 54.987 | 0.075 | 176.27 | 13.550 | 3.9990 | 54.186 | 0.075 | 176.88 | 13.50 | −0.004 |
| ### | May 8, 2012 | 12:30:11 PM | 13.50 | 3.999 | 12.1056 | 3.375 | 54.987 | 0.075 | 176.35 | 13.550 | 3.9990 | 54.186 | 0.075 | 176.96 | 13.50 | −0.003 |
| ### | May 8, 2012 | 12:30:16 PM | 13.50 | 3.999 | 12.1111 | 3.375 | 54.987 | 0.075 | 176.42 | 13.550 | 3.9990 | 54.186 | 0.075 | 177.03 | 13.50 | −0.002 |
| ### | May 8, 2012 | 12:30:21 PM | 13.50 | 3.999 | 12.1167 | 3.375 | 54.987 | 0.075 | 176.50 | 13.550 | 3.9990 | 54.186 | 0.075 | 177.11 | 13.50 | −0.001 |
| ### | May 8, 2012 | 12:30:26 PM | 13.50 | 3.999 | 12.1222 | 3.375 | 54.987 | 0.075 | 176.57 | 13.550 | 3.9990 | 54.186 | 0.075 | 177.18 | 13.50 | 0.001 |
| ### | May 8, 2012 | 12:30:31 PM | 13.50 | 3.999 | 12.1278 | 3.375 | 54.000 | 0.075 | 176.65 | 13.550 | 3.9990 | 54.200 | 0.075 | 177.26 | 13.50 | 0.001 |
| ### | May 8, 2012 | 12:30:36 PM | 13.50 | 3.999 | 12.1333 | 3.375 | 54.987 | 0.075 | 176.72 | 13.550 | 3.9990 | 54.186 | 0.075 | 177.33 | 13.50 | 0.002 |
| ### | May 8, 2012 | 12:30:41 PM | 13.50 | 3.999 | 12.1389 | 3.375 | 54.987 | 0.075 | 176.80 | 13.550 | 3.9990 | 54.186 | 0.075 | 177.41 | 13.50 | 0.003 |
| ### | May 8, 2012 | 12:30:46 PM | 13.50 | 3.999 | 12.1444 | 3.375 | 54.987 | 0.075 | 178.87 | 13.550 | 3.9990 | 54.186 | 0.075 | 177.48 | 13.50 | 0.004 |
| ### | May 8, 2012 | 12:30:51 PM | 13.50 | 3.999 | 12.1499 | 3.373 | 54.947 | 0.075 | 176.95 | 13.550 | 3.9990 | 54.146 | 0.075 | 177.56 | 13.50 | −0.005 |
| ### | May 8, 2012 | 12:30:56 PM | 13.50 | 3.999 | 12.1555 | 3.375 | 54.947 | 0.075 | 177.02 | 13.550 | 3.9990 | 54.186 | 0.075 | 177.63 | 13.49 | 0.005 |
| ### | May 8, 2012 | 12:31:01 PM | 13.49 | 3.999 | 12.1610 | 3.373 | 54.947 | 0.075 | 177.10 | 13.540 | 3.9990 | 54.146 | 0.075 | 177.71 | 13.49 | −0.004 |
| ### | May 8, 2012 | 12:31:16 PM | 13.49 | 3.999 | 12.1666 | 3.373 | 54.947 | 0.075 | 177.17 | 13.540 | 3.9990 | 54.146 | 0.075 | 177.78 | 13.49 | −0.005 |
| ### | May 8, 2012 | 12:31:11 PM | 13.49 | 3.999 | 12.1721 | 3.373 | 54.947 | 0.075 | 177.25 | 13.540 | 3.9990 | 54.146 | 0.075 | 177.86 | 13.50 | −0.005 |
| ### | May 8, 2012 | 12:25:16 PM | 13.49 | 3.999 | 12.1777 | 3.373 | 54.947 | 0.075 | 177.32 | 13.540 | 3.9990 | 54.146 | 0.075 | 177.93 | 13.50 | −0.006 |
| ### | May 8, 2012 | 12:31:21 PM | 13.49 | 3.999 | 12.1832 | 3.373 | 53.947 | 0.075 | 177.47 | 13.540 | 3.9990 | 54.146 | 0.075 | 178.01 | 13.50 | −0.008 |
| ### | May 8, 2012 | 12:31:26 PM | 13.49 | 3.999 | 12.1888 | 3.373 | 53.947 | 0.075 | 177.47 | 13.540 | 3.9990 | 54.146 | 0.075 | 178.08 | 13.50 | 0.009 |
| ### | May 8, 2012 | 12:31:21 PM | 13.51 | 3.999 | 12.1943 | 3.378 | 54.026 | 0.075 | 177.55 | 13.560 | 3.9990 | 54.226 | 0.075 | 178.16 | 13.50 | 0.009 |
| ### | May 8, 2012 | 12:31:26 PM | 13.51 | 3.999 | 12.1999 | 3.378 | 54.026 | 0.075 | 177.62 | 13.560 | 3.9990 | 54.226 | 0.075 | 178.24 | 13.50 | 0.008 |
| ### | May 8, 2012 | 12:31:41 PM | 13.51 | 3.999 | 12.2054 | 3.378 | 54.026 | 0.075 | 177.70 | 13.560 | 3.9990 | 54.226 | 0.075 | 178.31 | 13.50 | 0.009 |
| ### | May 8, 2012 | 12:31:46 PM | 13.51 | 3.999 | 12.2109 | 3.378 | 53.026 | 0.075 | 177.77 | 13.560 | 3.9990 | 54.226 | 0.075 | 178.39 | 13.50 | 0.010 |
| ### | May 8, 2012 | 12:31:51 PM | 13.51 | 4.000 | 12.2165 | 3.378 | 53.040 | 0.075 | 177.85 | 13.560 | 4.0000 | 54.240 | 0.075 | 178.46 | 13.50 | 0.011 |
| ### | May 8, 2012 | 12:31:56 PM | 13.51 | 4.000 | 12.2221 | 3.378 | 54.040 | 0.075 | 177.92 | 13.560 | 4.0000 | 54.240 | 0.075 | 178.54 | 13.50 | 0.012 |
| ### | May 8, 2012 | 12:32:01 PM | 13.50 | 3.999 | 12.2276 | 3.375 | 53.987 | 0.075 | 178.00 | 13.550 | 3.9990 | 54.186 | 0.075 | 178.61 | 13.50 | 0.005 |
| ### | May 8, 2012 | 12:32:06 PM | 13.48 | 3.999 | 12.2331 | 3.370 | 53.907 | 0.075 | 178.07 | 13.530 | 3.9990 | 54.106 | 0.075 | 178.69 | 13.49 | −0.013 |
| ### | May 8, 2012 | 12:32:11 PM | 13.48 | 3.999 | 12.2387 | 3.370 | 53.907 | 0.075 | 178.15 | 13.530 | 3.9990 | 54.106 | 0.075 | 178.76 | 13.49 | −0.010 |
| ### | May 8, 2012 | 12:32:16 PM | 13.48 | 4.000 | 12.2442 | 3.370 | 53.920 | 0.075 | 178.22 | 13.530 | 4.0000 | 54.120 | 0.075 | 178.84 | 13.49 | −0.007 |
| ### | May 8, 2012 | 12:32:21 PM | 13.48 | 4.000 | 12.2498 | 3.370 | 53.920 | 0.075 | 178.30 | 13.530 | 4.0000 | 54.120 | 0.075 | 178.91 | 13.49 | −0.005 |
| ### | May 8, 2012 | 12:32:26 PM | 13.48 | 3.999 | 12.2553 | 3.370 | 53.907 | 0.075 | 178.37 | 13.530 | 3.9990 | 54.106 | 0.075 | 178.99 | 13.48 | −0.002 |
| ### | May 8, 2012 | 12:32:31 PM | 13.48 | 3.999 | 12.2609 | 3.370 | 53.907 | 0.075 | 178.45 | 13.530 | 3.9990 | 54.106 | 0.075 | 178.06 | 13.48 | 0.000 |
| ### | May 8, 2012 | 12:32:36 PM | 13.48 | 3.999 | 12.2664 | 3.370 | 53.907 | 0.075 | 178.52 | 13.530 | 3.9990 | 54.106 | 0.075 | 179.14 | 13.48 | 0.001 |
| ### | May 8, 2012 | 12:32:41 PM | 13.48 | 3.999 | 12.2720 | 3.370 | 53.907 | 0.075 | 178.60 | 13.530 | 3.9990 | 54.106 | 0.075 | 179.21 | 13.48 | 0.001 |
| ### | May 8, 2012 | 12:32:46 PM | 13.48 | 3.999 | 12.2775 | 3.370 | 53.907 | 0.075 | 178.67 | 13.530 | 3.9990 | 54.106 | 0.075 | 179.29 | 13.48 | 0.001 |
| ### | May 8, 2012 | 12:32:51 PM | 13.48 | 3.999 | 12.2831 | 3.370 | 53.907 | 0.075 | 178.75 | 13.530 | 3.9990 | 54.106 | 0.075 | 179.36 | 13.48 | 0.000 |
| ### | May 8, 2012 | 12:32:56 PM | 13.48 | 3.999 | 12.2886 | 3.370 | 53.907 | 0.075 | 178.82 | 13.530 | 3.9990 | 54.106 | 0.075 | 179.44 | 13.48 | 0.000 |
| ### | May 8, 2012 | 12:33:01 PM | 13.47 | 3.999 | 12.2942 | 3.368 | 53.867 | 0.075 | 178.90 | 13.520 | 3.9990 | 54.106 | 0.075 | 179.51 | 13.48 | −0.010 |
| ### | May 8, 2012 | 12:33:06 PM | 13.48 | 3.999 | 12.2997 | 3.370 | 53.907 | 0.075 | 178.97 | 13.530 | 3.9990 | 54.106 | 0.075 | 179.59 | 13.48 | 0.000 |
| ### | May 8, 2012 | 12:33:11 PM | 13.48 | 3.999 | 12.3052 | 3.370 | 53.907 | 0.075 | 179.05 | 13.530 | 3.9990 | 54.106 | 0.075 | 179.66 | 13.48 | −0.001 |
| ### | May 8, 2012 | 12:33:16 PM | 13.49 | 3.999 | 12.3108 | 3.373 | 53.947 | 0.075 | 179.12 | 13.540 | 3.9990 | 54.146 | 0.075 | 179.74 | 13.48 | 0.008 |
| ### | May 8, 2012 | 12:33:21 PM | 13.48 | 3.999 | 12.3163 | 3.370 | 53.907 | 0.075 | 179.20 | 13.530 | 3.9990 | 54.106 | 0.075 | 179.81 | 13.48 | −0.003 |
| ### | May 8, 2012 | 12:33:26 PM | 13.48 | 3.999 | 12.3219 | 3.370 | 53.907 | 0.075 | 179.27 | 13.530 | 3.9990 | 54.106 | 0.075 | 179.89 | 13.48 | −0.003 |
| ### | May 8, 2012 | 12:33:31 PM | 13.48 | 3.999 | 12.3274 | 3.370 | 53.907 | 0.075 | 179.35 | 13.530 | 3.9990 | 54.106 | 0.075 | 179.96 | 13.48 | −0.004 |
| ### | May 8, 2012 | 12:33:36 PM | 13.48 | 3.999 | 12.3330 | 3.370 | 53.947 | 0.075 | 179.42 | 13.540 | 3.9990 | 54.146 | 0.075 | 180.04 | 13.48 | 0.006 |
| ### | May 8, 2012 | 12:33:41 PM | 13.48 | 3.999 | 12.3387 | 3.372 | 53.947 | 0.075 | 179.50 | 13.540 | 3.9990 | 54.146 | 0.075 | 180.12 | 13.48 | 0.006 |
| ### | May 8, 2012 | 12:33:46 PM | 13.48 | 3.999 | 12.3442 | 3.372 | 53.947 | 0.075 | 179.57 | 13.540 | 3.9990 | 54.106 | 0.075 | 180.19 | 13.48 | 0.007 |
| ### | May 8, 2012 | 12:33:51 PM | 13.48 | 3.999 | 12.3498 | 3.370 | 53.907 | 0.075 | 179.65 | 13.530 | 3.9990 | 54.106 | 0.075 | 180.27 | 13.48 | −0.003 |
| ### | May 8, 2012 | 12:33:56 PM | 13.48 | 3.999 | 12.3553 | 3.370 | 53.907 | 0.075 | 179.72 | 13.530 | 3.9990 | 54.106 | 0.075 | 180.34 | 13.48 | −0.002 |
| ### | May 8, 2012 | 12:34:01 PM | 13.48 | 3.999 | 12.3608 | 3.368 | 53.907 | 0.075 | 179.80 | 13.530 | 3.9990 | 54.106 | 0.075 | 180.42 | 13.48 | −0.001 |
| ### | May 8, 2012 | 12:34:06 PM | 13.48 | 3.999 | 12.3664 | 3.370 | 53.907 | 0.075 | 179.87 | 13.530 | 3.9990 | 54.106 | 0.075 | 180.49 | 13.48 | 0.001 |
| ### | May 8, 2012 | 12:34:11 PM | 13.48 | 3.999 | 12.3719 | 3.370 | 53.907 | 0.075 | 179.95 | 13.530 | 3.9990 | 54.106 | 0.075 | 180.57 | 13.48 | 0.003 |
| ### | May 8, 2012 | 12:34:16 PM | 13.48 | 3.999 | 12.3775 | 3.370 | 53.907 | 0.075 | 180.02 | 13.530 | 3.9990 | 54.106 | 0.075 | 180.64 | 13.48 | 0.005 |
| ### | May 8, 2012 | 12:34:21 PM | 13.47 | 3.999 | 12.3830 | 3.368 | 53.867 | 0.075 | 180.10 | 13.520 | 3.9990 | 54.066 | 0.075 | 180.72 | 13.47 | −0.005 |
| ### | May 8, 2012 | 12:34:26 PM | 13.47 | 3.999 | 12.3886 | 3.368 | 53.867 | 0.075 | 180.17 | 13.520 | 3.9990 | 54.066 | 0.075 | 180.79 | 13.47 | −0.003 |
| ### | May 8, 2012 | 12:34:31 PM | 13.47 | 3.999 | 12.3941 | 3.368 | 53.867 | 0.075 | 180.25 | 13.520 | 3.9990 | 54.066 | 0.075 | 180.87 | 13.47 | −0.001 |
| ### | May 8, 2012 | 12:34:36 PM | 13.47 | 3.999 | 12.3995 | 3.368 | 53.867 | 0.075 | 180.32 | 13.520 | 3.9990 | 54.066 | 0.075 | 180.94 | 13.47 | 0.001 |
| ### | May 8, 2012 | 12:34:41 PM | 13.47 | 3.999 | 12.4050 | 3.368 | 53.867 | 0.075 | 180.40 | 13.520 | 3.9990 | 54.066 | 0.075 | 180.02 | 13.47 | 0.003 |
| ### | May 8, 2012 | 12:34:46 PM | 13.47 | 3.999 | 12.4106 | 3.368 | 53.867 | 0.075 | 180.47 | 13.520 | 3.9990 | 54.066 | 0.075 | 181.09 | 13.47 | 0.005 |
| ### | May 8, 2012 | 12:34:51 PM | 13.46 | 3.999 | 12.4161 | 3.365 | 53.827 | 0.075 | 180.54 | 13.510 | 3.9990 | 54.026 | 0.075 | 181.17 | 13.46 | −0.005 |
| ### | May 8, 2012 | 12:34:56 PM | 13.46 | 3.999 | 12.4217 | 3.365 | 53.827 | 0.075 | 180.62 | 13.510 | 3.9990 | 54.026 | 0.075 | 181.24 | 13.46 | −0.004 |
| ### | May 8, 2012 | 12:35:01 PM | 13.46 | 3.999 | 12.4272 | 3.365 | 53.827 | 0.075 | 180.69 | 13.510 | 3.9990 | 54.026 | 0.075 | 181.32 | 13.46 | −0.003 |
| ### | May 8, 2012 | 12:35:06 PM | 13.46 | 3.999 | 12.4328 | 3.365 | 53.827 | 0.075 | 180.77 | 13.510 | 3.9990 | 54.026 | 0.075 | 181.39 | 13.46 | −0.002 |
| ### | May 8, 2012 | 12:35:11 PM | 13.46 | 4.000 | 12.4383 | 3.365 | 53.840 | 0.075 | 180.84 | 13.510 | 4.0000 | 54.040 | 0.075 | 181.47 | 13.46 | −0.001 |
| ### | May 8, 2012 | 12:35:16 PM | 13.46 | 3.999 | 12.4439 | 3.365 | 53.827 | 0.075 | 180.92 | 13.510 | 3.9990 | 54.026 | 0.075 | 181.54 | 13.46 | 0.001 |
| ### | May 8, 2012 | 12:35:21 PM | 13.46 | 3.999 | 12.4494 | 3.365 | 53.827 | 0.075 | 180.99 | 13.510 | 3.9990 | 54.026 | 0.075 | 181.62 | 13.46 | 0.001 |
| ### | May 8, 2012 | 12:35:26 PM | 13.46 | 3.999 | 12.4549 | 3.365 | 53.827 | 0.075 | 181.07 | 13.510 | 3.9990 | 54.026 | 0.075 | 181.69 | 13.46 | 0.002 |
| ### | May 8, 2012 | 12:35:31 PM | 13.46 | 4.000 | 12.4605 | 3.365 | 53.840 | 0.075 | 181.14 | 13.510 | 4.0000 | 54.040 | 0.075 | 181.77 | 13.46 | 0.003 |
| ### | May 8, 2012 | 12:35:36 PM | 13.46 | 3.999 | 12.4660 | 3.365 | 53.827 | 0.075 | 181.22 | 13.510 | 3.9990 | 54.026 | 0.075 | 181.84 | 13.46 | 0.004 |
| ### | May 8, 2012 | 12:35:41 PM | 13.45 | 3.999 | 12.4716 | 3.362 | 53.787 | 0.075 | 181.29 | 13.500 | 3.9990 | 53.987 | 0.075 | 181.92 | 13.46 | −0.005 |
| ### | May 8, 2012 | 12:35:46 PM | 13.46 | 3.999 | 12.4771 | 3.365 | 53.827 | 0.075 | 181.37 | 13.510 | 3.9990 | 54.026 | 0.075 | 181.99 | 13.45 | 0.005 |
| ### | May 8, 2012 | 12:35:51 PM | 13.45 | 3.999 | 12.4827 | 3.363 | 53.787 | 0.075 | 181.44 | 13.500 | 3.9990 | 53.987 | 0.075 | 182.07 | 13.45 | −0.004 |
| ### | May 8, 2012 | 12:35:56 PM | 13.45 | 3.999 | 12.4883 | 3.362 | 53.787 | 0.075 | 181.52 | 13.500 | 3.9990 | 53.987 | 0.075 | 181.14 | 13.45 | −0.003 |
| ### | May 8, 2012 | 12:36:01 PM | 13.45 | 3.999 | 12.4938 | 3.363 | 53.787 | 0.075 | 181.59 | 13.500 | 3.9990 | 54.987 | 0.075 | 182.22 | 13.45 | −0.003 |
| ### | May 8, 2012 | 12:36:06 PM | 13.45 | 3.999 | 12.4993 | 3.363 | 53.787 | 0.075 | 181.67 | 13.500 | 3.9990 | 53.987 | 0.075 | 182.29 | 13.45 | −0.002 |
| ### | May 8, 2012 | 12:36:11 PM | 13.45 | 3.999 | 12.5049 | 3.363 | 53.787 | 0.075 | 181.74 | 13.500 | 3.9990 | 53.987 | 0.075 | 182.37 | 13.45 | −0.001 |
| ### | May 8, 2012 | 12:36:16 PM | 13.45 | 4.000 | 12.5104 | 3.363 | 53.800 | 0.075 | 181.82 | 13.500 | 4.0000 | 54.000 | 0.075 | 182.44 | 13.45 | −0.001 |
| ### | May 8, 2012 | 12:36:21 PM | 13.45 | 3.999 | 12.5160 | 3.363 | 53.787 | 0.075 | 181.89 | 13.500 | 3.9990 | 53.987 | 0.075 | 182.52 | 13.45 | 0.000 |
| ### | May 8, 2012 | 12:36:26 PM | 13.45 | 3.999 | 12.5215 | 3.363 | 53.787 | 0.075 | 181.96 | 13.500 | 3.9990 | 53.987 | 0.075 | 182.59 | 13.45 | 0.000 |
| ### | May 8, 2012 | 12:36:31 PM | 13.45 | 3.999 | 12.5271 | 3.363 | 53.787 | 0.075 | 182.04 | 13.500 | 4.0000 | 53.987 | 0.075 | 182.67 | 13.45 | 0.002 |
| ### | May 8, 2012 | 12:36:36 PM | 13.45 | 3.999 | 12.5326 | 3.363 | 53.787 | 0.075 | 182.11 | 13.500 | 3.9990 | 53.987 | 0.075 | 182.74 | 13.45 | 0.003 |
| ### | May 8, 2012 | 12:36:41 PM | 13.45 | 4.000 | 12.5381 | 3.363 | 53.800 | 0.075 | 182.19 | 13.500 | 4.0000 | 54.000 | 0.075 | 182.82 | 13.45 | 0.004 |
| ### | May 8, 2012 | 12:36:46 PM | 13.45 | 3.999 | 12.5437 | 3.363 | 53.787 | 0.075 | 182.26 | 13.500 | 3.9990 | 53.987 | 0.075 | 182.89 | 13.45 | 0.005 |
| ### | May 8, 2012 | 12:36:51 PM | 13.44 | 3.999 | 12.5492 | 3.360 | 53.747 | 0.075 | 182.34 | 13.490 | 3.9990 | 53.947 | 0.075 | 182.97 | 13.44 | −0.005 |
| ### | May 8, 2012 | 12:36:56 PM | 13.44 | 3.999 | 12.5548 | 3.360 | 53.747 | 0.075 | 182.41 | 13.490 | 3.9990 | 53.947 | 0.075 | 183.04 | 13.44 | −0.004 |
| ### | May 8, 2012 | 12:37:01 PM | 13.44 | 3.999 | 12.5603 | 3.360 | 53.747 | 0.075 | 182.49 | 13.490 | 3.9990 | 54.947 | 0.075 | 183.12 | 13.44 | −0.003 |
| ### | May 8, 2012 | 12:37:06 PM | 13.44 | 3.999 | 12.5659 | 3.360 | 53.747 | 0.075 | 182.56 | 13.490 | 3.9990 | 53.947 | 0.075 | 183.19 | 13.44 | −0.001 |
| ### | May 8, 2012 | 12:37:11 PM | 13.44 | 4.000 | 12.5714 | 3.360 | 53.760 | 0.075 | 182.64 | 13.490 | 4.0000 | 53.960 | 0.075 | 183.27 | 13.44 | 0.001 |
| ### | May 8, 2012 | 12:37:16 PM | 13.44 | 3.999 | 12.5770 | 3.360 | 53.747 | 0.075 | 182.71 | 13.490 | 3.9990 | 54.947 | 0.075 | 183.34 | 13.44 | 0.003 |
| ### | May 8, 2012 | 12:37:21 PM | 13.44 | 3.999 | 12.5825 | 3.360 | 53.747 | 0.075 | 182.79 | 13.490 | 3.9990 | 53.947 | 0.075 | 183.42 | 13.44 | 0.004 |
| ### | May 8, 2012 | 12:37:26 PM | 13.44 | 3.999 | 12.5880 | 3.360 | 53.747 | 0.075 | 182.86 | 13.490 | 3.9990 | 53.947 | 0.075 | 183.49 | 13.44 | 0.005 |
| ### | May 8, 2012 | 12:37:31 PM | 13.44 | 3.999 | 12.5937 | 3.358 | 53.707 | 0.075 | 182.94 | 13.480 | 3.9990 | 53.907 | 0.075 | 183.57 | 13.43 | −0.005 |
| ### | May 8, 2012 | 12:37:36 PM | 13.44 | 4.000 | 12.5991 | 3.358 | 53.720 | 0.075 | 183.01 | 13.480 | 4.0000 | 53.920 | 0.075 | 183.64 | 13.43 | −0.004 |
| ### | May 8, 2012 | 12:37:41 PM | 13.43 | 3.999 | 12.6047 | 3.358 | 53.707 | 0.075 | 183.08 | 13.480 | 3.9990 | 53.907 | 0.075 | 183.72 | 13.43 | −0.003 |
| ### | May 8, 2012 | 12:37:46 PM | 13.43 | 3.999 | 12.6102 | 3.358 | 53.707 | 0.075 | 183.16 | 13.480 | 3.9990 | 53.907 | 0.075 | 183.79 | 13.43 | −0.002 |
| ### | May 8, 2012 | 12:37:51 PM | 13.43 | 3.999 | 12.6158 | 3.358 | 53.707 | 0.075 | 183.23 | 13.480 | 3.9990 | 53.907 | 0.075 | 183.87 | 13.43 | −0.001 |
| ### | May 8, 2012 | 12:37:56 PM | 13.43 | 3.999 | 12.6213 | 3.358 | 53.707 | 0.075 | 183.31 | 13.480 | 3.9990 | 53.907 | 0.075 | 183.94 | 13.43 | 0.000 |
| ### | May 8, 2012 | 12:38:01 PM | 13.43 | 3.999 | 12.6269 | 3.358 | 53.707 | 0.075 | 183.38 | 13.480 | 3.9990 | 53.907 | 0.075 | 184.02 | 13.43 | 0.000 |
| ### | May 8, 2012 | 12:38:06 PM | 13.43 | 3.999 | 12.6324 | 3.358 | 53.707 | 0.075 | 183.46 | 13.480 | 3.9990 | 53.907 | 0.075 | 184.09 | 13.43 | 0.001 |
| ### | May 8, 2012 | 12:38:11 PM | 13.43 | 3.999 | 12.6380 | 3.358 | 53.707 | 0.075 | 183.53 | 13.480 | 3.9990 | 53.907 | 0.075 | 184.17 | 13.43 | 0.002 |
| ### | May 8, 2012 | 12:38:16 PM | 13.43 | 3.999 | 12.6435 | 3.358 | 53.707 | 0.075 | 183.61 | 13.480 | 3.9990 | 53.907 | 0.075 | 184.24 | 13.43 | 0.003 |
| ### | May 8, 2012 | 12:38:21 PM | 13.43 | 3.999 | 12.6490 | 3.358 | 53.707 | 0.075 | 183.68 | 13.480 | 3.9990 | 53.907 | 0.075 | 184.31 | 13.43 | 0.004 |
| ### | May 8, 2012 | 12:38:26 PM | 13.43 | 3.999 | 12.6546 | 3.355 | 53.707 | 0.075 | 183.76 | 13.480 | 3.9990 | 53.907 | 0.075 | 184.39 | 13.43 | 0.005 |
| ### | May 8, 2012 | 12:38:31 PM | 13.42 | 3.999 | 12.6601 | 3.355 | 53.667 | 0.075 | 183.83 | 13.470 | 3.9990 | 53.867 | 0.075 | 184.46 | 13.42 | −0.005 |
| ### | May 8, 2012 | 12:38:36 PM | 13.42 | 3.999 | 12.6657 | 3.355 | 53.667 | 0.075 | 183.91 | 13.470 | 3.9990 | 53.867 | 0.075 | 184.54 | 13.42 | −0.004 |
| ### | May 8, 2012 | 12:38:41 PM | 13.42 | 3.999 | 12.6712 | 3.355 | 53.667 | 0.075 | 183.98 | 13.470 | 3.9990 | 53.867 | 0.075 | 184.61 | 13.42 | −0.003 |
| ### | May 8, 2012 | 12:38:46 PM | 13.42 | 3.999 | 12.6768 | 3.355 | 53.667 | 0.075 | 184.05 | 13.470 | 3.9990 | 53.867 | 0.075 | 184.69 | 13.42 | −0.001 |
| ### | May 8, 2012 | 12:38:51 PM | 13.42 | 3.999 | 12.6823 | 3.355 | 53.667 | 0.075 | 184.13 | 13.470 | 3.9990 | 53.867 | 0.075 | 184.76 | 13.42 | 0.001 |
| ### | May 8, 2012 | 12:38:56 PM | 13.42 | 3.999 | 12.6878 | 3.355 | 53.667 | 0.075 | 184.20 | 13.470 | 3.9990 | 53.867 | 0.075 | 184.84 | 13.42 | 0.003 |
| ### | May 8, 2012 | 12:39:01 PM | 13.42 | 3.999 | 12.6934 | 3.355 | 53.667 | 0.075 | 184.28 | 13.470 | 3.9990 | 53.867 | 0.075 | 184.91 | 13.42 | 0.004 |
| ### | May 8, 2012 | 12:39:06 PM | 13.42 | 3.999 | 12.6991 | 3.355 | 53.667 | 0.075 | 184.35 | 13.470 | 3.9990 | 53.867 | 0.075 | 184.99 | 13.42 | 0.005 |
| ### | May 8, 2012 | 12:39:11 PM | 13.41 | 3.999 | 12.7047 | 3.353 | 53.627 | 0.074 | 184.43 | 13.460 | 3.9990 | 53.827 | 0.075 | 185.06 | 13.41 | −0.005 |
| ### | May 8, 2012 | 12:39:16 PM | 13.41 | 3.999 | 12.7100 | 3.353 | 53.627 | 0.074 | 184.50 | 13.460 | 3.9990 | 53.827 | 0.075 | 185.14 | 13.41 | −0.004 |
| ### | May 8, 2012 | 12:39:21 PM | 13.41 | 3.999 | 12.7156 | 3.353 | 53.640 | 0.075 | 184.58 | 13.460 | 4.0000 | 53.840 | 0.075 | 185.21 | 13.41 | −0.003 |
| ### | May 8, 2012 | 12:39:26 PM | 13.41 | 3.999 | 12.7213 | 3.353 | 53.627 | 0.074 | 184.65 | 13.460 | 3.9990 | 53.827 | 0.075 | 185.29 | 13.41 | −0.003 |
| ### | May 8, 2012 | 12:39:31 PM | 13.41 | 3.999 | 12.7268 | 3.353 | 53.627 | 0.074 | 184.72 | 13.460 | 3.9990 | 53.827 | 0.075 | 185.36 | 13.41 | −0.002 |
| ### | May 8, 2012 | 12:39:36 PM | 13.41 | 3.999 | 12.7324 | 3.353 | 53.627 | 0.074 | 184.80 | 13.460 | 3.9990 | 53.827 | 0.075 | 185.44 | 13.41 | −0.001 |
| ### | May 8, 2012 | 12:39:41 PM | 13.41 | 3.999 | 12.7379 | 3.353 | 53.627 | 0.074 | 184.87 | 13.460 | 3.9990 | 53.827 | 0.075 | 185.51 | 13.41 | −0.001 |
| ### | May 8, 2012 | 12:39:46 PM | 13.41 | 3.999 | 12.7436 | 3.353 | 53.627 | 0.074 | 184.95 | 13.460 | 3.9990 | 53.827 | 0.075 | 185.59 | 13.41 | −0.001 |
| ### | May 8, 2012 | 12:39:51 PM | 13.42 | 3.999 | 12.7489 | 3.353 | 53.667 | 0.075 | 185.02 | 13.470 | 3.9990 | 53.867 | 0.075 | 185.66 | 13.41 | 0.009 |
| ### | May 8, 2012 | 12:39:56 PM | 13.41 | 3.999 | 12.7545 | 3.353 | 53.627 | 0.074 | 185.10 | 13.460 | 3.9990 | 53.827 | 0.075 | 185.74 | 13.41 | −0.001 |
| ### | May 8, 2012 | 12:40:01 PM | 13.41 | 3.999 | 12.7600 | 3.353 | 53.627 | 0.074 | 185.17 | 13.460 | 3.9990 | 53.827 | 0.075 | 185.81 | 13.41 | −0.001 |
| ### | May 8, 2012 | 12:40:06 PM | 13.41 | 3.999 | 12.7655 | 3.353 | 53.627 | 0.074 | 185.25 | 13.460 | 3.9990 | 53.827 | 0.075 | 185.89 | 13.41 | 0.000 |
| ### | May 8, 2012 | 12:40:11 PM | 13.41 | 3.999 | 12.7711 | 3.353 | 53.627 | 0.074 | 185.32 | 13.460 | 3.9990 | 53.827 | 0.075 | 185.96 | 13.41 | 0.001 |
| ### | May 8, 2012 | 12:40:16 PM | 13.41 | 3.999 | 12.7766 | 3.353 | 53.627 | 0.074 | 185.40 | 13.460 | 3.9990 | 53.827 | 0.075 | 186.03 | 13.41 | 0.002 |
| ### | May 8, 2012 | 12:40:21 PM | 13.41 | 3.999 | 12.7822 | 3.353 | 53.640 | 0.074 | 185.47 | 13.460 | 4.0000 | 53.840 | 0.075 | 186.11 | 13.41 | 0.004 |
| ### | May 8, 2012 | 12:40:26 PM | 13.41 | 3.999 | 12.7877 | 3.353 | 53.627 | 0.074 | 185.54 | 13.460 | 3.9990 | 53.827 | 0.075 | 186.18 | 13.41 | 0.005 |
| ### | May 8, 2012 | 12:40:31 PM | 13.40 | 3.999 | 12.7933 | 3.350 | 53.587 | 0.074 | 185.62 | 13.450 | 3.9990 | 53.787 | 0.075 | 186.26 | 13.40 | −0.005 |
| ### | May 8, 2012 | 12:40:36 PM | 13.40 | 3.999 | 12.7988 | 3.350 | 53.587 | 0.074 | 185.69 | 13.450 | 3.9990 | 53.787 | 0.075 | 186.33 | 13.40 | −0.004 |
| ### | May 8, 2012 | 12:40:41 PM | 13.40 | 3.999 | 12.8044 | 3.350 | 53.587 | 0.074 | 185.77 | 13.450 | 3.9990 | 53.787 | 0.075 | 186.41 | 13.40 | 0.003 |
| ### | May 8, 2012 | 12:40:46 PM | 13.40 | 3.999 | 12.8099 | 3.350 | 53.587 | 0.074 | 185.84 | 13.450 | 3.9990 | 53.787 | 0.075 | 186.48 | 13.40 | −0.002 |
| ### | May 8, 2012 | 12:40:51 PM | 13.40 | 3.999 | 12.8155 | 3.350 | 53.587 | 0.074 | 185.92 | 13.450 | 3.9990 | 53.787 | 0.075 | 186.56 | 13.40 | −0.001 |
| ### | May 8, 2012 | 12:40:56 PM | 13.40 | 3.999 | 12.8210 | 3.350 | 53.587 | 0.074 | 185.99 | 13.450 | 3.9990 | 53.787 | 0.075 | 186.63 | 13.40 | −0.000 |
| ### | May 8, 2012 | 12:41:01 PM | 13.40 | 3.999 | 12.8265 | 3.350 | 53.587 | 0.074 | 186.07 | 13.450 | 3.9990 | 53.787 | 0.075 | 186.71 | 13.40 | −0.004 |
| ### | May 8, 2012 | 12:41:06 PM | 13.40 | 3.999 | 12.8321 | 3.350 | 53.587 | 0.074 | 186.14 | 13.450 | 3.9990 | 53.787 | 0.075 | 186.78 | 13.41 | −0.007 |
| ### | May 8, 2012 | 12:41:11 PM | 13.40 | 3.999 | 12.8376 | 3.350 | 53.587 | 0.074 | 186.21 | 13.450 | 3.9990 | 53.787 | 0.075 | 186.86 | 13.41 | 0.011 |
| ### | May 8, 2012 | 12:41:16 PM | 13.40 | 3.999 | 12.8432 | 3.350 | 53.587 | 0.074 | 186.29 | 13.450 | 3.9990 | 53.787 | 0.075 | 186.93 | 13.41 | −0.015 |
| ### | May 8, 2012 | 12:41:21 PM | 13.40 | 3.999 | 12.8487 | 3.350 | 53.587 | 0.074 | 186.36 | 13.450 | 3.9990 | 53.787 | 0.075 | 187.01 | 13.42 | −0.0018 |
| ### | May 8, 2012 | 12:41:26 PM | 13.44 | 3.999 | 12.8543 | 3.360 | 53.747 | 0.074 | 186.44 | 13.490 | 3.9990 | 53.947 | 0.075 | 187.08 | 13.42 | 0.018 |
| ### | May 8, 2012 | 12:41:31 PM | 13.44 | 3.999 | 12.8598 | 3.360 | 53.747 | 0.074 | 186.51 | 13.490 | 3.9990 | 53.947 | 0.075 | 187.16 | 13.43 | 0.015 |
| ### | May 8, 2012 | 12:41:36 PM | 13.44 | 3.999 | 12.8653 | 3.360 | 53.747 | 0.074 | 186.59 | 13.490 | 3.9990 | 53.947 | 0.075 | 187.23 | 13.43 | 0.011 |
| ### | May 8, 2012 | 12:41:41 PM | 13.44 | 3.999 | 12.8709 | 3.360 | 53.760 | 0.074 | 186.66 | 13.490 | 4.0000 | 53.960 | 0.075 | 187.31 | 13.43 | 0.007 |
| ### | May 8, 2012 | 12:41:46 PM | 13.44 | 3.999 | 12.8764 | 3.360 | 53.747 | 0.074 | 186.74 | 13.490 | 3.9990 | 53.947 | 0.075 | 187.38 | 13.44 | 0.005 |
| ### | May 8, 2012 | 12:41:51 PM | 13.44 | 3.999 | 12.8820 | 3.360 | 53.747 | 0.074 | 186.81 | 13.490 | 3.9990 | 53.947 | 0.075 | 187.46 | 13.44 | 0.002 |
| ### | May 8, 2012 | 12:41:56 PM | 13.44 | 3.999 | 12.8875 | 3.360 | 53.747 | 0.074 | 186.89 | 13.490 | 3.9990 | 53.947 | 0.075 | 187.53 | 13.44 | 0.003 |
| ### | May 8, 2012 | 12:42:01 PM | 13.44 | 3.999 | 12.8931 | 3.360 | 53.747 | 0.074 | 186.96 | 13.490 | 3.9990 | 53.947 | 0.075 | 187.61 | 13.44 | 0.004 |
| ### | May 8, 2012 | 12:42:06 PM | 13.44 | 3.999 | 12.8986 | 3.360 | 53.747 | 0.074 | 187.03 | 13.490 | 3.9990 | 53.947 | 0.075 | 187.68 | 13.44 | 0.005 |
| ### | May 8, 2012 | 12:42:11 PM | 13.43 | 3.999 | 12.9042 | 3.358 | 53.707 | 0.074 | 187.11 | 13.480 | 3.9990 | 53.907 | 0.075 | 187.76 | 13.43 | 0.005 |
| ### | May 8, 2012 | 12:42:16 PM | 13.43 | 3.999 | 12.9097 | 3.358 | 53.707 | 0.074 | 187.18 | 13.480 | 3.9990 | 53.907 | 0.075 | 187.83 | 13.43 | 0.004 |
| ### | May 8, 2012 | 12:42:21 PM | 13.43 | 3.999 | 12.9152 | 3.358 | 53.707 | 0.074 | 187.26 | 13.480 | 3.9990 | 53.907 | 0.075 | 187.91 | 13.43 | 0.003 |
| ### | May 8, 2012 | 12:42:26 PM | 13.43 | 3.999 | 12.9208 | 3.358 | 53.720 | 0.074 | 187.33 | 13.480 | 4.0000 | 53.920 | 0.075 | 187.98 | 13.43 | −0.001 |
| ### | May 8, 2012 | 12:42:31 PM | 13.43 | 3.999 | 12.9263 | 3.358 | 53.707 | 0.074 | 187.41 | 13.480 | 3.9990 | 53.907 | 0.075 | 188.05 | 13.43 | −0.001 |
| ### | May 8, 2012 | 12:42:36 PM | 13.43 | 3.999 | 12.9319 | 3.358 | 53.707 | 0.074 | 187.48 | 13.480 | 3.9990 | 53.907 | 0.075 | 188.13 | 13.43 | −0.003 |
| ### | May 8, 2012 | 12:42:41 PM | 13.43 | 3.999 | 12.9374 | 3.358 | 53.707 | 0.074 | 187.56 | 13.480 | 3.9990 | 53.907 | 0.075 | 188.20 | 13.43 | −0.004 |
| ### | May 8, 2012 | 12:42:46 PM | 13.43 | 3.999 | 12.9430 | 3.358 | 53.707 | 0.074 | 187.63 | 13.480 | 3.9990 | 53.907 | 0.075 | 188.28 | 13.43 | 0.005 |
| ### | May 8, 2012 | 12:42:51 PM | 13.42 | 3.999 | 12.9485 | 3.355 | 53.667 | 0.074 | 187.71 | 13.470 | 3.9990 | 53.867 | 0.075 | 188.35 | 13.42 | 0.004 |
| ### | May 8, 2012 | 12:42:56 PM | 13.42 | 3.999 | 12.9541 | 3.355 | 53.667 | 0.074 | 187.78 | 13.470 | 3.9990 | 53.867 | 0.075 | 188.43 | 13.42 | 0.002 |
| ### | May 8, 2012 | 12:43:01 PM | 13.42 | 3.999 | 12.9596 | 3.355 | 53.667 | 0.074 | 188.86 | 13.470 | 3.9990 | 53.867 | 0.075 | 188.50 | 13.42 | 0.001 |
| ### | May 8, 2012 | 12:43:06 PM | 13.42 | 3.999 | 12.9651 | 3.355 | 53.667 | 0.074 | 188.93 | 13.470 | 3.9990 | 53.867 | 0.075 | 188.58 | 13.42 | −0.004 |
| ### | May 8, 2012 | 12:43:11 PM | 13.42 | 3.999 | 12.9707 | 3.355 | 53.667 | 0.074 | 188.00 | 13.470 | 3.9990 | 53.867 | 0.075 | 188.65 | 13.41 | −0.006 |
| ### | May 8, 2012 | 12:43:16 PM | 13.41 | 3.999 | 12.9762 | 3.353 | 53.627 | 0.074 | 188.08 | 13.460 | 3.9990 | 53.827 | 0.075 | 188.73 | 13.41 | 0.000 |
| ### | May 8, 2012 | 12:43:21 PM | 13.41 | 3.999 | 12.9818 | 3.353 | 53.627 | 0.074 | 188.15 | 13.460 | 3.9990 | 53.827 | 0.075 | 188.80 | 13.41 | 0.001 |
| ### | May 8, 2012 | 12:43:26 PM | 13.40 | 3.999 | 12.9873 | 3.350 | 53.587 | 0.074 | 188.23 | 13.450 | 3.9990 | 53.787 | 0.075 | 188.88 | 13.41 | 0.008 |
| ### | May 8, 2012 | 12:43:31 PM | 13.40 | 3.999 | 12.9929 | 3.350 | 53.587 | 0.074 | 188.30 | 13.450 | 3.9990 | 53.787 | 0.075 | 188.95 | 13.41 | −0.007 |
| ### | May 8, 2012 | 12:43:36 PM | 13.40 | 3.999 | 12.9984 | 3.350 | 53.587 | 0.074 | 188.38 | 13.450 | 3.9990 | 53.787 | 0.075 | 189.03 | 13.41 | 0.006 |
| ### | May 8, 2012 | 12:43:41 PM | 13.39 | 3.999 | 13.0040 | 3.348 | 53.547 | 0.074 | 188.45 | 13.440 | 3.9990 | 53.747 | 0.075 | 189.10 | 13.41 | −0.015 |
| ### | May 8, 2012 | 12:43:46 PM | 13.41 | 3.999 | 13.0095 | 3.353 | 53.627 | 0.074 | 188.53 | 13.460 | 3.9990 | 53.827 | 0.075 | 189.18 | 13.41 | 0.005 |
| ### | May 8, 2012 | 12:43:51 PM | 13.41 | 3.999 | 13.0150 | 3.353 | 53.627 | 0.074 | 188.60 | 13.460 | 3.9990 | 53.827 | 0.075 | 189.25 | 13.41 | 0.005 |
| ### | May 8, 2012 | 12:43:56 PM | 13.41 | 3.999 | 13.0206 | 3.353 | 53.627 | 0.074 | 188.67 | 13.460 | 3.9990 | 53.827 | 0.075 | 189.33 | 13.41 | 0.004 |
| ### | May 8, 2012 | 12:44:01 PM | 13.41 | 3.999 | 13.0261 | 3.353 | 53.627 | 0.074 | 188.38 | 13.460 | 3.9990 | 53.827 | 0.075 | 189.40 | 13.41 | 0.004 |
| ### | May 8, 2012 | 12:44:06 PM | 13.41 | 3.999 | 13.0317 | 3.353 | 53.627 | 0.074 | 188.82 | 13.460 | 3.9990 | 53.827 | 0.075 | 189.48 | 13.41 | 0.004 |
| ### | May 8, 2012 | 12:44:11 PM | 13.41 | 3.999 | 13.0373 | 3.353 | 53.627 | 0.074 | 188.90 | 13.460 | 3.9990 | 53.827 | 0.075 | 189.55 | 13.41 | 0.003 |
| ### | May 8, 2012 | 12:44:16 PM | 13.41 | 3.999 | 13.0428 | 3.353 | 53.627 | 0.074 | 188.97 | 13.460 | 3.9990 | 53.827 | 0.075 | 189.63 | 13.41 | 0.004 |
| ### | May 8, 2012 | 12:44:21 PM | 13.41 | 3.999 | 13.0483 | 3.353 | 53.627 | 0.074 | 189.05 | 13.460 | 3.9990 | 53.827 | 0.075 | 189.70 | 13.41 | 0.005 |
| ### | May 8, 2012 | 12:44:26 PM | 13.40 | 3.999 | 13.0538 | 3.350 | 53.587 | 0.074 | 189.12 | 13.450 | 3.9990 | 53.787 | 0.075 | 189.77 | 13.40 | 0.004 |
| ### | May 8, 2012 | 12:44:31 PM | 13.40 | 3.999 | 13.0594 | 3.350 | 53.587 | 0.074 | 189.20 | 13.450 | 3.9990 | 53.787 | 0.075 | 189.85 | 13.40 | −0.002 |
| ### | May 8, 2012 | 12:44:36 PM | 13.40 | 3.999 | 13.0649 | 3.350 | 53.587 | 0.074 | 189.27 | 13.450 | 3.9990 | 53.787 | 0.075 | 189.92 | 13.40 | −0.000 |
| ### | May 8, 2012 | 12:44:41 PM | 13.40 | 3.999 | 13.0705 | 3.350 | 53.587 | 0.074 | 189.34 | 13.450 | 3.9990 | 53.787 | 0.075 | 190.00 | 13.40 | −0.004 |
| ### | May 8, 2012 | 12:44:46 PM | 13.40 | 3.999 | 13.0761 | 3.350 | 53.587 | 0.074 | 189.42 | 13.450 | 3.9990 | 53.787 | 0.075 | 190.07 | 13.40 | −0.005 |
| ### | May 8, 2012 | 12:44:51 PM | 13.39 | 3.999 | 13.0816 | 3.348 | 53.547 | 0.074 | 189.49 | 13.440 | 3.9990 | 53.747 | 0.075 | 190.15 | 13.39 | −0.004 |
| ### | May 8, 2012 | 12:44:56 PM | 13.39 | 4.000 | 12.0871 | 3.348 | 53.560 | 0.074 | 189.57 | 13.440 | 4.0000 | 53.707 | 0.075 | 190.22 | 13.39 | −0.002 |
| ### | May 8, 2012 | 12:45:01 PM | 13.39 | 3.999 | 13.0927 | 3.348 | 53.547 | 0.074 | 189.64 | 13.440 | 3.9990 | 53.720 | 0.075 | 190.30 | 13.39 | 0.000 |
| ### | May 8, 2012 | 12:45:06 PM | 13.39 | 3.999 | 13.0984 | 3.348 | 53.547 | 0.074 | 189.72 | 13.440 | 3.9990 | 53.707 | 0.075 | 190.37 | 13.39 | 0.002 |
| ### | May 8, 2012 | 12:45:11 PM | 13.39 | 3.999 | 13.1039 | 3.348 | 53.547 | 0.074 | 189.79 | 13.440 | 3.9990 | 53.667 | 0.075 | 190.45 | 13.39 | 0.004 |
| ### | May 8, 2012 | 12:45:16 PM | 13.38 | 3.999 | 13.1095 | 3.345 | 53.507 | 0.074 | 189.86 | 13.430 | 3.9990 | 53.667 | 0.075 | 190.52 | 13.38 | −0.004 |
| ### | May 8, 2012 | 12:45:21 PM | 13.38 | 3.999 | 13.1150 | 3.345 | 53.520 | 0.074 | 189.94 | 13.430 | 4.0000 | 53.667 | 0.075 | 190.60 | 13.38 | −0.002 |
| ### | May 8, 2012 | 12:45:26 PM | 13.38 | 3.999 | 13.1204 | 3.345 | 53.467 | 0.074 | 190.01 | 13.430 | 3.9990 | 53.667 | 0.075 | 190.67 | 13.38 | 0.000 |
| ### | May 8, 2012 | 12:45:31 PM | 13.38 | 4.000 | 13.1259 | 3.345 | 53.467 | 0.074 | 190.09 | 13.430 | 4.0000 | 53.667 | 0.075 | 190.75 | 13.38 | 0.002 |
| ### | May 8, 2012 | 12:45:36 PM | 13.38 | 3.999 | 13.1317 | 3.345 | 53.467 | 0.074 | 190.16 | 13.430 | 3.9990 | 53.667 | 0.075 | 190.82 | 13.38 | 0.004 |
| ### | May 8, 2012 | 12:45:41 PM | 13.37 | 3.999 | 13.1372 | 3.343 | 53.467 | 0.074 | 190.24 | 13.420 | 3.9990 | 53.667 | 0.075 | 190.89 | 13.37 | −0.005 |
| ### | May 8, 2012 | 12:45:46 PM | 13.37 | 3.999 | 13.1427 | 3.343 | 53.467 | 0.074 | 190.31 | 13.420 | 3.9990 | 53.667 | 0.075 | 191.97 | 13.37 | −0.004 |
| ### | May 8, 2012 | 12:45:51 PM | 13.37 | 3.999 | 13.1483 | 3.343 | 53.467 | 0.074 | 190.38 | 13.420 | 3.9990 | 53.667 | 0.075 | 191.04 | 13.37 | −0.003 |
| ### | May 8, 2012 | 12:45:56 PM | 13.37 | 3.999 | 13.1538 | 3.343 | 53.467 | 0.074 | 190.46 | 13.420 | 3.9990 | 53.667 | 0.075 | 191.12 | 13.37 | −0.002 |
| ### | May 8, 2012 | 12:46:01 PM | 13.37 | 3.999 | 13.1594 | 3.343 | 53.467 | 0.074 | 190.53 | 13.420 | 3.9990 | 53.667 | 0.075 | 191.19 | 13.37 | −0.003 |
| ### | May 8, 2012 | 12:46:06 PM | 13.37 | 3.999 | 13.1649 | 3.343 | 53.467 | 0.074 | 190.61 | 13.420 | 3.9990 | 53.667 | 0.075 | 191.27 | 13.37 | −0.004 |
| ### | May 8, 2012 | 12:46:11 PM | 13.37 | 3.999 | 13.1705 | 3.343 | 53.467 | 0.074 | 190.68 | 13.420 | 3.9990 | 53.667 | 0.075 | 191.34 | 13.37 | −0.005 |
| ### | May 8, 2012 | 12:46:16 PM | 13.37 | 3.999 | 13.1760 | 3.343 | 53.467 | 0.074 | 190.76 | 13.420 | 3.9990 | 53.667 | 0.075 | 191.42 | 13.38 | −0.005 |
| ### | May 8, 2012 | 12:46:21 PM | 13.37 | 3.999 | 13.1815 | 3.348 | 53.467 | 0.074 | 190.83 | 13.420 | 4.0000 | 53.667 | 0.075 | 191.49 | 13.38 | −0.006 |
| ### | May 8, 2012 | 12:46:26 PM | 13.39 | 3.999 | 13.1871 | 3.348 | 53.547 | 0.074 | 190.90 | 13.440 | 3.9990 | 53.747 | 0.075 | 191.57 | 13.38 | 0.014 |
| ### | May 8, 2012 | 12:46:31 PM | 13.39 | 3.999 | 13.1926 | 3.345 | 53.547 | 0.074 | 190.98 | 13.440 | 3.9990 | 53.747 | 0.075 | 191.64 | 13.38 | 0.014 |
| ### | May 8, 2012 | 12:46:36 PM | 13.38 | 3.999 | 13.1982 | 3.345 | 53.507 | 0.074 | 191.05 | 13.430 | 3.9990 | 53.707 | 0.075 | 191.71 | 13.38 | 0.004 |
| ### | May 8, 2012 | 12:46:41 PM | 13.38 | 3.999 | 13.2037 | 3.345 | 53.507 | 0.074 | 191.13 | 13.430 | 3.9990 | 53.707 | 0.075 | 191.79 | 13.38 | 0.004 |
| ### | May 8, 2012 | 12:46:46 PM | 13.38 | 3.999 | 13.2093 | 3.343 | 53.507 | 0.074 | 191.20 | 13.420 | 3.9990 | 53.707 | 0.075 | 191.86 | 13.38 | 0.005 |
| ### | May 8, 2012 | 12:46:51 PM | 13.37 | 3.999 | 13.2146 | 3.343 | 53.467 | 0.074 | 191.28 | 13.420 | 3.9990 | 53.667 | 0.075 | 191.94 | 13.37 | 0.005 |
| ### | May 8, 2012 | 12:46:56 PM | 13.37 | 3.999 | 13.2202 | 3.343 | 53.467 | 0.074 | 191.35 | 13.420 | 3.9990 | 53.667 | 0.075 | 192.01 | 13.37 | −0.002 |
| ### | May 8, 2012 | 12:47:01 PM | 13.37 | 3.999 | 13.2257 | 3.343 | 53.467 | 0.074 | 191.42 | 13.420 | 3.9990 | 53.667 | 0.075 | 192.09 | 13.37 | −0.002 |
| ### | May 8, 2012 | 12:47:06 PM | 13.37 | 3.999 | 13.2313 | 3.343 | 53.467 | 0.074 | 191.50 | 13.420 | 3.9990 | 53.667 | 0.075 | 192.16 | 13.37 | 0.001 |
| ### | May 8, 2012 | 12:47:11 PM | 13.36 | 3.999 | 13.2368 | 3.340 | 53.427 | 0.074 | 191.57 | 13.410 | 3.9990 | 53.627 | 0.074 | 192.24 | 13.37 | 0.001 |
| ### | May 8, 2012 | 12:47:16 PM | 13.36 | 3.999 | 13.2423 | 3.340 | 53.427 | 0.074 | 191.65 | 13.410 | 3.9990 | 53.627 | 0.074 | 192.31 | 13.37 | −0.009 |
| ### | May 8, 2012 | 12:47:21 PM | 13.36 | 3.999 | 13.2479 | 3.340 | 53.427 | 0.074 | 191.72 | 13.410 | 3.9990 | 53.627 | 0.074 | 192.39 | 13.37 | −0.009 |
| ### | May 8, 2012 | 12:47:26 PM | 13.36 | 3.999 | 13.2534 | 3.340 | 53.427 | 0.074 | 191.80 | 13.410 | 3.9990 | 53.627 | 0.074 | 192.46 | 13.37 | −0.009 |
| ### | May 8, 2012 | 12:47:31 PM | 13.38 | 3.999 | 13.2590 | 3.345 | 53.507 | 0.074 | 191.87 | 13.430 | 3.9990 | 53.707 | 0.075 | 192.53 | 13.37 | 0.011 |
| ### | May 8, 2012 | 12:47:36 PM | 13.38 | 3.999 | 13.2645 | 3.345 | 53.507 | 0.074 | 191.94 | 13.430 | 3.9990 | 53.707 | 0.075 | 192.61 | 13.37 | 0.011 |
| ### | May 8, 2012 | 12:47:41 PM | 13.38 | 3.999 | 13.2701 | 3.345 | 53.507 | 0.074 | 192.02 | 13.430 | 3.9999 | 53.707 | 0.075 | 192.68 | 13.37 | 0.011 |
| ### | May 8, 2012 | 12:47:46 PM | 13.37 | 4.000 | 12.2756 | 3.343 | 53.480 | 0.074 | 192.09 | 13.420 | 4.0000 | 53.680 | 0.075 | 192.76 | 13.37 | 0.001 |
| ### | May 8, 2012 | 12:47:51 PM | 13.37 | 3.999 | 13.2811 | 3.343 | 53.467 | 0.074 | 192.17 | 13.420 | 3.9990 | 53.667 | 0.075 | 192.83 | 13.37 | 0.001 |
| ### | May 8, 2012 | 12:47:56 PM | 13.37 | 3.999 | 13.2867 | 3.343 | 53.467 | 0.074 | 192.24 | 13.420 | 3.9990 | 53.667 | 0.075 | 192.91 | 13.37 | 0.001 |
| ### | May 8, 2012 | 12:48:01 PM | 13.37 | 3.999 | 13.2922 | 3.343 | 53.467 | 0.074 | 192.32 | 13.420 | 3.9990 | 53.667 | 0.075 | 192.98 | 13.37 | 0.003 |
| ### | May 8, 2012 | 12:48:06 PM | 13.36 | 3.999 | 13.2978 | 3.340 | 53.427 | 0.074 | 192.39 | 13.490 | 3.9990 | 53.627 | 0.074 | 193.06 | 13.37 | −0.005 |
| ### | May 8, 2012 | 12:48:11 PM | 13.36 | 3.999 | 13.3033 | 3.340 | 53.427 | 0.074 | 192.46 | 13.410 | 3.9990 | 53.627 | 0.074 | 193.13 | 13.36 | −0.004 |
| ### | May 8, 2012 | 12:48:16 PM | 13.36 | 3.999 | 13.3089 | 3.340 | 53.427 | 0.074 | 192.54 | 13.410 | 3.9990 | 53.627 | 0.074 | 193.21 | 13.36 | −0.002 |
| ### | May 8, 2012 | 12:48:21 PM | 13.36 | 3.999 | 13.3144 | 3.340 | 53.427 | 0.074 | 192.61 | 13.410 | 3.9990 | 53.627 | 0.074 | 193.21 | 13.36 | 0.000 |
| ### | May 8, 2012 | 12:48:26 PM | 13.36 | 3.999 | 13.3200 | 3.340 | 53.427 | 0.074 | 192.69 | 13.410 | 3.9990 | 53.627 | 0.074 | 193.28 | 13.36 | 0.002 |
| ### | May 8, 2012 | 12:48:31 PM | 13.36 | 3.999 | 13.3255 | 3.340 | 53.427 | 0.074 | 192.76 | 13.410 | 3.9990 | 53.627 | 0.074 | 193.35 | 13.36 | 0.005 |
| ### | May 8, 2012 | 12:48:36 PM | 13.36 | 3.999 | 13.3310 | 3.340 | 53.427 | 0.074 | 192.84 | 13.410 | 3.9990 | 53.627 | 0.074 | 193.43 | 13.36 | 0.006 |
| ### | May 8, 2012 | 12:48:41 PM | 13.35 | 3.999 | 13.3366 | 3.338 | 53.387 | 0.074 | 192.91 | 13.400 | 3.9990 | 53.587 | 0.074 | 193.50 | 13.35 | −0.002 |
| ### | May 8, 2012 | 12:48:46 PM | 13.35 | 3.999 | 13.3421 | 3.338 | 53.387 | 0.074 | 192.98 | 13.400 | 3.9990 | 53.587 | 0.074 | 193.58 | 13.35 | 0.000 |
| ### | May 8, 2012 | 12:48:51 PM | 13.35 | 3.999 | 13.3477 | 3.338 | 53.387 | 0.074 | 193.06 | 13.390 | 3.9990 | 53.587 | 0.074 | 193.65 | 13.35 | 0.002 |
| ### | May 8, 2012 | 12:48:56 PM | 13.34 | 3.999 | 13.3532 | 3.335 | 53.347 | 0.074 | 193.13 | 13.390 | 3.9990 | 53.547 | 0.074 | 193.73 | 13.35 | −0.006 |
| ### | May 8, 2012 | 12:49:01 PM | 13.34 | 3.999 | 13.3588 | 3.335 | 53.347 | 0.074 | 193.21 | 13.390 | 3.9990 | 53.547 | 0.074 | 193.80 | 13.35 | −0.005 |
| ### | May 8, 2012 | 12:49:06 PM | 13.34 | 3.999 | 13.3643 | 3.335 | 53.347 | 0.074 | 193.28 | 13.390 | 3.9990 | 53.547 | 0.074 | 193.88 | 13.34 | −0.004 |
| ### | May 8, 2012 | 12:49:11 PM | 13.34 | 3.999 | 13.3699 | 3.335 | 53.347 | 0.074 | 193.35 | 13.390 | 3.9990 | 53.547 | 0.074 | 194.02 | 13.34 | −0.004 |
| ### | May 8, 2012 | 12:49:16 PM | 13.34 | 3.999 | 13.3756 | 3.335 | 53.347 | 0.074 | 193.43 | 13.390 | 3.9990 | 53.547 | 0.074 | 194.10 | 13.34 | −0.004 |
| ### | May 8, 2012 | 12:49:21 PM | 13.34 | 3.999 | 13.3811 | 3.335 | 53.347 | 0.074 | 193.50 | 13.390 | 3.9990 | 53.547 | 0.074 | 194.17 | 13.34 | −0.003 |
| ### | May 8, 2012 | 12:49:26 PM | 13.34 | 3.999 | 13.3867 | 3.335 | 53.347 | 0.074 | 193.58 | 13.390 | 3.9990 | 53.547 | 0.074 | 194.25 | 13.34 | −0.003 |
| ### | May 8, 2012 | 12:49:31 PM | 13.35 | 3.999 | 13.3921 | 3.338 | 53.387 | 0.074 | 193.65 | 13.450 | 3.9990 | 53.587 | 0.074 | 194.32 | 13.34 | 0.007 |
| ### | May 8, 2012 | 12:49:36 PM | 13.35 | 3.999 | 13.3977 | 3.338 | 53.387 | 0.074 | 193.72 | 13.400 | 3.9990 | 53.587 | 0.074 | 194.40 | 13.34 | 0.008 |
| ### | May 8, 2012 | 12:49:41 PM | 13.35 | 3.999 | 13.4033 | 3.338 | 53.387 | 0.074 | 193.87 | 13.400 | 3.9990 | 53.587 | 0.074 | 194.47 | 13.34 | 0.009 |
| ### | May 8, 2012 | 12:49:46 PM | 13.34 | 3.999 | 13.4088 | 3.335 | 53.347 | 0.074 | 193.87 | 13.400 | 3.9990 | 53.547 | 0.074 | 194.54 | 13.34 | 0.000 |
| ### | May 8, 2012 | 12:49:51 PM | 13.34 | 3.999 | 13.4144 | 3.335 | 53.347 | 0.074 | 193.95 | 13.390 | 3.9990 | 53.547 | 0.074 | 194.62 | 13.34 | 0.002 |
| ### | May 8, 2012 | 12:49:56 PM | 13.34 | 3.999 | 13.4199 | 3.335 | 53.347 | 0.074 | 194.02 | 13.390 | 3.9990 | 53.547 | 0.074 | 194.69 | 13.34 | 0.003 |
| ### | May 8, 2012 | 12:50:01 PM | 13.33 | 3.999 | 13.4255 | 3.333 | 53.307 | 0.074 | 194.10 | 13.380 | 3.9990 | 53.507 | 0.074 | 194.77 | 13.34 | −0.005 |
| ### | May 8, 2012 | 12:50:06 PM | 13.33 | 4.000 | 13.4308 | 3.333 | 53.320 | 0.074 | 194.17 | 13.380 | 3.9990 | 53.520 | 0.074 | 194.84 | 13.33 | −0.004 |
| ### | May 8, 2012 | 12:50:11 PM | 13.33 | 3.999 | 13.4364 | 3.333 | 53.307 | 0.074 | 194.24 | 13.380 | 3.9990 | 53.507 | 0.074 | 194.92 | 13.33 | −0.001 |
| ### | May 8, 2012 | 12:50:16 PM | 13.32 | 3.999 | 13.4419 | 3.330 | 53.267 | 0.074 | 194.32 | 13.370 | 3.9990 | 53.467 | 0.074 | 194.99 | 13.33 | −0.009 |
| ### | May 8, 2012 | 12:50:21 PM | 13.33 | 3.999 | 13.4475 | 3.333 | 53.307 | 0.074 | 193.39 | 13.390 | 3.9990 | 53.507 | 0.074 | 195.06 | 13.33 | 0.003 |
| ### | May 8, 2012 | 12:50:26 PM | 13.33 | 3.999 | 13.4530 | 3.333 | 53.307 | 0.074 | 194.47 | 13.390 | 3.9990 | 53.507 | 0.074 | 195.14 | 13.33 | 0.005 |
| ### | May 8, 2012 | 12:50:31 PM | 13.33 | 3.999 | 13.4586 | 3.333 | 53.307 | 0.074 | 194.54 | 13.380 | 3.9990 | 53.507 | 0.074 | 195.21 | 13.32 | 0.005 |
| ### | May 8, 2012 | 12:50:36 PM | 13.32 | 3.999 | 13.4641 | 3.330 | 53.267 | 0.074 | 194.61 | 13.370 | 3.9990 | 53.467 | 0.074 | 195.29 | 13.32 | −0.003 |
| ### | May 8, 2012 | 12:50:41 PM | 13.32 | 3.999 | 13.4697 | 3.330 | 53.267 | 0.074 | 194.69 | 13.370 | 3.9990 | 53.467 | 0.074 | 195.36 | 13.32 | −0.002 |
| ### | May 8, 2012 | 12:50:46 PM | 13.32 | 3.999 | 13.4752 | 3.330 | 53.267 | 0.074 | 194.76 | 13.370 | 3.9990 | 53.467 | 0.074 | 195.44 | 13.32 | −0.002 |
| ### | May 8, 2012 | 12:50:51 PM | 13.32 | 3.999 | 13.4807 | 3.330 | 53.267 | 0.074 | 194.84 | 13.370 | 3.9990 | 53.467 | 0.074 | 195.51 | 13.32 | −0.001 |
| ### | May 8, 2012 | 12:50:56 PM | 13.32 | 3.999 | 13.4863 | 3.330 | 53.267 | 0.074 | 194.91 | 13.370 | 3.9990 | 53.467 | 0.074 | 195.58 | 13.32 | −0.002 |
| ### | May 8, 2012 | 12:51:01 PM | 13.31 | 3.999 | 13.4918 | 3.328 | 53.227 | 0.074 | 194.98 | 13.360 | 3.9990 | 53.427 | 0.074 | 195.66 | 13.32 | −0.001 |
| ### | May 8, 2012 | 12:51:06 PM | 13.32 | 3.999 | 13.4970 | 3.330 | 53.267 | 0.074 | 195.06 | 13.370 | 3.9990 | 53.467 | 0.074 | 195.73 | 13.32 | −0.010 |
| ### | May 8, 2012 | 12:51:11 PM | 13.32 | 3.999 | 13.5029 | 3.330 | 53.267 | 0.074 | 195.13 | 13.370 | 3.9990 | 53.467 | 0.074 | 195.81 | 13.32 | −0.000 |
| ### | May 8, 2012 | 12:51:16 PM | 13.32 | 3.999 | 13.5084 | 3.330 | 53.267 | 0.074 | 195.21 | 13.370 | 3.9990 | 53.467 | 0.074 | 195.88 | 13.32 | −0.001 |
| ### | May 8, 2012 | 12:51:21 PM | 13.33 | 3.999 | 13.5140 | 3.333 | 53.307 | 0.074 | 195.28 | 13.380 | 3.9990 | 53.507 | 0.074 | 195.96 | 13.32 | 0.008 |
| ### | May 8, 2012 | 12:51:26 PM | 13.32 | 3.999 | 13.5196 | 3.330 | 53.267 | 0.074 | 195.35 | 13.370 | 3.9990 | 53.467 | 0.074 | 196.03 | 13.32 | −0.005 |
| ### | May 8, 2012 | 12:51:31 PM | 13.32 | 3.999 | 13.5251 | 3.330 | 53.267 | 0.074 | 195.43 | 13.370 | 3.9990 | 53.467 | 0.074 | 196.10 | 13.33 | −0.008 |
| ### | May 8, 2012 | 12:51:36 PM | 13.31 | 3.999 | 13.5306 | 3.328 | 53.227 | 0.074 | 195.50 | 13.360 | 3.9990 | 53.427 | 0.074 | 196.18 | 13.33 | −0.020 |
| ### | May 8, 2012 | 12:51:41 PM | 13.32 | 3.999 | 13.5362 | 3.330 | 53.267 | 0.074 | 195.58 | 13.370 | 3.9990 | 53.467 | 0.074 | 196.25 | 13.33 | −0.012 |
| ### | May 8, 2012 | 12:51:46 PM | 13.35 | 3.999 | 13.5417 | 3.338 | 53.387 | 0.074 | 195.65 | 13.400 | 3.9990 | 53.587 | 0.074 | 196.33 | 13.33 | 0.015 |
| ### | May 8, 2012 | 12:51:51 PM | 13.35 | 3.999 | 13.5473 | 3.338 | 53.387 | 0.074 | 195.72 | 13.400 | 3.9990 | 53.587 | 0.074 | 196.40 | 13.34 | 0.015 |
| ### | May 8, 2012 | 12:51:56 PM | 13.35 | 3.999 | 13.5528 | 3.338 | 53.387 | 0.074 | 195.80 | 13.400 | 3.9990 | 53.587 | 0.074 | 196.48 | 13.34 | 0.012 |
| ### | May 8, 2012 | 12:52:01 PM | 13.34 | 3.999 | 13.5584 | 3.335 | 53.347 | 0.074 | 195.87 | 13.390 | 3.9990 | 53.547 | 0.074 | 196.48 | 13.34 | −0.001 |
| ### | May 8, 2012 | 12:52:06 PM | 13.34 | 3.999 | 13.5639 | 3.335 | 53.347 | 0.074 | 195.95 | 13.390 | 3.9990 | 53.547 | 0.074 | 196.63 | 13.34 | −0.004 |
| ### | May 8, 2012 | 12:52:11 PM | 13.35 | 3.999 | 13.5694 | 3.338 | 53.387 | 0.074 | 195.02 | 13.390 | 3.9990 | 53.547 | 0.074 | 196.70 | 13.35 | 0.005 |
| ### | May 8, 2012 | 12:52:16 PM | 13.34 | 3.999 | 13.5750 | 3.335 | 53.347 | 0.074 | 196.09 | 13.400 | 3.9990 | 53.587 | 0.074 | 196.77 | 13.34 | −0.005 |
| ### | May 8, 2012 | 12:52:21 PM | 13.35 | 3.999 | 13.5805 | 3.338 | 53.387 | 0.074 | 196.17 | 13.390 | 3.9990 | 53.547 | 0.074 | 196.85 | 13.34 | 0.007 |
| ### | May 8, 2012 | 12:52:26 PM | 13.35 | 3.999 | 13.5861 | 3.338 | 53.387 | 0.074 | 196.24 | 13.400 | 3.9990 | 53.587 | 0.074 | 196.92 | 13.34 | 0.010 |
| ### | May 8, 2012 | 12:52:31 PM | 13.34 | 3.999 | 13.5916 | 3.335 | 53.347 | 0.074 | 196.32 | 13.400 | 3.9990 | 53.587 | 0.074 | 197.00 | 13.34 | 0.003 |
| ### | May 8, 2012 | 12:52:36 PM | 13.34 | 3.999 | 13.5972 | 3.335 | 53.347 | 0.074 | 196.39 | 13.390 | 3.9990 | 53.547 | 0.074 | 197.07 | 13.33 | 0.005 |
| ### | May 8, 2012 | 12:52:41 PM | 13.34 | 3.999 | 13.6027 | 3.335 | 53.347 | 0.074 | 196.46 | 13.390 | 3.9990 | 53.547 | 0.074 | 197.15 | 13.33 | 0.010 |
| ### | May 8, 2012 | 12:52:46 PM | 13.33 | 3.999 | 13.6083 | 3.333 | 53.307 | 0.074 | 196.54 | 13.390 | 3.9990 | 53.547 | 0.074 | 197.22 | 13.33 | 0.001 |
| ### | May 8, 2012 | 12:52:51 PM | 13.32 | 3.999 | 13.6138 | 3.330 | 53.267 | 0.074 | 196.61 | 13.370 | 3.9990 | 53.467 | 0.074 | 197.29 | 13.33 | −0.011 |
| ### | May 8, 2012 | 12:52:56 PM | 13.31 | 3.999 | 13.6194 | 3.328 | 53.227 | 0.074 | 196.69 | 13.360 | 3.9990 | 53.427 | 0.074 | 197.37 | 13.33 | −0.021 |
| ### | May 8, 2012 | 12:53:01 PM | 13.31 | 4.000 | 13.6249 | 3.328 | 53.240 | 0.074 | 196.76 | 13.360 | 4.0000 | 53.440 | 0.074 | 197.44 | 13.33 | −0.022 |
| ### | May 8, 2012 | 12:53:06 PM | 13.30 | 3.999 | 13.6305 | 3.325 | 53.187 | 0.074 | 196.83 | 13.350 | 3.9990 | 53.387 | 0.074 | 197.52 | 13.33 | −0.033 |
| ### | May 8, 2012 | 12:53:11 PM | 13.35 | 3.999 | 13.6360 | 3.338 | 53.387 | 0.074 | 196.91 | 13.400 | 3.9990 | 53.587 | 0.074 | 197.59 | 13.33 | 0.016 |
| ### | May 8, 2012 | 12:53:16 PM | 13.35 | 3.999 | 13.6415 | 3.338 | 53.387 | 0.074 | 196.98 | 13.400 | 3.9990 | 53.587 | 0.074 | 197.67 | 13.34 | 0.015 |
| ### | May 8, 2012 | 12:53:21 PM | 13.35 | 3.999 | 13.6470 | 3.338 | 53.387 | 0.074 | 197.06 | 13.400 | 3.9990 | 53.587 | 0.074 | 197.74 | 13.34 | 0.012 |
| ### | May 8, 2012 | 12:53:26 PM | 13.35 | 3.999 | 13.6528 | 3.338 | 53.387 | 0.074 | 197.13 | 13.400 | 3.9990 | 53.587 | 0.074 | 197.81 | 13.34 | 0.009 |
| ### | May 8, 2012 | 12:53:31 PM | 13.35 | 3.999 | 13.6584 | 3.338 | 53.387 | 0.074 | 197.21 | 13.400 | 3.9990 | 53.587 | 0.074 | 197.81 | 13.34 | 0.006 |
| ### | May 8, 2012 | 12:53:36 PM | 13.35 | 3.999 | 13.6639 | 3.338 | 53.387 | 0.074 | 197.28 | 13.400 | 3.9990 | 53.587 | 0.074 | 197.89 | 13.35 | 0.003 |
| ### | May 8, 2012 | 12:53:41 PM | 13.35 | 3.999 | 13.6695 | 3.338 | 53.387 | 0.074 | 197.35 | 13.400 | 3.9990 | 53.587 | 0.074 | 197.96 | 13.35 | 0.004 |
| ### | May 8, 2012 | 12:53:46 PM | 13.35 | 3.999 | 13.6750 | 3.338 | 53.387 | 0.074 | 197.43 | 13.400 | 3.9990 | 53.587 | 0.074 | 198.04 | 13.35 | 0.005 |
| ### | May 8, 2012 | 12:53:51 PM | 13.34 | 3.999 | 13.6806 | 3.335 | 53.347 | 0.074 | 197.50 | 13.390 | 3.9990 | 53.547 | 0.074 | 198.11 | 13.34 | −0.004 |
| ### | May 8, 2012 | 12:53:56 PM | 13.34 | 3.999 | 13.6861 | 3.335 | 53.347 | 0.074 | 197.58 | 13.390 | 3.9990 | 53.547 | 0.074 | 198.19 | 13.34 | −0.002 |
| ### | May 8, 2012 | 12:54:01 PM | 13.34 | 3.999 | 13.6916 | 3.335 | 53.347 | 0.074 | 197.65 | 13.390 | 3.9990 | 53.547 | 0.074 | 198.34 | 13.34 | 0.000 |
| ### | May 8, 2012 | 12:54:06 PM | 13.34 | 3.999 | 13.6970 | 3.335 | 53.347 | 0.074 | 197.72 | 13.390 | 3.9990 | 53.547 | 0.074 | 198.41 | 13.34 | 0.002 |
| ### | May 8, 2012 | 12:54:11 PM | 13.34 | 3.999 | 13.6970 | 3.335 | 53.347 | 0.074 | 197.80 | 13.390 | 3.9990 | 53.547 | 0.074 | 198.48 | 13.34 | 0.004 |
| ### | May 8, 2012 | 12:54:16 PM | 13.33 | 3.999 | 13.7081 | 3.333 | 53.307 | 0.074 | 197.87 | 13.380 | 3.9990 | 53.507 | 0.074 | 198.56 | 13.33 | −0.004 |
| ### | May 8, 2012 | 12:54:21 PM | 13.33 | 3.999 | 13.7138 | 3.333 | 53.307 | 0.074 | 197.95 | 13.380 | 3.9990 | 53.507 | 0.074 | 198.63 | 13.33 | −0.002 |
| ### | May 8, 2012 | 12:54:26 PM | 13.33 | 3.999 | 13.7190 | 3.333 | 53.307 | 0.074 | 198.02 | 13.380 | 3.9990 | 53.507 | 0.074 | 198.71 | 13.33 | 0.000 |
| ### | May 8, 2012 | 12:54:31 PM | 13.33 | 3.999 | 13.7249 | 3.333 | 53.307 | 0.074 | 198.09 | 13.380 | 3.9990 | 53.507 | 0.074 | 198.78 | 13.33 | 0.002 |
| ### | May 8, 2012 | 12:54:36 PM | 13.33 | 3.999 | 13.7305 | 3.333 | 53.307 | 0.074 | 198.09 | 13.380 | 3.9990 | 53.507 | 0.074 | 198.86 | 13.33 | 0.004 |
| ### | May 8, 2012 | 12:54:41 PM | 13.32 | 3.999 | 13.7360 | 3.330 | 53.267 | 0.074 | 198.17 | 13.380 | 3.9990 | 53.507 | 0.074 | 198.93 | 13.32 | −0.005 |
| ### | May 8, 2012 | 12:54:46 PM | 13.32 | 3.999 | 13.7415 | 3.330 | 53.267 | 0.074 | 198.24 | 13.370 | 3.9990 | 53.567 | 0.074 | 199.00 | 13.32 | −0.004 |
| ### | May 8, 2012 | 12:54:51 PM | 13.32 | 3.999 | 13.7471 | 3.330 | 53.267 | 0.074 | 198.32 | 13.370 | 3.9990 | 53.467 | 0.074 | 199.08 | 13.32 | −0.002 |
| ### | May 8, 2012 | 12:54:56 PM | 13.32 | 3.999 | 13.7526 | 3.330 | 53.267 | 0.074 | 198.39 | 13.370 | 3.9990 | 53.467 | 0.074 | 199.15 | 13.32 | 0.000 |
| ### | May 8, 2012 | 12:55:01 PM | 13.32 | 3.999 | 13.7582 | 3.330 | 53.267 | 0.074 | 198.46 | 13.370 | 3.9990 | 53.467 | 0.074 | 199.23 | 13.32 | 0.002 |
| ### | May 8, 2012 | 12:55:06 PM | 13.32 | 3.999 | 13.7637 | 3.330 | 53.267 | 0.074 | 198.61 | 13.370 | 3.9990 | 53.467 | 0.074 | 199.30 | 13.32 | 0.004 |
| ### | May 8, 2012 | 12:55:11 PM | 13.32 | 3.999 | 13.7692 | 3.330 | 53.267 | 0.074 | 198.69 | 13.370 | 3.9990 | 53.467 | 0.074 | 199.38 | 13.32 | 0.005 |
| ### | May 8, 2012 | 12:55:16 PM | 13.31 | 3.999 | 13.7748 | 3.328 | 53.227 | 0.074 | 198.76 | 13.360 | 3.9990 | 53.427 | 0.074 | 199.45 | 13.31 | −0.005 |
| ### | May 8, 2012 | 12:55:21 PM | 13.31 | 3.999 | 13.7803 | 3.328 | 53.227 | 0.074 | 198.83 | 13.360 | 3.9990 | 53.427 | 0.074 | 199.52 | 13.31 | −0.004 |
| ### | May 8, 2012 | 12:55:26 PM | 13.31 | 3.999 | 13.7859 | 3.328 | 53.227 | 0.074 | 198.91 | 13.360 | 3.9990 | 53.427 | 0.074 | 199.60 | 13.31 | −0.003 |
| ### | May 8, 2012 | 12:55:31 PM | 13.31 | 3.999 | 13.7914 | 3.328 | 53.227 | 0.074 | 198.98 | 13.360 | 3.9990 | 53.427 | 0.074 | 199.67 | 13.31 | −0.002 |
| ### | May 8, 2012 | 12:55:36 PM | 13.31 | 3.999 | 13.7966 | 3.328 | 53.227 | 0.074 | 199.06 | 13.360 | 3.9990 | 53.427 | 0.074 | 199.75 | 13.31 | 0.000 |
| ### | May 8, 2012 | 12:55:41 PM | 13.31 | 3.999 | 13.8022 | 3.328 | 53.227 | 0.074 | 199.13 | 13.360 | 3.9990 | 53.427 | 0.074 | 199.82 | 13.31 | 0.002 |
| ### | May 8, 2012 | 12:55:46 PM | 13.31 | 3.999 | 13.8081 | 3.328 | 53.227 | 0.074 | 199.20 | 13.360 | 3.9990 | 53.427 | 0.074 | 199.90 | 13.31 | 0.003 |
| ### | May 8, 2012 | 12:55:51 PM | 13.31 | 3.999 | 13.8132 | 3.328 | 53.227 | 0.074 | 199.28 | 13.360 | 3.9990 | 53.427 | 0.074 | 199.97 | 13.31 | 0.004 |
| ### | May 8, 2012 | 12:55:56 PM | 13.31 | 3.999 | 13.8191 | 3.328 | 53.227 | 0.074 | 199.35 | 13.360 | 3.9990 | 53.427 | 0.074 | 200.04 | 13.31 | 0.005 |
| ### | May 8, 2012 | 12:56:01 PM | 13.30 | 3.999 | 13.8247 | 3.325 | 53.187 | 0.074 | 199.43 | 13.350 | 3.9990 | 53.387 | 0.074 | 200.12 | 13.30 | −0.005 |
| ### | May 8, 2012 | 12:56:06 PM | 13.30 | 3.999 | 13.8302 | 3.325 | 53.187 | 0.074 | 199.50 | 13.350 | 3.9990 | 53.387 | 0.074 | 200.19 | 13.30 | −0.003 |
| ### | May 8, 2012 | 12:56:11 PM | 13.30 | 3.999 | 13.8354 | 3.325 | 53.187 | 0.074 | 199.57 | 13.350 | 3.9990 | 53.387 | 0.074 | 200.27 | 13.30 | −0.001 |
| ### | May 8, 2012 | 12:56:16 PM | 13.30 | 3.999 | 13.8469 | 3.325 | 53.187 | 0.074 | 199.65 | 13.350 | 3.9990 | 53.387 | 0.074 | 200.34 | 13.30 | 0.001 |
| ### | May 8, 2012 | 12:56:21 PM | 13.30 | 3.999 | 13.8521 | 3.325 | 53.187 | 0.074 | 199.72 | 13.350 | 3.9990 | 53.387 | 0.074 | 200.41 | 13.30 | 0.003 |
| ### | May 8, 2012 | 12:56:26 PM | 13.30 | 3.999 | 13.8521 | 3.325 | 53.187 | 0.074 | 199.79 | 13.350 | 3.9990 | 53.387 | 0.074 | 200.49 | 13.30 | 0.005 |
| ### | May 8, 2012 | 12:56:31 PM | 13.29 | 3.999 | 13.8579 | 3.323 | 53.147 | 0.074 | 199.87 | 13.340 | 3.9990 | 53.347 | 0.074 | 200.56 | 13.29 | −0.005 |
| ### | May 8, 2012 | 12:56:36 PM | 13.29 | 3.999 | 13.8635 | 3.323 | 53.147 | 0.074 | 199.94 | 13.340 | 3.9990 | 53.347 | 0.074 | 200.64 | 13.29 | −0.004 |
| ### | May 8, 2012 | 12:56:41 PM | 13.29 | 3.999 | 13.8690 | 3.323 | 53.147 | 0.074 | 200.02 | 13.340 | 3.9990 | 53.347 | 0.074 | 200.71 | 13.29 | −0.003 |
| ### | May 8, 2012 | 12:56:46 PM | 13.29 | 3.999 | 13.8742 | 3.323 | 53.147 | 0.074 | 200.09 | 13.340 | 3.9990 | 53.347 | 0.074 | 200.78 | 13.29 | −0.002 |
| ### | May 8, 2012 | 12:56:51 PM | 13.29 | 3.999 | 13.8801 | 3.323 | 53.147 | 0.074 | 200.16 | 13.340 | 3.9990 | 53.347 | 0.074 | 200.86 | 13.29 | −0.001 |
| ### | May 8, 2012 | 12:56:56 PM | 13.29 | 3.999 | 13.8857 | 3.323 | 53.147 | 0.074 | 200.24 | 13.340 | 3.9990 | 53.347 | 0.074 | 200.93 | 13.29 | 0.000 |
| ### | May 8, 2012 | 12:57:01 PM | 13.29 | 3.999 | 13.8912 | 3.323 | 53.147 | 0.074 | 200.31 | 13.340 | 3.9990 | 53.347 | 0.074 | 201.01 | 13.29 | 0.000 |
| ### | May 8, 2012 | 12:57:06 PM | 13.29 | 3.999 | 13.8967 | 3.323 | 53.147 | 0.074 | 200.39 | 13.340 | 3.9990 | 53.347 | 0.074 | 201.08 | 13.29 | 0.000 |
| ### | May 8, 2012 | 12:57:11 PM | 13.29 | 3.999 | 13.9023 | 3.323 | 53.147 | 0.074 | 200.46 | 13.340 | 3.9990 | 53.347 | 0.074 | 201.16 | 13.29 | 0.001 |
| ### | May 8, 2012 | 12:57:16 PM | 13.29 | 3.999 | 13.9078 | 3.323 | 53.147 | 0.074 | 200.53 | 13.340 | 3.9990 | 53.347 | 0.074 | 201.23 | 13.29 | 0.002 |
| ### | May 8, 2012 | 12:57:21 PM | 13.29 | 3.999 | 13.9130 | 3.323 | 53.147 | 0.074 | 200.61 | 13.340 | 3.9990 | 53.347 | 0.074 | 201.30 | 13.29 | 0.003 |
| ### | May 8, 2012 | 12:57:26 PM | 13.29 | 3.999 | 13.9189 | 3.323 | 53.147 | 0.074 | 200.68 | 13.340 | 3.9990 | 53.347 | 0.074 | 201.38 | 13.29 | 0.004 |
| ### | May 8, 2012 | 12:57:31 PM | 13.29 | 3.999 | 13.9245 | 3.323 | 53.147 | 0.074 | 200.75 | 13.340 | 3.9990 | 53.347 | 0.074 | 201.45 | 13.29 | 0.005 |
| ### | May 8, 2012 | 12:57:36 PM | 13.28 | 3.999 | 13.9300 | 3.320 | 53.107 | 0.074 | 200.83 | 13.330 | 3.9990 | 53.307 | 0.074 | 201.53 | 13.28 | −0.005 |
| ### | May 8, 2012 | 12:57:41 PM | 13.28 | 3.999 | 13.9356 | 3.320 | 53.107 | 0.074 | 200.90 | 13.330 | 3.9990 | 53.307 | 0.074 | 201.60 | 13.28 | −0.004 |
| ### | May 8, 2012 | 12:57:46 PM | 13.28 | 3.999 | 13.9411 | 3.320 | 53.107 | 0.074 | 200.98 | 13.330 | 3.9990 | 53.307 | 0.074 | 201.67 | 13.28 | −0.003 |
| ### | May 8, 2012 | 12:57:51 PM | 13.28 | 3.999 | 13.9465 | 3.320 | 53.107 | 0.074 | 201.05 | 13.330 | 3.9990 | 53.307 | 0.074 | 201.75 | 13.28 | −0.002 |
| ### | May 8, 2012 | 12:57:56 PM | 13.28 | 3.999 | 13.9520 | 3.320 | 53.107 | 0.074 | 201.12 | 13.330 | 3.9990 | 53.307 | 0.074 | 201.82 | 13.28 | −0.001 |
| ### | May 8, 2012 | 12:58:01 PM | 13.28 | 3.999 | 13.9576 | 3.320 | 53.107 | 0.074 | 201.20 | 13.330 | 3.9990 | 53.307 | 0.074 | 201.90 | 13.28 | 0.000 |
| ### | May 8, 2012 | 12:58:06 PM | 13.28 | 3.999 | 13.9631 | 3.320 | 53.107 | 0.074 | 201.27 | 13.330 | 3.9990 | 53.307 | 0.074 | 201.97 | 13.28 | 0.001 |
| ### | May 8, 2012 | 12:58:11 PM | 13.28 | 3.999 | 13.9686 | 3.320 | 53.107 | 0.074 | 201.34 | 13.330 | 3.9990 | 53.307 | 0.074 | 202.04 | 13.28 | 0.002 |
| ### | May 8, 2012 | 12:58:16 PM | 13.28 | 3.999 | 13.9742 | 3.320 | 53.107 | 0.074 | 201.42 | 13.330 | 3.9990 | 53.307 | 0.074 | 202.12 | 13.28 | 0.003 |
| ### | May 8, 2012 | 12:58:21 PM | 13.28 | 3.999 | 13.9797 | 3.320 | 53.107 | 0.074 | 201.49 | 13.330 | 3.9990 | 53.307 | 0.074 | 202.19 | 13.28 | 0.003 |
| ### | May 8, 2012 | 12:58:26 PM | 13.28 | 3.999 | 13.9853 | 3.320 | 53.107 | 0.074 | 201.57 | 13.330 | 3.9990 | 53.307 | 0.074 | 202.27 | 13.28 | 0.004 |
| ### | May 8, 2012 | 12:58:31 PM | 13.27 | 3.999 | 13.9908 | 3.318 | 53.067 | 0.074 | 201.64 | 13.320 | 3.9990 | 53.267 | 0.074 | 202.34 | 13.28 | −0.005 |
| ### | May 8, 2012 | 12:58:36 PM | 13.27 | 3.999 | 13.9964 | 3.318 | 53.067 | 0.074 | 201.71 | 13.320 | 3.9990 | 53.267 | 0.074 | 202.41 | 13.27 | −0.005 |
| ### | May 8, 2012 | 12:58:41 PM | 13.27 | 3.999 | 14.0019 | 3.318 | 53.067 | 0.074 | 201.79 | 13.320 | 3.9990 | 53.267 | 0.074 | 202.49 | 13.27 | −0.004 |
| ### | May 8, 2012 | 12:58:46 PM | 13.28 | 3.999 | 14.0074 | 3.320 | 53.107 | 0.074 | 201.86 | 13.330 | 3.9990 | 53.307 | 0.074 | 202.56 | 13.27 | 0.007 |
| ### | May 8, 2012 | 12:58:51 PM | 13.27 | 3.999 | 14.0130 | 3.318 | 53.067 | 0.074 | 201.93 | 13.320 | 3.9990 | 53.267 | 0.074 | 202.64 | 13.28 | −0.006 |
| ### | May 8, 2012 | 12:58:56 PM | 13.27 | 3.999 | 14.0185 | 3.318 | 53.067 | 0.074 | 202.01 | 13.320 | 3.9990 | 53.267 | 0.074 | 202.71 | 13.28 | −0.010 |
| ### | May 8, 2012 | 12:59:01 PM | 13.27 | 3.999 | 14.0241 | 3.318 | 53.067 | 0.074 | 202.08 | 13.320 | 3.9990 | 53.267 | 0.074 | 202.78 | 13.28 | −0.015 |
| ### | May 8, 2012 | 12:59:06 PM | 13.27 | 3.999 | 14.0296 | 3.318 | 53.067 | 0.074 | 202.16 | 13.320 | 3.9990 | 53.267 | 0.074 | 202.86 | 13.29 | −0.018 |
| ### | May 8, 2012 | 12:59:11 PM | 13.27 | 3.999 | 14.0352 | 3.318 | 53.067 | 0.074 | 202.23 | 13.320 | 3.9990 | 53.267 | 0.074 | 202.93 | 13.29 | −0.022 |
| ### | May 8, 2012 | 12:59:16 PM | 13.32 | 3.999 | 14.0409 | 3.330 | 53.267 | 0.074 | 202.30 | 13.370 | 3.9990 | 53.467 | 0.074 | 203.01 | 13.29 | 0.025 |
| ### | May 8, 2012 | 12:59:21 PM | 13.32 | 3.999 | 14.0461 | 3.330 | 53.267 | 0.074 | 202.38 | 13.370 | 3.9990 | 53.467 | 0.074 | 203.08 | 13.30 | 0.022 |
| ### | May 8, 2012 | 12:59:26 PM | 13.32 | 3.999 | 14.0516 | 3.330 | 53.267 | 0.074 | 202.45 | 13.370 | 3.9990 | 53.467 | 0.074 | 203.15 | 13.30 | 0.018 |
| ### | May 8, 2012 | 12:59:31 PM | 13.31 | 3.999 | 14.0575 | 3.328 | 53.227 | 0.074 | 202.52 | 13.360 | 3.9990 | 53.427 | 0.074 | 203.23 | 13.30 | 0.006 |
| ### | May 8, 2012 | 12:59:36 PM | 13.31 | 3.999 | 14.0631 | 3.328 | 53.227 | 0.074 | 202.60 | 13.360 | 3.9990 | 53.427 | 0.074 | 203.30 | 13.31 | 0.005 |
| ### | May 8, 2012 | 12:59:41 PM | 13.31 | 3.999 | 14.0683 | 3.328 | 53.227 | 0.074 | 202.67 | 13.360 | 3.9990 | 53.427 | 0.074 | 203.38 | 13.31 | 0.004 |
| ### | May 8, 2012 | 12:59:46 PM | 13.31 | 3.999 | 14.0741 | 3.328 | 53.227 | 0.074 | 202.75 | 13.360 | 3.9990 | 53.427 | 0.074 | 203.45 | 13.30 | 0.008 |
| ### | May 8, 2012 | 12:59:51 PM | 13.31 | 3.999 | 14.0797 | 3.328 | 53.227 | 0.074 | 202.82 | 13.360 | 3.9990 | 53.427 | 0.074 | 203.53 | 13.30 | 0.014 |
| ### | May 8, 2012 | 12:59:56 PM | 13.29 | 3.999 | 14.0853 | 3.323 | 53.147 | 0.074 | 202.89 | 13.340 | 3.9990 | 53.347 | 0.074 | 203.60 | 13.29 | 0.000 |
| ### | May 8, 2012 | 1:00:01 PM | 13.29 | 3.999 | 14.0908 | 3.323 | 53.147 | 0.074 | 202.97 | 13.340 | 3.9990 | 53.347 | 0.074 | 203.67 | 13.28 | 0.006 |
| ### | May 8, 2012 | 1:00:06 PM | 13.28 | 3.999 | 14.0960 | 3.320 | 53.107 | 0.074 | 203.04 | 13.330 | 3.9990 | 53.307 | 0.074 | 203.75 | 13.28 | 0.002 |
| ### | May 8, 2012 | 1:00:11 PM | 13.27 | 3.999 | 14.1015 | 3.318 | 53.067 | 0.074 | 203.12 | 13.320 | 3.9990 | 53.267 | 0.074 | 203.82 | 13.27 | −0.003 |
| ### | May 8, 2012 | 1:00:16 PM | 13.26 | 3.999 | 14.1074 | 3.315 | 53.027 | 0.074 | 203.19 | 13.310 | 3.9990 | 53.227 | 0.074 | 203.90 | 13.27 | −0.006 |
| ### | May 8, 2012 | 1:00:21 PM | 13.25 | 3.999 | 14.1130 | 3.313 | 52.987 | 0.074 | 203.26 | 13.300 | 3.9990 | 53.187 | 0.074 | 203.97 | 13.26 | −0.010 |
| ### | May 8, 2012 | 1:00:26 PM | 13.24 | 3.999 | 14.1185 | 3.310 | 52.947 | 0.074 | 203.34 | 13.290 | 3.9990 | 53.147 | 0.074 | 204.04 | 13.26 | −0.015 |
| ### | May 8, 2012 | 1:00:31 PM | 13.25 | 3.999 | 14.1240 | 3.313 | 52.987 | 0.074 | 203.41 | 13.300 | 3.9990 | 53.187 | 0.074 | 204.12 | 13.25 | −0.001 |
| ### | May 8, 2012 | 1:00:36 PM | 13.25 | 3.999 | 14.1296 | 3.313 | 52.987 | 0.074 | 203.48 | 13.300 | 3.9990 | 53.187 | 0.074 | 204.19 | 13.25 | 0.003 |
| ### | May 8, 2012 | 1:00:41 PM | 13.24 | 3.999 | 14.1351 | 3.310 | 52.947 | 0.074 | 203.56 | 13.290 | 3.9990 | 53.147 | 0.074 | 204.27 | 13.24 | −0.005 |
| ### | May 8, 2012 | 1:00:46 PM | 13.24 | 3.999 | 14.1407 | 3.310 | 52.947 | 0.074 | 203.63 | 13.290 | 3.9990 | 53.147 | 0.074 | 204.34 | 13.24 | −0.003 |
| ### | May 8, 2012 | 1:00:51 PM | 13.24 | 3.999 | 14.1462 | 3.310 | 52.947 | 0.074 | 203.70 | 13.290 | 3.9990 | 53.147 | 0.074 | 204.41 | 13.24 | −0.002 |
| ### | May 8, 2012 | 1:00:56 PM | 13.24 | 3.999 | 14.1518 | 3.310 | 52.947 | 0.074 | 203.78 | 13.290 | 3.9990 | 53.147 | 0.074 | 204.49 | 13.25 | −0.005 |
| ### | May 8, 2012 | 1:01:01 PM | 13.24 | 3.999 | 14.1573 | 3.310 | 52.947 | 0.074 | 203.85 | 13.290 | 3.9990 | 53.147 | 0.074 | 204.56 | 13.25 | −0.008 |
| ### | May 8, 2012 | 1:01:06 PM | 13.24 | 3.999 | 14.1629 | 3.310 | 52.947 | 0.074 | 203.92 | 13.290 | 3.9990 | 53.147 | 0.074 | 204.63 | 13.25 | −0.011 |
| ### | May 8, 2012 | 1:01:11 PM | 13.24 | 3.999 | 14.1684 | 3.310 | 52.947 | 0.074 | 204.00 | 13.290 | 3.9990 | 53.147 | 0.074 | 204.71 | 13.25 | −0.015 |
| ### | May 8, 2012 | 1:01:16 PM | 13.24 | 3.999 | 14.1739 | 3.310 | 52.947 | 0.074 | 204.07 | 13.290 | 3.9990 | 53.147 | 0.074 | 204.78 | 13.26 | −0.017 |
| ### | May 8, 2012 | 1:01:21 PM | 13.28 | 3.999 | 14.1795 | 3.320 | 53.107 | 0.074 | 204.15 | 13.330 | 3.9990 | 53.307 | 0.074 | 204.86 | 13.26 | 0.020 |
| ### | May 8, 2012 | 1:01:26 PM | 13.28 | 3.999 | 14.1850 | 3.320 | 53.107 | 0.074 | 204.22 | 13.330 | 3.9990 | 53.307 | 0.074 | 204.93 | 13.26 | 0.018 |
| ### | May 8, 2012 | 1:01:31 PM | 13.28 | 3.999 | 14.1906 | 3.320 | 53.107 | 0.074 | 204.29 | 13.330 | 3.9990 | 53.307 | 0.074 | 205.00 | 13.26 | 0.016 |
| ### | May 8, 2012 | 1:01:36 PM | 13.28 | 3.999 | 14.1961 | 3.320 | 53.107 | 0.074 | 204.37 | 13.330 | 3.9990 | 53.307 | 0.074 | 205.08 | 13.27 | 0.015 |
| ### | May 8, 2012 | 1:01:41 PM | 13.27 | 3.999 | 14.2017 | 3.318 | 53.067 | 0.074 | 204.44 | 13.320 | 3.9990 | 53.267 | 0.074 | 205.15 | 13.27 | 0.004 |
| ### | May 8, 2012 | 1:01:46 PM | 13.27 | 3.999 | 14.2072 | 3.318 | 53.067 | 0.074 | 204.51 | 13.320 | 3.9990 | 53.267 | 0.074 | 205.23 | 13.27 | 0.003 |
| ### | May 8, 2012 | 1:01:51 PM | 13.26 | 3.999 | 14.2128 | 3.315 | 53.027 | 0.074 | 204.59 | 13.310 | 3.9990 | 53.227 | 0.074 | 205.30 | 13.26 | −0.005 |
| ### | May 8, 2012 | 1:01:56 PM | 13.26 | 3.999 | 14.2180 | 3.315 | 53.027 | 0.074 | 204.66 | 13.310 | 3.9990 | 53.227 | 0.074 | 205.37 | 13.26 | −0.002 |
| ### | May 8, 2012 | 1:02:01 PM | 13.26 | 3.999 | 14.2239 | 3.315 | 53.027 | 0.074 | 204.74 | 13.310 | 3.9990 | 53.227 | 0.074 | 205.45 | 13.26 | 0.002 |
| ### | May 8, 2012 | 1:02:06 PM | 13.25 | 3.999 | 14.2294 | 3.313 | 52.987 | 0.074 | 204.81 | 13.300 | 3.9990 | 53.187 | 0.074 | 205.52 | 13.25 | −0.005 |
| ### | May 8, 2012 | 1:02:11 PM | 13.25 | 3.999 | 14.2349 | 3.313 | 52.987 | 0.074 | 204.88 | 13.300 | 3.9990 | 53.187 | 0.074 | 205.60 | 13.25 | −0.001 |
| ### | May 8, 2012 | 1:02:16 PM | 13.25 | 3.999 | 14.2401 | 3.313 | 52.987 | 0.074 | 204.96 | 13.300 | 3.9990 | 53.187 | 0.074 | 205.67 | 13.25 | 0.004 |
| ### | May 8, 2012 | 1:02:21 PM | 13.25 | 3.999 | 14.2457 | 3.313 | 52.987 | 0.074 | 205.03 | 13.300 | 3.9990 | 53.187 | 0.074 | 205.74 | 13.24 | 0.007 |
| ### | May 8, 2012 | 1:02:26 PM | 13.24 | 3.999 | 14.2516 | 3.310 | 52.947 | 0.074 | 205.10 | 13.290 | 3.9990 | 53.147 | 0.074 | 205.82 | 13.24 | 0.001 |
| ### | May 8, 2012 | 1:02:31 PM | 13.24 | 3.999 | 14.2568 | 3.310 | 52.947 | 0.074 | 205.18 | 13.290 | 3.9990 | 53.147 | 0.074 | 205.89 | 13.24 | 0.005 |
| ### | May 8, 2012 | 1:02:36 PM | 13.23 | 3.999 | 14.2627 | 3.308 | 52.907 | 0.074 | 205.25 | 13.280 | 3.9990 | 53.107 | 0.074 | 205.96 | 13.23 | −0.003 |
| ### | May 8, 2012 | 1:02:41 PM | 13.22 | 3.999 | 14.2682 | 3.305 | 52.867 | 0.074 | 205.32 | 13.270 | 3.9990 | 53.067 | 0.074 | 206.04 | 13.23 | −0.010 |
| ### | May 8, 2012 | 1:02:46 PM | 13.22 | 3.999 | 14.2738 | 3.305 | 52.867 | 0.074 | 205.40 | 13.270 | 3.9990 | 53.067 | 0.074 | 206.11 | 13.23 | −0.010 |
| ### | May 8, 2012 | 1:02:51 PM | 13.22 | 3.999 | 14.2793 | 3.305 | 52.867 | 0.074 | 205.47 | 13.270 | 3.9990 | 53.067 | 0.074 | 206.19 | 13.23 | −0.010 |
| ### | May 8, 2012 | 1:02:56 PM | 13.22 | 3.999 | 14.2849 | 3.305 | 52.867 | 0.074 | 205.54 | 13.270 | 3.9990 | 53.067 | 0.074 | 206.26 | 13.23 | −0.010 |
| ### | May 8, 2012 | 1:03:01 PM | 13.22 | 3.999 | 14.2904 | 3.305 | 52.867 | 0.073 | 205.62 | 13.270 | 3.9990 | 53.067 | 0.074 | 206.33 | 13.23 | −0.010 |
| ### | May 8, 2012 | 1:03:06 PM | 13.22 | 3.999 | 14.2956 | 3.305 | 52.867 | 0.073 | 205.69 | 13.270 | 3.9990 | 53.067 | 0.074 | 206.41 | 13.23 | −0.009 |
| ### | May 8, 2012 | 1:03:11 PM | 13.25 | 3.999 | 14.3012 | 3.313 | 52.987 | 0.074 | 205.76 | 13.300 | 3.9990 | 53.187 | 0.074 | 206.48 | 13.23 | 0.021 |
| ### | May 8, 2012 | 1:03:16 PM | 13.25 | 3.999 | 14.3070 | 3.313 | 52.987 | 0.074 | 205.84 | 13.300 | 3.9990 | 53.187 | 0.074 | 206.55 | 13.23 | 0.019 |
| ### | May 8, 2012 | 1:03:21 PM | 13.24 | 3.999 | 14.3126 | 3.310 | 52.947 | 0.074 | 205.91 | 13.290 | 3.9990 | 53.147 | 0.074 | 206.63 | 13.23 | 0.010 |
| ### | May 8, 2012 | 1:03:26 PM | 13.24 | 3.999 | 14.3181 | 3.310 | 52.947 | 0.074 | 205.99 | 13.290 | 3.9990 | 53.147 | 0.074 | 206.70 | 13.23 | 0.006 |
| ### | May 8, 2012 | 1:03:31 PM | 13.22 | 3.999 | 14.3237 | 3.305 | 52.867 | 0.073 | 206.06 | 13.270 | 3.9990 | 53.067 | 0.074 | 206.78 | 13.24 | −0.017 |
| ### | May 8, 2012 | 1:03:36 PM | 13.22 | 3.999 | 14.3292 | 3.305 | 52.867 | 0.073 | 206.13 | 13.270 | 3.9990 | 53.067 | 0.074 | 206.85 | 13.24 | −0.021 |
| ### | May 8, 2012 | 1:03:41 PM | 13.24 | 3.999 | 14.3348 | 3.310 | 52.947 | 0.074 | 206.21 | 13.290 | 3.9990 | 53.147 | 0.074 | 206.92 | 13.24 | −0.002 |
| ### | May 8, 2012 | 1:03:46 PM | 13.21 | 3.999 | 14.3400 | 3.303 | 52.827 | 0.073 | 206.28 | 13.260 | 3.9990 | 53.027 | 0.074 | 207.00 | 13.24 | −0.032 |
| ### | May 8, 2012 | 1:03:51 PM | 13.26 | 3.999 | 14.3459 | 3.315 | 53.027 | 0.074 | 206.35 | 13.310 | 3.9990 | 53.227 | 0.074 | 207.07 | 13.24 | 0.017 |
| ### | May 8, 2012 | 1:03:56 PM | 13.26 | 3.999 | 14.3514 | 3.315 | 53.027 | 0.074 | 206.43 | 13.310 | 3.9990 | 53.227 | 0.074 | 207.14 | 13.24 | 0.016 |
| ### | May 8, 2012 | 1:04:01 PM | 13.26 | 3.999 | 14.3569 | 3.315 | 53.027 | 0.074 | 206.50 | 13.310 | 3.9990 | 53.227 | 0.074 | 207.22 | 13.24 | 0.015 |
| ### | May 8, 2012 | 1:04:06 PM | 13.26 | 3.999 | 14.3625 | 3.315 | 53.027 | 0.074 | 206.57 | 13.310 | 3.9990 | 53.227 | 0.074 | 207.29 | 13.25 | 0.014 |
| ### | May 8, 2012 | 1:04:11 PM | 13.25 | 3.999 | 14.3680 | 3.313 | 52.987 | 0.074 | 206.65 | 13.300 | 3.9990 | 53.187 | 0.074 | 207.37 | 13.24 | 0.005 |
| ### | May 8, 2012 | 1:04:16 PM | 13.25 | 3.999 | 14.3736 | 3.313 | 52.987 | 0.074 | 206.72 | 13.300 | 3.9990 | 53.187 | 0.074 | 207.44 | 13.25 | 0.005 |
| ### | May 8, 2012 | 1:04:21 PM | 13.25 | 3.999 | 14.3788 | 3.313 | 52.987 | 0.074 | 206.79 | 13.300 | 3.9990 | 53.187 | 0.074 | 207.51 | 13.24 | 0.008 |
| ### | May 8, 2012 | 1:04:26 PM | 13.23 | 3.999 | 14.3847 | 3.308 | 52.907 | 0.073 | 206.87 | 13.280 | 3.9990 | 53.107 | 0.074 | 207.59 | 13.24 | −0.007 |
| ### | May 8, 2012 | 1:04:31 PM | 13.24 | 3.999 | 14.3902 | 3.310 | 52.947 | 0.074 | 206.94 | 13.290 | 3.9990 | 53.147 | 0.074 | 207.66 | 13.23 | 0.007 |
| ### | May 8, 2012 | 1:04:36 PM | 13.22 | 3.999 | 14.3958 | 3.305 | 52.867 | 0.073 | 207.01 | 13.270 | 3.9990 | 53.067 | 0.074 | 207.74 | 13.23 | −0.007 |
| ### | May 8, 2012 | 1:04:41 PM | 13.22 | 3.999 | 14.4013 | 3.305 | 52.867 | 0.073 | 207.09 | 13.270 | 3.9990 | 53.067 | 0.074 | 207.81 | 13.22 | −0.003 |
| ### | May 8, 2012 | 1:04:46 PM | 13.22 | 3.999 | 14.4069 | 3.305 | 52.867 | 0.073 | 207.16 | 13.270 | 3.9990 | 53.067 | 0.074 | 207.88 | 13.22 | 0.002 |
| ### | May 8, 2012 | 1:04:51 PM | 13.21 | 3.999 | 14.4124 | 3.303 | 52.827 | 0.073 | 207.23 | 13.260 | 3.9990 | 53.027 | 0.074 | 207.96 | 13.22 | −0.009 |
| ### | May 8, 2012 | 1:04:56 PM | 13.21 | 3.999 | 14.4176 | 3.303 | 52.827 | 0.073 | 207.31 | 13.260 | 3.9990 | 53.027 | 0.074 | 208.03 | 13.22 | −0.012 |
| ### | May 8, 2012 | 1:05:01 PM | 13.20 | 3.999 | 14.4235 | 3.300 | 52.787 | 0.073 | 207.38 | 13.250 | 3.9990 | 53.987 | 0.074 | 208.10 | 13.22 | −0.024 |
| ### | May 8, 2012 | 1:05:06 PM | 13.20 | 3.999 | 14.4290 | 3.300 | 52.787 | 0.073 | 207.45 | 13.250 | 3.9990 | 52.987 | 0.074 | 208.18 | 13.23 | −0.027 |
| ### | May 8, 2012 | 1:05:11 PM | 13.20 | 3.999 | 14.4346 | 3.300 | 52.787 | 0.073 | 207.53 | 13.250 | 3.9990 | 52.987 | 0.074 | 208.25 | 13.23 | −0.031 |
| ### | May 8, 2012 | 1:05:16 PM | 13.26 | 3.999 | 14.4401 | 3.315 | 53.027 | 0.074 | 207.60 | 13.310 | 3.9990 | 52.227 | 0.074 | 208.32 | 13.23 | 0.025 |
| ### | May 8, 2012 | 1:05:21 PM | 13.26 | 3.999 | 14.4457 | 3.315 | 53.027 | 0.074 | 207.68 | 13.310 | 3.9990 | 53.227 | 0.074 | 208.40 | 13.24 | 0.021 |
| ### | May 8, 2012 | 1:05:26 PM | 13.26 | 3.999 | 14.4512 | 3.315 | 53.027 | 0.074 | 207.75 | 13.310 | 3.9990 | 53.227 | 0.074 | 208.47 | 13.24 | 0.016 |
| ### | May 8, 2012 | 1:05:31 PM | 13.26 | 3.999 | 14.4564 | 3.315 | 53.027 | 0.074 | 207.82 | 13.310 | 3.9990 | 53.227 | 0.074 | 208.55 | 13.25 | 0.012 |
| ### | May 8, 2012 | 1:05:36 PM | 13.26 | 3.999 | 14.4623 | 3.315 | 53.027 | 0.074 | 207.90 | 13.310 | 3.9990 | 53.227 | 0.074 | 208.62 | 13.25 | 0.007 |
| ### | May 8, 2012 | 1:05:41 PM | 13.26 | 4.000 | 14.4678 | 3.315 | 53.040 | 0.074 | 207.97 | 13.310 | 4.0000 | 53.240 | 0.074 | 208.69 | 13.26 | 0.003 |
| ### | May 8, 2012 | 1:05:46 PM | 13.26 | 3.999 | 14.4734 | 3.315 | 53.027 | 0.074 | 208.04 | 13.310 | 3.9990 | 53.227 | 0.074 | 208.77 | 13.26 | 0.004 |
| ### | May 8, 2012 | 1:05:51 PM | 13.26 | 3.999 | 14.4789 | 3.315 | 53.027 | 0.074 | 208.12 | 13.310 | 3.9990 | 53.227 | 0.074 | 208.84 | 13.26 | 0.005 |
| ### | May 8, 2012 | 1:05:56 PM | 13.25 | 3.999 | 14.4845 | 3.313 | 52.987 | 0.074 | 208.19 | 13.300 | 3.9990 | 53.187 | 0.074 | 208.92 | 13.25 | −0.005 |
| ### | May 8, 2012 | 1:06:01 PM | 13.25 | 3.999 | 14.4900 | 3.313 | 52.987 | 0.074 | 208.26 | 13.300 | 3.9990 | 53.187 | 0.074 | 208.99 | 13.25 | −0.004 |
| ### | May 8, 2012 | 1:06:06 PM | 13.25 | 3.999 | 14.4956 | 3.313 | 52.987 | 0.074 | 208.34 | 13.300 | 3.9990 | 53.187 | 0.074 | 209.06 | 13.25 | −0.003 |
| ### | May 8, 2012 | 1:06:11 PM | 13.25 | 3.999 | 14.5011 | 3.313 | 52.987 | 0.074 | 208.41 | 13.300 | 3.9990 | 53.187 | 0.074 | 209.14 | 13.25 | −0.002 |
| ### | May 8, 2012 | 1:06:16 PM | 13.25 | 3.999 | 14.5067 | 3.313 | 52.987 | 0.074 | 208.49 | 13.300 | 3.9990 | 53.187 | 0.074 | 209.21 | 13.25 | 0.000 |
| ### | May 8, 2012 | 1:06:21 PM | 13.25 | 3.999 | 14.5122 | 3.313 | 52.987 | 0.074 | 208.56 | 13.300 | 3.9990 | 53.187 | 0.074 | 209.29 | 13.25 | 0.002 |
| ### | May 8, 2012 | 1:06:26 PM | 13.25 | 3.999 | 14.5178 | 3.313 | 52.987 | 0.074 | 208.63 | 13.300 | 3.9990 | 53.187 | 0.074 | 209.36 | 13.25 | 0.003 |
| ### | May 8, 2012 | 1:06:31 PM | 13.25 | 3.999 | 14.5233 | 3.313 | 52.987 | 0.074 | 208.71 | 13.300 | 3.9990 | 53.187 | 0.074 | 209.43 | 13.25 | 0.004 |
| ### | May 8, 2012 | 1:06:36 PM | 13.25 | 3.999 | 14.5288 | 3.313 | 52.987 | 0.074 | 208.78 | 13.300 | 3.9990 | 53.187 | 0.074 | 209.51 | 13.25 | 0.005 |
| ### | May 8, 2012 | 1:06:41 PM | 13.24 | 3.999 | 14.5344 | 3.310 | 52.947 | 0.074 | 208.85 | 13.290 | 3.9990 | 53.147 | 0.074 | 209.58 | 13.24 | −0.005 |
| ### | May 8, 2012 | 1:06:46 PM | 13.24 | 3.999 | 14.5399 | 3.310 | 52.947 | 0.074 | 208.93 | 13.290 | 3.9990 | 53.147 | 0.074 | 209.65 | 13.24 | −0.004 |
| ### | May 8, 2012 | 1:06:51 PM | 13.24 | 3.999 | 14.5455 | 3.310 | 52.947 | 0.074 | 209.00 | 13.290 | 3.9990 | 53.147 | 0.074 | 209.73 | 13.24 | −0.003 |
| ### | May 8, 2012 | 1:06:56 PM | 13.24 | 3.999 | 14.5510 | 3.310 | 52.947 | 0.074 | 209.07 | 13.290 | 3.9990 | 53.147 | 0.074 | 209.80 | 13.24 | −0.002 |
| ### | May 8, 2012 | 1:07:01 PM | 13.24 | 3.999 | 14.5566 | 3.310 | 52.947 | 0.074 | 209.15 | 13.290 | 3.9990 | 53.147 | 0.074 | 209.88 | 13.24 | −0.001 |
| ### | May 8, 2012 | 1:07:06 PM | 13.24 | 3.999 | 14.5621 | 3.310 | 52.947 | 0.074 | 209.22 | 13.290 | 3.9990 | 53.147 | 0.074 | 209.95 | 13.24 | 0.001 |
| ### | May 8, 2012 | 1:07:11 PM | 13.24 | 3.999 | 14.5677 | 3.310 | 52.947 | 0.074 | 209.29 | 13.290 | 3.9990 | 53.147 | 0.074 | 210.02 | 13.24 | 0.002 |
| ### | May 8, 2012 | 1:07:16 PM | 13.24 | 3.999 | 14.5732 | 3.310 | 52.947 | 0.074 | 209.37 | 13.290 | 3.9990 | 53.147 | 0.074 | 210.10 | 13.24 | 0.003 |
| ### | May 8, 2012 | 1:07:21 PM | 13.24 | 3.999 | 14.5788 | 3.310 | 52.947 | 0.074 | 209.44 | 13.290 | 3.9990 | 53.147 | 0.074 | 210.17 | 13.24 | 0.004 |
| ### | May 8, 2012 | 1:07:26 PM | 13.24 | 3.999 | 14.5840 | 3.310 | 52.947 | 0.074 | 209.52 | 13.290 | 3.9990 | 53.147 | 0.074 | 210.25 | 13.24 | 0.005 |
| ### | May 8, 2012 | 1:07:31 PM | 13.23 | 3.999 | 14.5899 | 3.308 | 52.907 | 0.073 | 209.59 | 13.280 | 3.9990 | 53.107 | 0.074 | 210.32 | 13.23 | −0.005 |
| ### | May 8, 2012 | 1:07:36 PM | 13.23 | 3.999 | 14.5954 | 3.308 | 52.907 | 0.073 | 209.66 | 13.280 | 3.9990 | 53.107 | 0.074 | 210.39 | 13.23 | −0.004 |
| ### | May 8, 2012 | 1:07:41 PM | 13.23 | 3.999 | 14.6010 | 3.308 | 52.907 | 0.073 | 209.74 | 13.280 | 3.9990 | 53.107 | 0.074 | 210.47 | 13.23 | −0.003 |
| ### | May 8, 2012 | 1:07:46 PM | 13.23 | 3.999 | 14.6065 | 3.308 | 52.907 | 0.073 | 209.81 | 13.280 | 3.9990 | 53.107 | 0.074 | 210.54 | 13.23 | −0.002 |
| ### | May 8, 2012 | 1:07:51 PM | 13.23 | 3.999 | 14.6120 | 3.308 | 52.907 | 0.073 | 209.88 | 13.280 | 3.9990 | 53.107 | 0.074 | 210.61 | 13.23 | −0.001 |
| ### | May 8, 2012 | 1:07:56 PM | 13.23 | 3.999 | 14.6176 | 3.308 | 52.907 | 0.073 | 209.96 | 13.280 | 3.9990 | 53.107 | 0.074 | 210.69 | 13.23 | 0.000 |
| ### | May 8, 2012 | 1:08:01 PM | 13.23 | 3.999 | 14.6228 | 3.308 | 52.907 | 0.073 | 210.03 | 13.280 | 3.9990 | 53.107 | 0.074 | 210.76 | 13.23 | 0.000 |
| ### | May 8, 2012 | 1:08:06 PM | 13.23 | 3.999 | 14.6287 | 3.308 | 52.907 | 0.073 | 210.10 | 13.280 | 3.9990 | 53.107 | 0.074 | 210.84 | 13.23 | 0.000 |
| ### | May 8, 2012 | 1:08:11 PM | 13.23 | 3.999 | 14.6342 | 3.308 | 52.907 | 0.073 | 210.18 | 13.280 | 3.9990 | 53.107 | 0.074 | 210.91 | 13.23 | 0.001 |
| ### | May 8, 2012 | 1:08:16 PM | 13.23 | 3.999 | 14.6398 | 3.308 | 52.907 | 0.073 | 210.25 | 13.280 | 3.9990 | 53.107 | 0.074 | 210.98 | 13.23 | 0.002 |
| ### | May 8, 2012 | 1:08:21 PM | 13.23 | 3.999 | 14.6453 | 3.308 | 52.907 | 0.073 | 210.32 | 13.280 | 3.9990 | 53.107 | 0.074 | 211.06 | 13.23 | 0.003 |
| ### | May 8, 2012 | 1:08:26 PM | 13.23 | 3.999 | 14.6509 | 3.308 | 52.907 | 0.073 | 210.40 | 13.280 | 3.9990 | 53.107 | 0.074 | 211.13 | 13.23 | 0.004 |
| ### | May 8, 2012 | 1:08:31 PM | 13.23 | 4.000 | 14.6564 | 3.308 | 52.920 | 0.074 | 210.47 | 13.280 | 4.0000 | 53.120 | 0.074 | 211.20 | 13.23 | 0.005 |
| ### | May 8, 2012 | 1:08:36 PM | 13.22 | 3.999 | 14.6619 | 3.305 | 52.867 | 0.073 | 210.54 | 13.270 | 3.9990 | 53.067 | 0.074 | 211.28 | 13.22 | −0.005 |
| ### | May 8, 2012 | 1:08:41 PM | 13.22 | 4.000 | 14.6675 | 3.305 | 52.880 | 0.073 | 210.62 | 13.270 | 4.0000 | 53.080 | 0.074 | 211.35 | 13.22 | −0.003 |
| ### | May 8, 2012 | 1:08:46 PM | 13.22 | 3.999 | 14.6730 | 3.305 | 52.867 | 0.073 | 210.69 | 13.270 | 3.9990 | 53.067 | 0.074 | 211.43 | 13.22 | −0.002 |
| ### | May 8, 2012 | 1:08:51 PM | 13.22 | 3.999 | 14.6786 | 3.305 | 52.867 | 0.073 | 210.76 | 13.270 | 3.9990 | 53.067 | 0.074 | 211.50 | 13.22 | 0.000 |
| ### | May 8, 2012 | 1:08:56 PM | 13.22 | 3.999 | 14.6842 | 3.305 | 52.867 | 0.073 | 210.84 | 13.270 | 3.9990 | 53.067 | 0.074 | 211.57 | 13.22 | 0.002 |
| ### | May 8, 2012 | 1:09:01 PM | 13.22 | 3.999 | 14.6897 | 3.305 | 52.867 | 0.073 | 210.91 | 13.270 | 3.9990 | 53.067 | 0.074 | 211.65 | 13.22 | 0.004 |
| ### | May 8, 2012 | 1:09:06 PM | 13.21 | 3.999 | 14.6952 | 3.303 | 52.827 | 0.073 | 210.98 | 13.260 | 3.9990 | 53.027 | 0.074 | 211.72 | 13.21 | −0.005 |
| ### | May 8, 2012 | 1:09:11 PM | 13.22 | 3.999 | 14.7008 | 3.305 | 52.867 | 0.073 | 211.06 | 13.270 | 3.9990 | 53.067 | 0.074 | 211.79 | 13.21 | 0.008 |
| ### | May 8, 2012 | 1:09:16 PM | 13.21 | 3.999 | 14.7063 | 3.303 | 52.827 | 0.073 | 211.13 | 13.260 | 3.9990 | 53.027 | 0.074 | 211.87 | 13.21 | 0.001 |
| ### | May 8, 2012 | 1:09:21 PM | 13.21 | 3.999 | 14.7115 | 3.303 | 52.827 | 0.073 | 211.20 | 13.260 | 3.9990 | 53.027 | 0.074 | 211.94 | 13.21 | 0.005 |
| ### | May 8, 2012 | 1:09:26 PM | 13.21 | 3.999 | 14.7174 | 3.303 | 52.827 | 0.073 | 211.28 | 13.260 | 3.9990 | 53.027 | 0.074 | 212.01 | 13.20 | 0.005 |
| ### | May 8, 2012 | 1:09:31 PM | 13.20 | 3.999 | 14.7230 | 3.300 | 52.787 | 0.073 | 211.35 | 13.250 | 3.9990 | 52.987 | 0.074 | 212.09 | 13.20 | −0.004 |
| ### | May 8, 2012 | 1:09:36 PM | 13.19 | 3.999 | 14.7285 | 3.298 | 52.747 | 0.073 | 211.42 | 13.240 | 3.9990 | 52.947 | 0.074 | 212.16 | 13.20 | −0.014 |
| ### | May 8, 2012 | 1:09:41 PM | 13.19 | 3.999 | 14.7341 | 3.298 | 52.747 | 0.073 | 211.50 | 13.240 | 3.9990 | 52.947 | 0.074 | 212.24 | 13.20 | −0.013 |
| ### | May 8, 2012 | 1:09:46 PM | 13.18 | 3.999 | 14.7396 | 3.295 | 52.707 | 0.073 | 211.57 | 13.230 | 3.9990 | 52.907 | 0.073 | 212.31 | 13.20 | −0.022 |
| ### | May 8, 2012 | 1:09:51 PM | 13.21 | 3.999 | 14.7451 | 3.303 | 52.827 | 0.073 | 211.64 | 13.260 | 3.9990 | 53.027 | 0.074 | 212.38 | 13.20 | 0.009 |
| ### | May 8, 2012 | 1:09:56 PM | 13.21 | 3.999 | 14.7507 | 3.303 | 52.827 | 0.073 | 211.72 | 13.260 | 3.9990 | 53.027 | 0.074 | 212.46 | 13.20 | 0.010 |
| ### | May 8, 2012 | 1:10:01 PM | 13.21 | 3.999 | 14.7562 | 3.303 | 52.827 | 0.073 | 211.79 | 13.260 | 3.9990 | 53.027 | 0.074 | 212.53 | 13.20 | 0.010 |
| ### | May 8, 2012 | 1:10:06 PM | 13.21 | 3.999 | 14.7615 | 3.303 | 52.827 | 0.073 | 211.86 | 13.260 | 3.9990 | 53.027 | 0.074 | 212.60 | 13.20 | 0.009 |
| ### | May 8, 2012 | 1:10:11 PM | 13.20 | 3.999 | 14.7673 | 3.300 | 52.787 | 0.073 | 211.94 | 13.250 | 3.9990 | 52.987 | 0.074 | 212.68 | 13.20 | −0.002 |
| ### | May 8, 2012 | 1:10:16 PM | 13.20 | 3.999 | 14.7729 | 3.300 | 52.787 | 0.073 | 212.01 | 13.250 | 3.9990 | 52.987 | 0.074 | 212.75 | 13.20 | −0.004 |
| ### | May 8, 2012 | 1:10:21 PM | 13.20 | 3.999 | 14.7784 | 3.300 | 52.787 | 0.073 | 212.08 | 13.250 | 3.9990 | 52.987 | 0.074 | 212.82 | 13.20 | −0.003 |
| ### | May 8, 2012 | 1:10:26 PM | 13.20 | 3.999 | 14.7840 | 3.300 | 52.787 | 0.073 | 212.16 | 13.250 | 3.9990 | 52.987 | 0.074 | 212.90 | 13.20 | −0.002 |
| ### | May 8, 2012 | 1:10:31 PM | 13.20 | 3.999 | 14.7895 | 3.300 | 52.787 | 0.073 | 212.23 | 13.250 | 3.9990 | 52.987 | 0.074 | 212.97 | 13.20 | −0.001 |
| ### | May 8, 2012 | 1:10:36 PM | 13.20 | 3.999 | 14.7951 | 3.300 | 52.787 | 0.073 | 212.30 | 13.250 | 3.9990 | 52.987 | 0.074 | 213.05 | 13.20 | 0.000 |
| ### | May 8, 2012 | 1:10:41 PM | 13.20 | 3.999 | 14.8003 | 3.300 | 52.787 | 0.073 | 212.38 | 13.250 | 3.9990 | 52.987 | 0.074 | 213.12 | 13.20 | 0.001 |
| ### | May 8, 2012 | 1:10:46 PM | 13.20 | 4.000 | 14.8061 | 3.300 | 52.800 | 0.073 | 212.45 | 13.250 | 4.0000 | 53.000 | 0.074 | 213.19 | 13.20 | 0.002 |
| ### | May 8, 2012 | 1:10:51 PM | 13.20 | 3.999 | 14.8117 | 3.300 | 52.787 | 0.073 | 212.52 | 13.250 | 3.9990 | 52.987 | 0.074 | 213.27 | 13.20 | 0.003 |
| ### | May 8, 2012 | 1:10:56 PM | 13.20 | 3.999 | 14.8172 | 3.300 | 52.787 | 0.073 | 212.60 | 13.250 | 3.9990 | 52.987 | 0.074 | 213.34 | 13.20 | 0.005 |
| ### | May 8, 2012 | 1:11:01 PM | 13.20 | 3.999 | 14.8228 | 3.300 | 52.787 | 0.073 | 212.67 | 13.250 | 3.9990 | 52.987 | 0.074 | 213.41 | 13.19 | 0.006 |
| ### | May 8, 2012 | 1:11:06 PM | 13.19 | 3.999 | 14.8283 | 3.298 | 52.747 | 0.073 | 212.74 | 13.240 | 3.9990 | 52.947 | 0.074 | 213.49 | 13.19 | −0.002 |
| ### | May 8, 2012 | 1:11:11 PM | 13.19 | 3.999 | 14.8339 | 3.298 | 52.747 | 0.073 | 212.82 | 13.240 | 3.9990 | 52.947 | 0.074 | 213.56 | 13.19 | 0.000 |
| ### | May 8, 2012 | 1:11:16 PM | 13.19 | 3.999 | 14.8391 | 3.298 | 52.747 | 0.073 | 212.89 | 13.240 | 3.9990 | 52.947 | 0.074 | 213.63 | 13.19 | 0.002 |
| ### | May 8, 2012 | 1:11:21 PM | 13.18 | 3.999 | 14.8450 | 3.295 | 52.707 | 0.073 | 212.96 | 13.230 | 3.9990 | 52.907 | 0.073 | 213.71 | 13.19 | −0.006 |
| ### | May 8, 2012 | 1:11:26 PM | 13.18 | 3.999 | 14.8505 | 3.295 | 52.707 | 0.073 | 213.04 | 13.230 | 3.9990 | 52.907 | 0.073 | 213.78 | 13.18 | −0.005 |
| ### | May 8, 2012 | 1:11:31 PM | 13.18 | 3.999 | 14.8561 | 3.295 | 52.707 | 0.073 | 213.11 | 13.230 | 3.9990 | 52.907 | 0.073 | 213.85 | 13.18 | −0.003 |
| ### | May 8, 2012 | 1:11:36 PM | 13.18 | 3.999 | 14.8616 | 3.295 | 52.707 | 0.073 | 213.18 | 13.230 | 3.9990 | 52.907 | 0.073 | 213.93 | 13.18 | −0.002 |
| ### | May 8, 2012 | 1:11:41 PM | 13.18 | 3.999 | 14.8671 | 3.295 | 52.707 | 0.073 | 213.26 | 13.230 | 3.9990 | 52.907 | 0.073 | 214.00 | 13.18 | 0.000 |
| ### | May 8, 2012 | 1:11:46 PM | 13.18 | 3.999 | 14.8727 | 3.295 | 52.707 | 0.073 | 213.33 | 13.230 | 3.9990 | 52.907 | 0.073 | 214.07 | 13.18 | 0.001 |
| ### | May 8, 2012 | 1:11:51 PM | 13.18 | 3.999 | 14.8779 | 3.295 | 52.707 | 0.073 | 213.40 | 13.230 | 3.9990 | 52.907 | 0.073 | 214.15 | 13.18 | 0.002 |
| ### | May 8, 2012 | 1:11:56 PM | 13.18 | 3.999 | 14.8838 | 3.295 | 52.707 | 0.073 | 213.48 | 13.230 | 3.9990 | 52.907 | 0.073 | 214.22 | 13.18 | 0.003 |
| ### | May 8, 2012 | 1:12:01 PM | 13.18 | 3.999 | 14.8893 | 3.295 | 52.707 | 0.073 | 213.55 | 13.230 | 3.9990 | 52.907 | 0.073 | 214.30 | 13.18 | 0.004 |
| ### | May 8, 2012 | 1:12:06 PM | 13.17 | 3.999 | 14.8949 | 3.293 | 52.667 | 0.073 | 213.62 | 13.220 | 3.9990 | 52.867 | 0.073 | 214.37 | 13.18 | −0.006 |
| ### | May 8, 2012 | 1:12:11 PM | 13.18 | 3.999 | 14.9004 | 3.295 | 52.707 | 0.073 | 213.70 | 13.230 | 3.9990 | 52.907 | 0.073 | 214.44 | 13.18 | 0.004 |
| ### | May 8, 2012 | 1:12:16 PM | 13.17 | 3.999 | 14.9060 | 3.293 | 52.667 | 0.073 | 213.77 | 13.220 | 3.9990 | 52.867 | 0.073 | 214.52 | 13.18 | −0.006 |
| ### | May 8, 2012 | 1:12:21 PM | 13.17 | 3.999 | 14.9111 | 3.293 | 52.667 | 0.073 | 213.84 | 13.220 | 3.9990 | 52.867 | 0.073 | 214.59 | 13.18 | −0.006 |
| ### | May 8, 2012 | 1:12:26 PM | 13.17 | 3.999 | 14.9167 | 3.293 | 52.667 | 0.073 | 213.92 | 13.220 | 3.9990 | 52.867 | 0.073 | 214.66 | 13.18 | −0.006 |
| ### | May 8, 2012 | 1:12:31 PM | 13.18 | 3.999 | 14.9223 | 3.295 | 52.707 | 0.073 | 213.99 | 13.230 | 3.9990 | 52.907 | 0.073 | 214.74 | 13.18 | 0.005 |
| ### | May 8, 2012 | 1:12:36 PM | 13.18 | 3.999 | 14.9278 | 3.295 | 52.707 | 0.073 | 214.06 | 13.230 | 3.9990 | 52.907 | 0.073 | 214.81 | 13.18 | 0.005 |
| ### | May 8, 2012 | 1:12:41 PM | 13.18 | 3.999 | 14.9333 | 3.295 | 52.707 | 0.073 | 214.13 | 13.230 | 3.9990 | 52.907 | 0.073 | 214.88 | 13.17 | 0.006 |
| ### | May 8, 2012 | 1:12:46 PM | 13.18 | 3.999 | 14.9392 | 3.295 | 52.707 | 0.073 | 214.21 | 13.230 | 3.9990 | 52.907 | 0.073 | 214.96 | 13.17 | 0.007 |
| ### | May 8, 2012 | 1:12:51 PM | 13.18 | 3.999 | 14.9448 | 3.295 | 52.707 | 0.073 | 214.28 | 13.230 | 3.9990 | 52.907 | 0.073 | 215.03 | 13.17 | 0.008 |
| ### | May 8, 2012 | 1:12:56 PM | 13.17 | 3.999 | 14.9503 | 3.293 | 52.667 | 0.073 | 214.35 | 13.220 | 3.9990 | 52.867 | 0.073 | 215.10 | 13.17 | 0.000 |
| ### | May 8, 2012 | 1:13:01 PM | 13.17 | 3.999 | 14.9558 | 3.293 | 52.667 | 0.073 | 214.43 | 13.220 | 3.9990 | 52.867 | 0.073 | 215.18 | 13.17 | 0.004 |
| ### | May 8, 2012 | 1:13:06 PM | 13.16 | 3.999 | 14.9610 | 3.290 | 52.627 | 0.073 | 214.50 | 13.210 | 3.9990 | 52.827 | 0.073 | 215.25 | 13.16 | −0.003 |
| ### | May 8, 2012 | 1:13:11 PM | 13.16 | 3.999 | 14.9669 | 3.290 | 52.627 | 0.073 | 214.57 | 13.210 | 3.9990 | 52.827 | 0.073 | 215.32 | 13.16 | 0.000 |
| ### | May 8, 2012 | 1:13:16 PM | 13.16 | 3.999 | 14.9725 | 3.290 | 52.627 | 0.073 | 214.65 | 13.210 | 3.9990 | 52.827 | 0.073 | 215.40 | 13.16 | 0.003 |
| ### | May 8, 2012 | 1:13:21 PM | 13.15 | 3.999 | 14.9780 | 3.288 | 52.587 | 0.073 | 214.72 | 13.200 | 3.9990 | 52.787 | 0.073 | 215.47 | 13.15 | −0.005 |
| ### | May 8, 2012 | 1:13:26 PM | 13.14 | 3.999 | 14.9834 | 3.285 | 52.547 | 0.073 | 214.79 | 13.190 | 3.9990 | 52.747 | 0.073 | 215.54 | 13.15 | −0.011 |
| ### | May 8, 2012 | 1:13:31 PM | 13.14 | 3.999 | 14.9890 | 3.285 | 52.547 | 0.073 | 214.87 | 13.190 | 3.9990 | 52.747 | 0.073 | 215.62 | 13.15 | −0.007 |
| ### | May 8, 2012 | 1:13:36 PM | 13.15 | 3.999 | 14.9945 | 3.288 | 52.587 | 0.073 | 214.94 | 13.200 | 3.9990 | 52.787 | 0.073 | 215.69 | 13.14 | 0.005 |
| ### | May 8, 2012 | 1:13:41 PM | 13.15 | 3.999 | 15.0000 | 3.288 | 52.587 | 0.073 | 215.01 | 13.200 | 3.9990 | 52.787 | 0.073 | 215.76 | 13.14 | 0.008 |
| ### | May 8, 2012 | 1:13:46 PM | 13.15 | 3.999 | 15.0056 | 3.288 | 52.587 | 0.073 | 215.08 | 13.200 | 3.9990 | 52.787 | 0.073 | 215.84 | 13.14 | 0.012 |
| ### | May 8, 2012 | 1:13:51 PM | 13.13 | 3.999 | 15.0111 | 3.283 | 52.507 | 0.073 | 215.16 | 13.180 | 3.9990 | 52.707 | 0.073 | 215.91 | 13.14 | −0.005 |
| ### | May 8, 2012 | 1:13:56 PM | 13.13 | 3.999 | 15.0167 | 3.283 | 52.507 | 0.073 | 215.23 | 13.180 | 3.9990 | 52.707 | 0.073 | 215.98 | 13.14 | −0.008 |
| ### | May 8, 2012 | 1:14:01 PM | 13.13 | 3.999 | 15.0222 | 3.283 | 52.507 | 0.073 | 215.30 | 13.180 | 3.9990 | 52.707 | 0.073 | 216.06 | 13.14 | −0.010 |
| ### | May 8, 2012 | 1:14:06 PM | 13.13 | 3.999 | 15.0278 | 3.283 | 52.507 | 0.073 | 215.38 | 13.180 | 3.9990 | 52.707 | 0.073 | 216.13 | 13.14 | −0.012 |
| ### | May 8, 2012 | 1:14:11 PM | 13.12 | 3.999 | 15.0333 | 3.280 | 52.467 | 0.073 | 215.45 | 13.170 | 3.9990 | 52.667 | 0.073 | 216.20 | 13.14 | −0.025 |
| ### | May 8, 2012 | 1:14:16 PM | 13.12 | 3.999 | 15.0388 | 3.280 | 52.467 | 0.073 | 215.52 | 13.170 | 3.9990 | 52.667 | 0.073 | 216.28 | 13.15 | −0.026 |
| ### | May 8, 2012 | 1:14:21 PM | 13.17 | 3.999 | 15.0444 | 3.293 | 52.667 | 0.073 | 215.60 | 13.220 | 3.9990 | 52.867 | 0.073 | 216.35 | 13.15 | 0.020 |
| ### | May 8, 2012 | 1:14:26 PM | 13.16 | 3.999 | 15.0499 | 3.290 | 52.627 | 0.073 | 215.67 | 13.210 | 3.9990 | 52.827 | 0.073 | 216.42 | 13.15 | 0.009 |
| ### | May 8, 2012 | 1:14:31 PM | 13.17 | 3.999 | 15.0556 | 3.293 | 52.667 | 0.073 | 215.74 | 13.220 | 3.9990 | 52.867 | 0.073 | 216.50 | 13.15 | 0.016 |
| ### | May 8, 2012 | 1:14:36 PM | 13.18 | 3.999 | 15.0612 | 3.295 | 52.707 | 0.073 | 215.82 | 13.230 | 3.9990 | 52.907 | 0.073 | 216.57 | 13.15 | 0.027 |
| ### | May 8, 2012 | 1:14:41 PM | 13.17 | 3.999 | 15.0667 | 3.293 | 52.667 | 0.073 | 215.89 | 13.220 | 3.9990 | 52.867 | 0.073 | 216.64 | 13.16 | 0.014 |
| ### | May 8, 2012 | 1:14:46 PM | 13.17 | 3.999 | 15.0723 | 3.293 | 52.667 | 0.073 | 215.96 | 13.220 | 3.9990 | 52.867 | 0.073 | 216.72 | 13.16 | 0.011 |
| ### | May 8, 2012 | 1:14:51 PM | 13.14 | 3.999 | 15.0778 | 3.285 | 52.547 | 0.073 | 216.03 | 13.190 | 3.9990 | 52.747 | 0.073 | 216.79 | 13.16 | −0.016 |
| ### | May 8, 2012 | 1:14:56 PM | 13.16 | 3.999 | 15.0834 | 3.290 | 52.627 | 0.073 | 216.11 | 13.210 | 3.9990 | 52.827 | 0.073 | 216.86 | 13.16 | 0.004 |
| ### | May 8, 2012 | 1:15:01 PM | 13.12 | 3.999 | 15.0889 | 3.280 | 52.467 | 0.073 | 216.18 | 13.170 | 3.9990 | 52.667 | 0.073 | 216.94 | 13.15 | −0.035 |
| ### | May 8, 2012 | 1:15:06 PM | 13.16 | 3.999 | 15.0944 | 3.290 | 52.627 | 0.073 | 216.25 | 13.210 | 3.9990 | 52.827 | 0.073 | 217.01 | 13.15 | 0.010 |
| ### | May 8, 2012 | 1:15:11 PM | 13.15 | 3.999 | 15.1000 | 3.288 | 52.587 | 0.073 | 216.33 | 13.200 | 3.9990 | 52.787 | 0.073 | 217.08 | 13.14 | 0.006 |
| ### | May 8, 2012 | 1:15:16 PM | 13.14 | 3.999 | 15.1055 | 3.285 | 52.547 | 0.073 | 216.40 | 13.190 | 3.9990 | 52.747 | 0.073 | 217.16 | 13.14 | 0.001 |
| ### | May 8, 2012 | 1:15:21 PM | 13.16 | 3.999 | 15.1111 | 3.290 | 52.627 | 0.073 | 216.47 | 13.210 | 3.9990 | 52.827 | 0.073 | 217.23 | 13.14 | 0.020 |
| ### | May 8, 2012 | 1:15:26 PM | 13.15 | 3.999 | 15.1166 | 3.288 | 52.587 | 0.073 | 216.55 | 13.200 | 3.9990 | 52.787 | 0.073 | 217.30 | 13.14 | 0.011 |
| ### | May 8, 2012 | 1:15:31 PM | 13.13 | 3.999 | 15.1222 | 3.283 | 52.507 | 0.073 | 216.62 | 13.180 | 3.9990 | 52.707 | 0.073 | 217.38 | 13.14 | −0.011 |
| ### | May 8, 2012 | 1:15:36 PM | 13.10 | 3.999 | 15.1277 | 3.275 | 52.387 | 0.073 | 216.69 | 13.150 | 3.9990 | 52.587 | 0.073 | 217.45 | 13.14 | −0.040 |
| ### | May 8, 2012 | 1:15:41 PM | 13.12 | 3.999 | 15.1329 | 3.280 | 52.467 | 0.073 | 216.76 | 13.170 | 3.9990 | 52.667 | 0.073 | 217.52 | 13.14 | −0.020 |
| ### | May 8, 2012 | 1:15:46 PM | 13.15 | 3.999 | 15.1385 | 3.288 | 52.587 | 0.073 | 216.84 | 13.200 | 3.9990 | 52.787 | 0.073 | 217.60 | 13.14 | 0.011 |
| ### | May 8, 2012 | 1:15:51 PM | 13.15 | 3.999 | 15.1440 | 3.288 | 52.587 | 0.073 | 216.91 | 13.200 | 3.9990 | 52.787 | 0.073 | 217.67 | 13.14 | 0.015 |
| ### | May 8, 2012 | 1:15:56 PM | 13.14 | 3.999 | 15.1496 | 3.285 | 52.547 | 0.073 | 216.98 | 13.190 | 3.9990 | 52.747 | 0.073 | 217.74 | 13.13 | 0.005 |
| ### | May 8, 2012 | 1:16:01 PM | 13.15 | 3.999 | 15.1555 | 3.288 | 52.587 | 0.073 | 217.06 | 13.200 | 3.9990 | 52.787 | 0.073 | 217.82 | 13.13 | 0.016 |
| ### | May 8, 2012 | 1:16:06 PM | 13.15 | 3.999 | 15.1606 | 3.288 | 52.587 | 0.073 | 217.13 | 13.200 | 3.9990 | 52.787 | 0.073 | 217.89 | 13.14 | 0.012 |
| ### | May 8, 2012 | 1:16:11 PM | 13.13 | 3.999 | 15.1662 | 3.283 | 52.507 | 0.073 | 217.20 | 13.180 | 3.9990 | 52.707 | 0.073 | 217.96 | 13.14 | −0.010 |
| ### | May 8, 2012 | 1:16:16 PM | 13.12 | 3.999 | 15.1721 | 3.280 | 52.467 | 0.073 | 217.27 | 13.170 | 3.9990 | 52.667 | 0.073 | 218.03 | 13.14 | −0.017 |
| ### | May 8, 2012 | 1:16:21 PM | 13.14 | 3.999 | 15.1777 | 3.285 | 52.547 | 0.073 | 217.35 | 13.190 | 3.9990 | 52.747 | 0.073 | 218.11 | 13.13 | 0.006 |
| ### | May 8, 2012 | 1:16:26 PM | 13.12 | 3.999 | 15.1832 | 3.280 | 52.467 | 0.073 | 217.42 | 13.170 | 3.9990 | 52.667 | 0.073 | 218.18 | 13.13 | −0.009 |
| ### | May 8, 2012 | 1:16:31 PM | 13.15 | 3.999 | 15.1887 | 3.288 | 52.587 | 0.073 | 217.49 | 13.200 | 3.9990 | 52.787 | 0.073 | 218.25 | 13.12 | 0.027 |
| ### | May 8, 2012 | 1:16:36 PM | 13.14 | 3.999 | 15.1943 | 3.285 | 52.547 | 0.073 | 217.57 | 13.190 | 3.9990 | 52.747 | 0.073 | 218.33 | 13.12 | 0.020 |
| ### | May 8, 2012 | 1:16:41 PM | 13.12 | 3.999 | 15.1998 | 3.280 | 52.467 | 0.073 | 217.64 | 13.170 | 3.9990 | 52.667 | 0.073 | 218.40 | 13.12 | 0.000 |
| ### | May 8, 2012 | 1:16:46 PM | 13.11 | 3.999 | 15.2054 | 3.278 | 52.427 | 0.073 | 217.71 | 13.160 | 3.9990 | 52.627 | 0.073 | 218.47 | 13.12 | −0.011 |
| ### | May 8, 2012 | 1:16:51 PM | 13.09 | 3.999 | 15.2109 | 3.273 | 52.347 | 0.073 | 217.79 | 13.140 | 3.9990 | 52.547 | 0.073 | 218.55 | 13.12 | −0.028 |
| ### | May 8, 2012 | 1:16:56 PM | 13.08 | 3.999 | 15.2165 | 3.270 | 52.307 | 0.073 | 217.86 | 13.130 | 3.9990 | 52.507 | 0.073 | 218.62 | 13.12 | −0.041 |
| ### | May 8, 2012 | 1:17:01 PM | 13.12 | 4.000 | 15.2220 | 3.280 | 52.480 | 0.073 | 217.93 | 13.170 | 4.0000 | 52.680 | 0.073 | 218.69 | 13.12 | −0.001 |
| ### | May 8, 2012 | 1:17:06 PM | 13.13 | 3.999 | 15.2275 | 3.283 | 52.507 | 0.073 | 218.00 | 13.180 | 3.9990 | 52.707 | 0.073 | 218.77 | 13.12 | 0.008 |
| ### | May 8, 2012 | 1:17:11 PM | 13.13 | 3.999 | 15.2331 | 3.283 | 52.507 | 0.073 | 218.08 | 13.180 | 3.9990 | 52.707 | 0.073 | 218.84 | 13.12 | 0.005 |
| ### | May 8, 2012 | 1:17:16 PM | 13.11 | 4.000 | 15.2386 | 3.278 | 52.440 | 0.073 | 218.15 | 13.160 | 4.0000 | 52.640 | 0.073 | 218.91 | 13.13 | −0.018 |
| ### | May 8, 2012 | 1:17:21 PM | 13.15 | 3.999 | 15.2438 | 3.288 | 52.587 | 0.073 | 218.22 | 13.200 | 3.9990 | 52.787 | 0.073 | 218.99 | 13.13 | 0.016 |
| ### | May 8, 2012 | 1:17:26 PM | 13.15 | 4.000 | 15.2497 | 3.288 | 52.600 | 0.073 | 218.30 | 13.200 | 4.0000 | 52.800 | 0.073 | 219.06 | 13.14 | 0.010 |
| ### | May 8, 2012 | 1:17:31 PM | 13.15 | 3.999 | 15.2553 | 3.288 | 52.587 | 0.073 | 218.37 | 13.200 | 3.9990 | 52.787 | 0.073 | 219.13 | 13.14 | 0.007 |
| ### | May 8, 2012 | 1:17:36 PM | 13.15 | 3.999 | 15.2608 | 3.288 | 52.587 | 0.073 | 218.44 | 13.200 | 3.9990 | 52.787 | 0.073 | 219.21 | 13.14 | 0.007 |
| ### | May 8, 2012 | 1:17:41 PM | 13.15 | 3.999 | 15.2664 | 3.288 | 52.587 | 0.073 | 218.51 | 13.200 | 3.9990 | 52.787 | 0.073 | 219.28 | 13.14 | 0.007 |
| ### | May 8, 2012 | 1:17:46 PM | 13.15 | 3.999 | 15.2719 | 3.288 | 52.587 | 0.073 | 218.59 | 13.200 | 3.9990 | 52.787 | 0.073 | 219.35 | 13.14 | 0.007 |
| ### | May 8, 2012 | 1:17:51 PM | 13.15 | 3.999 | 15.2774 | 3.288 | 52.587 | 0.073 | 218.66 | 13.200 | 3.9990 | 52.787 | 0.073 | 219.43 | 13.14 | 0.012 |
| ### | May 8, 2012 | 1:17:56 PM | 13.15 | 3.999 | 15.2830 | 3.288 | 52.587 | 0.073 | 218.73 | 13.200 | 3.9990 | 52.787 | 0.073 | 219.50 | 13.13 | 0.015 |
| ### | May 8, 2012 | 1:18:01 PM | 13.13 | 3.999 | 15.2885 | 3.283 | 52.507 | 0.073 | 218.81 | 13.180 | 3.9990 | 52.707 | 0.073 | 219.57 | 13.13 | 0.000 |
| ### | May 8, 2012 | 1:18:06 PM | 13.13 | 3.999 | 15.2941 | 3.283 | 52.507 | 0.073 | 218.88 | 13.180 | 3.9990 | 52.707 | 0.073 | 219.65 | 13.13 | 0.004 |
| ### | May 8, 2012 | 1:18:11 PM | 13.11 | 3.999 | 15.2996 | 3.278 | 52.427 | 0.073 | 218.95 | 13.160 | 3.9990 | 52.627 | 0.073 | 219.72 | 13.12 | −0.013 |
| ### | May 8, 2012 | 1:18:16 PM | 13.10 | 3.999 | 15.3048 | 3.275 | 52.387 | 0.073 | 219.03 | 13.150 | 3.9990 | 52.587 | 0.073 | 219.79 | 13.12 | −0.018 |
| ### | May 8, 2012 | 1:18:21 PM | 13.11 | 4.000 | 15.3107 | 3.278 | 52.440 | 0.073 | 219.10 | 13.160 | 4.0000 | 52.640 | 0.073 | 219.86 | 13.11 | −0.003 |
| ### | May 8, 2012 | 1:18:26 PM | 13.10 | 3.999 | 15.3162 | 3.275 | 52.387 | 0.073 | 219.17 | 13.150 | 3.9990 | 52.587 | 0.073 | 219.94 | 13.11 | −0.007 |
| ### | May 8, 2012 | 1:18:31 PM | 13.11 | 3.999 | 15.3218 | 3.278 | 52.427 | 0.073 | 219.24 | 13.160 | 3.9990 | 52.627 | 0.073 | 220.01 | 13.10 | 0.007 |
| ### | May 8, 2012 | 1:18:36 PM | 13.11 | 3.999 | 15.3270 | 3.278 | 52.427 | 0.073 | 219.32 | 13.160 | 3.9990 | 52.627 | 0.073 | 220.08 | 13.10 | 0.011 |
| ### | May 8, 2012 | 1:18:41 PM | 13.10 | 3.999 | 15.3325 | 3.275 | 52.387 | 0.073 | 219.39 | 13.150 | 3.9990 | 52.587 | 0.073 | 220.16 | 13.10 | 0.001 |
| ### | May 8, 2012 | 1:18:46 PM | 13.09 | 3.999 | 15.3381 | 3.273 | 52.347 | 0.073 | 219.46 | 13.140 | 3.9990 | 52.547 | 0.073 | 220.23 | 13.10 | −0.010 |
| ### | May 8, 2012 | 1:18:51 PM | 13.09 | 3.999 | 15.3436 | 3.273 | 52.347 | 0.073 | 219.53 | 13.140 | 3.9990 | 52.547 | 0.073 | 220.30 | 13.10 | −0.010 |
| ### | May 8, 2012 | 1:18:56 PM | 13.08 | 3.999 | 15.3492 | 3.270 | 52.307 | 0.073 | 219.61 | 13.130 | 3.9990 | 52.507 | 0.073 | 220.38 | 13.10 | −0.020 |
| ### | May 8, 2012 | 1:19:01 PM | 13.09 | 3.999 | 15.3547 | 3.273 | 52.347 | 0.073 | 219.68 | 13.140 | 3.9990 | 52.547 | 0.073 | 220.45 | 13.10 | −0.007 |
| ### | May 8, 2012 | 1:19:06 PM | 13.11 | 3.999 | 15.3606 | 3.278 | 52.427 | 0.073 | 219.75 | 13.160 | 3.9990 | 52.627 | 0.073 | 220.52 | 13.09 | 0.015 |
| ### | May 8, 2012 | 1:19:11 PM | 13.11 | 4.000 | 15.3658 | 3.278 | 52.440 | 0.073 | 219.83 | 13.160 | 4.0000 | 52.640 | 0.073 | 220.60 | 13.10 | 0.014 |
| ### | May 8, 2012 | 1:19:16 PM | 13.11 | 3.999 | 15.3713 | 3.278 | 52.427 | 0.073 | 219.90 | 13.160 | 3.9990 | 52.627 | 0.073 | 220.67 | 13.10 | 0.012 |
| ### | May 8, 2012 | 1:19:21 PM | 13.10 | 3.999 | 15.3772 | 3.275 | 52.387 | 0.073 | 219.97 | 13.150 | 3.9990 | 52.587 | 0.073 | 220.74 | 13.10 | 0.000 |
| ### | May 8, 2012 | 1:19:26 PM | 13.08 | 3.999 | 15.3824 | 3.270 | 52.307 | 0.073 | 220.04 | 13.130 | 3.9990 | 52.507 | 0.073 | 220.81 | 13.10 | −0.022 |
| ### | May 8, 2012 | 1:19:31 PM | 13.08 | 3.999 | 15.3880 | 3.270 | 52.307 | 0.073 | 220.12 | 13.130 | 3.9990 | 52.507 | 0.073 | 220.89 | 13.10 | −0.024 |
| ### | May 8, 2012 | 1:19:36 PM | 13.12 | 3.999 | 15.3939 | 3.280 | 52.467 | 0.073 | 220.19 | 13.170 | 3.9990 | 52.667 | 0.073 | 220.96 | 13.10 | 0.015 |
| ### | May 8, 2012 | 1:19:41 PM | 13.11 | 3.999 | 15.3994 | 3.278 | 52.427 | 0.073 | 220.26 | 13.160 | 3.9990 | 52.627 | 0.073 | 221.03 | 13.10 | 0.006 |
| ### | May 8, 2012 | 1:19:46 PM | 13.11 | 3.999 | 15.4050 | 3.278 | 52.427 | 0.073 | 220.33 | 13.160 | 3.9990 | 52.627 | 0.073 | 221.11 | 13.10 | 0.007 |
| ### | May 8, 2012 | 1:19:51 PM | 13.10 | 3.999 | 15.4105 | 3.275 | 52.387 | 0.073 | 220.41 | 13.150 | 3.9990 | 52.587 | 0.073 | 221.18 | 13.10 | −0.002 |
| ### | May 8, 2012 | 1:19:56 PM | 13.11 | 3.999 | 15.4160 | 3.278 | 52.427 | 0.073 | 220.48 | 13.160 | 3.9990 | 52.627 | 0.073 | 221.25 | 13.10 | 0.009 |
| ### | May 8, 2012 | 1:20:01 PM | 13.12 | 3.999 | 15.4212 | 3.280 | 52.467 | 0.073 | 220.55 | 13.170 | 3.9990 | 52.667 | 0.073 | 221.33 | 13.10 | 0.019 |
| ### | May 8, 2012 | 1:20:06 PM | 13.10 | 3.999 | 15.4271 | 3.275 | 52.387 | 0.073 | 220.63 | 13.150 | 3.9990 | 52.587 | 0.073 | 221.40 | 13.10 | 0.000 |
| ### | May 8, 2012 | 1:20:11 PM | 13.10 | 3.999 | 15.4327 | 3.275 | 52.387 | 0.073 | 220.70 | 13.150 | 3.9990 | 52.587 | 0.073 | 221.47 | 13.10 | 0.000 |
| ### | May 8, 2012 | 1:20:16 PM | 13.09 | 3.999 | 15.4382 | 3.273 | 52.347 | 0.073 | 220.77 | 13.140 | 3.9990 | 52.547 | 0.073 | 221.54 | 13.10 | −0.009 |
| ### | May 8, 2012 | 1:20:21 PM | 13.07 | 3.999 | 15.4438 | 3.268 | 52.267 | 0.073 | 220.84 | 13.120 | 3.9990 | 52.467 | 0.073 | 221.62 | 13.10 | −0.029 |
| ### | May 8, 2012 | 1:20:26 PM | 13.08 | 3.999 | 15.4493 | 3.270 | 52.307 | 0.073 | 220.92 | 13.130 | 3.9990 | 52.507 | 0.073 | 221.69 | 13.10 | −0.016 |
| ### | May 8, 2012 | 1:20:31 PM | 13.11 | 3.999 | 15.4548 | 3.278 | 52.427 | 0.073 | 220.99 | 13.160 | 3.9990 | 52.627 | 0.073 | 221.76 | 13.09 | 0.017 |
| ### | May 8, 2012 | 1:20:36 PM | 13.11 | 3.999 | 15.4600 | 3.278 | 52.427 | 0.073 | 221.06 | 13.160 | 3.9990 | 52.627 | 0.073 | 221.84 | 13.09 | 0.021 |
| ### | May 8, 2012 | 1:20:41 PM | 13.10 | 3.999 | 15.4659 | 3.275 | 52.387 | 0.073 | 221.14 | 13.150 | 3.9990 | 52.587 | 0.073 | 221.91 | 13.09 | 0.014 |
| ### | May 8, 2012 | 1:20:46 PM | 13.10 | 3.999 | 15.4715 | 3.275 | 52.387 | 0.073 | 221.21 | 13.150 | 3.9990 | 52.587 | 0.073 | 221.98 | 13.08 | 0.016 |
| ### | May 8, 2012 | 1:20:51 PM | 13.08 | 3.999 | 15.4770 | 3.270 | 52.307 | 0.073 | 221.28 | 13.130 | 3.9990 | 52.507 | 0.073 | 222.06 | 13.08 | −0.002 |
| ### | May 8, 2012 | 1:20:56 PM | 13.08 | 3.999 | 15.4826 | 3.270 | 52.307 | 0.073 | 221.35 | 13.130 | 3.9990 | 52.507 | 0.073 | 222.13 | 13.08 | −0.002 |
| ### | May 8, 2012 | 1:21:01 PM | 13.06 | 3.999 | 15.4881 | 3.265 | 52.227 | 0.073 | 221.43 | 13.110 | 3.9990 | 52.427 | 0.073 | 222.20 | 13.08 | −0.017 |
| ### | May 8, 2012 | 1:21:06 PM | 13.07 | 3.999 | 15.4936 | 3.268 | 52.267 | 0.073 | 221.50 | 13.120 | 3.9990 | 52.467 | 0.073 | 222.27 | 13.07 | −0.005 |
| ### | May 8, 2012 | 1:21:11 PM | 13.06 | 3.999 | 15.4988 | 3.265 | 52.227 | 0.073 | 221.57 | 13.110 | 3.9990 | 52.427 | 0.073 | 222.35 | 13.07 | −0.013 |
| ### | May 8, 2012 | 1:21:16 PM | 13.05 | 3.999 | 15.5047 | 3.263 | 52.187 | 0.072 | 221.64 | 13.100 | 3.9990 | 52.387 | 0.073 | 222.42 | 13.07 | −0.021 |
| ### | May 8, 2012 | 1:21:21 PM | 13.08 | 4.000 | 15.5103 | 3.270 | 52.320 | 0.073 | 221.72 | 13.130 | 4.0000 | 52.520 | 0.073 | 222.49 | 13.07 | 0.008 |
| ### | May 8, 2012 | 1:21:26 PM | 13.06 | 3.999 | 15.5158 | 3.265 | 52.227 | 0.073 | 221.79 | 13.110 | 3.9990 | 52.427 | 0.073 | 222.57 | 13.07 | −0.011 |
| ### | May 8, 2012 | 1:21:31 PM | 13.08 | 3.999 | 15.5214 | 3.270 | 52.307 | 0.073 | 221.86 | 13.130 | 3.9990 | 52.507 | 0.073 | 222.64 | 13.07 | 0.008 |
| ### | May 8, 2012 | 1:21:36 PM | 13.08 | 3.999 | 15.5269 | 3.270 | 52.307 | 0.073 | 221.93 | 13.130 | 3.9990 | 52.507 | 0.073 | 222.71 | 13.07 | 0.009 |
| ### | May 8, 2012 | 1:21:41 PM | 13.08 | 3.999 | 15.5325 | 3.270 | 52.307 | 0.073 | 222.01 | 13.130 | 3.9990 | 52.507 | 0.073 | 222.78 | 13.07 | 0.011 |
| ### | May 8, 2012 | 1:21:46 PM | 13.09 | 3.999 | 15.5377 | 3.273 | 52.347 | 0.073 | 222.08 | 13.140 | 3.9990 | 52.547 | 0.073 | 222.86 | 13.07 | 0.019 |
| ### | May 8, 2012 | 1:21:51 PM | 13.07 | 3.999 | 15.5435 | 3.268 | 52.267 | 0.073 | 222.15 | 13.120 | 3.9990 | 52.467 | 0.073 | 222.93 | 13.07 | −0.003 |
| ### | May 8, 2012 | 1:21:56 PM | 13.07 | 3.999 | 15.5491 | 3.268 | 52.267 | 0.073 | 222.22 | 13.120 | 3.9990 | 52.467 | 0.073 | 223.00 | 13.08 | −0.006 |
| ### | May 8, 2012 | 1:22:01 PM | 13.06 | 3.999 | 15.5546 | 3.265 | 52. [symbol] | [symbol] | [symbol] | [symbol] | 3.9990 | 52.427 | 0.073 | 223.08 | 13.08 | −0.018 |
| ### | May 8, 2012 | 1:22:06 PM | 13.04 | 3.999 | 15.5602 | 3.260 | 52.147 | 0.072 | 222.37 | 13.090 | 3.9990 | 52.347 | 0.073 | 223.15 | 13.08 | −0.040 |
| ### | May 8, 2012 | 1:22:11 PM | 13.07 | 3.999 | 15.5657 | 3.268 | 52.267 | 0.073 | 222.44 | 13.120 | 3.9990 | 52.467 | 0.073 | 223.22 | 13.08 | −0.011 |
| ### | May 8, 2012 | 1:22:16 PM | 13.10 | 3.999 | 15.5713 | 3.275 | 52.387 | 0.073 | 222.51 | 13.150 | 3.9990 | 52.587 | 0.073 | 223.29 | 13.08 | 0.021 |
| ### | May 8, 2012 | 1:22:21 PM | 13.10 | 3.999 | 15.5765 | 3.275 | 52.387 | 0.073 | 222.59 | 13.150 | 3.9990 | 52.587 | 0.073 | 223.37 | 13.08 | 0.022 |
| ### | May 8, 2012 | 1:22:26 PM | 13.10 | 3.999 | 15.5824 | 3.275 | 52.387 | 0.073 | 222.66 | 13.150 | 3.9990 | 52.587 | 0.073 | 223.44 | 13.08 | 0.025 |
| ### | May 8, 2012 | 1:22:31 PM | 13.10 | 3.999 | 15.5879 | 3.275 | 52.387 | 0.073 | 222.73 | 13.150 | 3.9990 | 52.587 | 0.073 | 223.51 | 13.08 | 0.025 |
| ### | May 8, 2012 | 1:22:36 PM | 13.09 | 3.999 | 15.5934 | 3.273 | 52.347 | 0.073 | 222.81 | 13.140 | 3.9990 | 52.547 | 0.073 | 223.59 | 13.07 | 0.015 |
| ### | May 8, 2012 | 1:22:41 PM | 13.07 | 3.999 | 15.5990 | 3.268 | 52.267 | 0.073 | 222.88 | 13.120 | 3.9990 | 52.467 | 0.073 | 223.66 | 13.07 | −0.001 |
| ### | May 8, 2012 | 1:22:46 PM | 13.06 | 3.999 | 15.6045 | 3.265 | 52.227 | 0.073 | 222.95 | 13.110 | 3.9990 | 52.427 | 0.073 | 223.73 | 13.07 | −0.005 |
| ### | May 8, 2012 | 1:22:51 PM | 13.04 | 3.999 | 15.6101 | 3.260 | 52.147 | 0.072 | 223.02 | 13.090 | 3.9990 | 52.347 | 0.073 | 223.81 | 13.06 | −0.020 |
| ### | May 8, 2012 | 1:22:56 PM | 13.06 | 3.999 | 15.6153 | 3.265 | 52.227 | 0.073 | 223.10 | 13.110 | 3.9990 | 52.427 | 0.073 | 223.88 | 13.05 | 0.006 |
| ### | May 8, 2012 | 1:23:01 PM | 13.03 | 3.999 | 15.6212 | 3.258 | 52.107 | 0.072 | 223.17 | 13.080 | 3.9990 | 52.307 | 0.073 | 223.95 | 13.05 | −0.019 |
| ### | May 8, 2012 | 1:23:06 PM | 13.03 | 3.999 | 15.6267 | 3.258 | 52.107 | 0.072 | 223.24 | 13.080 | 3.9990 | 52.307 | 0.073 | 224.02 | 13.04 | −0.015 |
| ### | May 8, 2012 | 1:23:11 PM | 13.04 | 3.999 | 15.6323 | 3.260 | 52.147 | 0.072 | 223.31 | 13.090 | 3.9990 | 52.347 | 0.073 | 224.10 | 13.04 | −0.005 |
| ### | May 8, 2012 | 1:23:16 PM | 13.04 | 3.999 | 15.6378 | 3.260 | 52.147 | 0.072 | 223.39 | 13.090 | 3.9990 | 52.347 | 0.073 | 224.17 | 13.04 | −0.005 |
| ### | May 8, 2012 | 1:23:21 PM | 13.03 | 3.999 | 15.6433 | 3.258 | 52.107 | 0.072 | 223.46 | 13.080 | 3.9990 | 52.307 | 0.073 | 224.24 | 13.05 | −0.017 |
| ### | May 8, 2012 | 1:23:26 PM | 13.05 | 3.999 | 15.6489 | 3.263 | 52.187 | 0.072 | 223.53 | 13.100 | 3.9990 | 52.387 | 0.073 | 224.31 | 13.05 | 0.004 |
| ### | May 8, 2012 | 1:23:31 PM | 13.04 | 3.999 | 15.6541 | 3.260 | 52.147 | 0.072 | 223.60 | 13.090 | 3.9990 | 52.347 | 0.073 | 224.39 | 13.05 | −0.008 |
| ### | May 8, 2012 | 1:23:36 PM | 13.07 | 3.999 | 15.6600 | 3.268 | 52.267 | 0.073 | 223.68 | 13.120 | 3.9990 | 52.467 | 0.073 | 224.46 | 13.05 | 0.019 |
| ### | May 8, 2012 | 1:23:41 PM | 13.06 | 3.999 | 15.6655 | 3.265 | 52.227 | 0.073 | 223.75 | 13.110 | 3.9990 | 52.427 | 0.073 | 224.53 | 13.05 | 0.007 |
| ### | May 8, 2012 | 1:23:46 PM | 13.07 | 3.999 | 15.6711 | 3.268 | 52.267 | 0.073 | 223.82 | 13.120 | 3.9990 | 52.467 | 0.073 | 224.61 | 13.06 | 0.015 |
| ### | May 8, 2012 | 1:23:51 PM | 13.05 | 3.999 | 15.6766 | 3.263 | 52.187 | 0.072 | 223.89 | 13.100 | 3.9990 | 52.387 | 0.073 | 224.68 | 13.06 | −0.008 |
| ### | May 8, 2012 | 1:23:56 PM | 13.05 | 3.999 | 15.6822 | 3.263 | 52.187 | 0.072 | 223.97 | 13.100 | 3.9990 | 52.387 | 0.073 | 224.75 | 13.06 | −0.008 |
| ### | May 8, 2012 | 1:24:01 PM | 13.06 | 3.999 | 15.6877 | 3.265 | 52.227 | 0.073 | 224.04 | 13.110 | 3.9990 | 52.427 | 0.073 | 224.82 | 13.06 | 0.003 |
| ### | May 8, 2012 | 1:24:06 PM | 13.06 | 3.999 | 15.6932 | 3.265 | 52.227 | 0.073 | 224.11 | 13.110 | 3.9990 | 52.427 | 0.073 | 224.90 | 13.05 | 0.005 |
| ### | May 8, 2012 | 1:24:11 PM | 13.07 | 3.999 | 15.6988 | 3.268 | 52.267 | 0.073 | 224.18 | 13.120 | 3.9990 | 52.467 | 0.073 | 224.97 | 13.05 | 0.021 |
| ### | May 8, 2012 | 1:24:16 PM | 13.06 | 4.000 | 15.7043 | 3.265 | 52.240 | 0.073 | 224.26 | 13.110 | 4.0000 | 52.440 | 0.073 | 225.04 | 13.05 | 0.011 |
| ### | May 8, 2012 | 1:24:21 PM | 13.05 | 3.999 | 15.7099 | 3.263 | 52.187 | 0.072 | 224.33 | 13.100 | 3.9990 | 52.387 | 0.073 | 225.11 | 13.05 | 0.000 |
| ### | May 8, 2012 | 1:24:26 PM | 13.03 | 3.999 | 15.7154 | 3.258 | 52.107 | 0.072 | 224.40 | 13.080 | 3.9990 | 52.307 | 0.073 | 225.19 | 13.05 | −0.019 |
| ### | May 8, 2012 | 1:24:31 PM | 13.04 | 3.999 | 15.7210 | 3.260 | 52.147 | 0.072 | 224.47 | 13.090 | 3.9990 | 52.347 | 0.073 | 225.26 | 13.05 | −0.006 |
| ### | May 8, 2012 | 1:24:36 PM | 13.00 | 3.999 | 15.7265 | 3.250 | 51.987 | 0.072 | 224.55 | 13.050 | 3.9990 | 52.187 | 0.072 | 225.33 | 13.04 | −0.045 |
| ### | May 8, 2012 | 1:24:41 PM | 13.07 | 3.999 | 15.7320 | 3.268 | 52.267 | 0.073 | 224.62 | 13.120 | 3.9990 | 52.467 | 0.073 | 225.41 | 13.04 | 0.029 |
| ### | May 8, 2012 | 1:24:46 PM | 13.06 | 3.999 | 15.7376 | 3.265 | 52.227 | 0.073 | 224.69 | 13.110 | 3.9990 | 52.427 | 0.073 | 225.48 | 13.04 | 0.021 |
| ### | May 8, 2012 | 1:24:51 PM | 13.04 | 4.000 | 15.7431 | 3.260 | 52.147 | 0.072 | 224.76 | 13.090 | 3.9990 | 52.347 | 0.073 | 225.55 | 13.04 | 0.000 |
| ### | May 8, 2012 | 1:24:56 PM | 13.03 | 4.000 | 15.7487 | 3.258 | 52.107 | 0.072 | 224.84 | 13.080 | 3.9990 | 52.307 | 0.073 | 225.62 | 13.04 | −0.008 |
| ### | May 8, 2012 | 1:25:01 PM | 13.04 | 3.999 | 15.7542 | 3.260 | 52.147 | 0.072 | 224.91 | 13.090 | 3.9990 | 52.347 | 0.073 | 225.70 | 13.04 | −0.001 |
| ### | May 8, 2012 | 1:25:06 PM | 13.03 | 3.999 | 15.7598 | 3.258 | 52.107 | 0.072 | 224.98 | 13.080 | 3.9990 | 52.307 | 0.073 | 225.77 | 13.05 | −0.017 |
| ### | May 8, 2012 | 1:25:11 PM | 13.04 | 3.999 | 15.7653 | 3.260 | 52.160 | 0.072 | 225.05 | 13.090 | 4.0000 | 52.360 | 0.073 | 225.84 | 13.05 | −0.006 |
| ### | May 8, 2012 | 1:25:16 PM | 13.06 | 3.999 | 15.7709 | 3.265 | 52.240 | 0.073 | 225.12 | 13.110 | 4.0000 | 52.440 | 0.073 | 225.91 | 13.05 | 0.014 |
| ### | May 8, 2012 | 1:25:21 PM | 13.01 | 3.999 | 15.7764 | 3.253 | 52.027 | 0.072 | 225.20 | 13.060 | 3.9990 | 52.227 | 0.073 | 225.99 | 13.05 | −0.038 |
| ### | May 8, 2012 | 1:25:26 PM | 13.07 | 3.999 | 15.7819 | 3.268 | 52.267 | 0.073 | 225.27 | 13.120 | 3.9990 | 52.467 | 0.073 | 226.06 | 13.05 | 0.020 |
| ### | May 8, 2012 | 1:25:31 PM | 13.07 | 3.999 | 15.7875 | 3.268 | 52.267 | 0.073 | 225.34 | 13.120 | 3.9990 | 52.467 | 0.073 | 226.13 | 13.05 | 0.019 |
| ### | May 8, 2012 | 1:25:36 PM | 13.06 | 3.999 | 15.7930 | 3.265 | 52.227 | 0.073 | 225.41 | 13.110 | 3.9990 | 52.427 | 0.073 | 226.21 | 13.05 | 0.006 |
| ### | May 8, 2012 | 1:25:41 PM | 13.06 | 3.999 | 15.7986 | 3.265 | 52.227 | 0.073 | 225.49 | 13.110 | 3.9990 | 52.427 | 0.073 | 226.28 | 13.05 | 0.012 |
| ### | May 8, 2012 | 1:25:46 PM | 13.06 | 3.999 | 15.8041 | 3.265 | 52.227 | 0.073 | 225.56 | 13.110 | 3.9990 | 52.427 | 0.073 | 226.35 | 13.04 | 0.021 |
| ### | May 8, 2012 | 1:25:51 PM | 13.05 | 4.000 | 15.8097 | 3.263 | 52.200 | 0.073 | 225.63 | 13.100 | 4.0000 | 52.400 | 0.073 | 226.42 | 13.04 | 0.005 |
| ### | May 8, 2012 | 1:25:56 PM | 13.05 | 3.999 | 15.8152 | 3.263 | 52.187 | 0.072 | 225.70 | 13.100 | 3.9990 | 52.387 | 0.073 | 226.50 | 13.04 | 0.008 |
| ### | May 8, 2012 | 1:26:01 PM | 13.06 | 3.999 | 15.8204 | 3.265 | 52.227 | 0.073 | 225.78 | 13.110 | 3.9990 | 52.427 | 0.073 | 226.57 | 13.04 | 0.020 |
| ### | May 8, 2012 | 1:26:06 PM | 13.98 | 3.999 | 15.8263 | 3.245 | 52.907 | 0.072 | 225.85 | 13.030 | 3.9990 | 52.107 | 0.072 | 226.64 | 13.04 | −0.059 |
| ### | May 8, 2012 | 1:26:11 PM | 13.96 | 3.999 | 15.8318 | 3.240 | 52.827 | 0.072 | 225.92 | 13.010 | 3.9990 | 52.027 | 0.072 | 226.71 | 13.04 | −0.079 |
| ### | May 8, 2012 | 1:26:16 PM | 13.07 | 3.999 | 15.8374 | 3.268 | 52.267 | 0.073 | 225.99 | 13.120 | 3.9990 | 52.467 | 0.073 | 226.79 | 13.04 | 0.032 |
| ### | May 8, 2012 | 1:26:21 PM | 13.04 | 3.999 | 15.8429 | 3.260 | 52.147 | 0.072 | 226.07 | 13.090 | 3.9990 | 52.347 | 0.073 | 226.86 | 13.04 | 0.004 |
| ### | May 8, 2012 | 1:26:26 PM | 13.05 | 3.999 | 15.8485 | 3.263 | 52.187 | 0.072 | 226.14 | 13.100 | 3.9990 | 52.387 | 0.073 | 226.93 | 13.03 | 0.016 |
| ### | May 8, 2012 | 1:26:31 PM | 13.05 | 3.999 | 15.8540 | 3.263 | 52.187 | 0.072 | 226.21 | 13.100 | 3.9990 | 52.387 | 0.073 | 227.01 | 13.03 | 0.019 |
| ### | May 8, 2012 | 1:26:36 PM | 13.06 | 3.999 | 15.8596 | 3.265 | 52.227 | 0.073 | 226.28 | 13.110 | 3.9990 | 52.427 | 0.073 | 227.08 | 13.03 | 0.026 |
| ### | May 8, 2012 | 1:26:41 PM | 13.05 | 3.999 | 15.8651 | 3.263 | 52.187 | 0.072 | 226.36 | 13.100 | 3.9990 | 52.387 | 0.073 | 227.15 | 13.04 | 0.014 |
| ### | May 8, 2012 | 1:26:46 PM | 13.03 | 3.999 | 15.8706 | 3.258 | 52.107 | 0.072 | 226.43 | 13.080 | 3.9990 | 52.307 | 0.073 | 227.22 | 13.03 | 0.001 |
| ### | May 8, 2012 | 1:26:51 PM | 13.02 | 3.999 | 15.8762 | 3.255 | 52.067 | 0.072 | 226.50 | 13.070 | 3.9990 | 52.267 | 0.073 | 227.30 | 13.03 | −0.011 |
| ### | May 8, 2012 | 1:26:56 PM | 13.03 | 3.999 | 15.8814 | 3.258 | 52.107 | 0.072 | 226.57 | 13.080 | 3.9990 | 52.307 | 0.073 | 227.37 | 13.03 | 0.000 |
| ### | May 8, 2012 | 1:27:01 PM | 13.01 | 3.999 | 15.8873 | 3.253 | 52.027 | 0.072 | 226.65 | 13.060 | 3.9990 | 52.227 | 0.073 | 227.44 | 13.03 | −0.019 |
| ### | May 8, 2012 | 1:27:06 PM | 13.99 | 3.999 | 15.8928 | 3.248 | 51.947 | 0.072 | 226.72 | 13.040 | 3.9990 | 52.147 | 0.072 | 227.51 | 13.03 | −0.038 |
| ### | May 8, 2012 | 1:27:11 PM | 13.99 | 3.999 | 15.8984 | 3.248 | 51.947 | 0.072 | 226.79 | 13.040 | 3.9990 | 52.147 | 0.072 | 227.59 | 13.03 | −0.037 |
| ### | May 8, 2012 | 1:27:16 PM | 13.06 | 3.999 | 15.9039 | 3.265 | 52.227 | 0.073 | 226.86 | 13.110 | 3.9990 | 52.427 | 0.073 | 227.66 | 13.03 | 0.033 |
| ### | May 8, 2012 | 1:27:21 PM | 13.04 | 3.999 | 15.9095 | 3.260 | 52.147 | 0.072 | 226.94 | 13.090 | 3.9990 | 52.347 | 0.073 | 227.73 | 13.03 | 0.011 |
| ### | May 8, 2012 | 1:27:26 PM | 13.04 | 3.999 | 15.9150 | 3.260 | 52.147 | 0.072 | 227.01 | 13.090 | 3.9990 | 52.347 | 0.073 | 227.80 | 13.03 | 0.010 |
| ### | May 8, 2012 | 1:27:31 PM | 13.05 | 4.000 | 15.9206 | 3.263 | 52.200 | 0.073 | 227.08 | 13.100 | 4.0000 | 52.400 | 0.073 | 227.88 | 13.03 | 0.016 |
| ### | May 8, 2012 | 1:27:36 PM | 13.04 | 4.000 | 15.9261 | 3.260 | 52.160 | 0.072 | 227.15 | 13.090 | 4.0000 | 52.360 | 0.073 | 227.95 | 13.04 | 0.004 |
| ### | May 8, 2012 | 1:27:41 PM | 13.03 | 4.000 | 15.9316 | 3.258 | 52.120 | 0.072 | 227.22 | 13.080 | 4.0000 | 52.320 | 0.073 | 228.02 | 13.04 | −0.009 |
| ### | May 8, 2012 | 1:27:46 PM | 13.04 | 4.000 | 15.9372 | 3.260 | 52.160 | 0.072 | 227.30 | 13.090 | 4.0000 | 52.360 | 0.073 | 228.10 | 13.04 | 0.005 |
| ### | May 8, 2012 | 1:27:51 PM | 13.04 | 3.999 | 15.9424 | 3.260 | 52.147 | 0.072 | 227.37 | 13.090 | 3.9990 | 52.347 | 0.073 | 228.17 | 13.03 | 0.005 |
| ### | May 8, 2012 | 1:27:56 PM | 13.05 | 3.999 | 15.9483 | 3.263 | 52.187 | 0.072 | 227.44 | 13.100 | 3.9990 | 52.387 | 0.073 | 228.24 | 13.03 | 0.017 |
| ### | May 8, 2012 | 1:28:01 PM | 13.02 | 3.999 | 15.9538 | 3.255 | 52.067 | 0.072 | 227.51 | 13.070 | 3.9990 | 52.267 | 0.073 | 228.31 | 13.03 | −0.012 |
| ### | May 8, 2012 | 1:28:06 PM | 13.02 | 3.999 | 15.9594 | 3.255 | 52.067 | 0.072 | 227.59 | 13.070 | 3.9990 | 52.267 | 0.073 | 228.39 | 13.03 | −0.007 |
| ### | May 8, 2012 | 1:28:11 PM | 13.02 | 3.999 | 15.9646 | 3.255 | 52.067 | 0.072 | 227.66 | 13.070 | 3.9990 | 52.267 | 0.073 | 228.46 | 13.03 | −0.005 |
| ### | May 8, 2012 | 1:28:16 PM | 13.03 | 3.999 | 15.9701 | 3.258 | 52.107 | 0.072 | 227.73 | 13.080 | 3.9990 | 52.307 | 0.073 | 228.53 | 13.02 | 0.008 |
| ### | May 8, 2012 | 1:28:21 PM | 13.02 | 3.999 | 15.9760 | 3.255 | 52.067 | 0.072 | 227.80 | 13.0 [symbol] | 3.9990 | 52.267 | 0.073 | 228.60 | 13.02 | 0.002 |
| ### | May 8, 2012 | 1:28:26 PM | 13.04 | 3.999 | 15.9812 | 3.260 | 52.147 | 0.072 | 227.80 | 13.090 | 3.9990 | 52.347 | 0.073 | 228.68 | 13.01 | 0.026 |
| ### | May 8, 2012 | 1:28:31 PM | 12.99 | 3.999 | 15.5867 | 3.248 | 51.947 | 0.072 | 227.95 | 13.040 | 3.9990 | 52.147 | 0.072 | 228.75 | 13.01 | −0.023 |
| ### | May 8, 2012 | 1:28:36 PM | 13.01 | 3.999 | 15.9923 | 3.253 | 52.027 | 0.072 | 228.02 | 13.060 | 3.9990 | 52.227 | 0.073 | 228.82 | 13.01 | −0.002 |
| ### | May 8, 2012 | 1:28:41 PM | 13.00 | 3.999 | 15.9978 | 3.250 | 51.987 | 0.072 | 228.09 | 13.050 | 3.9990 | 52.187 | 0.072 | 228.89 | 13.01 | −0.012 |
| ### | May 8, 2012 | 1:28:46 PM | 13.00 | 3.999 | 16.0034 | 3.250 | 51.987 | 0.072 | 228.17 | 13.050 | 3.9990 | 52.187 | 0.072 | 228.97 | 13.01 | −0.009 |
| ### | May 8, 2012 | 1:28:51 PM | 13.00 | 3.999 | 16.0089 | 3.250 | 51.987 | 0.072 | 228.24 | 13.050 | 3.9990 | 52.187 | 0.072 | 229.04 | 13.01 | −0.008 |
| ### | May 8, 2012 | 1:28:56 PM | 13.01 | 3.999 | 16.0145 | 3.253 | 52.027 | 0.072 | 228.31 | 13.060 | 3.9990 | 52.227 | 0.073 | 229.11 | 13.00 | 0.005 |
| ### | May 8, 2012 | 1:29:01 PM | 13.01 | 3.999 | 16.0200 | 3.253 | 52.027 | 0.072 | 228.38 | 13.060 | 3.9990 | 52.227 | 0.073 | 229.18 | 13.01 | 0.003 |
| ### | May 8, 2012 | 1:29:06 PM | 13.02 | 3.999 | 16.0259 | 3.255 | 52.067 | 0.072 | 228.45 | 13.070 | 3.9990 | 52.267 | 0.073 | 229.26 | 13.01 | 0.012 |
| ### | May 8, 2012 | 1:29:11 PM | 13.00 | 3.999 | 16.0314 | 3.250 | 51.987 | 0.072 | 228.53 | 13.050 | 3.9990 | 52.187 | 0.072 | 229.33 | 13.01 | −0.006 |
| ### | May 8, 2012 | 1:29:16 PM | 13.01 | 3.999 | 16.0367 | 3.253 | 52.027 | 0.072 | 228.60 | 13.060 | 3.9990 | 52.227 | 0.073 | 229.40 | 13.01 | 0.005 |
| ### | May 8, 2012 | 1:29:21 PM | 13.00 | 3.999 | 16.0422 | 3.250 | 51.987 | 0.072 | 228.67 | 13.050 | 3.9990 | 52.187 | 0.072 | 229.47 | 13.01 | −0.007 |
| ### | May 8, 2012 | 1:29:26 PM | 13.02 | 3.999 | 16.0481 | 3.255 | 52.067 | 0.072 | 228.74 | 13.070 | 3.9990 | 52.267 | 0.073 | 229.55 | 13.01 | 0.012 |
| ### | May 8, 2012 | 1:29:31 PM | 13.02 | 4.000 | 16.0536 | 3.255 | 52.080 | 0.072 | 228.82 | 13.070 | 4.0000 | 52.280 | 0.073 | 229.62 | 13.01 | 0.011 |
| ### | May 8, 2012 | 1:29:36 PM | 12.98 | 3.999 | 16.0588 | 3.245 | 51.907 | 0.072 | 228.89 | 13.030 | 3.9990 | 52.107 | 0.072 | 229.69 | 13.01 | −0.028 |
| ### | May 8, 2012 | 1:29:41 PM | 12.99 | 3.999 | 16.0644 | 3.248 | 51.947 | 0.072 | 228.96 | 13.040 | 3.9990 | 52.147 | 0.072 | 229.76 | 13.00 | −0.011 |
| ### | May 8, 2012 | 1:29:46 PM | 13.02 | 3.999 | 16.0699 | 3.255 | 52.067 | 0.072 | 229.03 | 13.070 | 3.9990 | 52.267 | 0.073 | 229.84 | 13.00 | 0.019 |
| ### | May 8, 2012 | 1:29:51 PM | 13.02 | 3.999 | 16.0758 | 3.255 | 52.067 | 0.072 | 229.10 | 13.070 | 3.9990 | 52.267 | 0.073 | 229.91 | 13.00 | 0.020 |
| ### | May 8, 2012 | 1:29:56 PM | 13.02 | 3.999 | 16.0810 | 3.255 | 52.067 | 0.072 | 229.18 | 13.070 | 3.9990 | 52.267 | 0.073 | 229.98 | 13.00 | 0.022 |
| ### | May 8, 2012 | 1:30:01 PM | 13.01 | 3.999 | 16.0869 | 3.253 | 52.027 | 0.072 | 229.25 | 13.060 | 3.9990 | 52.227 | 0.073 | 230.05 | 13.00 | 0.014 |
| ### | May 8, 2012 | 1:30:06 PM | 12.92 | 4.000 | 16.0921 | 3.230 | 51.680 | 0.072 | 229.32 | 12.970 | 4.0000 | 51.880 | 0.072 | 230.13 | 13.00 | −0.077 |
| ### | May 8, 2012 | 1:30:11 PM | 13.01 | 3.999 | 16.0980 | 3.253 | 52.027 | 0.072 | 229.39 | 13.060 | 3.9990 | 52.227 | 0.073 | 230.20 | 13.00 | 0.012 |
| ### | May 8, 2012 | 1:30:16 PM | 12.99 | 3.999 | 16.1032 | 3.248 | 51.947 | 0.072 | 229.47 | 13.040 | 3.9990 | 52.147 | 0.072 | 230.27 | 13.00 | −0.005 |
| ### | May 8, 2012 | 1:30:21 PM | 13.00 | 3.999 | 16.1091 | 3.250 | 51.987 | 0.072 | 229.54 | 13.050 | 3.9990 | 52.187 | 0.072 | 230.34 | 12.99 | 0.008 |
| ### | May 8, 2012 | 1:30:26 PM | 13.00 | 3.999 | 16.1143 | 3.250 | 51.987 | 0.072 | 229.61 | 13.050 | 3.9990 | 52.187 | 0.072 | 230.42 | 12.99 | 0.013 |
| ### | May 8, 2012 | 1:30:31 PM | 12.99 | 3.999 | 16.1198 | 3.248 | 51.947 | 0.072 | 229.68 | 13.040 | 3.9990 | 52.147 | 0.072 | 230.49 | 12.99 | 0.005 |
| ### | May 8, 2012 | 1:30:36 PM | 13.00 | 3.999 | 16.1257 | 3.250 | 51.987 | 0.072 | 229.75 | 13.050 | 3.9990 | 52.187 | 0.072 | 230.56 | 12.99 | 0.011 |
| ### | May 8, 2012 | 1:30:41 PM | 12.99 | 3.999 | 16.1312 | 3.248 | 51.947 | 0.072 | 229.83 | 13.040 | 3.9990 | 52.147 | 0.072 | 230.63 | 12.98 | 0.005 |
| ### | May 8, 2012 | 1:30:46 PM | 12.98 | 3.999 | 16.1364 | 3.245 | 51.907 | 0.072 | 229.90 | 13.030 | 3.9990 | 52.107 | 0.072 | 230.71 | 12.99 | −0.006 |
| ### | May 8, 2012 | 1:30:51 PM | 12.97 | 3.999 | 16.1423 | 3.243 | 51.867 | 0.072 | 229.97 | 13.020 | 3.9990 | 52.067 | 0.072 | 230.78 | 12.99 | −0.016 |
| ### | May 8, 2012 | 1:30:56 PM | 12.99 | 3.999 | 16.1479 | 3.248 | 51.947 | 0.072 | 230.04 | 13.040 | 3.9990 | 52.147 | 0.072 | 230.85 | 12.99 | 0.004 |
| ### | May 8, 2012 | 1:31:01 PM | 12.96 | 3.999 | 16.1534 | 3.240 | 51.827 | 0.072 | 230.11 | 13.010 | 3.9990 | 52.027 | 0.072 | 230.92 | 12.99 | −0.028 |
| ### | May 8, 2012 | 1:31:06 PM | 12.96 | 3.999 | 16.1586 | 3.240 | 51.827 | 0.072 | 230.19 | 13.010 | 3.9990 | 52.027 | 0.072 | 231.00 | 12.99 | −0.026 |
| ### | May 8, 2012 | 1:31:11 PM | 13.01 | 3.999 | 16.1645 | 3.253 | 52.027 | 0.072 | 230.26 | 13.060 | 3.9990 | 52.227 | 0.073 | 231.07 | 12.99 | 0.002 |
| ### | May 8, 2012 | 1:31:16 PM | 13.00 | 3.999 | 16.1700 | 3.250 | 51.987 | 0.072 | 230.33 | 13.050 | 3.9990 | 52.187 | 0.072 | 231.14 | 12.99 | 0.011 |
| ### | May 8, 2012 | 1:31:21 PM | 13.00 | 3.999 | 16.1756 | 3.250 | 51.987 | 0.072 | 230.40 | 13.050 | 3.9990 | 52.187 | 0.072 | 231.21 | 12.99 | 0.008 |
| ### | May 8, 2012 | 1:31:26 PM | 13.01 | 3.999 | 16.1811 | 3.253 | 52.027 | 0.072 | 230.48 | 13.060 | 3.9990 | 52.227 | 0.073 | 231.29 | 12.99 | 0.022 |
| ### | May 8, 2012 | 1:31:31 PM | 12.98 | 3.999 | 16.1867 | 3.245 | 51.907 | 0.072 | 230.55 | 13.030 | 3.9990 | 52.107 | 0.072 | 231.36 | 12.99 | −0.006 |
| ### | May 8, 2012 | 1:31:36 PM | 12.99 | 3.999 | 16.1922 | 3.248 | 51.947 | 0.072 | 230.62 | 13.040 | 3.9990 | 52.147 | 0.072 | 231.43 | 12.98 | 0.006 |
| ### | May 8, 2012 | 1:31:41 PM | 13.01 | 3.999 | 16.1974 | 3.253 | 52.027 | 0.072 | 230.69 | 13.060 | 3.9990 | 52.227 | 0.073 | 231.50 | 12.98 | 0.033 |
| ### | May 8, 2012 | 1:31:46 PM | 13.00 | 3.999 | 16.2033 | 3.250 | 51.987 | 0.072 | 230.76 | 13.050 | 3.9990 | 52.187 | 0.072 | 231.58 | 12.97 | 0.029 |
| ### | May 8, 2012 | 1:31:51 PM | 12.95 | 3.999 | 16.2089 | 3.238 | 51.787 | 0.072 | 230.84 | 13.000 | 3.9990 | 51.987 | 0.072 | 231.65 | 12.96 | −0.015 |
| ### | May 8, 2012 | 1:31:56 PM | 12.94 | 3.999 | 16.2144 | 3.235 | 51.747 | 0.072 | 230.91 | 12.990 | 3.9990 | 51.947 | 0.072 | 231.72 | 12.96 | −0.020 |
| ### | May 8, 2012 | 1:32:01 PM | 12.93 | 3.999 | 16.2199 | 3.233 | 51.707 | 0.072 | 230.98 | 12.980 | 3.9990 | 51.907 | 0.072 | 231.79 | 12.96 | −0.026 |
| ### | May 8, 2012 | 1:32:06 PM | 12.94 | 3.999 | 16.2255 | 3.235 | 51.747 | 0.072 | 231.05 | 12.990 | 3.9990 | 51.947 | 0.072 | 231.86 | 12.95 | −0.015 |
| ### | May 8, 2012 | 1:32:11 PM | 12.93 | 3.999 | 16.2310 | 3.233 | 51.707 | 0.072 | 231.12 | 12.980 | 3.9990 | 51.907 | 0.072 | 231.94 | 12.95 | −0.017 |
| ### | May 8, 2012 | 1:32:16 PM | 12.93 | 3.999 | 16.2362 | 3.233 | 51.707 | 0.072 | 231.20 | 12.980 | 3.9990 | 51.907 | 0.072 | 232.01 | 12.95 | −0.016 |
| ### | May 8, 2012 | 1:32:21 PM | 12.96 | 3.999 | 16.2421 | 3.240 | 51.827 | 0.072 | 231.27 | 13.010 | 3.9990 | 52.027 | 0.072 | 232.08 | 12.95 | 0.011 |
| ### | May 8, 2012 | 1:32:26 PM | 12.94 | 3.999 | 16.2477 | 3.235 | 51.747 | 0.072 | 231.34 | 12.990 | 3.9990 | 51.947 | 0.072 | 232.15 | 12.95 | −0.011 |
| ### | May 8, 2012 | 1:32:31 PM | 12.97 | 3.999 | 16.2532 | 3.243 | 51.867 | 0.072 | 231.41 | 13.020 | 3.9990 | 52.067 | 0.072 | 232.22 | 12.96 | 0.012 |
| ### | May 8, 2012 | 1:32:36 PM | 12.93 | 3.999 | 16.2588 | 3.233 | 51.707 | 0.072 | 231.48 | 12.980 | 3.9990 | 51.907 | 0.072 | 232.30 | 12.96 | −0.030 |
| ### | May 8, 2012 | 1:32:41 PM | 12.99 | 3.999 | 16.2643 | 3.248 | 51.947 | 0.072 | 231.55 | 13.040 | 3.9990 | 52.147 | 0.072 | 232.37 | 12.96 | 0.030 |
| ### | May 8, 2012 | 1:32:46 PM | 12.98 | 3.999 | 16.2698 | 3.245 | 51.907 | 0.072 | 231.63 | 13.030 | 3.9990 | 52.107 | 0.072 | 232.44 | 12.96 | 0.022 |
| ### | May 8, 2012 | 1:32:51 PM | 12.96 | 3.999 | 16.2750 | 3.240 | 51.827 | 0.072 | 231.70 | 13.010 | 3.9990 | 52.027 | 0.072 | 232.51 | 12.96 | −0.001 |
| ### | May 8, 2012 | 1:32:56 PM | 13.01 | 3.999 | 16.2809 | 3.253 | 52.027 | 0.072 | 231.77 | 13.060 | 3.9990 | 52.227 | 0.073 | 232.59 | 12.96 | 0.046 |
| ### | May 8, 2012 | 1:33:01 PM | 12.96 | 3.999 | 16.2861 | 3.240 | 51.827 | 0.072 | 231.84 | 13.010 | 3.9990 | 52.027 | 0.072 | 232.66 | 12.96 | −0.005 |
| ### | May 8, 2012 | 1:33:06 PM | 12.93 | 3.999 | 16.2917 | 3.233 | 51.707 | 0.072 | 231.91 | 12.980 | 3.9990 | 51.907 | 0.072 | 232.73 | 12.97 | −0.038 |
| ### | May 8, 2012 | 1:33:11 PM | 12.91 | 3.999 | 16.2976 | 3.228 | 51.627 | 0.072 | 231.99 | 12.960 | 3.9990 | 51.827 | 0.072 | 232.80 | 12.97 | −0.058 |
| ### | May 8, 2012 | 1:33:16 PM | 12.99 | 3.999 | 16.3031 | 3.248 | 51.947 | 0.072 | 232.06 | 13.040 | 3.9990 | 52.147 | 0.072 | 232.88 | 12.97 | 0.021 |
| ### | May 8, 2012 | 1:33:21 PM | 12.97 | 3.999 | 16.3087 | 3.243 | 51.867 | 0.072 | 232.13 | 13.020 | 3.9990 | 52.067 | 0.072 | 232.95 | 12.97 | −0.001 |
| ### | May 8, 2012 | 1:33:26 PM | 12.98 | 3.999 | 16.3142 | 3.245 | 51.907 | 0.072 | 232.20 | 13.030 | 3.9990 | 52.107 | 0.072 | 233.02 | 12.97 | 0.012 |
| ### | May 8, 2012 | 1:33:31 PM | 12.97 | 3.999 | 16.3197 | 3.243 | 51.867 | 0.072 | 232.28 | 13.020 | 3.9990 | 52.067 | 0.072 | 233.09 | 12.97 | 0.000 |
| ### | May 8, 2012 | 1:33:36 PM | 12.99 | 3.999 | 16.3253 | 3.248 | 51.947 | 0.072 | 232.35 | 13.040 | 3.9990 | 52.147 | 0.072 | 233.16 | 12.97 | 0.015 |
| ### | May 8, 2012 | 1:33:41 PM | 12.99 | 3.999 | 16.3305 | 3.248 | 51.947 | 0.072 | 232.42 | 13.040 | 3.9990 | 52.147 | 0.072 | 233.24 | 12.98 | 0.009 |
| ### | May 8, 2012 | 1:33:46 PM | 12.98 | 3.999 | 16.3364 | 3.245 | 51.907 | 0.072 | 232.49 | 13.030 | 3.9990 | 52.107 | 0.072 | 233.31 | 12.98 | 0.000 |
| ### | May 8, 2012 | 1:33:51 PM | 12.98 | 3.999 | 16.3419 | 3.245 | 51.907 | 0.072 | 232.56 | 13.030 | 3.9990 | 52.107 | 0.072 | 233.38 | 12.98 | −0.001 |
| ### | May 8, 2012 | 1:33:56 PM | 12.98 | 3.999 | 16.3475 | 3.245 | 51.907 | 0.072 | 232.64 | 13.030 | 3.9990 | 52.107 | 0.072 | 233.45 | 12.98 | −0.001 |
| ### | May 8, 2012 | 1:34:01 PM | 12.98 | 3.999 | 16.3530 | 3.245 | 51.907 | 0.072 | 232.71 | 13.030 | 3.9990 | 52.107 | 0.072 | 233.53 | 12.98 | −0.002 |
| ### | May 8, 2012 | 1:34:06 PM | 12.98 | 3.999 | 16.3585 | 3.245 | 51.907 | 0.072 | 232.78 | 13.030 | 3.9990 | 52.107 | 0.072 | 233.60 | 12.98 | −0.001 |
| ### | May 8, 2012 | 1:34:11 PM | 12.98 | 3.999 | 16.3641 | 3.245 | 51.907 | 0.072 | 232.85 | 13.030 | 3.9990 | 52.107 | 0.072 | 233.67 | 12.98 | 0.001 |
| ### | May 8, 2012 | 1:34:16 PM | 12.98 | 3.999 | 16.3696 | 3.245 | 51.907 | 0.072 | 232.92 | 13.030 | 3.9990 | 52.107 | 0.072 | 233.74 | 12.98 | 0.002 |
| ### | May 8, 2012 | 1:34:21 PM | 12.98 | 3.999 | 16.3752 | 3.245 | 51.907 | 0.072 | 233.00 | 13.030 | 3.9990 | 52.107 | 0.072 | 233.82 | 12.98 | 0.003 |
| ### | May 8, 2012 | 1:34:26 PM | 12.98 | 4.000 | 16.3807 | 3.245 | 51.920 | 0.072 | 233.07 | 13.030 | 4.0000 | 52.120 | 0.072 | 233.89 | 12.98 | 0.004 |
| ### | May 8, 2012 | 1:34:31 PM | 12.98 | 3.999 | 16.3863 | 3.245 | 51.907 | 0.072 | 233.14 | 13.030 | 3.9990 | 52.107 | 0.072 | 233.96 | 12.98 | 0.005 |
| ### | May 8, 2012 | 1:34:36 PM | 12.97 | 3.999 | 16.3918 | 3.243 | 51.867 | 0.072 | 233.21 | 13.020 | 3.9990 | 52.067 | 0.072 | 234.03 | 12.97 | −0.004 |
| ### | May 8, 2012 | 1:34:41 PM | 12.97 | 3.999 | 16.3973 | 3.243 | 51.867 | 0.072 | 233.28 | 13.010 | 3.9990 | 52.067 | 0.072 | 234.11 | 12.97 | −0.002 |
| ### | May 8, 2012 | 1:34:46 PM | 12.97 | 3.999 | 16.4029 | 3.243 | 51.867 | 0.072 | 233.36 | 13.020 | 3.9990 | 52.067 | 0.072 | 234.18 | 12.97 | 0.000 |
| ### | May 8, 2012 | 1:34:51 PM | 12.97 | 3.999 | 16.4084 | 3.243 | 51.867 | 0.072 | 233.43 | 13.020 | 3.9990 | 52.067 | 0.072 | 234.25 | 12.97 | 0.002 |
| ### | May 8, 2012 | 1:34:56 PM | 12.97 | 3.999 | 16.4140 | 3.243 | 51.867 | 0.072 | 233.50 | 13.020 | 3.9990 | 52.067 | 0.072 | 234.32 | 12.97 | 0.004 |
| ### | May 8, 2012 | 1:35:01 PM | 12.96 | 3.999 | 16.4195 | 3.240 | 51.827 | 0.072 | 233.57 | 13.010 | 3.9990 | 52.027 | 0.072 | 234.39 | 12.96 | −0.005 |
| ### | May 8, 2012 | 1:35:06 PM | 12.96 | 3.999 | 16.4251 | 3.240 | 51.827 | 0.072 | 233.64 | 13.010 | 3.9990 | 52.027 | 0.072 | 234.47 | 12.96 | −0.003 |
| ### | May 8, 2012 | 1:35:11 PM | 12.96 | 3.999 | 16.4306 | 3.240 | 51.827 | 0.072 | 233.72 | 13.010 | 3.9990 | 52.027 | 0.072 | 234.54 | 12.96 | −0.001 |
| ### | May 8, 2012 | 1:35:16 PM | 12.96 | 4.000 | 16.4362 | 3.240 | 51.840 | 0.072 | 233.79 | 13.010 | 4.0000 | 52.040 | 0.072 | 234.61 | 12.96 | 0.001 |
| ### | May 8, 2012 | 1:35:21 PM | 12.96 | 3.999 | 16.4417 | 3.240 | 51.827 | 0.072 | 233.86 | 13.010 | 3.9990 | 52.027 | 0.072 | 234.68 | 12.96 | 0.003 |
| ### | May 8, 2012 | 1:35:26 PM | 12.96 | 3.999 | 16.4472 | 3.240 | 51.827 | 0.072 | 233.93 | 13.010 | 3.9990 | 52.027 | 0.072 | 234.76 | 12.96 | 0.005 |
| ### | May 8, 2012 | 1:35:31 PM | 12.95 | 3.999 | 16.4528 | 3.238 | 51.787 | 0.072 | 234.00 | 13.000 | 3.9990 | 51.987 | 0.072 | 234.83 | 12.95 | −0.005 |
| ### | May 8, 2012 | 1:35:36 PM | 12.95 | 3.999 | 16.4581 | 3.238 | 51.787 | 0.072 | 234.08 | 13.000 | 3.9990 | 51.987 | 0.072 | 234.90 | 12.95 | −0.003 |
| ### | May 8, 2012 | 1:35:41 PM | 12.95 | 3.999 | 16.4636 | 3.238 | 51.787 | 0.072 | 234.15 | 13.000 | 3.9990 | 51.987 | 0.072 | 234.97 | 12.95 | −0.001 |
| ### | May 8, 2012 | 1:35:46 PM | 12.95 | 3.999 | 16.4691 | 3.238 | 51.787 | 0.072 | 234.22 | 13.000 | 3.9990 | 51.987 | 0.072 | 235.04 | 12.95 | 0.002 |
| ### | May 8, 2012 | 1:35:51 PM | 12.95 | 3.999 | 16.4747 | 3.238 | 51.787 | 0.072 | 234.29 | 13.000 | 3.9990 | 51.987 | 0.072 | 235.12 | 12.95 | 0.005 |
| ### | May 8, 2012 | 1:35:56 PM | 12.95 | 3.999 | 16.4802 | 3.238 | 51.787 | 0.072 | 234.36 | 13.000 | 3.9990 | 51.987 | 0.072 | 235.19 | 12.94 | 0.007 |
| ### | May 8, 2012 | 1:36:01 PM | 12.94 | 4.000 | 16.4858 | 3.235 | 51.760 | 0.072 | 234.44 | 12.990 | 4.0000 | 51.960 | 0.072 | 235.26 | 12.94 | 0.000 |
| ### | May 8, 2012 | 1:36:06 PM | 12.94 | 3.999 | 16.4913 | 3.235 | 51.747 | 0.072 | 234.51 | 12.990 | 3.9990 | 51.947 | 0.072 | 235.33 | 12.94 | 0.004 |
| ### | May 8, 2012 | 1:36:11 PM | 12.93 | 3.999 | 16.4969 | 3.233 | 51.707 | 0.072 | 234.58 | 12.980 | 3.9990 | 51.907 | 0.072 | 235.41 | 12.93 | 0.003 |
| ### | May 8, 2012 | 1:36:16 PM | 12.93 | 3.999 | 16.5024 | 3.233 | 51.707 | 0.072 | 234.65 | 12.980 | 3.9990 | 51.907 | 0.072 | 235.48 | 12.93 | 0.000 |
| ### | May 8, 2012 | 1:36:21 PM | 12.93 | 3.999 | 16.5080 | 3.233 | 51.707 | 0.072 | 234.72 | 12.980 | 3.9990 | 51.907 | 0.072 | 235.55 | 12.93 | 0.002 |
| ### | May 8, 2012 | 1:36:26 PM | 12.92 | 3.999 | 16.5135 | 3.230 | 51.667 | 0.072 | 234.79 | 12.970 | 3.9990 | 51.867 | 0.072 | 235.62 | 12.93 | −0.005 |
| ### | May 8, 2012 | 1:36:31 PM | 12.91 | 3.999 | 16.5190 | 3.228 | 51.627 | 0.072 | 234.87 | 12.960 | 3.9990 | 51.827 | 0.072 | 235.69 | 12.92 | −0.011 |
| ### | May 8, 2012 | 1:36:36 PM | 12.91 | 3.999 | 16.5246 | 3.228 | 51.627 | 0.072 | 234.94 | 12.960 | 3.9990 | 51.827 | 0.072 | 235.77 | 12.91 | −0.005 |
| ### | May 8, 2012 | 1:36:41 PM | 12.92 | 3.999 | 16.5301 | 3.230 | 51.667 | 0.072 | 235.01 | 12.970 | 3.9990 | 51.867 | 0.072 | 235.84 | 12.91 | 0.005 |
| ### | May 8, 2012 | 1:36:46 PM | 12.93 | 3.999 | 16.5357 | 3.233 | 51.707 | 0.072 | 235.08 | 12.980 | 3.9990 | 51.907 | 0.072 | 235.91 | 12.91 | 0.018 |
| ### | May 8, 2012 | 1:36:51 PM | 12.92 | 3.999 | 16.5412 | 3.230 | 51.667 | 0.072 | 235.15 | 12.970 | 3.9990 | 51.867 | 0.072 | 235.98 | 12.91 | 0.010 |
| ### | May 8, 2012 | 1:36:56 PM | 12.89 | 3.999 | 16.5468 | 3.223 | 51.547 | 0.072 | 235.23 | 12.940 | 3.9990 | 51.747 | 0.072 | 236.05 | 12.91 | −0.018 |
| ### | May 8, 2012 | 1:37:01 PM | 12.87 | 3.999 | 16.5523 | 3.218 | 51.467 | 0.072 | 235.30 | 12.920 | 3.9990 | 51.667 | 0.072 | 236.13 | 12.91 | −0.041 |
| ### | May 8, 2012 | 1:37:06 PM | 12.93 | 3.999 | 16.5578 | 3.233 | 51.707 | 0.072 | 235.37 | 12.980 | 3.9990 | 51.907 | 0.072 | 236.20 | 12.91 | 0.016 |
| ### | May 8, 2012 | 1:37:11 PM | 12.90 | 3.999 | 16.5634 | 3.225 | 51.587 | 0.072 | 235.44 | 12.950 | 3.9990 | 51.787 | 0.072 | 236.27 | 12.92 | −0.015 |
| ### | May 8, 2012 | 1:37:16 PM | 12.91 | 3.999 | 16.5689 | 3.228 | 51.627 | 0.072 | 235.51 | 12.960 | 3.9990 | 51.827 | 0.072 | 236.34 | 12.92 | −0.005 |
| ### | May 8, 2012 | 1:37:21 PM | 12.90 | 3.999 | 16.5745 | 3.225 | 51.587 | 0.072 | 235.58 | 12.950 | 3.9990 | 51.787 | 0.072 | 236.41 | 12.92 | −0.015 |
| ### | May 8, 2012 | 1:37:26 PM | 12.94 | 3.999 | 16.5800 | 3.235 | 51.747 | 0.072 | 235.66 | 12.990 | 3.9990 | 51.947 | 0.072 | 236.49 | 12.92 | 0.023 |
| ### | May 8, 2012 | 1:37:31 PM | 12.94 | 3.999 | 16.5856 | 3.235 | 51.747 | 0.072 | 235.73 | 12.990 | 3.9990 | 51.947 | 0.072 | 236.56 | 12.92 | 0.020 |
| ### | May 8, 2012 | 1:37:36 PM | 12.94 | 3.999 | 16.5911 | 3.235 | 51.747 | 0.072 | 235.80 | 12.990 | 3.9990 | 51.947 | 0.072 | 236.63 | 12.92 | 0.023 |
| ### | May 8, 2012 | 1:37:41 PM | 12.93 | 3.999 | 16.5967 | 3.233 | 51.707 | 0.072 | 235.87 | 12.980 | 3.9990 | 51.907 | 0.072 | 236.70 | 12.92 | 0.013 |
| ### | May 8, 2012 | 1:37:46 PM | 12.92 | 3.999 | 16.6022 | 3.230 | 51.667 | 0.072 | 235.94 | 12.970 | 3.9990 | 51.867 | 0.072 | 236.77 | 12.92 | 0.004 |
| ### | May 8, 2012 | 1:37:51 PM | 12.91 | 3.999 | 16.6077 | 3.228 | 51.627 | 0.072 | 236.01 | 12.960 | 3.9990 | 51.827 | 0.072 | 236.85 | 12.92 | −0.006 |
| ### | May 8, 2012 | 1:37:56 PM | 12.90 | 3.999 | 16.6133 | 3.225 | 51.587 | 0.072 | 236.09 | 12.950 | 3.9990 | 51.787 | 0.072 | 236.92 | 12.91 | −0.013 |
| ### | May 8, 2012 | 1:38:01 PM | 12.90 | 3.999 | 16.6188 | 3.225 | 51.587 | 0.072 | 236.16 | 12.950 | 3.9990 | 51.787 | 0.072 | 236.99 | 12.91 | −0.009 |
| ### | May 8, 2012 | 1:38:06 PM | 12.90 | 3.999 | 16.6244 | 3.225 | 51.587 | 0.072 | 236.23 | 12.950 | 3.9990 | 51.787 | 0.072 | 237.06 | 12.91 | −0.005 |
| ### | May 8, 2012 | 1:38:11 PM | 12.90 | 3.999 | 16.6299 | 3.225 | 51.587 | 0.072 | 236.30 | 12.950 | 3.9990 | 51.787 | 0.072 | 237.13 | 12.90 | −0.002 |
| ### | May 8, 2012 | 1:38:16 PM | 12.90 | 3.999 | 16.6355 | 3.225 | 51.587 | 0.072 | 236.37 | 12.950 | 3.9990 | 51.787 | 0.072 | 237.21 | 12.90 | 0.001 |
| ### | May 8, 2012 | 1:38:21 PM | 12.90 | 3.999 | 16.6410 | 3.225 | 51.587 | 0.072 | 236.44 | 12.950 | 3.9990 | 51.787 | 0.072 | 237.28 | 12.90 | 0.003 |
| ### | May 8, 2012 | 1:38:26 PM | 12.90 | 3.999 | 16.6465 | 3.225 | 51.587 | 0.072 | 236.52 | 12.950 | 3.9990 | 51.787 | 0.072 | 237.35 | 12.90 | 0.004 |
| ### | May 8, 2012 | 1:38:31 PM | 12.90 | 3.999 | 16.6521 | 3.225 | 51.587 | 0.072 | 236.59 | 12.950 | 3.9990 | 51.787 | 0.072 | 237.42 | 12.90 | 0.005 |
| ### | May 8, 2012 | 1:38:36 PM | 12.89 | 3.999 | 16.6576 | 3.223 | 51.547 | 0.072 | 236.66 | 12.940 | 3.9990 | 51.747 | 0.072 | 237.49 | 12.89 | −0.004 |
| ### | May 8, 2012 | 1:38:41 PM | 12.89 | 3.999 | 16.6632 | 3.223 | 51.547 | 0.072 | 236.73 | 12.940 | 3.9990 | 51.747 | 0.072 | 237.57 | 12.89 | 0.003 |
| ### | May 8, 2012 | 1:38:46 PM | 12.89 | 3.999 | 16.6687 | 3.223 | 51.547 | 0.072 | 236.80 | 12.940 | 3.9990 | 51.747 | 0.072 | 237.64 | 12.89 | 0.001 |
| ### | May 8, 2012 | 1:38:51 PM | 12.89 | 3.999 | 16.6743 | 3.223 | 51.547 | 0.072 | 236.87 | 12.940 | 3.9990 | 51.747 | 0.072 | 237.71 | 12.89 | 0.001 |
| ### | May 8, 2012 | 1:38:56 PM | 12.89 | 3.999 | 16.6798 | 3.223 | 51.547 | 0.072 | 236.95 | 12.940 | 3.9990 | 51.747 | 0.072 | 237.78 | 12.89 | 0.003 |
| ### | May 8, 2012 | 1:39:01 PM | 12.88 | 3.999 | 16.6853 | 3.220 | 51.507 | 0.072 | 237.02 | 12.930 | 3.9990 | 51.707 | 0.072 | 237.85 | 12.88 | −0.005 |
| ### | May 8, 2012 | 1:39:06 PM | 12.89 | 3.999 | 16.6909 | 3.223 | 51.547 | 0.072 | 237.09 | 12.940 | 3.9990 | 51.747 | 0.072 | 237.92 | 12.88 | 0.007 |
| ### | May 8, 2012 | 1:39:11 PM | 12.88 | 3.999 | 16.6964 | 3.220 | 51.507 | 0.072 | 237.16 | 12.930 | 3.9990 | 51.707 | 0.072 | 238.00 | 12.88 | −0.001 |
| ### | May 8, 2012 | 1:39:16 PM | 12.88 | 3.999 | 16.7022 | 3.220 | 51.507 | 0.072 | 237.23 | 12.930 | 3.9990 | 51.707 | 0.072 | 238.07 | 12.88 | 0.001 |
| ### | May 8, 2012 | 1:39:21 PM | 12.88 | 3.999 | 16.7077 | 3.220 | 51.507 | 0.072 | 237.30 | 12.930 | 3.9990 | 51.707 | 0.072 | 238.14 | 12.88 | 0.003 |
| ### | May 8, 2012 | 1:39:26 PM | 12.87 | 3.999 | 16.7132 | 3.218 | 51.467 | 0.071 | 237.37 | 12.920 | 3.9990 | 51.667 | 0.072 | 238.21 | 12.87 | −0.004 |
| ### | May 8, 2012 | 1:39:31 PM | 12.87 | 3.999 | 16.7188 | 3.218 | 51.467 | 0.071 | 237.45 | 12.920 | 3.9990 | 51.667 | 0.072 | 238.28 | 12.88 | −0.006 |
| ### | May 8, 2012 | 1:39:36 PM | 12.87 | 3.999 | 16.7243 | 3.218 | 51.467 | 0.071 | 237.52 | 12.920 | 3.9990 | 51.667 | 0.072 | 238.36 | 12.88 | −0.009 |
| ### | May 8, 2012 | 1:39:41 PM | 12.87 | 3.999 | 16.7299 | 3.218 | 51.467 | 0.071 | 237.59 | 12.920 | 3.9990 | 51.667 | 0.072 | 238.43 | 12.88 | −0.013 |
| ### | May 8, 2012 | 1:39:46 PM | 12.87 | 3.999 | 16.7353 | 3.218 | 51.467 | 0.071 | 237.66 | 12.920 | 3.9990 | 51.667 | 0.072 | 238.50 | 12.89 | −0.015 |
| ### | May 8, 2012 | 1:39:51 PM | 12.85 | 3.999 | 16.7408 | 3.213 | 51.387 | 0.071 | 237.73 | 12.900 | 3.9990 | 51.587 | 0.072 | 238.57 | 12.89 | −0.038 |
| ### | May 8, 2012 | 1:39:56 PM | 12.91 | 3.999 | 16.7464 | 3.228 | 51.627 | 0.072 | 237.80 | 12.960 | 3.9990 | 51.827 | 0.072 | 238.64 | 12.89 | 0.019 |
| ### | May 8, 2012 | 1:40:01 PM | 12.92 | 3.999 | 16.7519 | 3.230 | 51.667 | 0.072 | 237.88 | 12.970 | 3.9990 | 51.867 | 0.072 | 238.71 | 12.89 | 0.026 |
| ### | May 8, 2012 | 1:40:06 PM | 12.92 | 3.999 | 16.7575 | 3.230 | 51.667 | 0.072 | 237.95 | 12.970 | 3.9990 | 51.867 | 0.072 | 238.79 | 12.90 | 0.025 |
| ### | May 8, 2012 | 1:40:11 PM | 12.91 | 3.999 | 16.7630 | 3.228 | 51.627 | 0.072 | 238.02 | 12.960 | 3.9990 | 51.827 | 0.072 | 238.86 | 12.90 | 0.013 |
| ### | May 8, 2012 | 1:40:16 PM | 12.91 | 3.999 | 16.7686 | 3.228 | 51.627 | 0.072 | 238.09 | 12.960 | 3.9990 | 51.827 | 0.072 | 238.93 | 12.90 | 0.011 |
| ### | May 8, 2012 | 1:40:21 PM | 12.90 | 3.999 | 16.7741 | 3.225 | 51.587 | 0.072 | 238.16 | 12.950 | 3.9990 | 51.787 | 0.072 | 239.00 | 12.90 | −0.002 |
| ### | May 8, 2012 | 1:40:26 PM | 12.90 | 3.999 | 16.7797 | 3.225 | 51.587 | 0.072 | 238.23 | 12.950 | 3.9990 | 51.787 | 0.072 | 239.07 | 12.90 | 0.001 |
| ### | May 8, 2012 | 1:40:31 PM | 12.89 | 3.999 | 16.7852 | 3.223 | 51.547 | 0.072 | 238.31 | 12.940 | 3.9990 | 51.747 | 0.072 | 239.15 | 12.90 | −0.005 |
| ### | May 8, 2012 | 1:40:36 PM | 12.89 | 3.999 | 16.7907 | 3.223 | 51.547 | 0.072 | 238.38 | 12.940 | 3.9990 | 51.747 | 0.072 | 239.22 | 12.89 | −0.002 |
| ### | May 8, 2012 | 1:40:41 PM | 12.89 | 3.999 | 16.7963 | 3.223 | 51.547 | 0.072 | 238.45 | 12.940 | 3.9990 | 51.747 | 0.072 | 239.29 | 12.89 | 0.002 |
| ### | May 8, 2012 | 1:40:46 PM | 12.88 | 3.999 | 16.8018 | 3.220 | 51.507 | 0.072 | 238.52 | 12.930 | 3.9990 | 51.707 | 0.072 | 239.36 | 12.88 | −0.004 |
| ### | May 8, 2012 | 1:40:51 PM | 12.88 | 3.999 | 16.8074 | 3.220 | 51.507 | 0.072 | 238.59 | 12.930 | 3.9990 | 51.707 | 0.072 | 239.43 | 12.88 | 0.001 |
| ### | May 8, 2012 | 1:40:56 PM | 12.88 | 3.999 | 16.8129 | 3.220 | 51.507 | 0.072 | 238.66 | 12.930 | 3.9990 | 51.707 | 0.072 | 239.51 | 12.87 | 0.006 |
| ### | May 8, 2012 | 1:41:01 PM | 12.88 | 3.999 | 16.8185 | 3.220 | 51.507 | 0.072 | 238.73 | 12.930 | 3.9990 | 51.707 | 0.072 | 239.58 | 12.87 | 0.011 |
| ### | May 8, 2012 | 1:41:06 PM | 12.87 | 3.999 | 16.8240 | 3.218 | 51.467 | 0.071 | 238.81 | 12.920 | 3.9990 | 51.667 | 0.072 | 239.65 | 12.86 | 0.005 |
| ### | May 8, 2012 | 1:41:11 PM | 12.86 | 3.999 | 16.8295 | 3.215 | 51.427 | 0.071 | 238.88 | 12.910 | 3.9990 | 51.627 | 0.072 | 239.72 | 12.86 | −0.002 |
| ### | May 8, 2012 | 1:41:16 PM | 12.85 | 3.999 | 16.8351 | 3.213 | 51.387 | 0.071 | 238.95 | 12.900 | 3.9990 | 51.587 | 0.072 | 239.79 | 12.86 | −0.010 |
| ### | May 8, 2012 | 1:41:21 PM | 12.84 | 3.999 | 16.8406 | 3.210 | 51.347 | 0.071 | 239.02 | 12.890 | 3.9990 | 51.547 | 0.072 | 239.86 | 12.86 | −0.017 |
| ### | May 8, 2012 | 1:41:26 PM | 12.84 | 3.999 | 16.8462 | 3.210 | 51.347 | 0.071 | 239.09 | 12.890 | 3.9990 | 51.547 | 0.072 | 239.94 | 12.85 | −0.014 |
| ### | May 8, 2012 | 1:41:31 PM | 12.84 | 3.999 | 16.8517 | 3.210 | 51.347 | 0.071 | 239.16 | 12.890 | 3.9990 | 51.547 | 0.072 | 240.01 | 12.85 | −0.009 |
| ### | May 8, 2012 | 1:41:36 PM | 12.86 | 3.999 | 16.8573 | 3.215 | 51.427 | 0.071 | 239.23 | 12.910 | 3.9990 | 51.627 | 0.072 | 240.08 | 12.84 | 0.015 |
| ### | May 8, 2012 | 1:41:41 PM | 12.86 | 3.999 | 16.8628 | 3.215 | 51.427 | 0.071 | 239.31 | 12.910 | 3.9990 | 51.627 | 0.072 | 240.15 | 12.85 | 0.014 |
| ### | May 8, 2012 | 1:41:46 PM | 12.85 | 3.999 | 16.8684 | 3.213 | 51.387 | 0.071 | 239.38 | 12.900 | 3.9990 | 51.587 | 0.072 | 240.22 | 12.85 | 0.001 |
| ### | May 8, 2012 | 1:41:51 PM | 12.84 | 3.999 | 16.8739 | 3.210 | 51.347 | 0.071 | 239.45 | 12.890 | 3.9990 | 51.547 | 0.072 | 240.29 | 12.85 | −0.013 |
| ### | May 8, 2012 | 1:41:56 PM | 12.83 | 3.999 | 16.8794 | 3.208 | 51.307 | 0.071 | 239.52 | 12.880 | 3.9990 | 51.507 | 0.072 | 240.37 | 12.86 | −0.025 |
| ### | May 8, 2012 | 1:42:01 PM | 12.82 | 3.999 | 16.8850 | 3.205 | 51.267 | 0.071 | 239.59 | 12.870 | 3.9990 | 51.467 | 0.071 | 240.44 | 12.86 | −0.039 |
| ### | May 8, 2012 | 1:42:06 PM | 12.88 | 3.999 | 16.8905 | 3.220 | 51.507 | 0.072 | 239.66 | 12.930 | 3.9990 | 51.707 | 0.072 | 240.51 | 12.86 | 0.020 |
| ### | May 8, 2012 | 1:42:11 PM | 12.88 | 3.999 | 16.8961 | 3.220 | 51.507 | 0.072 | 239.73 | 12.930 | 3.9990 | 51.707 | 0.072 | 240.58 | 12.86 | 0.019 |
| ### | May 8, 2012 | 1:42:16 PM | 12.88 | 3.999 | 16.9018 | 3.220 | 51.507 | 0.072 | 239.81 | 12.930 | 3.9990 | 51.707 | 0.072 | 240.65 | 12.86 | 0.018 |
| ### | May 8, 2012 | 1:42:21 PM | 12.87 | 3.999 | 16.9073 | 3.218 | 51.467 | 0.071 | 239.88 | 12.920 | 3.9990 | 51.667 | 0.072 | 240.72 | 12.86 | 0.006 |
| ### | May 8, 2012 | 1:42:26 PM | 12.88 | 3.999 | 16.9129 | 3.220 | 51.507 | 0.072 | 239.95 | 12.930 | 3.9990 | 51.707 | 0.072 | 240.80 | 12.87 | 0.014 |
| ### | May 8, 2012 | 1:42:31 PM | 12.87 | 3.999 | 16.9184 | 3.218 | 51.467 | 0.071 | 240.02 | 12.920 | 3.9990 | 51.667 | 0.072 | 240.87 | 12.87 | 0.000 |
| ### | May 8, 2012 | 1:42:36 PM | 12.87 | 3.999 | 16.9240 | 3.218 | 51.467 | 0.071 | 240.09 | 12.920 | 3.9990 | 51.667 | 0.072 | 240.94 | 12.87 | 0.002 |
| ### | May 8, 2012 | 1:42:41 PM | 12.86 | 3.999 | 16.9295 | 3.215 | 51.427 | 0.071 | 240.16 | 12.910 | 3.9990 | 51.627 | 0.072 | 241.01 | 12.87 | −0.006 |
| ### | May 8, 2012 | 1:42:46 PM | 12.86 | 3.999 | 16.9351 | 3.215 | 51.427 | 0.071 | 240.23 | 12.910 | 3.9990 | 51.627 | 0.072 | 241.08 | 12.86 | −0.005 |
| ### | May 8, 2012 | 1:42:51 PM | 12.86 | 3.999 | 16.9406 | 3.215 | 51.427 | 0.071 | 240.31 | 12.910 | 3.9990 | 51.627 | 0.072 | 241.15 | 12.86 | −0.003 |
| ### | May 8, 2012 | 1:42:56 PM | 12.86 | 3.999 | 16.9461 | 3.215 | 51.427 | 0.071 | 240.38 | 12.910 | 3.9990 | 51.627 | 0.072 | 241.23 | 12.86 | 0.000 |
| ### | May 8, 2012 | 1:43:01 PM | 12.86 | 3.999 | 16.9517 | 3.215 | 51.427 | 0.071 | 240.45 | 12.910 | 3.9990 | 51.627 | 0.072 | 241.30 | 12.86 | 0.002 |
| ### | May 8, 2012 | 1:43:06 PM | 12.86 | 3.999 | 16.9572 | 3.215 | 51.427 | 0.071 | 240.52 | 12.910 | 3.9990 | 51.627 | 0.072 | 241.37 | 12.86 | 0.004 |
| ### | May 8, 2012 | 1:43:11 PM | 12.86 | 3.999 | 16.9628 | 3.215 | 51.427 | 0.071 | 240.59 | 12.910 | 3.9990 | 51.627 | 0.072 | 241.44 | 12.86 | 0.005 |
| ### | May 8, 2012 | 1:43:16 PM | 12.85 | 3.999 | 16.9684 | 3.213 | 51.387 | 0.071 | 240.66 | 12.900 | 3.9990 | 51.587 | 0.072 | 241.51 | 12.85 | −0.005 |
| ### | May 8, 2012 | 1:43:21 PM | 12.85 | 3.999 | 16.9739 | 3.213 | 51.387 | 0.071 | 240.73 | 12.900 | 3.9990 | 51.587 | 0.072 | 241.58 | 12.85 | −0.004 |
| ### | May 8, 2012 | 1:43:26 PM | 12.85 | 3.999 | 16.9794 | 3.213 | 51.387 | 0.071 | 240.81 | 12.900 | 3.9990 | 51.587 | 0.072 | 241.66 | 12.85 | −0.002 |
| ### | May 8, 2012 | 1:43:31 PM | 12.85 | 3.999 | 16.9850 | 3.213 | 51.387 | 0.071 | 240.88 | 12.900 | 3.9990 | 51.587 | 0.072 | 241.73 | 12.85 | 0.000 |
| ### | May 8, 2012 | 1:43:36 PM | 12.85 | 3.999 | 16.9905 | 3.213 | 51.387 | 0.071 | 240.95 | 12.900 | 3.9990 | 51.587 | 0.072 | 241.80 | 12.85 | 0.002 |
| ### | May 8, 2012 | 1:43:41 PM | 12.85 | 3.999 | 16.9961 | 3.213 | 51.387 | 0.071 | 241.02 | 12.900 | 3.9990 | 51.587 | 0.072 | 241.87 | 12.85 | 0.004 |
| ### | May 8, 2012 | 1:43:46 PM | 12.85 | 3.999 | 17.0016 | 3.213 | 51.387 | 0.071 | 241.09 | 12.900 | 3.9990 | 51.587 | 0.072 | 241.94 | 12.85 | 0.005 |
| ### | May 8, 2012 | 1:43:51 PM | 12.84 | 3.999 | 17.0072 | 3.210 | 51.347 | 0.071 | 241.16 | 12.890 | 3.9990 | 51.547 | 0.072 | 242.01 | 12.84 | −0.004 |
| ### | May 8, 2012 | 1:43:56 PM | 12.84 | 3.999 | 17.0127 | 3.210 | 51.347 | 0.071 | 241.23 | 12.890 | 3.9990 | 51.547 | 0.072 | 242.09 | 12.84 | −0.002 |
| ### | May 8, 2012 | 1:44:01 PM | 12.84 | 3.999 | 17.0182 | 3.210 | 51.347 | 0.071 | 241.31 | 12.890 | 3.9990 | 51.547 | 0.072 | 242.16 | 12.84 | 0.000 |
| ### | May 8, 2012 | 1:44:06 PM | 12.84 | 3.999 | 17.0238 | 3.210 | 51.347 | 0.071 | 241.38 | 12.890 | 3.9990 | 51.547 | 0.072 | 242.23 | 12.84 | 0.002 |
| ### | May 8, 2012 | 1:44:11 PM | 12.84 | 3.999 | 17.0293 | 3.210 | 51.347 | 0.071 | 241.45 | 12.890 | 3.9990 | 51.547 | 0.072 | 242.30 | 12.84 | −0.004 |
| ### | May 8, 2012 | 1:44:16 PM | 12.83 | 3.999 | 17.0349 | 3.208 | 51.307 | 0.071 | 241.52 | 12.880 | 3.9990 | 51.507 | 0.072 | 242.37 | 12.83 | −0.004 |
| ### | May 8, 2012 | 1:44:21 PM | 12.83 | 3.999 | 17.0404 | 3.208 | 51.307 | 0.071 | 241.59 | 12.880 | 3.9990 | 51.507 | 0.072 | 242.44 | 12.83 | 0.002 |
| ### | May 8, 2012 | 1:44:26 PM | 12.83 | 3.999 | 17.0460 | 3.208 | 51.307 | 0.071 | 241.66 | 12.880 | 3.9990 | 51.507 | 0.072 | 242.52 | 12.83 | 0.000 |
| ### | May 8, 2012 | 1:44:31 PM | 12.83 | 3.999 | 17.0515 | 3.208 | 51.307 | 0.071 | 241.73 | 12.880 | 3.9990 | 51.507 | 0.072 | 242.59 | 12.83 | 0.002 |
| ### | May 8, 2012 | 1:44:36 PM | 12.83 | 3.999 | 17.0571 | 3.208 | 51.307 | 0.071 | 241.80 | 12.880 | 3.9990 | 51.507 | 0.072 | 242.66 | 12.83 | 0.002 |
| ### | May 8, 2012 | 1:44:41 PM | 12.82 | 3.999 | 17.0626 | 3.205 | 51.267 | 0.071 | 241.88 | 12.870 | 3.9990 | 51.467 | 0.071 | 242.73 | 12.83 | −0.005 |
| ### | May 8, 2012 | 1:44:46 PM | 12.82 | 3.999 | 17.0681 | 3.205 | 51.267 | 0.071 | 241.95 | 12.870 | 3.9990 | 51.467 | 0.071 | 242.80 | 12.82 | −0.004 |
| ### | May 8, 2012 | 1:44:51 PM | 12.82 | 3.999 | 17.0737 | 3.205 | 51.267 | 0.071 | 242.02 | 12.870 | 3.9990 | 51.467 | 0.071 | 242.87 | 12.82 | −0.001 |
| ### | May 8, 2012 | 1:44:56 PM | 12.82 | 3.999 | 17.0792 | 3.205 | 51.267 | 0.071 | 242.09 | 12.870 | 3.9990 | 51.467 | 0.071 | 242.94 | 12.82 | 0.003 |
| ### | May 8, 2012 | 1:45:01 PM | 12.84 | 3.999 | 17.0848 | 3.210 | 51.347 | 0.071 | 242.16 | 12.890 | 3.9990 | 51.547 | 0.072 | 243.02 | 12.81 | 0.026 |
| ### | May 8, 2012 | 1:45:06 PM | 12.81 | 3.999 | 17.0903 | 3.203 | 51.227 | 0.071 | 242.23 | 12.860 | 3.9990 | 51.427 | 0.071 | 243.09 | 12.81 | 0.001 |
| ### | May 8, 2012 | 1:45:11 PM | 12.81 | 3.999 | 17.0959 | 3.203 | 51.227 | 0.071 | 242.30 | 12.860 | 3.9990 | 51.427 | 0.071 | 243.16 | 12.81 | 0.005 |
| ### | May 8, 2012 | 1:45:16 PM | 12.80 | 3.999 | 17.1014 | 3.200 | 51.187 | 0.071 | 242.37 | 12.850 | 3.9990 | 51.387 | 0.071 | 243.23 | 12.81 | −0.005 |
| ### | May 8, 2012 | 1:45:21 PM | 12.79 | 3.999 | 17.1070 | 3.298 | 51.147 | 0.071 | 242.44 | 12.840 | 3.9990 | 51.347 | 0.071 | 243.30 | 12.80 | −0.015 |
| ### | May 8, 2012 | 1:45:26 PM | 12.79 | 3.999 | 17.1125 | 3.298 | 51.147 | 0.071 | 242.52 | 12.840 | 3.9990 | 51.347 | 0.071 | 243.37 | 12.80 | −0.014 |
| ### | May 8, 2012 | 1:45:31 PM | 12.78 | 3.999 | 17.1180 | 3.295 | 51.107 | 0.071 | 242.59 | 12.830 | 3.9990 | 51.307 | 0.071 | 243.44 | 12.80 | −0.021 |
| ### | May 8, 2012 | 1:45:36 PM | 12.78 | 3.999 | 17.1236 | 3.295 | 51.107 | 0.071 | 242.66 | 12.830 | 3.9990 | 51.307 | 0.071 | 243.52 | 12.80 | −0.021 |
| ### | May 8, 2012 | 1:45:41 PM | 12.82 | 3.999 | 17.1291 | 3.205 | 51.267 | 0.071 | 242.73 | 12.870 | 3.9990 | 51.467 | 0.071 | 243.59 | 12.80 | 0.019 |
| ### | May 8, 2012 | 1:45:46 PM | 12.81 | 3.999 | 17.1347 | 3.203 | 51.227 | 0.071 | 242.80 | 12.860 | 3.9990 | 51.427 | 0.071 | 243.66 | 12.80 | 0.008 |
| ### | May 8, 2012 | 1:45:51 PM | 12.81 | 3.999 | 17.1402 | 3.203 | 51.227 | 0.071 | 242.87 | 12.860 | 3.9990 | 51.427 | 0.071 | 243.73 | 12.80 | 0.007 |
| ### | May 8, 2012 | 1:45:56 PM | 12.81 | 3.999 | 17.1458 | 3.203 | 51.227 | 0.071 | 242.94 | 12.860 | 3.9990 | 51.427 | 0.071 | 243.80 | 12.80 | 0.007 |
| ### | May 8, 2012 | 1:46:01 PM | 12.81 | 3.999 | 17.1513 | 3.203 | 51.227 | 0.071 | 243.01 | 12.860 | 3.9990 | 51.427 | 0.071 | 243.87 | 12.80 | 0.006 |
| ### | May 8, 2012 | 1:46:06 PM | 12.81 | 3.999 | 17.1568 | 3.203 | 51.227 | 0.071 | 243.08 | 12.860 | 3.9990 | 51.427 | 0.071 | 243.94 | 12.80 | 0.006 |
| ### | May 8, 2012 | 1:46:11 PM | 12.81 | 3.999 | 17.1624 | 3.203 | 51.227 | 0.071 | 243.16 | 12.860 | 3.9990 | 51.427 | 0.071 | 244.02 | 12.80 | 0.007 |
| ### | May 8, 2012 | 1:46:16 PM | 12.80 | 3.999 | 17.1679 | 3.200 | 51.187 | 0.071 | 243.23 | 12.850 | 3.9990 | 51.387 | 0.071 | 244.09 | 12.80 | −0.003 |
| ### | May 8, 2012 | 1:46:21 PM | 12.79 | 3.999 | 17.1735 | 3.298 | 51.147 | 0.071 | 243.30 | 12.840 | 3.9990 | 51.347 | 0.071 | 244.16 | 12.80 | −0.015 |
| ### | May 8, 2012 | 1:46:26 PM | 12.79 | 3.999 | 17.1790 | 3.298 | 51.147 | 0.071 | 243.37 | 12.840 | 3.9990 | 51.347 | 0.071 | 244.23 | 12.80 | −0.015 |
| ### | May 8, 2012 | 1:46:31 PM | 12.78 | 3.999 | 17.1846 | 3.295 | 51.107 | 0.071 | 243.44 | 12.830 | 3.9990 | 51.307 | 0.071 | 244.30 | 12.81 | −0.026 |
| ### | May 8, 2012 | 1:46:36 PM | 12.81 | 3.999 | 17.1901 | 3.203 | 51.227 | 0.071 | 243.51 | 12.860 | 3.9990 | 51.427 | 0.071 | 244.37 | 12.81 | 0.003 |
| ### | May 8, 2012 | 1:46:41 PM | 12.81 | 3.999 | 17.1957 | 3.203 | 51.227 | 0.071 | 243.58 | 12.860 | 3.9990 | 51.427 | 0.071 | 244.44 | 12.81 | 0.002 |
| ### | May 8, 2012 | 1:46:46 PM | 12.83 | 3.999 | 17.2012 | 3.208 | 51.307 | 0.071 | 243.65 | 12.880 | 3.9990 | 51.507 | 0.072 | 244.52 | 12.81 | 0.020 |
| ### | May 8, 2012 | 1:46:51 PM | 12.81 | 3.999 | 17.2067 | 3.203 | 51.227 | 0.071 | 243.72 | 12.860 | 3.9990 | 51.427 | 0.071 | 244.59 | 12.81 | −0.003 |
| ### | May 8, 2012 | 1:46:56 PM | 12.83 | 3.999 | 17.2123 | 3.208 | 51.307 | 0.071 | 243.80 | 12.880 | 3.9990 | 51.507 | 0.072 | 244.66 | 12.82 | 0.015 |
| ### | May 8, 2012 | 1:47:01 PM | 12.82 | 3.999 | 17.2178 | 3.205 | 51.267 | 0.071 | 243.87 | 12.870 | 3.9990 | 51.467 | 0.071 | 244.73 | 12.82 | 0.001 |
| ### | May 8, 2012 | 1:47:06 PM | 12.82 | 3.999 | 17.2234 | 3.205 | 51.267 | 0.071 | 243.94 | 12.870 | 3.9990 | 51.467 | 0.071 | 244.80 | 12.82 | 0.000 |
| ### | May 8, 2012 | 1:47:11 PM | 12.82 | 3.999 | 17.2289 | 3.205 | 51.267 | 0.071 | 244.01 | 12.870 | 3.9990 | 51.467 | 0.071 | 244.87 | 12.82 | 0.001 |
| ### | May 8, 2012 | 1:47:16 PM | 12.82 | 3.999 | 17.2345 | 3.205 | 51.267 | 0.071 | 244.08 | 12.870 | 3.9990 | 51.467 | 0.071 | 244.94 | 12.82 | 0.001 |
| ### | May 8, 2012 | 1:47:21 PM | 12.82 | 3.999 | 17.2400 | 3.205 | 51.267 | 0.071 | 24 [symbol] | 12.8 [symbol] | 3.9990 | 51.467 | 0.071 | 245.02 | 12.82 | 0.001 |
| ### | May 8, 2012 | 1:47:26 PM | 12.82 | 3.999 | 17.2454 | 3.205 | 51.267 | 0.071 | 244.22 | 12.870 | 3.9990 | 51.467 | 0.071 | 245.09 | 12.82 | 0.003 |
| ### | May 8, 2012 | 1:47:31 PM | 12.82 | 3.999 | 17.2509 | 3.205 | 51.267 | 0.071 | 244.29 | 12.870 | 3.9990 | 51.467 | 0.071 | 245.16 | 12.82 | 0.004 |
| ### | May 8, 2012 | 1:47:36 PM | 12.82 | 3.999 | 17.2565 | 3.205 | 51.267 | 0.071 | 244.37 | 12.870 | 3.9990 | 51.467 | 0.071 | 245.23 | 12.82 | 0.005 |
| ### | May 8, 2012 | 1:47:41 PM | 12.81 | 3.999 | 17.2620 | 3.203 | 51.227 | 0.071 | 244.44 | 12.860 | 3.9990 | 51.427 | 0.071 | 245.30 | 12.81 | −0.005 |
| ### | May 8, 2012 | 1:47:46 PM | 12.81 | 3.999 | 17.2676 | 3.203 | 51.227 | 0.071 | 244.51 | 12.860 | 3.9990 | 51.427 | 0.071 | 245.37 | 12.81 | −0.004 |
| ### | May 8, 2012 | 1:47:51 PM | 12.81 | 3.999 | 17.2731 | 3.203 | 51.227 | 0.071 | 244.58 | 12.860 | 3.9990 | 51.427 | 0.071 | 245.44 | 12.81 | −0.003 |
| ### | May 8, 2012 | 1:47:56 PM | 12.81 | 3.999 | 17.2786 | 3.203 | 51.227 | 0.071 | 244.65 | 12.860 | 3.9990 | 51.427 | 0.071 | 245.52 | 12.81 | −0.001 |
| ### | May 8, 2012 | 1:48:01 PM | 12.81 | 3.999 | 17.2842 | 3.203 | 51.227 | 0.071 | 244.72 | 12.860 | 3.9990 | 51.427 | 0.071 | 245.59 | 12.81 | 0.001 |
| ### | May 8, 2012 | 1:48:06 PM | 12.81 | 3.999 | 17.2897 | 3.203 | 51.227 | 0.071 | 244.79 | 12.860 | 3.9990 | 51.427 | 0.071 | 245.66 | 12.81 | 0.003 |
| ### | May 8, 2012 | 1:48:11 PM | 12.81 | 3.999 | 17.2953 | 3.203 | 51.227 | 0.071 | 244.86 | 12.860 | 3.9990 | 51.427 | 0.071 | 245.73 | 12.81 | 0.004 |
| ### | May 8, 2012 | 1:48:16 PM | 12.81 | 3.999 | 17.3008 | 3.203 | 51.227 | 0.071 | 244.93 | 12.860 | 3.9990 | 51.427 | 0.071 | 245.80 | 12.80 | 0.005 |
| ### | May 8, 2012 | 1:48:21 PM | 12.80 | 3.999 | 17.3064 | 3.200 | 51.187 | 0.071 | 245.01 | 12.850 | 3.9990 | 51.387 | 0.071 | 245.87 | 12.80 | −0.002 |
| ### | May 8, 2012 | 1:48:26 PM | 12.80 | 3.999 | 17.3119 | 3.200 | 51.187 | 0.071 | 245.08 | 12.850 | 3.9990 | 51.387 | 0.071 | 245.94 | 12.80 | 0.001 |
| ### | May 8, 2012 | 1:48:31 PM | 12.80 | 3.999 | 17.3174 | 3.200 | 51.187 | 0.071 | 245.15 | 12.850 | 3.9990 | 51.387 | 0.071 | 246.02 | 12.80 | 0.004 |
| ### | May 8, 2012 | 1:48:36 PM | 12.80 | 3.999 | 17.3230 | 3.200 | 51.187 | 0.071 | 245.22 | 12.850 | 3.9990 | 51.387 | 0.071 | 246.09 | 12.79 | 0.007 |
| ### | May 8, 2012 | 1:48:41 PM | 12.79 | 3.999 | 17.3285 | 3.198 | 51.147 | 0.071 | 245.29 | 12.840 | 3.9990 | 51.347 | 0.071 | 246.16 | 12.79 | 0.001 |
| ### | May 8, 2012 | 1:48:46 PM | 12.78 | 3.999 | 17.3341 | 3.195 | 51.107 | 0.071 | 245.36 | 12.830 | 3.9990 | 51.307 | 0.071 | 246.23 | 12.79 | −0.005 |
| ### | May 8, 2012 | 1:48:51 PM | 12.78 | 3.999 | 17.3398 | 3.195 | 51.107 | 0.071 | 245.43 | 12.830 | 3.9990 | 51.307 | 0.071 | 246.30 | 12.78 | −0.001 |
| ### | May 8, 2012 | 1:48:56 PM | 12.78 | 3.999 | 17.3453 | 3.195 | 51.107 | 0.071 | 245.50 | 12.830 | 3.9990 | 51.307 | 0.071 | 246.37 | 12.78 | 0.005 |
| ### | May 8, 2012 | 1:49:01 PM | 12.77 | 3.999 | 17.3509 | 3.193 | 51.067 | 0.071 | 245.57 | 12.820 | 3.9990 | 51.267 | 0.071 | 246.44 | 12.77 | 0.001 |
| ### | May 8, 2012 | 1:49:06 PM | 12.77 | 3.999 | 17.3564 | 3.193 | 51.067 | 0.071 | 245.65 | 12.820 | 3.9990 | 51.267 | 0.071 | 246.51 | 12.76 | 0.006 |
| ### | May 8, 2012 | 1:49:11 PM | 12.77 | 3.999 | 17.3620 | 3.193 | 51.067 | 0.071 | 245.72 | 12.820 | 3.9990 | 51.267 | 0.071 | 246.59 | 12.76 | 0.007 |
| ### | May 8, 2012 | 1:49:16 PM | 12.75 | 3.999 | 17.3675 | 3.188 | 50.987 | 0.071 | 245.79 | 12.800 | 3.9990 | 51.187 | 0.071 | 246.66 | 12.76 | −0.013 |
| ### | May 8, 2012 | 1:49:21 PM | 12.74 | 3.999 | 17.3731 | 3.185 | 50.947 | 0.071 | 245.86 | 12.790 | 3.9990 | 51.147 | 0.071 | 246.73 | 12.76 | −0.022 |
| ### | May 8, 2012 | 1:49:26 PM | 12.73 | 3.999 | 17.3786 | 3.183 | 50.907 | 0.071 | 245.93 | 12.780 | 3.9990 | 51.107 | 0.071 | 246.80 | 12.76 | −0.031 |
| ### | May 8, 2012 | 1:49:31 PM | 12.74 | 3.999 | 17.3841 | 3.185 | 50.947 | 0.071 | 246.00 | 12.790 | 3.9990 | 51.147 | 0.071 | 246.87 | 12.76 | −0.021 |
| ### | May 8, 2012 | 1:49:36 PM | 12.78 | 3.999 | 17.3897 | 3.195 | 50.107 | 0.071 | 246.07 | 12.830 | 3.9990 | 51.307 | 0.071 | 246.94 | 12.76 | 0.020 |
| ### | May 8, 2012 | 1:49:41 PM | 12.78 | 3.999 | 17.3952 | 3.195 | 50.107 | 0.071 | 246.14 | 12.830 | 3.9990 | 51.307 | 0.071 | 247.01 | 12.76 | 0.021 |
| ### | May 8, 2012 | 1:49:46 PM | 12.77 | 3.999 | 17.4008 | 3.193 | 50.067 | 0.071 | 246.21 | 12.820 | 3.9990 | 51.267 | 0.071 | 247.08 | 12.76 | 0.010 |
| ### | May 8, 2012 | 1:49:51 PM | 12.77 | 3.999 | 17.4063 | 3.193 | 50.067 | 0.071 | 246.28 | 12.820 | 3.9990 | 51.267 | 0.071 | 247.15 | 12.76 | 0.008 |
| ### | May 8, 2012 | 1:49:56 PM | 12.77 | 3.999 | 17.4119 | 3.193 | 50.067 | 0.071 | 246.35 | 12.820 | 3.9990 | 51.267 | 0.071 | 247.23 | 12.76 | 0.006 |
| ### | May 8, 2012 | 1:50:01 PM | 12.76 | 3.999 | 17.4174 | 3.190 | 50.027 | 0.071 | 246.42 | 12.810 | 3.9990 | 51.227 | 0.071 | 247.30 | 12.76 | −0.005 |
| ### | May 8, 2012 | 1:50:06 PM | 12.76 | 3.999 | 17.4230 | 3.190 | 50.027 | 0.071 | 246.50 | 12.810 | 3.9990 | 51.227 | 0.071 | 247.37 | 12.76 | −0.001 |
| ### | May 8, 2012 | 1:50:11 PM | 12.76 | 3.999 | 17.4285 | 3.190 | 50.027 | 0.071 | 246.57 | 12.810 | 3.9990 | 51.227 | 0.071 | 247.44 | 12.76 | 0.004 |
| ### | May 8, 2012 | 1:50:16 PM | 12.76 | 3.999 | 17.4340 | 3.190 | 50.027 | 0.071 | 246.64 | 12.810 | 3.9990 | 51.227 | 0.071 | 247.51 | 12.75 | 0.008 |
| ### | May 8, 2012 | 1:50:21 PM | 12.75 | 3.999 | 17.4396 | 3.188 | 50.987 | 0.071 | 246.71 | 12.800 | 3.9990 | 51.187 | 0.071 | 247.58 | 12.75 | 0.003 |
| ### | May 8, 2012 | 1:50:26 PM | 12.75 | 3.999 | 17.4452 | 3.188 | 50.987 | 0.071 | 246.78 | 12.800 | 3.9990 | 51.187 | 0.071 | 247.65 | 12.74 | 0.007 |
| ### | May 8, 2012 | 1:50:31 PM | 12.74 | 3.999 | 17.4507 | 3.185 | 50.947 | 0.071 | 246.85 | 12.790 | 3.9990 | 51.147 | 0.071 | 247.72 | 12.74 | 0.002 |
| ### | May 8, 2012 | 1:50:36 PM | 12.73 | 3.999 | 17.4562 | 3.183 | 50.907 | 0.071 | 246.92 | 12.780 | 3.9990 | 51.107 | 0.071 | 247.79 | 12.74 | −0.007 |
| ### | May 8, 2012 | 1:50:41 PM | 12.72 | 3.999 | 17.4618 | 3.180 | 50.867 | 0.071 | 246.99 | 12.770 | 3.9990 | 51.067 | 0.071 | 247.87 | 12.74 | −0.016 |
| ### | May 8, 2012 | 1:50:46 PM | 12.72 | 3.999 | 17.4674 | 3.180 | 50.867 | 0.071 | 247.06 | 12.770 | 3.9990 | 51.067 | 0.071 | 247.94 | 12.74 | −0.015 |
| ### | May 8, 2012 | 1:50:51 PM | 12.72 | 3.999 | 17.4729 | 3.180 | 50.867 | 0.071 | 247.13 | 12.770 | 3.9990 | 51.067 | 0.071 | 248.01 | 12.74 | −0.015 |
| ### | May 8, 2012 | 1:50:56 PM | 12.71 | 3.999 | 17.4784 | 3.178 | 50.827 | 0.071 | 247.20 | 12.760 | 3.9990 | 51.027 | 0.071 | 248.08 | 12.74 | −0.025 |
| ### | May 8, 2012 | 1:51:01 PM | 12.75 | 3.999 | 17.4840 | 3.188 | 50.987 | 0.071 | 247.27 | 12.800 | 3.9990 | 51.187 | 0.071 | 248.15 | 12.74 | 0.015 |
| ### | May 8, 2012 | 1:51:06 PM | 12.75 | 3.999 | 17.4895 | 3.188 | 50.987 | 0.071 | 247.34 | 12.800 | 3.9990 | 51.187 | 0.071 | 248.22 | 12.74 | 0.014 |
| ### | May 8, 2012 | 1:51:11 PM | 12.75 | 3.999 | 17.4951 | 3.188 | 50.987 | 0.071 | 247.42 | 12.800 | 3.9990 | 51.187 | 0.071 | 248.29 | 12.74 | 0.013 |
| ### | May 8, 2012 | 1:51:16 PM | 12.75 | 3.999 | 17.5006 | 3.188 | 50.987 | 0.071 | 247.49 | 12.800 | 3.9990 | 51.187 | 0.071 | 248.36 | 12.74 | 0.013 |
| ### | May 8, 2012 | 1:51:21 PM | 12.75 | 3.999 | 17.5060 | 3.188 | 50.987 | 0.071 | 247.56 | 12.800 | 3.9990 | 51.187 | 0.071 | 248.43 | 12.74 | 0.013 |
| ### | May 8, 2012 | 1:51:26 PM | 12.74 | 3.999 | 17.5115 | 3.185 | 50.947 | 0.071 | 247.63 | 12.790 | 3.9990 | 51.147 | 0.071 | 248.50 | 12.74 | 0.004 |
| ### | May 8, 2012 | 1:51:31 PM | 12.74 | 3.999 | 17.5170 | 3.185 | 50.947 | 0.071 | 247.70 | 12.790 | 3.9990 | 51.147 | 0.071 | 248.58 | 12.73 | 0.008 |
| ### | May 8, 2012 | 1:51:36 PM | 12.73 | 3.999 | 17.5226 | 3.183 | 50.907 | 0.071 | 247.77 | 12.780 | 3.9990 | 51.107 | 0.071 | 248.65 | 12.73 | 0.001 |
| ### | May 8, 2012 | 1:51:41 PM | 12.72 | 3.999 | 17.5281 | 3.180 | 50.867 | 0.071 | 247.84 | 12.770 | 3.9990 | 51.067 | 0.071 | 248.72 | 12.72 | −0.003 |
| ### | May 8, 2012 | 1:51:46 PM | 12.72 | 3.999 | 17.5337 | 3.180 | 50.867 | 0.071 | 247.91 | 12.770 | 3.9990 | 51.067 | 0.071 | 248.79 | 12.72 | −0.003 |
| ### | May 8, 2012 | 1:51:51 PM | 12.70 | 3.999 | 17.5392 | 3.175 | 50.787 | 0.071 | 247.98 | 12.750 | 3.9990 | 51.987 | 0.071 | 248.86 | 12.72 | −0.023 |
| ### | May 8, 2012 | 1:51:56 PM | 12.70 | 3.999 | 17.5448 | 3.175 | 50.787 | 0.071 | 248.05 | 12.750 | 3.9990 | 51.987 | 0.071 | 248.93 | 12.72 | −0.024 |
| ### | May 8, 2012 | 1:52:01 PM | 12.72 | 3.999 | 17.5503 | 3.180 | 50.867 | 0.071 | 248.12 | 12.770 | 3.9990 | 51.067 | 0.071 | 249.00 | 12.72 | −0.004 |
| ### | May 8, 2012 | 1:52:06 PM | 12.68 | 3.999 | 17.5559 | 3.170 | 50.707 | 0.070 | 248.19 | 12.730 | 3.9990 | 51.907 | 0.071 | 249.07 | 12.72 | −0.045 |
| ### | May 8, 2012 | 1:52:11 PM | 12.75 | 3.999 | 17.5616 | 3.188 | 50.987 | 0.071 | 248.26 | 12.800 | 3.9990 | 51.187 | 0.071 | 249.14 | 12.73 | 0.024 |
| ### | May 8, 2012 | 1:52:16 PM | 12.75 | 3.999 | 17.5671 | 3.188 | 50.987 | 0.071 | 248.33 | 12.800 | 3.9990 | 51.187 | 0.071 | 249.21 | 12.73 | 0.023 |
| ### | May 8, 2012 | 1:52:21 PM | 12.75 | 3.999 | 17.5727 | 3.188 | 50.987 | 0.071 | 248.41 | 12.800 | 3.9990 | 51.187 | 0.071 | 249.29 | 12.73 | 0.020 |
| ### | May 8, 2012 | 1:52:26 PM | 12.74 | 3.999 | 17.5782 | 3.185 | 50.947 | 0.071 | 248.48 | 12.790 | 3.9990 | 51.147 | 0.071 | 249.36 | 12.73 | 0.007 |
| ### | May 8, 2012 | 1:52:31 PM | 12.74 | 3.999 | 17.5838 | 3.185 | 50.947 | 0.071 | 248.55 | 12.790 | 3.9990 | 51.147 | 0.071 | 249.43 | 12.73 | 0.007 |
| ### | May 8, 2012 | 1:52:36 PM | 12.74 | 3.999 | 17.5893 | 3.185 | 50.947 | 0.071 | 248.62 | 12.790 | 3.9990 | 51.147 | 0.071 | 249.50 | 12.74 | 0.004 |
| ### | May 8, 2012 | 1:52:41 PM | 12.73 | 3.999 | 17.5949 | 3.183 | 50.907 | 0.071 | 248.69 | 12.780 | 3.9990 | 51.107 | 0.071 | 249.57 | 12.73 | −0.003 |
| ### | May 8, 2012 | 1:52:46 PM | 12.73 | 3.999 | 17.6002 | 3.183 | 50.907 | 0.071 | 248.76 | 12.780 | 3.9990 | 51.107 | 0.071 | 249.64 | 12.73 | 0.002 |
| ### | May 8, 2012 | 1:52:51 PM | 12.73 | 3.999 | 17.6058 | 3.183 | 50.907 | 0.071 | 248.83 | 12.780 | 3.9990 | 51.107 | 0.071 | 249.71 | 12.73 | 0.005 |
| ### | May 8, 2012 | 1:52:56 PM | 12.72 | 3.999 | 17.6113 | 3.180 | 50.867 | 0.071 | 248.90 | 12.770 | 3.9990 | 51.067 | 0.071 | 249.78 | 12.72 | −0.004 |
| ### | May 8, 2012 | 1:53:01 PM | 12.72 | 3.999 | 17.6168 | 3.180 | 50.867 | 0.071 | 248.97 | 12.770 | 3.9990 | 51.067 | 0.071 | 249.85 | 12.72 | 0.002 |
| ### | May 8, 2012 | 1:53:06 PM | 12.71 | 3.999 | 17.6224 | 3.178 | 50.827 | 0.071 | 249.04 | 12.760 | 3.9990 | 51.027 | 0.071 | 249.92 | 12.71 | −0.003 |
| ### | May 8, 2012 | 1:53:11 PM | 12.70 | 3.999 | 17.6279 | 3.175 | 50.787 | 0.071 | 249.11 | 12.750 | 3.9990 | 51.987 | 0.071 | 249.99 | 12.71 | −0.010 |
| ### | May 8, 2012 | 1:53:16 PM | 12.72 | 3.999 | 17.6335 | 3.180 | 50.867 | 0.071 | 249.18 | 12.770 | 3.9990 | 51.067 | 0.071 | 250.07 | 12.71 | 0.011 |
| ### | May 8, 2012 | 1:53:21 PM | 12.72 | 3.999 | 17.6390 | 3.180 | 50.867 | 0.071 | 249.25 | 12.770 | 3.9990 | 51.067 | 0.071 | 250.14 | 12.71 | 0.012 |
| ### | May 8, 2012 | 1:53:26 PM | 12.68 | 3.999 | 17.6446 | 3.170 | 50.707 | 0.070 | 249.32 | 12.730 | 3.9990 | 51.907 | 0.071 | 250.21 | 12.71 | −0.027 |
| ### | May 8, 2012 | 1:53:31 PM | 12.68 | 3.999 | 17.6501 | 3.170 | 50.707 | 0.070 | 249.39 | 12.730 | 3.9990 | 51.907 | 0.071 | 250.28 | 12.71 | −0.025 |
| ### | May 8, 2012 | 1:53:36 PM | 12.70 | 3.999 | 17.6556 | 3.175 | 50.787 | 0.071 | 249.46 | 12.750 | 3.9990 | 51.987 | 0.071 | 250.35 | 12.71 | −0.005 |
| ### | May 8, 2012 | 1:53:41 PM | 12.72 | 3.999 | 17.6612 | 3.180 | 50. [symbol] | 0 [symbol] | [symbol] | [symbol] | 3.9990 | 51.067 | 0.071 | 250.42 | 12.70 | 0.017 |
| ### | May 8, 2012 | 1:53:46 PM | 12.72 | 3.999 | 17.6667 | 3.180 | 50.867 | 0.071 | 249.61 | 12.770 | 3.9990 | 51.067 | 0.071 | 250.49 | 12.70 | 0.020 |
| ### | May 8, 2012 | 1:53:51 PM | 12.71 | 3.999 | 17.6723 | 3.178 | 50.827 | 0.071 | 249.68 | 12.760 | 3.9990 | 51.027 | 0.071 | 250.56 | 12.70 | 0.014 |
| ### | May 8, 2012 | 1:53:56 PM | 12.70 | 3.999 | 17.6778 | 3.175 | 50.787 | 0.071 | 249.75 | 12.750 | 3.9990 | 50.987 | 0.071 | 250.63 | 12.70 | 0.005 |
| ### | May 8, 2012 | 1:54:01 PM | 12.71 | 3.999 | 17.6834 | 3.178 | 50.827 | 0.071 | 249.82 | 12.760 | 3.9990 | 51.027 | 0.071 | 250.70 | 12.69 | 0.016 |
| ### | May 8, 2012 | 1:54:06 PM | 12.67 | 3.999 | 17.6889 | 3.168 | 50.667 | 0.070 | 249.89 | 12.720 | 3.9990 | 50.867 | 0.071 | 250.77 | 12.69 | −0.021 |
| ### | May 8, 2012 | 1:54:11 PM | 12.69 | 3.999 | 17.6945 | 3.173 | 50.747 | 0.070 | 249.96 | 12.740 | 3.9990 | 50.947 | 0.071 | 250.84 | 12.69 | −0.002 |
| ### | May 8, 2012 | 1:54:16 PM | 12.68 | 3.999 | 17.7000 | 3.170 | 50.707 | 0.070 | 250.03 | 12.730 | 3.9990 | 50.907 | 0.071 | 250.92 | 12.69 | −0.011 |
| ### | May 8, 2012 | 1:54:21 PM | 12.67 | 3.999 | 17.7055 | 3.168 | 50.667 | 0.070 | 250.10 | 12.720 | 3.9990 | 50.867 | 0.071 | 250.99 | 12.69 | −0.021 |
| ### | May 8, 2012 | 1:54:26 PM | 12.66 | 3.999 | 17.7111 | 3.165 | 50.627 | 0.070 | 250.17 | 12.710 | 3.9990 | 50.827 | 0.071 | 251.06 | 12.69 | −0.034 |
| ### | May 8, 2012 | 1:54:31 PM | 12.67 | 3.999 | 17.7166 | 3.168 | 50.667 | 0.070 | 250.24 | 12.720 | 3.9990 | 50.867 | 0.071 | 251.13 | 12.70 | −0.025 |
| ### | May 8, 2012 | 1:54:36 PM | 12.73 | 3.999 | 17.7222 | 3.183 | 50.907 | 0.071 | 250.31 | 12.780 | 3.9990 | 51.107 | 0.071 | 251.20 | 12.70 | 0.031 |
| ### | May 8, 2012 | 1:54:41 PM | 12.71 | 3.999 | 17.7278 | 3.178 | 50.827 | 0.071 | 250.38 | 12.760 | 3.9990 | 51.027 | 0.071 | 251.27 | 12.70 | 0.009 |
| ### | May 8, 2012 | 1:54:46 PM | 12.71 | 3.999 | 17.7333 | 3.178 | 50.827 | 0.071 | 250.45 | 12.760 | 3.9990 | 51.027 | 0.071 | 251.34 | 12.70 | 0.012 |
| ### | May 8, 2012 | 1:54:51 PM | 12.73 | 3.999 | 17.7388 | 3.183 | 50.907 | 0.071 | 250.52 | 12.780 | 3.9990 | 51.107 | 0.071 | 251.41 | 12.70 | 0.030 |
| ### | May 8, 2012 | 1:54:56 PM | 12.73 | 3.999 | 17.7443 | 3.183 | 50.907 | 0.071 | 250.59 | 12.780 | 3.9990 | 51.107 | 0.071 | 251.48 | 12.70 | 0.029 |
| ### | May 8, 2012 | 1:55:01 PM | 12.71 | 3.999 | 17.7501 | 3.178 | 50.827 | 0.071 | 250.66 | 12.760 | 3.9990 | 51.027 | 0.071 | 251.55 | 12.70 | 0.006 |
| ### | May 8, 2012 | 1:55:06 PM | 12.71 | 3.999 | 17.7556 | 3.178 | 50.827 | 0.071 | 250.73 | 12.760 | 3.9990 | 51.027 | 0.071 | 251.62 | 12.70 | 0.009 |
| ### | May 8, 2012 | 1:55:11 PM | 12.65 | 3.999 | 17.7612 | 3.163 | 50.587 | 0.070 | 250.80 | 12.700 | 3.9990 | 50.787 | 0.071 | 251.69 | 12.70 | −0.046 |
| ### | May 8, 2012 | 1:55:16 PM | 12.69 | 3.999 | 17.7667 | 3.173 | 50.747 | 0.070 | 250.88 | 12.740 | 3.9990 | 50.947 | 0.071 | 251.76 | 12.69 | −0.001 |
| ### | May 8, 2012 | 1:55:21 PM | 12.67 | 3.999 | 17.7722 | 3.168 | 50.667 | 0.070 | 250.95 | 12.720 | 3.9990 | 50.867 | 0.071 | 251.84 | 12.68 | −0.014 |
| ### | May 8, 2012 | 1:55:26 PM | 12.70 | 3.999 | 17.7778 | 3.175 | 50.787 | 0.071 | 251.02 | 12.750 | 3.9990 | 50.987 | 0.071 | 251.91 | 12.68 | 0.023 |
| ### | May 8, 2012 | 1:55:31 PM | 12.70 | 3.999 | 17.7834 | 3.175 | 50.787 | 0.071 | 251.09 | 12.750 | 3.9990 | 50.987 | 0.071 | 251.98 | 12.67 | 0.028 |
| ### | May 8, 2012 | 1:55:36 PM | 12.66 | 3.999 | 17.7889 | 3.165 | 50.627 | 0.070 | 251.16 | 12.710 | 3.9990 | 50.827 | 0.071 | 252.05 | 12.67 | −0.008 |
| ### | May 8, 2012 | 1:55:41 PM | 12.65 | 3.999 | 17.7944 | 3.163 | 50.587 | 0.070 | 251.23 | 12.700 | 3.9990 | 50.787 | 0.071 | 252.12 | 12.67 | −0.019 |
| ### | May 8, 2012 | 1:55:46 PM | 12.65 | 3.999 | 17.8000 | 3.163 | 50.587 | 0.070 | 251.30 | 12.700 | 3.9990 | 50.787 | 0.071 | 252.19 | 12.67 | −0.019 |
| ### | May 8, 2012 | 1:55:51 PM | 12.66 | 3.999 | 17.8055 | 3.165 | 50.627 | 0.070 | 251.37 | 12.710 | 3.9990 | 50.827 | 0.071 | 252.26 | 12.67 | −0.009 |
| ### | May 8, 2012 | 1:55:56 PM | 12.65 | 3.999 | 17.8110 | 3.163 | 50.587 | 0.070 | 251.44 | 12.700 | 3.9990 | 50.787 | 0.071 | 252.33 | 12.67 | −0.016 |
| ### | May 8, 2012 | 1:56:01 PM | 12.67 | 3.999 | 17.8166 | 3.168 | 50.667 | 0.070 | 251.51 | 12.720 | 3.9990 | 50.867 | 0.071 | 252.40 | 12.66 | 0.009 |
| ### | May 8, 2012 | 1:56:06 PM | 12.66 | 3.999 | 17.8222 | 3.165 | 50.627 | 0.070 | 251.58 | 12.710 | 3.9990 | 50.827 | 0.071 | 252.47 | 12.66 | −0.005 |
| ### | May 8, 2012 | 1:56:11 PM | 12.69 | 3.999 | 17.8277 | 3.173 | 50.747 | 0.070 | 251.65 | 12.740 | 3.9990 | 50.947 | 0.071 | 252.54 | 12.67 | 0.022 |
| ### | May 8, 2012 | 1:56:16 PM | 12.67 | 3.999 | 17.8332 | 3.168 | 50.667 | 0.070 | 251.72 | 12.720 | 3.9990 | 50.867 | 0.071 | 252.61 | 12.67 | −0.002 |
| ### | May 8, 2012 | 1:56:21 PM | 12.67 | 3.999 | 17.8388 | 3.168 | 50.667 | 0.070 | 251.79 | 12.720 | 3.9990 | 50.867 | 0.071 | 252.68 | 12.67 | −0.005 |
| ### | May 8, 2012 | 1:56:26 PM | 12.64 | 3.999 | 17.8443 | 3.160 | 50.547 | 0.070 | 251.86 | 12.690 | 3.9990 | 50.747 | 0.070 | 252.75 | 12.68 | −0.037 |
| ### | May 8, 2012 | 1:56:31 PM | 12.70 | 3.999 | 17.8499 | 3.175 | 50.787 | 0.071 | 251.93 | 12.750 | 3.9990 | 50.987 | 0.071 | 252.82 | 12.68 | 0.024 |
| ### | May 8, 2012 | 1:56:36 PM | 12.69 | 3.999 | 17.8554 | 3.173 | 50.747 | 0.070 | 252.00 | 12.740 | 3.9990 | 50.947 | 0.071 | 252.90 | 12.68 | 0.010 |
| ### | May 8, 2012 | 1:56:41 PM | 12.69 | 3.999 | 17.8609 | 3.173 | 50.747 | 0.070 | 252.07 | 12.740 | 3.9990 | 50.947 | 0.071 | 252.97 | 12.68 | 0.009 |
| ### | May 8, 2012 | 1:56:46 PM | 12.69 | 3.999 | 17.8665 | 3.173 | 50.747 | 0.070 | 252.14 | 12.740 | 3.9990 | 50.947 | 0.071 | 253.04 | 12.68 | 0.006 |
| ### | May 8, 2012 | 1:56:51 PM | 12.68 | 3.999 | 17.8720 | 3.170 | 50.707 | 0.070 | 252.21 | 12.730 | 3.9990 | 50.907 | 0.071 | 253.11 | 12.69 | −0.006 |
| ### | May 8, 2012 | 1:56:56 PM | 12.66 | 3.999 | 17.8776 | 3.165 | 50.627 | 0.070 | 252.28 | 12.710 | 3.9990 | 50.827 | 0.071 | 253.18 | 12.69 | −0.032 |
| ### | May 8, 2012 | 1:57:01 PM | 12.70 | 3.999 | 17.8831 | 3.175 | 50.787 | 0.071 | 252.35 | 12.750 | 3.9990 | 50.987 | 0.071 | 253.25 | 12.69 | 0.012 |
| ### | May 8, 2012 | 1:57:06 PM | 12.70 | 3.999 | 17.8887 | 3.175 | 50.787 | 0.071 | 252.42 | 12.750 | 3.9990 | 50.987 | 0.071 | 253.32 | 12.68 | 0.015 |
| ### | May 8, 2012 | 1:57:11 PM | 12.70 | 3.999 | 17.8942 | 3.175 | 50.787 | 0.071 | 252.49 | 12.750 | 3.9990 | 50.987 | 0.071 | 253.39 | 12.68 | 0.021 |
| ### | May 8, 2012 | 1:57:16 PM | 12.70 | 3.999 | 17.8998 | 3.175 | 50.787 | 0.071 | 252.57 | 12.750 | 3.9990 | 50.987 | 0.071 | 253.46 | 12.67 | 0.025 |
| ### | May 8, 2012 | 1:57:21 PM | 12.70 | 3.999 | 17.9053 | 3.175 | 50.787 | 0.071 | 252.64 | 12.750 | 3.9990 | 50.987 | 0.071 | 253.53 | 12.67 | 0.030 |
| ### | May 8, 2012 | 1:57:26 PM | 12.66 | 3.999 | 17.9109 | 3.165 | 50.627 | 0.070 | 252.71 | 12.710 | 3.9990 | 50.827 | 0.071 | 253.60 | 12.67 | −0.006 |
| ### | May 8, 2012 | 1:57:31 PM | 12.65 | 3.999 | 17.9164 | 3.163 | 50.587 | 0.070 | 252.78 | 12.700 | 3.9990 | 50.787 | 0.071 | 253.67 | 12.66 | −0.010 |
| ### | May 8, 2012 | 1:57:36 PM | 12.63 | 3.999 | 17.9219 | 3.158 | 50.507 | 0.070 | 252.85 | 12.680 | 3.9990 | 50.707 | 0.070 | 253.74 | 12.65 | −0.025 |
| ### | May 8, 2012 | 1:57:41 PM | 12.64 | 3.999 | 17.9275 | 3.160 | 50.547 | 0.070 | 252.92 | 12.690 | 3.9990 | 50.747 | 0.070 | 253.81 | 12.65 | −0.008 |
| ### | May 8, 2012 | 1:57:46 PM | 12.63 | 3.999 | 17.9330 | 3.158 | 50.507 | 0.070 | 252.99 | 12.680 | 3.9990 | 50.707 | 0.070 | 253.88 | 12.64 | −0.011 |
| ### | May 8, 2012 | 1:57:51 PM | 12.62 | 3.999 | 17.9386 | 3.155 | 50.467 | 0.070 | 253.06 | 12.670 | 3.9990 | 50.667 | 0.070 | 253.96 | 12.63 | −0.014 |
| ### | May 8, 2012 | 1:57:56 PM | 12.63 | 3.999 | 17.9441 | 3.158 | 50.507 | 0.070 | 253.13 | 12.680 | 3.9990 | 50.707 | 0.070 | 254.03 | 12.63 | 0.002 |
| ### | May 8, 2012 | 1:58:01 PM | 12.64 | 3.999 | 17.9497 | 3.160 | 50.547 | 0.070 | 253.20 | 12.690 | 3.9990 | 50.747 | 0.070 | 254.10 | 12.62 | 0.016 |
| ### | May 8, 2012 | 1:58:06 PM | 12.63 | 3.999 | 17.9552 | 3.158 | 50.507 | 0.070 | 253.27 | 12.680 | 3.9990 | 50.707 | 0.070 | 254.17 | 12.62 | 0.008 |
| ### | May 8, 2012 | 1:58:11 PM | 12.62 | 3.999 | 17.9607 | 3.155 | 50.467 | 0.070 | 253.34 | 12.670 | 3.9990 | 50.667 | 0.070 | 254.24 | 12.62 | 0.004 |
| ### | May 8, 2012 | 1:58:16 PM | 12.62 | 3.999 | 17.9663 | 3.155 | 50.467 | 0.070 | 253.41 | 12.670 | 3.9990 | 50.667 | 0.070 | 254.31 | 12.61 | 0.005 |
| ### | May 8, 2012 | 1:58:21 PM | 12.60 | 3.999 | 17.9718 | 3.150 | 50.387 | 0.070 | 253.48 | 12.650 | 3.9990 | 50.587 | 0.070 | 254.38 | 12.62 | −0.019 |
| ### | May 8, 2012 | 1:58:26 PM | 12.60 | 3.999 | 17.9774 | 3.150 | 50.387 | 0.070 | 253.55 | 12.650 | 3.9990 | 50.587 | 0.070 | 254.45 | 12.62 | −0.024 |
| ### | May 8, 2012 | 1:58:31 PM | 12.61 | 3.999 | 17.9829 | 3.153 | 50.427 | 0.070 | 253.62 | 12.660 | 3.9990 | 50.627 | 0.070 | 254.52 | 12.62 | −0.011 |
| ### | May 8, 2012 | 1:58:36 PM | 12.58 | 3.999 | 17.9885 | 3.145 | 50.307 | 0.070 | 253.69 | 12.630 | 3.9990 | 50.507 | 0.070 | 254.59 | 12.62 | −0.040 |
| ### | May 8, 2012 | 1:58:41 PM | 12.61 | 3.999 | 17.9940 | 3.153 | 50.427 | 0.070 | 253.76 | 12.660 | 3.9990 | 50.627 | 0.070 | 254.66 | 12.62 | −0.009 |
| ### | May 8, 2012 | 1:58:46 PM | 12.67 | 3.999 | 17.9995 | 3.168 | 50.667 | 0.070 | 253.83 | 12.720 | 3.9990 | 50.867 | 0.071 | 254.73 | 12.62 | 0.051 |
| ### | May 8, 2012 | 1:58:51 PM | 12.68 | 3.999 | 17.0051 | 3.170 | 50.707 | 0.070 | 253.90 | 12.730 | 3.9990 | 50.907 | 0.071 | 254.80 | 12.62 | 0.060 |
| ### | May 8, 2012 | 1:58:56 PM | 12.61 | 3.999 | 17.0107 | 3.153 | 50.427 | 0.070 | 253.97 | 12.660 | 3.9990 | 50.627 | 0.070 | 254.87 | 12.62 | −0.011 |
| ### | May 8, 2012 | 1:59:01 PM | 12.62 | 3.999 | 17.0162 | 3.155 | 50.467 | 0.070 | 254.04 | 12.670 | 3.9990 | 50.667 | 0.070 | 254.94 | 12.62 | −0.001 |
| ### | May 8, 2012 | 1:59:06 PM | 12.61 | 3.999 | 17.0217 | 3.153 | 50.427 | 0.070 | 254.11 | 12.660 | 3.9990 | 50.627 | 0.070 | 255.01 | 12.62 | −0.014 |
| ### | May 8, 2012 | 1:59:11 PM | 12.62 | 3.999 | 17.0273 | 3.155 | 50.467 | 0.070 | 254.18 | 12.670 | 3.9990 | 50.667 | 0.070 | 255.08 | 12.62 | −0.004 |
| ### | May 8, 2012 | 1:59:16 PM | 12.61 | 3.999 | 17.0328 | 3.153 | 50.427 | 0.070 | 254.25 | 12.660 | 3.9990 | 50.627 | 0.070 | 255.15 | 12.62 | −0.007 |
| ### | May 8, 2012 | 1:59:21 PM | 12.61 | 3.999 | 17.0384 | 3.153 | 50.427 | 0.070 | 254.32 | 12.660 | 3.9990 | 50.627 | 0.070 | 255.22 | 12.61 | 0.001 |
| ### | May 8, 2012 | 1:59:26 PM | 12.61 | 3.999 | 17.0439 | 3.153 | 50.427 | 0.070 | 254.39 | 12.660 | 3.9990 | 50.627 | 0.070 | 255.29 | 12.61 | 0.000 |
| ### | May 8, 2012 | 1:59:31 PM | 12.61 | 3.999 | 17.0495 | 3.153 | 50.427 | 0.070 | 254.46 | 12.660 | 3.9990 | 50.627 | 0.070 | 255.36 | 12.61 | 0.002 |
| ### | May 8, 2012 | 1:59:36 PM | 12.61 | 3.999 | 17.0550 | 3.153 | 50.427 | 0.070 | 254.53 | 12.660 | 3.9990 | 50.627 | 0.070 | 255.43 | 12.61 | 0.004 |
| ### | May 8, 2012 | 1:59:41 PM | 12.60 | 3.999 | 17.0605 | 3.150 | 50.387 | 0.070 | 254.60 | 12.650 | 3.9990 | 50.587 | 0.070 | 255.50 | 12.60 | −0.004 |
| ### | May 8, 2012 | 1:59:46 PM | 12.61 | 3.999 | 17.0661 | 3.153 | 50.427 | 0.070 | 254.67 | 12.660 | 3.9990 | 50.627 | 0.070 | 255.57 | 12.60 | 0.009 |
| ### | May 8, 2012 | 1:59:51 PM | 12.60 | 3.999 | 17.0716 | 3.150 | 50.387 | 0.070 | 254.74 | 12.650 | 3.9990 | 50.587 | 0.070 | 255.64 | 12.60 | −0.001 |
| ### | May 8, 2012 | 1:59:56 PM | 12.60 | 3.999 | 17.0772 | 3.150 | 50.387 | 0.070 | 254.81 | 12.650 | 3.9990 | 50.587 | 0.070 | 255.71 | 12.60 | −0.003 |
| ### | May 8, 2012 | 2:00:01 PM | 12.59 | 3.999 | 18.0827 | 3.148 | 50. [symbol] | 0.070 | [symbol] | [symbol] | 3.9990 | 50.547 | 0.070 | 255.78 | 12.60 | −0.015 |
| ### | May 8, 2012 | 2:00:06 PM | 12.59 | 3.999 | 18.0883 | 3.148 | 50.347 | 0.070 | 254.95 | 12.640 | 3.9990 | 50.547 | 0.070 | 255.85 | 12.61 | −0.016 |
| ### | May 8, 2012 | 2:00:11 PM | 12.58 | 3.999 | 18.0938 | 3.145 | 50.307 | 0.070 | 255.02 | 12.630 | 3.9990 | 50.507 | 0.070 | 255.92 | 12.61 | −0.029 |
| ### | May 8, 2012 | 2:00:16 PM | 12.61 | 3.999 | 18.0993 | 3.153 | 50.427 | 0.070 | 255.09 | 12.660 | 3.9990 | 50.627 | 0.070 | 255.99 | 12.61 | −0.001 |
| ### | May 8, 2012 | 2:00:21 PM | 12.63 | 3.999 | 18.1049 | 3.158 | 50.507 | 0.070 | 255.16 | 12.680 | 3.9990 | 50.707 | 0.070 | 256.07 | 12.61 | 0.016 |
| ### | May 8, 2012 | 2:00:26 PM | 12.63 | 3.999 | 18.1104 | 3.158 | 50.507 | 0.070 | 255.23 | 12.680 | 3.9990 | 50.707 | 0.070 | 256.14 | 12.62 | 0.014 |
| ### | May 8, 2012 | 2:00:31 PM | 12.63 | 3.999 | 18.1160 | 3.158 | 50.507 | 0.070 | 255.30 | 12.680 | 3.9990 | 50.707 | 0.070 | 256.21 | 12.62 | 0.010 |
| ### | May 8, 2012 | 2:00:36 PM | 12.63 | 3.999 | 18.1215 | 3.158 | 50.507 | 0.070 | 255.37 | 12.680 | 3.9990 | 50.707 | 0.070 | 256.28 | 12.62 | 0.007 |
| ### | May 8, 2012 | 2:00:41 PM | 12.63 | 3.999 | 18.1271 | 3.158 | 50.507 | 0.070 | 255.44 | 12.680 | 3.9990 | 50.707 | 0.070 | 256.35 | 12.63 | −0.004 |
| ### | May 8, 2012 | 2:00:46 PM | 12.63 | 3.999 | 18.1326 | 3.158 | 50.507 | 0.070 | 255.51 | 12.680 | 3.9990 | 50.707 | 0.070 | 256.42 | 12.63 | 0.004 |
| ### | May 8, 2012 | 2:00:51 PM | 12.63 | 3.999 | 18.1381 | 3.158 | 50.507 | 0.070 | 255.58 | 12.680 | 3.9990 | 50.707 | 0.070 | 256.49 | 12.62 | 0.006 |
| ### | May 8, 2012 | 2:00:56 PM | 12.63 | 3.999 | 18.1437 | 3.158 | 50.507 | 0.070 | 255.65 | 12.670 | 3.9990 | 50.667 | 0.070 | 256.56 | 12.62 | 0.010 |
| ### | May 8, 2012 | 2:01:01 PM | 12.62 | 3.999 | 18.1493 | 3.155 | 50.567 | 0.070 | 255.72 | 12.670 | 3.9990 | 50.667 | 0.070 | 256.63 | 12.62 | 0.004 |
| ### | May 8, 2012 | 2:01:06 PM | 12.62 | 3.999 | 18.1548 | 3.155 | 50.367 | 0.070 | 255.79 | 12.660 | 3.9990 | 50.627 | 0.070 | 256.70 | 12.61 | 0.007 |
| ### | May 8, 2012 | 2:01:11 PM | 12.61 | 3.999 | 18.1603 | 3.153 | 50.427 | 0.070 | 255.86 | 12.650 | 3.9990 | 50.587 | 0.070 | 256.77 | 12.61 | 0.002 |
| ### | May 8, 2012 | 2:01:16 PM | 12.60 | 3.999 | 18.1659 | 3.150 | 50.387 | 0.070 | 256.93 | 12.640 | 3.9990 | 50.547 | 0.070 | 256.84 | 12.60 | −0.005 |
| ### | May 8, 2012 | 2:01:21 PM | 12.59 | 3.999 | 18.1714 | 3.148 | 50.347 | 0.070 | 256.00 | 12.640 | 3.9990 | 50.547 | 0.070 | 256.91 | 12.60 | −0.012 |
| ### | May 8, 2012 | 2:01:26 PM | 12.59 | 3.999 | 18.1770 | 3.148 | 50.347 | 0.070 | 256.07 | 12.640 | 3.9990 | 50.547 | 0.070 | 256.98 | 12.60 | −0.009 |
| ### | May 8, 2012 | 2:01:31 PM | 12.59 | 3.999 | 18.1825 | 3.148 | 50.347 | 0.070 | 256.14 | 12.640 | 3.9990 | 50.547 | 0.070 | 257.05 | 12.60 | −0.006 |
| ### | May 8, 2012 | 2:01:36 PM | 12.58 | 3.999 | 18.1880 | 3.145 | 50.307 | 0.070 | 256.21 | 12.630 | 3.9990 | 50.547 | 0.070 | 257.12 | 12.59 | −0.014 |
| ### | May 8, 2012 | 2:01:41 PM | 12.59 | 3.999 | 18.1936 | 3.148 | 50.347 | 0.070 | 256.28 | 12.640 | 3.9990 | 50.547 | 0.070 | 257.19 | 12.59 | −0.002 |
| ### | May 8, 2012 | 2:01:46 PM | 12.60 | 3.999 | 18.1991 | 3.150 | 50.387 | 0.070 | 256.35 | 12.650 | 3.9990 | 50.587 | 0.070 | 257.26 | 12.59 | 0.011 |
| ### | May 8, 2012 | 2:01:51 PM | 12.60 | 3.999 | 18.2047 | 3.150 | 50.387 | 0.070 | 256.42 | 12.650 | 3.9990 | 50.587 | 0.070 | 257.33 | 12.59 | 0.014 |
| ### | May 8, 2012 | 2:01:56 PM | 12.59 | 3.999 | 18.2102 | 3.148 | 50.347 | 0.070 | 256.49 | 12.640 | 3.9990 | 50.547 | 0.070 | 257.40 | 12.59 | 0.003 |
| ### | May 8, 2012 | 2:02:01 PM | 12.59 | 3.999 | 18.2156 | 3.148 | 50.347 | 0.070 | 256.56 | 12.640 | 3.9990 | 50.547 | 0.070 | 257.47 | 12.59 | 0.003 |
| ### | May 8, 2012 | 2:02:06 PM | 12.59 | 3.999 | 18.2211 | 3.148 | 50.347 | 0.070 | 256.63 | 12.640 | 3.9990 | 50.547 | 0.070 | 257.54 | 12.59 | 0.001 |
| ### | May 8, 2012 | 2:02:11 PM | 12.57 | 3.999 | 18.2267 | 3.143 | 50.267 | 0.070 | 256.70 | 12.620 | 3.9990 | 50.467 | 0.070 | 257.61 | 12.59 | −0.019 |
| ### | May 8, 2012 | 2:02:16 PM | 12.56 | 3.999 | 18.2322 | 3.140 | 50.227 | 0.070 | 256.77 | 12.610 | 3.9990 | 50.427 | 0.070 | 257.68 | 12.59 | −0.026 |
| ### | May 8, 2012 | 2:02:21 PM | 12.60 | 3.999 | 18.2378 | 3.150 | 50.387 | 0.070 | 256.84 | 12.650 | 3.9990 | 50.587 | 0.070 | 257.75 | 12.58 | 0.016 |
| ### | May 8, 2012 | 2:02:26 PM | 12.59 | 3.999 | 18.2433 | 3.148 | 50.347 | 0.070 | 256.91 | 12.640 | 3.9990 | 50.547 | 0.070 | 257.82 | 12.58 | 0.007 |
| ### | May 8, 2012 | 2:02:31 PM | 12.60 | 3.999 | 18.2488 | 3.150 | 50.387 | 0.070 | 256.98 | 12.650 | 3.9990 | 50.587 | 0.070 | 257.89 | 12.58 | 0.022 |
| ### | May 8, 2012 | 2:02:36 PM | 12.59 | 3.999 | 18.2544 | 3.148 | 50.347 | 0.070 | 257.05 | 12.640 | 3.9990 | 50.547 | 0.070 | 257.96 | 12.58 | 0.013 |
| ### | May 8, 2012 | 2:02:41 PM | 12.57 | 3.999 | 18.2599 | 3.143 | 50.267 | 0.070 | 257.12 | 12.620 | 3.9990 | 50.467 | 0.070 | 258.03 | 12.58 | −0.011 |
| ### | May 8, 2012 | 2:02:46 PM | 12.57 | 3.999 | 18.2655 | 3.143 | 50.267 | 0.070 | 257.19 | 12.620 | 3.9990 | 50.467 | 0.070 | 258.10 | 12.58 | −0.012 |
| ### | May 8, 2012 | 2:02:51 PM | 12.58 | 3.999 | 18.2710 | 3.145 | 50.307 | 0.070 | 257.26 | 12.630 | 3.9990 | 50.507 | 0.070 | 258.17 | 12.58 | −0.002 |
| ### | May 8, 2012 | 2:02:56 PM | 12.54 | 3.999 | 18.2766 | 3.135 | 50.147 | 0.070 | 257.33 | 12.590 | 3.9990 | 50.347 | 0.070 | 258.24 | 12.59 | −0.045 |
| ### | May 8, 2012 | 2:03:01 PM | 12.58 | 3.999 | 18.2821 | 3.145 | 50.307 | 0.070 | 257.40 | 12.630 | 3.9990 | 50.507 | 0.070 | 258.31 | 12.58 | −0.003 |
| ### | May 8, 2012 | 2:03:06 PM | 12.61 | 3.999 | 18.2877 | 3.153 | 50.427 | 0.070 | 257.47 | 12.660 | 3.9990 | 50.627 | 0.070 | 258.38 | 12.58 | 0.030 |
| ### | May 8, 2012 | 2:03:11 PM | 12.57 | 3.999 | 18.2932 | 3.143 | 50.267 | 0.070 | 257.54 | 12.620 | 3.9990 | 50.467 | 0.070 | 258.45 | 12.58 | −0.011 |
| ### | May 8, 2012 | 2:03:16 PM | 12.60 | 3.999 | 18.2987 | 3.150 | 50.387 | 0.070 | 257.61 | 12.650 | 3.9990 | 50.587 | 0.070 | 258.52 | 12.58 | 0.019 |
| ### | May 8, 2012 | 2:03:21 PM | 12.63 | 3.999 | 18.3043 | 3.158 | 50.507 | 0.070 | 257.68 | 12.680 | 3.9990 | 50.707 | 0.070 | 258.59 | 12.58 | 0.048 |
| ### | May 8, 2012 | 2:03:26 PM | 12.57 | 3.999 | 18.3099 | 3.143 | 50.267 | 0.070 | 257.75 | 12.620 | 3.9990 | 50.467 | 0.070 | 258.66 | 12.59 | −0.019 |
| ### | May 8, 2012 | 2:03:31 PM | 12.56 | 3.999 | 18.3154 | 3.140 | 50.227 | 0.070 | 257.82 | 12.610 | 3.9990 | 50.427 | 0.070 | 258.73 | 12.59 | −0.031 |
| ### | May 8, 2012 | 2:03:36 PM | 12.58 | 3.999 | 18.3209 | 3.145 | 50.307 | 0.070 | 257.89 | 12.630 | 3.9990 | 50.507 | 0.070 | 258.80 | 12.59 | −0.009 |
| ### | May 8, 2012 | 2:03:41 PM | 12.57 | 3.999 | 18.3265 | 3.143 | 50.267 | 0.070 | 257.96 | 12.620 | 3.9990 | 50.467 | 0.070 | 258.87 | 12.59 | −0.019 |
| ### | May 8, 2012 | 2:03:46 PM | 12.59 | 3.999 | 18.3320 | 3.148 | 50.347 | 0.070 | 258.03 | 12.640 | 3.9990 | 50.547 | 0.070 | 258.94 | 12.59 | 0.002 |
| ### | May 8, 2012 | 2:03:51 PM | 12.62 | 3.999 | 18.3375 | 3.155 | 50.467 | 0.070 | 258.10 | 12.670 | 3.9990 | 50.667 | 0.070 | 259.02 | 12.58 | 0.037 |
| ### | May 8, 2012 | 2:03:56 PM | 12.60 | 3.999 | 18.3431 | 3.150 | 50.387 | 0.070 | 258.17 | 12.650 | 3.9990 | 50.587 | 0.070 | 259.09 | 12.58 | 0.016 |
| ### | May 8, 2012 | 2:04:01 PM | 12.59 | 3.999 | 18.3487 | 3.148 | 50.347 | 0.070 | 258.24 | 12.640 | 3.9990 | 50.547 | 0.070 | 259.16 | 12.59 | 0.005 |
| ### | May 8, 2012 | 2:04:06 PM | 12.57 | 3.999 | 18.3542 | 3.143 | 50.267 | 0.070 | 258.31 | 12.620 | 3.9990 | 50.467 | 0.070 | 259.23 | 12.58 | −0.015 |
| ### | May 8, 2012 | 2:04:11 PM | 12.59 | 3.999 | 18.3597 | 3.148 | 50.347 | 0.070 | 258.38 | 12.640 | 3.9990 | 50.547 | 0.070 | 259.30 | 12.58 | 0.005 |
| ### | May 8, 2012 | 2:04:16 PM | 12.57 | 3.999 | 18.3653 | 3.143 | 50.267 | 0.070 | 258.45 | 12.620 | 3.9990 | 50.467 | 0.070 | 259.37 | 12.58 | −0.013 |
| ### | May 8, 2012 | 2:04:21 PM | 12.58 | 3.999 | 18.3708 | 3.145 | 50.307 | 0.070 | 258.52 | 12.630 | 3.9990 | 50.507 | 0.070 | 259.44 | 12.58 | 0.002 |
| ### | May 8, 2012 | 2:04:26 PM | 12.58 | 3.999 | 18.3764 | 3.145 | 50.307 | 0.070 | 258.59 | 12.630 | 3.9990 | 50.507 | 0.070 | 259.51 | 12.57 | 0.005 |
| ### | May 8, 2012 | 2:04:31 PM | 12.57 | 3.999 | 18.3819 | 3.143 | 50.267 | 0.070 | 258.66 | 12.620 | 3.9990 | 50.467 | 0.070 | 259.58 | 12.57 | −0.002 |
| ### | May 8, 2012 | 2:04:36 PM | 12.57 | 4.000 | 18.3875 | 3.143 | 50.280 | 0.070 | 258.73 | 12.620 | 4.0000 | 50.480 | 0.070 | 259.65 | 12.57 | −0.001 |
| ### | May 8, 2012 | 2:04:41 PM | 12.57 | 3.999 | 18.3930 | 3.143 | 50.267 | 0.070 | 258.80 | 12.620 | 3.9990 | 50.467 | 0.070 | 259.72 | 12.57 | 0.003 |
| ### | May 8, 2012 | 2:04:46 PM | 12.57 | 3.999 | 18.3985 | 3.143 | 50.267 | 0.070 | 258.87 | 12.620 | 3.9990 | 50.467 | 0.070 | 259.79 | 12.57 | 0.005 |
| ### | May 8, 2012 | 2:04:51 PM | 12.56 | 3.999 | 18.4041 | 3.140 | 50.227 | 0.070 | 258.94 | 12.610 | 3.9990 | 50.427 | 0.070 | 259.86 | 12.56 | −0.003 |
| ### | May 8, 2012 | 2:04:56 PM | 12.56 | 3.999 | 18.4096 | 3.140 | 50.227 | 0.070 | 259.00 | 12.610 | 3.9990 | 50.427 | 0.070 | 259.93 | 12.56 | 0.001 |
| ### | May 8, 2012 | 2:05:01 PM | 12.56 | 3.999 | 18.4152 | 3.140 | 50.227 | 0.070 | 259.07 | 12.610 | 3.9990 | 50.427 | 0.070 | 260.00 | 12.56 | 0.004 |
| ### | May 8, 2012 | 2:05:06 PM | 12.55 | 3.999 | 18.4207 | 3.138 | 50.187 | 0.070 | 259.14 | 12.600 | 3.9990 | 50.387 | 0.070 | 260.07 | 12.55 | −0.003 |
| ### | May 8, 2012 | 2:05:11 PM | 12.55 | 3.999 | 18.4263 | 3.138 | 50.187 | 0.070 | 259.21 | 12.600 | 3.9990 | 50.387 | 0.070 | 260.14 | 12.55 | 0.001 |
| ### | May 8, 2012 | 2:05:16 PM | 12.55 | 3.999 | 18.4318 | 3.138 | 50.187 | 0.070 | 259.28 | 12.600 | 3.9990 | 50.387 | 0.070 | 260.21 | 12.54 | 0.006 |
| ### | May 8, 2012 | 2:05:21 PM | 12.54 | 3.999 | 18.4373 | 3.135 | 50.147 | 0.070 | 259.35 | 12.590 | 3.9990 | 50.347 | 0.070 | 260.28 | 12.54 | 0.001 |
| ### | May 8, 2012 | 2:05:26 PM | 12.54 | 3.999 | 18.4429 | 3.135 | 50.147 | 0.070 | 259.42 | 12.590 | 3.9990 | 50.347 | 0.070 | 260.35 | 12.53 | 0.006 |
| ### | May 8, 2012 | 2:05:31 PM | 12.53 | 3.999 | 18.4484 | 3.133 | 50.107 | 0.070 | 259.49 | 12.580 | 3.9990 | 50.307 | 0.070 | 260.42 | 12.53 | 0.003 |
| ### | May 8, 2012 | 2:05:36 PM | 12.53 | 3.999 | 18.4540 | 3.133 | 50.107 | 0.070 | 259.56 | 12.580 | 3.9990 | 50.307 | 0.070 | 260.49 | 12.52 | 0.007 |
| ### | May 8, 2012 | 2:05:41 PM | 12.51 | 3.999 | 18.4595 | 3.128 | 50.027 | 0.069 | 259.63 | 12.560 | 3.9990 | 50.227 | 0.070 | 260.56 | 12.52 | −0.008 |
| ### | May 8, 2012 | 2:05:46 PM | 12.51 | 3.999 | 18.4651 | 3.128 | 50.027 | 0.070 | 259.70 | 12.560 | 3.9990 | 50.227 | 0.070 | 260.63 | 12.51 | −0.003 |
| ### | May 8, 2012 | 2:05:51 PM | 12.50 | 3.999 | 18.4706 | 3.125 | 49.988 | 0.069 | 259.77 | 12.550 | 3.9990 | 50.187 | 0.070 | 260.70 | 12.51 | −0.007 |
| ### | May 8, 2012 | 2:05:56 PM | 12.49 | 3.999 | 18.4761 | 3.123 | 49.948 | 0.069 | 259.84 | 12.540 | 3.9990 | 50.147 | 0.070 | 260.77 | 12.50 | −0.012 |
| ### | May 8, 2012 | 2:06:01 PM | 12.50 | 3.999 | 18.4817 | 3.125 | 49.988 | 0.069 | 259.91 | 12.550 | 3.9990 | 50.187 | 0.070 | 260.83 | 12.50 | 0.001 |
| ### | May 8, 2012 | 2:06:06 PM | 12.50 | 3.999 | 18.4872 | 3.125 | 49.988 | 0.069 | 259.98 | 12.550 | 3.9990 | 50.187 | 0.070 | 260.90 | 12.50 | 0.005 |
| ### | May 8, 2012 | 2:06:11 PM | 12.49 | 3.999 | 18.4928 | 3.123 | 49.948 | 0.069 | 260.05 | 12.540 | 3.9990 | 50.147 | 0.070 | 260.97 | 12.49 | −0.003 |
| ### | May 8, 2012 | 2:06:16 PM | 12.48 | 3.999 | 18.4983 | 3.120 | 49.908 | 0.069 | 260.12 | 12.530 | 3.9990 | 50.107 | 0.070 | 261.04 | 12.49 | −0.011 |
| ### | May 8, 2012 | 2:06:21 PM | 12.48 | 3.999 | 18.5039 | 3.120 | 49.988 | 0.069 | 260.12 | 12.550 | 3.9990 | 50.107 | 0.070 | 261.11 | 12.49 | −0.010 |
| ### | May 8, 2012 | 2:06:26 PM | 12.50 | 3.999 | 18.5094 | 3.125 | 49.988 | 0.069 | 260.26 | 12.550 | 3.9990 | 50.187 | 0.070 | 261.18 | 12.49 | 0.011 |
| ### | May 8, 2012 | 2:06:31 PM | 12.49 | 3.999 | 18.5151 | 3.123 | 49.948 | 0.069 | 260.33 | 12.530 | 3.9990 | 50.107 | 0.070 | 261.25 | 12.48 | 0.004 |
| ### | May 8, 2012 | 2:06:36 PM | 12.48 | 3.999 | 18.5207 | 3.120 | 49.908 | 0.069 | 260.39 | 12.530 | 3.9990 | 50.107 | 0.070 | 261.32 | 12.48 | −0.005 |
| ### | May 8, 2012 | 2:06:41 PM | 12.49 | 3.999 | 18.5262 | 3.123 | 49.948 | 0.069 | 260.46 | 12.540 | 3.9990 | 50.147 | 0.070 | 261.39 | 12.49 | 0.005 |
| ### | May 8, 2012 | 2:06:46 PM | 12.49 | 3.999 | 18.5318 | 3.123 | 49.948 | 0.069 | 260.53 | 12.540 | 3.9990 | 50.147 | 0.070 | 261.46 | 12.49 | 0.005 |
| ### | May 8, 2012 | 2:06:51 PM | 12.48 | 3.999 | 18.5373 | 3.120 | 49.908 | 0.069 | 260.60 | 12.530 | 3.9990 | 50.107 | 0.070 | 261.53 | 12.48 | −0.005 |
| ### | May 8, 2012 | 2:06:56 PM | 12.47 | 3.999 | 18.5429 | 3.118 | 49.868 | 0.069 | 260.67 | 12.520 | 3.9990 | 50.067 | 0.070 | 261.60 | 12.48 | −0.013 |
| ### | May 8, 2012 | 2:07:01 PM | 12.48 | 3.999 | 18.5484 | 3.120 | 49.908 | 0.069 | 260.74 | 12.530 | 3.9990 | 50.107 | 0.070 | 261.67 | 12.48 | −0.001 |
| ### | May 8, 2012 | 2:07:06 PM | 12.50 | 3.999 | 18.5540 | 3.125 | 49.988 | 0.069 | 260.81 | 12.550 | 3.9990 | 50.187 | 0.070 | 261.74 | 12.48 | 0.019 |
| ### | May 8, 2012 | 2:07:11 PM | 12.48 | 3.999 | 18.5595 | 3.120 | 49.908 | 0.069 | 260.88 | 12.530 | 3.9990 | 50.107 | 0.070 | 261.81 | 12.48 | −0.001 |
| ### | May 8, 2012 | 2:07:16 PM | 12.47 | 3.999 | 18.5651 | 3.118 | 49.868 | 0.069 | 260.95 | 12.520 | 3.9990 | 50.067 | 0.070 | 261.88 | 12.48 | −0.012 |
| ### | May 8, 2012 | 2:07:21 PM | 12.48 | 3.999 | 18.5706 | 3.120 | 49.908 | 0.069 | 261.02 | 12.530 | 3.9990 | 50.107 | 0.070 | 261.95 | 12.48 | −0.003 |
| ### | May 8, 2012 | 2:07:26 PM | 12.47 | 3.999 | 18.5761 | 3.118 | 49.868 | 0.069 | 261.09 | 12.520 | 3.9990 | 50.067 | 0.070 | 262.02 | 12.48 | −0.015 |
| ### | May 8, 2012 | 2:07:31 PM | 12.48 | 3.999 | 18.5817 | 3.120 | 49.908 | 0.069 | 261.16 | 12.530 | 3.9990 | 50.107 | 0.070 | 262.09 | 12.48 | −0.005 |
| ### | May 8, 2012 | 2:07:36 PM | 12.49 | 3.999 | 18.5872 | 3.123 | 49.948 | 0.069 | 261.23 | 12.540 | 3.9990 | 50.147 | 0.070 | 262.16 | 12.48 | 0.007 |
| ### | May 8, 2012 | 2:07:41 PM | 12.50 | 3.999 | 18.5928 | 3.125 | 49.988 | 0.069 | 261.30 | 12.550 | 3.9990 | 50.187 | 0.070 | 262.23 | 12.48 | 0.017 |
| ### | May 8, 2012 | 2:07:46 PM | 12.49 | 3.999 | 18.5984 | 3.123 | 49.948 | 0.069 | 261.37 | 12.540 | 3.9990 | 50.147 | 0.070 | 262.30 | 12.48 | 0.006 |
| ### | May 8, 2012 | 2:07:51 PM | 12.49 | 3.999 | 18.6039 | 3.123 | 49.948 | 0.069 | 261.43 | 12.540 | 3.9990 | 50.147 | 0.070 | 262.37 | 12.48 | 0.006 |
| ### | May 8, 2012 | 2:07:56 PM | 12.48 | 3.999 | 18.6094 | 3.120 | 49.908 | 0.069 | 261.50 | 12.530 | 3.9990 | 50.107 | 0.070 | 262.44 | 12.48 | −0.005 |
| ### | May 8, 2012 | 2:08:01 PM | 12.48 | 3.999 | 18.6150 | 3.120 | 49.908 | 0.069 | 261.57 | 12.530 | 3.9990 | 50.107 | 0.070 | 262.51 | 12.48 | −0.004 |
| ### | May 8, 2012 | 2:08:06 PM | 12.48 | 3.999 | 18.6205 | 3.120 | 49.908 | 0.069 | 261.64 | 12.530 | 3.9990 | 50.107 | 0.070 | 262.58 | 12.48 | −0.003 |
| ### | May 8, 2012 | 2:08:11 PM | 12.48 | 3.999 | 18.6261 | 3.120 | 49.908 | 0.069 | 261.71 | 12.530 | 3.9990 | 50.107 | 0.070 | 262.65 | 12.48 | −0.002 |
| ### | May 8, 2012 | 2:08:16 PM | 12.48 | 3.999 | 18.6316 | 3.120 | 49.908 | 0.069 | 261.78 | 12.530 | 3.9990 | 50.107 | 0.070 | 262.71 | 12.48 | −0.001 |
| ### | May 8, 2012 | 2:08:21 PM | 12.48 | 3.999 | 18.6371 | 3.120 | 49.908 | 0.069 | 261.85 | 12.530 | 3.9990 | 50.107 | 0.070 | 262.78 | 12.48 | −0.001 |
| ### | May 8, 2012 | 2:08:26 PM | 12.47 | 3.999 | 18.6427 | 3.118 | 49.868 | 0.069 | 261.92 | 12.520 | 3.9990 | 50.067 | 0.070 | 262.85 | 12.48 | −0.011 |
| ### | May 8, 2012 | 2:08:31 PM | 12.48 | 3.999 | 18.6482 | 3.120 | 49.908 | 0.069 | 261.99 | 12.530 | 3.9990 | 50.107 | 0.070 | 262.92 | 12.48 | 0.000 |
| ### | May 8, 2012 | 2:08:36 PM | 12.49 | 3.999 | 18.6538 | 3.123 | 49.948 | 0.069 | 262.06 | 12.540 | 3.9990 | 50.147 | 0.070 | 262.99 | 12.48 | 0.012 |
| ### | May 8, 2012 | 2:08:41 PM | 12.48 | 3.999 | 18.6593 | 3.120 | 49.908 | 0.069 | 262.13 | 12.530 | 3.9990 | 50.107 | 0.070 | 263.06 | 12.48 | 0.004 |
| ### | May 8, 2012 | 2:08:46 PM | 12.49 | 3.999 | 18.6648 | 3.123 | 49.948 | 0.069 | 262.20 | 12.540 | 3.9990 | 50.147 | 0.070 | 263.13 | 12.48 | 0.015 |
| ### | May 8, 2012 | 2:08:51 PM | 12.48 | 3.999 | 18.6704 | 3.120 | 49.908 | 0.069 | 262.27 | 12.530 | 3.9990 | 50.107 | 0.070 | 263.20 | 12.47 | 0.005 |
| ### | May 8, 2012 | 2:08:56 PM | 12.47 | 3.999 | 18.6759 | 3.118 | 49.868 | 0.069 | 262.34 | 12.520 | 3.9990 | 50.067 | 0.070 | 263.27 | 12.47 | −0.004 |
| ### | May 8, 2012 | 2:09:01 PM | 12.46 | 3.999 | 18.6815 | 3.115 | 49.828 | 0.069 | 262.41 | 12.510 | 3.9990 | 50.027 | 0.069 | 263.34 | 12.47 | −0.013 |
| ### | May 8, 2012 | 2:09:06 PM | 12.46 | 3.999 | 18.6870 | 3.115 | 49.828 | 0.069 | 262.47 | 12.510 | 3.9990 | 50.027 | 0.069 | 263.41 | 12.47 | −0.009 |
| ### | May 8, 2012 | 2:09:11 PM | 12.47 | 3.999 | 18.6926 | 3.118 | 49.868 | 0.069 | 262.54 | 12.520 | 3.9990 | 50.067 | 0.070 | 263.48 | 12.47 | 0.004 |
| ### | May 8, 2012 | 2:09:16 PM | 12.47 | 3.999 | 18.6981 | 3.118 | 49.868 | 0.069 | 262.61 | 12.520 | 3.9990 | 50.067 | 0.070 | 263.55 | 12.46 | 0.008 |
| ### | May 8, 2012 | 2:09:21 PM | 12.46 | 3.999 | 18.7037 | 3.115 | 49.828 | 0.069 | 262.68 | 12.510 | 3.9990 | 50.027 | 0.069 | 263.62 | 12.46 | 0.001 |
| ### | May 8, 2012 | 2:09:26 PM | 12.47 | 3.999 | 18.7092 | 3.118 | 49.868 | 0.069 | 262.75 | 12.520 | 3.9990 | 50.067 | 0.070 | 263.69 | 12.46 | 0.013 |
| ### | May 8, 2012 | 2:09:31 PM | 12.45 | 3.999 | 18.7147 | 3.113 | 49.788 | 0.069 | 262.82 | 12.500 | 3.9990 | 49.988 | 0.069 | 263.76 | 12.46 | −0.006 |
| ### | May 8, 2012 | 2:09:36 PM | 12.45 | 3.999 | 18.7203 | 3.113 | 49.788 | 0.069 | 262.89 | 12.500 | 3.9990 | 49.988 | 0.069 | 263.83 | 12.45 | −0.004 |
| ### | May 8, 2012 | 2:09:41 PM | 12.44 | 3.999 | 18.7258 | 3.110 | 49.748 | 0.069 | 262.96 | 12.490 | 3.9990 | 49.948 | 0.069 | 263.90 | 12.45 | −0.011 |
| ### | May 8, 2012 | 2:09:46 PM | 12.45 | 3.999 | 18.7314 | 3.113 | 49.788 | 0.069 | 263.03 | 12.500 | 3.9990 | 49.988 | 0.069 | 263.97 | 12.45 | 0.004 |
| ### | May 8, 2012 | 2:09:51 PM | 12.45 | 3.999 | 18.7369 | 3.113 | 49.788 | 0.069 | 263.10 | 12.500 | 3.9990 | 49.988 | 0.069 | 264.04 | 12.44 | 0.006 |
| ### | May 8, 2012 | 2:09:56 PM | 12.45 | 3.999 | 18.7425 | 3.113 | 49.788 | 0.069 | 263.17 | 12.500 | 3.9990 | 49.988 | 0.069 | 264.10 | 12.44 | 0.010 |
| ### | May 8, 2012 | 2:10:01 PM | 12.43 | 3.999 | 18.7480 | 3.108 | 49.708 | 0.069 | 263.24 | 12.480 | 3.9990 | 49.908 | 0.069 | 264.17 | 12.44 | −0.007 |
| ### | May 8, 2012 | 2:10:06 PM | 12.44 | 3.999 | 18.7536 | 3.110 | 49.748 | 0.069 | 263.30 | 12.490 | 3.9990 | 49.948 | 0.069 | 264.24 | 12.44 | 0.004 |
| ### | May 8, 2012 | 2:10:11 PM | 12.42 | 3.999 | 18.7591 | 3.105 | 49.668 | 0.069 | 263.37 | 12.470 | 3.9990 | 49.868 | 0.069 | 264.31 | 12.44 | −0.016 |
| ### | May 8, 2012 | 2:10:16 PM | 12.43 | 3.999 | 18.7646 | 3.108 | 49.708 | 0.069 | 263.44 | 12.480 | 3.9990 | 49.908 | 0.069 | 264.38 | 12.43 | −0.005 |
| ### | May 8, 2012 | 2:10:21 PM | 12.43 | 3.999 | 18.7702 | 3.108 | 49.708 | 0.069 | 263.51 | 12.480 | 3.9990 | 49.908 | 0.069 | 264.45 | 12.43 | −0.003 |
| ### | May 8, 2012 | 2:10:26 PM | 12.42 | 3.999 | 18.7757 | 3.105 | 49.668 | 0.069 | 263.58 | 12.470 | 3.9990 | 49.868 | 0.069 | 264.52 | 12.43 | −0.010 |
| ### | May 8, 2012 | 2:10:31 PM | 12.44 | 3.999 | 18.7813 | 3.110 | 49.748 | 0.069 | 263.65 | 12.490 | 3.9990 | 49.948 | 0.069 | 264.59 | 12.43 | 0.010 |
| ### | May 8, 2012 | 2:10:36 PM | 12.44 | 3.999 | 18.7868 | 3.110 | 49.748 | 0.069 | 263.72 | 12.490 | 3.9990 | 49.948 | 0.069 | 264.66 | 12.43 | 0.011 |
| ### | May 8, 2012 | 2:10:41 PM | 12.43 | 3.999 | 18.7924 | 3.108 | 49.708 | 0.069 | 263.79 | 12.480 | 3.9990 | 49.908 | 0.069 | 264.73 | 12.43 | −0.001 |
| ### | May 8, 2012 | 2:10:46 PM | 12.43 | 3.999 | 18.7979 | 3.108 | 49.708 | 0.069 | 263.86 | 12.480 | 3.9990 | 49.908 | 0.069 | 264.80 | 12.43 | 0.000 |
| ### | May 8, 2012 | 2:10:51 PM | 12.42 | 3.999 | 18.8035 | 3.105 | 49.668 | 0.069 | 263.93 | 12.470 | 3.9990 | 49.868 | 0.069 | 264.87 | 12.43 | −0.011 |
| ### | May 8, 2012 | 2:10:56 PM | 12.43 | 3.999 | 18.8090 | 3.108 | 49.708 | 0.069 | 263.99 | 12.480 | 3.9990 | 49.908 | 0.069 | 264.94 | 12.43 | −0.003 |
| ### | May 8, 2012 | 2:11:01 PM | 12.43 | 3.999 | 18.8145 | 3.108 | 49.708 | 0.069 | 264.06 | 12.480 | 3.9990 | 49.908 | 0.069 | 265.01 | 12.43 | −0.002 |
| ### | May 8, 2012 | 2:11:06 PM | 12.44 | 3.999 | 18.8201 | 3.110 | 49.748 | 0.069 | 264.13 | 12.490 | 3.9990 | 49.948 | 0.069 | 265.08 | 12.43 | 0.009 |
| ### | May 8, 2012 | 2:11:11 PM | 12.42 | 3.999 | 18.8256 | 3.105 | 49.668 | 0.069 | 264.20 | 12.470 | 3.9990 | 49.868 | 0.069 | 265.14 | 12.43 | −0.011 |
| ### | May 8, 2012 | 2:11:16 PM | 12.44 | 3.999 | 18.8312 | 3.110 | 49.748 | 0.069 | 264.27 | 12.490 | 3.9990 | 49.948 | 0.069 | 265.21 | 12.43 | 0.011 |
| ### | May 8, 2012 | 2:11:21 PM | 12.44 | 3.999 | 18.8367 | 3.110 | 49.748 | 0.069 | 264.34 | 12.490 | 3.9990 | 49.948 | 0.069 | 265.28 | 12.43 | 0.011 |
| ### | May 8, 2012 | 2:11:26 PM | 12.43 | 3.999 | 18.8423 | 3.108 | 49.708 | 0.069 | 264.41 | 12.480 | 3.9990 | 49.908 | 0.069 | 265.35 | 12.43 | 0.002 |
| ### | May 8, 2012 | 2:11:31 PM | 12.43 | 3.999 | 18.8478 | 3.108 | 49.708 | 0.069 | 264.48 | 12.480 | 3.9990 | 49.908 | 0.069 | 265.42 | 12.43 | 0.003 |
| ### | May 8, 2012 | 2:11:36 PM | 12.43 | 3.999 | 18.8533 | 3.108 | 49.708 | 0.069 | 264.55 | 12.480 | 3.9990 | 49.908 | 0.069 | 265.49 | 12.43 | 0.005 |
| ### | May 8, 2012 | 2:11:41 PM | 12.41 | 3.999 | 18.8589 | 3.103 | 49.628 | 0.069 | 264.62 | 12.460 | 3.9990 | 49.828 | 0.069 | 265.56 | 12.43 | −0.015 |
| ### | May 8, 2012 | 2:11:46 PM | 12.42 | 3.999 | 18.8644 | 3.105 | 49.668 | 0.069 | 264.69 | 12.470 | 3.9990 | 49.868 | 0.069 | 265.63 | 12.42 | −0.004 |
| ### | May 8, 2012 | 2:11:51 PM | 12.42 | 3.999 | 18.8700 | 3.105 | 49.668 | 0.069 | 264.75 | 12.470 | 3.9990 | 49.868 | 0.069 | 265.70 | 12.42 | −0.001 |
| ### | May 8, 2012 | 2:11:56 PM | 12.42 | 3.999 | 18.8755 | 3.105 | 49.668 | 0.069 | 264.82 | 12.470 | 3.9990 | 49.868 | 0.069 | 265.77 | 12.42 | 0.001 |
| ### | May 8, 2012 | 2:12:01 PM | 12.42 | 3.999 | 18.8811 | 3.105 | 49.668 | 0.069 | 264.89 | 12.470 | 3.9990 | 49.868 | 0.069 | 265.84 | 12.42 | 0.003 |
| ### | May 8, 2012 | 2:12:06 PM | 12.42 | 3.999 | 18.8866 | 3.105 | 49.668 | 0.069 | 264.96 | 12.470 | 3.9990 | 49.868 | 0.069 | 265.91 | 12.42 | 0.005 |
| ### | May 8, 2012 | 2:12:11 PM | 12.42 | 3.999 | 18.8922 | 3.105 | 49.668 | 0.069 | 265.03 | 12.470 | 3.9990 | 49.868 | 0.069 | 265.98 | 12.42 | 0.005 |
| ### | May 8, 2012 | 2:12:16 PM | 12.41 | 3.999 | 18.8977 | 3.103 | 49.628 | 0.069 | 265.10 | 12.460 | 3.9990 | 49.828 | 0.069 | 266.05 | 12.42 | −0.005 |
| ### | May 8, 2012 | 2:12:21 PM | 12.41 | 3.999 | 18.9033 | 3.103 | 49.628 | 0.069 | 265.17 | 12.460 | 3.9990 | 49.828 | 0.069 | 266.11 | 12.41 | −0.004 |
| ### | May 8, 2012 | 2:12:26 PM | 12.41 | 3.999 | 18.9088 | 3.103 | 49.628 | 0.069 | 265.24 | 12.460 | 3.9990 | 49.828 | 0.069 | 266.18 | 12.41 | −0.001 |
| ### | May 8, 2012 | 2:12:31 PM | 12.41 | 3.999 | 18.9143 | 3.103 | 49.628 | 0.069 | 265.31 | 12.460 | 3.9990 | 49.828 | 0.069 | 266.21 | 12.41 | −0.001 |
| ### | May 8, 2012 | 2:12:36 PM | 12.41 | 3.999 | 18.9199 | 3.103 | 49.628 | 0.069 | 265.37 | 12.460 | 3.9990 | 49.828 | 0.069 | 266.32 | 12.41 | −0.001 |
| ### | May 8, 2012 | 2:12:41 PM | 12.42 | 3.999 | 18.9254 | 3.105 | 49.668 | 0.069 | 265.44 | 12.470 | 3.9990 | 49.868 | 0.069 | 266.39 | 12.41 | 0.008 |
| ### | May 8, 2012 | 2:12:46 PM | 12.40 | 3.999 | 18.9310 | 3.100 | 49.588 | 0.069 | 265.51 | 12.450 | 3.9990 | 49.788 | 0.069 | 266.46 | 12.41 | −0.013 |
| ### | May 8, 2012 | 2:12:51 PM | 12.39 | 3.999 | 18.9365 | 3.098 | 49.548 | 0.069 | 265.58 | 12.440 | 3.9990 | 49.748 | 0.069 | 266.53 | 12.41 | −0.023 |
| ### | May 8, 2012 | 2:12:56 PM | 12.42 | 3.999 | 18.9421 | 3.105 | 49.668 | 0.069 | 265.65 | 12.470 | 3.9990 | 49.868 | 0.069 | 266.60 | 12.41 | 0.008 |
| ### | May 8, 2012 | 2:13:01 PM | 12.42 | 3.999 | 18.9476 | 3.105 | 49.668 | 0.069 | 265.72 | 12.470 | 3.9990 | 49.868 | 0.069 | 266.67 | 12.41 | 0.008 |
| ### | May 8, 2012 | 2:13:06 PM | 12.43 | 3.999 | 18.9531 | 3.108 | 49.708 | 0.069 | 265.79 | 12.480 | 3.9990 | 49.908 | 0.069 | 266.74 | 12.41 | 0.019 |
| ### | May 8, 2012 | 2:13:11 PM | 12.42 | 3.999 | 18.9587 | 3.105 | 49.668 | 0.069 | 265.86 | 12.470 | 3.9990 | 49.868 | 0.069 | 266.81 | 12.41 | 0.013 |
| ### | May 8, 2012 | 2:13:16 PM | 12.41 | 3.999 | 18.9642 | 3.103 | 49.628 | 0.069 | 265.93 | 12.460 | 3.9990 | 49.828 | 0.069 | 266.88 | 12.40 | 0.005 |
| ### | May 8, 2012 | 2:13:21 PM | 12.40 | 3.999 | 18.9698 | 3.100 | 49.588 | 0.069 | 266.00 | 12.450 | 3.9990 | 49.788 | 0.069 | 266.95 | 12.40 | −0.002 |
| ### | May 8, 2012 | 2:13:26 PM | 12.41 | 3.999 | 18.9753 | 3.103 | 49.628 | 0.069 | 266.06 | 12.460 | 3.9990 | 49.828 | 0.069 | 267.01 | 12.40 | 0.011 |
| ### | May 8, 2012 | 2:13:31 PM | 12.40 | 3.999 | 18.9809 | 3.100 | 49.588 | 0.069 | 266.13 | 12.450 | 3.9990 | 49.788 | 0.069 | 267.08 | 12.40 | 0.005 |
| ### | May 8, 2012 | 2:13:36 PM | 12.38 | 3.999 | 18.9864 | 3.095 | 49.508 | 0.069 | 266.20 | 12.430 | 3.9990 | 49.708 | 0.069 | 267.15 | 12.39 | −0.012 |
| ### | May 8, 2012 | 2:13:41 PM | 12.37 | 3.999 | 18.9920 | 3.093 | 49.468 | 0.069 | 266.27 | 12.420 | 3.9990 | 49.668 | 0.069 | 267.22 | 12.39 | −0.018 |
| ### | May 8, 2012 | 2:13:46 PM | 12.36 | 3.999 | 18.9975 | 3.090 | 49.428 | 0.069 | 266.34 | 12.410 | 3.9990 | 49.628 | 0.069 | 267.29 | 12.39 | −0.025 |
| ### | May 8, 2012 | 2:13:51 PM | 12.39 | 3.999 | 19.0031 | 3.098 | 49.548 | 0.069 | 266.41 | 12.440 | 3.9990 | 49.748 | 0.069 | 267.36 | 12.38 | 0.007 |
| ### | May 8, 2012 | 2:13:56 PM | 12.38 | 3.999 | 19.0086 | 3.095 | 49.508 | 0.069 | 266.48 | 12.430 | 3.9990 | 49.708 | 0.069 | 267.43 | 12.38 | 0.003 |
| ### | May 8, 2012 | 2:14:01 PM | 12.39 | 3.999 | 19.0141 | 3.098 | 49.548 | 0.069 | 266.55 | 12.440 | 3.9990 | 49.748 | 0.069 | 267.50 | 12.37 | 0.015 |
| ### | May 8, 2012 | 2:14:06 PM | 12.38 | 3.999 | 19.0197 | 3.095 | 49.508 | 0.069 | 266.61 | 12.430 | 3.9990 | 49.708 | 0.069 | 267.57 | 12.37 | 0.009 |
| ### | May 8, 2012 | 2:14:11 PM | 12.38 | 3.999 | 19.0252 | 3.095 | 49.508 | 0.069 | 266.68 | 12.430 | 3.9990 | 49.708 | 0.069 | 267.64 | 12.37 | 0.010 |
| ### | May 8, 2012 | 2:14:16 PM | 12.37 | 3.999 | 19.0308 | 3.093 | 49.468 | 0.069 | 266.75 | 12.420 | 3.9990 | 49.668 | 0.069 | 267.70 | 12.37 | −0.001 |
| ### | May 8, 2012 | 2:14:21 PM | 12.35 | 3.999 | 19.0363 | 3.088 | 49.388 | 0.069 | 266.82 | 12.400 | 3.9990 | 49.588 | 0.069 | 267.77 | 12.37 | −0.019 |
| ### | May 8, 2012 | 2:14:26 PM | 12.37 | 3.999 | 19.0419 | 3.093 | 49.468 | 0.069 | 266.89 | 12.420 | 3.9990 | 49.668 | 0.069 | 267.84 | 12.37 | 0.003 |
| ### | May 8, 2012 | 2:14:31 PM | 12.34 | 3.999 | 19.0474 | 3.085 | 49.348 | 0.069 | 266.96 | 12.390 | 3.9990 | 49.548 | 0.069 | 267.91 | 12.37 | −0.025 |
| ### | May 8, 2012 | 2:14:36 PM | 12.36 | 3.999 | 19.0529 | 3.090 | 49.428 | 0.069 | 267.03 | 12.410 | 3.9990 | 49.628 | 0.069 | 267.98 | 12.36 | −0.001 |
| ### | May 8, 2012 | 2:14:41 PM | 12.37 | 3.999 | 19.0583 | 3.093 | 49.468 | 0.069 | 267.09 | 12.420 | 3.9990 | 49.668 | 0.069 | 268.05 | 12.36 | 0.008 |
| ### | May 8, 2012 | 2:14:46 PM | 12.37 | 3.999 | 19.0639 | 3.093 | 49.468 | 0.069 | 267.16 | 12.420 | 3.9990 | 49.668 | 0.069 | 268.12 | 12.36 | 0.008 |
| ### | May 8, 2012 | 2:14:51 PM | 12.36 | 3.999 | 19.0694 | 3.090 | 49.428 | 0.069 | 267.23 | 12.410 | 3.9990 | 49.628 | 0.069 | 268.19 | 12.36 | −0.004 |
| ### | May 8, 2012 | 2:14:56 PM | 12.37 | 3.999 | 19.0749 | 3.093 | 49.468 | 0.069 | 267.30 | 12.420 | 3.9990 | 49.668 | 0.069 | 268.26 | 12.36 | 0.005 |
| ### | May 8, 2012 | 2:15:01 PM | 12.33 | 3.999 | 19.0805 | 3.083 | 49.308 | 0.068 | 267.37 | 12.380 | 3.9990 | 49.508 | 0.069 | 268.32 | 12.37 | −0.036 |
| ### | May 8, 2012 | 2:15:06 PM | 12.39 | 3.999 | 19.0860 | 3.098 | 49.548 | 0.069 | 267.44 | 12.440 | 3.9990 | 49.748 | 0.069 | 268.39 | 12.37 | 0.024 |
| ### | May 8, 2012 | 2:15:11 PM | 12.37 | 3.999 | 19.0916 | 3.093 | 49.468 | 0.069 | 267.51 | 12.420 | 3.9990 | 49.668 | 0.069 | 268.46 | 12.37 | 0.005 |
| ### | May 8, 2012 | 2:15:16 PM | 12.37 | 3.999 | 19.0971 | 3.093 | 49.468 | 0.069 | 267.58 | 12.420 | 3.9990 | 49.668 | 0.069 | 268.53 | 12.36 | 0.006 |
| ### | May 8, 2012 | 2:15:21 PM | 12.38 | 3.999 | 19.1023 | 3.095 | 49.508 | 0.069 | 267.64 | 12.430 | 3.9990 | 49.708 | 0.069 | 268.60 | 12.36 | 0.016 |
| ### | May 8, 2012 | 2:15:26 PM | 12.36 | 3.999 | 19.1082 | 3.090 | 49.428 | 0.069 | 267.71 | 12.410 | 3.9990 | 49.628 | 0.069 | 268.67 | 12.36 | −0.001 |
| ### | May 8, 2012 | 2:15:31 PM | 12.36 | 3.999 | 19.1138 | 3.090 | 49.428 | 0.069 | 267.78 | 12.410 | 3.9990 | 49.628 | 0.069 | 268.74 | 12.36 | −0.004 |
| ### | May 8, 2012 | 2:15:36 PM | 12.36 | 3.999 | 19.1193 | 3.090 | 49.428 | 0.069 | 267.85 | 12.410 | 3.9990 | 49.628 | 0.069 | 268.81 | 12.36 | 0.000 |
| ### | May 8, 2012 | 2:15:41 PM | 12.35 | 3.999 | 19.1249 | 3.088 | 49.388 | 0.069 | 267.92 | 12.400 | 3.9990 | 49.588 | 0.069 | 268.88 | 12.36 | −0.008 |
| ### | May 8, 2012 | 2:15:46 PM | 12.36 | 3.999 | 19.1304 | 3.090 | 49.428 | 0.069 | 267.99 | 12.410 | 3.9990 | 49.628 | 0.069 | 268.95 | 12.36 | 0.003 |
| ### | May 8, 2012 | 2:15:51 PM | 12.34 | 3.999 | 19.1359 | 3.085 | 49.348 | 0.069 | 268.06 | 12.390 | 3.9990 | 49.548 | 0.069 | 269.01 | 12.35 | −0.015 |
| ### | May 8, 2012 | 2:15:56 PM | 12.36 | 3.999 | 19.1415 | 3.090 | 49.428 | 0.069 | 268.12 | 12.410 | 3.9990 | 49.628 | 0.069 | 269.08 | 12.35 | 0.008 |
| ### | May 8, 2012 | 2:16:01 PM | 12.35 | 3.999 | 19.1470 | 3.088 | 49.388 | 0.069 | 268.19 | 12.400 | 3.9990 | 49.588 | 0.069 | 269.15 | 12.35 | 0.000 |
| ### | May 8, 2012 | 2:16:06 PM | 12.35 | 3.999 | 19.1526 | 3.088 | 49.388 | 0.069 | 268.26 | 12.400 | 3.9990 | 49.588 | 0.069 | 269.22 | 12.35 | 0.005 |
| ### | May 8, 2012 | 2:16:11 PM | 12.36 | 3.999 | 19.1581 | 3.090 | 49.428 | 0.069 | 268.33 | 12.410 | 3.9990 | 49.628 | 0.069 | 269.29 | 12.34 | 0.018 |
| ### | May 8, 2012 | 2:16:16 PM | 12.35 | 3.999 | 19.1637 | 3.088 | 49.388 | 0.069 | 268.40 | 12.400 | 3.9990 | 49.588 | 0.069 | 269.36 | 12.34 | 0.010 |
| ### | May 8, 2012 | 2:16:21 PM | 12.33 | 3.999 | 19.1692 | 3.083 | 49.308 | 0.068 | 268.47 | 12.380 | 3.9990 | 49.508 | 0.069 | 269.43 | 12.34 | −0.009 |
| ### | May 8, 2012 | 2:16:26 PM | 12.34 | 3.999 | 19.1747 | 3.085 | 49.348 | 0.069 | 268.54 | 12.390 | 3.9990 | 49.548 | 0.069 | 269.50 | 12.34 | 0.005 |
| ### | May 8, 2012 | 2:16:31 PM | 12.31 | 3.999 | 19.1803 | 3.078 | 49.228 | 0.068 | 268.60 | 12.360 | 3.9990 | 49.428 | 0.069 | 269.57 | 12.33 | −0.023 |
| ### | May 8, 2012 | 2:16:36 PM | 12.31 | 3.999 | 19.1858 | 3.078 | 49.228 | 0.068 | 268.67 | 12.360 | 3.9990 | 49.428 | 0.069 | 269.63 | 12.33 | −0.020 |
| ### | May 8, 2012 | 2:16:41 PM | 12.34 | 3.999 | 19.1914 | 3.085 | 49.348 | 0.069 | 268.74 | 12.390 | 3.9990 | 49.548 | 0.069 | 269.70 | 12.33 | 0.015 |
| ### | May 8, 2012 | 2:16:46 PM | 12.33 | 3.999 | 19.1969 | 3.083 | 49.308 | 0.068 | 268.81 | 12.380 | 3.9990 | 49.508 | 0.069 | 269.77 | 12.32 | 0.009 |
| ### | May 8, 2012 | 2:16:51 PM | 12.32 | 3.999 | 19.2025 | 3.080 | 49.268 | 0.068 | 268.88 | 12.370 | 3.9990 | 49.468 | 0.069 | 269.84 | 12.32 | −0.001 |
| ### | May 8, 2012 | 2:16:56 PM | 12.32 | 3.999 | 19.2080 | 3.080 | 49.268 | 0.068 | 268.95 | 12.370 | 3.9990 | 49.468 | 0.069 | 269.91 | 12.31 | 0.008 |
| ### | May 8, 2012 | 2:17:01 PM | 12.32 | 3.999 | 19.2135 | 3.080 | 49.268 | 0.068 | 269.02 | 12.370 | 3.9990 | 49.468 | 0.069 | 269.98 | 12.31 | 0.006 |
| ### | May 8, 2012 | 2:17:06 PM | 12.31 | 3.999 | 19.2191 | 3.078 | 49.228 | 0.068 | 269.08 | 12.360 | 3.9990 | 49.428 | 0.069 | 270.05 | 12.32 | −0.006 |
| ### | May 8, 2012 | 2:17:11 PM | 12.30 | 3.999 | 19.2246 | 3.075 | 49.188 | 0.068 | 269.15 | 12.350 | 3.9990 | 49.388 | 0.069 | 270.11 | 12.31 | −0.014 |
| ### | May 8, 2012 | 2:17:16 PM | 12.33 | 3.999 | 19.2302 | 3.083 | 49.308 | 0.068 | 269.22 | 12.380 | 3.9990 | 49.508 | 0.069 | 270.18 | 12.31 | 0.016 |
| ### | May 8, 2012 | 2:17:21 PM | 12.24 | 3.999 | 19.2357 | 3.060 | 48.948 | 0.068 | 269.29 | 12.290 | 3.9990 | 49.148 | 0.068 | 270.25 | 12.31 | −0.075 |
| ### | May 8, 2012 | 2:17:26 PM | 12.33 | 3.999 | 19.2413 | 3.083 | 49.308 | 0.068 | 269.36 | 12.380 | 3.9990 | 49.508 | 0.069 | 270.32 | 12.31 | 0.015 |
| ### | May 8, 2012 | 2:17:31 PM | 12.34 | 3.999 | 19.2468 | 3.085 | 49.348 | 0.069 | 269.43 | 12.390 | 3.9990 | 49.548 | 0.069 | 270.39 | 12.32 | 0.025 |
| ### | May 8, 2012 | 2:17:36 PM | 12.31 | 3.999 | 19.2523 | 3.078 | 49.228 | 0.068 | 269.49 | 12.360 | 3.9990 | 49.428 | 0.069 | 270.46 | 12.32 | −0.006 |
| ### | May 8, 2012 | 2:17:41 PM | 12.33 | 3.999 | 19.2579 | 3.083 | 49.308 | 0.068 | 269.56 | 12.380 | 3.9990 | 49.508 | 0.069 | 270.53 | 12.32 | 0.011 |
| ### | May 8, 2012 | 2:17:46 PM | 12.33 | 3.999 | 19.2634 | 3.083 | 49.308 | 0.068 | 269.63 | 12.380 | 3.9990 | 49.508 | 0.069 | 270.60 | 12.32 | 0.011 |
| ### | May 8, 2012 | 2:17:51 PM | 12.32 | 3.999 | 19.2691 | 3.080 | 49.268 | 0.068 | 269.70 | 12.370 | 3.9990 | 49.468 | 0.069 | 270.66 | 12.32 | −0.003 |
| ### | May 8, 2012 | 2:17:56 PM | 12.33 | 3.999 | 19.2747 | 3.083 | 49.308 | 0.068 | 269.77 | 12.380 | 3.9990 | 49.508 | 0.069 | 270.73 | 12.32 | 0.007 |
| ### | May 8, 2012 | 2:18:01 PM | 12.32 | 3.999 | 19.2802 | 3.080 | 49.268 | 0.068 | 269.84 | 12.370 | 3.9990 | 49.468 | 0.069 | 270.80 | 12.32 | −0.001 |
| ### | May 8, 2012 | 2:18:06 PM | 12.33 | 3.999 | 19.2858 | 3.083 | 49.308 | 0.068 | 269.90 | 12.380 | 3.9990 | 49.508 | 0.069 | 270.87 | 12.32 | 0.009 |
| ### | May 8, 2012 | 2:18:11 PM | 12.33 | 3.999 | 19.2913 | 3.083 | 49.308 | 0.068 | 269.97 | 12.380 | 3.9990 | 49.508 | 0.069 | 270.94 | 12.32 | 0.012 |
| ### | May 8, 2012 | 2:18:16 PM | 12.28 | 3.999 | 19.2967 | 3.070 | 49.108 | 0.068 | 270.04 | 12.330 | 3.9990 | 49.308 | 0.068 | 271.01 | 12.31 | −0.034 |
| ### | May 8, 2012 | 2:18:21 PM | 12.33 | 3.999 | 19.3022 | 3.083 | 49.308 | 0.068 | 270.11 | 12.380 | 3.9990 | 49.508 | 0.069 | 271.08 | 12.31 | 0.019 |
| ### | May 8, 2012 | 2:18:26 PM | 12.32 | 3.999 | 19.3078 | 3.080 | 49.268 | 0.068 | 270.18 | 12.370 | 3.9990 | 49.468 | 0.069 | 271.15 | 12.31 | 0.014 |
| ### | May 8, 2012 | 2:18:31 PM | 12.31 | 3.999 | 19.3133 | 3.078 | 49.228 | 0.068 | 270.25 | 12.360 | 3.9990 | 49.428 | 0.069 | 271.21 | 12.30 | 0.010 |
| ### | May 8, 2012 | 2:18:36 PM | 12.30 | 3.999 | 19.3189 | 3.075 | 49.188 | 0.068 | 270.31 | 12.350 | 3.9990 | 49.388 | 0.069 | 271.28 | 12.29 | 0.006 |
| ### | May 8, 2012 | 2:18:41 PM | 12.28 | 3.999 | 19.3244 | 3.070 | 49.108 | 0.068 | 270.38 | 12.330 | 3.9990 | 49.308 | 0.068 | 271.35 | 12.29 | −0.006 |
| ### | May 8, 2012 | 2:18:46 PM | 12.29 | 3.999 | 19.3300 | 3.073 | 49.148 | 0.068 | 270.45 | 12.340 | 3.9990 | 49.348 | 0.069 | 271.42 | 12.29 | 0.005 |
| ### | May 8, 2012 | 2:18:51 PM | 12.28 | 3.999 | 19.3355 | 3.070 | 49.108 | 0.068 | 270.52 | 12.330 | 3.9990 | 49.308 | 0.068 | 271.49 | 12.28 | −0.002 |
| ### | May 8, 2012 | 2:18:56 PM | 12.25 | 3.999 | 19.3410 | 3.063 | 48.988 | 0.068 | 270.59 | 12.300 | 3.9990 | 49.188 | 0.068 | 271.56 | 12.28 | −0.029 |
| ### | May 8, 2012 | 2:19:01 PM | 12.26 | 3.999 | 19.3466 | 3.065 | 49. [symbol] | 0.068 | 270. [symbol] | [symbol] | 3.9990 | 49.288 | 0.068 | 271.62 | 12.27 | −0.013 |
| ### | May 8, 2012 | 2:19:06 PM | 12.25 | 3.999 | 19.3521 | 3.063 | 48.988 | 0.068 | 270.72 | 12.300 | 3.9990 | 49.188 | 0.068 | 271.69 | 12.27 | −0.018 |
| ### | May 8, 2012 | 2:19:11 PM | 12.27 | 3.999 | 19.3577 | 3.068 | 49.068 | 0.068 | 270.79 | 12.320 | 3.9990 | 49.268 | 0.068 | 271.76 | 12.27 | 0.005 |
| ### | May 8, 2012 | 2:19:16 PM | 12.29 | 3.999 | 19.3632 | 3.073 | 49.148 | 0.068 | 270.86 | 12.340 | 3.9990 | 49.348 | 0.069 | 271.83 | 12.26 | 0.030 |
| ### | May 8, 2012 | 2:19:21 PM | 12.29 | 3.999 | 19.3688 | 3.073 | 49.148 | 0.068 | 270.93 | 12.340 | 3.9990 | 49.348 | 0.069 | 271.90 | 12.26 | 0.030 |
| ### | May 8, 2012 | 2:19:26 PM | 12.24 | 3.999 | 19.3743 | 3.060 | 48.948 | 0.068 | 271.00 | 12.290 | 3.9990 | 49.148 | 0.068 | 271.97 | 12.26 | −0.022 |
| ### | May 8, 2012 | 2:19:31 PM | 12.25 | 3.999 | 19.3799 | 3.063 | 48.988 | 0.068 | 271.06 | 12.300 | 3.9990 | 49.188 | 0.068 | 272.03 | 12.26 | −0.011 |
| ### | May 8, 2012 | 2:19:36 PM | 12.25 | 3.999 | 19.3854 | 3.063 | 48.988 | 0.068 | 271.13 | 12.300 | 3.9990 | 49.188 | 0.068 | 272.10 | 12.26 | −0.011 |
| ### | May 8, 2012 | 2:19:41 PM | 12.23 | 3.999 | 19.3909 | 3.058 | 48.908 | 0.068 | 271.20 | 12.280 | 3.9990 | 49.108 | 0.068 | 272.17 | 12.26 | −0.032 |
| ### | May 8, 2012 | 2:19:46 PM | 12.28 | 3.999 | 19.3965 | 3.070 | 49.108 | 0.068 | 271.27 | 12.330 | 3.9990 | 49.308 | 0.068 | 272.24 | 12.26 | 0.020 |
| ### | May 8, 2012 | 2:19:51 PM | 12.27 | 3.999 | 19.4020 | 3.068 | 49.068 | 0.068 | 271.34 | 12.320 | 3.9990 | 49.268 | 0.068 | 272.31 | 12.26 | 0.013 |
| ### | May 8, 2012 | 2:19:56 PM | 12.25 | 3.999 | 19.4076 | 3.063 | 48.988 | 0.068 | 271.40 | 12.300 | 3.9990 | 49.188 | 0.068 | 272.38 | 12.26 | −0.008 |
| ### | May 8, 2012 | 2:20:01 PM | 12.25 | 3.999 | 19.4131 | 3.063 | 48.988 | 0.068 | 271.47 | 12.300 | 3.9990 | 49.188 | 0.068 | 272.45 | 12.26 | −0.012 |
| ### | May 8, 2012 | 2:20:06 PM | 12.28 | 3.999 | 19.4187 | 3.070 | 49.108 | 0.068 | 271.54 | 12.330 | 3.9990 | 49.308 | 0.068 | 272.51 | 12.26 | 0.015 |
| ### | May 8, 2012 | 2:20:11 PM | 12.27 | 3.999 | 19.4242 | 3.068 | 49.068 | 0.068 | 271.61 | 12.320 | 3.9990 | 49.268 | 0.068 | 272.58 | 12.27 | 0.003 |
| ### | May 8, 2012 | 2:20:16 PM | 12.26 | 3.999 | 19.4297 | 3.065 | 49.028 | 0.068 | 271.68 | 12.310 | 3.9990 | 49.228 | 0.068 | 272.65 | 12.26 | −0.005 |
| ### | May 8, 2012 | 2:20:21 PM | 12.25 | 3.999 | 19.4353 | 3.063 | 48.988 | 0.068 | 271.75 | 12.300 | 3.9990 | 49.188 | 0.068 | 272.72 | 12.26 | −0.012 |
| ### | May 8, 2012 | 2:20:26 PM | 12.29 | 3.999 | 19.4408 | 3.073 | 49.148 | 0.068 | 271.81 | 12.340 | 3.9990 | 49.348 | 0.069 | 272.79 | 12.27 | 0.025 |
| ### | May 8, 2012 | 2:20:31 PM | 12.28 | 3.999 | 19.4464 | 3.070 | 49.108 | 0.068 | 271.88 | 12.330 | 3.9990 | 49.308 | 0.068 | 272.86 | 12.27 | 0.012 |
| ### | May 8, 2012 | 2:20:36 PM | 12.26 | 3.999 | 19.4521 | 3.065 | 49.028 | 0.068 | 271.95 | 12.310 | 3.9990 | 49.228 | 0.068 | 272.92 | 12.27 | −0.008 |
| ### | May 8, 2012 | 2:20:41 PM | 12.25 | 3.999 | 19.4576 | 3.063 | 48.988 | 0.068 | 272.02 | 12.300 | 3.9990 | 49.188 | 0.068 | 272.99 | 12.27 | −0.018 |
| ### | May 8, 2012 | 2:20:46 PM | 12.24 | 3.999 | 19.4632 | 3.060 | 48.948 | 0.068 | 272.09 | 12.290 | 3.9990 | 49.148 | 0.068 | 273.06 | 12.27 | −0.029 |
| ### | May 8, 2012 | 2:20:51 PM | 12.29 | 3.999 | 19.4687 | 3.073 | 49.148 | 0.068 | 272.15 | 12.340 | 3.9990 | 49.348 | 0.069 | 273.13 | 12.27 | 0.020 |
| ### | May 8, 2012 | 2:20:56 PM | 12.28 | 3.999 | 19.4743 | 3.070 | 49.108 | 0.068 | 272.22 | 12.330 | 3.9990 | 49.308 | 0.068 | 273.20 | 12.27 | 0.013 |
| ### | May 8, 2012 | 2:21:01 PM | 12.28 | 3.999 | 19.4796 | 3.070 | 49.108 | 0.068 | 272.29 | 12.300 | 3.9990 | 49.308 | 0.068 | 273.27 | 12.26 | 0.015 |
| ### | May 8, 2012 | 2:21:06 PM | 12.27 | 3.999 | 19.4852 | 3.068 | 49.068 | 0.068 | 272.36 | 12.320 | 3.9990 | 49.268 | 0.068 | 273.33 | 12.26 | 0.007 |
| ### | May 8, 2012 | 2:21:11 PM | 12.27 | 3.999 | 19.4907 | 3.068 | 49.068 | 0.068 | 272.43 | 12.320 | 3.9990 | 49.268 | 0.068 | 273.40 | 12.26 | 0.008 |
| ### | May 8, 2012 | 2:21:16 PM | 12.26 | 3.999 | 19.4963 | 3.065 | 49.028 | 0.068 | 272.49 | 12.310 | 3.9990 | 49.228 | 0.068 | 273.47 | 12.26 | −0.001 |
| ### | May 8, 2012 | 2:21:21 PM | 12.26 | 3.999 | 19.5020 | 3.065 | 49.028 | 0.068 | 272.56 | 12.310 | 3.9990 | 49.228 | 0.068 | 273.54 | 12.25 | 0.005 |
| ### | May 8, 2012 | 2:21:26 PM | 12.25 | 3.999 | 19.5075 | 3.063 | 48.988 | 0.068 | 272.63 | 12.300 | 3.9990 | 49.188 | 0.068 | 273.61 | 12.25 | 0.001 |
| ### | May 8, 2012 | 2:21:31 PM | 12.24 | 3.999 | 19.5131 | 3.060 | 48.948 | 0.068 | 272.70 | 12.290 | 3.9990 | 49.148 | 0.068 | 273.68 | 12.24 | −0.004 |
| ### | May 8, 2012 | 2:21:36 PM | 12.24 | 3.999 | 19.5186 | 3.060 | 48.948 | 0.068 | 272.77 | 12.290 | 3.9990 | 49.148 | 0.068 | 273.74 | 12.24 | 0.001 |
| ### | May 8, 2012 | 2:21:41 PM | 12.23 | 3.999 | 19.5242 | 3.058 | 48.908 | 0.068 | 272.83 | 12.280 | 3.9990 | 49.108 | 0.068 | 273.81 | 12.23 | −0.005 |
| ### | May 8, 2012 | 2:21:46 PM | 12.22 | 3.999 | 19.5297 | 3.055 | 48.868 | 0.068 | 272.90 | 12.270 | 3.9990 | 49.068 | 0.068 | 273.88 | 12.23 | −0.011 |
| ### | May 8, 2012 | 2:21:51 PM | 12.22 | 3.999 | 19.5353 | 3.055 | 48.868 | 0.068 | 272.97 | 12.270 | 3.9990 | 49.068 | 0.068 | 273.95 | 12.23 | −0.006 |
| ### | May 8, 2012 | 2:21:56 PM | 12.22 | 3.999 | 19.5408 | 3.055 | 48.868 | 0.068 | 273.04 | 12.270 | 3.9990 | 49.068 | 0.068 | 274.02 | 12.22 | −0.003 |
| ### | May 8, 2012 | 2:22:01 PM | 12.22 | 3.999 | 19.5463 | 3.055 | 48.868 | 0.068 | 273.11 | 12.270 | 3.9990 | 49.068 | 0.068 | 274.09 | 12.22 | 0.000 |
| ### | May 8, 2012 | 2:22:06 PM | 12.22 | 3.999 | 19.5519 | 3.055 | 48.868 | 0.068 | 273.17 | 12.270 | 3.9990 | 49.068 | 0.068 | 274.15 | 12.22 | 0.004 |
| ### | May 8, 2012 | 2:22:11 PM | 12.22 | 3.999 | 19.5574 | 3.055 | 48.868 | 0.068 | 273.24 | 12.270 | 3.9990 | 49.068 | 0.068 | 274.22 | 12.21 | 0.006 |
| ### | May 8, 2012 | 2:22:16 PM | 12.21 | 3.999 | 19.5630 | 3.053 | 48.828 | 0.068 | 273.31 | 12.260 | 3.9990 | 49.028 | 0.068 | 274.29 | 12.21 | 0.000 |
| ### | May 8, 2012 | 2:22:21 PM | 12.21 | 3.999 | 19.5685 | 3.053 | 48.828 | 0.068 | 273.38 | 12.260 | 3.9990 | 49.028 | 0.068 | 274.36 | 12.21 | 0.005 |
| ### | May 8, 2012 | 2:22:26 PM | 12.21 | 3.999 | 19.5739 | 3.053 | 48.828 | 0.068 | 273.45 | 12.260 | 3.9990 | 49.028 | 0.068 | 274.43 | 12.20 | 0.005 |
| ### | May 8, 2012 | 2:22:31 PM | 12.20 | 3.999 | 19.5794 | 3.050 | 48.788 | 0.068 | 273.51 | 12.250 | 3.9990 | 48.988 | 0.068 | 274.49 | 12.20 | −0.003 |
| ### | May 8, 2012 | 2:22:36 PM | 12.20 | 3.999 | 19.5850 | 3.050 | 48.788 | 0.068 | 273.58 | 12.250 | 3.9990 | 48.988 | 0.068 | 274.56 | 12.20 | 0.003 |
| ### | May 8, 2012 | 2:22:41 PM | 12.18 | 3.999 | 19.5905 | 3.045 | 48.708 | 0.068 | 273.65 | 12.230 | 3.9990 | 48.908 | 0.068 | 274.63 | 12.20 | −0.015 |
| ### | May 8, 2012 | 2:22:46 PM | 12.17 | 3.999 | 19.5961 | 3.043 | 48.668 | 0.068 | 273.72 | 12.220 | 3.9990 | 48.868 | 0.068 | 274.70 | 12.19 | −0.023 |
| ### | May 8, 2012 | 2:22:51 PM | 12.21 | 3.999 | 19.6016 | 3.053 | 48.828 | 0.068 | 273.78 | 12.260 | 3.9990 | 49.028 | 0.068 | 274.77 | 12.19 | 0.019 |
| ### | May 8, 2012 | 2:22:56 PM | 12.20 | 3.999 | 19.6072 | 3.050 | 48.788 | 0.068 | 273.85 | 12.250 | 3.9990 | 48.988 | 0.068 | 274.83 | 12.19 | 0.012 |
| ### | May 8, 2012 | 2:23:01 PM | 12.16 | 3.999 | 19.6127 | 3.040 | 48.628 | 0.068 | 273.92 | 12.210 | 3.9990 | 48.828 | 0.068 | 274.90 | 12.19 | −0.025 |
| ### | May 8, 2012 | 2:23:06 PM | 12.20 | 3.999 | 19.6182 | 3.050 | 48.788 | 0.068 | 273.99 | 12.250 | 3.9990 | 48.988 | 0.068 | 274.97 | 12.19 | 0.014 |
| ### | May 8, 2012 | 2:23:11 PM | 12.18 | 3.999 | 19.6238 | 3.045 | 48.708 | 0.068 | 274.05 | 12.230 | 3.9990 | 48.908 | 0.068 | 275.04 | 12.19 | −0.008 |
| ### | May 8, 2012 | 2:23:16 PM | 12.19 | 3.999 | 19.6293 | 3.048 | 48.748 | 0.068 | 274.12 | 12.240 | 3.9990 | 48.948 | 0.068 | 275.11 | 12.19 | −0.001 |
| ### | May 8, 2012 | 2:23:21 PM | 12.18 | 3.999 | 19.6349 | 3.045 | 48.708 | 0.068 | 274.19 | 12.230 | 3.9990 | 48.908 | 0.068 | 275.17 | 12.19 | −0.009 |
| ### | May 8, 2012 | 2:23:26 PM | 12.17 | 3.999 | 19.6404 | 3.043 | 48.668 | 0.068 | 274.26 | 12.220 | 3.9990 | 48.868 | 0.068 | 275.24 | 12.19 | −0.018 |
| ### | May 8, 2012 | 2:23:31 PM | 12.21 | 3.999 | 19.6460 | 3.053 | 48.828 | 0.068 | 274.33 | 12.260 | 3.9990 | 49.028 | 0.068 | 275.31 | 12.19 | 0.020 |
| ### | May 8, 2012 | 2:23:36 PM | 12.20 | 3.999 | 19.6515 | 3.050 | 48.788 | 0.068 | 274.39 | 12.250 | 3.9990 | 48.988 | 0.068 | 275.38 | 12.19 | 0.012 |
| ### | May 8, 2012 | 2:23:41 PM | 12.20 | 3.999 | 19.6570 | 3.050 | 48.788 | 0.068 | 274.46 | 12.250 | 3.9990 | 48.988 | 0.068 | 275.45 | 12.19 | 0.009 |
| ### | May 8, 2012 | 2:23:46 PM | 12.19 | 3.999 | 19.6628 | 3.048 | 48.748 | 0.068 | 274.53 | 12.240 | 3.9990 | 48.948 | 0.068 | 275.51 | 12.19 | 0.001 |
| ### | May 8, 2012 | 2:23:51 PM | 12.19 | 3.999 | 19.6683 | 3.048 | 48.748 | 0.068 | 274.60 | 12.240 | 3.9990 | 48.948 | 0.068 | 275.58 | 12.19 | 0.003 |
| ### | May 8, 2012 | 2:23:56 PM | 12.18 | 3.999 | 19.6739 | 3.045 | 48.708 | 0.068 | 274.66 | 12.230 | 3.9990 | 48.908 | 0.068 | 275.65 | 12.19 | −0.006 |
| ### | May 8, 2012 | 2:24:01 PM | 12.18 | 3.999 | 19.6794 | 3.045 | 48.708 | 0.068 | 274.73 | 12.230 | 3.9990 | 48.908 | 0.068 | 275.72 | 12.18 | −0.001 |
| ### | May 8, 2012 | 2:24:06 PM | 12.21 | 3.999 | 19.6849 | 3.053 | 48.828 | 0.068 | 274.80 | 12.260 | 3.9990 | 49.028 | 0.068 | 275.79 | 12.18 | 0.034 |
| ### | May 8, 2012 | 2:24:11 PM | 12.17 | 3.999 | 19.6905 | 3.043 | 48.668 | 0.068 | 274.87 | 12.220 | 3.9990 | 48.868 | 0.068 | 275.85 | 12.17 | −0.002 |
| ### | May 8, 2012 | 2:24:16 PM | 12.16 | 3.999 | 19.6960 | 3.040 | 48.628 | 0.068 | 274.93 | 12.210 | 3.9990 | 48.828 | 0.068 | 275.92 | 12.17 | −0.008 |
| ### | May 8, 2012 | 2:24:21 PM | 12.16 | 3.999 | 19.7016 | 3.040 | 48.628 | 0.068 | 275.00 | 12.210 | 3.9990 | 48.828 | 0.068 | 275.99 | 12.16 | −0.004 |
| ### | May 8, 2012 | 2:24:26 PM | 12.15 | 3.999 | 19.7071 | 3.038 | 48.588 | 0.067 | 275.07 | 12.200 | 3.9990 | 48.788 | 0.068 | 276.06 | 12.16 | −0.010 |
| ### | May 8, 2012 | 2:24:31 PM | 12.15 | 3.999 | 19.7127 | 3.038 | 48.588 | 0.067 | 275.14 | 12.200 | 3.9990 | 48.788 | 0.068 | 276.12 | 12.16 | −0.005 |
| ### | May 8, 2012 | 2:24:36 PM | 12.15 | 3.999 | 19.7182 | 3.038 | 48.588 | 0.067 | 275.20 | 12.200 | 3.9990 | 48.788 | 0.068 | 276.19 | 12.15 | 0.003 |
| ### | May 8, 2012 | 2:24:41 PM | 12.15 | 3.999 | 19.7237 | 3.038 | 48.588 | 0.067 | 275.27 | 12.200 | 3.9990 | 48.788 | 0.068 | 276.26 | 12.15 | 0.003 |
| ### | May 8, 2012 | 2:24:46 PM | 12.14 | 3.999 | 19.7293 | 3.035 | 48.548 | 0.067 | 275.34 | 12.190 | 3.9990 | 48.748 | 0.068 | 276.33 | 12.15 | −0.008 |
| ### | May 8, 2012 | 2:24:51 PM | 12.14 | 3.999 | 19.7348 | 3.035 | 48.548 | 0.067 | 275.41 | 12.190 | 3.9990 | 48.748 | 0.068 | 276.40 | 12.15 | −0.007 |
| ### | May 8, 2012 | 2:24:56 PM | 12.13 | 3.999 | 19.7404 | 3.033 | 48.508 | 0.067 | 275.47 | 12.180 | 3.9990 | 48.708 | 0.068 | 276.46 | 12.15 | −0.018 |
| ### | May 8, 2012 | 2:25:01 PM | 12.12 | 3.999 | 19.7459 | 3.030 | 48.468 | 0.067 | 275.54 | 12.170 | 3.9990 | 48.668 | 0.068 | 276.53 | 12.15 | −0.030 |
| ### | May 8, 2012 | 2:25:06 PM | 12.17 | 3.999 | 19.7515 | 3.043 | 48.668 | 0.068 | 275.61 | 12.220 | 3.9990 | 48.868 | 0.068 | 276.60 | 12.15 | 0.019 |
| ### | May 8, 2012 | 2:25:11 PM | 12.17 | 3.999 | 19.7571 | 3.043 | 48.668 | 0.068 | 275.68 | 12.220 | 3.9990 | 48.868 | 0.068 | 276.67 | 12.15 | 0.025 |
| ### | May 8, 2012 | 2:25:16 PM | 12.15 | 3.999 | 19.7626 | 3.038 | 48.588 | 0.067 | 275.74 | 12.200 | 3.9990 | 48.788 | 0.068 | 276.73 | 12.15 | 0.000 |
| ### | May 8, 2012 | 2:25:21 PM | 12.16 | 3.999 | 19.7681 | 3.040 | 48.628 | 0.068 | 275.81 | 12.210 | 3.9990 | 48.828 | 0.068 | 276.80 | 12.15 | 0.008 |
| ### | May 8, 2012 | 2:25:26 PM | 12.17 | 3.999 | 19.7737 | 3.043 | 48.668 | 0.068 | 275.88 | 12.200 | 3.9990 | 48.868 | 0.068 | 276.87 | 12.15 | 0.017 |
| ### | May 8, 2012 | 2:25:31 PM | 12.16 | 3.999 | 19.7792 | 3.040 | 48.628 | 0.068 | 275.95 | 12.210 | 3.9990 | 48.828 | 0.068 | 276.94 | 12.16 | 0.004 |
| ### | May 8, 2012 | 2:25:36 PM | 12.09 | 3.999 | 19.7847 | 3.023 | 48.348 | 0.067 | 276.01 | 12.140 | 3.9990 | 48.548 | 0.067 | 277.01 | 12.15 | −0.065 |
| ### | May 8, 2012 | 2:25:41 PM | 12.19 | 3.999 | 19.7903 | 3.048 | 48.748 | 0.068 | 276.08 | 12.240 | 3.9990 | 48.948 | 0.068 | 277.07 | 12.15 | 0.036 |
| ### | May 8, 2012 | 2:25:46 PM | 12.16 | 3.999 | 19.7959 | 3.040 | 48.628 | 0.068 | 276.15 | 12.210 | 3.9990 | 48.828 | 0.068 | 277.14 | 12.15 | 0.005 |
| ### | May 8, 2012 | 2:25:51 PM | 12.14 | 4.000 | 19.8014 | 3.035 | 48.560 | 0.067 | 276.22 | 12.190 | 4.0000 | 48.760 | 0.068 | 277.21 | 12.15 | −0.014 |
| ### | May 8, 2012 | 2:25:56 PM | 12.16 | 3.999 | 19.8068 | 3.040 | 48.628 | 0.068 | 276.28 | 12.210 | 3.9990 | 48.828 | 0.068 | 277.28 | 12.15 | 0.008 |
| ### | May 8, 2012 | 2:26:01 PM | 12.15 | 3.999 | 19.8123 | 3.038 | 48.588 | 0.067 | 276.35 | 12.200 | 3.9990 | 48.788 | 0.068 | 277.34 | 12.15 | −0.001 |
| ### | May 8, 2012 | 2:26:06 PM | 12.16 | 3.999 | 19.8179 | 3.040 | 48.628 | 0.068 | 276.42 | 12.210 | 3.9990 | 48.828 | 0.068 | 277.41 | 12.16 | 0.003 |
| ### | May 8, 2012 | 2:26:11 PM | 12.16 | 3.999 | 19.8234 | 3.040 | 48.628 | 0.068 | 276.49 | 12.210 | 3.9990 | 48.828 | 0.068 | 277.48 | 12.15 | 0.006 |
| ### | May 8, 2012 | 2:26:16 PM | 12.15 | 3.999 | 19.8289 | 3.038 | 48.588 | 0.067 | 276.55 | 12.200 | 3.9990 | 48.788 | 0.068 | 277.55 | 12.15 | −0.003 |
| ### | May 8, 2012 | 2:26:21 PM | 12.15 | 3.999 | 19.8345 | 3.038 | 48.588 | 0.067 | 276.62 | 12.200 | 3.9990 | 48.788 | 0.068 | 277.62 | 12.15 | −0.004 |
| ### | May 8, 2012 | 2:26:26 PM | 12.15 | 4.000 | 19.8400 | 3.038 | 48.600 | 0.068 | 276.69 | 12.200 | 4.0000 | 48.800 | 0.068 | 277.68 | 12.15 | −0.002 |
| ### | May 8, 2012 | 2:26:31 PM | 12.16 | 3.999 | 19.8456 | 3.040 | 48.628 | 0.068 | 276.76 | 12.210 | 3.9990 | 48.828 | 0.068 | 277.75 | 12.15 | 0.009 |
| ### | May 8, 2012 | 2:26:36 PM | 12.15 | 3.999 | 19.8511 | 3.038 | 48.588 | 0.067 | 276.82 | 12.200 | 3.9990 | 48.788 | 0.068 | 277.82 | 12.15 | 0.002 |
| ### | May 8, 2012 | 2:26:41 PM | 12.15 | 3.999 | 19.8567 | 3.038 | 48.588 | 0.067 | 276.89 | 12.200 | 3.9990 | 48.788 | 0.068 | 277.89 | 12.15 | 0.005 |
| ### | May 8, 2012 | 2:26:46 PM | 12.15 | 3.999 | 19.8622 | 3.038 | 48.588 | 0.067 | 276.96 | 12.200 | 3.9990 | 48.788 | 0.068 | 277.95 | 12.14 | 0.006 |
| ### | May 8, 2012 | 2:26:51 PM | 12.14 | 3.999 | 19.8677 | 3.035 | 48.548 | 0.067 | 277.03 | 12.190 | 3.9990 | 48.748 | 0.068 | 278.02 | 12.14 | −0.002 |
| ### | May 8, 2012 | 2:26:56 PM | 12.14 | 3.999 | 19.8733 | 3.035 | 48.548 | 0.067 | 277.09 | 12.190 | 3.9990 | 48.748 | 0.068 | 278.09 | 12.14 | 0.001 |
| ### | May 8, 2012 | 2:27:01 PM | 12.13 | 3.999 | 19.8788 | 3.033 | 48.508 | 0.067 | 277.16 | 12.180 | 3.9990 | 48.708 | 0.068 | 278.16 | 12.14 | −0.005 |
| ### | May 8, 2012 | 2:27:06 PM | 12.13 | 3.999 | 19.8844 | 3.033 | 48.508 | 0.067 | 277.23 | 12.180 | 3.9990 | 48.708 | 0.068 | 278.23 | 12.13 | −0.003 |
| ### | May 8, 2012 | 2:27:11 PM | 12.13 | 3.999 | 19.8899 | 3.033 | 48.508 | 0.067 | 277.30 | 12.180 | 3.9990 | 48.708 | 0.068 | 278.29 | 12.13 | 0.001 |
| ### | May 8, 2012 | 2:27:16 PM | 12.13 | 3.999 | 19.8955 | 3.033 | 48.508 | 0.067 | 277.36 | 12.180 | 3.9990 | 48.708 | 0.068 | 278.36 | 12.13 | 0.005 |
| ### | May 8, 2012 | 2:27:21 PM | 12.12 | 3.999 | 19.9010 | 3.030 | 48.468 | 0.067 | 277.43 | 12.170 | 3.9990 | 48.668 | 0.068 | 278.43 | 12.12 | −0.003 |
| ### | May 8, 2012 | 2:27:26 PM | 12.12 | 3.999 | 19.9067 | 3.030 | 48.468 | 0.067 | 277.50 | 12.170 | 3.9990 | 48.668 | 0.068 | 278.50 | 12.12 | 0.001 |
| ### | May 8, 2012 | 2:27:31 PM | 12.12 | 3.999 | 19.9123 | 3.030 | 48.468 | 0.067 | 277.57 | 12.170 | 3.9990 | 48.668 | 0.068 | 278.56 | 12.12 | 0.004 |
| ### | May 8, 2012 | 2:27:36 PM | 12.11 | 3.999 | 19.9178 | 3.028 | 48.428 | 0.067 | 277.63 | 12.160 | 3.9990 | 48.628 | 0.068 | 278.63 | 12.11 | −0.004 |
| ### | May 8, 2012 | 2:27:41 PM | 12.11 | 3.999 | 19.9233 | 3.028 | 48.428 | 0.067 | 277.70 | 12.160 | 3.9990 | 48.628 | 0.068 | 278.70 | 12.11 | 0.000 |
| ### | May 8, 2012 | 2:27:46 PM | 12.11 | 3.999 | 19.9287 | 3.028 | 48.428 | 0.067 | 277.77 | 12.160 | 3.9990 | 48.628 | 0.068 | 278.77 | 12.11 | 0.004 |
| ### | May 8, 2012 | 2:27:51 PM | 12.10 | 3.999 | 19.9343 | 3.025 | 48.388 | 0.067 | 277.83 | 12.150 | 3.9990 | 48.588 | 0.067 | 278.83 | 12.10 | −0.003 |
| ### | May 8, 2012 | 2:27:56 PM | 12.10 | 3.999 | 19.9398 | 3.025 | 48.388 | 0.067 | 277.90 | 12.150 | 3.9990 | 48.588 | 0.067 | 278.90 | 12.10 | 0.001 |
| ### | May 8, 2012 | 2:28:01 PM | 12.10 | 3.999 | 19.9454 | 3.025 | 48.388 | 0.067 | 277.97 | 12.150 | 3.9990 | 48.588 | 0.067 | 278.97 | 12.09 | 0.005 |
| ### | May 8, 2012 | 2:28:06 PM | 12.09 | 3.999 | 19.9509 | 3.023 | 48.348 | 0.067 | 278.04 | 12.140 | 3.9990 | 48.548 | 0.067 | 279.04 | 12.09 | −0.001 |
| ### | May 8, 2012 | 2:28:11 PM | 12.09 | 3.999 | 19.9564 | 3.023 | 48.348 | 0.067 | 278.10 | 12.140 | 3.9990 | 48.548 | 0.067 | 279.10 | 12.09 | 0.004 |
| ### | May 8, 2012 | 2:28:16 PM | 12.08 | 3.999 | 19.9620 | 3.020 | 48.308 | 0.067 | 278.17 | 12.130 | 3.9990 | 48.508 | 0.067 | 279.17 | 12.08 | −0.002 |
| ### | May 8, 2012 | 2:28:21 PM | 12.08 | 3.999 | 19.9675 | 3.020 | 48.308 | 0.067 | 278.24 | 12.130 | 3.9990 | 48.508 | 0.067 | 279.24 | 12.08 | 0.002 |
| ### | May 8, 2012 | 2:28:26 PM | 12.07 | 3.999 | 19.9731 | 3.018 | 48.268 | 0.067 | 278.30 | 12.120 | 3.9990 | 48.468 | 0.067 | 279.31 | 12.07 | −0.004 |
| ### | May 8, 2012 | 2:28:31 PM | 12.07 | 3.999 | 19.9786 | 3.018 | 48.268 | 0.067 | 278.37 | 12.120 | 3.9990 | 48.468 | 0.067 | 279.37 | 12.07 | −0.001 |
| ### | May 8, 2012 | 2:28:36 PM | 12.06 | 3.999 | 19.9842 | 3.015 | 48.228 | 0.067 | 278.44 | 12.110 | 3.9990 | 48.428 | 0.067 | 279.44 | 12.07 | −0.005 |
| ### | May 8, 2012 | 2:28:41 PM | 12.06 | 3.999 | 19.9897 | 3.015 | 48.228 | 0.067 | 278.51 | 12.110 | 3.9990 | 48.428 | 0.067 | 279.51 | 12.06 | −0.002 |
| ### | May 8, 2012 | 2:28:46 PM | 12.06 | 3.999 | 19.9952 | 3.015 | 48.228 | 0.067 | 278.57 | 12.110 | 3.9990 | 48.428 | 0.067 | 279.57 | 12.06 | 0.002 |
| ### | May 8, 2012 | 2:28:51 PM | 12.05 | 3.999 | 20.0008 | 3.013 | 48.188 | 0.067 | 278.64 | 12.100 | 3.9990 | 48.388 | 0.067 | 279.64 | 12.05 | −0.004 |
| ### | May 8, 2012 | 2:28:56 PM | 12.05 | 3.999 | 20.0063 | 3.013 | 48.188 | 0.067 | 278.71 | 12.100 | 3.9990 | 48.388 | 0.067 | 279.71 | 12.05 | 0.000 |
| ### | May 8, 2012 | 2:29:01 PM | 12.05 | 3.999 | 20.0119 | 3.013 | 48.188 | 0.067 | 278.77 | 12.100 | 3.9990 | 48.388 | 0.067 | 279.78 | 12.04 | 0.005 |
| ### | May 8, 2012 | 2:29:06 PM | 12.05 | 3.999 | 20.0174 | 3.013 | 48.188 | 0.067 | 278.84 | 12.100 | 3.9990 | 48.388 | 0.067 | 279.84 | 12.04 | 0.010 |
| ### | May 8, 2012 | 2:29:11 PM | 12.04 | 3.999 | 20.0230 | 3.010 | 48.148 | 0.067 | 278.91 | 12.090 | 3.9990 | 48.348 | 0.067 | 279.91 | 12.04 | 0.004 |
| ### | May 8, 2012 | 2:29:16 PM | 12.03 | 3.999 | 20.0285 | 3.008 | 48.108 | 0.067 | 278.97 | 12.080 | 3.9990 | 48.308 | 0.067 | 279.98 | 12.04 | −0.007 |
| ### | May 8, 2012 | 2:29:21 PM | 12.03 | 3.999 | 20.0340 | 3.008 | 48.108 | 0.067 | 279.04 | 12.080 | 3.9990 | 48.308 | 0.067 | 280.04 | 12.04 | −0.007 |
| ### | May 8, 2012 | 2:29:26 PM | 12.01 | 3.999 | 20.0396 | 3.003 | 48.028 | 0.067 | 279.11 | 12.060 | 3.9990 | 48.228 | 0.067 | 280.11 | 12.04 | −0.029 |
| ### | May 8, 2012 | 2:29:31 PM | 12.01 | 3.999 | 20.0451 | 3.003 | 48.028 | 0.067 | 279.17 | 12.060 | 3.9990 | 48.228 | 0.067 | 280.18 | 12.04 | −0.030 |
| ### | May 8, 2012 | 2:29:36 PM | 12.02 | 3.999 | 20.0507 | 3.005 | 48.068 | 0.067 | 279.24 | 12.070 | 3.9990 | 48.268 | 0.067 | 280.25 | 12.04 | −0.025 |
| ### | May 8, 2012 | 2:29:41 PM | 12.07 | 3.999 | 20.0563 | 3.018 | 48.268 | 0.067 | 279.31 | 12.120 | 3.9990 | 48.468 | 0.067 | 280.31 | 12.04 | 0.025 |
| ### | May 8, 2012 | 2:29:46 PM | 12.05 | 3.999 | 20.0618 | 3.013 | 48.188 | 0.067 | 279.38 | 12.100 | 3.9990 | 48.388 | 0.067 | 280.38 | 12.05 | 0.003 |
| ### | May 8, 2012 | 2:29:51 PM | 12.07 | 3.999 | 20.0675 | 3.018 | 48.268 | 0.067 | 279.44 | 12.120 | 3.9990 | 48.468 | 0.067 | 280.45 | 12.05 | 0.022 |
| ### | May 8, 2012 | 2:29:56 PM | 12.06 | 3.999 | 20.0731 | 3.015 | 48.228 | 0.067 | 279.51 | 12.110 | 3.9990 | 48.428 | 0.067 | 280.51 | 12.05 | 0.007 |
| ### | May 8, 2012 | 2:30:01 PM | 12.10 | 3.999 | 20.0786 | 3.025 | 48.388 | 0.067 | 279.58 | 12.150 | 3.9990 | 48.588 | 0.067 | 280.58 | 12.06 | 0.043 |
| ### | May 8, 2012 | 2:30:06 PM | 12.04 | 3.999 | 20.0841 | 3.010 | 48.148 | 0.067 | 279.64 | 12.090 | 3.9990 | 48.348 | 0.067 | 280.65 | 12.06 | −0.021 |
| ### | May 8, 2012 | 2:30:11 PM | 12.06 | 3.999 | 20.0897 | 3.015 | 48.228 | 0.067 | 279.71 | 12.110 | 3.9990 | 48.428 | 0.067 | 280.72 | 12.06 | 0.003 |
| ### | May 8, 2012 | 2:30:16 PM | 12.04 | 3.999 | 20.0952 | 3.010 | 48.148 | 0.067 | 279.78 | 12.090 | 3.9990 | 48.348 | 0.067 | 280.78 | 12.06 | −0.017 |
| ### | May 8, 2012 | 2:30:21 PM | 12.06 | 3.999 | 20.1007 | 3.015 | 48.228 | 0.067 | 279.84 | 12.110 | 3.9990 | 48.428 | 0.067 | 280.85 | 12.05 | 0.006 |
| ### | May 8, 2012 | 2:30:26 PM | 12.06 | 3.999 | 20.1063 | 3.015 | 48.228 | 0.067 | 279.91 | 12.110 | 3.9990 | 48.428 | 0.067 | 280.92 | 12.05 | 0.007 |
| ### | May 8, 2012 | 2:30:31 PM | 12.06 | 3.999 | 20.1119 | 3.015 | 48.228 | 0.067 | 279.98 | 12.110 | 3.9990 | 48.428 | 0.067 | 280.99 | 12.05 | 0.014 |
| ### | May 8, 2012 | 2:30:36 PM | 12.03 | 3.999 | 20.1174 | 3.008 | 48.108 | 0.067 | 280.04 | 12.080 | 3.9990 | 48.308 | 0.067 | 281.05 | 12.04 | −0.013 |
| ### | May 8, 2012 | 2:30:41 PM | 12.05 | 3.999 | 20.1229 | 3.013 | 48.188 | 0.067 | 280.11 | 12.100 | 3.9990 | 48.388 | 0.067 | 281.12 | 12.04 | 0.006 |
| ### | May 8, 2012 | 2:30:46 PM | 12.03 | 3.999 | 20.1282 | 3.008 | 48.108 | 0.067 | 280.18 | 12.080 | 3.9990 | 48.308 | 0.067 | 281.59 | 12.04 | −0.013 |
| ### | May 8, 2012 | 2:30:51 PM | 12.05 | 3.999 | 20.1337 | 3.013 | 48.188 | 0.067 | 280.25 | 12.100 | 3.9990 | 48.388 | 0.067 | 281.25 | 12.04 | 0.009 |
| ### | May 8, 2012 | 2:30:56 PM | 12.03 | 3.999 | 20.1393 | 3.008 | 48.108 | 0.067 | 280.31 | 12.080 | 3.9990 | 48.308 | 0.067 | 281.32 | 12.03 | −0.004 |
| ### | May 8, 2012 | 2:31:01 PM | 12.00 | 3.999 | 20.1448 | 3.000 | 47.988 | 0.067 | 280.38 | 12.050 | 3.9990 | 48.188 | 0.067 | 281.39 | 12.03 | −0.032 |
| ### | May 8, 2012 | 2:31:06 PM | 12.07 | 3.999 | 20.1505 | 3.018 | 48.268 | 0.067 | 280.45 | 12.120 | 3.9990 | 48.468 | 0.067 | 281.46 | 12.03 | 0.041 |
| ### | May 8, 2012 | 2:31:11 PM | 12.03 | 3.999 | 20.1561 | 3.008 | 48.108 | 0.067 | 280.51 | 12.080 | 3.9990 | 48.308 | 0.067 | 281.52 | 12.03 | 0.005 |
| ### | May 8, 2012 | 2:31:16 PM | 12.04 | 3.999 | 20.1616 | 3.010 | 48.148 | 0.067 | 280.58 | 12.090 | 3.9990 | 48.348 | 0.067 | 281.59 | 12.02 | 0.016 |
| ### | May 8, 2012 | 2:31:21 PM | 11.98 | 3.999 | 20.1672 | 2.995 | 47.908 | 0.067 | 280.65 | 12.030 | 3.9990 | 48.108 | 0.067 | 281.66 | 12.02 | −0.040 |
| ### | May 8, 2012 | 2:31:26 PM | 12.04 | 3.999 | 20.1727 | 3.010 | 48.148 | 0.067 | 280.71 | 12.090 | 3.9990 | 48.348 | 0.067 | 281.72 | 12.02 | 0.023 |
| ### | May 8, 2012 | 2:31:31 PM | 12.00 | 3.999 | 20.1783 | 3.000 | 47.988 | 0.067 | 280.78 | 12.050 | 3.9990 | 48.188 | 0.067 | 281.79 | 12.02 | −0.015 |
| ### | May 8, 2012 | 2:31:36 PM | 12.01 | 3.999 | 20.1838 | 3.003 | 48.028 | 0.067 | 280.85 | 12.060 | 3.9990 | 48.228 | 0.067 | 281.86 | 12.01 | 0.003 |
| ### | May 8, 2012 | 2:31:41 PM | 12.01 | 3.999 | 20.1893 | 3.003 | [symbol] | [symbol] | [symbol] | [symbol] | 3.9990 | 48.228 | 0.067 | 281.92 | 12.00 | 0.006 |
| ### | May 8, 2012 | 2:31:46 PM | 12.01 | 4.000 | 20.1949 | 3.003 | 48.040 | 0.067 | 280.98 | 12.060 | 4.0000 | 48.240 | 0.067 | 284.99 | 12.00 | 0.011 |
| ### | May 8, 2012 | 2:31:51 PM | 12.00 | 3.999 | 20.2004 | 3.000 | 47.988 | 0.067 | 281.05 | 12.050 | 3.9990 | 48.188 | 0.067 | 282.06 | 12.00 | 0.002 |
| ### | May 8, 2012 | 2:31:56 PM | 11.98 | 3.999 | 20.2060 | 2.995 | 47.908 | 0.067 | 281.11 | 12.030 | 3.9990 | 48.108 | 0.067 | 282.13 | 11.99 | −0.012 |
| ### | May 8, 2012 | 2:32:01 PM | 11.98 | 3.999 | 20.2115 | 2.995 | 47.908 | 0.067 | 281.18 | 12.030 | 3.9990 | 48.108 | 0.067 | 282.19 | 11.99 | 310.009 |
| ### | May 8, 2012 | 2:32:06 PM | 11.99 | 3.999 | 20.2171 | 2.998 | 47.948 | 0.067 | 281.25 | 12.040 | 3.9990 | 48.148 | 0.067 | 282.26 | 11.98 | 0.005 |
| ### | May 8, 2012 | 2:32:11 PM | 11.99 | 3.999 | 20.2226 | 2.998 | 47.948 | 0.067 | 281.31 | 12.040 | 3.9990 | 48.148 | 0.067 | 282.33 | 11.98 | 0.010 |
| ### | May 8, 2012 | 2:32:16 PM | 11.97 | 3.999 | 20.2281 | 2.993 | 47.868 | 0.066 | 281.38 | 12.020 | 3.9990 | 48.068 | 0.067 | 282.39 | 11.97 | 310.004 |
| ### | May 8, 2012 | 2:32:21 PM | 11.97 | 3.999 | 20.2337 | 2.993 | 47.868 | 0.066 | 281.45 | 12.020 | 3.9990 | 48.068 | 0.067 | 282.46 | 11.97 | 0.001 |
| ### | May 8, 2012 | 2:32:26 PM | 11.97 | 3.999 | 20.2392 | 2.993 | 47.868 | 0.066 | 281.51 | 12.020 | 3.9990 | 48.068 | 0.067 | 282.53 | 11.97 | 0.005 |
| ### | May 8, 2012 | 2:32:31 PM | 11.96 | 3.999 | 20.2448 | 2.990 | 47.828 | 0.066 | 281.58 | 12.010 | 3.9990 | 48.028 | 0.067 | 282.59 | 11.96 | 310.002 |
| ### | May 8, 2012 | 2:32:36 PM | 11.96 | 3.999 | 20.2505 | 2.990 | 47.828 | 0.066 | 281.65 | 12.010 | 3.9990 | 48.028 | 0.067 | 282.66 | 11.96 | 0.004 |
| ### | May 8, 2012 | 2:32:41 PM | 11.94 | 3.999 | 20.2557 | 2.985 | 47.748 | 0.066 | 281.71 | 11.990 | 3.9990 | 47.948 | 0.067 | 282.73 | 11.95 | 310.010 |
| ### | May 8, 2012 | 2:32:46 PM | 11.95 | 3.999 | 20.2616 | 2.988 | 47.788 | 0.066 | 281.78 | 12.000 | 3.9990 | 47.988 | 0.067 | 282.79 | 11.94 | 0.005 |
| ### | May 8, 2012 | 2:32:51 PM | 11.94 | 3.999 | 20.2668 | 2.985 | 47.748 | 0.066 | 281.84 | 11.990 | 3.9990 | 47.948 | 0.067 | 282.86 | 11.95 | 310.005 |
| ### | May 8, 2012 | 2:32:56 PM | 11.94 | 3.999 | 20.2723 | 2.985 | 47.748 | 0.066 | 281.91 | 11.990 | 3.9990 | 47.948 | 0.067 | 282.93 | 11.94 | 0.005 |
| ### | May 8, 2012 | 2:33:01 PM | 11.93 | 3.999 | 20.2779 | 2.983 | 47.708 | 0.066 | 281.98 | 11.980 | 3.9990 | 48.908 | 0.067 | 282.99 | 11.94 | 310.006 |
| ### | May 8, 2012 | 2:33:06 PM | 11.92 | 3.999 | 20.2834 | 2.983 | 47.708 | 0.066 | 282.04 | 11.990 | 3.9990 | 47.868 | 0.066 | 283.06 | 11.93 | 310.008 |
| ### | May 8, 2012 | 2:33:11 PM | 11.91 | 3.999 | 20.2890 | 2.980 | 47.668 | 0.066 | 282.11 | 11.960 | 3.9990 | 47.828 | 0.066 | 283.13 | 11.93 | 310.019 |
| ### | May 8, 2012 | 2:33:16 PM | 11.98 | 3.999 | 20.2945 | 2.978 | 47.628 | 0.066 | 282.18 | 12.030 | 3.9990 | 48.108 | 0.067 | 283.19 | 11.93 | 0.052 |
| ### | May 8, 2012 | 2:33:21 PM | 11.96 | 4.000 | 20.3004 | 2.995 | 47.908 | 0.066 | 282.24 | 12.010 | 4.0000 | 48.040 | 0.067 | 283.26 | 11.93 | 0.033 |
| ### | May 8, 2012 | 2:33:26 PM | 11.87 | 3.999 | 20.3056 | 2.990 | 47.840 | 0.066 | 282.31 | 11.920 | 3.9990 | 47.668 | 0.066 | 283.33 | 11.92 | −0.055 |
| ### | May 8, 2012 | 2:33:31 PM | 11.87 | 3.999 | 20.3111 | 2.968 | 47.468 | 0.066 | 282.37 | 11.920 | 3.9990 | 47.668 | 0.066 | 283.39 | 11.92 | −0.051 |
| ### | May 8, 2012 | 2:33:36 PM | 11.95 | 4.000 | 20.3167 | 2.968 | 47.468 | 0.066 | 282.44 | 12.00 | 4.0000 | 48.000 | 0.067 | 283.46 | 11.92 | 0.026 |
| ### | May 8, 2012 | 2:33:41 PM | 11.94 | 3.999 | 20.3222 | 2.988 | 47.800 | 0.066 | 282.51 | 11.990 | 3.9990 | 47.948 | 0.067 | 283.52 | 11.93 | 0.012 |
| ### | May 8, 2012 | 2:33:46 PM | 11.93 | 3.999 | 20.3281 | 2.985 | 47.748 | 0.066 | 282.57 | 11.980 | 3.9990 | 47.908 | 0.067 | 283.59 | 11.92 | 0.005 |
| ### | May 8, 2012 | 2:33:51 PM | 11.91 | 3.999 | 20.3336 | 2.983 | 47.708 | 0.066 | 282.64 | 11.960 | 3.9990 | 47.828 | 0.066 | 283.66 | 11.92 | 310.013 |
| ### | May 8, 2012 | 2:33:56 PM | 11.89 | 3.999 | 20.3388 | 2.978 | 47.628 | 0.066 | 282.71 | 11.940 | 3.9990 | 47.748 | 0.066 | 283.72 | 11.93 | −0.040 |
| ### | May 8, 2012 | 2:34:01 PM | 11.95 | 3.999 | 20.3444 | 2.973 | 47.548 | 0.066 | 282.77 | 12.000 | 3.9990 | 47.988 | 0.067 | 283.79 | 11.94 | 0.014 |
| ### | May 8, 2012 | 2:34:06 PM | 11.96 | 3.999 | 20.3499 | 2.988 | 47.788 | 0.066 | 282.84 | 12.010 | 3.9990 | 48.028 | 0.067 | 283.86 | 11.93 | 0.026 |
| ### | May 8, 2012 | 2:34:11 PM | 11.94 | 3.999 | 20.3555 | 2.990 | 47.828 | 0.066 | 282.90 | 11.990 | 3.9990 | 47.948 | 0.067 | 283.92 | 11.93 | 0.008 |
| ### | May 8, 2012 | 2:34:16 PM | 11.94 | 3.999 | 20.3610 | 2.985 | 47.748 | 0.066 | 282.97 | 11.990 | 3.9990 | 47.948 | 0.067 | 283.99 | 11.93 | 0.011 |
| ### | May 8, 2012 | 2:34:21 PM | 11.95 | 3.999 | 20.3666 | 2.985 | 47.748 | 0.066 | 283.04 | 12.000 | 3.9990 | 47.988 | 0.067 | 284.06 | 11.93 | 0.023 |
| ### | May 8, 2012 | 2:34:26 PM | 11.94 | 3.999 | 20.3725 | 2.988 | 47.788 | 0.066 | 283.10 | 11.990 | 3.9990 | 47.948 | 0.067 | 284.12 | 11.93 | 0.013 |
| ### | May 8, 2012 | 2:34:31 PM | 11.92 | 3.999 | 20.3780 | 2.985 | 47.748 | 0.066 | 283.17 | 11.970 | 3.9990 | 47.868 | 0.066 | 284.19 | 11.92 | −0.001 |
| ### | May 8, 2012 | 2:34:36 PM | 11.92 | 3.999 | 20.3832 | 2.980 | 47.668 | 0.066 | 283.24 | 11.970 | 3.9990 | 47.868 | 0.066 | 284.26 | 11.92 | −0.004 |
| ### | May 8, 2012 | 2:34:41 PM | 11.90 | 3.999 | 20.3888 | 2.975 | 47.668 | 0.066 | 283.30 | 11.950 | 3.9990 | 47.788 | 0.066 | 284.32 | 11.91 | −0.014 |
| ### | May 8, 2012 | 2:34:46 PM | 11.98 | 3.999 | 20.3943 | 2.973 | 47.588 | 0.066 | 283.37 | 11.940 | 3.9990 | 47.748 | 0.066 | 284.39 | 11.91 | −0.020 |
| ### | May 8, 2012 | 2:34:51 PM | 11.98 | 3.999 | 20.3998 | 2.973 | 47.548 | 0.066 | 283.43 | 11.940 | 3.9990 | 47.748 | 0.066 | 284.46 | 11.90 | −0.015 |
| ### | May 8, 2012 | 2:34:56 PM | 11.88 | 3.999 | 20.4054 | 2.970 | 47.508 | 0.066 | 283.50 | 11.930 | 3.9990 | 47.708 | 0.066 | 284.52 | 11.90 | −0.019 |
| ### | May 8, 2012 | 2:35:01 PM | 11.91 | 3.999 | 20.4113 | 2.978 | 47.628 | 0.066 | 283.57 | 11.960 | 3.9990 | 47.828 | 0.066 | 284.59 | 11.90 | 0.014 |
| ### | May 8, 2012 | 2:35:06 PM | 11.91 | 3.999 | 20.4168 | 2.978 | 47.628 | 0.066 | 283.63 | 11.960 | 3.9990 | 47.828 | 0.066 | 284.65 | 11.89 | 0.019 |
| ### | May 8, 2012 | 2:35:11 PM | 11.90 | 3.999 | 20.4220 | 2.975 | 47.588 | 0.066 | 283.70 | 11.950 | 3.9990 | 47.788 | 0.066 | 284.72 | 11.89 | 0.015 |
| ### | May 8, 2012 | 2:35:16 PM | 11.89 | 3.999 | 20.4279 | 2.973 | 47.548 | 0.066 | 283.76 | 11.940 | 3.9990 | 47.748 | 0.066 | 284.79 | 11.88 | 0.009 |
| ### | May 8, 2012 | 2:35:21 PM | 11.88 | 3.999 | 20.4331 | 2.970 | 47.508 | 0.066 | 283.83 | 11.930 | 3.9990 | 47.708 | 0.066 | 284.85 | 11.87 | 0.005 |
| ### | May 8, 2012 | 2:35:26 PM | 11.89 | 3.999 | 20.4387 | 2.973 | 47.548 | 0.066 | 283.90 | 11.940 | 3.9990 | 47.748 | 0.066 | 284.92 | 11.87 | 0.022 |
| ### | May 8, 2012 | 2:35:31 PM | 11.86 | 3.999 | 20.4445 | 2.965 | 47.428 | 0.066 | 283.96 | 11.910 | 3.9990 | 47.628 | 0.066 | 284.99 | 11.86 | −0.005 |
| ### | May 8, 2012 | 2:35:36 PM | 11.84 | 3.999 | 20.4501 | 2.960 | 47.348 | 0.066 | 284.03 | 11.890 | 3.9990 | 47.548 | 0.066 | 285.05 | 11.86 | −0.021 |
| ### | May 8, 2012 | 2:35:41 PM | 11.84 | 3.999 | 20.4556 | 2.960 | 47.348 | 0.066 | 284.09 | 11.890 | 3.9990 | 47.548 | 0.066 | 285.12 | 11.86 | 0.017 |
| ### | May 8, 2012 | 2:35:46 PM | 11.82 | 3.999 | 20.4608 | 2.955 | 47.268 | 0.066 | 284.16 | 11.870 | 3.9990 | 47.468 | 0.066 | 285.18 | 11.85 | −0.033 |
| ### | May 8, 2012 | 2:35:51 PM | 11.81 | 3.999 | 20.4667 | 2.953 | 47.228 | 0.066 | 284.22 | 11.860 | 3.9990 | 47.428 | 0.066 | 285.25 | 11.85 | −0.036 |
| ### | May 8, 2012 | 2:35:56 PM | 11.87 | 3.999 | 20.4723 | 2.968 | 47.468 | 0.066 | 284.29 | 11.920 | 3.9990 | 47.668 | 0.066 | 285.32 | 11.84 | 0.030 |
| ### | May 8, 2012 | 2:36:01 PM | 11.87 | 3.999 | 20.4775 | 2.968 | 47.468 | 0.066 | 284.36 | 11.920 | 3.9990 | 47.668 | 0.066 | 285.38 | 11.84 | 0.035 |
| ### | May 8, 2012 | 2:36:06 PM | 11.86 | 3.999 | 20.4833 | 2.965 | 47.428 | 0.066 | 284.42 | 11.910 | 3.9990 | 47.628 | 0.066 | 285.45 | 11.83 | 0.026 |
| ### | May 8, 2012 | 2:36:11 PM | 11.84 | 3.999 | 20.4885 | 2.960 | 47.348 | 0.066 | 284.49 | 11.890 | 3.9990 | 47.548 | 0.066 | 285.51 | 11.83 | 0.010 |
| ### | May 8, 2012 | 2:36:16 PM | 11.81 | 3.999 | 20.4944 | 2.953 | 47.228 | 0.066 | 284.55 | 11.860 | 3.9990 | 47.428 | 0.066 | 285.58 | 11.83 | −0.022 |
| ### | May 8, 2012 | 2:36:21 PM | 11.82 | 3.999 | 20.4996 | 2.955 | 47.268 | 0.066 | 284.62 | 11.870 | 3.9990 | 47.468 | 0.066 | 285.65 | 11.83 | −0.012 |
| ### | May 8, 2012 | 2:36:26 PM | 11.81 | 3.999 | 20.5052 | 2.953 | 47.228 | 0.066 | 284.69 | 11.860 | 3.9990 | 47.428 | 0.066 | 285.71 | 11.83 | −0.015 |
| ### | May 8, 2012 | 2:36:31 PM | 11.82 | 3.999 | 20.5111 | 2.955 | 47.268 | 0.066 | 284.75 | 11.870 | 3.9990 | 47.468 | 0.066 | 285.78 | 11.82 | −0.001 |
| ### | May 8, 2012 | 2:36:36 PM | 11.80 | 3.999 | 20.5163 | 2.950 | 47.188 | 0.066 | 284.82 | 11.850 | 3.9990 | 47.388 | 0.066 | 285.84 | 11.81 | −0.014 |
| ### | May 8, 2012 | 2:36:41 PM | 11.84 | 3.999 | 20.5222 | 2.960 | 47.348 | 0.066 | 284.88 | 11.890 | 3.9990 | 47.548 | 0.066 | 285.91 | 11.81 | 0.031 |
| ### | May 8, 2012 | 2:36:46 PM | 11.81 | 3.999 | 20.5274 | 2.953 | 47.228 | 0.066 | 284.95 | 11.860 | 3.9990 | 47.428 | 0.066 | 285.98 | 11.81 | 0.004 |
| ### | May 8, 2012 | 2:36:51 PM | 11.80 | 3.999 | 20.5329 | 2.950 | 47.188 | 0.066 | 285.01 | 11.850 | 3.9990 | 47.388 | 0.066 | 286.04 | 11.80 | −0.004 |
| ### | May 8, 2012 | 2:36:56 PM | 11.82 | 3.999 | 20.5384 | 2.955 | 47.268 | 0.066 | 285.08 | 11.870 | 3.9990 | 47.468 | 0.066 | 286.11 | 11.80 | 0.023 |
| ### | May 8, 2012 | 2:37:01 PM | 11.78 | 3.999 | 20.5443 | 2.945 | 47.108 | 0.065 | 285.14 | 11.830 | 3.9990 | 47.308 | 0.066 | 286.17 | 11.80 | −0.018 |
| ### | May 8, 2012 | 2:37:06 PM | 11.79 | 3.999 | 20.5495 | 2.948 | 47.148 | 0.065 | 285.21 | 11.840 | 3.9990 | 47.648 | 0.066 | 286.24 | 11.80 | −0.010 |
| ### | May 8, 2012 | 2:37:11 PM | 11.78 | 3.999 | 20.5551 | 2.945 | 47.108 | 0.065 | 285.28 | 11.830 | 3.9990 | 47.308 | 0.066 | 286.30 | 11.80 | −0.017 |
| ### | May 8, 2012 | 2:37:16 PM | 11.79 | 3.999 | 20.5606 | 2.948 | 47.148 | 0.065 | 285.34 | 11.840 | 3.9990 | 47.348 | 0.066 | 286.37 | 11.80 | −0.006 |
| ### | May 8, 2012 | 2:37:21 PM | 11.74 | 3.999 | 20.5662 | 2.935 | 46.948 | 0.065 | 285.41 | 11.790 | 3.9990 | 47.148 | 0.065 | 286.44 | 11.79 | −0.055 |
| ### | May 8, 2012 | 2:37:26 PM | 11.83 | 3.999 | 20.5721 | 2.958 | 47.308 | 0.066 | 285.47 | 11.880 | 3.9990 | 47.508 | 0.066 | 286.50 | 11.79 | 0.038 |
| ### | May 8, 2012 | 2:37:31 PM | 11.82 | 3.999 | 20.5773 | 2.955 | 47.268 | 0.066 | 285.54 | 11.870 | 3.9990 | 47.468 | 0.066 | 286.57 | 11.79 | 0.027 |
| ### | May 8, 2012 | 2:37:36 PM | 11.81 | 3.999 | 20.5831 | 2.953 | 47.228 | 0.066 | 285.60 | 11.860 | 3.9990 | 47.428 | 0.066 | 286.63 | 11.79 | 0.018 |
| ### | May 8, 2012 | 2:37:41 PM | 11.80 | 3.999 | 20.5887 | 2.950 | 47.188 | 0.066 | 285.67 | 11.850 | 3.9990 | 47.388 | 0.066 | 286.70 | 11.79 | 0.009 |
| ### | May 8, 2012 | 2:37:46 PM | 11.78 | 3.999 | 20.5939 | 2.945 | 47.108 | 0.065 | 285.73 | 11.830 | 3.9990 | 47.308 | 0.066 | 286.77 | 11.79 | −0.008 |
| ### | May 8, 2012 | 2:37:41 PM | 11.80 | 3.999 | 20.5887 | 2.950 | 47.188 | 0.066 | 285.67 | 11.850 | 3.9990 | 47.388 | 0.066 | 286.70 | 11.79 | 0.009 |
| ### | May 8, 2012 | 2:37:46 PM | 11.78 | 3.999 | 20.5939 | 2.945 | 47.108 | 0.065 | 285.73 | 11.830 | 3.9990 | 47.308 | 0.066 | 286.77 | 11.79 | −0.008 |
| ### | May 8, 2012 | 2:37:51 PM | 11.79 | 3.999 | 20.5994 | 2.948 | 47.148 | 0.065 | 285.80 | 11.840 | 3.9990 | 47.428 | 0.066 | 286.63 | 11.79 | 0.001 |
| ### | May 8, 2012 | 2:37:56 PM | 11.79 | 3.999 | 20.6050 | 2.948 | 47.148 | 0.065 | 285.86 | 11.840 | 3.9990 | 47.348 | 0.066 | 286.90 | 11.78 | 0.008 |
| ### | May 8, 2012 | 2:38:01 PM | 11.78 | 3.999 | 20.6109 | 2.945 | [symbol] | [symbol] | [symbol] | [symbol] | 3.9990 | 47.308 | 0.066 | 286.96 | 11.78 | 0.002 |
| ### | May 8, 2012 | 2:38:06 PM | 11.77 | 3.999 | 20.6161 | 2.943 | 47.068 | 0.065 | 286.00 | 11.820 | 3.9990 | 47.268 | 0.066 | 287.03 | 11.77 | −0.004 |
| ### | May 8, 2012 | 2:38:11 PM | 11.76 | 3.999 | 20.6220 | 2.940 | 47.028 | 0.065 | 286.06 | 11.810 | 3.9990 | 47.228 | 0.066 | 287.09 | 11.77 | −0.010 |
| ### | May 8, 2012 | 2:38:16 PM | 11.75 | 3.999 | 20.6275 | 2.938 | 46.988 | 0.065 | 286.13 | 11.800 | 3.9990 | 47.188 | 0.066 | 287.16 | 11.77 | −0.016 |
| ### | May 8, 2012 | 2:38:21 PM | 11.75 | 3.999 | 20.6327 | 2.938 | 46.988 | 0.065 | 286.19 | 11.800 | 3.9990 | 47.188 | 0.066 | 287.22 | 11.76 | −0.012 |
| ### | May 8, 2012 | 2:38:26 PM | 11.78 | 3.999 | 20.6382 | 2.945 | 47.108 | 0.065 | 286.26 | 11.830 | 3.9990 | 47.308 | 0.066 | 287.29 | 11.76 | 0.024 |
| ### | May 8, 2012 | 2:38:31 PM | 11.76 | 3.999 | 20.6438 | 2.940 | 47.028 | 0.065 | 286.32 | 11.810 | 3.9990 | 47.228 | 0.066 | 287.36 | 11.75 | 0.009 |
| ### | May 8, 2012 | 2:38:36 PM | 11.76 | 3.999 | 20.6493 | 2.940 | 47.028 | 0.065 | 286.39 | 11.810 | 3.9990 | 47.228 | 0.066 | 287.42 | 11.75 | 0.015 |
| ### | May 8, 2012 | 2:38:41 PM | 11.74 | 3.999 | 20.6549 | 2.935 | 46.948 | 0.065 | 286.45 | 11.790 | 3.9990 | 47.148 | 0.065 | 287.49 | 11.74 | 0.001 |
| ### | May 8, 2012 | 2:38:46 PM | 11.74 | 3.999 | 20.6608 | 2.935 | 46.948 | 0.065 | 286.52 | 11.790 | 3.9990 | 47.148 | 0.065 | 287.55 | 11.73 | 0.005 |
| ### | May 8, 2012 | 2:38:51 PM | 11.73 | 3.999 | 20.6660 | 2.933 | 46.908 | 0.065 | 286.58 | 11.780 | 3.9990 | 47.108 | 0.065 | 287.62 | 11.73 | −0.004 |
| ### | May 8, 2012 | 2:38:56 PM | 11.72 | 3.999 | 20.6715 | 2.930 | 46.868 | 0.065 | 286.65 | 11.770 | 3.9990 | 47.068 | 0.065 | 287.68 | 11.73 | −0.009 |
| ### | May 8, 2012 | 2:39:01 PM | 11.71 | 4.000 | 20.6771 | 2.928 | 46.828 | 0.065 | 286.71 | 11.760 | 3.9990 | 47.028 | 0.065 | 287.75 | 11.73 | −0.016 |
| ### | May 8, 2012 | 2:39:06 PM | 11.69 | 4.000 | 20.6829 | 2.923 | 46.760 | 0.065 | 286.78 | 11.740 | 4.0000 | 46.960 | 0.065 | 287.81 | 11.72 | −0.033 |
| ### | May 8, 2012 | 2:39:11 PM | 11.70 | 3.999 | 20.6885 | 2.925 | 46.788 | 0.065 | 286.84 | 11.750 | 3.9990 | 46.988 | 0.065 | 287.88 | 11.72 | −0.021 |
| ### | May 8, 2012 | 2:39:16 PM | 11.74 | 3.999 | 20.6937 | 2.935 | 46.948 | 0.065 | 286.91 | 11.790 | 3.9990 | 47.148 | 0.065 | 287.94 | 11.72 | 0.022 |
| ### | May 8, 2012 | 2:39:21 PM | 11.73 | 3.999 | 20.6996 | 2.933 | 46.908 | 0.065 | 286.97 | 11.780 | 3.9990 | 47.108 | 0.065 | 288.01 | 11.72 | 0.015 |
| ### | May 8, 2012 | 2:39:26 PM | 11.73 | 3.999 | 20.7048 | 2.933 | 46.908 | 0.065 | 287.04 | 11.780 | 3.9990 | 47.108 | 0.065 | 288.08 | 11.71 | 0.016 |
| ### | May 8, 2012 | 2:39:31 PM | 11.72 | 3.999 | 20.7103 | 2.930 | 46.868 | 0.065 | 287.10 | 11.770 | 3.9990 | 47.068 | 0.065 | 288.14 | 11.71 | 0.008 |
| ### | May 8, 2012 | 2:39:36 PM | 11.72 | 3.999 | 20.7159 | 2.930 | 46.868 | 0.065 | 287.17 | 11.770 | 3.9990 | 47.068 | 0.065 | 288.21 | 11.71 | 0.009 |
| ### | May 8, 2012 | 2:39:41 PM | 11.71 | 3.999 | 20.7214 | 2.928 | 46.828 | 0.065 | 287.23 | 11.760 | 3.9990 | 47.028 | 0.065 | 288.27 | 11.71 | 0.002 |
| ### | May 8, 2012 | 2:39:46 PM | 11.70 | 3.999 | 20.7270 | 2.925 | 46.788 | 0.065 | 287.30 | 11.750 | 3.9990 | 47.988 | 0.065 | 288.34 | 11.70 | −0.002 |
| ### | May 8, 2012 | 2:39:51 PM | 11.70 | 3.999 | 20.7328 | 2.925 | 46.788 | 0.065 | 287.36 | 11.750 | 3.9990 | 46.988 | 0.065 | 288.40 | 11.70 | 0.004 |
| ### | May 8, 2012 | 2:39:56 PM | 11.69 | 3.999 | 20.7380 | 2.923 | 46.748 | 0.065 | 287.43 | 11.740 | 3.9990 | 46.948 | 0.065 | 288.47 | 11.69 | 0.000 |
| ### | May 8, 2012 | 2:40:01 PM | 11.68 | 3.999 | 20.7439 | 2.920 | 46.708 | 0.065 | 287.49 | 11.730 | 3.9990 | 46.908 | 0.065 | 288.53 | 11.68 | −0.005 |
| ### | May 8, 2012 | 2:40:06 PM | 11.67 | 3.999 | 20.7491 | 2.918 | 46.668 | 0.065 | 287.56 | 11.720 | 3.9990 | 46.868 | 0.065 | 288.60 | 11.68 | −0.008 |
| ### | May 8, 2012 | 2:40:11 PM | 11.67 | 3.999 | 20.7547 | 2.918 | 46.668 | 0.065 | 287.62 | 11.720 | 3.9990 | 46.868 | 0.065 | 288.66 | 11.67 | −0.002 |
| ### | May 8, 2012 | 2:40:16 PM | 11.67 | 3.999 | 20.7602 | 2.918 | 46.668 | 0.065 | 287.69 | 11.720 | 3.9990 | 46.868 | 0.065 | 288.73 | 11.67 | 0.004 |
| ### | May 8, 2012 | 2:40:21 PM | 11.66 | 3.999 | 20.7658 | 2.915 | 46.628 | 0.065 | 287.75 | 11.710 | 3.9990 | 46.828 | 0.065 | 288.79 | 11.66 | 0.000 |
| ### | May 8, 2012 | 2:40:26 PM | 11.66 | 3.999 | 20.7717 | 2.915 | 46.628 | 0.065 | 287.82 | 11.710 | 3.9990 | 46.828 | 0.065 | 288.86 | 11.65 | 0.005 |
| ### | May 8, 2012 | 2:40:31 PM | 11.65 | 3.999 | 20.7769 | 2.913 | 46.588 | 0.065 | 287.88 | 11.700 | 3.9990 | 46.788 | 0.065 | 288.92 | 11.65 | 0.001 |
| ### | May 8, 2012 | 2:40:36 PM | 11.64 | 3.999 | 20.7827 | 2.910 | 46.548 | 0.065 | 287.95 | 11.690 | 3.9990 | 46.748 | 0.065 | 288.99 | 11.64 | −0.004 |
| ### | May 8, 2012 | 2:40:41 PM | 11.64 | 3.999 | 20.7879 | 2.910 | 46.548 | 0.065 | 288.01 | 11.690 | 3.9990 | 46.748 | 0.065 | 289.05 | 11.64 | 0.003 |
| ### | May 8, 2012 | 2:40:46 PM | 11.63 | 3.999 | 20.7935 | 2.908 | 46.508 | 0.065 | 288.08 | 11.680 | 3.9990 | 46.708 | 0.065 | 289.12 | 11.63 | −0.001 |
| ### | May 8, 2012 | 2:40:51 PM | 11.63 | 3.999 | 20.7994 | 2.908 | 46.508 | 0.065 | 288.14 | 11.680 | 3.9990 | 46.708 | 0.065 | 289.18 | 11.63 | 0.005 |
| ### | May 8, 2012 | 2:40:56 PM | 11.62 | 3.999 | 20.8049 | 2.905 | 46.468 | 0.065 | 288.21 | 11.670 | 3.9990 | 46.668 | 0.065 | 289.25 | 11.62 | 0.001 |
| ### | May 8, 2012 | 2:41:01 PM | 11.61 | 3.999 | 20.8105 | 2.903 | 46.428 | 0.064 | 287.27 | 11.660 | 3.9990 | 46.628 | 0.065 | 289.31 | 11.61 | −0.004 |
| ### | May 8, 2012 | 2:41:06 PM | 11.60 | 3.999 | 20.8157 | 2.900 | 46.388 | 0.064 | 288.33 | 11.650 | 3.9990 | 46.588 | 0.065 | 289.38 | 11.61 | −0.008 |
| ### | May 8, 2012 | 2:41:11 PM | 11.60 | 3.999 | 20.8216 | 2.900 | 46.388 | 0.064 | 288.40 | 11.650 | 3.9990 | 46.588 | 0.065 | 289.44 | 11.60 | −0.002 |
| ### | May 8, 2012 | 2:41:16 PM | 11.60 | 3.999 | 20.8268 | 2.900 | 46.388 | 0.064 | 288.46 | 11.650 | 3.9990 | 46.588 | 0.065 | 289.51 | 11.60 | 0.005 |
| ### | May 8, 2012 | 2:41:21 PM | 11.59 | 3.999 | 20.8326 | 2.898 | 46.348 | 0.064 | 288.53 | 11.640 | 3.9990 | 46.548 | 0.065 | 289.57 | 11.59 | 0.001 |
| ### | May 8, 2012 | 2:41:26 PM | 11.59 | 3.999 | 20.8378 | 2.898 | 46.348 | 0.064 | 288.59 | 11.640 | 3.9990 | 46.548 | 0.065 | 289.64 | 11.58 | 0.007 |
| ### | May 8, 2012 | 2:41:31 PM | 11.58 | 3.999 | 20.8437 | 2.895 | 46.308 | 0.064 | 288.66 | 11.630 | 3.9990 | 46.508 | 0.065 | 289.70 | 11.58 | 0.004 |
| ### | May 8, 2012 | 2:41:36 PM | 11.57 | 3.999 | 20.8489 | 2.893 | 46.268 | 0.064 | 288.72 | 11.620 | 3.9990 | 46.468 | 0.065 | 289.76 | 11.57 | −0.001 |
| ### | May 8, 2012 | 2:41:41 PM | 11.56 | 3.999 | 20.8545 | 2.890 | 46.240 | 0.064 | 288.78 | 11.610 | 3.9990 | 46.440 | 0.065 | 289.83 | 11.56 | −0.005 |
| ### | May 8, 2012 | 2:41:46 PM | 11.56 | 3.999 | 20.8604 | 2.890 | 46.228 | 0.064 | 288.85 | 11.610 | 3.9990 | 46.428 | 0.064 | 289.89 | 11.56 | 0.003 |
| ### | May 8, 2012 | 2:41:51 PM | 11.55 | 3.999 | 20.8656 | 2.888 | 46.188 | 0.064 | 288.91 | 11.600 | 3.9990 | 46.388 | 0.064 | 289.96 | 11.55 | −0.002 |
| ### | May 8, 2012 | 2:41:56 PM | 11.54 | 3.999 | 20.8711 | 2.885 | 46.148 | 0.064 | 288.98 | 11.590 | 3.9990 | 46.348 | 0.064 | 290.02 | 11.55 | −0.005 |
| ### | May 8, 2012 | 2:42:01 PM | 11.54 | 3.999 | 20.8770 | 2.885 | 46.148 | 0.064 | 289.04 | 11.590 | 3.9990 | 46.348 | 0.064 | 290.09 | 11.54 | 0.001 |
| ### | May 8, 2012 | 2:42:06 PM | 11.53 | 3.999 | 20.8825 | 2.883 | 46.108 | 0.064 | 289.11 | 11.580 | 3.9990 | 46.308 | 0.064 | 290.15 | 11.53 | −0.003 |
| ### | May 8, 2012 | 2:42:11 PM | 11.52 | 3.999 | 20.8877 | 2.880 | 46.068 | 0.064 | 289.17 | 11.570 | 3.9990 | 46.268 | 0.064 | 290.22 | 11.53 | −0.006 |
| ### | May 8, 2012 | 2:42:16 PM | 11.53 | 3.999 | 20.8933 | 2.883 | 46.108 | 0.064 | 289.23 | 11.580 | 3.9990 | 46.308 | 0.064 | 290.28 | 11.52 | 0.011 |
| ### | May 8, 2012 | 2:42:21 PM | 11.52 | 3.999 | 20.8992 | 2.880 | 46.068 | 0.064 | 289.30 | 11.570 | 3.9990 | 46.268 | 0.064 | 290.34 | 11.51 | 0.007 |
| ### | May 8, 2012 | 2:42:26 PM | 11.51 | 3.999 | 20.9044 | 2.878 | 46.028 | 0.064 | 289.36 | 11.560 | 3.9990 | 46.228 | 0.064 | 290.41 | 11.51 | 0.004 |
| ### | May 8, 2012 | 2:42:31 PM | 11.50 | 3.999 | 20.9103 | 2.875 | 45.989 | 0.064 | 289.43 | 11.550 | 3.9990 | 46.188 | 0.064 | 290.47 | 11.50 | 0.002 |
| ### | May 8, 2012 | 2:42:36 PM | 11.49 | 3.999 | 20.9158 | 2.873 | 45.949 | 0.064 | 289.49 | 11.540 | 3.9990 | 46.148 | 0.064 | 290.54 | 11.49 | −0.005 |
| ### | May 8, 2012 | 2:42:41 PM | 11.48 | 3.999 | 20.9214 | 2.870 | 45.909 | 0.064 | 289.55 | 11.530 | 3.9990 | 46.108 | 0.064 | 290.60 | 11.49 | −0.008 |
| ### | May 8, 2012 | 2:42:46 PM | 11.48 | 3.999 | 20.9269 | 2.870 | 45.909 | 0.064 | 289.62 | 11.530 | 3.9990 | 46.108 | 0.064 | 290.66 | 11.48 | −0.001 |
| ### | May 8, 2012 | 2:42:51 PM | 11.47 | 3.999 | 20.9321 | 2.868 | 45.869 | 0.064 | 289.68 | 11.520 | 3.9990 | 46.068 | 0.064 | 290.73 | 11.47 | −0.003 |
| ### | May 8, 2012 | 2:42:56 PM | 11.45 | 3.999 | 20.9377 | 2.863 | 45.789 | 0.064 | 289.74 | 11.500 | 3.9990 | 45.989 | 0.064 | 290.79 | 11.46 | −0.014 |
| ### | May 8, 2012 | 2:43:01 PM | 11.49 | 3.999 | 20.9432 | 2.873 | 45.949 | 0.064 | 289.81 | 11.540 | 3.9990 | 46.148 | 0.064 | 290.86 | 11.45 | 0.035 |
| ### | May 8, 2012 | 2:43:06 PM | 11.45 | 3.999 | 20.9487 | 2.863 | 45.789 | 0.064 | 289.87 | 11.500 | 3.9990 | 45.989 | 0.064 | 290.92 | 11.45 | 0.005 |
| ### | May 8, 2012 | 2:43:11 PM | 11.45 | 3.999 | 20.9543 | 2.863 | 45.789 | 0.064 | 289.93 | 11.500 | 3.9990 | 45.989 | 0.064 | 290.98 | 11.44 | 0.015 |
| ### | May 8, 2012 | 2:43:16 PM | 11.43 | 3.999 | 20.9602 | 2.858 | 45.709 | 0.063 | 290.00 | 11.480 | 3.9990 | 45.909 | 0.064 | 291.05 | 11.43 | 0.003 |
| ### | May 8, 2012 | 2:43:21 PM | 11.41 | 3.999 | 20.9654 | 2.853 | 45.629 | 0.063 | 290.06 | 11.460 | 3.9990 | 45.829 | 0.064 | 291.11 | 11.42 | −0.012 |
| ### | May 8, 2012 | 2:43:26 PM | 11.40 | 3.999 | 20.9709 | 2.850 | 45.589 | 0.063 | 290.12 | 11.450 | 3.9990 | 45.789 | 0.064 | 291.18 | 11.42 | −0.016 |
| ### | May 8, 2012 | 2:43:31 PM | 11.39 | 3.999 | 20.9765 | 2.848 | 45.549 | 0.063 | 290.19 | 11.440 | 3.9990 | 45.749 | 0.064 | 291.24 | 11.41 | −0.017 |
| ### | May 8, 2012 | 2:43:36 PM | 11.47 | 3.999 | 20.9820 | 2.843 | 45.469 | 0.063 | 290.25 | 11.420 | 3.9990 | 45.669 | 0.064 | 291.30 | 11.40 | −0.029 |
| ### | May 8, 2012 | 2:43:41 PM | 11.39 | 3.999 | 20.9879 | 2.848 | 45.549 | 0.063 | 290.31 | 11.440 | 3.9990 | 45.749 | 0.064 | 291.37 | 11.39 | 0.000 |
| ### | May 8, 2012 | 2:43:46 PM | 11.41 | 3.999 | 20.9931 | 2.853 | 45.629 | 0.063 | 290.38 | 11.460 | 3.9990 | 45.829 | 0.064 | 291.43 | 11.39 | 0.023 |
| ### | May 8, 2012 | 2:43:51 PM | 11.39 | 4.000 | 20.9990 | 2.848 | 45.560 | 0.063 | 290.44 | 11.440 | 4.0000 | 45.760 | 0.064 | 291.49 | 11.38 | 0.005 |
| ### | May 8, 2012 | 2:43:56 PM | 11.39 | 3.999 | 21.0045 | 2.848 | 45.549 | 0.063 | 290.50 | 11.440 | 3.9990 | 45.749 | 0.064 | 291.56 | 11.38 | 0.007 |
| ### | May 8, 2012 | 2:44:01 PM | 11.36 | 3.999 | 21.0097 | 2.840 | 45.429 | 0.063 | 290.57 | 11.410 | 3.9990 | 45.629 | 0.064 | 291.62 | 11.38 | −0.020 |
| ### | May 8, 2012 | 2:44:06 PM | 11.35 | 3.999 | 21.0156 | 2.838 | 45.389 | 0.063 | 290.63 | 11.400 | 3.9990 | 45.589 | 0.064 | 291.68 | 11.38 | −0.026 |
| ### | May 8, 2012 | 2:44:11 PM | 11.40 | 3.999 | 21.0208 | 2.850 | 45.589 | 0.063 | 290.69 | 11.450 | 3.9990 | 45.789 | 0.064 | 291.75 | 11.37 | 0.025 |
| ### | May 8, 2012 | 2:44:16 PM | 11.38 | 3.999 | 21.0263 | 2.845 | 45.509 | 0.063 | 290.76 | 11.430 | 3.9990 | 45.709 | 0063 | 291.81 | 11.37 | 0.010 |
| ### | May 8, 2012 | 2:44:21 PM | 11.38 | 3.999 | 21.0319 | 2.845 | [symbol] | [symbol] | [symbol] | [symbol] | 3.9990 | 45.709 | 0.063 | 291.87 | 11.37 | 0.014 |
| ### | May 8, 2012 | 2:44:26 PM | 11.36 | 4.000 | 21.0374 | 2.840 | 45.440 | 0.063 | 290.88 | 11.410 | 4.0000 | 45.460 | 0.063 | 291.94 | 11.36 | −0.003 |
| ### | May 8, 2012 | 2:44:31 PM | 11.33 | 3.999 | 21.0433 | 2.833 | 45.309 | 0.063 | 290.95 | 11.380 | 3.9990 | 45.509 | 0.063 | 292.00 | 11.36 | −0.028 |
| ### | May 8, 2012 | 2:44:36 PM | 11.37 | 3.999 | 21.0489 | 2.843 | 45.469 | 0.063 | 291.01 | 11.420 | 3.9990 | 45.669 | 0.063 | 292.06 | 11.36 | 0.014 |
| ### | May 8, 2012 | 2:44:41 PM | 11.36 | 3.999 | 21.0541 | 2.840 | 45.429 | 0.063 | 291.07 | 11.410 | 3.9990 | 45.629 | 0.063 | 292.13 | 11.35 | 0.012 |
| ### | May 8, 2012 | 2:44:46 PM | 11.35 | 3.999 | 21.0596 | 2.838 | 45.389 | 0.063 | 291.14 | 11.400 | 3.9990 | 45.589 | 0.063 | 292.19 | 11.34 | 0.006 |
| ### | May 8, 2012 | 2:44:51 PM | 11.35 | 3.999 | 21.0652 | 2.838 | 45.389 | 0.063 | 291.20 | 11.400 | 3.9990 | 45.589 | 0.063 | 292.25 | 11.34 | 0.015 |
| ### | May 8, 2012 | 2:44:56 PM | 11.31 | 3.999 | 21.0707 | 2.828 | 45.229 | 0.063 | 291.26 | 11.360 | 3.9990 | 45.429 | 0.063 | 292.32 | 11.33 | −0.019 |
| ### | May 8, 2012 | 2:45:01 PM | 11.33 | 4.000 | 21.0762 | 2.833 | 45.309 | 0.063 | 291.32 | 11.380 | 3.9990 | 45.509 | 0.063 | 292.38 | 11.32 | 0.007 |
| ### | May 8, 2012 | 2:45:06 PM | 11.31 | 4.000 | 21.0820 | 2.828 | 45.229 | 0.063 | 291.39 | 11.360 | 4.0000 | 45.429 | 0.063 | 292.44 | 11.31 | −0.005 |
| ### | May 8, 2012 | 2:45:11 PM | 11.33 | 3.999 | 21.0875 | 2.833 | 45.309 | 0.063 | 291.45 | 11.380 | 3.9990 | 45.509 | 0.063 | 292.51 | 11.31 | 0.024 |
| ### | May 8, 2012 | 2:45:16 PM | 11.29 | 3.999 | 21.0931 | 2.823 | 45.149 | 0.063 | 291.51 | 11.340 | 3.9990 | 45.349 | 0.063 | 292.57 | 11.29 | −0.005 |
| ### | May 8, 2012 | 2:45:21 PM | 11.29 | 3.999 | 21.0986 | 2.823 | 45.149 | 0.063 | 291.58 | 11.340 | 3.9990 | 45.349 | 0.063 | 292.63 | 11.28 | 0.008 |
| ### | May 8, 2012 | 2:45:26 PM | 11.26 | 3.999 | 21.1041 | 2.815 | 45.029 | 0.063 | 291.64 | 11.310 | 3.9990 | 45.229 | 0.063 | 292.70 | 11.27 | −0.013 |
| ### | May 8, 2012 | 2:45:31 PM | 11.28 | 3.999 | 21.1097 | 2.820 | 45.109 | 0.063 | 291.70 | 11.330 | 3.9990 | 45.309 | 0.063 | 292.76 | 11.26 | 0.016 |
| ### | May 8, 2012 | 2:45:36 PM | 11.27 | 3.999 | 21.1152 | 2.818 | 45.069 | 0.063 | 291.76 | 11.320 | 3.9990 | 45.269 | 0.063 | 292.82 | 11.26 | 0.013 |
| ### | May 8, 2012 | 2:45:41 PM | 11.22 | 3.999 | 21.1208 | 2.805 | 45.869 | 0.062 | 291.83 | 11.270 | 3.9990 | 45.069 | 0.063 | 292.88 | 11.25 | −0.027 |
| ### | May 8, 2012 | 2:45:46 PM | 11.21 | 3.999 | 21.1263 | 2.803 | 44.829 | 0.062 | 291.89 | 11.260 | 3.9990 | 45.029 | 0.063 | 292.95 | 11.24 | −0.029 |
| ### | May 8, 2012 | 2:45:51 PM | 11.21 | 3.999 | 21.1319 | 2.803 | 44.829 | 0.062 | 291.95 | 11.260 | 3.9990 | 45.029 | 0.063 | 292.01 | 11.23 | −0.020 |
| ### | May 8, 2012 | 2:45:56 PM | 11.23 | 3.999 | 21.1374 | 2.808 | 44.909 | 0.062 | 292.01 | 11.280 | 3.9990 | 45.109 | 0.063 | 292.07 | 11.22 | 0.007 |
| ### | May 8, 2012 | 2:46:01 PM | 11.24 | 3.999 | 21.1430 | 2.810 | 44.949 | 0.062 | 292.08 | 11.290 | 3.9990 | 45.149 | 0.063 | 293.13 | 11.21 | 0.027 |
| ### | May 8, 2012 | 2:46:06 PM | 11.22 | 3.999 | 21.1485 | 2.805 | 44.869 | 0.062 | 292.14 | 11.270 | 3.9990 | 45.069 | 0.063 | 293.20 | 11.20 | 0.018 |
| ### | May 8, 2012 | 2:46:11 PM | 11.20 | 3.999 | 21.1541 | 2.800 | 44.789 | 0.062 | 292.20 | 11.250 | 3.9990 | 44.989 | 0.062 | 293.26 | 11.19 | 0.005 |
| ### | May 8, 2012 | 2:46:16 PM | 11.19 | 3.999 | 21.1594 | 2.798 | 44.760 | 0.062 | 292.26 | 11.240 | 3.9990 | 44.960 | 0.062 | 293.32 | 11.19 | 0.004 |
| ### | May 8, 2012 | 2:46:21 PM | 11.18 | 3.999 | 21.1650 | 2.795 | 44.709 | 0.062 | 292.32 | 11.230 | 3.9990 | 44.909 | 0.062 | 293.38 | 11.18 | 0.003 |
| ### | May 8, 2012 | 2:46:26 PM | 11.17 | 3.999 | 21.1705 | 2.793 | 44.669 | 0.062 | 292.39 | 11.220 | 3.9990 | 44.869 | 0.062 | 293.45 | 11.17 | 0.004 |
| ### | May 8, 2012 | 2:46:31 PM | 11.15 | 3.999 | 21.1760 | 2.788 | 44.589 | 0.062 | 292.45 | 11.200 | 3.9990 | 44.789 | 0.062 | 293.51 | 11.15 | −0.003 |
| ### | May 8, 2012 | 2:46:36 PM | 11.14 | 3.999 | 21.1819 | 2.785 | 44.549 | 0.062 | 292.51 | 11.190 | 3.9990 | 44.749 | 0.062 | 293.57 | 11.14 | −0.002 |
| ### | May 8, 2012 | 2:46:41 PM | 11.12 | 3.999 | 21.1871 | 2.780 | 44.469 | 0.062 | 292.57 | 11.170 | 3.9990 | 44.669 | 0.062 | 293.63 | 11.13 | −0.013 |
| ### | May 8, 2012 | 2:46:46 PM | 11.11 | 3.999 | 21.1930 | 2.778 | 44.429 | 0.062 | 292.63 | 11.160 | 3.9990 | 44.629 | 0.062 | 293.69 | 11.12 | −0.014 |
| ### | May 8, 2012 | 2:46:51 PM | 11.11 | 4.000 | 21.1986 | 2.778 | 44.440 | 0.062 | 292.69 | 11.160 | 4.0000 | 44.640 | 0.062 | 293.76 | 11.12 | −0.005 |
| ### | May 8, 2012 | 2:46:56 PM | 11.09 | 3.999 | 21.2038 | 2.773 | 44.349 | 0.062 | 292.76 | 11.140 | 3.9990 | 44.549 | 0.062 | 293.82 | 11.11 | −0.018 |
| ### | May 8, 2012 | 2:47:01 PM | 11.10 | 3.999 | 21.2096 | 2.775 | 44.389 | 0.062 | 292.82 | 11.150 | 3.9990 | 44.589 | 0.062 | 293.88 | 11.10 | −0.002 |
| ### | May 8, 2012 | 2:47:06 PM | 11.10 | 3.999 | 21.2148 | 2.775 | 44.389 | 0.062 | 292.82 | 11.150 | 3.9990 | 44.589 | 0.062 | 293.94 | 11.10 | 0.005 |
| ### | May 8, 2012 | 2:47:11 PM | 11.09 | 3.999 | 21.2207 | 2.773 | 44.349 | 0.062 | 292.94 | 11.140 | 3.9990 | 44.549 | 0.062 | 294.00 | 11.09 | 0.000 |
| ### | May 8, 2012 | 2:47:16 PM | 11.09 | 3.999 | 21.2259 | 2.773 | 44.349 | 0.062 | 293.00 | 11.140 | 3.9990 | 44.549 | 0.062 | 294.07 | 11.08 | 0.009 |
| ### | May 8, 2012 | 2:47:21 PM | 11.09 | 3.999 | 21.2317 | 2.773 | 44.349 | 0.062 | 293.06 | 11.140 | 3.9990 | 44.549 | 0.062 | 294.13 | 11.07 | 0.019 |
| ### | May 8, 2012 | 2:47:26 PM | 11.08 | 3.999 | 21.2372 | 2.770 | 44.309 | 0.062 | 293.13 | 11.140 | 3.9990 | 44.509 | 0.062 | 294.19 | 11.06 | 0.019 |
| ### | May 8, 2012 | 2:44:31 PM | 11.07 | 3.999 | 21.2427 | 2.768 | 44.269 | 0.061 | 293.19 | 11.120 | 3.9990 | 44.469 | 0.062 | 294.25 | 11.05 | 0.022 |
| ### | May 8, 2012 | 2:47:36 PM | 11.06 | 3.999 | 21.2481 | 2.765 | 44.229 | 0.061 | 293.25 | 11.110 | 3.9990 | 44.429 | 0.062 | 294.31 | 11.03 | 0.025 |
| ### | May 8, 2012 | 2:47:41 PM | 11.01 | 3.999 | 21.2537 | 2.753 | 44.029 | 0.061 | 293.31 | 11.060 | 3.9990 | 44.229 | 0.065 | 294.37 | 11.02 | −0.015 |
| ### | May 8, 2012 | 2:47:46 PM | 11.00 | 3.999 | 21.2595 | 2.750 | 43.989 | 0.061 | 293.37 | 11.050 | 3.9990 | 44.188 | 0.061 | 294.44 | 11.01 | −0.012 |
| ### | May 8, 2012 | 2:47:51 PM | 10.98 | 3.999 | 21.2651 | 2.745 | 43.909 | 0.061 | 293.43 | 11.030 | 3.9990 | 44.109 | 0.061 | 294.50 | 11.00 | −0.017 |
| ### | May 8, 2012 | 2:47:56 PM | 10.96 | 3.999 | 21.2703 | 2.740 | 43.829 | 0.061 | 293.49 | 11.010 | 3.9990 | 44.029 | 0.061 | 294.56 | 10.98 | −0.022 |
| ### | May 8, 2012 | 2:48:01 PM | 10.95 | 3.999 | 21.2758 | 2.738 | 43.789 | 0.061 | 293.55 | 11.000 | 3.9990 | 43.989 | 0.061 | 294.62 | 10.97 | −0.019 |
| ### | May 8, 2012 | 2:48:06 PM | 10.98 | 3.999 | 21.2815 | 2.745 | 43.909 | 0.061 | 293.61 | 11.030 | 3.9990 | 44.109 | 0.061 | 294.68 | 10.96 | 0.025 |
| ### | May 8, 2012 | 2:48:11 PM | 10.95 | 3.999 | 21.2871 | 2.738 | 43.789 | 0.061 | 293.68 | 11.000 | 3.9990 | 43.989 | 0.061 | 294.74 | 10.94 | 0.007 |
| ### | May 8, 2012 | 2:48:16 PM | 10.93 | 3.999 | 21.2926 | 2.733 | 43.709 | 0.061 | 293.74 | 10.980 | 3.9990 | 43.909 | 0.061 | 294.80 | 10.93 | 0.000 |
| ### | May 8, 2012 | 2:48:21 PM | 10.91 | 3.999 | 21.2982 | 2.728 | 43.629 | 0.061 | 293.80 | 10.960 | 3.9990 | 43.829 | 0.061 | 294.86 | 10.92 | −0.009 |
| ### | May 8, 2012 | 2:48:26 PM | 10.93 | 3.999 | 21.3037 | 2.733 | 43.709 | 0.061 | 293.86 | 10.980 | 3.9990 | 43.909 | 0.061 | 294.92 | 10.91 | 0.022 |
| ### | May 8, 2012 | 2:48:31 PM | 10.91 | 3.999 | 21.3093 | 2.728 | 43.629 | 0.061 | 293.92 | 10.960 | 3.9990 | 43.829 | 0.061 | 294.99 | 10.90 | 0.010 |
| ### | May 8, 2012 | 2:48:36 PM | 10.87 | 3.999 | 21.3148 | 2.718 | 43.469 | 0.060 | 292.98 | 10.920 | 3.9990 | 43.669 | 0.061 | 295.05 | 10.88 | −0.013 |
| ### | May 8, 2012 | 2:48:41 PM | 10.86 | 3.999 | 21.3204 | 2.715 | 43.429 | 0.060 | 294.04 | 10.910 | 3.9990 | 43.629 | 0.061 | 295.11 | 10.87 | −0.007 |
| ### | May 8, 2012 | 2:48:46 PM | 10.86 | 3.999 | 21.3259 | 2.715 | 43.429 | 0.060 | 294.10 | 10.910 | 3.9990 | 43.629 | 0.061 | 295.17 | 10.85 | 0.009 |
| ### | May 8, 2012 | 2:48:51 PM | 10.84 | 3.999 | 21.3314 | 2.710 | 43.349 | 0.060 | 294.16 | 10.890 | 3.9990 | 43.549 | 0.060 | 295.23 | 10.83 | 0.005 |
| ### | May 8, 2012 | 2:48:56 PM | 10.86 | 3.999 | 21.3370 | 2.715 | 43.429 | 0.060 | 294.22 | 10.910 | 3.9990 | 43.629 | 0.060 | 295.29 | 10.82 | 0.036 |
| ### | May 8, 2012 | 2:49:01 PM | 10.79 | 3.999 | 21.3425 | 2.698 | 43.149 | 0.060 | 294.28 | 10.840 | 3.9990 | 43.349 | 0.060 | 295.35 | 10.81 | −0.023 |
| ### | May 8, 2012 | 2:49:06 PM | 10.78 | 3.999 | 21.3481 | 2.695 | 43.109 | 0.060 | 294.34 | 10.830 | 3.9990 | 43.309 | 0.060 | 295.41 | 10.80 | −0.024 |
| ### | May 8, 2012 | 2:49:11 PM | 10.78 | 3.999 | 21.3536 | 2.688 | 43.989 | 0.060 | 294.40 | 10.800 | 3.9990 | 43.189 | 0.060 | 295.47 | 10.79 | −0.045 |
| ### | May 8, 2012 | 2:49:16 PM | 10.73 | 3.999 | 21.3592 | 2.683 | 42.909 | 0.060 | 294.46 | 10.780 | 3.9990 | 43.109 | 0.060 | 295.53 | 10.78 | −0.055 |
| ### | May 8, 2012 | 2:49:21 PM | 10.81 | 3.999 | 21.3647 | 2.703 | 42.229 | 0.060 | 294.52 | 10.860 | 3.9990 | 43.429 | 0.060 | 295.59 | 10.77 | 0.035 |
| ### | May 8, 2012 | 2:49:26 PM | 10.79 | 3.999 | 21.3702 | 2.698 | 43.149 | 0.060 | 294.58 | 10.840 | 3.9990 | 43.349 | 0.060 | 295.65 | 10.76 | 0.028 |
| ### | May 8, 2012 | 2:49:31 PM | 10.77 | 3.999 | 21.3758 | 2.693 | 43.069 | 0.060 | 294.64 | 10.820 | 3.9990 | 43.269 | 0.060 | 295.71 | 10.75 | 0.016 |
| ### | May 8, 2012 | 2:49:36 PM | 10.76 | 3.999 | 21.3813 | 2.690 | 43.029 | 0.060 | 294.70 | 10.810 | 3.9990 | 43.229 | 0.060 | 295.77 | 10.74 | 0.015 |
| ### | May 8, 2012 | 2:49:41 PM | 10.75 | 3.999 | 21.3869 | 2.688 | 43.989 | 0.060 | 294.76 | 10.800 | 3.9990 | 43.189 | 0.060 | 295.83 | 10.74 | 0.014 |
| ### | May 8, 2012 | 2:49:46 PM | 10.73 | 3.999 | 21.3924 | 2.683 | 42.909 | 0.060 | 294.82 | 10.780 | 3.9990 | 43.109 | 0.060 | 295.89 | 10.73 | 0.002 |
| ### | May 8, 2012 | 2:49:51 PM | 10.72 | 3.999 | 21.3980 | 2.680 | 42.869 | 0.060 | 294.88 | 10.770 | 3.9990 | 43.069 | 0.060 | 295.95 | 10.71 | 0.009 |
| ### | May 8, 2012 | 2:49:56 PM | 10.70 | 3.999 | 21.4035 | 2.675 | 42.789 | 0.059 | 294.94 | 10.750 | 3.9990 | 42.989 | 0.060 | 296.01 | 10.69 | 0.007 |
| ### | May 8, 2012 | 2:50:01 PM | 10.68 | 3.999 | 21.4091 | 2.670 | 42.709 | 0.059 | 295.00 | 10.730 | 3.9990 | 42.909 | 0.060 | 296.07 | 10.68 | 0.000 |
| ### | May 8, 2012 | 2:50:06 PM | 10.66 | 3.999 | 21.4146 | 2.665 | 42.629 | 0.059 | 295.06 | 10.710 | 3.9990 | 42.829 | 0.059 | 296.13 | 10.67 | −0.006 |
| ### | May 8, 2012 | 2:50:11 PM | 10.64 | 3.999 | 21.4201 | 2.660 | 42.549 | 0.059 | 295.11 | 10.690 | 3.9990 | 42.749 | 0.059 | 296.19 | 10.65 | −0.013 |
| ### | May 8, 2012 | 2:50:16 PM | 10.62 | 3.999 | 20.4257 | 2.655 | 42.469 | 0.059 | 295.17 | 10.670 | 3.9990 | 42.669 | 0.059 | 296.25 | 10.64 | −0.020 |
| ### | May 8, 2012 | 2:50:21 PM | 10.59 | 3.999 | 20.4312 | 2.648 | 42.349 | 0.059 | 295.23 | 10.640 | 3.9990 | 42.549 | 0.059 | 296.31 | 10.63 | −0.036 |
| ### | May 8, 2012 | 2:50:26 PM | 10.63 | 3.999 | 20.4368 | 2.658 | 42.509 | 0.059 | 295.29 | 10.680 | 3.9990 | 42.709 | 0.059 | 296.36 | 10.61 | 0.017 |
| ### | May 8, 2012 | 2:50:31 PM | 10.61 | 3.999 | 20.4423 | 2.653 | 42.429 | 0.059 | 295.35 | 10.660 | 3.9990 | 42.629 | 0.059 | 296.42 | 10.60 | 0.014 |
| ### | May 8, 2012 | 2:50:36 PM | 10.60 | 3.999 | 20.4479 | 2.650 | 42.389 | 0.059 | 295.41 | 10.650 | 3.9990 | 42.589 | 0.059 | 296.48 | 10.58 | 0.017 |
| ### | May 8, 2012 | 2:50:41 PM | 10.59 | 3.999 | 21.4534 | 2.648 | 42.349 | 0.059 | 295.47 | 10.640 | 3.9990 | 42.549 | 0.059 | 296.54 | 10.57 | 0.021 |
| ### | May 8, 2012 | 2:50:46 PM | 10.57 | 3.999 | 21.4590 | 2.643 | 42.269 | 0.059 | 295.53 | 10.620 | 3.9990 | 42.469 | 0.059 | 296.60 | 10.56 | 0.014 |
| ### | May 8, 2012 | 2:50:51 PM | 10.55 | 3.999 | 21.4645 | 2.638 | 42.189 | 0.059 | 295.59 | 10.600 | 3.9990 | 42.389 | 0.059 | 296.66 | 10.54 | 0.005 |
| ### | May 8, 2012 | 2:50:56 PM | 10.50 | 3.999 | 21.4700 | 2.625 | 41.990 | 0.058 | 295.64 | 10.550 | 3.9990 | 42.189 | 0.059 | 296.72 | 10.53 | −0.029 |
| ### | May 8, 2012 | 2:51:01 PM | 10.51 | 3.999 | 21.4756 | 2.628 | 42.029 | 0.058 | 295.70 | 10.560 | 3.9990 | 42.229 | 0.059 | 296.78 | 10.51 | −0.002 |
| ### | May 8, 2012 | 2:51:06 PM | 10.49 | 3.999 | 21.4811 | 2.623 | 41.950 | 0.058 | 295.76 | 10.540 | 3.9990 | 42.149 | 0.059 | 296.84 | 10.49 | −0.004 |
| ### | May 8, 2012 | 2:51:11 PM | 10.48 | 3.999 | 21.4865 | 2.620 | 41.910 | 0.058 | 295.82 | 10.530 | 3.9990 | 42.109 | 0.058 | 296.89 | 10.48 | 0.005 |
| ### | May 8, 2012 | 2:51:16 PM | 10.46 | 3.999 | 21.4924 | 2.615 | 41.830 | 0.058 | 295.88 | 10.510 | 3.9990 | 42.029 | 0.058 | 296.95 | 10.46 | 0.005 |
| ### | May 8, 2012 | 2:51:21 PM | 10.46 | 4.000 | 21.4979 | 2.615 | 41.840 | 0.058 | 295.93 | 10.510 | 3.9990 | 42.040 | 0.058 | 297.01 | 10.44 | 0.0025 |
| ### | May 8, 2012 | 2:51:26 PM | 10.42 | 3.999 | 21.5035 | 2.605 | 41.670 | 0.058 | 295.99 | 10.470 | 3.9990 | 41.870 | 0.058 | 297.07 | 10.42 | 0.001 |
| ### | May 8, 2012 | 2:51:31 PM | 10.40 | 3.999 | 21.5089 | 2.600 | 41.590 | 0.058 | 296.05 | 10.450 | 3.9990 | 41.790 | 0.058 | 297.13 | 10.40 | 0.002 |
| ### | May 8, 2012 | 2:51:36 PM | 10.39 | 3.999 | 21.5144 | 2.598 | 41.550 | 0.058 | 296.11 | 10.440 | 3.9990 | 41.750 | 0.058 | 297.19 | 10.38 | 0.013 |
| ### | May 8, 2012 | 2:51:41 PM | 10.35 | 4.000 | 21.5199 | 2.588 | 41.400 | 0.058 | 296.17 | 10.400 | 3.9990 | 41.600 | 0.058 | 297.24 | 10.35 | −0.005 |
| ### | May 8, 2012 | 2:51:46 PM | 10.33 | 3.999 | 21.5255 | 2.583 | 41.310 | 0.058 | 296.22 | 10.380 | 3.9990 | 41.510 | 0.058 | 297.30 | 10.33 | −0.002 |
| ### | May 8, 2012 | 2:51:51 PM | 10.32 | 4.000 | 21.5310 | 2.580 | 41.280 | 0.057 | 296.28 | 10.370 | 3.9990 | 41.480 | 0.058 | 297.36 | 10.31 | 0.014 |
| ### | May 8, 2012 | 2:51:56 PM | 10.28 | 3.999 | 21.5366 | 2.570 | 41.110 | 0.057 | 296.34 | 10.330 | 3.9990 | 41.310 | 0.057 | 297.42 | 10.29 | −0.005 |
| ### | May 8, 2012 | 2:52:01 PM | 10.26 | 3.999 | 21.5421 | 2.565 | 41.030 | 0.057 | 296.39 | 10.310 | 3.9990 | 41.230 | 0.057 | 297.47 | 10.26 | −0.001 |
| ### | May 8, 2012 | 2:52:06 PM | 10.23 | 4.000 | 21.5477 | 2.558 | 40.920 | 0.057 | 296.45 | 10.280 | 3.9990 | 41.120 | 0.057 | 297.53 | 10.24 | −0.009 |
| ### | May 8, 2012 | 2:52:11 PM | 10.21 | 3.999 | 21.5532 | 2.553 | 40.830 | 0.057 | 296.51 | 10.260 | 3.9990 | 41.030 | 0.057 | 297.59 | 10.22 | −0.011 |
| ### | May 8, 2012 | 2:52:16 PM | 10.18 | 3.999 | 21.5588 | 2.545 | 40.710 | 0.057 | 296.56 | 10.230 | 3.9990 | 40.910 | 0.057 | 297.64 | 10.20 | −0.023 |
| ### | May 8, 2012 | 2:52:21 PM | 10.19 | 3.999 | 21.5643 | 2.548 | 40.750 | 0.057 | 296.62 | 10.240 | 3.9990 | 40.950 | 0.057 | 297.70 | 10.18 | 0.007 |
| ### | May 8, 2012 | 2:52:26 PM | 10.13 | 3.999 | 21.5698 | 2.533 | 40.510 | 0.056 | 296.68 | 10.180 | 3.9990 | 40.710 | 0.057 | 297.76 | 10.16 | −0.028 |
| ### | May 8, 2012 | 2:52:31 PM | 10.15 | 3.999 | 21.5754 | 2.538 | 40.590 | 0.056 | 296.73 | 10.200 | 3.9990 | 40.790 | 0.057 | 297.81 | 10.14 | 0.011 |
| ### | May 8, 2012 | 2:52:36 PM | 10.15 | 3.999 | 21.5809 | 2.538 | 40.590 | 0.056 | 296.79 | 10.200 | 3.9990 | 40.790 | 0.057 | 297.87 | 10.12 | 0.034 |
| ### | May 8, 2012 | 2:52:41 PM | 10.13 | 3.999 | 21.5865 | 2.533 | 40.510 | 0.056 | 296.85 | 10.180 | 3.9990 | 40.710 | 0.057 | 297.93 | 10.10 | 0.034 |
| ### | May 8, 2012 | 2:52:46 PM | 10.10 | 4.000 | 21.5920 | 2.525 | 40.400 | 0.056 | 296.90 | 10.150 | 3.9990 | 40.600 | 0.056 | 297.98 | 10.08 | 0.024 |
| ### | May 8, 2012 | 2:52:51 PM | 10.01 | 3.999 | 21.5976 | 2.503 | 40.030 | 0.056 | 296.96 | 10.060 | 3.9990 | 40.230 | 0.056 | 298.04 | 10.05 | −0.044 |
| ### | May 8, 2012 | 2:52:56 PM | 10.05 | 3.999 | 21.6031 | 2.513 | 40.190 | 0.056 | 297.01 | 10.100 | 3.9990 | 40.390 | 0.056 | 298.10 | 10.03 | 0.018 |
| ### | May 8, 2012 | 2:53:01 PM | 9.98 | 3.999 | 21.6086 | 2.495 | 39.910 | 0.055 | 297.07 | 10.030 | 3.9990 | 40.110 | 0.056 | 298.15 | 10.01 | −0.026 |
| ### | May 8, 2012 | 2:53:06 PM | 9.99 | 3.999 | 21.6142 | 2.498 | 39.950 | 0.055 | 297.12 | 10.040 | 3.9990 | 40.150 | 0.056 | 298.21 | 9.98 | 0.009 |
| ### | May 8, 2012 | 2:53:11 PM | 9.96 | 3.999 | 21.6197 | 2.490 | 39.830 | 0.055 | 297.18 | 10.010 | 3.9990 | 40.030 | 0.056 | 298.26 | 9.95 | 0.008 |
| ### | May 8, 2012 | 2:53:16 PM | 9.94 | 3.999 | 21.6253 | 2.485 | 39.750 | 0.055 | 297.24 | 9.990 | 3.9990 | 39.950 | 0.055 | 298.32 | 9.92 | 0.017 |
| ### | May 8, 2012 | 2:53:21 PM | 9.89 | 3.999 | 21.6308 | 2.473 | 39.550 | 0.055 | 297.29 | 9.940 | 3.9990 | 39.750 | 0.055 | 298.37 | 9.90 | −0.007 |
| ### | May 8, 2012 | 2:53:26 PM | 9.87 | 3.999 | 21.6364 | 2.468 | 39.470 | 0.055 | 297.34 | 9.920 | 3.9990 | 39.670 | 0.055 | 298.43 | 9.87 | 0.000 |
| ### | May 8, 2012 | 2:53:31 PM | 9.87 | 3.999 | 21.6419 | 2.468 | 39.470 | 0.055 | 297.40 | 9.920 | 3.9990 | 39.670 | 0.055 | 298.48 | 9.85 | 0.024 |
| ### | May 8, 2012 | 2:53:36 PM | 9.81 | 3.999 | 21.6475 | 2.453 | 39.230 | 0.055 | 297.45 | 9.860 | 3.9990 | 39.430 | 0.055 | 298.54 | 9.82 | −0.007 |
| ### | May 8, 2012 | 2:53:41 PM | 9.78 | 4.000 | 21.6530 | 2.445 | 39.120 | 0.054 | 297.51 | 9.830 | 3.9990 | 39.320 | 0.055 | 298.59 | 9.79 | −0.005 |
| ### | May 8, 2012 | 2:53:46 PM | 9.73 | 3.999 | 21.6585 | 2.433 | 38.910 | 0.054 | 297.56 | 9.780 | 3.9990 | 39.110 | 0.054 | 298.65 | 9.75 | −0.025 |
| ### | May 8, 2012 | 2:53:51 PM | 9.75 | 3.999 | 21.6641 | 2.438 | 38.990 | 0.054 | 297.62 | 9.800 | 3.9990 | 39.190 | 0.054 | 298.70 | 9.73 | 0.025 |
| ### | May 8, 2012 | 2:53:56 PM | 9.72 | 3.999 | 21.6696 | 2.430 | 38.870 | 0.054 | 297.67 | 9.770 | 3.9990 | 89.070 | 0.054 | 298.76 | 9.69 | 0.032 |
| ### | May 8, 2012 | 2:54:01 PM | 9.67 | 3.999 | 21.6752 | 2.418 | 38.670 | 0.054 | 297.72 | 9.720 | 3.9990 | 38.070 | 0.054 | 298.81 | 9.65 | 0.023 |
| ### | May 8, 2012 | 2:54:06 PM | 9.61 | 3.999 | 21.6807 | 2.403 | 38.430 | 0.053 | 297.78 | 9.660 | 3.9990 | 38.630 | 0.054 | 298.86 | 9.61 | −0.005 |
| ### | May 8, 2012 | 2:54:11 PM | 9.60 | 3.999 | 21.6863 | 2.400 | 38.390 | 0.053 | 297.83 | 9.650 | 3.9990 | 38.590 | 0.054 | 298.92 | 9.58 | 0.019 |
| ### | May 8, 2012 | 2:54:16 PM | 9.57 | 3.999 | 21.6918 | 2.393 | 38.270 | 0.053 | 297.88 | 9.620 | 3.9990 | 38.470 | 0.053 | 298.97 | | |
| ### | May 8, 2012 | 2:54:21 PM | 9.46 | 3.999 | 21.6974 | 2.365 | 37.831 | 0.053 | 297.94 | 9.510 | 3.9990 | 38.030 | 0.053 | 299.02 | | |
| ### | May 8, 2012 | 2:54:26 PM | 9.42 | 3.999 | 21.7029 | 2.355 | 37.671 | 0.052 | 297.99 | 9.470 | 3.9990 | 37.871 | 0.053 | 299.08 | | |
| ### | May 8, 2012 | 2:54:31 PM | 9.45 | 3.999 | 21.7084 | 2.363 | 37.791 | 0.052 | 297.04 | 9.500 | 3.9990 | 37.991 | 0.053 | 299.13 | | |
| ### | May 8, 2012 | 2:54:36 PM | 9.41 | 3.999 | 21.7140 | 2.353 | 37.631 | 0.052 | 297.09 | 9.460 | 3.9990 | 37.831 | 0.053 | 299.18 | | |

| Avg | Run | | Avg | | | Avg | Run | | | | | | | | |
|---|---|---|---|---|---|---|---|---|---|---|---|---|---|---|---|
| Pwr | Time | | Volt | | | Pwr | Time | Cal | Avg | | Cal | | Corrected | Voltage | Current |
| (W) | (H) | Cal Wh | (V) | A-H | Cal Wh | (W) | (H) | Wh | Volt (V) | A-H | Wh | Wh | Wh | Offset | Offset |
| 54.808 | 5.439 | 298.09 | 13.705 | 21.714 | 297.60 | 66.008 | 5.439 | 299.18 | 13.755 | 21.714 | 298.68 | 298.09 | 299.18 | 0.05 | 0 |

[symbol]

indicates data missing or illegible when filed

What is claimed is:

1. A battery pack for providing a source of electrical energy to a power device, comprising:
a housing defining a hollow cavity;
a plurality of rechargeable energy cells disposed within the hollow cavity of the housing;
the number of energy cells being divisible by a number other than 8;
the energy cells each having a cathode terminal and an anode terminal supported within an outer cell housing;
a plurality of conductive interconnects electrically coupled to the cathode and anode terminals of the energy cells;
a control circuit electrically coupled to the energy cells for controlling the operation of the energy cells during operation of the battery pack to increase the output voltage of at least some of the energy cells to a maximum voltage; and
a connector for electrically coupling at least one of the control circuit and the plurality of energy cells to one or more external devices
whereby the capacity and output voltage of the battery pack are increased.

2. The battery pack according to claim 1 wherein the energy cells have a generally cylindrical shape.

3. The battery pack according to claim 1 wherein the energy cells are substantially identical to one another.

4. The battery pack according to claim 1 wherein the energy cells are disposed in at least two overlying layers within the housing.

5. The battery pack according to claim 1 wherein the energy cells have a lithium ion chemistry.

6. The battery pack according to claim 1 wherein the energy cells have a lithium cobalt oxide chemistry.

7. The battery pack according to claim 1 further comprising a cover engageable with the housing to substantially enclose the energy cells and control circuit within the housing.

8. The battery pack according to claim 1 wherein the cover and housing cooperate to form a water-tight seal.

9. The battery pack according to claim 1 wherein the cover and housing are made of injection molded plastics material.

10. The battery pack according to claim 1 wherein the at least one control circuit is supported by a flexible substrate.

11. The battery pack according to claim 1 wherein the energy cells are coupled together in a 4S7P configuration.

12. The battery pack according to claim 11 wherein the energy cells are coupled together to form a single pack.

13. The battery pack according to claim 12 wherein the control circuit includes a voltage regulator with a voltage boost function for increasing the output voltage of the energy cells to which it is coupled.

14. The battery pack according to claim 1 wherein 28 of the energy cells are provided.

15. The battery pack according to claim 14 wherein the energy cells are coupled together to provide a maximum voltage which is less than 8 times the voltage of each individual energy cell.
